(19) United States
(12) Patent Application Publication
(10) Pub. No.: US 2026/0237005 A1
(43) Pub. Date: Aug. 13, 2026

(54) AI-BASED ENERGY EDGE PLATFORM, SYSTEMS, AND METHODS

(71) Applicant: Strong Force EE Portfolio 2022, LLC, Fort Lauderdale, FL (US)

(72) Inventors: Charles Howard Cella, Pembroke, MA (US); Andrew Bunin, Lakewood Ranch, FL (US); Andrew Cardno, San Diego, CA (US); Anthony Cascio, Lutz, FL (US); Taylor Charon, Troy, MI (US); Joshua Dobrowitsky, Birmingham, MI (US); Teymour S. El-Tahry, Detroit, MI (US); Leon R. Fortin, JR., Providence, RI (US); Andrew Locke, Farmington, MI (US); Henry Mohr, Philadelphia, PA (US); Jenna Parenti, Broomfield, CO (US); Nicholas Rogosin, Studio City, CA (US); Kunal Sharma, Mumbai (IN); David Stein, Fairfax, VA (US); Eric P. Vetter, Apex, NC (US)

(21) Appl. No.: 19/352,237

(22) Filed: Oct. 7, 2025

Related U.S. Application Data
(63) Continuation of application No. PCT/US2024/026336, filed on Apr. 25, 2024.
Application No. PCT/US2024/026336 is a continuation-in-part of application No. PCT/IB2023/058962, filed on Sep. 10, 2023.
(60) Provisional application No. 63/375,225, filed on Sep. 10, 2022.
(60) Provisional application No. 63/461,810, filed on Apr. 25, 2023.
(60) Provisional application No. 63/472,225, filed on Jun. 9, 2023.
(60) Provisional application No. 63/535,747, filed on Aug. 31, 2023.
(60) Provisional application No. 63/537,478, filed on Sep. 8, 2023.
(60) Provisional application No. 63/537,478, filed on Sep. 8, 2023.
(60) Provisional application No. 63/610,870, filed on Dec. 15, 2023.
(60) Provisional application No. 63/621,540, filed on Jan. 16, 2024.
(60) Provisional application No. 63/625,613, filed on Jan. 26, 2024.

(30) Foreign Application Priority Data
Aug. 23, 2025 (IN) 202311057688

(51) Int. Cl. G06Q 50/06; G06Q 30/0201; G06Q 30/0283

(52) U.S. Cl. CPC G06Q 50/06; G06Q 30/0206; G06Q 30/0283

(57) ABSTRACT

An AI-based energy edge platform is provided herein with a wide range of features, components and capabilities for management and improvement of legacy infrastructure, coordination, and orchestration with distributed systems to support important use cases for a range of enterprises. An AI-based energy edge platform may include a graph neural network including a set of nodes respectively representing at least one distributed energy resource (DER) and a set of edges respectively interconnecting the set of nodes, wherein each edge represents at least one energy-related feature among at least two nodes of the set of nodes. The platform may incorporate emerging technologies to enable ecosystem and individual energy edge node efficiencies, agility, engagement, and profitability. Embodiments may forecast, plan for, and manage the demand and utilization of energy in greater distributed environments. Embodiments may employ intelligent provisioning, data aggregation, and analytics to leverage energy market connection, communication, and transaction enablement platforms.

### CROSS-REFERENCE TO RELATED APPLICATIONS

This application is a continuation of International Application No. PCT/US24/26336, filed Apr. 25, 2024, which is a continuation-in-part of International Application No. PCT/IB2023/058962 filed Sep. 10, 2023, which claims priority to IN 202311057688 filed Aug. 28, 2023 and claims the benefit of:
U.S. Prov. App. No. 63/375,225 filed Sep. 10, 2022, and
U.S. Prov. App. No. 63/537,478 filed Sep. 8, 2023.

International Application No. PCT/US24/26336 claims priority to IN 202311057688 filed Aug. 28, 2023.

International Application No. PCT/US24/26336 also claims the benefit of:
U.S. Prov. App. No. 63/461,810 filed Apr. 25, 2023,
U.S. Prov. App. No. 63/472,225 filed Jun. 9, 2023,
U.S. Prov. App. No. 63/535,747 filed Aug. 31, 2023,
U.S. Prov. App. No. 63/537,478 filed Sep. 8, 2023,
U.S. Prov. App. No. 63/610,870 filed Dec. 15, 2023,
U.S. Prov. App. No. 63/621,540 filed Jan. 16, 2024, and
U.S. Prov. App. No. 63/625,613 filed Jan. 26, 2024.

All of the aforementioned applications are hereby incorporated by reference in their entireties.

### BACKGROUND

Energy remains a critical factor in the world economy and is undergoing an evolution and transformation, involving changes in energy generation, storage, planning, demand management, consumption and delivery systems and processes. These changes are enabled by the development and convergence of numerous diverse technologies, including more distributed, modular, mobile and/or portable energy generation and storage technologies that will make the energy market much more decentralized and localized, as well as a range of technologies that will facilitate management of energy in a more decentralized system, including edge and Internet of Things networking technologies, advanced computation and artificial intelligence technologies, transaction enablement technologies (such as blockchains, distributed ledgers and smart contracts) and others. The convergence of these more decentralized energy technologies with these networking, computation and intelligence technologies is referred to herein as the “energy edge.”

The energy market is expected to evolve and transform over the next few decades from a highly centralized model that relies on fossil fuels and a managed electrical grid to a much more distributed and decentralized model that involves many more localized generation, storage, and consumption systems. During that transition, a hybrid system will likely persist for many years in which the conventional grid becomes more intelligent, and in which distributed systems will play a growing role. A need exists for a platform that facilitates management and improvement of legacy infrastructure in coordination with distributed systems.

### SUMMARY

An AI-based energy edge platform is provided herein with a wide range of features, components and capabilities for management and improvement of legacy infrastructure and coordination with distributed systems to support important use cases for a range of enterprises. The platform may incorporate emerging technologies to enable ecosystem and individual energy edge node efficiencies, agility, engagement, and profitability. Embodiments may be guided by, and in some cases integrated with, methodologies and systems that are used to forecast, plan for, and manage the demand and utilization of energy in greater distributed environments. Embodiments may use AI, and AI enablers such as IoT, which may be deployed in vastly denser data environments (reflecting the proliferation of smart energy systems and of sensors in the IoT), as well as technologies that filter, process, and move data more effectively across communication networks. Embodiments of the platform may leverage energy market connection, communication, and transaction enablement platforms. Embodiments may employ intelligent provisioning, data aggregation, and analytics. Among many use cases the platform may enable improvements in the optimization of energy generation, storage, delivery and/or enterprise consumption in operations (e.g., buildings, data centers, and factories, among many others), the integration and use of new power generation and energy storage technologies and assets (distributed energy resources, or “DERs”), the optimization of energy utilization across existing networks and the digitalization of existing infrastructure and supporting systems.

In some aspects, the techniques described herein relate to an AI-based platform for enabling intelligent orchestration and management of power and energy, including: an adaptive energy data pipeline configured to communicate data across a set of nodes in a network, wherein each node of the set of nodes is adapted to operate on an energy data set associated with at least one of energy generation, energy storage, energy delivery, or energy consumption, and wherein at least one node of the set of nodes is configured, by one or both of an algorithm or a rule set, to filter, compress, transform, error correct and/or route at least a portion of the energy data set based on at least one of a set of network conditions, data size, data granularity, or data content.

In some aspects, the techniques described herein relate to an AI-based platform, wherein the adaptive energy data pipeline is further configured to adapt a transport of data over a network and/or communication system, wherein the adapting is based on one or more of, a congestion condition, a delay and/or latency condition, a packet loss condition, an error rate condition, a cost of transport condition, a quality-of-service (QoS) condition, a usage condition, a market factor condition, and a user configuration condition.

In some aspects, the techniques described herein relate to an AI-based platform, further including an adaptive energy digital twin that represents one or more of, an energy stakeholder entity, an energy distribution resource, a stakeholder information technology, a networking infrastructure entity, an energy-dependent stakeholder production facility, a stakeholder transportation system, a market condition, or an energy usage priority condition.

In some aspects, the techniques described herein relate to an AI-based platform, further including an adaptive energy digital twin that is configured to perform one or more of, providing a visual and/or analytic indicator of energy consumption by one or more energy consumers, filtering energy data, highlighting energy data, or adjusting energy data.

In some aspects, the techniques described herein relate to an AI-based platform, further including an adaptive energy digital twin that is configured to generate a visual and/or analytic indicator of energy consumption by one or more of, one or more machines, one or more factories, or one or more vehicles in a vehicle fleet.

In some aspects, the techniques described herein relate to an AI-based platform, wherein the adaptive energy data pipeline is further configured to perform one or more of, extracting energy-related data, detecting and/or correcting errors in energy-related data, transforming, converting, normalizing, and/or cleansing energy-related data, parsing energy-related data, detecting patterns, content, and/or objects in energy-related data, compressing energy-related data, streaming energy-related data, filtering energy-related data, loading and/or storing energy-related data, routing and/or transporting energy-related data, or maintaining security of energy-related data.

In some aspects, the techniques described herein relate to an AI-based platform, wherein the energy data set is based on one or more public data resources, the public data resources including one or more of, a weather data resource, a satellite data resource, a census, population, demographic, and/or psychographic data resource, a market data resource, or an ecommerce data resource.

In some aspects, the techniques described herein relate to an AI-based platform, wherein the energy data set is based on one or more enterprise data resources, the enterprise data resources including one or more of, resource planning data, sales and/or marketing data, financial planning data, demand planning data, supply chain data, procurement data, pricing data, customer data, product data, or operating data.

In some aspects, the techniques described herein relate to an AI-based platform, further including at least one AI-based model and/or algorithm, wherein the at least one AI-based model and/or algorithm is trained based on a training data set, and the training data set is based on one or more of, one or more human tags and/or labels, one or more human interactions with a hardware and/or software system, one or more outcomes, one or more AI-generated training data samples, a supervised learning training process, a semi-supervised learning training process, or a deep learning training process.

In some aspects, the techniques described herein relate to an AI-based platform, wherein at least one node of the set of nodes is configured to orchestrate delivery of energy to one or more points of consumption, and the delivery of the energy includes one or more of, one or more fixed transmission lines, one or more instances of wireless energy transmission, one or more deliveries of fuel, or one or more deliveries of stored energy.

In some aspects, the techniques described herein relate to an AI-based platform, wherein at least one node of the set of nodes is further configured to record, in a distributed ledger and/or blockchain, one or more energy-related events, the one or more energy-related events including one or more of, an energy purchase and/or sale event, a service charge associated with an energy purchase and/or sale event, an energy consumption event, an energy generation event, an energy distribution event, an energy storage event, a carbon emission production event, a carbon emission abatement event, a renewable energy credit event, a pollution production event, or a pollution abatement event.

In some aspects, the techniques described herein relate to an AI-based platform, wherein at least one node of the set of nodes is deployed in an off-grid environment, and the off-grid environment includes one or more of, an off-grid energy generation system, an off-grid energy storage system, or an off-grid energy mobilization system.

In some aspects, the techniques described herein relate to an AI-based platform, wherein the adaptive energy data pipeline is further configured to, monitor one or both of, an overall energy consumption by at least a portion of the set of nodes, or a role of at least one node of the set of nodes in an overall energy consumption by at least a portion of the set of nodes, and based on the monitoring, perform one or more of, managing an energy consumption by the set of nodes, forecasting an energy consumption by the set of nodes, or provisioning resources associated with energy consumption by the set of nodes.

In some aspects, the techniques described herein relate to an AI-based platform, wherein the set of nodes in the network that include the adaptive energy data pipeline include a set of edge networking devices that govern at least one of energy consumption, energy storage, energy delivery or energy consumption by a set of operating devices that are controlled via the edge networking devices.

In some aspects, the techniques described herein relate to an AI-based platform, wherein the adaptive energy data pipeline is further configured to automatically select a least-cost route for data communicated across the set of nodes, the selection being based on a low-priority energy use related to the data.

In some aspects, the techniques described herein relate to an AI-based platform, wherein the adaptive energy data pipeline is further configured to automatically select a high-quality of service route for data communicated across the set of nodes, the selection being based on a high-priority energy use related to the data.

In some aspects, the techniques described herein relate to an AI-based platform, wherein the adaptive energy data pipeline includes a set of artificial intelligence capabilities, the capabilities being configured to adapt the pipeline to enable optimization of elements of data transmission in coordination with energy orchestration needs.

In some aspects, the techniques described herein relate to an AI-based platform, wherein the adaptive energy data pipeline includes a self-organizing data storage, the data storage being configured to store data on a device based on one or more of patterns of the data, content of the data, or context of the data.

In some aspects, the techniques described herein relate to an AI-based platform, wherein the adaptive energy data pipeline is configured to perform automated, adaptive networking, the adaptive networking including one or more of adaptive protocol selection, adaptive routing of data based on RF conditions, adaptive filtering of data, adaptive slicing of network bandwidth, adaptive use of cognitive network capacity, or adaptive use of peer-to-peer network capacity.

In some aspects, the techniques described herein relate to an AI-based platform, wherein the adaptive energy data pipeline is configured to perform enterprise contextual adaptation by automatically processing data based on one or more of an operating context of an enterprise, a transactional context of an enterprise, or a financial context of an enterprise.

In some aspects, the techniques described herein relate to an AI-based platform, wherein at least one node of the set of nodes is further configured to adjust communication with at least one other node of the set of nodes to adapt a reporting, to the at least one other node, of data associated with the at least one of energy generation, energy storage, energy delivery, or energy consumption.

In some aspects, the techniques described herein relate to an AI-based platform, wherein the at least one node at least one node of the set of nodes is further configured to adapt reported data to at least one other node of the set of nodes, wherein adapting the reported data is based on a priority of a consumption of the reported data.

In some aspects, the techniques described herein relate to an AI-based platform, wherein the set of nodes includes a heterogeneous set including at least one energy producer and at least one energy consumer, and the adaptive energy data pipeline is further configured to instruct one or both of the at least one energy producer and at least one energy consumer to communicate with at least one other node of the set of nodes through at least one communication route.

In some aspects, the techniques described herein relate to an AI-based platform, wherein the adaptive energy data pipeline is further configured to request reported data, from at least one node of the set of nodes, the reported data is based on a level of granularity, and the level of granularity is based on a priority of a machine associated with the reported data.

In some aspects, the techniques described herein relate to an AI-based platform, wherein the adaptive energy data pipeline is further configured to prioritize a transmission of reported data through the adaptive energy data pipeline, and the prioritizing is based on a monitoring responsibility associated with the reported data.

In some aspects, the techniques described herein relate to an AI-based platform for enabling intelligent orchestration and management of power and energy, including: a set of adaptive, autonomous data handling systems, wherein each of the adaptive, autonomous data handling systems is configured to collect data relating to energy generation, storage, or delivery from a set of edge devices that are in operational control of a set of distributed energy resources and is configured to autonomously adjust, based on the collected data, a set of operational parameters for such operational control.

In some aspects, the techniques described herein relate to an AI-based platform, wherein each of the adaptive, autonomous data handling systems is further configured to adapt a transport of data over a network and/or communication system, wherein the adapting is based on one or more of, a congestion condition, a delay and/or latency condition, a packet loss condition, an error rate condition, a cost of transport condition, a quality-of-service (QoS) condition, a usage condition, a market factor condition, or a user configuration condition.

In some aspects, the techniques described herein relate to an AI-based platform, wherein each of the adaptive, autonomous data handling systems includes an adaptive energy digital twin that represents one or more of, an energy stakeholder entity, an energy distribution resource, a stakeholder information technology, a networking infrastructure entity, an energy-dependent stakeholder production facility, a stakeholder transportation system, a market condition, or an energy usage priority condition.

In some aspects, the techniques described herein relate to an AI-based platform, wherein each of the adaptive, autonomous data handling systems includes an adaptive energy digital twin that is configured to perform one or more of, providing a visual and/or analytic indicator of energy consumption by one or more energy consumers, filtering energy data, highlighting energy data, or adjusting energy data.

In some aspects, the techniques described herein relate to an AI-based platform, wherein each of the adaptive, autonomous data handling systems includes an adaptive energy digital twin that is configured to generate a visual and/or analytic indicator of energy consumption by one or more of, one or more machines, one or more factories, or one or more vehicles in a vehicle fleet.

In some aspects, the techniques described herein relate to an AI-based platform, wherein each of the adaptive, autonomous data handling systems is further configured to perform one or more of, extracting energy-related data, detecting and/or correcting errors in energy-related data, transforming, converting, normalizing, and/or cleansing energy-related data, parsing energy-related data, detecting patterns, content, and/or objects in energy-related data, compressing energy-related data, streaming energy-related data, filtering energy-related data, loading and/or storing energy-related data, routing and/or transporting energy-related data, or maintaining security of energy-related data.

In some aspects, the techniques described herein relate to an AI-based platform, wherein the energy edge data is based on one or more public data resources, the public data resources including one or more of, a weather data resource, a satellite data resource, a census, population, demographic, and/or psychographic data resource, a market data resource, or an ecommerce data resource.

In some aspects, the techniques described herein relate to an AI-based platform, wherein the energy edge data is based on one or more enterprise data resources, the enterprise data resources including one or more of, resource planning data, sales and/or marketing data, financial planning data, demand planning data, supply chain data, procurement data, pricing data, customer data, product data, or operating data.

In some aspects, the techniques described herein relate to an AI-based platform, further including at least one AI-based model and/or algorithm, wherein the at least one AI-based model and/or algorithm is trained based on a training data set, and the training data set is based on one or more of, one or more human tags and/or labels, one or more human interactions with a hardware and/or software system, one or more outcomes, one or more AI-generated training data samples, a supervised learning training process, a semi-supervised learning training process, or a deep learning training process.

In some aspects, the techniques described herein relate to an AI-based platform, wherein each of the adaptive, autonomous data handling systems is further configured to orchestrate delivery of energy to one or more points of consumption, and the delivery of the energy includes one or more of, one or more fixed transmission lines, one or more instances of wireless energy transmission, one or more deliveries of fuel, or one or more deliveries of stored energy.

In some aspects, the techniques described herein relate to an AI-based platform, wherein each of the adaptive, autonomous data handling systems is further configured to record, in a distributed ledger and/or blockchain, one or more energy-related events, the one or more energy-related events including one or more of, an energy purchase and/or sale event, a service charge associated with an energy purchase and/or sale event, an energy consumption event, an energy generation event, an energy distribution event, an energy storage event, a carbon emission production event, a carbon emission abatement event, a renewable energy credit event, a pollution production event, or a pollution abatement event.

In some aspects, the techniques described herein relate to an AI-based platform, wherein at least one of the adaptive, autonomous data handling systems is deployed in an off-grid environment, and the off-grid environment includes one or more of, an off-grid energy generation system, an off-grid energy storage system, or an off-grid energy mobilization system.

In some aspects, the techniques described herein relate to an AI-based platform, wherein the platform further includes an adaptive energy data pipeline configured to communicate data across a set of nodes in a network.

In some aspects, the techniques described herein relate to an AI-based platform, wherein the set of nodes in the network that include the adaptive energy data pipeline include a set of edge networking devices that govern at least one of energy consumption, energy storage, energy delivery or energy consumption by a set of operating devices that are controlled via the edge networking devices.

In some aspects, the techniques described herein relate to an AI-based platform, wherein the adaptive energy data pipeline is further configured to automatically select a least-cost route for data communicated across the set of nodes, the selection being based on a low-priority energy use related to the data.

In some aspects, the techniques described herein relate to an AI-based platform, wherein the adaptive energy data pipeline is further configured to automatically select a high-quality of service route for data communicated across the set of nodes, the selection being based on a high-priority energy use related to the data.

In some aspects, the techniques described herein relate to an AI-based platform, wherein the adaptive energy data pipeline includes a set of artificial intelligence capabilities, the capabilities being configured to adapt the pipeline to enable optimization of elements of data transmission in coordination with energy orchestration needs.

In some aspects, the techniques described herein relate to an AI-based platform, wherein the adaptive energy data pipeline includes a self-organizing data storage, the data storage being configured to store data on a device based on one or more of patterns of the data, content of the data, or context of the data.

In some aspects, the techniques described herein relate to an AI-based platform, wherein the adaptive energy data pipeline is configured to perform automated, adaptive networking, the adaptive networking including one or more of adaptive protocol selection, adaptive routing of data based on RF conditions, adaptive filtering of data, adaptive slicing of network bandwidth, adaptive use of cognitive network capacity, or adaptive use of peer-to-peer network capacity.

In some aspects, the techniques described herein relate to an AI-based platform, wherein the adaptive energy data pipeline is configured to perform enterprise contextual adaptation by automatically processing data based on one or more of an operating context of an enterprise, a transactional context of an enterprise, or a financial context of an enterprise.

In some aspects, the techniques described herein relate to an AI-based platform, wherein at least one of the adaptive, autonomous data handling systems is further configured to determine a schedule of a set of processes based on at least one priority and/or need associated with the set of distributed energy resources.

In some aspects, the techniques described herein relate to an AI-based platform, wherein at least one of the adaptive, autonomous data handling systems is further configured to adjust communication with at least one edge device of the set of edge devices based on at least one priority and/or need associated with the set of distributed energy resources, and the communication is associated with a surveying of energy generation, storage, or delivery by the distributed energy resources.

In some aspects, the techniques described herein relate to an AI-based platform, wherein at least one of the adaptive, autonomous data handling systems is further configured to issue an instruction to at least one edge device of the set of edge devices, the instruction is based on a surveying of energy generation, storage, or delivery by the distributed energy resources, and the instruction causes the at least one edge device to adjust energy generation, storage, or delivery by the at least one edge device.

In some aspects, the techniques described herein relate to an AI-based platform for enabling intelligent orchestration and management of power and energy, including: a system configured to perform automated and coordinated governance of a set of energy entities that are operationally coupled within an energy grid and a set of distributed edge energy resources, wherein at least one of the distributed edge energy resources is operationally independent of the energy grid.

In some aspects, the techniques described herein relate to an AI-based platform, wherein the system is further configured to adapt a transport of data over a network and/or communication system, wherein the adapting is based on one or more of, a congestion condition, a delay and/or latency condition, a packet loss condition, an error rate condition, a cost of transport condition, a quality-of-service (QoS) condition, a usage condition, a market factor condition, or a user configuration condition.

In some aspects, the techniques described herein relate to an AI-based platform, further including an adaptive energy digital twin that represents one or more of, an energy stakeholder entity, an energy distribution resource, a stakeholder information technology, a networking infrastructure entity, an energy-dependent stakeholder production facility, a stakeholder transportation system, a market condition, or an energy usage priority condition.

In some aspects, the techniques described herein relate to an AI-based platform, further including an adaptive energy digital twin that is configured to perform one or more of, providing a visual and/or analytic indicator of energy consumption by one or more energy consumers, filtering energy data, highlighting energy data, or adjusting energy data.

In some aspects, the techniques described herein relate to an AI-based platform, further including an adaptive energy digital twin that is configured to generate a visual and/or analytic indicator of energy consumption by one or more of, one or more machines, one or more factories, or one or more vehicles in a vehicle fleet.

In some aspects, the techniques described herein relate to an AI-based platform, wherein the system is further configured to perform one or more of, extracting energy-related data, detecting and/or correcting errors in energy-related data, transforming, converting, normalizing, and/or cleansing energy-related data, parsing energy-related data, detecting patterns, content, and/or objects in energy-related data, compressing energy-related data, streaming energy-related data, filtering energy-related data, loading and/or storing energy-related data, routing and/or transporting energy-related data, or maintaining security of energy-related data.

In some aspects, the techniques described herein relate to an AI-based platform, further including at least one AI-based model and/or algorithm, wherein the at least one AI-based model and/or algorithm is trained based on a training data set, and the training data set is based on one or more of, one or more human tags and/or labels, one or more human interactions with a hardware and/or software system, one or more outcomes, one or more AI-generated training data samples, a supervised learning training process, a semi-supervised learning training process, or a deep learning training process.

In some aspects, the techniques described herein relate to an AI-based platform, wherein the system is further configured to orchestrate delivery of energy to one or more points of consumption, and the delivery of the energy includes one or more of, one or more fixed transmission lines, one or more instances of wireless energy transmission, one or more deliveries of fuel, or one or more deliveries of stored energy.

In some aspects, the techniques described herein relate to an AI-based platform, wherein the system is further configured to record, in a distributed ledger and/or blockchain, one or more energy-related events, the one or more energy-related events including one or more of, an energy purchase and/or sale event, a service charge associated with an energy purchase and/or sale event, an energy consumption event, an energy generation event, an energy distribution event, an energy storage event, a carbon emission production event, a carbon emission abatement event, a renewable energy credit event, a pollution production event, or a pollution abatement event.

In some aspects, the techniques described herein relate to an AI-based platform, wherein at least one of the distributed energy edge resources is deployed in an off-grid environment, and the off-grid environment includes one or more of, an off-grid energy generation system, an off-grid energy storage system, or an off-grid energy mobilization system.

In some aspects, the techniques described herein relate to an AI-based platform, wherein the system is configured to facilitate governance of a mining environment.

In some aspects, the techniques described herein relate to an AI-based platform, wherein the system includes mine-level Internet of Things (IoT) sensing of the mining environment, ground-penetrating sensing of unmined portions of the mining environment, mass spectrometry and computer vision-based sensing of mined materials, asset tagging of smart containers, wearable device for detecting physiological status of miners, secure recording and resolution of transactions and transaction-related events, smart contracts for automatically allocating proceeds derived from the mining environment, and an automated system for recording, reporting, and assessing compliance with contractual, regulatory, and legal policy requirements.

In some aspects, the techniques described herein relate to an AI-based platform, wherein the system includes a set of carbon-aware energy edge solutions, the solutions including exploring, configuring, and implementing a set of policies regarding carbon generation.

In some aspects, the techniques described herein relate to an AI-based platform, wherein the solutions require energy production by a mining environment to be monitored to track carbon emissions generated by the mining environment.

In some aspects, the techniques described herein relate to an AI-based platform, wherein the solutions require energy production by a mining environment to require offsetting carbon generation by the mining environment.

In some aspects, the techniques described herein relate to an AI-based platform, wherein the platform includes a user interface and system includes a set of automated energy policy deployment solutions, the solutions being configurable via user interaction with the user interface.

In some aspects, the techniques described herein relate to an AI-based platform, wherein the system includes an intelligent agent trained to generate policies related to governance of the mining environment, the intelligent agent being trained on a training set of historical data, feedback from outcomes, and human policy-setting interactions.

In some aspects, the techniques described herein relate to an AI-based platform, wherein the system facilitates governance of the mining environment by implementing policies including one or more of, setting maximum energy usage for an entity for a time period, setting maximum energy cost for an entity for a time period, setting maximum carbon production for an entity for a time period, setting maximum pollution emissions for an entity for a time period, setting carbon offset requirements, setting renewable energy credit requirements, setting energy mix requirements, setting profit margin minimums based on energy and other marginal costs for a production entity, or setting minimum storage baselines for energy storage entities.

In some aspects, the techniques described herein relate to an AI-based platform, wherein the system includes a set of energy governance smart contract solutions configured to allow a user of the platform to design, generate, and deploy a smart contract that automatically provides a degree of governance of a set of energy transaction.

In some aspects, the techniques described herein relate to an AI-based platform, wherein the system includes a set of automated energy financial control solutions configured to allow a user of the platform to design, generate, configure, or deploy a policy related to control of financial factors related to one or more of energy generation, storage, delivery, or utilization.

In some aspects, the techniques described herein relate to an AI-based platform, wherein the system is further configured to determine priorities associated with at least one of the set of energy entities or the set of distributed edge energy resources, and the priorities are based on a policy associated with at least one of the set of energy entities or the set of distributed energy resources.

In some aspects, the techniques described herein relate to an AI-based platform, wherein the system is further configured to perform monitoring of production rates of energy by the set of energy entities, and to adjust the automated and coordinated governance of the set of energy entities based on the monitoring of the production rates.

In some aspects, the techniques described herein relate to an AI-based platform, wherein the system is further configured to allocate processing of the set of distributed edge energy resources based on at least one measurement and/or forecast of energy associated with the set of energy entities.

In some aspects, the techniques described herein relate to an AI-based platform for enabling intelligent orchestration and management of power and energy, including: an adaptive energy data pipeline configured to communicate data across a set of nodes in a network, wherein at least a subset of the set of nodes is configured, by at least one of a rule or an algorithm, to set at least one parameter of data communication associated with the adaptive energy data pipeline, and the at least one parameter is based on a set of indicators of current network conditions in order to optimize energy used in the data communication.

In some aspects, the techniques described herein relate to an AI-based platform, wherein the at least one parameter is one or more of: a routing instruction, a route parameter, an error correction parameter, a compression parameter, a storage parameter, or a timing parameter.

In some aspects, the techniques described herein relate to an AI-based platform, wherein the adaptive energy data pipeline is further configured to adapt a transport of data over a network and/or communication system, wherein the adapting is based on one or more of, a congestion condition, a delay and/or latency condition, a packet loss condition, an error rate condition, a cost of transport condition, a quality-of-service (QoS) condition, a usage condition, a market factor condition, a user configuration condition.

In some aspects, the techniques described herein relate to an AI-based platform, further including an adaptive energy digital twin that represents one or more of, an energy stakeholder entity, an energy distribution resource, a stakeholder information technology, a networking infrastructure entity, an energy-dependent stakeholder production facility, a stakeholder transportation system, a market condition, or an energy usage priority condition.

In some aspects, the techniques described herein relate to an AI-based platform, further including an adaptive energy digital twin that is configured to perform one or more of, providing a visual and/or analytic indicator of energy consumption by one or more energy consumers, filtering energy data, highlighting energy data, or adjusting energy data.

In some aspects, the techniques described herein relate to an AI-based platform, further including an adaptive energy digital twin that is configured to generate a visual and/or analytic indicator of energy consumption by one or more of, one or more machines, one or more factories, or one or more vehicles in a vehicle fleet.

In some aspects, the techniques described herein relate to an AI-based platform, wherein the adaptive energy data pipeline is further configured to perform one or more of, extracting energy-related data, detecting and/or correcting errors in energy-related data, transforming, converting, normalizing, and/or cleansing energy-related data, parsing energy-related data, detecting patterns, content, and/or objects in energy-related data, compressing energy-related data, streaming energy-related data, filtering energy-related data, loading and/or storing energy-related data, routing and/or transporting energy-related data, or maintaining security of energy-related data.

In some aspects, the techniques described herein relate to an AI-based platform, wherein the data is based on one or more public data resources, the public data resources including one or more of, a weather data resource, a satellite data resource, a census, population, demographic, and/or psychographic data resource, a market data resource, or an ecommerce data resource.

In some aspects, the techniques described herein relate to an AI-based platform, wherein the data is based on one or more enterprise data resources, the enterprise data resources including one or more of, resource planning data, sales and/or marketing data, financial planning data, demand planning data, supply chain data, procurement data, pricing data, customer data, product data, or operating data.

In some aspects, the techniques described herein relate to an AI-based platform, further including at least one AI-based model and/or algorithm, wherein the at least one AI-based model and/or algorithm is trained based on a training data set, and the training data set is based on one or more of, one or more human tags and/or labels, one or more human interactions with a hardware and/or software system, one or more outcomes, one or more AI-generated training data samples, a supervised learning training process, a semi-supervised learning training process, or a deep learning training process.

In some aspects, the techniques described herein relate to an AI-based platform, wherein the adaptive energy data pipeline is further configured to orchestrate delivery of energy to one or more points of consumption, and the delivery of the energy includes one or more of, one or more fixed transmission lines, one or more instances of wireless energy transmission, one or more deliveries of fuel, or one or more deliveries of stored energy.

In some aspects, the techniques described herein relate to an AI-based platform, wherein the adaptive energy data pipeline is further configured to record, in a distributed ledger and/or blockchain, one or more energy-related events, the one or more energy-related events including one or more of, an energy purchase and/or sale event, a service charge associated with an energy purchase and/or sale event, an energy consumption event, an energy generation event, an energy distribution event, an energy storage event, a carbon emission production event, a carbon emission abatement event, a renewable energy credit event, a pollution production event, or a pollution abatement event.

In some aspects, the techniques described herein relate to an AI-based platform, wherein at least a portion of the adaptive energy data pipeline is deployed in an off-grid environment, and the off-grid environment includes one or more of, an off-grid energy generation system, an off-grid energy storage system, or an off-grid energy mobilization system.

In some aspects, the techniques described herein relate to an AI-based platform, wherein the adaptive energy data pipeline is further configured to, monitor one or both of, an overall energy consumption by at least a portion of the set of nodes, or a role of at least one node of the set of nodes in an overall energy consumption by at least a portion of the set of nodes, and based on the monitoring, perform one or more of, managing an energy consumption by the set of nodes, forecast an energy consumption by the set of nodes, or provision resources associated with energy consumption by the set of nodes.

In some aspects, the techniques described herein relate to an AI-based platform, wherein the set of nodes in the network that include the adaptive energy data pipeline include a set of edge networking devices that govern at least one of energy consumption, energy storage, energy delivery or energy consumption by a set of operating devices that are controlled via the edge networking devices.

In some aspects, the techniques described herein relate to an AI-based platform, wherein the adaptive energy data pipeline is further configured to automatically select a least-cost route for data communicated across the set of nodes, the selection being based on a low-priority energy use related to the data.

In some aspects, the techniques described herein relate to an AI-based platform, wherein the adaptive energy data pipeline is further configured to automatically select a high-quality of service route for data communicated across the set of nodes, the selection being based on a high-priority energy use related to the data.

In some aspects, the techniques described herein relate to an AI-based platform, wherein the adaptive energy data pipeline includes a set of artificial intelligence capabilities, the capabilities being configured to adapt the pipeline to enable optimization of elements of data transmission in coordination with energy orchestration needs.

In some aspects, the techniques described herein relate to an AI-based platform, wherein the adaptive energy data pipeline includes a self-organizing data storage, the data storage being configured to store data on a device based on one or more of patterns of the data, content of the data, or context of the data.

In some aspects, the techniques described herein relate to an AI-based platform, wherein the adaptive energy data pipeline is configured to perform automated, adaptive networking, the adaptive networking including one or more of adaptive protocol selection, adaptive routing of data based on RF conditions, adaptive filtering of data, adaptive slicing of network bandwidth, adaptive use of cognitive network capacity, or adaptive use of peer-to-peer network capacity.

In some aspects, the techniques described herein relate to an AI-based platform for enabling intelligent orchestration and management of power and energy, including: a digital twin system having a digital twin of a mining environment, wherein the digital twin includes at least one parameter that is detected by a sensor of the mining environment.

In some aspects, the techniques described herein relate to an AI-based platform, wherein the at least one parameter is associated with one or more of, an unmined portion of the mining environment, a mining of materials from the mining environment, a smart container event involving a smart container associated with the mining environment, a physiological status of a miner associated with the mining environment, a transaction-related event associated with the mining environment, or a compliance of the mining environment with one or more contractual, regulatory, and/or legal policies.

In some aspects, the techniques described herein relate to an AI-based platform, wherein the digital twin system additionally represents one or more of, an energy stakeholder entity, an energy distribution resource, a stakeholder information technology, a networking infrastructure entity, an energy-dependent stakeholder production facility, a stakeholder transportation system, a market condition, or an energy usage priority condition.

In some aspects, the techniques described herein relate to an AI-based platform, wherein the digital twin system is further configured to perform one or more of, providing a visual and/or analytic indicator of energy consumption by one or more energy consumers, filtering energy data, highlighting energy data, or adjusting energy data.

In some aspects, the techniques described herein relate to an AI-based platform, wherein the digital twin system is further configured to generate a visual and/or analytic indicator of energy consumption by one or more of, one or more machines, one or more factories, or one or more vehicles in a vehicle fleet.

In some aspects, the techniques described herein relate to an AI-based platform, wherein the parameter is based on one or more public data resources, the public data resources including one or more of, a weather data resource, a satellite data resource, a census, population, demographic, and/or psychographic data resource, a market data resource, or an ecommerce data resource.

In some aspects, the techniques described herein relate to an AI-based platform, wherein the parameter is based on one or more enterprise data resources, the enterprise data resources including one or more of, resource planning data, sales and/or marketing data, financial planning data, demand planning data, supply chain data, procurement data, pricing data, customer data, product data, or operating data.

In some aspects, the techniques described herein relate to an AI-based platform, wherein the digital twin system includes at least one AI-based model and/or algorithm, wherein the at least one AI-based model and/or algorithm is trained based on a training data set, and the training data set is based on one or more of, one or more human tags and/or labels, one or more human interactions with a hardware and/or software system, one or more outcomes, one or more AI-generated training data samples, a supervised learning training process, a semi-supervised learning training process, or a deep learning training process.

In some aspects, the techniques described herein relate to an AI-based platform, wherein the digital twin system is further configured to orchestrate delivery of energy to one or more points of consumption, and the delivery of the energy includes one or more of, one or more fixed transmission lines, one or more instances of wireless energy transmission, one or more deliveries of fuel, or one or more deliveries of stored energy.

In some aspects, the techniques described herein relate to an AI-based platform, wherein the digital twin system is further configured to record, in a distributed ledger and/or blockchain, one or more energy-related events, the one or more energy-related events including one or more of, an energy purchase and/or sale event, a service charge associated with an energy purchase and/or sale event, an energy consumption event, an energy generation event, an energy distribution event, an energy storage event, a carbon emission production event, a carbon emission abatement event, a renewable energy credit event, a pollution production event, or a pollution abatement event.

In some aspects, the techniques described herein relate to an AI-based platform, wherein the digital twin system is deployed in an off-grid environment, and the off-grid environment includes one or more of, an off-grid energy generation system, an off-grid energy storage system, or an off-grid energy mobilization system.

In some aspects, the techniques described herein relate to an AI-based platform, wherein the mining environment is a data mining environment.

In some aspects, the techniques described herein relate to an AI-based platform, wherein the mining environment is a set of resources for conducting computational operations.

In some aspects, the techniques described herein relate to an AI-based platform, wherein the platform includes mine-level Internet of Things (IoT) sensing of the mining environment, ground-penetrating sensing of unmined portions of the mining environment, mass spectrometry and computer vision-based sensing of mined materials, asset tagging of smart containers, wearable device for detecting physiological status of miners, secure recording and resolution of transactions and transaction-related events, smart contracts for automatically allocating proceeds derived from the mining environment, and an automated system for recording, reporting, and assessing compliance with contractual, regulatory, and legal policy requirements.

In some aspects, the techniques described herein relate to an AI-based platform, wherein the platform includes a set of carbon-aware energy edge solutions, the solutions including exploring, configuring, and implementing a set of policies regarding carbon generation.

In some aspects, the techniques described herein relate to an AI-based platform, wherein the solutions require energy production by a mining environment to be monitored to track carbon emissions generated by the mining environment.

In some aspects, the techniques described herein relate to an AI-based platform, wherein the solutions require energy production by a mining environment to require offsetting carbon generation by the mining environment.

In some aspects, the techniques described herein relate to an AI-based platform, wherein the platform includes a user interface and platform includes a set of automated energy policy deployment solutions, the solutions being configurable via user interaction with the user interface.

In some aspects, the techniques described herein relate to an AI-based platform, wherein the platform includes an intelligent agent trained to generate policies related to governance of the mining environment, the intelligent agent being trained on a training set of historical data, feedback from outcomes, and human policy-setting interactions.

In some aspects, the techniques described herein relate to an AI-based platform, wherein the platform facilitates governance of the mining environment by implementing policies including one or more of, setting maximum energy usage for an entity for a time period, setting maximum energy cost for an entity for a time period, setting maximum carbon production for an entity for a time period, setting maximum pollution emissions for an entity for a time period, setting carbon offset requirements, setting renewable energy credit requirements, setting energy mix requirements, setting profit margin minimums based on energy and other marginal costs for a production entity, or setting minimum storage baselines for energy storage entities.

In some aspects, the techniques described herein relate to an AI-based platform, wherein the at least one parameter includes a measurement by the sensor, and the measurement is associated with a least one piece of equipment included in an industrial operation of the mining environment.

In some aspects, the techniques described herein relate to an AI-based platform, wherein the digital twin system includes a scheduler that is configured to determine a schedule for generating, storing, and/or transporting energy to at least one piece of equipment associated with an industrial operation of the mining environment, and the schedule is based on the at least one parameter detected by the sensor.

In some aspects, the techniques described herein relate to an AI-based platform, wherein the at least one parameter included in the digital twin includes at least one property of at least one data set associated with the mining environment.

In some aspects, the techniques described herein relate to an AI-based platform for enabling intelligent orchestration and management of power and energy, including: a governance system for a mining operation; and a reporting system for conveying at least one parameter that is sensed by a sensor of a mine of the mining operation, wherein the at least one parameter is associated with a compliance of the mining operation with a set of labor standards.

In some aspects, the techniques described herein relate to an AI-based platform, wherein the reporting system is further configured to adapt a transport of data over a network and/or communication system, wherein the adapting is based on one or more of, a congestion condition, a delay and/or latency condition, a packet loss condition, an error rate condition, a cost of transport condition, a quality-of-service (QoS) condition, a usage condition, a market factor condition, or a user configuration condition.

In some aspects, the techniques described herein relate to an AI-based platform, further including an adaptive energy digital twin that represents one or more of, an energy stakeholder entity, an energy distribution resource, a stakeholder information technology, a networking infrastructure entity, an energy-dependent stakeholder production facility, a stakeholder transportation system, a market condition, or an energy usage priority condition.

In some aspects, the techniques described herein relate to an AI-based platform, further including an adaptive energy digital twin that is configured to perform one or more of, providing a visual and/or analytic indicator of energy consumption by one or more energy consumers, filtering energy data, highlighting energy data, adjusting energy data, or generating a visual and/or analytic indicator of energy consumption by one or more of, one or more machines, one or more factories, or one or more vehicles in a vehicle fleet.

In some aspects, the techniques described herein relate to an AI-based platform, wherein the reporting system is further configured to perform one or more of, extracting energy-related data, detecting and/or correcting errors in energy-related data, transforming, converting, normalizing, and/or cleansing energy-related data, parsing energy-related data, detecting patterns, content, and/or objects in energy-related data, compressing energy-related data, streaming energy-related data, filtering energy-related data, loading and/or storing energy-related data, routing and/or transporting energy-related data, or maintaining security of energy-related data.

In some aspects, the techniques described herein relate to an AI-based platform, wherein the reporting system is further configured to record, in a distributed ledger and/or blockchain, one or more energy-related events, the one or more energy-related events including one or more of, an energy purchase and/or sale event, a service charge associated with an energy purchase and/or sale event, an energy consumption event, an energy generation event, an energy distribution event, an energy storage event, a carbon emission production event, a carbon emission abatement event, a renewable energy credit event, a pollution production event, or a pollution abatement event.

In some aspects, the techniques described herein relate to an AI-based platform, wherein at least one of the at least one parameter is based on one or more of, one or more public data resources, the one or more public data resources including one or more of, a weather data resource, a satellite data resource, a census, population, demographic, and/or psychographic data resource, a market data resource, or an ecommerce data resource, or one or more enterprise data resources, the one or more enterprise data resources including one or more of, resource planning data, sales and/or marketing data, financial planning data, demand planning data, supply chain data, procurement data, pricing data, customer data, product data, or operating data.

In some aspects, the techniques described herein relate to an AI-based platform, further including at least one AI-based model and/or algorithm, wherein the at least one AI-based model and/or algorithm is trained based on a training data set, and the training data set is based on one or more of, one or more human tags and/or labels, one or more human interactions with a hardware and/or software system, one or more outcomes, one or more AI-generated training data samples, a supervised learning training process, a semi-supervised learning training process, or a deep learning training process.

In some aspects, the techniques described herein relate to an AI-based platform, wherein the governance system is further configured to orchestrate delivery of energy to one or more points of consumption, and the delivery of the energy includes one or more of, one or more fixed transmission lines, one or more instances of wireless energy transmission, one or more deliveries of fuel, or one or more deliveries of stored energy.

In some aspects, the techniques described herein relate to an AI-based platform, wherein the set of labor standards is associated with at least one activity performed by a laborer of the mine, and conveying the at least one parameter that is sensed by the sensor includes conveying an indication of a performance of the at least one activity by the laborer that is sensed by the sensor.

In some aspects, the techniques described herein relate to an AI-based platform, wherein the set of labor standards is associated with at least one object associated with a laborer of the mine, and conveying the at least one parameter that is sensed by the sensor includes conveying an indication of a detection of the at least one object by the sensor.

In some aspects, the techniques described herein relate to an AI-based platform, wherein the set of labor standards includes a threshold of a property of the mine, and the reporting system is further configured to convey a determination based on a comparison of the at least one parameter sensed by the sensor with the threshold.

In some aspects, the techniques described herein relate to an AI-based platform, further including a compliance restoration system that is configured to perform at least one compliance restoration action based on a determination that the at least one parameter sensed by the sensor indicates a condition that is not in compliance with the set of labor standards.

In some aspects, the techniques described herein relate to an AI-based platform, further including an emergency response system that is configured to perform at least one emergency response action based on a determination that the at least one parameter sensed by the sensor indicates an occurrence of an emergency associated with the mine.

In some aspects, the techniques described herein relate to an AI-based platform, further including a sensor configuration system that is configured to determine a configuration of the sensor to perform sensing of the at least one parameter, wherein the configuration is based on the compliance of the mining operation with the set of labor standards.

In some aspects, the techniques described herein relate to an AI-based platform, wherein the set of labor standards is accessible to the sensor configuration system and is specified in a natural language, and the sensor configuration system is configured to determine the configuration of the sensor based on a natural language parsing of the set of labor standards.

In some aspects, the techniques described herein relate to an AI-based platform, further including a sensor remediation system that is configured to perform at least one sensor remediation measure based on a determination of a failure of the sensor to sense the at least one parameter, wherein the at least one sensor remediation measure includes one or more of, initiating a replacement of the sensor, initiating a diagnostic operation involving the sensor, initiating a reconfiguration of the sensor to detect the at least one parameter in a different manner, initiating a request for a laborer of the mine to perform a manual sensing of the at least one parameter, or initiating a substitution of the sensor of the mine with at least one other sensor of the mine to sense the at least one parameter.

In some aspects, the techniques described herein relate to an AI-based platform, further including a compliance verification system that is configured to verify that the at least one parameter sensed by the sensor indicates compliance of the mining operation with the set of labor standards, wherein the verifying includes one or more of, verifying a calibration of the sensor of the mine, verifying the at least one parameter sensed by the sensor of the mine based on a comparison of the at least one parameter with at least one parameter sensed by at least one other sensor of the mine, requesting manual verification of the at least one parameter by a laborer of the mine, or requesting verification by a compliance officer that the at least one parameter indicates the compliance of the mining operation with the set of labor standards.

In some aspects, the techniques described herein relate to an AI-based platform, further including a laborer communication interface that is configured to engage in a communication with a laborer of the mine based on the at least one parameter sensed by the sensor, wherein the communication is associated with the compliance of the mining operation with the set of labor standards.

In some aspects, the techniques described herein relate to an AI-based platform, further including a user interface that is configured to display a map of the mining operation, wherein the map includes an indication of the compliance of the mining operation with the set of labor standards based on the at least one parameter sensed by the sensor.

In some aspects, the techniques described herein relate to an AI-based platform, wherein set of labor standards includes a set of work requirements for a laborer to perform a task associated with the mining operation, and the reporting system is further configured to adapt an allocation of the laborer to the task based on the set of work requirements.

In some aspects, the techniques described herein relate to an AI-based platform, wherein the at least one parameter includes a schedule for a laborer to perform a task associated with the mining operation, and the reporting system is further configured to adapt the schedule based on the compliance of the mining operation with the set of labor standards.

In some aspects, the techniques described herein relate to an AI-based platform, wherein the reporting system is further configured to initiate at least one protocol in response to the at least one parameter sensed by the sensor, and the at least one protocol is based on adjusting the at least one parameter sensed by the sensor to maintain or restore the compliance of the mining operation with the set of labor standards.

In some aspects, the techniques described herein relate to an AI-based platform, wherein the reporting system is further configured to maintain a digital record of a training status and/or certification status of at least one laborer associated with at least one task of the mining operation.

In some aspects, the techniques described herein relate to an AI-based platform for enabling intelligent orchestration and management of power and energy, including: a set of edge devices, wherein each edge device of the set is configured to maintain awareness of carbon generation and/or emissions of at least one entity of a set of energy-using entities that are linked to and/or governed by the set of edge devices.

In some aspects, the techniques described herein relate to an AI-based platform, wherein at least one edge device of the set is configured to simulate the carbon generation and/or emissions of at least one entity of the set of energy-using entities.

In some aspects, the techniques described herein relate to an AI-based platform, wherein at least one edge device of the set is configured to execute a set of machine-learned algorithms trained on a training data set of carbon generation data to calculate a metric of the carbon generation and/or emissions for a set of operational entities.

In some aspects, the techniques described herein relate to an AI-based platform, wherein at least one edge device of the set is configured to execute a set of machine-learned algorithms trained on a training data set of carbon generation data to calculate a metric of the carbon generation and/or emissions for a set of operational entities.

In some aspects, the techniques described herein relate to an AI-based platform, wherein at least one edge device of the set is further configured to adapt a transport of data over a network and/or communication system, wherein the adapting is based on one or more of, a congestion condition, a delay and/or latency condition, a packet loss condition, an error rate condition, a cost of transport condition, a quality-of-service (QoS) condition, a usage condition, a market factor condition, or a user configuration condition.

In some aspects, the techniques described herein relate to an AI-based platform, further including an adaptive energy digital twin that represents one or more of, an energy stakeholder entity, an energy distribution resource, a stakeholder information technology, a networking infrastructure entity, an energy-dependent stakeholder production facility, a stakeholder transportation system, a market condition, or an energy usage priority condition.

In some aspects, the techniques described herein relate to an AI-based platform, further including an adaptive energy digital twin that is configured to perform one or more of, providing a visual and/or analytic indicator of energy consumption by one or more energy consumers, filtering energy data, highlighting energy data, adjusting energy data, or generating a visual and/or analytic indicator of energy consumption by one or more of, one or more machines, one or more factories, or one or more vehicles in a vehicle fleet.

In some aspects, the techniques described herein relate to an AI-based platform, wherein at least one edge device of the set is further configured to perform one or more of, extracting energy-related data, detecting and/or correcting errors in energy-related data, transforming, converting, normalizing, and/or cleansing energy-related data, parsing energy-related data, detecting patterns, content, and/or objects in energy-related data, compressing energy-related data, streaming energy-related data, filtering energy-related data, loading and/or storing energy-related data, routing and/or transporting energy-related data, or maintaining security of energy-related data.

In some aspects, the techniques described herein relate to an AI-based platform, wherein at least one edge device of the set includes at least one AI-based model and/or algorithm, wherein the at least one AI-based model and/or algorithm is trained based on a training data set, and the training data set is based on one or more of, one or more human tags and/or labels, one or more human interactions with a hardware and/or software system, one or more outcomes, one or more AI-generated training data samples, a supervised learning training process, a semi-supervised learning training process, or a deep learning training process.

In some aspects, the techniques described herein relate to an AI-based platform, wherein at least one edge device of the set is configured to orchestrate delivery of energy to one or more points of consumption, and the delivery of the energy includes one or more of, one or more fixed transmission lines, one or more instances of wireless energy transmission, one or more deliveries of fuel, or one or more deliveries of stored energy.

In some aspects, the techniques described herein relate to an AI-based platform, wherein at least one edge device of the set is further configured to record, in a distributed ledger and/or blockchain, one or more energy-related events, the one or more energy-related events including one or more of, an energy purchase and/or sale event, a service charge associated with an energy purchase and/or sale event, an energy consumption event, an energy generation event, an energy distribution event, an energy storage event, a carbon emission production event, a carbon emission abatement event, a renewable energy credit event, a pollution production event, or a pollution abatement event.

In some aspects, the techniques described herein relate to an AI-based platform, wherein at least one edge device of the set is deployed in an off-grid environment, and the off-grid environment includes one or more of, an off-grid energy generation system, an off-grid energy storage system, or an off-grid energy mobilization system.

In some aspects, the techniques described herein relate to an AI-based platform, wherein at least one edge device of the set is further configured to determine a change in the carbon generation and/or emissions over a period of time based on a comparison of a current metric of the carbon generation and/or emissions with a historical metric of the carbon generation and/or emissions.

In some aspects, the techniques described herein relate to an AI-based platform, wherein at least one edge device of the set is further configured to determine a target for the carbon generation and/or emissions based on a policy for the carbon generation and/or emissions.

In some aspects, the techniques described herein relate to an AI-based platform, wherein at least one edge device of the set is further configured to, perform a comparison of a metric of the carbon generation and/or emissions with a target of the carbon generation and/or emissions, and determine a compliance of the carbon generation and/or emissions with a policy for the carbon generation and/or emissions based on the comparison.

In some aspects, the techniques described herein relate to an AI-based platform, wherein at least one edge device of the set is further configured to determine an environmental impact of the carbon generation and/or emissions based on a metric of the carbon generation and/or emissions with a target of the carbon generation and/or emissions.

In some aspects, the techniques described herein relate to an AI-based platform, wherein the carbon generation and/or emissions are associated with a set of activities, and at least one edge device of the set is further configured to allocate at least a portion of the carbon generation and/or emissions to at least one activity of the set of activities.

In some aspects, the techniques described herein relate to an AI-based platform, wherein at least one edge device of the set is further configured to associate at least one indicator with a metric of the carbon generation and/or emissions with a target of the carbon generation and/or emissions, wherein the indicator includes one or more of, a date, time, and/or time period of the carbon generation and/or emissions, a source location of the carbon generation and/or emissions, a direction and/or speed of a conveyance of the carbon generation and/or emissions, an impacted location of the carbon generation and/or emissions, a physical metric of the carbon generation and/or emissions, a chemical component of the carbon generation and/or emissions, a weather pattern occurring in an area that is associated with the carbon generation and/or emissions, a wildlife population in an area that is associated with the carbon generation and/or emissions, or a human activity that is affected by the carbon generation and/or emissions.

In some aspects, the techniques described herein relate to an AI-based platform, wherein at least one edge device of the set is further configured to transmit an alert associated with the carbon generation and/or the emissions based on a comparison of a metric of the carbon generation and/or the emissions with an alert threshold associated with the carbon generation and/or the emissions.

In some aspects, the techniques described herein relate to an AI-based platform, wherein at least one edge device of the set is further configured to adjust an activity associated with the carbon generation and/or the emissions based on a metric of the carbon generation and/or the emissions, and the adjusting modifies a future state of the carbon generation and/or the emissions.

In some aspects, the techniques described herein relate to an AI-based platform, wherein at least one edge device of the set of edge devices is further configured to maintain awareness by detecting, based on a detection interval, a measurement of a carbon generation and/or emission associated with the at least one entity of the set of energy-using entities.

In some aspects, the techniques described herein relate to an AI-based platform, wherein at least one edge device of the set of edge devices is further configured to maintain awareness by generating at least one localized report and/or alert, and the at least one localized report and/or alert is associated with a pattern of carbon generation and/or emission associated with the at least one entity of the set of energy-using entities.

In some aspects, the techniques described herein relate to an AI-based platform, wherein at least one edge device of the set of edge devices is further configured to alter an operation of one or more pieces of equipment and/or processes associated with the at least one entity of the set of energy-using entities, and altering the operation is based on at least one measurement of a carbon generation and/or emission associated with the at least one entity of the set of energy-using entities.

In some aspects, the techniques described herein relate to an AI-based platform for enabling intelligent orchestration and management of power and energy, including: a digital twin that is updated by a data collection system that dynamically maintains a set of historical, current, and/or forecast energy demand parameters for a set of fixed entities and a set of mobile entities within a defined domain, wherein the updating of the digital twin is based on the set of energy demand parameters.

In some aspects, the techniques described herein relate to an AI-based platform, wherein a set of operating entities is controlled via a set of edge networking devices that are linked to the set of operating entities, and the energy demand parameters are based on one or more of, a current set of aggregate data derived from demand from the set of operating entities, wherein the set of operating entities is controlled via a set of edge networking devices that are linked to the set of operating entities, a historical set of aggregate data derived from demand from the set of operating entities, wherein the set of operating entities is controlled via a set of edge networking devices that are linked to the set of operating entities, or a simulated set of aggregate data derived from demand from the set of operating entities.

In some aspects, the techniques described herein relate to an AI-based platform, wherein the data collection system is further configured to adapt a transport of data over a network and/or communication system, wherein the adapting is based on one or more of, a congestion condition, a delay and/or latency condition, a packet loss condition, an error rate condition, a cost of transport condition, a quality-of-service (QoS) condition, a usage condition, a market factor condition, or a user configuration condition.

In some aspects, the techniques described herein relate to an AI-based platform, wherein the digital twin represents one or more of, an energy stakeholder entity, an energy distribution resource, a stakeholder information technology, a networking infrastructure entity, an energy-dependent stakeholder production facility, a stakeholder transportation system, a market condition, or an energy usage priority condition.

In some aspects, the techniques described herein relate to an AI-based platform, wherein the digital twin is further configured to perform one or more of, providing a visual and/or analytic indicator of energy consumption by one or more energy consumers, filtering energy data, highlighting energy data, adjusting energy data, or generating a visual and/or analytic indicator of energy consumption by one or more of, one or more machines, one or more factories, or one or more vehicles in a vehicle fleet.

In some aspects, the techniques described herein relate to an AI-based platform, wherein at least one of the energy demand parameters is based on one or more of, on one or more public data resources, the one or more public data resources including one or more of, a weather data resource, a satellite data resource, a census, population, demographic, and/or psychographic data resource, a market data resource, or an ecommerce data resource, or one or more enterprise data resources, the one or more enterprise data resources including one or more of, resource planning data, sales and/or marketing data, financial planning data, demand planning data, supply chain data, procurement data, pricing data, customer data, product data, or operating data.

In some aspects, the techniques described herein relate to an AI-based platform, wherein the digital twin includes at least one AI-based model and/or algorithm, wherein the at least one AI-based model and/or algorithm is trained based on a training data set, and the training data set is based on one or more of, one or more human tags and/or labels, one or more human interactions with a hardware and/or software system, one or more outcomes, one or more AI-generated training data samples, a supervised learning training process, a semi-supervised learning training process, or a deep learning training process.

In some aspects, the techniques described herein relate to an AI-based platform, wherein the digital twin is further configured to orchestrate delivery of energy to one or more points of consumption, and the delivery of the energy includes one or more of, one or more fixed transmission lines, one or more instances of wireless energy transmission, one or more deliveries of fuel, or one or more deliveries of stored energy.

In some aspects, the techniques described herein relate to an AI-based platform, wherein the digital twin is further configured to adjust the delivery of energy to the one or more points of consumption based on an energy delivery and/or consumption policy.

In some aspects, the techniques described herein relate to an AI-based platform, wherein the digital twin is further configured to determine a carbon generation and/or emissions effect of the delivery of energy to the one or more points of consumption.

In some aspects, the techniques described herein relate to an AI-based platform, wherein the digital twin is further configured to adjust the delivery of energy to the one or more points of consumption based on a probability of a deficiency of available energy at the one or more points of consumption and a consequence of the deficiency of available energy at the one or more points of consumption.

In some aspects, the techniques described herein relate to an AI-based platform, wherein the digital twin is further configured to determine the delivery of energy to the one or more points of consumption based on a comparison of energy availability at each of two or more energy sources, wherein the comparison includes one or more of, a current and/or future quantity of energy stored by at least one of the two or more energy sources, a current and/or future resource expenditure associated with acquiring, storing, and/or delivering the energy by at least one of the two or more energy sources, or a current and/or future demand by other energy consumers for the energy of at least one of the two or more energy sources.

In some aspects, the techniques described herein relate to an AI-based platform, wherein the digital twin is further configured to record, in a distributed ledger and/or blockchain, one or more energy-related events, the one or more energy-related events including one or more of, an energy purchase and/or sale event, a service charge associated with an energy purchase and/or sale event, an energy consumption event, an energy generation event, an energy distribution event, an energy storage event, a carbon emission production event, a carbon emission abatement event, a renewable energy credit event, a pollution production event, or a pollution abatement event.

In some aspects, the techniques described herein relate to an AI-based platform, wherein the digital twin is deployed in an off-grid environment, and the off-grid environment includes one or more of, an off-grid energy generation system, an off-grid energy storage system, or an off-grid energy mobilization system.

In some aspects, the techniques described herein relate to an AI-based platform, wherein the AI-based platform is configured to measure a performance of the digital twin based on a prediction delta, and the prediction delta is based on a comparison of a prediction generated by the digital twin based on the set of energy demand parameters with a measurement within the data collection system that corresponds to the prediction.

In some aspects, the techniques described herein relate to an AI-based platform, wherein the AI-based platform is configured to update the digital twin based on the prediction delta, and the updating includes one or more of, retraining the digital twin based on the prediction delta, adjusting a prediction correction applied to predictions of the digital twin based on the prediction delta, supplementing the digital twin with at least one other trained machine learning model, or replacing the digital twin with a substitute digital twin.

In some aspects, the techniques described herein relate to an AI-based platform, wherein the digital twin is further configured to generate, a prediction based on at least one of the energy demand parameters, and an indication of an effect of at least one of the energy demand parameters on the prediction.

In some aspects, the techniques described herein relate to an AI-based platform, wherein the digital twin is further configured to determine one or more modifications of the set of energy demand parameters to improve future predictions of the digital twin, wherein the one or more modifications include one or more of, one or more additional historical, current, and/or forecast energy demand parameters associated with the set of fixed entities and the set of mobile entities within the defined domain, or one or more modifications of one or more of the historical, current, and/or forecast energy demand parameters associated with the set of fixed entities and the set of mobile entities within the defined domain.

In some aspects, the techniques described herein relate to an AI-based platform, wherein the digital twin is further configured to orchestrate a delivery of energy to one or more points of consumption based on one or more entity parameters received from at least one entity of the set of fixed entities and/or the set of mobile entities within the defined domain, and the one or more entity parameters includes one or more of, a current and/or future energy status of the at least one entity, a current and/or future energy consumption by the at least one entity, or a current and/or future activity performed by the at least one entity that is associated with energy consumption.

In some aspects, the techniques described herein relate to an AI-based platform, wherein the digital twin is further configured to transmit, to at least one entity of the set of fixed entities and/or the set of mobile entities within the defined domain, a request to adjust one or more entity parameters associated with the at least one entity, and the one or more entity parameters includes one or more of, a current and/or future energy status of the at least one entity, a current and/or future energy consumption by the at least one entity, or a current and/or future activity performed by the at least one entity that is associated with energy consumption.

In some aspects, the techniques described herein relate to an AI-based platform, wherein the digital twin is further configured to, perform a simulation of at least one process of at least one physical machine associated with one or both of the set of fixed entities or the set of mobile entities, and output at least one energy demand parameter resulting from the at least one process based on the simulation.

In some aspects, the techniques described herein relate to an AI-based platform, wherein the digital twin is associated with at least one physical machine associated with one or both of the set of fixed entities or the set of mobile entities, and the digital twin is updated by the data collection system to generate output of a process that corresponds to an updated detection of output of the process performed by the at least one physical machine.

In some aspects, the techniques described herein relate to an AI-based platform, wherein the digital twin is updated by the data collection system based on a policy of conserving power and energy consumption associated with the set of energy demand parameters.

In some aspects, the techniques described herein relate to an AI-based platform for enabling intelligent orchestration and management of power and energy, including: a set of modular, distributed energy systems that are configurable based on local demand requirements.

In some aspects, the techniques described herein relate to an AI-based platform, wherein the local demand requirements are forecast by demand forecasting algorithm operating on a set of edge networking devices that are linked to a set of systems that consume energy.

In some aspects, the techniques described herein relate to an AI-based platform, wherein at least one of the modular, distributed energy systems of the set is configured by the AI-based platform to be located in proximity to a location and time of demand.

In some aspects, the techniques described herein relate to an AI-based platform, wherein at least one of the modular, distributed energy systems of the set is configured by the AI-based platform to be located based on a location and type of a local demand requirement.

In some aspects, the techniques described herein relate to an AI-based platform, wherein at least one of the modular, distributed energy systems of the set is configured by the AI-based platform to generate energy at a point of local demand.

In some aspects, the techniques described herein relate to an AI-based platform, wherein at least one of the modular, distributed energy systems of the set is configured by the AI-based platform to deliver a modular generation system to a location of demand.

In some aspects, the techniques described herein relate to an AI-based platform, wherein at least one of the modular, distributed energy systems of the set is configured by the AI-based platform to route a delivery of energy by a set of energy delivery facilities to a location of demand.

In some aspects, the techniques described herein relate to an AI-based platform, wherein at least one of the modular, distributed energy systems of the set is orchestrated by the AI-based platform to store energy in proximity to a location and time of demand.

In some aspects, the techniques described herein relate to an AI-based platform, wherein at least one of the modular, distributed energy systems of the set is further configured to adapt a transport of data over a network and/or communication system, wherein the adapting is based on one or more of, a congestion condition, a delay and/or latency condition, a packet loss condition, an error rate condition, a cost of transport condition, a quality-of: service (QoS) condition, a usage condition, a market factor condition, or a user configuration condition.

In some aspects, the techniques described herein relate to an AI-based platform, further including an adaptive energy digital twin that represents one or more of, an energy stakeholder entity, an energy distribution resource, a stakeholder information technology, a networking infrastructure entity, an energy-dependent stakeholder production facility, a stakeholder transportation system, a market condition, or an energy usage priority condition.

In some aspects, the techniques described herein relate to an AI-based platform, further including an adaptive energy digital twin that is configured to perform one or more of, providing a visual and/or analytic indicator of energy consumption by one or more energy consumers, filtering energy data, highlighting energy data, adjusting energy data, or generating a visual and/or analytic indicator of energy consumption by one or more of, one or more machines, one or more factories, or one or more vehicles in a vehicle fleet.

In some aspects, the techniques described herein relate to an AI-based platform, wherein at least one of the modular, distributed energy systems is further configured to perform one or more of, extracting energy-related data, detecting and/or correcting errors in energy-related data, transforming, converting, normalizing, and/or cleansing energy-related data, parsing energy-related data, detecting patterns, content, and/or objects in energy-related data, compressing energy-related data, streaming energy-related data, filtering energy-related data, loading and/or storing energy-related data, routing and/or transporting energy-related data, or maintaining security of energy-related data.

In some aspects, the techniques described herein relate to an AI-based platform, wherein the local demand requirements are based one or more of, on one or more public data resources, the one or more public data resources including one or more of, a weather data resource, a satellite data resource, a census, population, demographic, and/or psychographic data resource, a market data resource, or an ecommerce data resource, or one or more enterprise data resources, the one or more enterprise data resources including one or more of, resource planning data, sales and/or marketing data, financial planning data, demand planning data, supply chain data, procurement data, pricing data, customer data, product data, or operating data.

In some aspects, the techniques described herein relate to an AI-based platform, further including at least one AI-based model and/or algorithm, wherein the at least one AI-based model and/or algorithm is trained based on a training data set, and the training data set is based on one or more of, one or more human tags and/or labels, one or more human interactions with a hardware and/or software system, one or more outcomes, one or more AI-generated training data samples, a supervised learning training process, a semi-supervised learning training process, or a deep learning training process.

In some aspects, the techniques described herein relate to an AI-based platform, wherein at least one of the modular, distributed energy systems is configured to orchestrate delivery of energy to one or more points of consumption, and the delivery of the energy includes one or more of, one or more fixed transmission lines, one or more instances of wireless energy transmission, one or more deliveries of fuel, or one or more deliveries of stored energy.

In some aspects, the techniques described herein relate to an AI-based platform, wherein a first system of the modular, distributed energy systems is configured to communicate with a second system of the modular, distributed energy systems to orchestrate the delivery of energy to the one or more points of consumption by adjusting an energy generation, storage, delivery, and/or consumption by one or both of the first system or the second system.

In some aspects, the techniques described herein relate to an AI-based platform, wherein at least one of the modular, distributed energy systems is configured to adjust the delivery of energy to the one or more points of consumption based on a carbon generation and/or emissions policy.

In some aspects, the techniques described herein relate to an AI-based platform, wherein at least one of the modular, distributed energy systems is further configured to record, in a distributed ledger and/or blockchain, one or more energy-related events, the one or more energy-related events including one or more of, an energy purchase and/or sale event, a service charge associated with an energy purchase and/or sale event, an energy consumption event, an energy generation event, an energy distribution event, an energy storage event, a carbon emission production event, a carbon emission abatement event, a renewable energy credit event, a pollution production event, or a pollution abatement event.

In some aspects, the techniques described herein relate to an AI-based platform, wherein at least one of the modular, distributed energy systems is deployed in an off-grid environment, and the off-grid environment includes one or more of, an off-grid energy generation system, an off-grid energy storage system, or an off-grid energy mobilization system.

In some aspects, the techniques described herein relate to an AI-based platform, wherein at least one of the modular, distributed energy systems is associated with a digital twin that is configured to model and/or predict one or more properties and/or operations of the at least one of the modular, distributed energy systems.

In some aspects, the techniques described herein relate to an AI-based platform, wherein the set of modular, distributed energy systems is configurable to change an amount of reserved capacity to accommodate a pattern of energy demand associated with the local demand requirements.

In some aspects, the techniques described herein relate to an AI-based platform, wherein the set of modular, distributed energy systems is configurable to change a location of an energy provision and/or access resource based on a measurement and/or forecast of the local demand requirements.

In some aspects, the techniques described herein relate to an AI-based platform, wherein the set of modular, distributed energy systems is configurable to change a schedule of energy production based on a measurement and/or forecast of the local demand requirements.

In some aspects, the techniques described herein relate to an AI-based platform, wherein the set of modular, distributed energy systems is configurable to change an allocation of resources associated with the set of modular, distributed energy systems, and the allocation is based on a subset of the local demand requirements.

In some aspects, the techniques described herein relate to an AI-based platform for enabling intelligent orchestration and management of power and energy, including: an artificial intelligence system that is configured to: perform an analysis of a pattern of energy associated with an operating process that involves a set of resources, the set of resources being at least partially independent of an electrical grid; and output a set of operating parameters to provision energy generation, storage, and/or consumption to enable the operating process, wherein the set of operating parameters is based on the analysis.

In some aspects, the techniques described herein relate to an AI-based platform, wherein at least one operating parameter in the set of operating parameters is a generation output level for a distributed energy generation resource.

In some aspects, the techniques described herein relate to an AI-based platform, wherein at least one operating parameter in the set of operating parameters is a target storage level for a distributed energy storage resource.

In some aspects, the techniques described herein relate to an AI-based platform, wherein at least one operating parameter in the set of operating parameters is a delivery timing for a distributed energy delivery resource.

In some aspects, the techniques described herein relate to an AI-based platform, wherein the artificial intelligence system is further configured to adapt a transport of data over a network and/or communication system, wherein the adapting is based on one or more of, a congestion condition, a delay and/or latency condition, a packet loss condition, an error rate condition, a cost of transport condition, a quality-of-service (QoS) condition, a usage condition, a market factor condition, or a user configuration condition.

In some aspects, the techniques described herein relate to an AI-based platform, further including an adaptive energy digital twin that represents one or more of, an energy stakeholder entity, an energy distribution resource, a stakeholder information technology, a networking infrastructure entity, an energy-dependent stakeholder production facility, a stakeholder transportation system, a market condition, or an energy usage priority condition.

In some aspects, the techniques described herein relate to an AI-based platform, further including an adaptive energy digital twin that is configured to perform one or more of, providing a visual and/or analytic indicator of energy consumption by one or more energy consumers, filtering energy data, highlighting energy data, adjusting energy data, or generating a visual and/or analytic indicator of energy consumption by one or more of, one or more machines, one or more factories, or one or more vehicles in a vehicle fleet.

In some aspects, the techniques described herein relate to an AI-based platform, wherein the artificial intelligence system is further configured to perform one or more of, extracting energy-related data, detecting and/or correcting errors in energy-related data, transforming, converting, normalizing, and/or cleansing energy-related data, parsing energy-related data, detecting patterns, content, and/or objects in energy-related data, compressing energy-related data, streaming energy-related data, filtering energy-related data, loading and/or storing energy-related data, routing and/or transporting energy-related data, or maintaining security of energy-related data.

In some aspects, the techniques described herein relate to an AI-based platform, wherein at least one of the operating parameters is based on one or more of, one or more public data resources, the one or more public data resources including one or more of, a weather data resource, a satellite data resource, a census, population, demographic, and/or psychographic data resource, a market data resource, or an ecommerce data resource, or one or more enterprise data resources, the one or more enterprise data resources including one or more of, resource planning data, sales and/or marketing data, financial planning data, demand planning data, supply chain data, procurement data, pricing data, customer data, product data, or operating data.

In some aspects, the techniques described herein relate to an AI-based platform, wherein the artificial intelligence system is trained based on a training data set, and the training data set is based on one or more of, one or more human tags and/or labels, one or more human interactions with a hardware and/or software system, one or more outcomes, one or more AI-generated training data samples, a supervised learning training process, a semi-supervised learning training process, or a deep learning training process.

In some aspects, the techniques described herein relate to an AI-based platform, wherein the artificial intelligence system is configured to orchestrate delivery of energy to one or more points of consumption, and the delivery of the energy includes one or more of, one or more fixed transmission lines, one or more instances of wireless energy transmission, one or more deliveries of fuel, or one or more deliveries of stored energy.

In some aspects, the techniques described herein relate to an AI-based platform, wherein the artificial intelligence system is further configured to record, in a distributed ledger and/or blockchain, one or more energy-related events, the one or more energy-related events including one or more of, an energy purchase and/or sale event, a service charge associated with an energy purchase and/or sale event, an energy consumption event, an energy generation event, an energy distribution event, an energy storage event, a carbon emission production event, a carbon emission abatement event, a renewable energy credit event, a pollution production event, or a pollution abatement event.

In some aspects, the techniques described herein relate to an AI-based platform, wherein the artificial intelligence system is deployed in an off-grid environment, and the off-grid environment includes one or more of, an off-grid energy generation system, an off-grid energy storage system, or an off-grid energy mobilization system.

In some aspects, the techniques described herein relate to an AI-based platform, wherein the artificial intelligence system is further configured to determine an environmental impact of a carbon generation and/or emission associated with the operating process on an area that is associated with the operating process.

In some aspects, the techniques described herein relate to an AI-based platform, wherein the artificial intelligence system is further configured to evaluate a compliance of the operating process with one or both of, a carbon generation and/or emissions policy, or a set of labor standards associated with the operating process.

In some aspects, the techniques described herein relate to an AI-based platform, wherein the artificial intelligence system is further configured to adjust the set of operating parameters to provision energy generation, storage, and/or consumption associated with the operating process based on one or both of, a carbon generation and/or emissions policy, or a set of labor standards associated with the operating process.

In some aspects, the techniques described herein relate to an AI-based platform, wherein the artificial intelligence system is further configured to transmit a message to at least one edge device of a set of edge devices that are associated with the operating process, and the message includes a request to adjust at least one operation of the at least one edge device based on the set of operating parameters.

In some aspects, the techniques described herein relate to an AI-based platform, wherein the artificial intelligence system is further configured to receive, from at least one edge device of a set of edge devices that are associated with the operating process, an indicator of a current and/or predicted energy status of the at least one edge device, and the set of operating parameters is based on the indicator of the current and/or predicted energy status of the at least one edge device.

In some aspects, the techniques described herein relate to an AI-based platform, wherein the artificial intelligence system is further configured to determine the set of operating parameters based on an output of a digital twin that represents at least one edge device of a set of edge devices that are associated with the operating process, and the output of the digital twin indicates a current and/or predicted energy status of the at least one edge device.

In some aspects, the techniques described herein relate to an AI-based platform, wherein the artificial intelligence system is further configured to orchestrate a set of modular, distributed energy systems to generate, store, and/or deliver energy, wherein the orchestrating is based on the set of operating parameters and local demand requirements.

In some aspects, the techniques described herein relate to an AI-based platform, wherein the analysis of the pattern of energy associated with the operating process includes an analysis of an availability of a backup source of power that is usable in response to a failure of at least a portion of the electrical grid.

In some aspects, the techniques described herein relate to an AI-based platform, wherein the analysis of the pattern of energy associated with the operating process includes an analysis of at least one auxiliary function associated with the set of resources, and the set of operational parameters includes at least one operational parameter associated with the at least one auxiliary function.

In some aspects, the techniques described herein relate to an AI-based platform for enabling intelligent orchestration and management of power and energy, including: a policy and governance engine configured to deploy a set of rules and/or policies that govern a set of energy generation, storage, and/or consumption workloads, wherein the rules and/or policies are associated with a configuration of a set of edge devices operating in local data communication with a set of energy generation facilities, energy storage facilities, energy delivery facilities or energy consumption systems.

In some aspects, the techniques described herein relate to an AI-based platform, wherein upon configuration in the policy and governance engine, a policy associated with an energy generation instruction is automatically applied by at least one of the edge devices to control energy generation by at least one energy generation system that is controlled via the edge device.

In some aspects, the techniques described herein relate to an AI-based platform, wherein upon configuration in the policy and governance engine, a policy associated with an energy consumption instruction is automatically applied by at least one of the edge devices to control energy consumption by at least one energy consuming system that is controlled via the edge device.

In some aspects, the techniques described herein relate to an AI-based platform, wherein upon configuration in the policy and governance engine, a policy associated with an energy delivery instruction is automatically applied by at least one of the edge devices to control energy delivery by at least one energy delivery system that is controlled via the edge device.

In some aspects, the techniques described herein relate to an AI-based platform, wherein upon configuration in the policy and governance engine, a policy associated with an energy storage instruction is automatically applied by at least one of the edge devices to control energy storage by at least one energy storage system that is controlled via the edge device.

In some aspects, the techniques described herein relate to an AI-based platform, wherein the policy and governance engine is configured to operate on a stored set of policy templates in order to configure a policy.

In some aspects, the techniques described herein relate to an AI-based platform, wherein a set of recommended policies is automatically generated for presentation in the policy and governance engine based on a data set of historical policies, a data set representing operating states and/or configurations of a set of distributed energy resources, and a set of historical outcomes.

In some aspects, the techniques described herein relate to an AI-based platform, wherein the policy and governance engine is further configured to adjust the rules and/or policies based on at least one contextual factor, and the at least one contextual factor includes at least one of, historical data of energy transactions, at least one operational factor, at least one market factor, at least one anticipated market behavior, or at least one anticipated customer behavior.

In some aspects, the techniques described herein relate to an AI-based platform, wherein the policy and governance engine is further configured to adapt a transport of data over a network and/or communication system, wherein the adapting is based on at least one of, a congestion condition, a delay and/or latency condition, a packet loss condition, an error rate condition, a cost of transport condition, a quality-of-service (QoS) condition, a usage condition, a market factor condition, or a user configuration condition.

In some aspects, the techniques described herein relate to an AI-based platform, further including an adaptive energy digital twin that represents at least one of, an energy stakeholder entity, an energy distribution resource, a stakeholder information technology, a networking infrastructure entity, an energy-dependent stakeholder production facility, a stakeholder transportation system, a market condition, or an energy usage priority condition.

In some aspects, the techniques described herein relate to an AI-based platform, further including an adaptive energy digital twin that is configured to perform at least one of, providing a visual and/or analytic indicator of energy consumption by at least one energy consumer, filtering energy data, highlighting energy data, or adjusting energy data.

In some aspects, the techniques described herein relate to an AI-based platform, further including an adaptive energy digital twin that is configured to generate a visual and/or analytic indicator of energy consumption by at least one of, at least one machine, at least one factory, or at least one vehicle in a vehicle fleet.

In some aspects, the techniques described herein relate to an AI-based platform, wherein the policy and governance engine is further configured to perform at least one of, extracting energy-related data, detecting and/or correcting errors in energy-related data, transforming, converting, normalizing, and/or cleansing energy-related data, parsing energy-related data, detecting patterns, content, and/or objects in energy-related data, compressing energy-related data, streaming energy-related data, filtering energy-related data, loading and/or storing energy-related data, routing and/or transporting energy-related data, or maintaining security of energy-related data.

In some aspects, the techniques described herein relate to an AI-based platform, wherein at least one of the rules and/or policies is based on at least one public data resource, the at least one public data resource including at least one of, a weather data resource, a satellite data resource, a census, population, demographic, and/or psychographic data resource, a market data resource, or an ecommerce data resource.

In some aspects, the techniques described herein relate to an AI-based platform, wherein at least one of the rules and/or policies is based on at least one enterprise data resource, the at least one enterprise data resource including at least one of, resource planning data, sales and/or marketing data, financial planning data, demand planning data, supply chain data, procurement data, pricing data, customer data, product data, or operating data.

In some aspects, the techniques described herein relate to an AI-based platform, further including at least one AI-based model and/or algorithm, wherein the at least one AI-based model and/or algorithm is trained based on a training data set, and the training data set is based on at least one of, at least one human tag and/or label, at least one human interaction with a hardware and/or software system, at least one outcome, at least one AI-generated training data sample, a supervised learning training process, a semi-supervised learning training process, or a deep learning training process.

In some aspects, the techniques described herein relate to an AI-based platform, wherein the policy and governance engine is configured to orchestrate delivery of energy to at least one point of consumption, and the delivery of the energy includes at least one of, at least one fixed transmission line, at least one instance of wireless energy transmission, at least one delivery of fuel, or at least one delivery of stored energy.

In some aspects, the techniques described herein relate to an AI-based platform, wherein the policy and governance engine is further configured to record, in a distributed ledger and/or blockchain, at least one energy-related event, the at least one energy-related event including at least one of, an energy purchase and/or sale event, a service charge associated with an energy purchase and/or sale event, an energy consumption event, an energy generation event, an energy distribution event, an energy storage event, a carbon emission production event, a carbon emission abatement event, a renewable energy credit event, a pollution production event, or a pollution abatement event.

In some aspects, the techniques described herein relate to an AI-based platform, wherein the policy and governance engine is deployed in an off-grid environment, and the off-grid environment includes at least one of, an off-grid energy generation system, an off-grid energy storage system, or an off-grid energy mobilization system.

In some aspects, the techniques described herein relate to an AI-based platform, wherein the policy and governance engine is further configured to generate and/or execute at least one smart contract, wherein each of the at least one smart contract applies the rules and/or policies to at least one energy-related transaction.

In some aspects, the techniques described herein relate to an AI-based platform, wherein the set of rules and/or policies is based on an at least one objective associated with the set of energy generation, storage, and/or consumption workloads, and the policy and governance engine is further configured to deploy, to the set of edge devices, an update to the set of rules and/or policies based on the objective.

In some aspects, the techniques described herein relate to an AI-based platform, wherein the policy and governance engine is further configured to deploy, to the set of edge devices, at least one instruction to adapt at least one operational parameter associated with at least one industrial machine and/or industrial process that is controlled by the set of edge devices.

In some aspects, the techniques described herein relate to an AI-based platform for enabling intelligent orchestration and management of power and energy, including: a set of edge devices configured to, communicate with at least one energy generation facility, energy storage facility, and/or energy consumption system, and automatically execute a set of preconfigured policies that govern energy generation, energy storage, or energy consumption of the respective energy generation facilities, energy storage facilities, or energy consumption systems.

In some aspects, the techniques described herein relate to an AI-based platform, wherein the automatically executed policies are a set of contextual policies that adjust based on a current status of a set of energy generation entities in an energy grid.

In some aspects, the techniques described herein relate to an AI-based platform, wherein the automatically executed policies are a set of contextual policies that adjust based on a current status of a set of energy generation entities in an energy generation environment that includes an energy grid and a set of distributed energy resources that operate independently of the energy grid.

In some aspects, the techniques described herein relate to an AI-based platform, wherein the automatically executed policies are a set of contextual policies that adjust based on a current status of a set of energy storage entities in an energy grid.

In some aspects, the techniques described herein relate to an AI-based platform, wherein the automatically executed policies are a set of contextual policies that adjust based on a current status of a set of energy storage entities in an energy storage environment that includes an energy grid and a set of distributed energy resources that operate independently of the energy grid, wherein the automatically executed policies are a set of contextual policies that adjust based on the current status of a set of energy delivery entities in an energy grid.

In some aspects, the techniques described herein relate to an AI-based platform, wherein the automatically executed policies are a set of contextual policies that adjust based on a current status of a set of energy transmission entities in an energy transmission environment that includes an energy grid and a set of distributed energy resources that operate independently of the energy grid.

In some aspects, the techniques described herein relate to an AI-based platform, wherein the automatically executed policies are a set of contextual policies that adjust based on a current status of a set of energy consumption entities that consume energy from an energy grid.

In some aspects, the techniques described herein relate to an AI-based platform, wherein the automatically executed policies are a set of contextual policies that adjust based on a current status of a set of energy consumption entities that consume energy from an energy grid and from a set of distributed energy resources that operate independently of the energy grid.

In some aspects, the techniques described herein relate to an AI-based platform, wherein the set of edge devices is further configured to adjust the set of preconfigured policies based on at least one contextual factor, and the at least one contextual factor includes at least one of, historical data of energy transactions, at least one operational factor, at least one market factor, at least one anticipated market behavior, or at least one anticipated customer behavior.

In some aspects, the techniques described herein relate to an AI-based platform, wherein at least one of the edge devices is further configured to adapt a transport of data over a network and/or communication system, wherein the adapting is based on at least one of, a congestion condition, a delay and/or latency condition, a packet loss condition, an error rate condition, a cost of transport condition, a quality-of-service (QoS) condition, a usage condition, a market factor condition, or a user configuration condition.

In some aspects, the techniques described herein relate to an AI-based platform, further including an adaptive energy digital twin that represents at least one of, an energy stakeholder entity, an energy distribution resource, a stakeholder information technology, a networking infrastructure entity, an energy-dependent stakeholder production facility, a stakeholder transportation system, a market condition, or an energy usage priority condition.

In some aspects, the techniques described herein relate to an AI-based platform, further including an adaptive energy digital twin that is configured to perform at least one of, providing a visual and/or analytic indicator of energy consumption by at least one energy consumer, filtering energy data, highlighting energy data, or adjusting energy data.

In some aspects, the techniques described herein relate to an AI-based platform, further including an adaptive energy digital twin that is configured to generate a visual and/or analytic indicator of energy consumption by at least one of, at least one machine, at least one factory, or at least one vehicle in a vehicle fleet.

In some aspects, the techniques described herein relate to an AI-based platform, wherein at least one of the edge devices is further configured to perform at least one of, extracting energy-related data, detecting and/or correcting errors in energy-related data, transforming, converting, normalizing, and/or cleansing energy-related data, parsing energy-related data, detecting patterns, content, and/or objects in energy-related data, compressing energy-related data, streaming energy-related data, filtering energy-related data, loading and/or storing energy-related data, routing and/or transporting energy-related data, or maintaining security of energy-related data.

In some aspects, the techniques described herein relate to an AI-based platform, wherein at least one of the preconfigured policies is based on at least one public data resource, the at least one public data resource including at least one of, a weather data resource, a satellite data resource, a census, population, demographic, and/or psychographic data resource, a market data resource, or an ecommerce data resource.

In some aspects, the techniques described herein relate to an AI-based platform, wherein at least one of the preconfigured policies is based on at least one enterprise data resource, the at least one enterprise data resource including at least one of, resource planning data, sales and/or marketing data, financial planning data, demand planning data, supply chain data, procurement data, pricing data, customer data, product data, or operating data.

In some aspects, the techniques described herein relate to an AI-based platform, wherein at least one of the edge devices includes at least one AI-based model and/or algorithm, wherein the at least one AI-based model and/or algorithm is trained based on a training data set, and the training data set is based on at least one of, at least one human tag and/or label, at least one human interaction with a hardware and/or software system, at least one outcome, at least one AI-generated training data sample, a supervised learning training process, a semi-supervised learning training process, or a deep learning training process.

In some aspects, the techniques described herein relate to an AI-based platform, wherein at least one of the edge devices is further configured to orchestrate delivery of energy to at least one point of consumption, and the delivery of the energy includes at least one of, at least one fixed transmission line, at least one instance of wireless energy transmission, at least one delivery of fuel, or at least one delivery of stored energy.

In some aspects, the techniques described herein relate to an AI-based platform, wherein at least one of the edge devices is further configured to record, in a distributed ledger and/or blockchain, at least one energy-related event, the at least one energy-related event including at least one of, an energy purchase and/or sale event, a service charge associated with an energy purchase and/or sale event, an energy consumption event, an energy generation event, an energy distribution event, an energy storage event, a carbon emission production event, a carbon emission abatement event, a renewable energy credit event, a pollution production event, or a pollution abatement event.

In some aspects, the techniques described herein relate to an AI-based platform, wherein at least one of the edge devices is deployed in an off-grid environment, and the off-grid environment includes at least one of, an off-grid energy generation system, an off-grid energy storage system, or an off-grid energy mobilization system.

In some aspects, the techniques described herein relate to an AI-based platform, wherein the set of edge devices is further configured to, determine at least one pattern of energy availability based on communicating with the at least one energy generation facility, energy storage facility, and/or energy consumption system, and update execution of the set of preconfigured policies based on the at least one pattern.

In some aspects, the techniques described herein relate to an AI-based platform, wherein at least one edge device of the set of edge devices is configured to manage an operation of an industrial facility, and the set of preconfigured policies is based on at least one energy objective associated with the industrial facility.

In some aspects, the techniques described herein relate to an AI-based platform, wherein the at least one energy generation facility, energy storage facility, and/or energy consumption system is located in a geographic region, and the set of preconfigured policies are based on at least one energy objective associated with the geographic region.

In some aspects, the techniques described herein relate to an AI-based platform, wherein the set of edge devices is configured to automatically execute the set of preconfigured policies by adjusting at least one of, an allocation of energy resources associated with the at least one energy generation facility, energy storage facility, and/or energy consumption system, or a schedule of processes executed by the at least one energy generation facility, energy storage facility, and/or energy consumption system.

In some aspects, the techniques described herein relate to an AI-based platform for enabling intelligent orchestration and management of power and energy, including: a machine learning system trained on a set of energy intelligence data and deployed on an edge device, wherein the machine learning system is configured to receive additional training by the edge device to improve energy management.

In some aspects, the techniques described herein relate to an AI-based platform, wherein the energy management includes management of generation of energy by a set of distributed energy generation resources.

In some aspects, the techniques described herein relate to an AI-based platform, wherein the energy management includes management of storage of energy by a set of distributed energy storage resources.

In some aspects, the techniques described herein relate to an AI-based platform, wherein the energy management includes management of delivery of energy by a set of distributed energy delivery resources.

In some aspects, the techniques described herein relate to an AI-based platform, wherein the energy management includes management of consumption of energy by a set of distributed energy consumption resources.

In some aspects, the techniques described herein relate to an AI-based platform, wherein the energy management is based on a set of rules and/or policies associated with the edge device and a set of energy generation facilities, energy storage facilities, energy delivery facilities or energy consumption systems.

In some aspects, the techniques described herein relate to an AI-based platform, wherein the machine learning system is further configured to adapt a transport of data over a network and/or communication system, wherein the adapting is based on at least one of, a congestion condition, a delay and/or latency condition, a packet loss condition, an error rate condition, a cost of transport condition, a quality-of-service (QoS) condition, a usage condition, a market factor condition, or a user configuration condition.

In some aspects, the techniques described herein relate to an AI-based platform, further including an adaptive energy digital twin that represents at least one of, an energy stakeholder entity, an energy distribution resource, a stakeholder information technology, a networking infrastructure entity, an energy-dependent stakeholder production facility, a stakeholder transportation system, a market condition, or an energy usage priority condition.

In some aspects, the techniques described herein relate to an AI-based platform, further including an adaptive energy digital twin that is configured to perform at least one of, providing a visual and/or analytic indicator of energy consumption by at least one energy consumer, filtering energy data, highlighting energy data, or adjusting energy data.

In some aspects, the techniques described herein relate to an AI-based platform, further including an adaptive energy digital twin that is configured to generate a visual and/or analytic indicator of energy consumption by at least one of, at least one machine, at least one factory, or at least one vehicle in a vehicle fleet.

In some aspects, the techniques described herein relate to an AI-based platform, wherein the machine learning system is further configured to perform at least one of, extracting energy-related data, detecting and/or correcting errors in energy-related data, transforming, converting, normalizing, and/or cleansing energy-related data, parsing energy-related data, detecting patterns, content, and/or objects in energy-related data, compressing energy-related data, streaming energy-related data, filtering energy-related data, loading and/or storing energy-related data, routing and/or transporting energy-related data, or maintaining security of energy-related data.

In some aspects, the techniques described herein relate to an AI-based platform, wherein the energy intelligence data is based on at least one public data resource, the at least one public data resources including at least one of, a weather data resource, a satellite data resource, a census, population, demographic, and/or psychographic data resource, a market data resource, or an ecommerce data resource.

In some aspects, the techniques described herein relate to an AI-based platform, wherein the energy intelligence data is based on at least one enterprise data resource, the at least one enterprise data resource including at least one of, resource planning data, sales and/or marketing data, financial planning data, demand planning data, supply chain data, procurement data, pricing data, customer data, product data, or operating data.

In some aspects, the techniques described herein relate to an AI-based platform, wherein the machine learning system is further trained based on a training data set, and the training data set is based on at least one of, at least one human tag and/or label, at least one human interaction with a hardware and/or software system, at least one outcome, at least one AI-generated training data sample, a supervised learning training process, a semi-supervised learning training process, or a deep learning training process.

In some aspects, the techniques described herein relate to an AI-based platform, wherein the machine learning system is further configured to orchestrate delivery of energy to at least one point of consumption, and the delivery of the energy includes at least one of, at least one fixed transmission line, at least one instance of wireless energy transmission, at least one delivery of fuel, or at least one delivery of stored energy.

In some aspects, the techniques described herein relate to an AI-based platform, wherein the machine learning system is further configured to record, in a distributed ledger and/or blockchain, at least one energy-related event, the at least one energy-related event including at least one of, an energy purchase and/or sale event, a service charge associated with an energy purchase and/or sale event, an energy consumption event, an energy generation event, an energy distribution event, an energy storage event, a carbon emission production event, a carbon emission abatement event, a renewable energy credit event, a pollution production event, or a pollution abatement event.

In some aspects, the techniques described herein relate to an AI-based platform, wherein the edge device is deployed in an off-grid environment, and the off-grid environment includes at least one of, an off-grid energy generation system, an off-grid energy storage system, or an off-grid energy mobilization system.

In some aspects, the techniques described herein relate to an AI-based platform, wherein the edge device is located in proximity to at least one entity that generates, stores, delivers, and/or uses energy.

In some aspects, the techniques described herein relate to an AI-based platform, wherein the edge device provides information about an energy state and/or energy flow of at least one entity that generates, stores, delivers, and/or uses energy.

In some aspects, the techniques described herein relate to an AI-based platform, wherein the edge device contains and/or governs at least one sensor of a set of sensors, and the set of sensors is associated with a set of infrastructure assets that are configured to generate, store, deliver, and/or use energy.

In some aspects, the techniques described herein relate to an AI-based platform, wherein the edge device is associated with a circumstance and/or environment, and the edge device is further configured to perform the additional training of the machine learning system in response to a change in the circumstance and/or environment.

In some aspects, the techniques described herein relate to an AI-based platform, wherein the edge device is further configured to perform the additional training of the machine learning system based on a determination of model drift by the machine learning system.

In some aspects, the techniques described herein relate to an AI-based platform, wherein the additional training is based on the set of energy intelligence data on which the machine learning system was initially trained and an additional energy intelligence data on which the machine learning system has not yet been trained.

In some aspects, the techniques described herein relate to an AI-based platform, wherein the additional training includes adding the machine learning system to an ensemble that includes at least one other artificial intelligence system.

In some aspects, the techniques described herein relate to an AI-based platform, wherein the set of energy intelligence data is based on at least one energy-related policy and/or rule, and the additional training is based on a change in the at least one energy-related policy and/or rule.

In some aspects, the techniques described herein relate to an AI-based platform for enabling intelligent orchestration and management of power and energy, including: a set of edge devices including a set of artificial intelligence systems that are configured to: process data handled by the edge devices; and determine, based on the data, a mix of energy generation, storage, delivery and/or consumption characteristics for a set of systems that are in local communication with the edge devices and to output a data set that indicates constituent proportions of the mix.

In some aspects, the techniques described herein relate to an AI-based platform, wherein the output data set indicates a fraction of energy generated by an energy grid and a fraction of energy generated by a set of distributed energy resources that operate independently of the energy grid.

In some aspects, the techniques described herein relate to an AI-based platform, wherein the output data set indicates a fraction of energy generated by renewable energy resources and a fraction of energy generated by nonrenewable resources.

In some aspects, the techniques described herein relate to an AI-based platform, wherein the output data set indicates a fraction of energy generation by type for each interval in a series of time intervals.

In some aspects, the techniques described herein relate to an AI-based platform, wherein the output data set indicates carbon generation associated with energy generation for each type of energy in the energy mix during each interval of a series of time intervals.

In some aspects, the techniques described herein relate to an AI-based platform, wherein the output data set indicates carbon emissions associated with energy generation for each type of energy in the energy mix during each interval of a series of time intervals.

In some aspects, the techniques described herein relate to an AI-based platform, wherein at least one of the edge devices is further configured to adapt a transport of data over a network and/or communication system, wherein the adapting is based on at least one of, a congestion condition, a delay and/or latency condition, a packet loss condition, an error rate condition, a cost of transport condition, a quality-of-service (QoS) condition, a usage condition, a market factor condition, or a user configuration condition.

In some aspects, the techniques described herein relate to an AI-based platform, further including an adaptive energy digital twin that represents at least one of, an energy stakeholder entity, an energy distribution resource, a stakeholder information technology, a networking infrastructure entity, an energy-dependent stakeholder production facility, a stakeholder transportation system, a market condition, or an energy usage priority condition.

In some aspects, the techniques described herein relate to an AI-based platform, further including an adaptive energy digital twin that is configured to perform at least one of, providing a visual and/or analytic indicator of energy consumption by at least one energy consumer, filtering energy data, highlighting energy data, or adjusting energy data.

In some aspects, the techniques described herein relate to an AI-based platform, further including an adaptive energy digital twin that is configured to generate a visual and/or analytic indicator of energy consumption by at least one of, at least one machine, at least one factory, or at least one vehicle in a vehicle fleet.

In some aspects, the techniques described herein relate to an AI-based platform, wherein at least one of the edge devices is further configured to perform at least one of, extracting energy-related data, detecting and/or correcting errors in energy-related data, transforming, converting, normalizing, and/or cleansing energy-related data, parsing energy-related data, detecting patterns, content, and/or objects in energy-related data, compressing energy-related data, streaming energy-related data, filtering energy-related data, loading and/or storing energy-related data, routing and/or transporting energy-related data, or maintaining security of energy-related data.

In some aspects, the techniques described herein relate to an AI-based platform, wherein the data is based on at least one public data resource, the public data resources including at least one of, a weather data resource, a satellite data resource, a census, population, demographic, and/or psychographic data resource, a market data resource, or an ecommerce data resource.

In some aspects, the techniques described herein relate to an AI-based platform, wherein the data is based on at least one enterprise data resource, the enterprise data resources including at least one of, resource planning data, sales and/or marketing data, financial planning data, demand planning data, supply chain data, procurement data, pricing data, customer data, product data, or operating data.

In some aspects, the techniques described herein relate to an AI-based platform, wherein at least one of the edge devices includes at least one AI-based model and/or algorithm, the at least one AI-based model and/or algorithm is trained based on a training data set, and the training data set is based on at least one of, at least one human tag and/or label, at least one human interaction with a hardware and/or software system, at least one outcome, at least one AI-generated training data sample, a supervised learning training process, a semi-supervised learning training process, or a deep learning training process.

In some aspects, the techniques described herein relate to an AI-based platform, wherein at least one of the edge devices is further configured to orchestrate delivery of energy to at least one point of consumption, and the delivery of the energy includes at least one of, at least one fixed transmission line, at least one instance of wireless energy transmission, at least one delivery of fuel, or at least one delivery of stored energy.

In some aspects, the techniques described herein relate to an AI-based platform, wherein at least one of the edge devices is further configured to record, in a distributed ledger and/or blockchain, at least one energy-related event, the at least one energy-related event including at least one of, an energy purchase and/or sale event, a service charge associated with an energy purchase and/or sale event, an energy consumption event, an energy generation event, an energy distribution event, an energy storage event, a carbon emission production event, a carbon emission abatement event, a renewable energy credit event, a pollution production event, or a pollution abatement event.

In some aspects, the techniques described herein relate to an AI-based platform, wherein at least one of the edge devices is deployed in an off-grid environment, and the off-grid environment includes at least one of, an off-grid energy generation system, an off-grid energy storage system, or an off-grid energy mobilization system.

In some aspects, the techniques described herein relate to an AI-based platform, wherein at least a portion of the set of edge devices is located in proximity to at least one entity that generates, stores, delivers, and/or uses energy.

In some aspects, the techniques described herein relate to an AI-based platform, wherein the set of edge devices provides information about an energy state and/or energy flow of at least one entity that generates, stores, delivers, and/or uses energy.

In some aspects, the techniques described herein relate to an AI-based platform, wherein the set of edge devices contains and/or governs at least one sensor of a set of sensors, and the set of sensors is associated with a set of infrastructure assets that are configured to generate, store, deliver, and/or use energy.

In some aspects, the techniques described herein relate to an AI-based platform, wherein the mix of energy generation, storage, delivery and/or consumption characteristics is based on at least one energy demand requirement associated with the set of edge devices.

In some aspects, the techniques described herein relate to an AI-based platform, wherein the mix of energy generation, storage, delivery and/or consumption characteristics is based on a prioritization of energy collection, storage, transportation, and/or usage associated with each energy source associated with the set of edge devices.

In some aspects, the techniques described herein relate to an AI-based platform, wherein the mix of energy generation, storage, delivery and/or consumption characteristics is based on a schedule of storage, transportation, and/or usage associated with each energy source associated with the set of edge devices.

In some aspects, the techniques described herein relate to an AI-based platform for enabling intelligent orchestration and management of power and energy, including: a data processing system configured to fuse at least one entity of an energy grid entity generation, storage, delivery or consumption grid data set with at least one entity of an off-grid energy entity generation, storage, delivery and/or consumption data set.

In some aspects, the techniques described herein relate to an AI-based platform, wherein the data processing system is configured to automatically time align energy grid entity data with off-grid energy entity data.

In some aspects, the techniques described herein relate to an AI-based platform, wherein the data processing system is configured to automatically collect off-grid energy entity sensor data from a set of edge devices via which a set of off-grid energy entities are controlled.

In some aspects, the techniques described herein relate to an AI-based platform, wherein the data processing system is configured to automatically normalize the energy grid entity data and the off-grid energy entity data such as to present the data according to a set of common units.

In some aspects, the techniques described herein relate to an AI-based platform, wherein the data processing system is further configured to adapt a transport of data over a network and/or communication system, wherein the adapting is based on at least one of, a congestion condition, a delay and/or latency condition, a packet loss condition, an error rate condition, a cost of transport condition, a quality-of-service (QoS) condition, a usage condition, a market factor condition, or a user configuration condition.

In some aspects, the techniques described herein relate to an AI-based platform, further including an adaptive energy digital twin that represents at least one of, an energy stakeholder entity, an energy distribution resource, a stakeholder information technology, a networking infrastructure entity, an energy-dependent stakeholder production facility, a stakeholder transportation system, a market condition, or an energy usage priority condition.

In some aspects, the techniques described herein relate to an AI-based platform, further including an adaptive energy digital twin that is configured to perform at least one of, providing a visual and/or analytic indicator of energy consumption by at least one energy consumer, filtering energy data, highlighting energy data, or adjusting energy data.

In some aspects, the techniques described herein relate to an AI-based platform, further including an adaptive energy digital twin that is configured to generate a visual and/or analytic indicator of energy consumption by at least one of, at least one machine, at least one factory, or at least one vehicle in a vehicle fleet.

In some aspects, the techniques described herein relate to an AI-based platform, wherein the data processing system is further configured to perform at least one of, extracting energy-related data, detecting and/or correcting errors in energy-related data, transforming, converting, normalizing, and/or cleansing energy-related data, parsing energy-related data, detecting patterns, content, and/or objects in energy-related data, compressing energy-related data, streaming energy-related data, filtering energy-related data, loading and/or storing energy-related data, routing and/or transporting energy-related data, or maintaining security of energy-related data.

In some aspects, the techniques described herein relate to an AI-based platform, further including at least one AI-based model and/or algorithm, wherein the at least one AI-based model and/or algorithm is trained based on a training data set, and the training data set is based on at least one of, at least one human tag and/or label, at least one human interaction with a hardware and/or software system, at least one outcome, at least one AI-generated training data sample, a supervised learning training process, a semi-supervised learning training process, or a deep learning training process.

In some aspects, the techniques described herein relate to an AI-based platform, wherein the data processing system is further configured to orchestrate delivery of energy to at least one point of consumption, and the delivery of the energy includes at least one of, at least one fixed transmission line, at least one instance of wireless energy transmission, at least one delivery of fuel, or at least one delivery of stored energy.

In some aspects, the techniques described herein relate to an AI-based platform, wherein the data processing system is further configured to record, in a distributed ledger and/or blockchain, at least one energy-related event, the at least one energy-related event including at least one of, an energy purchase and/or sale event, a service charge associated with an energy purchase and/or sale event, an energy consumption event, an energy generation event, an energy distribution event, an energy storage event, a carbon emission production event, a carbon emission abatement event, a renewable energy credit event, a pollution production event, or a pollution abatement event.

In some aspects, the techniques described herein relate to an AI-based platform, wherein the at least one entity of an off-grid energy generation, storage, and/or consumption data set is deployed in an off-grid environment, and the off-grid environment includes at least one of, an off-grid energy generation system, an off-grid energy storage system, or an off-grid energy mobilization system.

In some aspects, the techniques described herein relate to an AI-based platform, wherein the data processing system is further configured to intelligently orchestrate and manage power and/or energy based on a data set of energy generation, storage, and/or consumption data for a set of infrastructure assets, and the data set is produced at least in part by a set of sensors contained in and/or governed by a set of edge devices.

In some aspects, the techniques described herein relate to an AI-based platform, wherein the data processing system is further configured to manage at least one of, generation of energy by a set of distributed energy generation resources, storage of energy by a set of distributed energy storage resources, delivery of energy by a set of distributed energy delivery resources, or consumption of energy by a set of distributed energy consumption resources.

In some aspects, the techniques described herein relate to an AI-based platform, wherein the data processing system is further configured to intelligently orchestrate and manage power and/or energy of a set of entities, wherein the set of entities includes at least one of, a weather data resource, a satellite data resource, a census, population, demographic, and/or psychographic data resource, a market data resource, or an ecommerce data resource.

In some aspects, the techniques described herein relate to an AI-based platform, wherein the data processing system is further configured to execute at least one algorithm that perform a simulation of energy consumption by at least one of the entities, wherein the simulation is based on a data set that includes alternative state or event parameters for at least one of the entities that reflect alternative consumption scenarios, and the algorithms accesses a demand response model that accounts for how energy demand responds to changes in a price of energy or a price of an operation or activity for which the energy is consumed.

In some aspects, the techniques described herein relate to an AI-based platform, wherein the data processing system includes a policy and governance engine that is configured to deploy a set of rules and/or policies to at least one edge device that is in local communication with at least one of the entities, and the edge device is configured to govern at least one of the entities based on the rules and/or policies.

In some aspects, the techniques described herein relate to an AI-based platform, wherein the data processing system includes an analytic system that represents a set of operating parameters and current states of at least one of the entities based on a set of sensed parameters, the set of sensed parameters is generated by a set of edge devices that are in proximity to at least one of the entities, and the analytic system is configured to provide a recommendation associated with at least one the at least one of the entities or at least one additional available entity.

In some aspects, the techniques described herein relate to an AI-based platform, wherein the data processing system includes an artificial intelligence system that is trained on a historical data set relating to energy generation, storage, and/or utilization of an operating process associated with at least one of the entities, and the data processing system is further configured to, analyze an energy pattern for the operating process, and output a forecast of energy requirements of the operating process based on a current state and/or information associated with at least one of the entities.

In some aspects, the techniques described herein relate to an AI-based platform, wherein the data processing system is further configured to fuse, with the energy grid entity generation, storage, delivery or consumption grid data set and the off-grid energy entity generation, storage, delivery and/or consumption data set, at least one entity of a backup and/or auxiliary energy generation, storage, delivery or consumption grid data set.

In some aspects, the techniques described herein relate to an AI-based platform, wherein the data processing system is further configured to coordinate a development of energy grid resources and/or off-grid energy resource based on fusing the energy grid entity generation, storage, delivery or consumption grid data set and the off-grid energy entity generation, storage, delivery and/or consumption data set.

In some aspects, the techniques described herein relate to an AI-based platform for enabling intelligent orchestration and management of power and energy, including: a set of autonomous orchestration systems for improving delivery of a heterogeneous set of energy types to a point of consumption based on: a location of the point of consumption, and a set of consumption attributes, the consumption attributes including at least one of: a peak power requirement at the point of consumption; a continuity of power requirement at the point of consumption; and a type of energy that can be used at the point of consumption.

In some aspects, the techniques described herein relate to an AI-based platform, wherein the set of autonomous orchestration systems orchestrates delivery of defined types of energy generation capacity to the point of consumption.

In some aspects, the techniques described herein relate to an AI-based platform, wherein the set of autonomous orchestration systems orchestrates delivery of defined types of energy storage capacity to the point of consumption.

In some aspects, the techniques described herein relate to an AI-based platform, wherein the type of energy that can be used is determined at least in part based on a set of operational compatibility parameters.

In some aspects, the techniques described herein relate to an AI-based platform, wherein the type of energy that can be used is determined at least in part based on a set of governance parameters.

In some aspects, the techniques described herein relate to an AI-based platform, wherein the set of governance parameters relates to use of renewable energy resources.

In some aspects, the techniques described herein relate to an AI-based platform, wherein the set of governance parameters relates to carbon generation or emissions.

In some aspects, the techniques described herein relate to an AI-based platform, wherein at least one of the set of autonomous orchestration systems is further configured to adapt a transport of data over a network and/or communication system, wherein the adapting is based on at least one of, a congestion condition, a delay and/or latency condition, a packet loss condition, an error rate condition, a cost of transport condition, a quality-of-service (QoS) condition, a usage condition, a market factor condition, or a user configuration condition.

In some aspects, the techniques described herein relate to an AI-based platform, further including an adaptive energy digital twin that represents at least one of, an energy stakeholder entity, an energy distribution resource, a stakeholder information technology, a networking infrastructure entity, an energy-dependent stakeholder production facility, a stakeholder transportation system, a market condition, or an energy usage priority condition.

In some aspects, the techniques described herein relate to an AI-based platform, further including an adaptive energy digital twin that is configured to perform at least one of, providing a visual and/or analytic indicator of energy consumption by at least one energy consumer, filtering energy data, highlighting energy data, or adjusting energy data.

In some aspects, the techniques described herein relate to an AI-based platform, further including an adaptive energy digital twin that is configured to generate a visual and/or analytic indicator of energy consumption by at least one of, at least one machine, at least one factory, or at least one vehicle in a vehicle fleet.

In some aspects, the techniques described herein relate to an AI-based platform, wherein at least one of the set of autonomous orchestration systems is further configured to perform at least one of, extracting energy-related data, detecting and/or correcting errors in energy-related data, transforming, converting, normalizing, and/or cleansing energy-related data, parsing energy-related data, detecting patterns, content, and/or objects in energy-related data, compressing energy-related data, streaming energy-related data, filtering energy-related data, loading and/or storing energy-related data, routing and/or transporting energy-related data, or maintaining security of energy-related data.

In some aspects, the techniques described herein relate to an AI-based platform, wherein at least one of the consumption attributes is based on at least one public data resource, the public data resources including at least one of, a weather data resource, a satellite data resource, a census, population, demographic, and/or psychographic data resource, a market data resource, or an ecommerce data resource.

In some aspects, the techniques described herein relate to an AI-based platform, wherein at least one of the consumption attributes is based on at least one enterprise data resource, the enterprise data resources including at least one of, resource planning data, sales and/or marketing data, financial planning data, demand planning data, supply chain data, procurement data, pricing data, customer data, product data, or operating data.

In some aspects, the techniques described herein relate to an AI-based platform, further including at least one AI-based model and/or algorithm, wherein the at least one AI-based model and/or algorithm is trained based on a training data set, and the training data set is based on at least one of, at least one human tag and/or label, at least one human interaction with a hardware and/or software system, at least one outcome, at least one AI-generated training data sample, a supervised learning training process, a semi-supervised learning training process, or a deep learning training process.

In some aspects, the techniques described herein relate to an AI-based platform, wherein at least one of the set of autonomous orchestration systems is further configured to orchestrate delivery of energy to at least one point of consumption, and the delivery of the energy includes at least one of, at least one fixed transmission line, at least one instance of wireless energy transmission, at least one delivery of fuel, or at least one delivery of stored energy.

In some aspects, the techniques described herein relate to an AI-based platform, wherein at least one of the set of autonomous orchestration systems is further configured to record, in a distributed ledger and/or blockchain, at least one energy-related event, the at least one energy-related event including at least one of, an energy purchase and/or sale event, a service charge associated with an energy purchase and/or sale event, an energy consumption event, an energy generation event, an energy distribution event, an energy storage event, a carbon emission production event, a carbon emission abatement event, a renewable energy credit event, a pollution production event, or a pollution abatement event.

In some aspects, the techniques described herein relate to an AI-based platform, wherein at least one of the set of autonomous orchestration systems is deployed in an off-grid environment, and the off-grid environment includes at least one of, an off-grid energy generation system, an off-grid energy storage system, or an off-grid energy mobilization system.

In some aspects, the techniques described herein relate to an AI-based platform, wherein the set of autonomous orchestration systems is further configured to determine the delivery of the heterogeneous set of energy types based on a set of rules and/or policies that govern a set of energy generation, storage, and/or consumption workloads, and the rules and/or policies are associated with a configuration of a set of edge devices operating in local data communication with a set of energy generation facilities, energy storage facilities, energy delivery facilities or energy consumption systems.

In some aspects, the techniques described herein relate to an AI-based platform, wherein the set of autonomous orchestration systems is further configured to determine the delivery of the heterogeneous set of energy types based on a simulation of energy consumption by at least one energy consumer, the simulation is based on a data set that includes alternative state or event parameters for at least one of the at least one energy consumer that reflect alternative consumption scenarios, and the simulation is based on a demand response model that accounts for how energy demand responds to changes in a price of energy or a price of an operation or activity for which the energy is consumed.

In some aspects, the techniques described herein relate to an AI-based platform, wherein the set of autonomous orchestration systems improves the delivery of the heterogeneous set of energy types to the point of consumption by matching each of the heterogeneous set of energy types with at least one consumer associated with the point of consumption.

In some aspects, the techniques described herein relate to an AI-based platform, wherein the set of autonomous orchestration systems improves the delivery of the heterogeneous set of energy types to the point of consumption by determining a development of additional energy sources of one or more energy types, and the development is based on a forecast of energy demand requirements associated with the point of consumption.

In some aspects, the techniques described herein relate to an AI-based platform, wherein the set of autonomous orchestration systems improves the delivery of the heterogeneous set of energy types to the point of consumption by comparing characteristic of energy demand associated with the point of consumption and characteristics of each energy type of the heterogeneous set of energy types.

In some aspects, the techniques described herein relate to an AI-based platform for enabling intelligent orchestration and management of power and energy, including: an intelligent agent trained on a data set of expert interactions with an energy provisioning system, wherein the intelligent agent is trained to generate at least one recommendation and/or instruction with respect to optimization of at least one energy objective and at least one other objective.

In some aspects, the techniques described herein relate to an AI-based platform, wherein the other objective is an operational objective of an enterprise.

In some aspects, the techniques described herein relate to an AI-based platform, wherein the intelligent agent operates on status data from a set of edge devices via which a set of energy generation resources are controlled.

In some aspects, the techniques described herein relate to an AI-based platform, wherein the intelligent agent operates on status data from a set of edge devices via which a set of energy consumption resources are controlled.

In some aspects, the techniques described herein relate to an AI-based platform, wherein the intelligent agent operates on status data from a set of edge devices via which a set of energy storage resources are controlled.

In some aspects, the techniques described herein relate to an AI-based platform, wherein the intelligent agent operates on status data from a set of edge devices via which a set of energy delivery resources are controlled.

In some aspects, the techniques described herein relate to an AI-based platform, wherein the intelligent agent is further configured to adapt a transport of data over a network and/or communication system, wherein the adapting is based on at least one of, a congestion condition, a delay and/or latency condition, a packet loss condition, an error rate condition, a cost of transport condition, a quality-of-service (QoS) condition, a usage condition, a market factor condition, or a user configuration condition.

In some aspects, the techniques described herein relate to an AI-based platform, further including an adaptive energy digital twin that represents at least one of, an energy stakeholder entity, an energy distribution resource, a stakeholder information technology, a networking infrastructure entity, an energy-dependent stakeholder production facility, a stakeholder transportation system, a market condition, or an energy usage priority condition.

In some aspects, the techniques described herein relate to an AI-based platform, further including an adaptive energy digital twin that is configured to perform at least one of, providing a visual and/or analytic indicator of energy consumption by at least one energy consumer, filtering energy data, highlighting energy data, or adjusting energy data.

In some aspects, the techniques described herein relate to an AI-based platform, further including an adaptive energy digital twin that is configured to generate a visual and/or analytic indicator of energy consumption by at least one of, at least one machine, at least one factory, or at least one vehicle in a vehicle fleet.

In some aspects, the techniques described herein relate to an AI-based platform, wherein the intelligent agent is further configured to perform at least one of, extracting energy-related data, detecting and/or correcting errors in energy-related data, transforming, converting, normalizing, and/or cleansing energy-related data, parsing energy-related data, detecting patterns, content, and/or objects in energy-related data, compressing energy-related data, streaming energy-related data, filtering energy-related data, loading and/or storing energy-related data, routing and/or transporting energy-related data, or maintaining security of energy-related data.

In some aspects, the techniques described herein relate to an AI-based platform, wherein the data set is based on at least one public data resource, the public data resources including at least one of, a weather data resource, a satellite data resource, a census, population, demographic, and/or psychographic data resource, a market data resource, or an ecommerce data resource.

In some aspects, the techniques described herein relate to an AI-based platform, wherein the data set is based on at least one enterprise data resource, the enterprise data resources including at least one of, resource planning data, sales and/or marketing data, financial planning data, demand planning data, supply chain data, procurement data, pricing data, customer data, product data, or operating data.

In some aspects, the techniques described herein relate to an AI-based platform, wherein the intelligent agent is trained based on a training data set, and the training data set is based on at least one of, at least one human tag and/or label, at least one human interaction with a hardware and/or software system, at least one outcome, at least one AI-generated training data sample, a supervised learning training process, a semi-supervised learning training process, or a deep learning training process.

In some aspects, the techniques described herein relate to an AI-based platform, wherein the intelligent agent is further configured to orchestrate delivery of energy to at least one point of consumption, and the delivery of the energy includes at least one of, at least one fixed transmission line, at least one instance of wireless energy transmission, at least one delivery of fuel, or at least one delivery of stored energy.

In some aspects, the techniques described herein relate to an AI-based platform, wherein the intelligent agent is further configured to record, in a distributed ledger and/or blockchain, at least one energy-related event, the at least one energy-related event including at least one of, an energy purchase and/or sale event, a service charge associated with an energy purchase and/or sale event, an energy consumption event, an energy generation event, an energy distribution event, an energy storage event, a carbon emission production event, a carbon emission abatement event, a renewable energy credit event, a pollution production event, or a pollution abatement event.

In some aspects, the techniques described herein relate to an AI-based platform, wherein the intelligent agent is deployed in an off-grid environment, and the off-grid environment includes at least one of, an off-grid energy generation system, an off-grid energy storage system, or an off-grid energy mobilization system.

In some aspects, the techniques described herein relate to an AI-based platform, wherein the intelligent agent is located in proximity to at least one entity that generates, stores, delivers, and/or uses energy.

In some aspects, the techniques described herein relate to an AI-based platform, wherein the intelligent agent provides information about an energy state and/or energy flow of at least one entity that generates, stores, delivers, and/or uses energy.

In some aspects, the techniques described herein relate to an AI-based platform, wherein the intelligent agent governs at least one sensor of a set of sensors, and the set of sensors is associated with a set of infrastructure assets that are configured to generate, store, deliver, and/or use energy.

In some aspects, the techniques described herein relate to an AI-based platform, wherein the intelligent agent is further configured to manage at least one processing task associated with at least one device, and the at least one recommendation and/or instruction includes an adjustment of the at least one processing task based on the at least one energy objective and/or the at least one other objective.

In some aspects, the techniques described herein relate to an AI-based platform, wherein the intelligent agent is further configured to, migrate among at least two devices, and while resident one each device of the least two devices, apply the at least one recommendation and/or instruction to the device on which the intelligent agent is resident.

In some aspects, the techniques described herein relate to an AI-based platform, wherein the intelligent agent is further configured to exchange information with at least one other intelligent agent, and the information is based on one or both of, the at least one recommendation and/or instruction, or the at least one energy objective and/or the least one other objective.

In some aspects, the techniques described herein relate to an AI-based platform, wherein the recommendation and/or instruction is associated with at least one device, and the intelligent agent is further configured to exchange, with at least one other intelligent agent, collected and/or determined data that is associated with the at least one device.

In some aspects, the techniques described herein relate to an AI-based platform for enabling intelligent orchestration and management of power and energy, including: an artificial intelligence system that is trained on a set of energy generation, energy storage, energy delivery and/or energy consumption outcomes, wherein the artificial intelligence system is configured to, analyze a data set of current energy generation, current energy storage, current energy delivery and/or current energy consumption information, and provide a recommendation including at least one operating parameter that satisfies both of a mobile entity energy demand or a fixed location energy demand in a defined domain.

In some aspects, the techniques described herein relate to an AI-based platform, wherein the defined domain includes a defined geolocation and a defined time period.

In some aspects, the techniques described herein relate to an AI-based platform, wherein the at least one operating parameter indicates a generation instruction for a set of energy generation resources.

In some aspects, the techniques described herein relate to an AI-based platform, wherein the at least one operating parameter indicates a storage instruction for a set of energy storage resources.

In some aspects, the techniques described herein relate to an AI-based platform, wherein the at least one operating parameter indicates a delivery instruction for a set of energy delivery resources.

In some aspects, the techniques described herein relate to an AI-based platform, wherein the at least one operating parameter indicates a consumption instruction for a set of entities that consume energy.

In some aspects, the techniques described herein relate to an AI-based platform, wherein the artificial intelligence system is further configured to adapt a transport of data over a network and/or communication system, wherein the adapting is based on at least one of, a congestion condition, a delay and/or latency condition, a packet loss condition, an error rate condition, a cost of transport condition, a quality-of-service (QoS) condition, a usage condition, a market factor condition, or a user configuration condition.

In some aspects, the techniques described herein relate to an AI-based platform, further including an adaptive energy digital twin that represents at least one of, an energy stakeholder entity, an energy distribution resource, a stakeholder information technology, a networking infrastructure entity, an energy-dependent stakeholder production facility, a stakeholder transportation system, a market condition, or an energy usage priority condition.

In some aspects, the techniques described herein relate to an AI-based platform, further including an adaptive energy digital twin that is configured to perform at least one of, providing a visual and/or analytic indicator of energy consumption by at least one energy consumer, filtering energy data, highlighting energy data, or adjusting energy data.

In some aspects, the techniques described herein relate to an AI-based platform, further including an adaptive energy digital twin that is configured to generate a visual and/or analytic indicator of energy consumption by at least one of, at least one machine, at least one factory, or at least one vehicle in a vehicle fleet.

In some aspects, the techniques described herein relate to an AI-based platform, wherein the artificial intelligence system is further configured to perform at least one of, extracting energy-related data, detecting and/or correcting errors in energy-related data, transforming, converting, normalizing, and/or cleansing energy-related data, parsing energy-related data, detecting patterns, content, and/or objects in energy-related data, compressing energy-related data, streaming energy-related data, filtering energy-related data, loading and/or storing energy-related data, routing and/or transporting energy-related data, or maintaining security of energy-related data.

In some aspects, the techniques described herein relate to an AI-based platform, wherein the data set is based on at least one public data resource, the at least one public data resource including at least one of, a weather data resource, a satellite data resource, a census, population, demographic, and/or psychographic data resource, a market data resource, or an ecommerce data resource.

In some aspects, the techniques described herein relate to an AI-based platform, wherein the data set is based on at least one enterprise data resource, the at least one enterprise data resources including at least one of, resource planning data, sales and/or marketing data, financial planning data, demand planning data, supply chain data, procurement data, pricing data, customer data, product data, or operating data.

In some aspects, the techniques described herein relate to an AI-based platform, wherein the artificial intelligence system is trained based on a training data set, and the training data set is based on at least one of, at least one human tag and/or label, at least one human interaction with a hardware and/or software system, at least one outcome, at least one AI-generated training data sample, a supervised learning training process, a semi-supervised learning training process, or a deep learning training process.

In some aspects, the techniques described herein relate to an AI-based platform, wherein the artificial intelligence system is further configured to orchestrate delivery of energy to at least one point of consumption, and the delivery of the energy includes at least one of, at least one fixed transmission line, at least one instance of wireless energy transmission, at least one delivery of fuel, or at least one delivery of stored energy.

In some aspects, the techniques described herein relate to an AI-based platform, wherein the artificial intelligence system is further configured to record, in a distributed ledger and/or blockchain, at least one energy-related event, the at least one energy-related event including at least one of, an energy purchase and/or sale event, a service charge associated with an energy purchase and/or sale event, an energy consumption event, an energy generation event, an energy distribution event, an energy storage event, a carbon emission production event, a carbon emission abatement event, a renewable energy credit event, a pollution production event, or a pollution abatement event.

In some aspects, the techniques described herein relate to an AI-based platform, wherein the artificial intelligence system is deployed in an off-grid environment, and the off-grid environment includes at least one of, an off-grid energy generation system, an off-grid energy storage system, or an off-grid energy mobilization system.

In some aspects, the techniques described herein relate to an AI-based platform, wherein the artificial intelligence system is located in proximity to at least one entity that generates, stores, delivers, and/or uses energy.

In some aspects, the techniques described herein relate to an AI-based platform, wherein the artificial intelligence system provides information about an energy state and/or energy flow of at least one entity that generates, stores, delivers, and/or uses energy.

In some aspects, the techniques described herein relate to an AI-based platform, wherein the artificial intelligence system governs at least one sensor of a set of sensors, and the set of sensors is associated with a set of infrastructure assets that are configured to generate, store, deliver, and/or use energy.

In some aspects, the techniques described herein relate to an AI-based platform, wherein the defined domain includes at least one boundary, and the data set is limited based on the at least one boundary associated with the defined domain.

In some aspects, the techniques described herein relate to an AI-based platform, wherein the recommendation is based on at least one constraint associated with the at least one operating parameter, and the artificial intelligence system is trained to analyze the data set based on the at least one constraint.

In some aspects, the techniques described herein relate to an AI-based platform for enabling intelligent orchestration and management of power and energy, including: an artificial intelligence system configured to, analyze a data set of monitored local conditions, and generate a recommended configuration of at least one distributed system of a set of distributed systems, each distributed system of the set of distributed systems being configurable both to produce energy and to consume energy, wherein the configuration causes the at least one distributed system to produce and/or consume energy based on the monitored local conditions.

In some aspects, the techniques described herein relate to an AI-based platform, wherein the artificial intelligence system configures a plurality of the distributed systems in the set such that a set of aggregate performance requirements are satisfied across the plurality.

In some aspects, the techniques described herein relate to an AI-based platform, wherein the aggregate performance requirements are a set of economic performance requirements.

In some aspects, the techniques described herein relate to an AI-based platform, wherein the aggregate performance requirements are a set of regulatory performance requirements.

In some aspects, the techniques described herein relate to an AI-based platform, wherein the aggregate performance requirements relate to carbon generation or emissions.

In some aspects, the techniques described herein relate to an AI-based platform, wherein the aggregate performance requirements are a set of consumption requirements.

In some aspects, the techniques described herein relate to an AI-based platform, wherein the artificial intelligence system is further configured to adapt a transport of data over a network and/or communication system, wherein the adapting is based on at least one of, a congestion condition, a delay and/or latency condition, a packet loss condition, an error rate condition, a cost of transport condition, a quality-of-service (QoS) condition, a usage condition, a market factor condition, or a user configuration condition.

In some aspects, the techniques described herein relate to an AI-based platform, further including an adaptive energy digital twin that represents at least one of, an energy stakeholder entity, an energy distribution resource, a stakeholder information technology, a networking infrastructure entity, an energy-dependent stakeholder production facility, a stakeholder transportation system, a market condition, or an energy usage priority condition.

In some aspects, the techniques described herein relate to an AI-based platform, further including an adaptive energy digital twin that is configured to perform at least one of, providing a visual and/or analytic indicator of energy consumption by at least one energy consumer, filtering energy data, highlighting energy data, or adjusting energy data.

In some aspects, the techniques described herein relate to an AI-based platform, further including an adaptive energy digital twin that is configured to generate a visual and/or analytic indicator of energy consumption by at least one of, at least one machine, at least one factory, or at least one vehicle in a vehicle fleet.

In some aspects, the techniques described herein relate to an AI-based platform, wherein the artificial intelligence system is further configured to perform at least one of, extracting energy-related data, detecting and/or correcting errors in energy-related data, transforming, converting, normalizing, and/or cleansing energy-related data, parsing energy-related data, detecting patterns, content, and/or objects in energy-related data, compressing energy-related data, streaming energy-related data, filtering energy-related data, loading and/or storing energy-related data, routing and/or transporting energy-related data, or maintaining security of energy-related data.

In some aspects, the techniques described herein relate to an AI-based platform, wherein the data set is based on at least one public data resource, the public data resources including at least one of, a weather data resource, a satellite data resource, a census, population, demographic, and/or psychographic data resource, a market data resource, or an ecommerce data resource.

In some aspects, the techniques described herein relate to an AI-based platform, wherein the data set is based on at least one enterprise data resource, the enterprise data resources including at least one of, resource planning data, sales and/or marketing data, financial planning data, demand planning data, supply chain data, procurement data, pricing data, customer data, product data, or operating data.

In some aspects, the techniques described herein relate to an AI-based platform, wherein the artificial intelligence system is further configured to orchestrate delivery of energy to at least one point of consumption, and the delivery of the energy includes at least one of, at least one fixed transmission line, at least one instance of wireless energy transmission, at least one delivery of fuel, or at least one delivery of stored energy.

In some aspects, the techniques described herein relate to an AI-based platform, wherein the artificial intelligence system is further configured to record, in a distributed ledger and/or blockchain, at least one energy-related event, the at least one energy-related event including at least one of, an energy purchase and/or sale event, a service charge associated with an energy purchase and/or sale event, an energy consumption event, an energy generation event, an energy distribution event, an energy storage event, a carbon emission production event, a carbon emission abatement event, a renewable energy credit event, a pollution production event, or a pollution abatement event.

In some aspects, the techniques described herein relate to an AI-based platform, wherein the artificial intelligence system is deployed in an off-grid environment, and the off-grid environment includes at least one of, an off-grid energy generation system, an off-grid energy storage system, or an off-grid energy mobilization system.

In some aspects, the techniques described herein relate to an AI-based platform, wherein the artificial intelligence system is trained based on a training data set, and the training data set is based on at least one of, at least one human tag and/or label, at least one human interaction with a hardware and/or software system, at least one outcome, at least one AI-generated training data sample, a supervised learning training process, a semi-supervised learning training process, or a deep learning training process.

In some aspects, the techniques described herein relate to an AI-based platform, wherein the artificial intelligence system is located in proximity to at least one entity that generates, stores, delivers, and/or uses energy.

In some aspects, the techniques described herein relate to an AI-based platform, wherein the artificial intelligence system provides information about an energy state and/or energy flow of at least one entity that generates, stores, delivers, and/or uses energy.

In some aspects, the techniques described herein relate to an AI-based platform, wherein the artificial intelligence system governs at least one sensor of a set of sensors, and the set of sensors is associated with a set of infrastructure assets that are configured to generate, store, deliver, and/or use energy.

In some aspects, the techniques described herein relate to an AI-based platform, wherein the recommended configuration is based on at least one auxiliary power resource that is associated with the set of distributed systems.

In some aspects, the techniques described herein relate to an AI-based platform, wherein the recommended configuration is based on at least one of, a current and/or forecasted location of the at least one distributed system of the set of distributed systems, or a current and/or forecasted location of at least one energy resource associated with the set of distributed systems.

In some aspects, the techniques described herein relate to an AI-based platform, wherein the recommended configuration is further based on at least one of, a local demand condition associated with the current and/or forecasted location of the at least one distributed system of the set of distributed systems, or a local demand condition associated with the current and/or forecasted location of at least one energy resource associated with the set of distributed systems.

In some aspects, the techniques described herein relate to an AI-based platform for enabling intelligent orchestration and management of power and energy, including: a set of adaptive, autonomous data handling systems for energy data collection and transmission from a set of edge networking devices via which a set of distributed energy entities are controlled, wherein the data handling systems are trained based on a training data set to recognize a set of events and/or signals that indicate at least one energy pattern of the set of distributed energy entities.

In some aspects, the techniques described herein relate to an AI-based platform, wherein the set of distributed energy entities includes at least one energy generation resource.

In some aspects, the techniques described herein relate to an AI-based platform, wherein the set of distributed energy entities includes at least one energy consuming entity.

In some aspects, the techniques described herein relate to an AI-based platform, wherein the set of distributed energy entities includes at least one energy storage resource.

In some aspects, the techniques described herein relate to an AI-based platform, wherein the set of distributed energy entities includes at least one energy delivery resource.

In some aspects, the techniques described herein relate to an AI-based platform, wherein the training data set includes historical energy generation data for a set of entities similar to the entities controlled via the edge networking devices.

In some aspects, the techniques described herein relate to an AI-based platform, wherein the training data set includes historical energy consumption data for a set of entities similar to the entities controlled via the edge networking devices.

In some aspects, the techniques described herein relate to an AI-based platform, wherein the training data set includes historical energy delivery data for a set of entities similar to the entities controlled via the edge networking devices.

In some aspects, the techniques described herein relate to an AI-based platform, wherein the training data set includes historical energy storage data for a set of entities similar to the entities controlled via the edge networking devices.

In some aspects, the techniques described herein relate to an AI-based platform, wherein at least one of the adaptive, autonomous data handling systems is further configured to adapt a transport of data over a network and/or communication system, wherein the adapting is based on at least one of, a congestion condition, a delay and/or latency condition, a packet loss condition, an error rate condition, a cost of transport condition, a quality-of: service (QoS) condition, a usage condition, a market factor condition, or a user configuration condition.

In some aspects, the techniques described herein relate to an AI-based platform, further including an adaptive energy digital twin that represents at least one of, an energy stakeholder entity, an energy distribution resource, a stakeholder information technology, a networking infrastructure entity, an energy-dependent stakeholder production facility, a stakeholder transportation system, a market condition, or an energy usage priority condition.

In some aspects, the techniques described herein relate to an AI-based platform, further including an adaptive energy digital twin that is configured to perform at least one of, providing a visual and/or analytic indicator of energy consumption by at least one energy consumer, filtering energy data, highlighting energy data, or adjusting energy data.

In some aspects, the techniques described herein relate to an AI-based platform, further including an adaptive energy digital twin that is configured to generate a visual and/or analytic indicator of energy consumption by at least one of, at least one machine, at least one factory, or at least one vehicle in a vehicle fleet.

In some aspects, the techniques described herein relate to an AI-based platform, wherein at least one of the adaptive, autonomous data handling systems is further configured to perform at least one of, extracting energy-related data, detecting and/or correcting errors in energy-related data, transforming, converting, normalizing, and/or cleansing energy-related data, parsing energy-related data, detecting patterns, content, and/or objects in energy-related data, compressing energy-related data, streaming energy-related data, filtering energy-related data, loading and/or storing energy-related data, routing and/or transporting energy-related data, or maintaining security of energy-related data.

In some aspects, the techniques described herein relate to an AI-based platform, wherein the energy edge set is based on at least one public data resource, the public data resources including at least one of, a weather data resource, a satellite data resource, a census, population, demographic, and/or psychographic data resource, a market data resource, or an ecommerce data resource.

In some aspects, the techniques described herein relate to an AI-based platform, wherein the energy edge set is based on at least one enterprise data resource, the at least one enterprise data resource including at least one of, resource planning data, sales and/or marketing data, financial planning data, demand planning data, supply chain data, procurement data, pricing data, customer data, product data, or operating data.

In some aspects, the techniques described herein relate to an AI-based platform, further including at least one AI-based model and/or algorithm, wherein the at least one AI-based model and/or algorithm is trained based on a training data set, and the training data set is based on at least one of, at least one human tag and/or label, at least one human interaction with a hardware and/or software system, at least one outcome, at least one AI-generated training data sample, a supervised learning training process, a semi-supervised learning training process, or a deep learning training process.

In some aspects, the techniques described herein relate to an AI-based platform, wherein at least one of the adaptive, autonomous data handling systems is further configured to orchestrate delivery of energy to at least one point of consumption, and the delivery of the energy includes at least one of, at least one fixed transmission line, at least one instance of wireless energy transmission, at least one delivery of fuel, or at least one delivery of stored energy.

In some aspects, the techniques described herein relate to an AI-based platform, wherein at least one of the adaptive, autonomous data handling systems is further configured to record, in a distributed ledger and/or blockchain, at least one energy-related event, the at least one energy-related event including at least one of, an energy purchase and/or sale event, a service charge associated with an energy purchase and/or sale event, an energy consumption event, an energy generation event, an energy distribution event, an energy storage event, a carbon emission production event, a carbon emission abatement event, a renewable energy credit event, a pollution production event, or a pollution abatement event.

In some aspects, the techniques described herein relate to an AI-based platform, wherein at least one of the adaptive, autonomous data handling systems is deployed in an off-grid environment, and the off-grid environment includes at least one of, an off-grid energy generation system, an off-grid energy storage system, or an off-grid energy mobilization system.

In some aspects, the techniques described herein relate to an AI-based platform, wherein the set of adaptive, autonomous data handling systems is further configured to perform additional training of the data handling systems based on an initial set of energy intelligence data on which the data handling systems were initially trained and an additional energy intelligence data on which the data handling systems have not yet been trained.

In some aspects, the techniques described herein relate to an AI-based platform, wherein the set of adaptive, autonomous data handling systems is further configured to instruct at least one edge networking device of the set of edge networking devices to adjust operational parameters associated with the set of distributed energy entities based on a recognition of an event and/or signal of the set of events and/or signals.

In some aspects, the techniques described herein relate to an AI-based platform, wherein the set of adaptive, autonomous data handling systems is further configured to detect events and/or signals based on data collected from the set of edge networking devices during a time period, and the data handling systems are trained to recognize the set of events and/or signals based on at least one feature of the time period.

In some aspects, the techniques described herein relate to an AI-based platform for enabling intelligent orchestration and management of power and energy, including: a data integration module that integrates energy intelligence data collected from at least one internal edge device located within an environment and at least one external edge device located outside of the environment.

In some aspects, the techniques described herein relate to an AI-based platform, wherein the data collected from at least one of the at least one internal edge device or the at least one external edge device is vectorized.

In some aspects, the techniques described herein relate to an AI-based platform, wherein the data collected from at least one of the at least one internal edge device or the at least one external edge device is stored in a distributed database.

In some aspects, the techniques described herein relate to an AI-based platform, wherein the data integration module is further configured to determine patterns of energy based on localized energy patterns associated with the data collected from the at least one internal edge device and the at least one external edge device.

In some aspects, the techniques described herein relate to an AI-based platform for enabling intelligent orchestration and management of power and energy, including: a digital dynamic twin configured to model at least one of a historical energy demand, a current historical energy demand, or a forecast energy demand, and an AI-based digital twin updater that updates the dynamic digital twin based on set of energy parameters.

In some aspects, the techniques described herein relate to an AI-based platform, wherein the AI-based digital twin updater performs an update of the dynamic digital twin to determine a forecast of energy demand during a future period of time, and the update is based on an forecast of energy demand during the future period of time by another AI model.

In some aspects, the techniques described herein relate to an AI-based platform, wherein the dynamic digital twin is associated with a device type, and the AI-based digital twin updater analyzes data associated with energy consumption by devices of the device type in order to update the dynamic digital twin to model the energy consumption by devices of the device type.

In some aspects, the techniques described herein relate to an AI-based platform, wherein the dynamic digital twin is further configured to model an energy demand by at least one entity, wherein the model is based on data that indicates energy consumption by the at least one entity.

In some aspects, the techniques described herein relate to an AI-based platform for enabling intelligent orchestration and management of power and energy, including: an energy access arbitrator that arbitrates, among a set of energy consumption devices, access to at least one energy source by at least one energy consumption device of the set of energy consumption devices.

In some aspects, the techniques described herein relate to an AI-based platform for enabling intelligent orchestration and management of power and energy, including: a set of edge devices that communicate locally with at least one energy consuming devices to determine at least one feature of energy consumption by the at least one energy consuming devices, wherein at least one edge device of the set of edge devices determined the at least one feature of energy consumption by the at least one energy consuming devices based on a plurality of perspectives associated with the energy consumption by the at least one energy consuming devices.

In some aspects, the techniques described herein relate to an AI-based platform, further including an edge device monitoring system that monitors an energy consumption by at least one downstream device of the at least one energy consuming devices, and enforces an energy policy on the at least one downstream device based on the energy consumption.

In some aspects, the techniques described herein relate to an AI-based platform, wherein the energy policy is based on a generation mechanism by which energy associated with the energy consumption was generated.

In some aspects, the techniques described herein relate to an AI-based platform, wherein the edge device monitoring system is further configured to determine a carbon emission associated with the energy consumption by the at least one downstream device.

In some aspects, the techniques described herein relate to an AI-based platform for enabling intelligent orchestration and management of power and energy, including: a set of artificial general intelligence (AGI) agents, wherein each AGI agent is allocated to govern a set of energy generation, storage, and/or consumption workloads by a set of entities.

In some aspects, the techniques described herein relate to an AI-based platform, wherein at least one AGI agent of the set of AGI agents is further configured to adjust at least one parameter associated with the AI-based platform based on at least one interaction between the at least one AGI agent and at least one of, a human, another AGI agent, or another component of the AI-based platform.

In some aspects, the techniques described herein relate to an AI-based platform, wherein at least one AGI agent of the set of AGI agents monitors decisions by at least one other AGI agent of the set of AGI agents and to adjust at least one parameter associated with the AI-based platform based on the decisions by the at least one other AGI agent.

In some aspects, the techniques described herein relate to an AI-based platform, wherein at least one AGI agent of the set of AGI agents monitors energy-related data associated with at least one of, at least one interaction between at least one human and at least one component of the AI-based platform, at least one pattern of wildlife usage, at least one instance of space travel, at least one satellite, at least one asteroid mining operation, at least one banking system, at least one marketing operation, at least one instance of radioactive waste disposal associated with at least one nuclear power plant, at least one cyberattack associated with at least one energy resource, at least one land cleanup operation, at least one AI entity, or at least one robotic entity.

In some aspects, the techniques described herein relate to an AI-based platform, wherein at least one AGI agent of the set of AGI agents performs an adjusting of data associated with at least one of a data collection process, a data storage process, a data reporting process, or a data transmission process, and the adjusting is based on at least one of an anonymity request by an individual associated with the data or a privacy request by an individual associated with the data.

In some aspects, the techniques described herein relate to an AI-based platform, at least one AGI agent of the set of AGI agents monitors a movement of at least one energy resource within a networked element, and updates a policy associated with the at least one energy resource based on the movement.

In some aspects, the techniques described herein relate to an AI-based platform, wherein at least one AGI agent of the set of AGI agents updates an allocation of energy to promote an availability of energy to the at least one energy resource in response to the movement.

In some aspects, the techniques described herein relate to an AI-based platform for enabling intelligent orchestration and management of power and energy, wherein the AI-based platform includes a graph neural network including a set of nodes respectively representing at least one distributed energy resource (DER) and a set of edges respectively interconnecting the set of nodes, wherein each edge represents at least one energy-related feature among at least two nodes of the set of nodes.

In some aspects, the techniques described herein relate to an AI-based platform for enabling intelligent orchestration and management of power and energy, wherein the AI-based platform includes a supply graph neural network a set of nodes respectively representing at least one distributed energy resource (DER) configured to generate, store, convert, and/or transport energy, a demand graph neural network a set of nodes respectively representing at least one distributed energy resource (DER) configured to consume energy.

In some aspects, the techniques described herein relate to an AI-based platform for enabling intelligent orchestration and management of power and energy, wherein the AI-based platform includes at least one digital twin representing at least one distributed energy resource (DER), and a graph neural network including a set of nodes associated with at least one digital twin and a set of edges respectively interconnecting the set of nodes.

In some aspects, the techniques described herein relate to an AI-based platform for enabling intelligent orchestration and management of power and energy, wherein the AI-based platform includes a graph neural network including a set of nodes respectively representing at least one distributed energy resource (DER) and a set of edges respectively interconnecting the set of nodes, and an attention model that indicates at least one attention relationship among at least two nodes of the set of nodes of the graph neural network.

In some aspects, the techniques described herein relate to an AI-based platform for enabling intelligent orchestration and management of power and energy, wherein the AI-based platform includes a graph neural network including a set of nodes respectively representing at least one distributed energy resource (DER) and a set of edges respectively interconnecting the set of nodes, and a large language model configured to generate at least one description of the set of nodes and the set of edges included in the graph neural network.

### BRIEF DESCRIPTION OF THE DRAWINGS

The present disclosure will become more fully understood from the detailed description and the accompanying drawings.

FIG. 1 is a schematic diagram that presents an introduction of platform and main elements, according to some embodiments.

FIGS. 2A and 2B are schematic diagrams that present an introduction of main subsystems of a major ecosystem, according to some embodiments.

FIG. 3 is a schematic diagram that presents more detail on distributed energy generation systems, according to some embodiments.

FIG. 4 is a schematic diagram that presents more detail on data resources, according to some embodiments.

FIG. 5 is a schematic diagram that presents more detail on configured energy edge stakeholders, according to some embodiments.

FIG. 6 is a schematic diagram that presents more detail on intelligence enablement systems, according to some embodiments.

FIG. 7 is a schematic diagram that presents more detail on AI-based energy orchestration, according to some embodiments.

FIG. 8 is a schematic diagram that presents more detail on configurable data and intelligence, according to some embodiments.

FIG. 9 is a schematic diagram that presents a dual-process learning function of a dual-process artificial neural network, according to some embodiments.

FIGS. 10-37 are schematic diagrams of embodiments of neural net systems that may connect to, be integrated in, and be accessible by the platform for enabling intelligent transactions including ones involving expert systems, self-organization, machine learning, artificial intelligence and including neural net systems trained for pattern recognition, for classification of one or more parameters, characteristics, or phenomena, for support of autonomous control, and other purposes in accordance with embodiments of the present disclosure.

FIG. 38 is a schematic view of an exemplary embodiment of a quantum computing service according to some embodiments of the present disclosure.

FIG. 39 illustrates quantum computing service request handling according to some embodiments of the present disclosure.

FIG. 40 is a diagrammatic view of a thalamus service and how it coordinates within the modules in accordance with the present disclosure.

FIG. 41 is another diagrammatic view of a thalamus service and how it coordinates within the modules in accordance with the present disclosure.

FIG. 42 is a diagrammatic view of a determination of attention by a machine learning model in accordance with the present disclosure.

FIG. 43 is a diagrammatic view of a transformer model in accordance with the present disclosure.

FIG. 44 is a diagrammatic view of an energy edge converging technology stack in accordance with the present disclosure.

FIG. 45 is a diagrammatic view of a set of capabilities of an energy edge convergence technology stack in accordance with the present disclosure.

### DETAILED DESCRIPTION

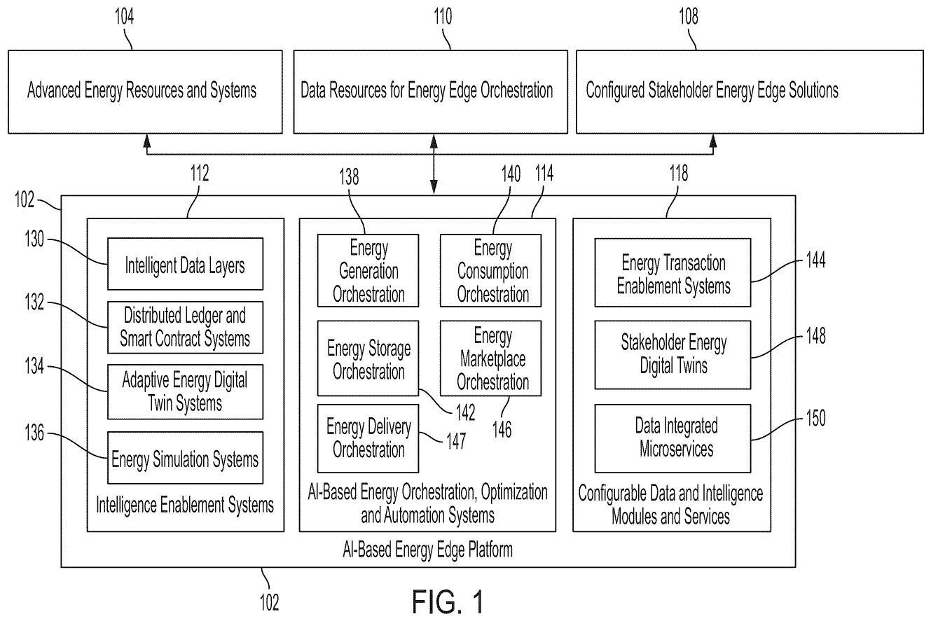

### FIG. 1: Introduction of Platform and Main Elements

In embodiments, provided herein is an AI-based energy edge platform, referred to herein for convenience in some cases as simply the platform 102, including a set of systems, subsystems, applications, processes, methods, modules, services, layers, devices, components, machines, products, sub-systems, interfaces, connections, and other elements working in coordination to enable intelligent, and in some cases autonomous or semi-autonomous, orchestration and management of power and energy in a variety of ecosystems and environments that include distributed entities (referred to herein in some cases as “distributed energy resources” or “DERs”) and other energy resources and systems that generate, store, consume, and/or transport energy and that include IoT, edge and other devices and systems that process data in connection with the DERs and other energy resources and that can be used to inform, analyze, control, optimize, forecast, and otherwise assist in the orchestration of the distributed energy resources and other energy resources.

By way of example, distributed energy resources (“DERs”) may include (without limitation): wind turbines (including wind turbine farms), solar photovoltaics (PV), flexible and/or floating solar energy systems (including solar energy farms), fuel cells (including natural-gas-fired fuel cells and biomass-fired fuel cells), coal mines, petroleum wells, natural gas wells, modular nuclear reactors, nuclear batteries, modular hydropower systems, microturbines and turbine arrays, reciprocating engines, combustion turbines, cogeneration plants, biomass generators, municipal solid waste incinerators, battery storage energy (including chemical batteries and others), capacitive energy storage, geothermal energy systems, molten salt energy storage, electro-thermal energy storage (ETES), gravity-based storage, compressed fluid energy storage, pumped hydroelectric energy storage (PHES), liquid air energy storage (LAES), coal storage facilities, petroleum storage tanks, natural gas storage tanks, liquefied natural gas (LNG) storage tanks, physical energy storage systems such as flywheels, gravity batteries (e.g., mass suspended in a gravity well), fuel transport vehicles, fuel transport pipelines, wired power transmission systems, wireless power transmission systems, or the like.

In embodiments, the platform 102 enables a set of configured stakeholder energy edge solutions 108, with a wide range of functions, applications, capabilities, and uses that may be accomplished, without limitation, by using or orchestrating a set of advanced energy resources and systems 104, including DERs and others. The set of configured stakeholder energy edge solutions 108 may integrate, for example, domain-specific stakeholder data, such as proprietary data sets that are generated in connection with enterprise operations, analysis and/or strategy, real-time data from stakeholder assets (such as collected by IoT and edge devices located in proximity to the assets and operations of the stakeholder), stakeholder-specific energy resources and systems 104 (such as available energy generation, storage, or distribution systems that may be positioned at stakeholder locations to augment or substitute for an electrical grid), and the like into a solution that meets the stakeholder's energy needs and capabilities, including baseline, period, and peak energy needs to conduct operations such as large-scale data processing, transportation, production of goods and materials, resource extraction and processing, heating and cooling, and many others.

In embodiments, the platform 102 (and/or elements thereof) and/or the set of configured stakeholder energy edge solutions 108 may take data from, provide data to and/or exchange data with a set of data resources for energy edge orchestration 110. The platform 102 obtains information from the set of data resources for the energy edge orchestration 110. These data resources may include datasets, ranging from real-time energy consumption metrics to predictive analytics on future energy demands. By using these resources, the platform 102 is able to make decisions that are both timely and informed. The platform 102 is also equipped to provide data back to the set of data resources for the energy edge orchestration 110. Such data may include feedback on energy optimization strategies, insights derived from AI analyses, and/or even raw data collected from various sensors and nodes within the energy infrastructure. This feedback loop ensures that the data resources remain updated, facilitating more accurate and dynamic energy management. Further, the set of configured stakeholder energy edge solutions 108, tailored to meet the unique needs of various stakeholders, can contribute data to and derive insights from the platform 102. By way of example, a stakeholder solution designed for a solar energy farm may provide real-time data on solar panel efficiency, which the platform 102 can then use to optimize energy distribution. Such data exchange between the platform 102, the set of configured stakeholder energy edge solutions 108, and the set of data resources for energy edge orchestration 110 ensures that optimizations are based on the most updated available data.

The platform 102 may include, integrate with, exchange data with and/or otherwise link to a set of intelligence enablement systems 112, a set of AI-based energy orchestration, optimization, and automation systems 114 and a set of configurable data and intelligence modules and services 118. The set of intelligence enablement systems 112 serves as the cognitive backbone of the platform 102. The set of intelligence enablement systems 112, utilizing advanced algorithms and computational tools, enable the platform 102 with the requisite intelligence to parse vast datasets, recognize patterns, and make informed decisions. The set of AI-based energy orchestration, optimization, and automation systems 114 ensures that the platform 102 achieves efficiency and adaptability. By orchestrating energy sources, optimizing energy flows, and automating processes, the set of AI-based energy orchestration, optimization, and automation systems 114 transform the platform 102 into a dynamic entity, responsive to real-time changes and proactive in its strategies. The set of configurable data and intelligence modules and services 118 provides the platform 102 with flexibility of modularity and customization. Depending on specific use-cases, stakeholders can configure these modules to cater to their unique requirements.

The set of intelligence enablement systems 112 may include a set of intelligent data layers 130 that manage and process information, a set of distributed ledger and smart contract systems 132 that ensure secure and transparent transactions and data management, a set of adaptive energy digital twin systems 134 that create virtual replicas of physical energy assets for better monitoring and optimization, and/or a set of energy simulation systems 136 that model potential energy scenarios to aid in decision-making. These integrated systems work collectively within the set of intelligence enablement systems 112 to provide a comprehensive solution for advanced energy management.

The set of AI-based energy orchestration, optimization, and automation systems 114 may include a set of energy generation orchestration systems 138 that manage and coordinate energy production sources, a set of energy consumption orchestration systems 140 that oversee and optimize how energy is used, a set of energy marketplace orchestration systems 146 that facilitate energy trading and transactions, a set of energy delivery orchestration systems 147 that ensure efficient and reliable energy distribution, and a set of energy storage orchestration systems 142 that manage the storage of energy. Together, these systems provide a holistic approach to orchestrating the entire energy lifecycle.

The set of configurable data and intelligence modules and services 118 may include a set of energy transaction enablement systems 144 that facilitate and streamline energy-related transactions, a set of stakeholder energy digital twins 148 that provide virtual representations of stakeholder-specific energy assets for better monitoring and management, and a set of data integrated microservices 150 that may enable or contribute to enablement of the set of configured stakeholder energy edge solutions 108, ensuring an integrated approach to energy management.

The platform 102 may include, integrate with, link to, exchange data with, be governed by, take inputs from, and/or provide outputs to one or more artificial intelligence (AI) systems, which may include models, rule-based systems, expert systems, neural networks, deep learning systems, supervised learning systems, robotic process automation systems, natural language processing systems, intelligent agent systems, self-optimizing and self-organizing systems, and others as described throughout this disclosure and in the documents incorporated by reference herein. Except where context specifically indicates otherwise, references to AI, or to one or more examples of AI, should be understood to encompass these various alternative methods and systems; for example, without limitation, an AI system described for enabling any of a wide variety of functions, capabilities and solutions described herein (such as optimization, autonomous operation, prediction, control, orchestration, or the like) should be understood to be capable of implementation by operation on a model or rule set; by training on a training data set of human tag, labels, or the like; by training on a training data set of human interactions (e.g., human interactions with software interfaces or hardware systems); by training on a training data set of outcomes; by training on an AI-generated training data set (e.g., where a full training data set is generated by AI from a seed training data set); by supervised learning; by semi-supervised learning; by deep learning; or the like. For any given function or capability that is described herein, neural networks of various types may be used, including any of the types described herein or in the documents incorporated by reference, and, in embodiments, a hybrid set of neural networks may be selected such that within the set a neural network type that is more favorable for performing each element of a multi-function or multi-capability system or method is implemented. As one example among many, a deep learning, or black box, system may use a gated recurrent neural network for a function like language translation for an intelligent agent, where the underlying mechanisms of AI operation need not be understood as long as outcomes are favorably perceived by users, while a more transparent model or system and a simpler neural network may be used for a system for automated governance, where a greater understanding of how inputs are translated to outputs may be needed to comply with regulations or policies.

### AI-Based Energy Orchestration, Optimization and Automation Systems

In embodiments, the platform 102 may employ demand forecasting, including automated forecasting by artificial intelligence or by taking a data stream of forecast information from a third party. Among other things, forecasting demand helps inform site selection and intelligently planned network expansion. In embodiments, machine learning algorithms may generate multiple forecasts—such as about weather, prices, solar generation, energy demand, and other factors—and analyze how energy assets can best capture or generate value at different times and/or locations.

In embodiments, the AI-based energy orchestration, optimization, and automation systems 114 may enable energy pattern optimization, such as by analyzing building or other operational energy usage and seeking to reshape patterns for optimization (e.g., by modeling demand response to various stimuli). By analyzing energy consumption trends, the AI-based energy orchestration, optimization, and automation systems 114 can identify areas of wastage or inefficiency. By way of example, they can evaluate how a building's energy consumption varies during different times of the day or in different seasons. Using this knowledge, the automation systems 114 can then reshape these patterns to achieve optimal energy usage. This may be applied in a commercial office building where the AI-based energy orchestration, optimization, and automation systems 114 may notice that energy consumption spikes during the early afternoon due to the simultaneous use of lighting, heating, and cooling systems. By modeling how the building may respond to certain stimuli, such as optimizing Heating, Ventilation, and Air Conditioning (HVAC) system based on real-time occupancy data, the AI-based energy orchestration, optimization, and automation systems 114 can suggest measures to distribute energy consumption more evenly throughout the day, thereby reducing peak demand and associated costs.

The AI-based energy orchestration, optimization, and automation systems 114 may be enabled by the set of intelligence enablement systems 112 that provide functions and capabilities that support a range of applications and use cases.

In embodiments, the platform 102 may be configured to integrate data from an at least one internal edge device located within an environment (e.g. sensors within a building, vehicle, machine, utility) and an at least one external edge device located outside the environment (e.g. sensors on weather monitoring stations broadcasting real-time data, vehicles, etc.). The platform 102 may collect real-time energy intelligence data and provide the real-time energy intelligence data to an intelligence circuit that is trained on the data and outcomes and automatically executes an action to optimize energy management. For example, an edge device connected to a DER may be taken in combination with an edge device from a local weather monitoring station. Local weather data (e.g. cloud cover, temperature, wind, precipitation, etc.) may be correlated with energy output from the DER, and a machine learning model may be trained to utilize variables from the second edge device to anticipate actions related to the environment of the first edge device. By way of further example, a radar signature output by the weather station edge device may be used to action a ramping up or down of energy from the DER.

In embodiments, data output from one or more edge devices may be vectorized and/or stored in a distributed database. Capturing energy data from devices may be optimized further through use of vector-based updating of the data in which only changes that impact a model of the consumption information are communicated. The vector may be developed based on the analysis of data from consuming devices described above. A vector for a composite energy consuming system may be a multi-dimensional vector that represents consumption type, purpose, device, and the like to form a highly efficient way of communicating complex energy usage environments. By way of example, consider a smart grid system where thousands of home appliances, HVAC systems, and lighting solutions are continuously sending energy consumption data. Instead of sending every minute detail, the system analyzes this data, and based on the consumption patterns, develops a vector. This vector, especially for a composite energy consuming system, may include various parameters like consumption type, the purpose of consumption, the specific device consuming energy, among others.

In embodiments, patterns of energy usage may include localized patterns, such as based on consumer's work-a-day schedule. However, patterns of energy usage may be based on a wider range of data, including weather forecast data; energy consumption in areas being currently affected by a weather system for preparing an area predicted to receive the weather system; and the like. Pattern analysis may include not only raw usage, but may include information about consumers (e.g., devices being operated that consume energy) that may impact learnings. By way of example, a consumer's work-a-day schedule, which may involve turning off all home appliances during working hours and increasing energy consumption in the evenings, may be a localized pattern which may be recognized and adapted to by the system.

Demographics and other human-based activity may play a role in energy pattern analysis. In an example, demographics of an area that suggest consumers replace older vehicles with new vehicles more frequently than in other areas may suggest that local energy demand for electric vehicle charging might increase sooner in such areas. When demographics and/or consumer behaviors suggest that consumers in a region tend to replace vehicles with used vehicles, then maintenance of legacy energy sourcing may be indicated as preferred for those areas.

### Subsystems and Modules of Intelligence Enablement Systems Intelligent Data Layers

The set of intelligence enablement systems 112 may include a set of intelligent data layers 130, such as a set of services (including microservices), APIs, interfaces, modules, applications, programs, and the like which may consume any of the data entities and types described throughout this disclosure and undertake a wide range of processing functions, such as extraction, cleansing, normalization, calculation, transformation, loading, batch processing, streaming, filtering, routing, parsing, converting, pattern recognition, content recognition, object recognition, and others. Through a set of interfaces, a user of the platform 102 may configure the set of intelligent data layers 130 or outputs thereof to meet internal platform needs and/or to enable further configuration, such as for the set of configured stakeholder energy edge solutions 108. The set of intelligent data layers 130, the set of intelligence enablement systems 112 more generally, and/or the configurable data and intelligence modules and services 118 may access data from various sources throughout the platform 102 and, in embodiments, may operate from the set of shared data resources, which may be contained in a centralized database and/or in a set of distributed databases, or which may consist of a set of distributed or decentralized data sources, such as IoT or edge devices that produce energy-relevant event logs or streams. The set of intelligent data layers 130 may be configured for a wide range of energy-relevant tasks, such as prediction/forecasting of energy consumption, generation, storage or distribution parameters (e.g., at the level of individual devices, subsystems, systems, machines, or fleets); optimization of energy generation, storage, distribution or consumption (also at various levels of optimization); automated discovery, configuration and/or execution of energy transactions (including microtransactions and/or larger transactions in spot and futures markets as well as in peer-to-peer groups or single counterparty transactions); monitoring and tracking of parameters and attributes of energy consumption, generation, distribution and/or storage (e.g., baseline levels, volatility, periodic patterns, episodic events, peak levels, and the like); monitoring and tracking of energy-related parameters and attributes (e.g., pollution, carbon production, renewable energy credits, production of waste heat, and others); automated generation of energy-related alerts, recommendations and other content (e.g., messaging to prompt or promote favorable user behavior); and many others.

In embodiments, the platform 102 may be configured to analyze a monitored energy data set and generate configuration recommendations for a distributed system to produce and consume energy. The platform 102 may be configured to analyze streams from one or more local power consumption entities and generate recommendations. For example, a manufacturing plant may have a set of needs that differ greatly from a hospital campus. As such, the AI-based platform may perform analysis of each of a plurality of energy consumption scenarios and related devices and demands, and recommend types of DERs for providing energy and conditioning energy corresponding to the needs and demands of the local power consumption entities. A hospital may have an ER that has a specific set of demands, such as times when an operating theater is open, or contingent demands based on emergencies. Examples of a monitored energy data set may include one or more of grid-based energy resources and mobile energy resources. Grid-based energy resources may include, for example, fossil fuel-based energy production facilities (coal, oil, natural gas, etc.), renewable energy-based production facilities (solar farms, wind farms, geothermal generators, tidal generators, hydroelectric power facilities, etc.) Mobile energy resources may include, for example, mobile battery installations, mobile fossil fuel-based generators, mobile renewable energy producers, mobile transformers and power conditioning systems, drone-based power delivery/storage systems, vehicle-based power delivery/storage systems, etc.

### Distributed Ledger and Smart Contract Systems

The set of intelligence enablement systems 112 may include a smart contract system 132 for handling a set of smart contracts, each of which may optionally operate on a set of blockchain-based distributed ledgers. Each of the smart contracts may operate on data stored in the set of distributed ledgers or blockchains, such as to record energy-related transactional events, such as energy purchases and sales (in spot, forward and peer-to-peer markets, as well as direct counterparty transactions), relevant service charges and the like; transaction relevant energy events, such as consumption, generation, distribution and/or storage events, and other transaction-relevant events often associated with energy, such as carbon production or abatement events, renewable energy credit events, pollution production or abatement events, and the like. The set of smart contracts handled by the smart contract system 132 may consume as a set of inputs any of the data types and entities described throughout this disclosure, undertake a set of calculations (optionally configured in a flow that takes inputs from disparate systems in a multi-step transaction), and provide a set of outputs that enable completion of a transaction, reporting (optionally recorded on a set of distributed ledgers), and the like. The set of energy transaction enablement systems 144 may be enabled or augmented by artificial intelligence, including to autonomously discover, configure, and execute transactions according to a strategy and/or to provide automation or semi-automation of transactions based on training and/or supervision by a set of transaction experts.

In embodiments, the smart contract systems 132 may be used by the set of energy transaction enablement systems 144 (described elsewhere in this disclosure) to configure transactional solutions. Each smart contract within the smart contract systems 132 is intricately designed to process data stored within these distributed ledgers or blockchains. The functionality of the smart contracts extends to documenting a variety of energy-associated transactional events. This includes, but is not limited to, recording peer-to-peer energy transactions and even direct transactions between parties. Furthermore, they capture data related to service charges and other transaction-relevant energy events, including information on energy consumption, generation, distribution, and storage. For example, a city's energy grid having integrated renewable energy sources, such as solar and wind, the smart contract systems 132 can autonomously execute contracts that purchase solar energy during peak sunlight hours and wind energy during windy periods. Simultaneously, it records each transaction, the associated service charges, and even the carbon offset achieved by using renewable sources.

### Adaptive Energy Digital Twin Systems

Any entity, analytic results, output of artificial intelligence, state, operating condition, or other feature noted throughout this disclosure may, in embodiments, be presented in a digital twin, such as the set of adaptive energy digital twin systems 134, which is widely applicable, and/or the set of stakeholder energy digital twins 148, which is configured for the needs of a particular stakeholder or stakeholder solution. The set of adaptive energy digital twin systems 134 may, for example, provide a visual or analytic indicator of energy consumption by a set of machines, a group of factories, a fleet of vehicles, or the like; a subset of the same (e.g., to compare energy parameters by each of a set of similar machines to identify out-of-range behavior); and many other aspects. A digital twin may be adaptive, such as to filter, highlight, or otherwise adjust data presented based on real-time conditions, such as changes in energy costs, changes in operating behavior, or the like.

In embodiments, the platform 102 may be configured to create, manage, and/or otherwise provide a dynamic digital twin of historical, current, and forecast distributed energy demand for both mobile and fixed entities within a domain based. For example, relatively large companies or organization settings may be modeled via digital twins, such as industrial environments, factory environments, distribution centers, hospital settings, university/college environments, office building settings, mining operations, etc. In a specific example, for a manufacturing facility with numerous machines, assembly lines, and automated systems, the platform 102 can create a digital twin of this environment, capturing every detail of its energy consumption patterns. Such digital twin can provide real-time information about the facility's energy demands, from the historical energy usage data of each machine to the present consumption rates, and even predictions about future energy needs based on forecasted production schedules. Larger environments may be modeled where the costs can be shifted significantly based on energy adjustments across entire environment. By way of example, in larger environments, where energy consumption is high, even minor adjustments can lead to substantial financial implications. By having a dynamic digital twin, stakeholders can simulate various energy adjustments and analyze their impact. By way of example, in an office building setting, adjusting the HVAC system's operation based on real-time occupancy data or optimizing lighting based on natural daylight availability can shift the energy costs considerably.

In embodiments, the platform 102 may be configured to model government entities via one or more digital twins, such as states, counties, cities, towns, developmental areas, communities, and the like. In an example, for a city, having thousands or hundreds of thousands of residents, businesses, public transport systems, and numerous amenities, the platform 102 can create a digital twin of such city, capturing every aspect of its energy consumption. This digital representation may include everything from the lighting in public parks, the HVAC systems in government buildings, to the energy demands of public transport systems. By doing so, the platform 102 offers city administrators a holistic view of the city's energy footprint, facilitating informed decisions on energy management. The platform 102 can even model larger entities like states or counties, capturing the diverse energy demands of various regions, from urban hubs to rural areas. On the other end, the platform 102 can also represent smaller entities, like towns. By way of example, in a new town which is being developed for industrial use, the platform 102 can model the expected energy demands based on planned industries, ensuring that the energy infrastructure is adequately prepared to meet the demand. In another example, a county planning to transition to renewable energy sources can utilize its digital twin to simulate the impact of integrating solar farms or wind turbines. This simulation can provide insights into potential energy savings, grid stability, and even the environmental benefits of such a transition.

In embodiments, the platform 102 may include an AI-based system for updating a digital twin based on set of energy parameters which may include adapting energy consumption data from a physical device for the digital twin based on the set of energy parameters, such as by adjusting a cost incurred for energy consumed based on a dynamic energy marketplace from which the device sources energy. By way of example, consider a device that sources its energy from a dynamic energy marketplace, where the cost of energy fluctuates based on demand, supply, and other market factors. If the device consumes energy at a time when costs are high, the AI-based system can adjust the digital twin to reflect this, ensuring that the virtual representation accurately mirrors the financial implications of real-world energy consumption. The AI-based system may also incorporate energy sourcing preferences of user(s) of the device (optionally as expressed in the device digital twin) when updating the device. By way of example, if a user, through their device's digital twin, has expressed a preference for green energy, the AI system ensures that this preference is factored into the energy consumption data updates. For a shared device (e.g., e-bike), energy consumed during and/or associated with a user share of the device (while the e-bike is checked out in the user's account) may be assigned to/across specific energy source(s) based on the user profile. For example, when a user checks out the e-bike on their user account, the energy consumed during their usage can be specifically sourced from their preferred energy source, as detailed in their user profile associated with the user account. Additionally or alternatively, an owner of the device and/or digital twin may identify an allocation of consumed energy to be assigned to each of a plurality of energy sources. By way of example, there may be scenarios where the owner of the device has specific allocations for consumed energy across multiple energy sources. In such cases, the AI system ensures that the digital twin reflects this allocation accurately. For example, an owner may specify that 50% of the energy consumed by a device should be sourced from wind energy and the remaining 50% from hydro energy. The AI system, when updating the digital twin, may ensure that this allocation is accurately represented. Thus, the platform 102, with its AI-based system, provides digital twins which are not just static representations but are dynamic, responsive, and tailored to individual preferences and real-world scenarios.

In embodiments, the AI-based system for updating a digital twin based on a set of energy parameters may include adapting energy production and/or allocation control for an upcoming time period (e.g., during an upcoming high-demand event and the like) based on the set of energy parameters. This may include relying on an AI-based forecast of energy demand for a future period of time to adjust how an energy sourcing system operates, such as energy parameters that determine how much energy to store versus generate and deliver, for example. By way of example, in a scenario where there is an anticipated high-demand event, perhaps due to a festival, the AI-based system, by analyzing the energy parameters, can predict this surge in demand and adapt the energy production and/or allocation controls accordingly. In another example, based on past data and current trends, the AI-based system may anticipate increased energy demand during the summer months. In addition to AI-based energy demand forecasts, an AI-based system may evaluate macro trends/activity based on the energy parameters. In an example, an AI-based system that updates an energy consumption system may detect pricing patterns that suggest energy costs may sharply increase (e.g., due to a major weather event, or the like), the set of energy parameters may guide the AI-based system to adapt energy consumption and/or storage guidance for at least select consumers (e.g., public systems (e.g., tax-based systems) so as to avoid unnecessary burden on taxpayers). By way of example, if the AI-based system detects patterns suggesting that energy costs may increase due to an upcoming major weather event, it can take preemptive measures. By analyzing the set of energy parameters, the AI-based system may guide certain consumers to adapt their energy consumption or storage patterns, or guide public systems to reduce consumption or increase storage. Thus, the platform 102, with its AI-based system, ensures that energy management is proactive and efficient.

In embodiments, the platform 102 may be configured to provide and/or facilitate digital twins of common device types (e.g., same model of e-bike). The digital twins may exchange consumption data across a range of instances of use to develop an understanding of how this common device type consumes energy in different environments, during different times of day, different geographies, demographics of users (including demographics local to a point of use). For example, an e-bike used predominantly in a hilly terrain may exhibit different energy consumption patterns compared to one used in a flat urban setting. The platform 102, by aggregating this data from various digital twins, can identify these patterns and make informed predictions. This can allow digital twins of specific devices (a specific e-bike) to better forecast energy demand leading to, among other things, dynamic recharging profiles. Some devices may be located in an area of high demand that suggests a need for more frequent charging, whereas others may be permitted to sustain a lower average energy charge due to, for example, shorter and less frequent utilization. For example, an e-bike stationed in a busy urban center may be identified to require frequent recharging due to high demand; on the other hand, another e-bike, perhaps stationed in a less frequented area, may operate optimally even without frequent recharging. This can also allow aggregation of demand profiles for a range of geographic areas to identify demand, such as recharging needs, available energy and the like. By way of example, in a locality with a high concentration of e-bikes (for example), the platform 102 may suggest staggered recharging schedules to balance the demand and prevent grid overloads. This can lead to management of charging activities for e-bikes, including demand balance of other rechargeable devices in an area.

In embodiments, the platform 102 may be configured such that not every physical instance of a device (e.g., a specific model e-bike) needs to have its own permanent digital twin. Most of these types of devices are dormant for significantly longer durations than they are in use (duty cycle is very sparse), so even energy demand for processing to support digital twins of these types of devices can be managed based on a demand profile. An instance of a physical device (or a configured genetic instance) can be activated (can be allocated energy resources) based on predictions of demand. Consider the scenario of a specific model of an e-bike. While these e-bikes may be scattered across various locations and be available for use all the time, their actual usage or “duty cycle” may be infrequent, with the devices lying dormant for extended periods. Understanding this unique characteristic, the platform 102 is configured in a way that instead of maintaining a continuous digital twin for each e-bike, the platform 102 can activate digital twins for these devices based on predicted demand. By way of example, in an urban setting, if the platform 102 predicts a surge in demand for e-bikes during, say, the morning rush hours, it can activate the digital twins for the e-bikes during such time. These digital twins can then facilitate energy management, ensuring that the e-bikes are charged and ready for use. Post the rush hour, these digital twins can be deactivated to conserve processing energy. This demand-driven approach ensures that energy resources for processing the digital twins are optimally utilized.

In embodiments, the platform 102 may provide and/or facilitate sharing, exchange, and/or aggregation of energy consumption data provided to digital twins by physical device instances that can be harvested to establish a set of energy demand parameters for predictive energy demand models, and the like. For example, the platform 102 is designed to facilitate the exchange and aggregation of energy consumption data from various physical device instances and channeled to their respective digital twins. By way of example, consider a neighborhood with multiple smart homes, each equipped with multiple smart devices. While each home may have its unique energy consumption patterns, the collective data from all these homes can reveal broader trends. The platform 102, by aggregating this data, may identify patterns like increased energy consumption during holiday seasons or reduced demand during vacation periods. These insights can then inform predictive models, ensuring that energy providers are well-prepared to meet the anticipated demands.

In embodiments, the platform 102 may be configured such that energy consumption data provided to digital twins can also facilitate prediction of energy-related demands, such as maintenance of energy providing infrastructure, and the like. For example, a need for addressing waste from energy production can be better predicted based on not only consumption, but supply sourcing that can be available to digital twins. In other words, not only does a physical device consume energy, but it must also be supplied with (or must generate its own) energy. Energy supply and/or sourcing can be used by digital twins to indicate times/regions/specific sources of energy production for support (waste removal, refurbishment, etc.). By way of example, if a local energy production facility predominantly relies on non-renewable sources, the associated waste generation would be higher. The digital twin, by predicting this, can ensure that adequate waste management measures are in place. Further, a digital twin of a local energy production facility can utilize predicted demand from energy consumption digital twins to address not only production, but up-the-chain sourcing. For example, if a predicted demand for (again using e-bikes as the example) e-bike utilization for upcoming event(s) (graduation, new student day, etc.) can be forecasted along with, for example, availability of solar produced energy expectations, local energy supply depots can source up-chain energy only if needed and/or as needed. By way of example, if the solar energy predictions are favorable, the depots can rely predominantly on solar energy, otherwise the depots can source energy from up-the-chain energy providers to meet the demand.

### Energy Simulation Systems

In embodiments, a set of energy simulation systems 136 is provided, such as to develop and evaluate detailed simulations of energy generation, demand response and charge management, including a simulation environment that simulates the outcomes of use of various algorithms that may govern generation across various generations assets, consumption by devices and systems that demand energy, and storage of energy. Data can be used to simulate the interaction of non-controllable loads and optimized charging processes, among other use cases. The simulation environment may provide output to, integrate with, or share data with the set of adaptive energy digital twin systems 134. By way of example, if a city plans to transition to renewable energy sources, the city can use the set of energy simulation systems 136 to simulate various outcomes. This simulation can predict how solar panels may respond to varying weather conditions, how wind turbines may operate during different seasons, or how energy storage solutions may need to be managed during peak demand periods.

In embodiments, as more enterprises embrace hybrid infrastructure, uptime is becoming more complex, requiring backup and failover strategies that span cloud, colocation, on-premises facilities, and edge infrastructure. This may include AI-based algorithms for automatically managing energy for devices and systems in such devices. For example, artificial intelligence may enable autonomous data center cooling and industrial control. In embodiments, distributed energy resources, or DERs 128, may be integrated into or with, for example, AI-driven computing infrastructure, smart Power Distribution Units (PDUs), Uninterrupted Power Supply (UPS) systems, energy-enabled air flow management systems, and HVAC systems, among others. By simulating energy scenarios, the set of energy simulation systems 136 ensures that enterprises, irrespective of their infrastructure model, operate seamlessly and sustainably.

### Introduction of Main Subsystems and Modules of AI-Based Energy Orchestration, Optimization, and Automation Systems

The set of AI-based energy orchestration, optimization, and automation systems 114 may include the set of energy generation orchestration systems 138, the set of energy consumption orchestration systems 140, the set of energy storage orchestration systems 142, the set of energy marketplace orchestration systems 146 and the set of energy delivery orchestration systems 147, among others. For example, the set of energy delivery orchestration systems 147 may enable orchestration of the delivery of energy to a point of consumption, such as by fixed transmission lines, wireless energy transmission, delivery of fuel, delivery of stored energy (e.g., chemical or nuclear batteries), or the like, and may involve autonomously optimizing the mix of energy types among the foregoing available resources based on various factors, such as location (e.g., based on distance from the grid), purpose or type of consumption (e.g., whether there is a need for very high peak energy delivery, such as for power-intensive production processes), and the like. Consider a remote industrial unit located far from the main grid, requiring power for its production processes. The set of energy generation orchestration systems 138 may analyze the location and determine that connecting such unit to the main grid may not be feasible. Instead, the set of energy generation orchestration systems 138 may suggest that a combination of wireless energy transmission and delivery of chemical batteries may be most suitable in this case.

### Configurable Data and Intelligence Modules and Services

In embodiments, the platform 102 may include a set of configurable data and intelligence modules and services 118. These may include a set of energy transaction enablement systems 144, a set of stakeholder energy digital twins 148, a set of data integrated microservices 150, and others. Each module or service (optionally configured in a microservices architecture) may exchange data with the various data resources in order to provide a relevant output, such as to support a set of internal functions or capabilities of the platform 102 and/or to support a set of functions or capabilities of one or more of the set of configured stakeholder energy edge solutions 108. As one example among many, a service may be configured to take event data from an IoT device that has cameras or sensors that monitor a generator and integrate it with weather data from public data resources 162 to provide a weather-correlated timeline of energy generation data for the generator, which in turn may be consumed by a set of configured stakeholder energy edge solutions 108, such as to assist with forecasting day-ahead energy generation by the generator based on a day-ahead weather forecast. A wide range of such configured data and intelligence modules and services 118 may be enabled by the platform 102, representing, for example, various outputs that consist of the fusion or combination of the wide range of energy edge data sources handled by the platform, higher-level analytic outputs resulting from expert analysis of data, forecasts and predictions based on patterns of data, automation and control outputs, and many others.

In embodiments, the platform 102 may be configured such that energy consumption devices and/or systems (e.g., a set of energy consuming devices in a household) may arbitrate locally for access to energy sources, such as main line energy, first level stored energy (e.g., at a device), local stored energy (e.g., a local battery that can source energy to a plurality of devices), and the like. Also, devices may consume energy for a range of purposes, consumption, storage, balancing sourcing, acting as a proxy for other devices, and the like. Yet further, energy consuming devices may be configured/configurable to use a plurality of energy types, such as electric grid, solar, geothermal, fossil fuel (combustion engine), hydrogen, and the like. Also, within an energy consumption system (set of devices as noted above) energy consumption may span a range of energy sources (e.g., hydrogen for cooking, solar for energy storage, waste energy recovery, and the like). By way of example, consider a household equipped with multiple energy-consuming devices, each with its unique energy demands and preferences. The platform 102 can facilitate a dynamic environment where these devices can locally arbitrate for access to various energy sources based on their immediate needs and available resources. By way of example, on a sunny day, solar panels in a house may be generating excess energy, in such case, the platform 102 may utilize energy primarily from the solar panels, reducing energy consumption from the grid.

In embodiments, the platform 102 may capture the energy consumption information from/via the edge devices and develop a data set that represents a plurality of perspectives regarding consumed energy. Edge devices that may communicate (e.g., locally or in close proximity) with a range of energy consuming devices and device types may collect data about the devices, including, for example, what sources can the devices consume, what source have the devices consumed, purpose/use of the consumed energy, and the like. Further examples may include whether it appear as if the devices performing any sort of optimization, such as utilizing local storage during high energy cost periods (including high transmission costs which might be measured based on efficiencies of the delivery and the like), consuming energy for replenishing storage during off-peak times, and/or utilizing low cost sources (e.g., solar) when readily available. A wide range of analytics may be generated, captured, used in an energy management system, and the like. By way of example, consider a smart plug connected to a refrigerator which can provide insights into energy consumption patterns thereof, revealing details like its preference for utilizing local storage during high energy cost periods. By aggregating this data from various edge devices, the platform 102 can identify patterns, predict future energy demands, and optimize energy consumption across devices.

### Energy Transaction Enablement Systems

Configurable data and intelligence modules and services 118 may include a set of energy transaction enablement systems 144. The set of energy transaction enablement systems 144 may include a set of smart contracts, which may operate on data stored in a set of distributed ledgers or blockchains, such as to record energy-related transactional events, such as energy purchases and sales (in spot, forward and peer-to-peer markets, as well as direct counterparty transactions) and relevant service charges; transaction relevant energy events, such as consumption, generation, distribution and/or storage events, and other transaction-relevant events often associated with energy, such as carbon production or abatement events, renewable energy credit events, pollution production or abatement events, and the like. The set of smart contracts may consume as a set of inputs any of the data types and entities described throughout this disclosure, undertake a set of calculations (optionally configured in a flow that takes inputs from disparate systems in a multi-step transaction), and provide a set of outputs that enable completion of a transaction, reporting (optionally recorded on a set of distributed ledgers), and the like. The set of energy transaction enablement systems 144 may be enabled or augmented by artificial intelligence, including to autonomously discover, configure, and execute transactions according to a strategy and/or to provide automation or semi-automation of transactions based on training and/or supervision by a set of transaction experts. Autonomy and/or automation (supervised or semi-supervised) may be enabled by robotic process automation, such as by training a set of intelligent agents on transactional discovery, configuration, or execution interactions of a set of transactional experts with transaction-enabling systems (such as software systems used to configure and execute energy trading activities).

As energy is increasingly produced and consumed in local, decentralized markets, the energy market is likely to follow patterns of other peer-to-peer or shared economy markets, such as ride sharing, apartment sharing and used goods markets. Technology enables the bypassing of top-down or centralized energy supply and enables operators to create platforms that can manage and monetize spare capacity, such as through the leasing and trading of assets and outputs.

As more distributed or peer-to-peer transactive energy markets develop, the platform 102 may include systems or link to, integrate with, or enable other platforms that facilitate P2P trading, wholesale contracts, renewable energy certificate (REC) tracking, and broader distributed energy provisioning, payment management and other transaction elements. In embodiments, the foregoing may use blockchain, distributed ledger and/or smart contract systems 132. By way of example, a homeowner with excess solar energy may decide to sell this surplus energy. This transaction gets securely recorded on the blockchain.

In embodiments, with increased transparency, choice, and flexibility, consumers will be able to participate actively in energy markets, by generating, storing, and selling, as well as consuming electricity. By way of example, a local community may decide to capitalize on its collective solar energy generation. The platform 102 enables homes with solar panels to trade their excess energy with those without, ensuring that the entire community benefits.

In embodiments, transactional elements may be configured by a set of energy transaction enablement systems 144 to optimize energy generation, storage, or consumption, such as utility time of use charges. Shifting energy demand away from high-priced time periods with IoT-based platforms that can identify periods where energy costs are the least expensive. By way of example, in regions where utility charges vary based on the time of use, the platform 102 can shift energy demand to periods when energy is cheaper. In an example, smart home devices, linked to the platform 102, can identify periods when energy costs are lowest and adjust their operations accordingly, ensuring efficient and cost-effective energy consumption.

### Stakeholder Energy Digital Twins

The configurable data and intelligence modules and services 118 may include a set of stakeholder energy digital twins 148, which may, in embodiments, include set of digital twins that are configured to represent a set of stakeholder entities that are relevant to energy, including stakeholder-owned and stakeholder-operated energy generation resources, energy distribution resources, and/or energy distribution resources (including representing them by type, such as indicating renewable energy systems, carbon-producing systems, and others); stakeholder information technology and networking infrastructure entities (e.g., edge and IoT devices and systems, networking systems, data centers, cloud data systems, on premises information technology systems, and the like); energy-intensive stakeholder production facilities, such as machines and systems used in manufacturing; stakeholder transportation systems; market conditions (e.g., relating to current and forward market pricing for energy, for the stakeholder's supply chain, for the stakeholders product and services, and the like), and others. The set of stakeholder energy digital twins 148 may provide real-time information, such as provided sensor data from IoT and edge devices, event logs, and other information streams, about status, operating conditions, and the like, particularly relating to energy consumption, generation, storage, and or distribution.

The set of stakeholder energy digital twins 148 may provide a visual, real-time view of the impact of energy on all aspects of an enterprise. A digital twin may be role-based, such as providing visual and analytic indicators that are suitable for the role of the user, such as financial reporting information for a Chief Financial Officer (CFO); operating parameter information for a power plant manager; and energy market information for an energy trader. A CFO, by way of example, may need a visual representation highlighting the financial cost of energy consumption, like how shifting operations to off-peak hours impacts the energy cost. In contrast, a power plant manager may be more interested in operational parameters, like the efficiency of the energy generation resources. An energy trader, on the other hand, may want insights into the energy market, like tracking prices. Thus, by offering insights tailored to individual roles, the set of stakeholder energy digital twins 148 ensures that different stakeholders have the relevant information they need to make informed decisions.

### Data Integrated Microservices

The configurable data and intelligence modules and services 118 may include a set of data integrated microservices 150, such as organized in a service-oriented architecture, such that various microservices can be grouped in series, in parallel, or in more complex flows to create higher-level, more complex services that each provide a defined set of outputs by processing a defined set of outputs, such as to enable a set of configured stakeholder energy edge solutions 108 or to facilitate AI-based orchestration, optimization and/or automation systems 114. The configurable data and intelligence modules and services 118 may, without limitation, be configured from various functions and capabilities of the set of intelligent data layers 130, which in turn operate on various data resources for energy edge orchestration 110 and/or internal event logs, outputs, data streams and the like of the platform 102.

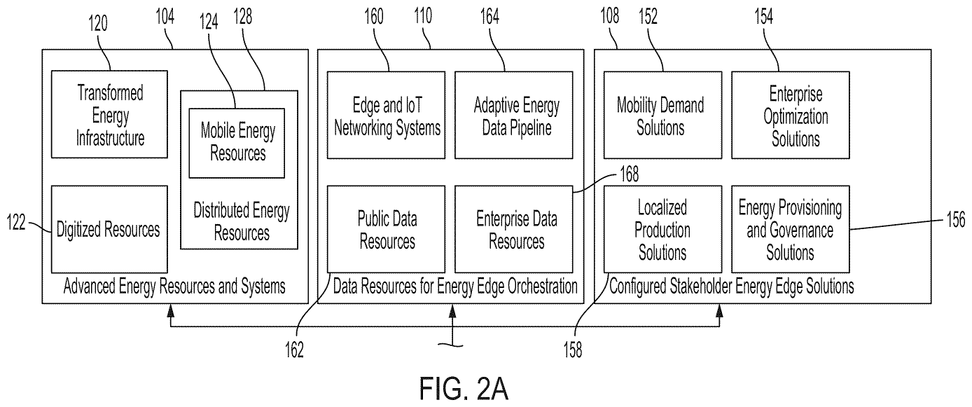

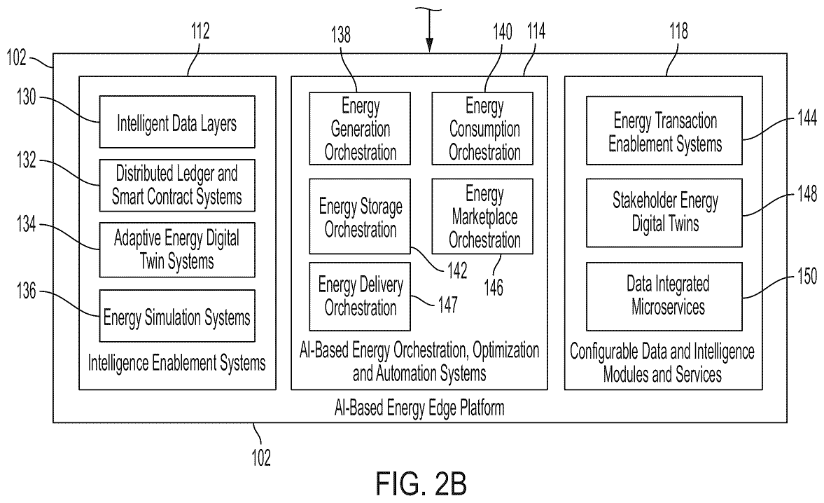

### FIGS. 2A and 2B: Introduction of Main Subsystems of Major Ecosystem Components Data Resources for Energy Edge Orchestration

Referring to FIG. 2A, the data resources for energy edge orchestration 110 may include a set of edge and IoT networking systems 160, public data resources 162, and/or a set of enterprise data resources 168, which in embodiments may use or be enabled by an adaptive energy data pipeline 164 that automatically handles data processing, filtering, compression, storage, routing, transport, error correction, security, extraction, transformation, loading, normalization, cleansing and/or other data handling capabilities involved in the transport of data over a network or communication system. This may include adapting one or more of these aspects of data handling based on data content (e.g., by packet inspection or other mechanisms for understanding the same), based on network conditions (e.g., congestion, delays/latency, packet loss, error rates, cost of transport, quality of service (QoS), or the like), based on context of usage (e.g., based on user, system, use case, application, or the like, including based on prioritization of the same), based on market factors (e.g., price or cost factors), based on user configuration, or other factors, as well as based on various combinations of the same. For example, among many others, a least-cost route may be automatically selected for data that relates to management of a low-priority use of energy, such as heating a swimming pool, while a fastest or highest-QoS route may be selected for data that supports a prioritized use or energy, such as support of critical healthcare infrastructure.

Referring to FIG. 2B, the platform 102 and orchestration may include, integrate, link to, integrate with, use, create, or otherwise handle, a wide range of data resources for the advanced energy resources and systems 104, the set of configured stakeholder energy edge solutions 108, and/or the energy edge orchestration 110. In embodiments, elements of the advanced energy resources and systems 104, the set of configured stakeholder energy edge solutions 108, and/or the energy edge orchestration 110 may be the same as, similar to, or different from corresponding elements shown in FIG. 1. The data resources may include separate databases, distributed databases, and/or federated data resources, among many others.

### Edge and IoT Networking Systems

A wide range of energy-related data may be collected and processed (including by artificial intelligence services and other capabilities), and control instructions may be handled, by a set of edge and IoT networking systems 160, such as ones integrated into devices, components or systems, ones located in IoT devices and systems, ones located in edge devices and systems, or the like, such as where the foregoing are located in or around energy-related entities, such as ones used by consumers or enterprises, such as ones involved in energy generation, storage, delivery or use. These include any of the wide range of software, data and networking systems described herein.

### Public Data Resources

In embodiments, the platform 102 may track public data resources 162, such as weather data. Weather conditions can impact energy use, particularly as they relate to HVAC systems. Collecting, compiling, and analyzing weather data in connection with other building information allows building managers to be proactive about HVAC energy consumption. The public data resources 162 may include satellite data, demographic and psychographic data, population data, census data, market data, website data, ecommerce data, and many other types.

### Enterprise Data Resources

A set of enterprise data resources 168 may include a wide range of enterprise resources, such as enterprise resource planning data, sales and marketing data, financial planning data, accounting data, tax data, customer relationship management data, demand planning data, supply chain data, procurement data, pricing data, customer data, product data, operating data, and many others.

### Subsystems and Modules of Advanced Energy Resources and Systems

In embodiments, the advanced energy resources and systems 104 may include distributed energy resources, or DERs 128. More decentralized energy resources will mean that more individuals, networked groups, and energy communities will be capable of generating and sharing their own energy and coordinating systems to achieve ultimate efficacy. The DER 128 may be a small- or medium-scale unit of power generation and/or storage that operates locally and may be connected to a larger power grid at the distribution level. For example, the DERs 128 may be either connected to the local electric power grid or isolated from the grid in stand-alone applications.

### Transformed Energy Infrastructure

The advanced energy resources and systems 104 orchestrated by the platform 102 may include a set of transformed energy infrastructure systems 120. The energy edge will involve increasing digitalization of generation, transmission, substation, and distribution assets, which in turn will shape the operations, maintenance, and expansion of legacy grid infrastructure. In embodiments, a set of transformed energy infrastructure systems 120 may be integrated with or linked to the platform 102. The transition to improved infrastructure may include moving from SCADA systems and other existing control, automation, and monitoring systems to IoT platforms with advanced capabilities.

In embodiments, new assets added to or coordinated with the grid (e.g., DERs 128) may be compatible with existing infrastructure to maintain voltage, frequency, and phase synchronization. By way of example, consider a city that is incorporating renewable energy sources like wind turbines and solar panels (DERs 128) into its existing power grid. These new assets need to integrate with the older infrastructure to ensure consistent power delivery. This compatibility ensures that even as the city transitions to greener energy sources, residents experience no fluctuations in voltage, frequency, or phase synchronization, ensuring a stable power supply.

Any improvements to legacy grid assets, new grid-connected equipment, and supporting systems may, in embodiments, comply with regulatory standards from NERC, FERC, NIST, and other relevant authorities; positively impact the reliability of the grid; reduce the grid's susceptibility to cyberattacks and other security threats; increase the ability of the grid to adapt to extensive bi-directional flow of energy (i.e., DER proliferation); and offer interoperability with technologies that improve the efficiency of the grid (i.e., by providing and promoting demand response, reducing grid congestion, etc.).

Digitalization of legacy grid assets may relate to assets used for generation, transmission, storage, distribution or the like, including power stations, substations, transmission wires, and others.

In embodiments, in order to maintain and improve existing energy infrastructure, the platform 102 may include various capabilities, including fully integrated predictive maintenance across utility-owned assets (i.e., generation, transmission, substations, and distribution); smart (AI/ML-based) outage detection and response; and/or smart (AI/ML-based) load forecasting, including optional integration of the DERs 128 with the existing grid. By way of example, consider a scenario where a utility company has a network of power generation and distribution assets, some of which are decades old. To ensure the longevity and efficiency of these assets, the platform 102 can offer predictive maintenance, alerting the utility company about potential issues before they become critical.

In embodiments, power grid maintenance may be provided. With proactive maintenance, utilities can accurately detect defects and reduce unplanned outages to better serve customers. AI systems, deployed with IoT and/or edge computing, can help monitor energy assets and reduce maintenance costs. By way of example, if a transmission line shows signs of wear and tear, the platform 102 can alert the utility company for timely repair. This proactive approach not only reduces unplanned outages but also reduce maintenance costs, leading to a more efficient and cost-effective power grid.

### Digitized Resources

In embodiments, the platform 102 may take advantage of the digital transformation of a wide range of digitized resources. Machines are becoming smarter, and software intelligence is being embedded into every aspect of a business, helping drive new levels of operational efficiency and innovation. Also, digital transformation is ongoing, involving increasing presence of smart devices and systems that are capable of data processing and communication, nearly ubiquitous sensors in edge, IoT and other devices, and generation of large, dense streams of data, all of which provide opportunities for increased intelligence, automation, optimization, and agility, as information flows continuously between the physical and digital world. Such devices and systems demand large amounts of energy. Data centers, for example, consume massive amounts of energy, and edge and IoT devices may be deployed in off-grid environments that require alternative forms of generation, storage, or mobility of energy. In embodiments, a set of digitized resources may be integrated, accessed, or used for optimization of energy for compute, storage, and other resources in data centers and at the edge, among other places. In embodiments, as more and more devices are embedded with sensors and controls, information can flow continuously between the physical and digital worlds as machines ‘talk’ to each other. Products can be tracked from source to customer, or while they are in use, enabling fast responses to internal and external changes. Those tasked with managing or regulating such systems can gain detailed data from these devices to optimize the operation of the entire process. This trend turns big data into smart data, enabling significant cost- and process efficiencies.

In embodiments, advances in digital technologies enable a level of monitoring and operational performance that was not previously possible. Thanks to sensors and other smart assets, a service provider can collect a wide range of data across multiple parameters, monitoring in real-time, 24 hours a day.

In embodiments, the DERs 128 will be integrated into computational networks and infrastructure devices and systems, augmenting the existing power grid and serving to decrease costs and improve reliability. For example, the platform 102 by integrating DERs 128, such as localized solar farms or wind turbines, into a city infrastructure can significantly augment the existing power grid. By way of example, during peak demand times, rather than solely relying on traditional power plants, the platform 102 can enable energy management system of the city to utilize localized energy sources, which may, in turn, reduce the strain on the main grid and can also lead to substantial cost savings.

### Mobile Energy Resources

In embodiments, DERs may be integrated into mobile energy resources 124, such as electric vehicles (EVs) and their charging networks/infrastructure, thereby augmenting the existing power grid and serving to decrease costs and improve reliability. Given the rise of EVs (of all types) charging infrastructure and vehicle charging plans will need to be optimized to match supply and demand. Also, growing electricity demand and development of EV infrastructure will require optimization using edge and other related technologies such as IoT. Electric vehicle charging may be integrated into decentralized infrastructure and may even be used as the DER 128 by adding to the grid, such as through two-way charging stations, or by powering another system locally. Vehicle power electronic systems and batteries can benefit the power grid by providing system and grid services. Excess energy can be stored in the vehicles as needed and discharged when required. This flexibility option not only avoids expensive load peaks during times of short-term, high-energy demand but also increases the share of renewable energy use.

In embodiments, in order to universally integrate electric vehicles and charging infrastructure into a distribution network, coordination with various other standardized communication protocols is needed. The platform 102 may include, integrate and/or link to a set of communication protocols that enable management, provisioning, governance, control or the like of energy edge devices and systems using such protocols. Herein, the platform 102 can serve as a central hub, integrating various protocols, ensuring that when an EV docks at a charging station, the communication between the vehicle, the station, and the grid is smooth, efficient, and coordinated.

### Configured Stakeholder Energy Edge Solutions

The set of configured stakeholder energy edge solutions 108 may include a set of mobility demand solutions 152, a set of enterprise optimization solutions 154, a set of energy provisioning and governance solutions 156, and/or a set of localized production solutions 158, among others, that use various advanced energy resources and systems 104 and/or various configurable data and intelligence modules and services 118 to enable benefits to particular stakeholders, such as private enterprises, non-governmental organizations, independent service organizations, governmental organizations, and others. All such solutions may leverage edge intelligence, such as using data collected from onboard or integrated sensors, IoT systems, and edge devices that are located in proximity to entities that generate, store, deliver and/or use energy to feed models, expert systems, analytic systems, data services, intelligent agents, robotic process automation systems, and other artificial intelligence systems into order to facilitate a solution for a particular stakeholder needs. By way of example, in the case of a city, the set of mobility demand solutions 152 can be utilized to predict peak travel times and adjust public transport schedules accordingly. Similarly, in case of a large corporate campus, the set of enterprise optimization solutions 154 can be utilized to manage its energy consumption, ensuring that office buildings are adequately powered during work hours while conserving energy during off-hours.

### Enterprise Optimization Solutions

In embodiments, the DERs 128 will be integrated with or into enterprises and shared resources, augmenting the existing power grid and serving to decrease costs and improve reliability. Increasing levels of digitalization will help integrate activities and facilitate new ways of optimizing energy in buildings/operations, and across campuses and enterprises. By way of example, by integrating the DERs 128, the campus can supplement its power needs with renewable sources. Digitalization of energy management can help the campus monitor and adjust its energy consumption in real-time. In embodiments, this may enable increasing the operational bottom line of a for-profit enterprise by leveraging big data and plug load analytics to efficiently manage buildings. For example, the campus can manage its buildings efficiently, ensuring that energy is used where needed, optimizing operational costs.

In embodiments, IoT sensors and building automation control systems may be configured to assist in optimizing floor space, identifying unused equipment, automating efficient energy consumption, improving safety, and reducing environmental impact of buildings. By way of example, in a multi-storied office building equipped with IoT sensors and building automation control systems, these systems can monitor each floor's energy consumption, ensuring that lighting and HVAC systems are optimized for the number of occupants. In an example, unused conference rooms can automatically switch off lights and adjust temperatures, reducing energy wastage.

In embodiments, the platform 102 may manage total energy consumption of systems and equipment connected to the electrical network or to a set of DERs 128. Some systems are almost always operational, while other pieces of equipment and machinery may be connected only occasionally. By maintaining an understanding of both the total daily electrical consumption of a building and the role individual devices play in the overall energy use of a specific system, the platform 102 may forecast, provision, manage and control, optionally by AI or algorithm, the total consumption. For example, the platform 102, through AI and algorithms, can monitor and adjust energy consumption based on the specific needs of each building, optimizing energy use.

In embodiments, the platform 102 may track and leverage an understanding of occupants' behavior. Activity levels, behavior patterns, and comfort preferences of occupants may be a consideration for energy efficiency measures. This may include tracking various cyclical or seasonal factors. Over time, a building's energy generation, storage and/or consumption may follow predictable patterns that an IoT-based analytics platform can take into consideration when generating proposed solutions. By way of example, during winter, if the platform notices residents tend to stay in during evenings, it can adjust heating accordingly. Over time, the system learns from these patterns, ensuring energy is used efficiently.

In embodiments, the platform 102 may enable or integrate with systems or platforms for autonomous operations. For example, industrial sites, such as oil rigs and power plants, require extensive monitoring for efficiency and safety because liquid, steam, or oil leakages can be catastrophic, costly, and wasteful. AI and machine learning may provide autonomous capabilities for power plants, such as those served by edge devices, IoT devices, and onsite cameras and sensors. Models may be deployed at the edge in power plants or on DERs 128, such as to use real-time inferencing and pattern detection to identify faults, such as leaks, shaking, stress, or the like. Operators may use computer vision, deep learning, and intelligent video analytics (IVA) to monitor heavy machinery, detect potential hazards, and alert workers in real-time to protect their health and safety, prevent accidents, and assign repair technicians for maintenance. By way of example, in a factory with multiple machines, the platform 102, through AI and machine learning, can monitor the health of the machines in real-time, predicting potential weak points, and suggesting timely maintenance and repair.

In embodiments, the platform 102 may enable or integrate with systems or platforms for pipeline optimization. For example, oil and gas enterprises may rely on finding the best-fit routes to transfer oil to refineries and eventually to fuel stations. Edge AI can calculate the optimal flow of oil to ensure reliability of production and protect long-term pipeline health. In embodiments, enterprises can inspect pipelines for defects that can lead to dangerous failures and automatically alert pipeline operators.

### Energy Provisioning and Governance Solutions

The energy provisioning and governance solutions 156 may include solutions for governance of mining operations. Cobalt, nickel, and other metals are fundamental components of the batteries that will be needed for the green EV revolution. Amounts required to support the growing market will create economic pressure on mining operations, many of which take place in regions like the DRC where there is long history of corruption, child labor, and violence. Companies are exploring areas like Greenland for cobalt, in part on the basis that it can offer reliable labor law enforcement, taxation compliance, and the like. Such promises can be made there and in other jurisdictions with greater reliability through a set of mining governance solutions 542. The set of mining governance solutions 542 may include mine-level IoT sensing of the mine environment, ground-penetrating sensing of unmined portions, mass spectrometry and computer vision-based sensing of mined materials, asset tagging of smart containers (e.g., detecting and recording opening and closing events to ensure that the material placed in a container is the same material delivered at the end point), wearable devices for detecting physiological status of miners, secure (e.g., blockchain- and DLT-based) recording and resolution of transactions and transaction-related events, smart contracts for automatically allocating proceeds (e.g., to tax authorities, to workers, and the like), and an automated system for recording, reporting, and assessing compliance with contractual, regulatory, and legal policy requirements. All of the above, from base sensors to compliance reports can be optionally represented in a digital twin that represents each mine owner or operated by an enterprise.

The energy provisioning and governance solutions 156 may also include a set of carbon-aware energy solutions, where controls for operating entities that generate (or capture) carbon are managed by data collection through edge and IoT devices about current carbon generation or emission status and by automated generation of a set of recommendations and or control instructions to govern the operating entities to satisfy policies, such as by keeping operations within a range that is offset by available carbon offset credits, or the like.

More detail on a variety of energy provisioning and governance solutions 156 is provided below.

### Localized Production Solutions

In embodiments, a set of localized production solutions 158 may be integrated with, linked to, or managed by the platform 102, such that localized production demand can be met, particularly for goods that are very costly to transport (e.g., food) or services where the cost of energy distribution has a large adverse impact on product or service margins (e.g., where there is a need for intensive computation in places where the electrical grid is absent, lacks capacity, is unreliable, or is too expensive). The platform 102 can manage the energy consumption of the set of localized production solutions 158, optimizing usage based on available resources, especially in places where the conventional electrical grid may be absent or unreliable.

In embodiments, power management systems may converge with other systems, such as building management systems, operational management systems, production systems, services systems, data centers, and others to allow for enterprise-wide energy management. The platform 102 by converging power management with the building management systems, the operational management systems, the production systems, the services systems, the data centers, and the like, can ensure that energy is used optimally across the board in the enterprise. For example, during off-hours, while the building management system reduces lighting, the data center can shift its heavy computations, balancing the overall energy load.

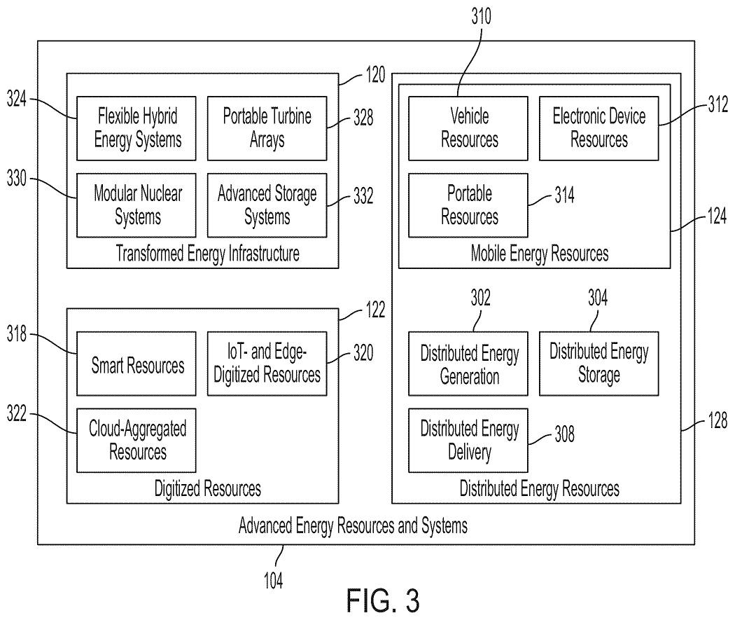

### FIG. 3: More Detail on Distributed Energy Generation Systems

Referring to FIG. 3, a distributed energy generation systems 302 may include wind turbines, solar photovoltaics (PV), flexible and/or floating solar systems, fuel cells, modular nuclear reactors, nuclear batteries, modular hydropower systems, microturbines and turbine arrays, reciprocating engines, combustion turbines, and cogeneration plants, among others. The distributed energy storage systems 304 may include battery storage energy (including chemical batteries and others), molten salt energy storage, electro-thermal energy storage (ETES), gravity-based storage, compressed fluid energy storage, pumped hydroelectric energy storage (PHES), and liquid air energy storage (LAES), among others. The distributed energy storage systems 304 may be managed by the platform 102. In embodiments, the distributed energy storage systems 304 may be portable, such that units of energy may be transported to points of use, including points of use that are not connected to the conventional grid or ones where the conventional grid does not fully satisfy demand (e.g., where greater peak power, more reliable continuous power, or other capabilities are needed). Management may include the integration, coordination, and maximizing of return-on-investment (ROI) on distributed energy resources (DERs), while providing reliability and flexibility for energy needs.

In embodiments, the DERs 128 may use various distributed energy delivery methods and systems 308 having various energy delivery capabilities, including transmission lines (e.g., conventional grid and building infrastructure), wireless energy transmission (including by coupled, resonant transfer between high-Q resonators, near-field energy transfer and other methods), transportation of fluids, batteries, fuel cells, small nuclear systems, and the like), and others.

The mobile energy resources 124 include a wide range of resources for generation, storage, or delivery of energy at various scales; accordingly, the mobile energy resources 124 may comprise a subcategory of the DERs 128 that have attributes of mobility, such as where the mobile energy resources 124 are integrated into a vehicle 310 (e.g., an electric vehicle, hybrid electric vehicle, hydrogen fuel cell vehicle, or the like, and in embodiments including a set of autonomous vehicles, which may be unmanned autonomous vehicles (UAVs), drones, or the like); where resources are integrated into or used by a mobile electronic device 312, or other mobile system; where the mobile energy resources 124 are portable resources 314 (including where they are removable and replaceable from a vehicle or other system), and the like. As the mobile energy resources 124 and supporting infrastructure (e.g., charging stations) scale in capacity and availability, orchestration of the mobile energy resources 124 and other DERs 128, optionally in coordination with available grid resources, takes on increased importance.

Resources involved in generation, storage, and transmission of energy are increasingly undergoing digital transformation. These digitized resources 122 may include smart resources 318 (such as smart devices (e.g., thermostats), smart home devices (e.g., speakers), smart buildings, smart wearable devices and many others that are enabled with processors, network connectivity, intelligent agents, and other onboard intelligence features) where intelligence features of the smart resources 318 can be used for energy orchestration, optimization, autonomy, control or the like and/or used to supply data for artificial intelligence and analytics in connection with the foregoing. The digitized resources 122 may also include IoT- and edge-digitized resources 320, where sensors or other data collectors (such as data collectors that monitor event logs, network packets, network traffic patterns, networked device location patterns, or other available data) provide additional energy-related intelligence, such as in connection with energy generation, storage, transmission or consumption by legacy infrastructure systems and devices ranging from large scale generators and transformers to consumer or business devices, appliances, and other systems that are in proximity to a set of IoT or edge devices that can monitor the same. Thus, IoT and edge device can provide digital information about energy states and flows for such devices and systems whether or not the devices and systems have onboard intelligence features; for example, among many others, an IoT device can deploy a current sensor on a power line to an appliance to detect utilization patterns, or an edge networking device can detect whether another device or system connected to the device is in use (and in what state) by monitoring network traffic from the other device. The digitized resources 122 may also include cloud-aggregated resources 322 about energy generation, storage, transmission, or use, such as by aggregating data across a fleet of similar resources that are owned or operated by an enterprise, that are used in connection with a defined workflow or activity, or the like. The cloud-aggregated resources 322 may consume data from the various data resources, from crowdsourcing, from sensor data collection, from edge device data collection, and many other sources.

In embodiments, the digitized resources 122 may be used for a wide range of uses that involve or benefit from real time information about the attributes, states, or flows of energy generation, storage, transmission, or consumption, including to enable digital twins, such as a set of adaptive energy digital twin systems 134 and/or the set of stakeholder energy digital twins 148 and for the set of configured stakeholder energy edge solutions 108. By way of example, a digital twin of public transport system in a city can predict energy needs based on commuter patterns, adjusting the operation of electric buses accordingly. Similarly, digital twins can be employed in various sectors, such as manufacturing units monitoring machinery energy consumption. Integration of the platform 102 with these digital twins ensures that energy is always used optimally, adjusting to the real-time needs of the corresponding system.

Energy generation, storage, and consumption, particularly involving green or renewable energy, have been the subject of intensive research and development in recent decades, yielding higher peak power generation capacity, increases in storage capacity, reductions in size and weight, improvements in intelligence and autonomy, and many others. The advanced energy resources and systems 104 may include a wide range of advanced energy infrastructure systems and devices that result from combinations of features and capabilities. In embodiments, flexible hybrid energy systems 324 may be provided that is adaptable to meet varying energy consumption requirements, such as ones that can provide more than one kind of energy (e.g., solar or wind power) to meet baseline requirements of an off-grid operation, along with a nuclear battery to satisfy much higher peak power requirements, such as for temporary, resource intensive activities, such as operating a drill in a mine or running a large factory machine on a periodic basis. A wide variety of flexible hybrid energy systems 324 are contemplated herein, including ones that are configured for modular interconnection with various types of localized production infrastructure as described elsewhere herein. In embodiments, the advanced energy resources and systems 104 may include advanced energy generation systems that draw power from fluid flows, such as portable turbine arrays 328 that can be transported to points of consumption that are in proximity to wind or water flows to substitute for or augment grid resources. The advanced energy resources and systems 104 may also include modular nuclear systems 330, including ones that are configured to use a nuclear battery and ones that are configured with mechanical, electrical and data interfaces to work with various consumption systems, including vehicles, localized production systems (as described elsewhere herein), smart buildings, and many others. The modular nuclear systems 330 may include SMRs and other reactor types. The advanced energy resources and systems 104 may include advanced storage systems 332, including advanced batteries and fuel cells, including batteries with onboard intelligence for autonomous management, batteries with network connectivity for remote management, batteries with alternative chemistry (including green chemistry, such as nickel zinc), batteries made from alternative materials or structures (e.g., diamond batteries), batteries that incorporate generation capacity (e.g., nuclear batteries), advanced fuel cells (e.g., cathode layer fuels cells, alkaline fuel cells, polymer electrolyte fuel cells, solid oxide fuel cells, and many others).

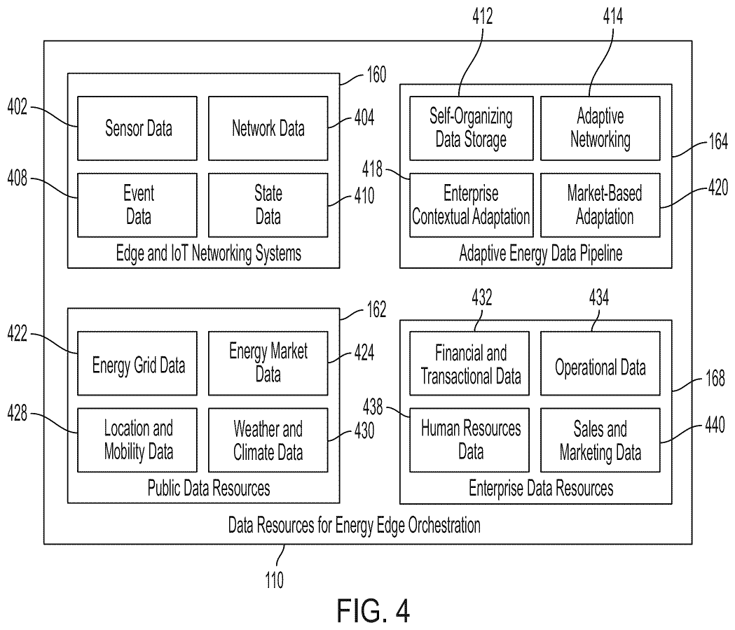

### FIG. 4: More Detail on Data Resources

Referring to FIG. 4, the data resources for energy edge orchestration 110 may include a wide range of public data sets, as well as private or proprietary data sets of an enterprise or individual. This may include data sets generated by or passed through the edge and IoT networking systems 160, such as sensor data 402 (e.g., from sensors integrated into or placed on machines or devices, sensors in wearable devices, and others); network data 404 (such as data on network traffic volume, latency, congestion, quality of service (QoS), packet loss, error rate, and the like); event data 408 (such as data from event logs of edge and IoT devices, data from event logs of operating assets of an enterprise, event logs of wearable devices, event data detected by inspection of traffic on application programming interfaces, event streams published by devices and systems, user interface interaction events (such as captured by tracking clicks, eye tracking and the like), user behavioral events, transaction events (including financial transaction, database transactions and others), events within workflows (including directed, acyclic flows, iterative and/or looping flows, and the like), and others); state data 410 (such as data indicating historical, current or predicted/anticipated states of entities (such as machines, systems, devices, users, objects, individuals, and many others) and including a wide range of attributes and parameters relevant to energy generation, storage, delivery or utilization of such entities); and/or combinations of the foregoing (e.g., data indicating the state of an entity and of a workflow involving the entity).

In embodiments, data resources may include, among many others, public data resources 162 that are relevant to energy, such as energy grid data 422 (such as historical, current and anticipated/predicted maintenance status, operating status, energy production status, capacity, efficiency, or other attribute of energy grid assets involved in generation, storage or transmission of energy); energy market data 424 (such as historical, current and anticipated/predicted pricing data for energy or energy-related entities, including spot market prices of energy based on location, type of consumption, type of generation and the like, day-ahead or other futures market pricing for the same, costs of fuel, cost of raw materials involved (e.g., costs of materials used in battery production), costs of energy-related activities, such as mineral extraction, and many others); location and mobility data 428 (such as data indicating historical, current and/or anticipated/predicted locations or movements of groups of individuals (e.g., crowds attending large events, such as concerts, festivals, sporting events, conventions, and the like), data indicating historical, current and/or anticipated/predicted locations or movements of vehicles (such as used in transportation of people, goods, fuel, materials, and the like), data indicating historical, current and/or anticipated/predicted locations or movements of points of production and/or demand for resources, and others); and weather and climate data 430 (such as indicating historical, current and/or anticipated/predicted energy-relevant weather patterns, including temperature data, precipitation data, cloud cover data, humidity data, wind velocity data, wind direction data, storm data, barometric pressure data, and others).

In embodiments, the data resources for energy edge orchestration 110 may include a set of enterprise data resources 168, which may include, among many others, energy-relevant financial and transactional data 432 (such as indicating historical, current and/or anticipated/predicted state, event, or workflow data involving financial entities, assets, and the like, such as data relating to prices and/or costs of energy and/or of goods and services, data related to transactions, data relating to valuation of assets, balance sheet data, accounting data, data relating to profits or losses, data relating to investments, interest rate data, data relating to debt and equity financing, capitalization data, and many others); operational data 434 (such as indicating historical, current and/or anticipated/predicted states or flows of operating entities, such as relating to operation of assets and systems used in production of goods and performance of services, relating to movement of individuals, devices, vehicles, machines and systems, relating to maintenance and repair operations, and many others); human resources data 438 (such as indicating historical, current and/or anticipated/predicted states, activities, locations or movements of enterprise personnel); and sales and marketing data 440 (such as indicating historical, current and/or anticipated/predicted states or activities of customers, advertising data, promotional data, loyalty program data, customer behavioral data, demand planning data, pricing data, and many others); and others.

In embodiments, the data resources for energy edge orchestration 110 may be handled by an adaptive energy data pipeline 164, which may leverage artificial intelligence capabilities of the platform 102 in order to optimize the handling of the various data resources. Increases in processing power and storage capacity of devices are combining with wider deployment of edge and IoT devices to produce massive increases in the scale and granularity of data of available data of the many types described herein. Accordingly, even more powerful networks like 5G, and anticipated 6G, are likely to have difficulty transmitting available volumes of data without problems of congestion, latency, errors, and reduced QoS. The adaptive energy data pipeline 164 can include a set of artificial intelligence capabilities for adapting the pipeline of the data resources to enable more effective orchestration of energy-related activities, such as by optimizing various elements of data transmission in coordination with energy orchestration needs. In embodiments, the adaptive energy data pipeline 164 may include self-organizing data storage 412 (such as storing data on a device or system (e.g., an edge, IoT, or other networking device, cloud or data center system, on-premises system, or the like) based on the patterns or attributes of the data (e.g., patterns in volume of data over time, or other metrics), the content of the data, the context of the data (e.g., whether the data relates high-stakes enterprise activities), and the like). In embodiments, the adaptive energy data pipeline 164 may include automated, adaptive networking 414 (such as adaptive routing based on network route conditions (including packet loss, error rates, QoS, congestion, cost/pricing and the like)), adaptive protocol selection (such as selecting among transport layer protocols (e.g., TCP or UDP) and others), adaptive routing based on RF conditions (e.g., adaptive selection among available RF networks (e.g., Bluetooth, Zigbee, NFC, and others)), adaptive filtering of data (e.g., DSP-based filtering of data based on recognition of whether a device is permitted to use RF capability), adaptive slicing of network bandwidth, adaptive use of cognitive and/or peer-to-peer network capacity, and others. In embodiments, the adaptive energy data pipeline 164 may include enterprise contextual adaptation 418, such as where data is automatically processed based on context (such as operating context of an enterprise (e.g., distinguishing between mission-critical and less critical operations, distinguishing between time-sensitive and other operations, distinguishing between context required for compliance with policy or law, and the like), transactional or financial context (e.g., based on whether the data is required based on contractual requirements, based on whether the data is useful or necessary for real-time transactional or financial benefits (e.g., time-sensitive arbitrage opportunities or damage-mitigation needs)), and many others). In embodiments, the adaptive energy data pipeline 164 may include market-based adaptation 420, such as where storage, networking, or other adaptation is based on historical, current and/or anticipated/predicted market factors (such as based on the cost of storage, transmission and/or processing of the data (including the cost of energy used for the same), the price, cost, and/or marginal profit of goods or services that are produced based on the data, and many others).

In embodiments, the adaptive energy data pipeline 164 may adapt any and all aspects of data handling, including storage, routing, transmission, error correction, timing, security, extraction, transformation, loading, cleansing, normalization, filtering, compression, protocol selection (including physical layer, media access control layer and application layer protocol selection), encoding, decoding, and others.

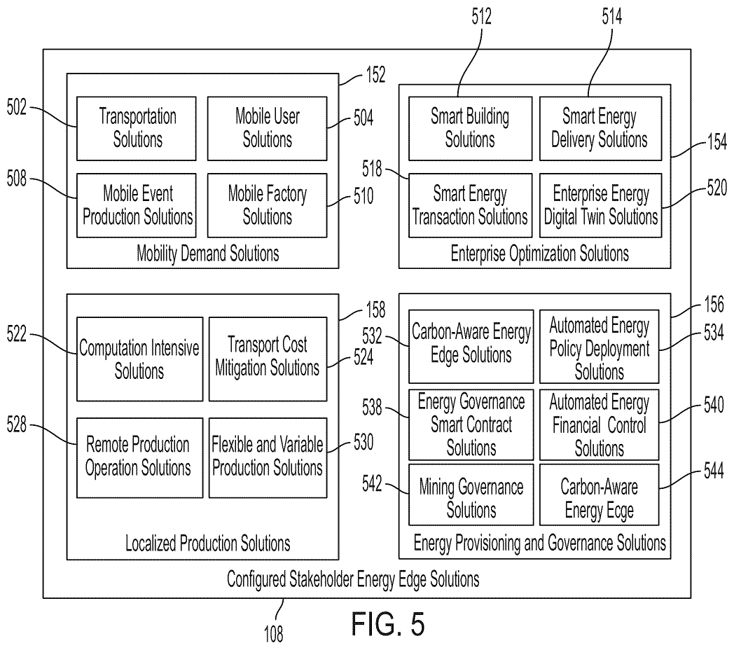

### FIG. 5: More Detail on Configured Energy Edge Stakeholder Solutions Localized Production

Referring to FIG. 5, the platform 102 may orchestrate the various services and capabilities described in order to configure the set of configured stakeholder energy edge solutions 108, including the set of mobility demand solutions 152, the set of enterprise optimization solutions 154, energy provisioning and governance solutions 156, and a set of localized production solutions 158.

The set of localized production solutions 158 may include a set of computation intensive solutions 522 where the demand for energy involved in computation activities in a location is operationally significant, either in terms of overall energy usage or peak demand (particularly ones where location is a relevant factor in operations, but energy availability may not be assured in adequate capacity, at acceptable prices), such as data center operations (e.g., to support high-frequency trading operations that require low-latency and benefit from close proximity to the computational systems of marketplaces and exchanges), operations using quantum computation, operations using very large neural networks or computation-intensive artificial intelligence solutions (e.g., encoding and decoding systems used in cryptography), operations involving complex optimization solutions (e.g., high-dimensionality database operations, analytics and the like, such as route optimization in computer networks, behavioral targeting in marketing, route optimization in transportation), operations supporting cryptocurrencies (such as mining operations in cryptocurrencies that use proof-of-work or other computationally intensive approaches), operations where energy is sourced from local energy sources (e.g., hydropower dams, wind farms, and the like), and many others.

The set of localized production solutions 158 may include a set of transport cost mitigation solutions 524, such as ones where the cost of energy required to transport raw materials or finished goods to a point of sale or to a point of use is a significant component in overall cost of goods. The set of transport cost mitigation solutions 524 may configure a set of DERs 128 or other advanced energy resources to provide energy that either supplements or substitutes for conventional grid energy in order to allow localized production of goods that are conventionally produced remotely and transported by transportation and logistics networks (e.g., long-haul trucking) to points of sale or use. For example, crops that have high water content can be produced locally, such as in containers that are equipped with lighting systems, hydration systems, and the like in order to shift the energy mix toward production of the crops, rather than transportation of the finished goods. The platform 102 may be used to optimize, at a fleet level, the mix of a set of localized, modular energy generation systems or storage systems to support a set of localized production systems for heavy goods, such as by rotating the energy generation or storage systems among the localized production systems to meet demand (e.g., seasonal demand, demand based on crop cycles, demand based on market cycles and the like).

The set of localized production solutions 158 may include a set of remote production operation solutions 528, such as to orchestrate DERs 128 or other advanced energy resources to provide energy in a more optimal way to remote operations, such as mineral mining operations, energy exploration operations, drilling operations, military operations, firefighting and other disaster response operations, forestry operations, and others where localized energy demand at given points of time periodically exceeds what can be provided by the energy grid, or where the energy grid is not available. This may include orchestration of the routing and provisioning of a fleet of portable energy storage systems (e.g., vehicles, batteries, and others), the routing and provisioning of a fleet of portable renewable energy generation systems (wind, solar, nuclear, hydropower and others), and the routing and provisioning of fuels (e.g., fuel cells).

The set of localized production solutions 158 may include a set of flexible and variable production solutions 530, such as where a set of production assets (e.g., 3D printers, CNC machines, reactors, fabrication systems, conveyors and other components) are configured to interface with a set of modular energy production systems, such as to accept a combination of energy from the grid and from a localized energy generation or storage source, and where the energy storage and generation systems are configured to be modular, removable, and portable among the production assets in order to provide grid augmentation or substitution at a fleet level, without requiring a dedicated energy asset for each production asset. The platform 102 may be used to configure and orchestrate the set of energy assets and the set of production assets in order to optimize localized production, including based on various factors noted herein, such as marketplace conditions in the energy market and in the market for the goods and services of an enterprise.

### Enterprise Optimization Solutions

The set of configured stakeholder energy edge solutions 108 may also include a set of enterprise optimization solutions 154, such as to provide an enterprise with greater visibility into the role that energy plays in enterprise operations (such as to enable targeted, strategic investment in energy-relevant assets); greater agility in configuring operations and transactions to meet operational and financial objectives that are driven at least in part by energy availability energy market prices or the like; improved governance and control over energy-related factors, such as carbon production, waste heat and pollution emissions; and improved efficiency in use of energy at any and all scales of use, ranging from electronic devices and smart buildings to factories and energy extraction activities. The term “enterprise,” as used herein, may, except where context requires otherwise, include private and public enterprises, including corporations, limited liability companies, partnerships, proprietorships and the like, non-governmental organizations, for-profit organizations, non-profit organizations, public-private partnerships, military organizations, first responder organizations (police, fire departments, emergency medical services and the like), private and public educational entities (schools, colleges, universities and others), governmental entities (municipal, county, state, provincial, regional, federal, national and international), agencies (local, state, federal, national and international, cooperative (e.g., treaty-based agencies), regulatory, environmental, energy, defense, civil rights, educational, and many others), and others. Examples provided in connection with a for-profit business should be understood to apply to other enterprises, and vice versa, except where context precludes such applicability.

The set of enterprise optimization solutions 154 may include a set of smart building solutions 512, where the platform 102 may be used to orchestrate energy generation, transmission, storage and/or consumption across a set of buildings owned or operated by the enterprise, such as by aggregating energy purchasing transactions across a fleet of smart buildings, providing a set of shared mobile or portable energy units across a fleet of smart buildings that are provisioned based on contextual factors, such as utilization requirements, weather, market prices and the like at each of the buildings, and many others.

The set of enterprise optimization solutions 154 may include a set of smart energy delivery solutions 514, where the platform 102 may be used to orchestrate delivery or energy at a favorable cost and at a favorable time to a point of operational use. In embodiments, the platform 102 may, for example, be used to time the routing of liquid fuel through elements of a pipeline by automatically controlling switching points of the pipeline based on contextual factors, such as operational utilization requirements, regulatory requirements, market prices, and the like. In other embodiments, the platform 102 may be used to orchestrate routing of portable energy storage units or portable energy generation units in order to deliver energy to augment or substitute for grid energy capacity at a point and time of operational use. In embodiments, the platform 102 may be used to orchestrate routing and delivery of wireless power to deliver energy to a point and time of use. Energy delivery optimization may be based on market prices (historical, current, futures market, and/or predicted), based on operational conditions (current and predicted), based on policies (e.g., dictating priority for certain uses) and many other factors.

The set of enterprise optimization solutions 154 may include a set of smart energy transaction solutions 518, where the platform 102 may be used to orchestrate transactions in energy or energy-related entities (e.g., renewable energy credits (RECs), pollution abatement credits, carbon-reduction credits, or the like) across a fleet of enterprise assets and/or operations, such as to optimize energy purchases and sales in coordination with energy-relevant operations at any and all scales of energy usage. This may include, in embodiments, aggregating and timing current and futures market energy purchases across assets and operations, automatically configuring purchases of shared generation, storage or delivery capacity for enterprise operational usage and the like. The platform 102 may leverage blockchain, smart contract, and artificial intelligence capabilities, trained as described throughout this disclosure, to undertake such activities based on the operational needs, strategic objectives, and contextual factors of an enterprise, as well as external contextual factors, such as market needs. For example, an anticipated need for energy by an enterprise machine may be provided as an event stream to a smart contract, which may automatically secure a future energy delivery contract to meet the need, either by purchasing grid-based energy from a provider or by ordering a portable energy storage unit, among other possibilities. The smart contract may be configured with intelligence, such as to time the purchase based on a predicted market price, which may be predicated, such as by an intelligent agent, based on historical market prices and current contextual factors.

The set of enterprise optimization solutions 154 may include a set of enterprise energy digital twin solutions 520, where the platform 102 may be used to collect, monitor, store, process and represent in a digital twin a wide range of data representing states, conditions, operating parameters, events, workflows and other attributes of energy-relevant entities, such as assets of the enterprise involved in operations, assets of external entities that are relevant to the energy utilization or transactions of the enterprise (e.g., energy grid entities, pipelines, charging locations, and the like), energy market entities (e.g., counterparties, smart contracts, blockchains, prices and the like). A user of the set of enterprise energy digital twin solutions 520 may, for example, view a set of factories that are consuming energy and be presented with a view that indicates the relative efficiency of each factory, of individual machines within the factory, or of components of the machines, such as to identify inefficient assets or components that should be replaced because the cost of replacement would be rapidly recouped by reduced energy usage. The digital twin, in such example, may provide a visual indicator of inefficient assets, such as a red flag, may provide an ordered list of the assets most benefiting from replacement, may provide a recommendation that can be accepted by the user (e.g., triggering an order for replacement), or the like. Digital twins may be role-based, adaptive based on context or market conditions, personalized, augmented by artificial intelligence, and the like, in the many ways described herein and in the documents incorporated by reference herein.

### Mobility Demand Solutions

Referring still to FIG. 5, the set of configured stakeholder energy edge solutions 108 may include a set of mobility demand solutions 152, such as where the platform 102 may be used to orchestrate energy generation, storage, delivery and or consumption by or for a set of mobile entities, such as a fleet of vehicles, a set of individuals, a set of mobile event production units, or a set of mobile factory units, among many others.

The set of mobility demand solutions 510 may include a set of transportation solutions 502, such as where the platform 102 may be used to orchestrate energy generation, storage, delivery and or consumption by or for a set of vehicles, such as used to transport goods, passengers, or the like. The platform 102 may handle relevant operational and contextual data, such as indicating needs, priorities, and the like for transportation, as well as relevant energy data, such as the cost of energy used to transport entities using different modes of transportation at different points in time, and may provide a set of recommendations, or automated provisioning, of transportation in order to optimize transportation operations while accounting fully for energy costs and prices. For example, among many others, an electric or hybrid passenger tour bus may be automatically routed to a scenic location that is in proximity to a low cost, renewable energy charging station, so that the bus can be recharged while the tourists experience the location, thus satisfying an energy-related objective (cost reduction) and an operational objective (customer satisfaction). An intelligent agent may be trained, using techniques described herein and in the documents incorporated by reference (such as by training robotic process automation on a training set of expert interactions), to provide a set of recommendations for optimizing energy-related objectives and other operational objectives.

The set of mobility demand solutions 510 may include a set of mobile user solutions 504, such as where the platform 102 may be used to orchestrate energy generation, storage, delivery and or consumption by or for a set of mobile users, such as users of mobile devices. For example, in anticipation of a large, temporary increase in the number of people at a location (such as in a small city hosting a major sporting event), the platform 102 may provide a set of recommendations for, or automatically configure a set of orders for a set of portable recharging units to support charging of consumer devices.

The set of mobility demand solutions 510 may include a set of mobile event production solutions 508, such as where the platform 102 may be used to orchestrate energy generation, storage, delivery and or consumption by or for a set of mobile entities involved in production of an event, such as a concert, sporting event, convention, circus, fair, revival, graduation ceremony, college reunion, festival, or the like. This may include automatically configuring a set of energy generation, storage or delivery units based on the operational configuration of the event (e.g., to meet needs for lighting, food service, transportation, loudspeakers and other audio-visual elements, machines (e.g., 3D printers, video gaming machines, and the like), rides and others), automatically configuring such operational configuration based on energy capabilities, configuring one or more of energy or operational factors based on contextual factors (e.g., market prices, demographic factors of attendees, or the like), and the like.

The set of mobility demand solutions 510 may include a set of mobile factory solutions, such as where the platform 102 may be used to orchestrate energy generation, storage, delivery and or consumption by or for a set of mobile factory entities. These may include container-based factories, such as where a 3D printer, CNC machine, closed-environment agriculture system, semiconductor fabricator, gene editing machine, biological or chemical reactor, furnace, or other factory machine is integrated into or otherwise contained in a shipping container or other mobile factory housing, wherein the platform 102 may, based on a set of operational needs of the set of factory machines, configure a set of recommendations or instructions to provision energy generation, storage, or delivery to meet the operational needs of the set of factory machine at a set of times and places. The configuration may be based on energy factors, operational factors, and/or contextual factors, such as market prices of goods and energy, needs of a population (such as disaster recovery needs), and many other factors.

### Energy Provisioning and Governance Solutions

Referring still to FIG. 5, the set of configured stakeholder energy edge solutions 108 may include a set of energy provisioning and governance solutions 156, such as where the platform 102 may be used to orchestrate energy generation, storage, delivery and or consumption by or for a set of entities based on a set of policies, regulations, laws, or the like, such as to facilitate compliance with company financial control policies, government or company policies on carbon reduction, and many others.

The set of energy provisioning and governance solutions 156 may include a set of carbon-aware energy edge solutions 532, such as where a set of policies regarding carbon generation may be explored, configured, and implemented in the platform 102, such as to require energy production by one or more assets or operations to be monitored in order to track carbon generation or emissions, to require offsetting of such generation or emissions, or the like. In embodiments, energy generation control instructions (such as for a machine or set of machines) may be configured with embedded policy instructions, such as required confirmation of available offsets before a machine is permitted to generate energy (and carbon), or before a machine can exceed a given amount of production in a given period. In embodiments, the embedded policy instructions may include a set of override provisions that enable the policy to be overridden (such as by a user, or based on contextual factors, such as a declared state of emergency) for mission critical or emergency operations. Carbon generation, reduction and offsets may be optimized across operations and assets of an enterprise, such as by an intelligent agent trained in various ways as described elsewhere in this disclosure.

The set of energy provisioning and governance solutions 156 may include a set of automated energy policy deployment solutions 534, such as where a user may interact with a user interface to design, develop or configure (such as by entering rules or parameters) a set of policies relating to energy generation, storage, delivery and/or utilization, which may be handled by the platform, such as by presenting the policies to users who interact with entities that are subject to the policies (such as interfaces of such entities and/or digital twins of such entities, such as to provide alerts as to actions that risk noncompliance, to log noncompliant events, to recommend alternative, compliance options, and the like), by embedding the policies in control systems of entities that generate, store, deliver or use energy (such that operations of such entities are controlled in a manner that is compliant with the policies), by embedding the policies in smart contracts that enable energy-related transactions (such that transactions are automatically executed in compliance with the policies, such that warnings or alerts are provided in the case of non-compliance, or the like), by setting policies that are automatically reconfigured based on contextual factors (such as operational and/or market factors) and others. In embodiments, an intelligent agent may be trained, such as on a training data set of historical data, on feedback from outcomes, and/or on a training data set of human policy-setting interactions, to generate policies, to configure or modify policies, and/or to undertake actions based on policies. A wide range of policies and configurations may be implemented, such as setting maximum energy usage for an entity for a time period, setting maximum energy cost for an entity for a time period, setting maximum carbon production for an entity for a time period, setting maximum pollution emissions for an entity for a time period, setting carbon offset requirements, setting renewable energy credit requirements, setting energy mix requirements (e.g., requiring a minimum fraction of renewable energy), setting profit margin minimums based on energy and other marginal costs for a production entity, setting minimum storage baselines for energy storage entities (such as to provide a margin of safety for disaster recovery), and many others.

The set of energy provisioning and governance solutions 156 may include a set of energy governance smart contract solutions 538, such as to allow a user of the platform 102 to design, generate, configure and/or deploy a smart contract that automatically provides a degree of governance of a set of energy transactions, such as where the smart contract takes a set of operational, market or other contextual inputs (such as energy utilization information collected by edge devices about operating assets) as inputs and automatically configures a set of contracts that are compliance with a set of policies for the purchase, sale, reservation, sharing, or other transaction for energy, energy-related credits, and the like. For example, a smart contract may automatically aggregate carbon offset credits needed to balance carbon generation detected across a set of machines used in enterprise operations.

The set of energy provisioning and governance solutions 156 may include a set of automated energy financial control solutions 540, such as to allow a user of the platform 102 and/or an intelligent agent to design, generate, configure, or deploy a policy related to control of financial factors related to energy generation, storage, delivery and/or utilization. For example, a user may set a policy requiring minimum marginal profit for a machine to continue operation, and the policy may be presented to an operator of the machine, to a manager, or the like. As another example, the policy may be embedded in a control system for the machine that takes a set of inputs needed to determine marginal profitability (e.g., cost of inputs and other non-energy resources used in production, cost of energy, predicted energy required to produce outputs, and market price of outputs) and automatically determines whether to continue production, and at what level, in order to maintain marginal profitability. Such a policy may take further inputs, such as relating to anticipated market and customer behavior, such as based on elasticity of demand for relevant outputs.

In embodiments, an automated energy and governance policy may refer to a policy that to which an underlying system must adhere. In other words, the automated energy and governance policy is like a rulebook that a system strictly follows. In some embodiments, a set of edge devices may enforce the energy policies for a set of “downstream devices” (which is any device that uses power in the edge devices covered area). By way of example, in a smart city grid, the automated energy and governance policy may be utilized to ensure that streetlights operate within certain energy constraints. Edge devices, as part of the platform 102, which may include energy-efficient controllers, may be tasked with ensuring these energy policies for other devices connected to them. In an example, during festive seasons when there are additional decorative lights in use, these edge devices can enforce energy policies, ensuring that the overall energy consumption of all lights (including the additional decorative lights, i.e., the “downstream devices”) does not cross a predefined limit.

In embodiments, an energy policy may define an upper limit of “carbon creation”, meaning that individual devices or the collection of downstream devices may not exceed a total carbon footprint over a given time. By way of example, for a corporation aiming for carbon neutrality, an energy policy may be set to ensure that their buildings or factories don't exceed a certain carbon footprint. In an example, a company may have a policy stating that its operations do not create more than a specific tonnage of carbon emissions in a year. This ensures that the company's activities remain environmentally sustainable, even as it scales up its operations.

In embodiments, energy delivery mechanisms may include “energy source” metadata indicating how the energy being delivered was generated and a measure of carbon output per “unit-of-usage”. Thereby, if energy was generated by wind, solar, nuclear, etc., the carbon footprint per unit of usage would be zero or close to zero, but if it was coal, natural gas, gas, etc., it would have a non-zero factor. Consider an industrial plant powered by a mix of renewable and non-renewable energy sources. The energy delivered to the plant may come with metadata indicating its origin. If the energy was predominantly generated through green sources like wind or solar, the associated carbon footprint would be low. However, if a significant portion was from coal or natural gas, the footprint would be higher. In these cases, the power may be delivered in portable storage or wired storage. If wired storage with mixed grid, the energy source metadata may indicate the overall percentage of energy from each power source feeding into the grid (e.g., 20% renewable, 50% nuclear, 10% coal), such that the carbon output per unit of usage parameter may be derived from the respective percentages. Overall, this metadata can be especially useful for businesses operating in regions with mixed energy grids, helping them calculate their actual carbon impact.

In embodiments, the edge device may monitor the amount of power being used by the set of downstream devices and may determine the carbon output based on the energy source metadata and carbon output rate associated with the energy source metadata. When the edge device determines that the set of downstream devices is approaching the policy limit, the energy and governance engine may take a set of preventative actions to avoid hitting the upper limit. Examples of preventative actions may include switching to a different energy delivery mechanism (which may be more expensive or less optimal in other ways), shutting down certain devices to reduce the energy spend, toggling energy usage between different devices, sending alerts to human users, or the like. When the edge device determines the set of downstream devices exceeded the upper limit, the energy and governance engine may take a set of corrective actions to avoid hitting the upper limit. The corrective actions may include one or more of buying carbon offset credits, turning off the system, and switching to a carbon neutral operating mode. By way of example, in a residential community powered by multiple energy sources, an edge device may monitor energy consumption of households and determine their carbon output. If the residential community is approaching its carbon limit due to excessive use of non-renewable energy, the platform 102 may shift more households in the residential community to solar power, despite potential added costs.

In embodiments, management of the reliability and uptime from energy edge components may be critical parts of overall operation of a distributed edge environment. Like for any business, ensuring that its operations are uninterrupted is crucial. This is especially true for sectors like healthcare or data centers, where energy reliability directly impacts human lives or vital data. Therefore, maintaining the reliability and uptime of energy edge components becomes a non-negotiable aspect of their operations. The platform 102 is configured to ensure to identify such operations, and ensure that their operations are uninterrupted, such as, by diverting energy from other sources if needed.

In embodiments, the platform 102 may be configured to provide and/or facilitate artificial general intelligence (AGI)-based governance of energy resources. The platform 102 may include one or more AGI agents configured to make decisions and interact with one or more of humans, other AGI agents, and components of the platform 102. The one or more AGI agents may be configured to make decisions based on an internal state of the one or more AGI agents. The platform 102 may be configured to create snapshots of the internal state of the one or more AGI agents, the snapshot being associated with decisions made by the one or more AGI agents. The platform 102 may be configured to analyze and/or monitor the snapshots to improve management and/or governance of energy resources.

In embodiments, the platform 102 may be configured to monitor decisions of components of the platform 102 to perform, provide, and/or facilitate continuous and/or near-continuous correction and/or micro-adjustment of the components to align with strategic goals of the platform 102. By way of example, in large-scale energy projects, it is essential to ensure that all components work towards the project's strategic goals. By continuously monitoring decisions of these components, the platform 102 can realign any deviations, ensuring that the entire system works in harmony.

In embodiments, the platform 102 may be configured to detect bad actors. With increasing cyber threats, the ability of the platform 102 to detect bad actors becomes important. The platform 102 may be configured to perform one or more actions in response to detection of a bad actor. By way of example, if someone tries to manipulate the energy consumption data of a smart grid to gain undue advantages, the platform 102 can detect such anomalies and take corrective actions, like blocking of such manipulating agents, raising flags, etc.

In embodiments, the platform 102 may be configured to track and monitor human interaction with components of the platform 102 and related edge devices and/or energy devices. The platform 102 may track and monitor human interaction to evaluate consistency of decisions of distributed agents, thereby encouraging that decisions made by the platform 102 and components thereof are consistent across a plurality of distributed energy resources. The platform 102 may be configured to additionally, or alternatively, track and monitor one or more of decision-making about resource allocation by components of the platform 102, management of supply and demand of energy resources, and responses to changes in an environment and/or market. By way of example, in a scenario where a human operator regularly interacts with an energy management system in a factory, by tracking these interactions, the platform 102 can determine the consistency of decisions made by different agents, ensuring a harmonized approach across the factory. Such tracking may, particularly, be useful for factories with multiple shifts, ensuring that energy decisions are consistent, regardless of the operating personnel.

In embodiments, the platform 102 may be configured to provide and/or facilitate detection and prevention of harm to wildlife by energy infrastructure. Infrastructure development often comes at an environmental cost. For energy projects located near forests or water bodies, there is a risk of harming wildlife. The platform 102 may be configured to detect any potential threats to wildlife due to the infrastructure, like birds flying into wind turbines or aquatic life being affected by hydropower plants, and take preventive actions.

In embodiments, the platform 102 may be configured to gather data related to patterns of wildlife and use the wildlife pattern data to perform optimization of energy generation and distribution. By way of example, in wind farms located near habitats of migratory birds, the platform 102 can analyze data related to birds' movement patterns. By understanding these patterns, it can optimize energy generation schedules, reducing the risk of bird collisions with the blades of the wind turbine, which ultimately may also reduce infrastructure damage. By way of example, in extreme cases, during peak migration periods, the platform 102 can stop the operations of wind turbines directly in path of movement of birds to minimize bird impacts.

In embodiments, the platform 102 may be configured to determine and/or manage energy needs related to space travel. The platform 102 may perform and/or provide improvements to power generation, storage, and distribution during space missions based on the determined energy needs. Space missions, like the Mars rovers, require precise energy management. The platform 102 can monitor solar panel efficiencies, battery storage levels, and energy consumption rates in such rovers. By way of example, during periods when there is no sunlight, the platform 102 can help optimize energy consumption ensuring essential systems remain functional.

In embodiments, the platform 102 may be configured to receive data from and/or transmit energy-related data to one or more satellites. The platform 102 may improve operation of one or more systems of components based on data received from the one or more satellites. By way of example, weather satellites provide crucial data that impacts energy generation, especially for renewables (like cloud cover over an area which can impact solar energy generation). By receiving data from these satellites, the platform 102 can forecast cloud cover, aiding solar farms to predict energy generation dips and adjust their distribution strategies accordingly.

In embodiments, the platform 102 may be configured to use data received from the one or more satellites to perform and/or improve one or more of monitoring energy usage, predicting energy demand, and allocating energy resources. For example, satellite data can also be invaluable for energy management. By way of example, by analyzing cloud movement patterns from satellites, the platform 102 can anticipate when solar farms in a region may experience reduced sunlight and adjust energy distribution from other sources.

In embodiments, the platform 102 may be configured to plan and/or manage energy needs and resources related to asteroid mining operations. Asteroid mining is being explored as a future method to extract rare minerals. The platform 102 may consider energy requirements of extraction and/or transportation operations of the asteroid mining operations. In such operations, the platform 102 can manage energy for mineral extraction (like operating various tools for mining operation) and transportation (like propulsion). By way of example, when extracting minerals from an asteroid bound for Earth, the platform 102 can optimize energy use for both the extraction process and subsequent transportation of the extracted minerals back.

In embodiments, the platform 102 may be configured to manage and/or track disposal of radioactive waste generated by nuclear power plants. The platform 102 may ensure safety and compliance with international standards and regulations. Herein, the platform 102 can track waste quantities, monitor storage conditions, and ensure that disposal methods are compliant with international standards. By way of example, after a reactor's fuel is spent, the platform 102 can monitor the cooling process to ensure safety of such cooling operation, and subsequent safe storage of the spent fuel.

In embodiments, the platform 102 may be configured to optimize solar power generation via advanced analytics. The platform 102 may ensure maximum efficiency and reliability of solar power plants and distributed solar energy resources. For example, in case of solar energy, solar power plants and solar installations have become increasingly complex. To ensure their peak performance, the platform 102 can utilize advanced analytics to analyze the operational data of these systems. By doing so, the platform 102 can provide insights into panel efficiency, dirt accumulation, etc. By way of example, using the platform 102, operators can predict which panels may need maintenance, determine optimal panel angles based on the sun's position, and even predict energy generation based on weather forecasts.

In embodiments, the platform 102 may be configured to anticipate and respond to threats from hostile nation states, such as cyberattacks targeting energy grids and/or sabotage of energy resources. In an era of increasing cyber warfare, energy grids are potential targets. The platform 102 can monitor for unusual patterns for detecting cyber intrusions, ensuring that energy resources remain secure. By way of example, during a sudden grid shutdown, the platform 102 can identify if it's a technical failure or a cyberattack.

In embodiments, the platform 102 may be configured to plan and/or manage energy needs related to land mine cleanup operations. The platform 102 may consider energy required for detection, extraction, and/or safe disposal of land mines. Land mine cleanup is a dangerous and energy-intensive operation. The platform 102 can manage energy needs for detection robots, ensuring they operate efficiently. By way of example, during a land mine detection operation in a large field, the platform 102 can optimize robot paths to minimize energy consumption.

In embodiments, the platform 102 may be configured to address legal and/or ethical implications of decisions made by the platform 102. The platform 102 may ensure compliance with laws and regulations, and/or may implement safeguards to prevent harm related to operation of the platform 102. The platform 102, with its AI systems, can make decisions impacting human lives. The platform 102 is configured to cross-check every decision with legal and ethical guidelines, ensuring that it does not even inadvertently cause harm. By way of example, in case of power shortage, before shutting off power to a critical facility, the platform 102 can assess the human impact, and may accordingly decide not to take such step and may try to divert power from other sources, and the like.

In embodiments, the platform 102 may be configured to manage data storage in compliance with regulatory requirements, thereby ensuring data privacy and security. Data storage, especially in the energy sector, involves a plethora of user-specific information that can be both sensitive and crucial for operations. Particularly, in regions with strict data regulations, like the EU with its GDPR, the platform 102 ensures that all stored energy consumption data complies with local regulations, safeguarding user privacy. Using the platform 102, this data can be stored with advanced encryption standards, and only be accessed when necessary.

In embodiments, the platform 102 may be configured to manage and respect requests from individual and/or groups of individuals for data anonymity in accordance with data privacy and protection laws. As energy consumption data becomes more granular, and with smart home devices, it may become increasingly possible to understand behaviors of humans by analyzing his/her energy usage patterns. Considering that, individuals may demand that their data be anonymized. The platform 102 can ensure that individual energy consumption patterns aren't traceable back to specific users, adhering to privacy norms.

In embodiments, the platform 102 may be configured to manage and/or address scenarios in which AI entities and/or robotic entities may request anonymity. By way of example, a business employing AI entities for providing energy management support (like a chatbot) for its users may wish not to let their user know about the use of AI; in such case, the AI entities may send an anonymity request to the platform 102 in its interactions, and the platform 102 may be configured to ensure that its identity remains protected.

In embodiments, the platform 102 may store data related to DNA and perform handling of the DNA data in accordance with laws and regulations. By way of example, the platform 102 can store DNA data related to bio-energy projects, ensuring that this sensitive data is handled ethically and legally. In an example, with the platform 102, research institutions can store DNA sequences of algae species being used for biofuel production. This data can then be accessed and analyzed to determine which species produced the most biofuel under specific conditions, all while ensuring the sensitive genetic data remains protected.

In embodiments, the platform 102 may be configured to interact with bank systems to manage financial transactions related to energy trading. The platform 102 may ensure secure and/or efficient energy trading operations. With the growth of energy trading, the platform 102 can act as a bridge between energy producers, traders, and consumers. The platform 102 can integrate with banking systems to streamline financial transactions. By way of example, during an energy trade between two businesses, the platform 102 can manage the financial aspects, ensuring swift and secure payments.

In embodiments, the platform 102 may be configured to perform automated marketing operations. The platform 102 may provide and/or facilitate one or more of personalized customer engagement, predictive analytics related to marketing operations, and optimization of marketing campaigns. For example, the platform 102 can use energy consumption data to tailor marketing campaigns. In an example, if a region has high solar energy potential (say, for example, due to all-seasons sunlight availability), the platform 102 can target consumers in such region with solar panels product ads. In another example, if a region already has high solar energy adoption, the platform 102 can target consumers in such region with solar accessory product ads.

In embodiments, the platform 102 may be configured to provide and/or facilitate secure and compliant use of text messaging communications with one or both of customers and stakeholders. The platform 102 may adhere to regulations related to privacy and/or consent. For example, the platform 102 can manage text-based communications with stakeholders, ensuring every message sent complies with privacy and consent regulations. By way of example, before sending a promotional message to a user, the platform 102 can check if the said user has consented to such communications.

In embodiments, the platform 102 may be configured such that edge devices may monitor movement of energy production, storage, and consumption devices throughout an area served by an energy grid. Movement and/or dispositioning of devices may be based on monitoring network traffic passing through/by the edge devices, such as network equipment and the like. Movement and/or dispositioning may also be based on changes in network activity, such as increases in localized network activity associated with energy production/storage/consumption devices.

In embodiments, the platform 102 may be configured to detect movement of energy production devices. When energy producing devices are moved within a networked environment, such as by being detected in a new locale (different/new segment) of a networked environment, edge devices may use this information to adjust guidance/instructions for local energy systems regarding energy production, pricing, and the like. Depending on the nature of the newly positioned energy producing resources (e.g., temporal or permanent) the rules or policies to govern energy production, storage, and utilization may be impacted. As an example, new energy production resources that are dedicated to a temporal event such as construction, a high attendance local event (e.g., a sports event), festival, and the like may suggest that demand on a local energy infrastructure may be mitigated for/during the event. Although demand for energy locally may increase substantially, due to the dedicated energy sourcing resources being disposed locally, energy policies may suggest taking some portion of the local energy grid and/or energy producing resources off-line for maintenance. If it appears that newly disposed energy producing resources have a more generalized local supply approach (including a long-term presence), such as when responding to an increase in demand and/or reduction in unreliable sourcing, edge devices that detect these new energy supply resources may act as moderator to temper an impact on local energy supply providers, such as by limiting access to the new source of supply, alerting local energy authorities of the new sourcing presence, and the like.

In embodiments, the platform 102 may be configured to detect movement of energy consumption devices or of energy consumers based on movement of, for example, consumer mobile devices. This may be achieved through detecting an unusual increase in device presence in a localized network, such as in proximity to one or more cellular antennas, and the like. Increasing presence of potential energy consumers, (e.g., such as at a social event, concert, sporting event, political event, and the like) in a localized network environment, once detected, may be responded to by the edge devices adjusting energy delivery infrastructure to make a corresponding amount of energy available in the impacted region. Another role that edge devices may play in such a scenario, is to increase radio transmit power and/or receive power across the affected region to accommodate the increase in device traffic. This may extend to signaling to energy providers that networked edge devices (within a region and/or as identified by specific identifier) will be increasing energy consumption in the near term.

In embodiments, the platform 102 may be configured such that edge devices may also detect and/or react to detecting an influx of energy storage systems, including without limitation, whole-home energy storage systems. When new energy storage device(s) are detected by edge devices, an energy management plan for a region may be adjusted to take into consideration new energy storage capabilities. This may involve managing energy grid utilization to better take advantage of the increased storage capacity. Local storage of energy, particularly consumer-direct energy, can be leveraged to off-load an energy grid during certain times, such as when demand is high, by directing the local energy storage systems to give up their energy to the grid at high demand times. Likewise, edge devices may configure communication channels between sourcing and storage to facilitate coordination among these resources.

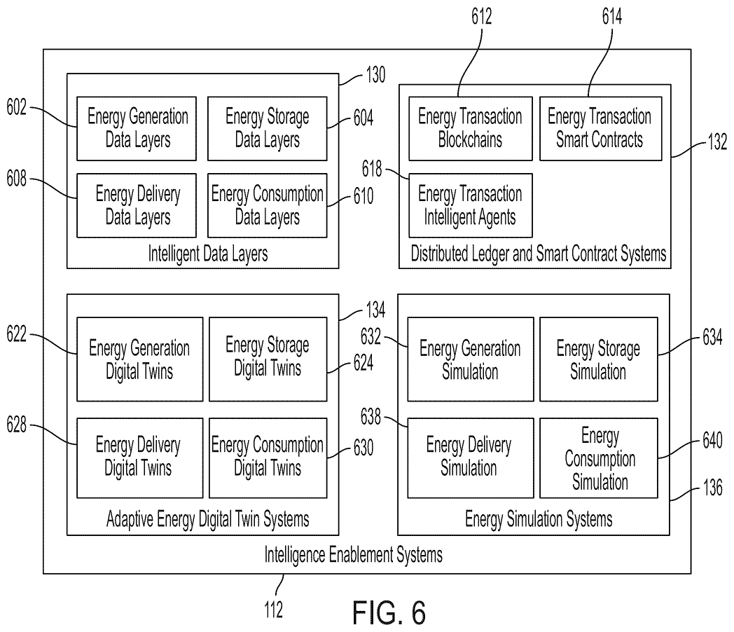

### FIG. 6: More Detail on Intelligence Enablement Systems

Referring to FIG. 6, further detail is provided as to embodiments of the set of intelligence enablement systems 112, including the set of intelligent data layers 130, the distributed ledger and smart contract systems 132, the set of adaptive energy digital twin systems 134 and the set of energy simulation systems 136.

The set of intelligent data layers 130 may undertake any of the wide range of data processing capabilities noted throughout this disclosure and the documents incorporated by reference herein, optionally autonomously, under user supervision, or with semi-supervision, including extraction, transformation, loading, normalization, cleansing, compression, route selection, protocol selection, self-organization of storage, filtering, timing of transmission, encoding, decoding, and many others. The set of intelligent data layers 130 may include energy generation data layers 602 (such as producing and automatically configuring and routing streams or batches of data relating to energy generation by a set of entities, such as operating assets of an enterprise), energy storage data layers 604 (such as producing and automatically configuring and routing streams or batches of data relating to energy storage by a set of entities, such as operating assets of an enterprise or assets of a set of customers), energy delivery data layers 608 (such as producing and automatically configuring and routing streams or batches of data relating to energy delivery by a set of entities, such as delivery by transmission line, by pipeline, by portable energy storage, or others), and energy consumption data layers 610 (such as producing and automatically configuring and routing streams or batches of data relating to energy consumption by a set of entities, such as operating assets of an enterprise, a set of customers, a set of vehicles, or the like).

The distributed ledger and smart contract systems 132 may provide a set of underlying capabilities to enable energy-related transactions, such as purchases, sales, leases, futures contracts, and the like for energy generation, storage, delivery, or consumption, as well as for related types of transactions, such as in renewable energy credits, carbon abatement credits, pollution abatement credits, leasing of assets, shared economy transactions for asset usage, shared consumption contracts, bulk purchases, provisioning of mobile resources, and many others. This may include a set of energy transaction blockchains 612 or distributed ledgers to record energy transactions, including generation, storage, delivery, and consumption transactions. A set of energy transaction smart contracts 614 may operate on blockchain events and other input data to enable, configure, and execute the aforementioned types of transactions and others. In embodiments, a set of energy transaction intelligent agents 618 may be configured to design, generate, and deploy the set of energy transaction smart contracts 614, to optimize transaction parameters, to automatically discover counterparties, arbitrage opportunities, and the like, to recommend and/or automatically initiate steps to contract offers or execution, to resolve contracts upon completion based on blockchain data, and many other functions.

The set of adaptive energy digital twin systems 134 may include digital twins of energy-related entities, such as operating assets of an enterprise that generate, store, deliver, or consume energy, and may include may include energy generation digital twins 622 (such as displaying content from event logs, or from streams or batches of data relating to energy generation by a set of entities, such as operating assets of an enterprise), energy storage digital twins 624 (such as displaying energy storage status information, usage patterns, or the like for a set of entities, such as operating assets of an enterprise or assets of a set of customers), energy delivery digital twins 628 (such as displaying status data, events, workflows, and the like relating to energy delivery by a set of entities, such as delivery by transmission line, by pipeline, by portable energy storage, or others), and energy consumption digital twins 630 (such as displaying data relating to energy consumption by a set of entities, such as operating assets of an enterprise, a set of customers, a set of vehicles, or the like). The set of adaptive energy digital twin systems 134 may include various types of digital twin described throughout this disclosure and/or the documents incorporated herein by reference, such as ones fed by data streams from edge and IoT devices, ones that adapt based on user role or context, ones that adapt based on market context, ones that adapt based on operating context, and many others.

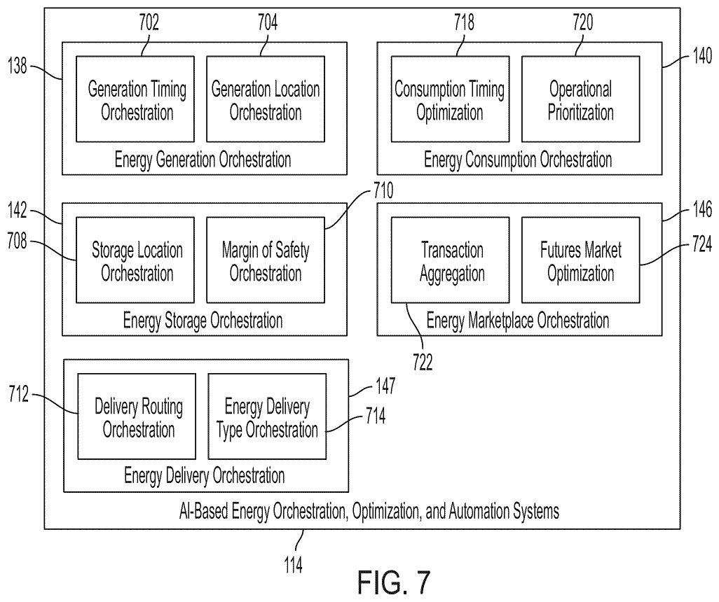

The set of energy simulation systems 136 may include a wide range of systems for the simulation of energy-related behavior based on historical patterns, current states (including contextual, operating, market and other information), and anticipated/predicted states of entities involved in generation, storage, delivery and/or consumption of energy. This may include an energy generation simulation 632, energy storage simulation 634, energy delivery simulation 638 and energy consumption simulation 640, among others. The set of energy simulation systems 136 may employ a wide range of simulation capabilities, such as 3D visualization simulation of behavior of physical, presentation of simulation outputs in a digital twin, generation of simulated financial outcomes for a set of different operational scenarios, generation of simulated operational outcomes, and many others. Simulation may be based on a set of models, such as models of the energy generation, storage, delivery and/or consumption behavior of a machine or system, or a fleet of machines or systems (which may be aggregated based on underlying models and/or based on projection to a larger set from a subset of models). Models may be iteratively improved, such as by feedback of outcomes from operations and/or by feedback comparing model-based predictions to actual outcomes and/or predictions by other models or human experts. Simulations may be undertaken using probabilistic techniques, by random walk or random forest algorithms, by projections of trends from past data on current conditions, or the like. Simulations may be based on behavioral models, such as models of enterprise or individual behavior based on various factors, including past behavior, economic factors (e.g., elasticity of demand or supply in response to price changes), energy utilization models, and others. Simulations may use predictions from artificial intelligence, including artificial intelligence trained by machine learning (including deep learning, supervised learning, semi-supervised learning, or the like). Simulations may be configured for presentation in augmented reality, virtual reality and/or mixed reality interfaces and systems (collectively referred to as “XR”), such as to enable a user to interact with aspects of a simulation in order to be trained to control a machine, to set policies, to govern a factory or other entity that includes multiple machines, to handle a fleet of machines or factories, or the like. As one example among many, a simulation of a factory may simulate the energy consumption of all machines in the factory while presenting other data, such as operational data, input costs, production costs, computation costs, market pricing data, and other content in the simulation. In the simulation, a user may configure the factory, such as by setting output levels for each machine, and the simulation may simulate profitability of the factory based on a variety of simulated market conditions. Thus, the user may be trained to configure the factory under a variety of different market conditions. FIG. 7: MORE DETAIL ON AI-BASED ENERGY ORCHESTRATION, OPTIMIZATION, AND AUTOMATION SYSTEMS

Referring to FIG. 7 more detail is provided with respect to the set of AI-based energy orchestration, optimization, and automation systems 114, each of which may use various other capabilities, services, functions, modules, components, or other elements of the platform 102 in order to orchestrate energy-related entities, workflows, or the like on behalf of an enterprise or other user. Orchestration may, for example, use robotic process automation to facilitate automated orchestration of energy-related entities and resources based on training data sets and/or human supervision based on historical human interaction data. As another example, orchestration may involve design, configuration, and deployment of a set of intelligent agents, which may automatically orchestrate a set of energy-related workflows based on operational, market, contextual and other inputs. Orchestration may involve design, configuration, and deployment of autonomous control systems, such as systems that control energy-related activities based on operational data collected by or from onboard sensors, edge devices, IoT devices and the like. Orchestration may involve optimization, such as optimization of multivariate decisions based on simulation, optimization based on real-time inputs, and others. Orchestration may involve use of artificial intelligence for pattern recognition, forecasting and prediction, such as based on historical data sets and current conditions.

The set of AI-based energy orchestration, optimization, and automation systems 114 may include the set of energy generation orchestration systems 138, the set of energy consumption orchestration systems 140, the set of energy storage orchestration systems 142, the set of energy marketplace orchestration systems 146 and the set of energy delivery orchestration systems 147, among others.

The set of energy generation orchestration systems 138 may include a set of generation timing orchestration systems 702 and a set of location orchestration systems 704, among others. The set of timing orchestration systems 702 may orchestrate the timing of energy generation, such as to ensure that timing of generation meets mission critical or operational needs, complies with policies and plans, is optimized to improve financial or operational metrics and/or (in the case of energy generated for sale) is well-timed based on fluctuations of energy market prices. Generation timing orchestration can be based on models, simulations, or machine learning on historical data sets. Generation timing orchestration can be based on current conditions (operating, market, and others).

The set of location orchestration systems 704 may orchestrate location of generation assets, including mobile or portable generation assets, such as portable generators, solar systems, wind systems, modular nuclear systems and others, as well as selection of locations for larger-scale, fixed infrastructure generation assets, such as power plants, generators, turbines, and others, such as to ensure that for any given operational location, available generation capacity (baseline and peak capacity) meets mission critical or operational needs, complies with policies and plans, is optimized to improve financial or operational metrics and/or (in the case of energy generated for sale) is well-located based on local variations in energy market prices. Generation location orchestration can be based on models, simulations, or machine learning on historical data sets. Generation location orchestration can be based on current conditions (operating, market, and others).

The set of energy consumption orchestration systems 140 may include a set of consumption timing optimization systems 718 and a set of operational prioritization systems 720, among others. The set of consumption timing optimization systems 718 may orchestrate timing consumption, such as to shift consumption for non-critical activities to lower-cost energy resources (e.g., by shifting to off-peak times to obtain lower electricity pricing for grid energy consumption, shifting to lower cost resources (e.g., renewable energy systems in lieu of the grid), to shift consumption to activities that are more profitable (e.g., to shift consumption to a machine that has a high marginal profit per time period based on current market and operating conditions (such as detected by a combination of edge and IoT devices and market data sources), and the like).

The set of operational prioritization systems 720 may enable a user, intelligent agent, or the like to set operational priorities, such as by rule or policy, by setting target metrics (e.g., for efficiency, marginal profit production, or the like), by declaring mission-critical operations (e.g., for safety, disaster recovery and emergency systems), by declaring priority among a set of operating assets or activities, or the like. In embodiments, energy consumption orchestration may take inputs from operational prioritization to provide a set of recommendations or control instructions to optimize energy consumption by a machine, components, a set of machines, a factory, or a fleet of assets.

The set of energy storage orchestration systems 142 may include a set of storage location orchestration systems 708 and a set of margin of safety orchestration systems 710. The set of storage location orchestration systems 708 may orchestrate location of storage assets, including mobile or portable generation assets, such as portable batteries, fuel cells, nuclear storage systems and others, as well as selection of locations for larger-scale, fixed infrastructure storage assets, such as large-scale arrays of batteries, fuel storage systems, thermal energy storage systems (e.g., using molten salt), gravity-based storage systems, storage systems using fluid compression, and others, such as to ensure that for any given operational location, available storage capacity meets mission critical or operational needs, complies with policies and plans, is optimized to improve financial or operational metrics and/or (in the case of energy stored and provide for sale) is well-located based on local variations in energy market prices. Storage location orchestration can be based on models, simulations, or machine learning on historical data sets, such as behavioral models that indicate usage patterns by individuals or enterprises. Storage location orchestration can be based on current conditions (operating, market, and others) and many other factors; for example, storage capacity can be brought to locations where grid capacity is offline or unusually constrained (e.g., for disaster recovery).

The set of margin of safety orchestration systems 710 may be used to orchestrate storage capacity to preserve a margin of safety, such as a minimum amount of stored energy to power mission critical systems (e.g., life support systems, perimeter security systems, or the like) or high priority systems (e.g., high-margin manufacturing) for a defined period in case of loss of baseline energy capacity (e.g., due to an outage or brownout of the grid) or inadequate renewable energy production (e.g., when there is inadequate wind, water or solar power due to weather conditions, drought, or the like). The minimum amount may be set by rule or policy, or may be learned adaptively, such as by an intelligent agent, based on a training data set of outcomes and/or based on historical, current, and anticipated conditions (e.g., climate and weather forecasts). The set of margin of safety orchestration systems 710 may, in embodiments, take inputs from the energy provisioning and governance solutions 156.

The set of energy marketplace orchestration systems 146 may include a set of transaction aggregation systems 722 and a set of futures market optimization systems 724.

The set of transaction aggregation systems 722 systems may automatically orchestrate a set of energy-related transactions, such as purchases, sales, orders, futures contracts, hedging contracts, limit orders, stop loss orders, and others for energy generation, storage, delivery or consumption, for renewable energy credits, for carbon abatement credits, for pollution abatement credits, or the like, such as to aggregate a set of smaller transactions into a bulk transaction, such as to take advantage of volume discounts, to ensure current or day-ahead pricing when favorable, to enable fractional ownership by a set of owners, operators, or consumers of a block of energy generation, storage, or delivery capacity, or the like. For example, an enterprise may aggregate energy purchases across a set of assets in different jurisdictions by use of an intelligent agent that aggregates a set of futures market energy purchases across the jurisdiction and represents the aggregated purchases in a centralized location, such as an operating digital twin of the enterprise.

The set of futures market optimization systems 724 may automatically orchestrate aggregation of a set of futures markets contracts for energy, renewable energy credits, for carbon offsets or abatement credits, for pollution abatement credits, or the like based on a forecast of future energy needs for an individual or enterprise. The forecast may be based on historical usage patterns, current operating conditions, current market conditions, anticipated operational needs, and the like. The forecast may be generated using a predictive model and/or by an intelligent agent, such as one based on machine learning on outcomes, on human output, on human-labeled data, or the like. The forecast may be generated by deep learning, supervised learning, semi-supervised learning, or the like. Based on the forecast, an intelligent agent may design, configure, and execute a series of futures market transactions across various jurisdictions to meet anticipated timing, location, and type of needs.

The set of energy delivery orchestration systems 147 may include a set of delivery routing orchestration systems 712 and a set of energy delivery type orchestration systems 714.

The set of energy delivery routing orchestration systems 712 may use various components, modules, facilities, services, functions and other elements of the platform 102 to orchestrate routing of energy delivery, such as based on location, timing and type of needs, available generation and storage capacity at places of energy need, available energy sources for routing (e.g., liquid fuel, portable energy generation systems, portable energy storage systems, and the like), available routes (e.g., main pipelines, pipeline branches, transmission lines, wireless power transfer systems, and transportation infrastructure (roads, railways and waterways, among others)), market factors (price of energy, price of goods, profit margins for production activities, timing of events that require energy, and others), environmental factors (e.g., weather), operational priorities, and others. A set of artificial intelligence systems trained in various ways disclosed herein may be trained to recommend or to configure a route, such as based on the foregoing inputs and a set of training data, such as human routing activities, a route optimization model, iteration among a large number of simulated scenarios, or the like, or combination of any of the foregoing. For example, a set of control instructions may direct valves and other elements of an energy pipeline to deliver an amount of fluid-based energy to a location while directing mobile or portable resources to another location that would otherwise have reduced energy availability based on the pipeline routing instructions.

The set of energy delivery type orchestration systems 714 may use various components, modules, facilities, services, functions and other elements of the platform 102 to orchestrate optimization of the type of energy delivery, such as based on location, timing and type of needs, available generation and storage capacity at places of energy need, available energy sources for routing (e.g., liquid fuel, portable energy generation systems, portable energy storage systems, and the like), available routes (e.g., main pipelines, pipeline branches, transmission lines, wireless power transfer systems, and transportation infrastructure (roads, railways and waterways, among others)), market factors (price of energy, price of goods, profit margins for production activities, timing of events that require energy, and others), environmental factors (e.g., weather), operational priorities, and others. A set of artificial intelligence systems trained in various ways disclosed herein may be trained to recommend or to configure a mix of energy types, such as based on the foregoing inputs and a set of training data, such as human type selection activities, a delivery type optimization model, iteration among a large number of simulated scenarios, or the like, or combination of any of the foregoing. For example, a set of recommendations or control instructions may select a set of portable, modular energy resources that are compatible with needs (e.g., specifying renewable sources where there is high storage capacity to meet operational needs, such that inexpensive, intermittent sources are preferred), while the instructions may select more expensive natural gas energy where storage capacity is limited or absent and usage is continuous (such as for a 24/7 data center that operates remotely from the energy grid).

Many other examples of AI-based energy orchestration, optimization, and automation systems 114 are provided throughout this disclosure.

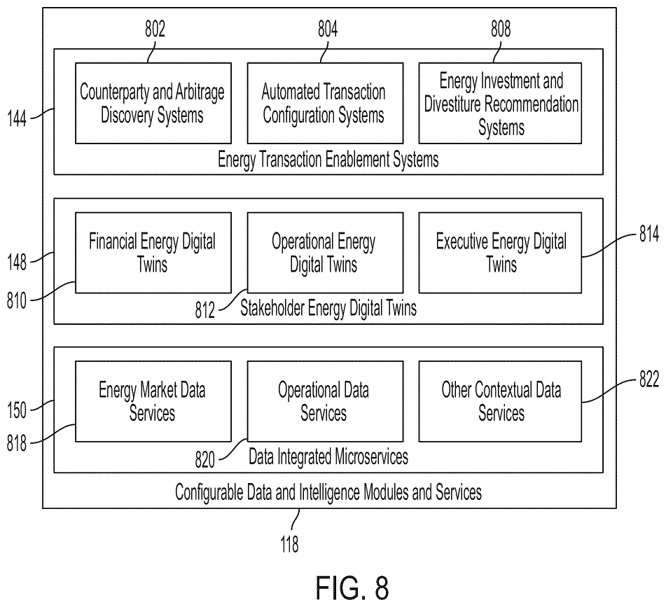

### FIG. 8: More Detail on Configurable Data and Intelligence Modules and Services

Referring to FIG. 8 the set of configurable data and intelligence modules and services 118 may include the set of energy transaction enablement systems 144, the set of stakeholder energy digital twins 148 and the set of data integrated microservices 150, among many others. These data and intelligence modules may include various components, modules, services, subsystems, and other elements needed to configure a data stream or batch, to configure intelligence to provide a particular type of output, or the like, such as to enable other elements of the platform 102 and/or various stakeholder solutions.

The set of energy transaction enablement systems 144 may include a set of counterparty and arbitrage discovery systems 802, a set of automated transaction configuration systems 804 and a set of energy investment and divestiture recommendation systems 808, among others. The set of counterparty and arbitrage discovery systems 802 may be configured to operate on various data sources related to operating energy needs, contextual factors, and a set of energy market, renewable energy credit, carbon offset, pollution abatement credit, or other energy-related market offers by a set of counterparties in order to determine a recommendation or selection of a set of counterparties and offers. An intelligent agent of the set of counterparty and arbitrage discovery systems 802 may initiate a transaction with a set of counterparties based on the recommendation or selection. Factors may include cost, counterparty reliability, size of counterparty offer, timing, location of energy needs, and many others.

The set of automated transaction configuration systems 804 may automatically or under human supervision recommend or automatically configure terms for a transaction, such as based on contextual factors (e.g., weather), historical, current, or anticipated/predicted market data (e.g., relating to energy pricing, costs of production, costs of storage, and the like), timing and location of operating needs, and other factors. Automation may be by artificial intelligence, such as trained on human configuration interactions, trained by deep learning on outcomes, or trained by iterative improvement through a series of trials and adjustments (e.g., of the inputs and/or weights of a neural network).

The set of energy investment and divestiture recommendation systems 808 may automatically or under human supervision recommend or automatically configure terms for an investment or divestiture transaction, such as based on contextual factors (e.g., weather), historical, current, or anticipated/predicted market data (e.g., relating to energy pricing, costs of production, costs of storage, and the like), timing and location of operating needs, and other factors. Automation may be by artificial intelligence, such as trained on human configuration interactions, trained by deep learning on outcomes, or trained by iterative improvement through a series of trials and adjustments (e.g., of the inputs and/or weights of a neural network). For example, the set of energy investment and divestiture recommendation systems 808 may output a recommendation to invest in additional modular, portable generation units to support locations of planned energy exploration activities or the divestiture of relatively inefficient factories, where energy costs are forecast to produce negative marginal profits.

The set of stakeholder energy digital twins 148 may include a set of financial energy digital twins 810, a set of operational energy digital twins 812 and a set of executive energy digital twins 814, among many others. The set of financial energy digital twins 810 may, for example, represent a set of entities, such as operating assets of an enterprise, along with energy-related financial data, such as the cost of energy being used or forecast to be used by a machine, component, factory, or fleet of assets, the price of energy that could be sold, the cost or price of renewable energy credits available through use of renewable energy generation capacity, the cost or price of carbon offsets needed to offset current of future anticipated operations, the cost of pollution abatement offsets or credits, and the like. The set of financial energy digital twins 810 may be integrated with other financial reporting systems and interfaces, such as enterprise resource planning suites, financial accounting suites, tax systems, and others.

The set of operational energy digital twins 812 may, for example, represent operational entities involved in energy generation, storage, delivery, or consumption, along with relevant specification data, historical, current or anticipated/predicted operating states or parameters, and other information, such as to enable an operator to view components, machines, systems, factories, and various combinations and sets thereof, on an individual or aggregate level. The set of operational energy digital twins 812 may display energy data and energy-related data relevant to operations, such as generation, storage, delivery and consumption data, carbon production, pollution emissions, waste heat production, and the like. A set of intelligent agents may provide alerts in the digital twins. The digital twins may automatically adapt, such as by highlighting important changes, critical operations, maintenance, or replacement needs, or the like. The set of operational energy digital twins 812 may take data from onboard sensors, IoT devices, and edge devices positioned at or near relevant operations, such as to provide real-time, current data.

The set of executive energy digital twins 814 may, for example, display entities involved in energy generation, storage, delivery or consumption, along with relevant specification data, historical, current or anticipated/predicted operating states or parameters, and other information, such as to enable an executive to view key performance metrics driven by energy with respect to components, machines, systems, factories, and various combinations and sets thereof, on an individual or aggregate level. The set of executive energy digital twins 814 may display energy data and energy-related data relevant to executive decisions, such as generation, storage, delivery and consumption data, carbon production, pollution emissions, waste heat production, and the like, as well as financial performance data, competitive market data, and the like. A set of intelligent agents may provide alerts in the digital twins, such as configured to the role of the executive (e.g., financial data to a CFO, risk management data to a chief legal officer, and aggregate performance data to a CEO or chief strategy officer. The set of executive energy digital twins 814 may automatically adapt, such as by highlighting important changes, critical operations, strategic opportunities, or the like. The set of executive energy digital twins 814 may take data from onboard sensors, IoT devices, and edge devices positioned at or near relevant operations, such as to provide real-time, current data.

The set of data integrated microservices 150 may include a set of energy market data services 818, a set of operational data services 820 and a set of other contextual data services 822, among many others.

The set of energy market data services 818 may provide a configured, filtered and/or otherwise processed feed of relevant market data, such as market prices of the goods and services of an enterprise, a feed of historical, current and/or futures market energy prices in the operating jurisdictions of the enterprise (optionally weighted or ordered based on relative energy usage across the jurisdictions), a feed of historical and/or proposed transactions (optionally augmented with counterparty information) configured according to a set of preferences of a user or enterprise (e.g., to show transactions relevant to the operating requirements or energy capacities of the enterprise), a feed of historical, current or future renewable energy credit prices, a feed of historical, current or future carbon offset prices, a feed of historical, current or future pollution abatement credit prices, and others.

The set of operational data services 820 may provide a configured, filtered and/or otherwise processed feed of operational data, such as historical, current, and anticipated/predicted states and events of operating assets of an enterprise, such as collected by sensors, IoT devices and/or edge devices and or anticipated or inferred based on a set of models, analytic systems, and or operation of artificial intelligence systems, such as intelligent forecasting agents.

The set of other contextual data services 822 may provide a wide range of configured, filtered, or otherwise processed feeds of contextual data, such as weather data, user behavior data, location data for a population, demographic data, psychographic data, and many others.

The configurable data integrated microservices of various types may provide various configured outputs, such as batches and files, database reports, event logs, data streams, and others. Streams and feeds may be automatically generated and pushed to other systems, services may be queried and/or may be pulled from sources (e.g., distributed databases, data lakes, and the like), and may be pulled by application programming interfaces.

In embodiments, the platform 102 may include one or more virtual power plants. The virtual power plants may be or include one or more of: a virtual power plant for aggregating and managing multiple heterogeneous energy resources in one place, a virtual power plant wherein the energy resources include solar plants, battery storage systems, wind turbines, electric vehicle charging stations, demand and response management centers, and smart meters, and a virtual power plant for managing a set of small, isolated power generation points used for load-leveling, to absorb excess supply from intermittent renewables, and to deliver supply during shortages.

### Additional Concepts and Examples

### Adaptive Energy Data Pipeline

In embodiments, an AI-based platform for enabling intelligent orchestration and management of power and energy includes an adaptive energy data pipeline configured to communicate data across a set of nodes in a network. Each node of the set of nodes is adapted to operate on an energy data set associated with at least one of energy generation, energy storage, energy delivery, or energy consumption. At least one node of the set of nodes is configured, by one or both of an algorithm or a rule set, to filter, compress, transform, error correct and/or route at least a portion of the energy data set based on at least one of a set of network conditions, data size, data granularity, or data content.

For example, the nodes may include a set of energy producers, and the adaptive energy data pipeline may be configured to adapt communication with each of the energy producers, thereby causing the energy producers to adapt the data on energy production that is reported to other nodes via the energy data pipeline. If network bandwidth is low, the adaptive energy data pipeline may instruct one or more of the energy producers to compress data more tightly so that data may be delivered more efficiently; to report data with a lower frequency in order to reduce bandwidth consumption; and/or apply a form of error correction in order to reduce retransmissions of data that includes correctible errors.

For example, the nodes may include a set of energy consumers, and the adaptive energy data pipeline may instruct one or more of the energy consumers to adapt data content to adapt reported data (such as energy consumption types, rates, and/or uses) to focus on a particular consumption of data that is of higher priority than other types of consumption. If the focus includes climate control, the adaptive energy data pipeline may instruct one or more of the energy consumers to increase reporting of energy consumption data that is associated with climate control and/or to reduce reporting of energy consumption data that is not associated with climate control. If the focus includes emissions, the adaptive energy data pipeline may instruct one or more of the energy consumers to increase reporting of energy consumption data that is associated with emissions and/or to reduce reporting of energy consumption data that is not associated with emissions. If the focus includes consumption of energy that involves other resources of interest, such as water, the adaptive energy data pipeline may instruct one or more of the energy consumers to increase reporting of energy consumption data that is associated with the resource of interest (e.g., energy spent on water filtration and/or purification) and/or to reduce reporting of energy consumption data that is not associated with the resource of interest.

For example, the nodes may include a heterogeneous set of energy producers and energy consumers, and the adaptive energy data pipeline may instruct one or more of the energy producers and/or one or more of the energy consumers to communicate through one or more communication routes, such as one or more network paths. The communication route may include a direct communication path between an energy producer and an energy consumer that is consuming energy produced, at least in part, by the energy producer. The communication route may include an indirect communication path between an energy producer and an energy consumer that passes between one or more intermediary locations, such as an auditor or broker. The communication route may include a shared communication path among an energy consumer and two or more energy producers that are capable of producing energy needed by the energy consumer, such that the energy producers may negotiate and/or cooperate to determine the manner of providing energy to the energy consumer. The communication route may include a shared communication path among an energy producer and two or more energy consumers that are capable of consuming energy that is produced by the energy producer, such that the energy consumers may negotiate and/or cooperate to determine the manner of allocating consumption of the produced energy. The adaptive energy data pipeline may aid in determining communication routes (e.g., network topologies and/or allocation of bandwidth among a communicating set of resources) to enable an efficient, reliable, prioritized, and/or purposeful exchange of communication among the resources.

For example, the node may include a smart grid control center that manages multiple microgrids. In periods of high energy demand, the control center needs real-time or near-real-time energy usage data to manage load distribution effectively. During such high-demand periods, the adaptive energy data pipeline may prioritize the transmission of energy consumption data over less critical data. Conversely, during periods of low demand, the adaptive energy data pipeline may prioritize maintenance or status data.

For example, the node may be responsible for monitoring the health and safety of energy infrastructure, like power plants or substations. If this node detects potential safety hazards, the adaptive energy data pipeline may prioritize the transmission of these critical alerts over routine data, ensuring rapid response to potential issues.

For example, the node may be an industrial setting with multiple energy-consuming machinery, where not all machines may have equal priority of respective operations. For high-priority machines, the adaptive energy data pipeline may request detailed, granular data, such as minute-by-minute energy consumption metrics. For less critical machines, the adaptive energy data pipeline may only request hourly or daily summaries, which may suffice for such less critical machines.

In embodiments, the adaptive energy data pipeline is further configured to adapt a transport of data over a network and/or communication system. The adapting is based on one or more of, a congestion condition, a delay and/or latency condition, a packet loss condition, an error rate condition, a cost of transport condition, a quality-of: service (QoS) condition, a usage condition, a market factor condition, and a user configuration condition. For example, the adaptive energy data pipeline may adapt a network topology based on parameters of the network and/or communication system, such as deploying new communication routes among resources; increasing and/or decreasing bandwidth of a communication route among resources; routing or re-routing network communication among the available network routes; and/or scheduling, prioritizing, or otherwise configuring communication among the resources to make use of available communication resources based on the set of available communication conditions. The adapting may be based on short-term conditions and/or priorities (e.g., allocating currently available bandwidth to support current communication needs among the resources). The adapting may be based on long-term conditions and/or priorities (e.g., allocating development resources to plan the development, construction, maintenance, and transfer of infrastructure, such as new network deployments or the acquisition of wireless communication spectrum) based on current and/or projected needs.

In embodiments, the AI-based platform further includes an adaptive energy digital twin that represents one or more of, an energy stakeholder entity, an energy distribution resource, a stakeholder information technology, a networking infrastructure entity, an energy-dependent stakeholder production facility, a stakeholder transportation system, a market condition, or an energy usage priority condition. For example, the adaptive energy twin may make decisions about purchasing energy-related resources on behalf of an energy stakeholder entity and may engage in transactions with other energy stakeholder entities, including other adaptive energy twins that represent such other energy stakeholder entities. The adaptive energy twin may autonomously initiate, transact, complete, and/or record ledger entries for energy-related transactions, such as the purchase of raw energy, raw energy resources, energy production, energy transport, and/or energy consumption. The adaptive energy twin may determine a conformity of energy activities of an energy stakeholder entity with regard to an energy usage policy, such as an energy consumption policy or a carbon emissions policy. The adaptive energy twin may operate on a combination of a set of needs, priorities, and/or interests of an energy stakeholder entity and one or more other parties, such as a government, a public body, an industry consortium, one or more entities that depend upon the energy stakeholder entity (e.g., consumers of energy that is produced by an energy producing entity), and/or the environment.

In embodiments, the AI-based platform further includes an adaptive energy digital twin that is configured to perform one or more of, providing a visual and/or analytic indicator of energy consumption by one or more energy consumers, filtering energy data, highlighting energy data, or adjusting energy data. For example, the visual and/or analytic indicators may include energy availability alerts (e.g., alerts of power outages, blackouts, brownouts, power surges, or the like arising from weather conditions, equipment failures, and/or maintenance operations). The visual and/or analytic indicators may include excess consumption and/or cost alerts provided to the one or more energy consumers as to excess energy consumption by certain activities (e.g., manufacturing activities or climate control activities). The visual and/or analytic indicators may include recommendations for adapting energy consumption based on various conditions (e.g., a recommendation to reduce energy consumption during periods of energy scarcity). The visual and/or analytic indicators may be presented to one or more users (e.g., as visual alerts shown in a web browser page, an app on a user device, a display component of a display-equipped consumer device, an audio alert presented by an audio device, or the like). The visual and/or analytic indicators may include recommendations for improving an efficiency of energy consumption (e.g., replacing a particularly energy-inefficient appliance, such as an old refrigerator or HVAC unit, with a newer and more energy-efficient version of the appliance).

In embodiments, the AI-based platform further includes an adaptive energy digital twin that is configured to generate a visual and/or analytic indicator of energy consumption by one or more of, one or more machines, one or more factories, or one or more vehicles in a vehicle fleet. For example, the visual and/or analytic indicators may be processed by a vehicle owned by the user. The visual and/or analytic indicators may cause the vehicle to operate differently, such as causing an autonomous vehicle may drive more slowly and/or efficiently in order to reduce energy usage during periods of energy scarcity, such as fuel shortages or cost increases. The visual and/or analytic indicators may advise a user of emissions created by the consumer use of the vehicle, such as during periods of varying traffic and/or weather conditions. The visual and/or analytic indicators may inform the user of the comparative costs of using the vehicle during certain periods, such as a cost of traveling before, during, and/or after rush-hour traffic. The visual and/or analytic indicators may include a comparison of energy use and/or efficiency by various modes of transportation, such as energy use when traveling by car, truck, bus, motorcycle, airplane, helicopter, or the like. In an example, the adaptive energy digital twin may be employed by cities and municipalities to monitor and manage, and to provide visual and/or analytic indicators for public services, such as street lighting, public transport systems, and water supply. Herein, these visual and/or analytic indicators may show patterns of energy consumption during different times of the day or year, helping city managers optimize operations and reduce costs. In another example, the adaptive energy digital twin may be employed in hospitals or healthcare facilities. Herein, the adaptive energy digital twin may provide visual and/or analytic indicators on the energy consumption of different departments or equipment. Such insights may be utilized in prioritizing power supply during outages or emergencies. In yet another example, the adaptive energy digital twin may be employed in large industrial units. Herein, the adaptive energy digital twin may provide visual and/or analytic indicators related to the energy consumption of various production processes. This can assist in scheduling operations to take advantage of low energy rates or shift loads to off-peak hours.

In embodiments, the adaptive energy data pipeline is further configured to perform one or more of, extracting energy-related data, detecting and/or correcting errors in energy-related data, transforming, converting, normalizing, and/or cleansing energy-related data, parsing energy-related data, detecting patterns, content, and/or objects in energy-related data, compressing energy-related data, streaming energy-related data, filtering energy-related data, loading and/or storing energy-related data, routing and/or transporting energy-related data, or maintaining security of energy-related data. For example, the adaptive energy data pipeline may adapt to cause certain kinds of data to be stored by, routed to, and/or processed by certain locations, such as causing energy consumption data of particular energy consumers to be transmitted to and/or stored by energy producers that produce the energy consumed by the particular energy consumers. The adaptive energy data pipeline may adapt to cause certain kinds of data to be retained, analyzed, summarized, and/or discarded, such as an automated collection and/or curation of data by refrigeration systems in a region in furtherance of government research into incentivizing energy-efficient refrigeration policies.

In embodiments, the energy data set is based on one or more public data resources, the public data resources including one or more of, a weather data resource, a satellite data resource, a census, population, demographic, and/or psychographic data resource, a market data resource, or an ecommerce data resource. For example, the adaptive energy data pipeline may be configured to monitor public resources for information on climate conditions, pollution, governmental energy policy, energy-related market conditions, or the like. The adaptive energy data pipeline may automatically search public data sources (e.g., the Internet) to discover sources of valuable energy-related data, and may develop a catalog of discovered sources, including the types of energy-related data, the accuracy and/or reliability of such data, the security and/or sensitivity of such data to various parties, or the like. The adaptive energy data pipeline may distribute the catalog (e.g., to digital twins of energy stakeholder entities) and/or merge the catalog with similar catalogs from other sources (e.g., indications of data sources provided by digital twins of energy stakeholder entities). The adaptive energy data pipeline may use the catalog to develop instructions for energy-related resources. For example, the adaptive energy data pipeline may receive data from a research group or government agency that describes energy-related driving behaviors associated with various objectives such as energy efficiency, safety, emissions, or the like. The adaptive energy data pipeline may use the data received from catalogued data sources to generate and/or adapt instructions for vehicles that adapt autonomous driving behavior in furtherance of the identified objectives. In an example, the adaptive energy data pipeline may utilize real-time traffic and public transit data to understand road congestion, public transport schedules, and traffic patterns. This data can help in optimizing energy consumption for electric vehicles or public transit systems by suggesting optimal routes, speeds, and charging schedules. In another example, the adaptive energy data pipeline may utilize data on the production of renewable energy sources, such as wind, solar, and hydro. By analyzing this data, the AI-based platform can predict the availability of renewable energy and adjust energy consumption or storage strategies accordingly. In yet another example, the adaptive energy data pipeline may utilize real-time air quality indices from environmental agencies. This data can provide insights into pollution levels, which can be valuable for optimizing energy generation in urban areas or adjusting operations of power generation facilities that may increase pollution during peak times.

In embodiments, the energy data set is based on one or more enterprise data resources, the enterprise data resources including one or more of, resource planning data, sales and/or marketing data, financial planning data, demand planning data, supply chain data, procurement data, pricing data, customer data, product data, or operating data. For example, the adaptive energy data pipeline may have access to organizational data of an energy stakeholder entity, such as a company, an educational institution, or a government. The organizational data can include, for example, organizational objectives such as reducing costs, improving energy efficiency, prioritizing energy availability for organizational processes, reducing emissions, shifting to renewable energy resources, establishing new resources in particular geographic regions, entering new markets, developing new products, undertaking new manufacturing processes, or the like. The adaptive energy data pipeline can adapt energy resources based on the organizational data, such as allocating energy resources or gathering energy-related data to match energy resource planning and development to the organizational objectives. The adaptive energy data pipeline can inform the organization as to policies that may impact one or more of the organizational objectives, such as informing the organization of the prospects for energy-related resource development and energy availability in a region where the organization is planning to develop or position new organizational resources.

In embodiments, the AI-based platform further includes at least one AI-based model and/or algorithm, wherein the at least one AI-based model and/or algorithm is trained based on a training data set, and the training data set is based on one or more of, one or more human tags and/or labels, one or more human interactions with a hardware and/or software system, one or more outcomes, one or more AI-generated training data samples, a supervised learning training process, a semi-supervised learning training process, or a deep learning training process. For example, the adaptive energy data pipeline may generate a training data set based on discovered data sources, such as research groups and/or government agencies. The adaptive energy data pipeline may initiate new training processes based on the newly developed training data sets, such as training or retraining models of autonomous vehicle control based on new studies regarding the energy-efficiency, safety, and/or emissions of certain autonomous vehicle driving behaviors. The adaptive energy data pipeline may identify certain areas of error, weakness, or loss of confidence in new or in-use AI-based models, such as driving patterns by autonomous vehicles in certain types of conditions (e.g., rain, snow, or nighttime) that relate to energy-related objectives (e.g., conserving fuel resources and/or reducing emissions). The adaptive energy data pipeline may generate new AI models, adapt existing AI models, and/or initiate training or retraining procedures of AI models, wherein these processes are carried out to include the new or adjusted AI models in the autonomous driving control systems of autonomous vehicles.

In embodiments, at least one node of the set of nodes is configured to orchestrate delivery of energy to one or more points of consumption, and the delivery of the energy includes one or more of, one or more fixed transmission lines, one or more instances of wireless energy transmission, one or more deliveries of fuel, or one or more deliveries of stored energy. For example, the adaptive energy data pipeline may be configured to schedule delivery of fuel resources to various depots. The adaptive energy data pipeline may be configured to schedule transmission of quantities of power from some power sources or power stores (e.g., factories or batteries) to other power stores or power consumers. The adaptive energy data pipeline may be configured to schedule use of energy by energy consumers based on the availability, transfer, and/or costs of such energy. The adaptive energy data pipeline may be configured to develop energy-related policies in order to satisfy the needs and/or objectives of energy producers, energy stores, energy transporters, and/or energy consumers, such as ensuring the availability of power resources for essential operations of an energy stakeholder entity and/or reducing excessive consumption for low-priority uses during periods of energy scarcity.

In embodiments, at least one node of the set of nodes is further configured to record, in a distributed ledger and/or blockchain, one or more energy-related events, the one or more energy-related events including one or more of, an energy purchase and/or sale event, a service charge associated with an energy purchase and/or sale event, an energy consumption event, an energy generation event, an energy distribution event, an energy storage event, a carbon emission production event, a carbon emission abatement event, a renewable energy credit event, a pollution production event, or a pollution abatement event. For example, the adaptive energy data pipeline may generate entries on a distributed ledger to indicate the offer, negotiation, acceptance, and/or completion of an energy-related transaction between one or more energy producers and one or more energy consumers. The adaptive energy data pipeline may generate one or more smart contracts by which energy-related transactions are carried out, and/or may record such one or more smart contracts on the distributed ledger. The adaptive energy data pipeline may audit a distributed ledger to develop data and information that may inform various energy-related analyses, such as an analysis of energy transactions recorded on a distributed ledger to guide the development of new energy production and/or storage infrastructure resources in view of an indication of energy supply, energy demand, energy usage, energy cost, or the like.

In embodiments, at least one node of the set of nodes is deployed in an off-grid environment, and the off-grid environment includes one or more of, an off-grid energy generation system, an off-grid energy storage system, or an off-grid energy mobilization system. For example, off-grid nodes may include residences, mobile homes, encampments, or the like that develop, store, transport, and/or consume energy supplied by renewable energy resources. The adaptive data energy data pipeline may adapt energy resources based on the needs of such nodes. For example, the adaptive energy data pipeline may provide supplemental and/or emergency energy generation, storage, and/or transport facilities that can provide power in case the off-grid renewable energy resources fail to meet demand. The adaptive energy data pipeline may provide energy generation, storage, and/or transport facilities that can make use of excess power that is generated by one or more off-grid nodes beyond the energy consumption needs of such nodes. The adaptive energy data pipeline may coordinate the development of energy grid resources based on the nodes of the off-grid environment, such as adjusting the capacity, scale, and/or development of new energy plants, storage facilities, and/or transmission channels based on the initiation, expansion, reduction, and/or collapse of communities of nodes in the off-grid environment.

In embodiments, the adaptive energy data pipeline is further configured to monitor one or both of, an overall energy consumption by at least a portion of the set of nodes, or a role of at least one node of the set of nodes in an overall energy consumption by at least a portion of the set of nodes, and based on the monitoring, perform one or more of, managing an energy consumption by the set of nodes, forecasting an energy consumption by the set of nodes, or provisioning resources associated with energy consumption by the set of nodes. For example, manufacturing organizations may adapt the roles of manufacturing resources such as facilities, warehouses, data centers, and vehicles. Such roles may inform the energy generation, storage, transport, and/or consumption needs and priorities of such resources. For example, a repurposing of a manufacturing plant from using a first manufacturing process to using a second manufacturing process, and the change of manufacturing processes may change the forecasted demand for energy. The adaptive energy data pipeline may respond to changes in forecasted demand for energy based on the roles of the manufacturing organization, such as allocating new power plants and/or energy storage resources in the vicinity of the manufacturing resource to accommodate the change in forecasted energy demand. For example, in case of EV charging stations, if a particular charging station node gets upgraded to a fast-charging station or if its usage frequency increases due to a new transit route nearby, its energy consumption pattern can change significantly. The adaptive energy data pipeline can recognize this and may prioritize energy supply to such charging stations during peak commuting hours or facilitate faster grid connections. For example, in cities, nodes like street-lights may be retrofitted with additional functionalities, like turning them into Wi-Fi hotspots. This multifunctionality alters their energy consumption profile. The adaptive energy data pipeline can recognize this and may ensure that these multi-purpose nodes are sufficiently powered, especially during times when their additional functionalities are in high demand, such as providing Wi-Fi during public events or the like.

In embodiments, the set of nodes in the network that comprise the adaptive energy data pipeline comprise a set of edge networking devices that govern at least one of energy generation, energy storage, energy delivery or energy consumption by a set of operating devices that are controlled via the edge networking devices. For example, the edge devices may include a set of IoT devices in a facility, wherein each IoT device includes a set of computing resources that can be used for various forms of computation that consume energy. The adaptive energy data pipeline may adapt the energy generation, storage, and/or delivery to accommodate the consumption of energy by the IoT devices. For example, a power-over-Ethernet (PoE) network may be adapted to provide power to various IoT devices, some of which may have energy storage resources, such as local batteries or capacitors. The adaptive energy data pipeline may schedule the delivery of power over the PoE network such that IoT devices are supplied with enough power to perform scheduled computation, and, optionally, to maintain power in local energy storage resources. For example, a first IoT device that performs significant computation, but that also includes a battery. The adaptive energy data pipeline may be configured to schedule delivery of energy to the IoT device at sufficient intervals to allow the IoT device to perform its computation while avoiding depletion of the battery. A second IoT device may perform a periodic monitoring function, such as applying a computer vision (CV) model to a camera input. The periodic monitoring function may involve significant expenditure of energy, and the IoT device may not have a local battery. The adaptive energy data pipeline may be configured to schedule a supply of energy to the IoT device over the PoE network so that it has enough power to perform the periodic monitoring function. The adaptive energy data pipeline can also adapt the schedule of the IoT device so that the monitoring function is performed during periods of sufficient energy supply and/or delivery, and is not performed during periods of energy scarcity.

In embodiments, the adaptive energy data pipeline is further configured to automatically select a least-cost route for data communicated across the set of nodes, the selection being based on a low-priority energy use related to the data. For example, the adaptive energy data pipeline may be configured to assign costs to available routes for data communication, including wired local-area and wide-area network routes, wireless local-area network (WLAN) routes, cellular communication routes, and satellite routes. “Cost” may be determined based on a variety of factors, such as energy expenditure, bandwidth expenditure, and/or use of limited resources. The adaptive energy data pipeline may also determine the value of various forms of communication, such as a value of communicating reports of occurrences of energy generation, storage, transport, and/or consumption; a value of communicating reports of audits of energy resources, such as status, capacity, and usage of energy generation, storage, and/or transport resources; and a value of communicating energy-based transactions, such as recordation of energy-related events on a distributed ledger. The adaptive energy data pipeline may match the value of each communication with the costs of the routes associated with each such communication. The adaptive energy data pipeline may perform the matching on an ad-hoc basis to determine a route for a particular communication. The adaptive energy data pipeline may perform the matching on a holistic basis to determine routes for all current and/or future communications among a set of nodes. The adaptive energy data pipeline may prioritize the occurrence and/or frequency of communications based on the matching (e.g., increasing a reporting occurrence and/or frequency of reports having a high value/cost ratio, and decreasing a reporting occurrence and/or frequency of reports having a low value/cost ratio). In some cases, the adaptive energy data pipeline may be capable of identifying and using least-cost routes for all current and/or forecasted communications. In some cases, the adaptive energy data pipeline may have to switch from a least-cost route to a higher-cost route for a particular communication (e.g., in case the least-cost route is entirely consumed by a first energy consumer that transmits large volumes of data, such that a higher-cost route has to be used by a second energy consumer that transmits only low volumes of intermittent data).

In embodiments, the adaptive energy data pipeline is further configured to automatically select a high-quality of service route for data communicated across the set of nodes, the selection being based on a high-priority energy use related to the data. For example, the adaptive energy data pipeline may be configured to determine a quality of service of each available route for data communication, including wired local-area and wide-area network routes, wireless local-area network (WLAN) routes, cellular communication routes, and satellite routes. “Quality of service” may be determined based on a variety of factors, such as speed, bandwidth, latency, capacity, reliability, demand, and/or security. The adaptive energy data pipeline may also determine the quality-of-service needs of various forms of communication, such as a quality-of-service need of communicating reports of occurrences of energy generation, storage, transport, and/or consumption; a quality-of-service need of communicating reports of audits of energy resources, such as status, capacity, and usage of energy generation, storage, and/or transport resources; and a quality-of-service need of communicating energy-based transactions, such as recordation of energy-related events on a distributed ledger. The adaptive energy data pipeline may match the value of each communication with the quality-of-service needs of the routes associated with each such communication. The adaptive energy data pipeline may perform the matching on an ad-hoc basis to determine a route for a particular communication. The adaptive energy data pipeline may perform the matching on a holistic basis to determine routes for all current and/or future communications among a set of nodes. The adaptive energy data pipeline may prioritize the occurrence and/or frequency of communications based on the matching (e.g., choosing higher-QoS routes for communications having a high value/QoS-need product, and choosing lower-QoS routes for communications having a low value/QoS-need product). In some cases, the adaptive energy data pipeline may be capable of identifying and using least-cost routes for all current and/or forecasted communications. In some cases, the adaptive energy data pipeline may have to switch from a least-cost route to a higher-cost route for a particular communication in order to meet a QoS need for the communication (e.g., in case the bandwidth and/or latency associated with the least-cost route are not suitable for an urgent communication, such as an indication of a detected or imminent failure of an energy resource or an urgent demand for energy by an energy consumer).

In embodiments, the adaptive energy data pipeline includes a set of artificial intelligence capabilities, the capabilities being configured to adapt the pipeline to enable optimization of elements of data transmission in coordination with energy orchestration needs. For example, various energy resources, such as energy producers, energy stores, energy transporters, and energy consumers may include one or more machine learning models that adapt the capabilities of such resources to energy availability and/or costs. Each energy resource may have to retrain its machine learning models to account for new data, new market conditions, new usage patterns, or the like. Such retraining of machine learning models also consumes energy. Accordingly, the adaptive energy data pipeline may coordinate the retraining of the machine learning models based on energy availability, need, and/or value. For example, the adaptive energy data pipeline may instruct the energy resources to schedule retraining during periods of lower energy demand, such as off-peak hours. The adaptive energy data pipeline may instruct a particular energy resource to retrain its machine learning model urgently based on a mismatch between a performance of the energy resource and the environment (e.g., behaviors of the machine learning model that do not correspond to energy market conditions, and therefore causes the energy resource to produce, store, transport, and/or consume too much or too little energy based on updated energy market conditions). Further, such retraining may be based on the communication of information to the energy resource, such as up-to-date information about energy market conditions. The adaptive energy data pipeline may adapt the transmission of information to the energy resource to provide up-to-date information for the retraining of its machine learning model(s). Further, the adaptive energy data pipeline may be utilized to anticipate energy demands and adjust data transmission processes accordingly. For example, the adaptive energy data pipeline can forecast a spike in energy demand due to impending weather conditions like a heatwave. Based on this prediction, the adaptive energy data pipeline may prioritize data transmission from energy storage systems, to ensure they are prepared to dispatch energy efficiently. Moreover, by optimizing data transmission, the adaptive energy data pipeline ensures that energy distribution centers receive real-time consumption data without delay, enabling them to make instantaneous adjustments in energy supply.

In embodiments, the adaptive energy data pipeline includes a self-organizing data storage, the data storage being configured to store data on a device based on one or more of patterns of the data, content of the data, or context of the data. For example, information about patterns of energy production, storage, transportation, and/or consumption may be stored by various devices, wherein such devices may have dynamic access to available storage resources. The adaptive energy data pipeline may adapt the provisioning of data storage to satisfy the storage needs of the energy resources. For example, the adaptive energy data pipeline may provision a pool of data storage devices such that the data storage needs of energy producers are sufficient to hold information about current or forecasted energy consumption. The provisioned data storage may be used to adapt the current and/or future operation of data production, storage, and/or transport by the energy resource. Additionally, the provisioned data storage may be used to store labeled data in a training data set to update one or more machine learning models of such energy resources, such as a machine learning model used by an energy producer to forecast energy demand cycles. The adaptive energy data pipeline may ensure that sufficient data storage is provisioned for the energy resource to accommodate the data needed to retrain the machine learning model. Such retraining may occur on a periodic basis (e.g., once a month) and/or on demand (e.g., when drift is detected), and the adaptive energy data pipeline may schedule the provisioning of data storage accordingly (e.g., increasing a provisioning of data storage capacity for the energy resource in anticipation of an imminent retraining period, or upon detecting drift that will likely necessitate retraining of the machine learning model). If such provisioning is detected or projected to be insufficient, the adaptive energy data pipeline may alert one or more administrators of the insufficiency, and/or may arrange for the acquisition of additional data storage capacity (e.g., by completing transactions for additional data storage via the execution of smart contracts and recordation for transactions on a distributed ledger).

In embodiments, the adaptive energy data pipeline is configured to perform automated, adaptive networking, the adaptive networking including one or more of adaptive protocol selection, adaptive routing of data based on RF conditions, adaptive filtering of data, adaptive slicing of network bandwidth, adaptive use of cognitive network capacity, or adaptive use of peer-to-peer network capacity. For example, the adaptive networking may involve switching between protocols based on a determination that a current protocol is insufficient. Such insufficiency may include, for example, excessive latency; excessive errors and/or retransmission; excessive overhead and/or bandwidth usage; and/or inadequate security, such as a protocol that uses a cryptography technique that has been compromised. The adaptive energy data pipeline may determine an alternative protocol that may reduce or eliminate the insufficiency of the current protocol. The determination may be based on a comparison of the features of the protocols; testing and/or metering of the protocols; historical data of the performance of various protocols under various conditions; and/or simulations and/or heuristics regarding the performance of different protocols in a particular scenario. The adaptive energy data pipeline may automatically switch a network from the current protocol to the alternative protocol based on the determination. The switch may include one or more of: reconfiguring a piece of communication hardware to use an updated set of communication parameters; changing a driver of a piece of communication hardware; reconfiguring a communication stack; changing communication libraries used by a piece of communication equipment; substituting a first piece of communication hardware of a device with a second piece of communication hardware of the device (e.g., switching from a wired connection to a wireless connection or vice versa); acquiring new hardware and/or software to be added to the set of communication resources used by a device; and/or requesting and/or recommending a development or acquisition of new communication resources for a device.

In embodiments, the adaptive energy data pipeline is configured to perform enterprise contextual adaptation by automatically processing data based on one or more of an operating context of an enterprise, a transactional context of an enterprise, or a financial context of an enterprise. For example, the enterprise may pursue one or more enterprise objectives such as reducing costs, improving energy efficiency, prioritizing energy availability for organizational processes, reducing emissions, shifting to renewable energy resources, establishing new resources in particular geographic regions, entering new markets, developing new products, undertaking new manufacturing processes, or the like. The adaptive energy data pipeline may be configured to interpret energy-related data in the context of the enterprise objectives. For example, a current use of energy by the enterprise may be undesirably high, but the energy usage may be in furtherance of developing and/or deploying renewable energy resources that are forecasted to reduce energy usage considerably for the long-term future. Thus, the adaptive energy data pipeline may prioritize the production, storage, and/or transport of energy on behalf of the enterprise today, in order to achieve rapid efficiency gains in energy production and/or use in the near-term future that benefits both the enterprise and the broader set of energy producers, stores, transporters, and consumers.

### Automatically Optimizing Energy Used in Edge Data Pipeline

In embodiments, an AI-based platform for enabling intelligent orchestration and management of power and energy includes a set of adaptive, autonomous data handling systems. Each of the adaptive, autonomous data handling systems is configured to collect data relating to energy generation, storage, or delivery from a set of edge devices that are in operational control of a set of distributed energy resources. Each of the adaptive, autonomous data handling systems is configured to autonomously adjust, based on the collected data, a set of operational parameters for such operational control.

For example, the data collected by each of the adaptive, autonomous data handling systems may include various properties of energy generation, such as total power capacity, peak power generation, surge power generation capacity, per-unit power generation cost, or the like. The data collected by each of the adaptive, autonomous data handling systems may include various properties of energy storage, such as total power storage capacity, current power storage, power storage density, per-unit power storage cost, or the like. The data collected by each of the adaptive, autonomous data handling systems may include various properties of energy delivery, such as peak power delivery, surge power delivery capacity, per-unit power delivery cost, or the like.

For example, the operational parameters may include a schedule of a set of processes, including computational, industrial, research, engineering, and/or auditing processes. Each adaptive, autonomous data handling system may be configured to determine the schedule of the set of processes based on the priorities and needs of the adaptive, autonomous data handling systems, and/or of other systems of the same or other energy generators, stores, transporters, and/or consumers. For example, during periods of energy scarcity, an adaptive, autonomous data handling system may be configured to increase and/or prioritize communication with edge devices relating to surveying their energy consumption needs and priorities, and may issue instructions to adapt the processes performed by such edge devices to address energy scarcity based on the results of such surveys. During periods of energy inefficiency, an adaptive, autonomous data handling system may be configured to increase and/or prioritize communication with edge devices relating to surveying the efficiency of their energy consumption, and may issue instructions to such edge devices to improve their energy consumption efficiency based on the results of such surveys. During periods of energy resource planning (e.g., provisioning the development of new energy resources), an adaptive, autonomous data handling system may be configured to increase and/or prioritize communication with edge devices relating to surveying their projected energy needs, and may inform the energy resource planning based on such forecasts.

In embodiments, each of the adaptive, autonomous data handling systems is further configured to adapt a transport of data over a network and/or communication system, wherein the adapting is based on one or more of, a congestion condition, a delay and/or latency condition, a packet loss condition, an error rate condition, a cost of transport condition, a quality-of-service (QoS) condition, a usage condition, a market factor condition, or a user configuration condition.

In embodiments, each of the adaptive, autonomous data handling systems includes an adaptive energy digital twin that represents one or more of, an energy stakeholder entity, an energy distribution resource, a stakeholder information technology, a networking infrastructure entity, an energy-dependent stakeholder production facility, a stakeholder transportation system, a market condition, or an energy usage priority condition.

In embodiments, each of the adaptive, autonomous data handling systems includes an adaptive energy digital twin that is configured to perform one or more of, providing a visual and/or analytic indicator of energy consumption by one or more energy consumers, filtering energy data, highlighting energy data, or adjusting energy data.

In embodiments, each of the adaptive, autonomous data handling systems includes an adaptive energy digital twin that is configured to generate a visual and/or analytic indicator of energy consumption by one or more of, one or more machines, one or more factories, or one or more vehicles in a vehicle fleet.

In embodiments, each of the adaptive, autonomous data handling systems is further configured to perform one or more of, extracting energy-related data, detecting and/or correcting errors in energy-related data, transforming, converting, normalizing, and/or cleansing energy-related data, parsing energy-related data, detecting patterns, content, and/or objects in energy-related data, compressing energy-related data, streaming energy-related data, filtering energy-related data, loading and/or storing energy-related data, routing and/or transporting energy-related data, or maintaining security of energy-related data.

In embodiments, the energy edge data is based on one or more public data resources, the public data resources including one or more of, weather data resource, a satellite data resource, a census, population, demographic, and/or psychographic data resource, a market data resource, or an ecommerce data resource.

In embodiments, the energy edge data is based on one or more enterprise data resources, the enterprise data resources including one or more of, resource planning data, sales and/or marketing data, financial planning data, demand planning data, supply chain data, procurement data, pricing data, customer data, product data, or operating data.

In embodiments, the AI-based platform further includes at least one AI-based model and/or algorithm, wherein the at least one AI-based model and/or algorithm is trained based on a training data set, and the training data set is based on one or more of, one or more human tags and/or labels, one or more human interactions with a hardware and/or software system, one or more outcomes, one or more AI-generated training data samples, a supervised learning training process, a semi-supervised learning training process, or a deep learning training process.

In embodiments, each of the adaptive, autonomous data handling systems is further configured to orchestrate delivery of energy to one or more points of consumption, and the delivery of the energy includes one or more of, one or more fixed transmission lines, one or more instances of wireless energy transmission, one or more deliveries of fuel, or one or more deliveries of stored energy.

In embodiments, each of the adaptive, autonomous data handling systems is further configured to record, in a distributed ledger and/or blockchain, one or more energy-related events, the one or more energy-related events including one or more of, an energy purchase and/or sale event, a service charge associated with an energy purchase and/or sale event, an energy consumption event, an energy generation event, an energy distribution event, an energy storage event, a carbon emission production event, a carbon emission abatement event, a renewable energy credit event, a pollution production event, or a pollution abatement event.

In embodiments, at least one of the adaptive, autonomous data handling systems is deployed in an off-grid environment, and the off-grid environment includes one or more of, an off-grid energy generation system, an off-grid energy storage system, or an off-grid energy mobilization system.

In embodiments, the platform further comprises an adaptive energy data pipeline configured to communicate data across a set of nodes in a network.

In embodiments, the set of nodes in the network that comprise the adaptive energy data pipeline comprise a set of edge networking devices that govern at least one of energy consumption, energy storage, energy delivery or energy consumption by a set of operating devices that are controlled via the edge networking devices.

In embodiments, the adaptive energy data pipeline is further configured to automatically select a least-cost route for data communicated across the set of nodes, the selection being based on a low-priority energy use related to the data.

In embodiments, the adaptive energy data pipeline is further configured to automatically select a high-quality of service route for data communicated across the set of nodes, the selection being based on a high-priority energy use related to the data.

In embodiments, the adaptive energy data pipeline includes a set of artificial intelligence capabilities, the capabilities being configured to adapt the pipeline to enable optimization of elements of data transmission in coordination with energy orchestration needs.

In embodiments, the adaptive energy data pipeline includes a self-organizing data storage, the data storage being configured to store data on a device based on one or more of patterns of the data, content of the data, or context of the data.

In embodiments, the adaptive energy data pipeline is configured to perform automated, adaptive networking, the adaptive networking including one or more of adaptive protocol selection, adaptive routing of data based on RF conditions, adaptive filtering of data, adaptive slicing of network bandwidth, adaptive use of cognitive network capacity, or adaptive use of peer-to-peer network capacity.

In embodiments, the adaptive energy data pipeline is configured to perform enterprise contextual adaptation by automatically processing data based on one or more of an operating context of an enterprise, a transactional context of an enterprise, or a financial context of an enterprise.

### Automated and Coordinated Governance of a Grid and a Distributed Edge (Non-Grid) Resource Set

In embodiments, an AI-based platform for enabling intelligent orchestration and management of power and energy includes a system configured to perform automated and coordinated governance of a set of energy entities that are operationally coupled within an energy grid and a set of distributed edge energy resources, wherein at least one of the distributed edge energy resources is operationally independent of the energy grid.

For example, governance of the energy grid may involve managing and responding to varying energy demands. In this scenario, the AI-based platform can be integrated with a system of smart meters deployed across residential and commercial properties. These smart meters continuously transmit consumption data to the AI-based platform. When the AI-based platform detects a peak demand period, perhaps due to extreme weather conditions, it can initiate demand response strategies. This may involve sending signals to smart home systems, prompting them to temporarily adjust thermostats or delay the operation of high-energy-consuming appliances like washing machines. Further, the AI-based platform may incentivize the factories to reschedule some of their energy-intensive operations to non-peak hours. This governance approach ensures that the grid does not get overloaded.

For example, governance of the energy grid may involve a determination and/or ranking of priorities such as energy grid capacity, energy grid reliability, energy grid cost reduction, energy grid efficiency, energy grid security, and/or energy grid emissions reduction. The priorities may be based on policies developed by a nation, government, organization, or research group, such as global, national, and/or regional targets for reducing emissions. The priorities may be based on market conditions, such as current and/or forecasted costs of planning, building, developing, using, and/or maintaining renewable vs. non-renewable energy resources. The AI-based platform may adapt its orchestration and management of power and energy based on the priorities, such as adapting computation performed by various edge devices in view of the overall priorities of the AI-based platform. For example, the AI-based platform may allocate processing of the distributed edge energy resources over a certain time period, such that a total amount of energy consumed by the distributed edge energy resources remains within an energy consumption cap that is projected to satisfy an emissions target for the time period.

For example, governance of the energy grid may involve the AI-based platform to constantly monitor production rates of the DERs like solar panels, wind turbines, and battery storage systems, and adjusting grid input accordingly. By way of example, on a particularly sunny day, if there is excess energy production from solar panels across a locality, the AI-based platform may either store the excess energy in grid-connected battery systems or redirect it to areas with higher demand. Conversely, if there is a forecasted drop in renewable energy production due to weather conditions, the AI-based platform may use stored energy or manage demand to prevent grid instability. Additionally, the AI-based platform can predict maintenance needs for these DERs, ensuring they operate optimally and contribute efficiently to the grid.

In embodiments, the system is further configured to adapt a transport of data over a network and/or communication system, wherein the adapting is based on one or more of, a congestion condition, a delay and/or latency condition, a packet loss condition, an error rate condition, a cost of transport condition, a quality-of-service (QoS) condition, a usage condition, a market factor condition, or a user configuration condition.

In embodiments, the AI-based platform further includes an adaptive energy digital twin that represents one or more of, an energy stakeholder entity, an energy distribution resource, a stakeholder information technology, a networking infrastructure entity, an energy-dependent stakeholder production facility, a stakeholder transportation system, a market condition, or an energy usage priority condition.

In embodiments, the AI-based platform further includes an adaptive energy digital twin that is configured to perform one or more of, providing a visual and/or analytic indicator of energy consumption by one or more energy consumers, filtering energy data, highlighting energy data, or adjusting energy data.

In embodiments, the AI-based platform further includes an adaptive energy digital twin that is configured to generate a visual and/or analytic indicator of energy consumption by one or more of, one or more machines, one or more factories, or one or more vehicles in a vehicle fleet.

In embodiments, the system is further configured to perform one or more of, extracting energy-related data, detecting and/or correcting errors in energy-related data, transforming, converting, normalizing, and/or cleansing energy-related data, parsing energy-related data, detecting patterns, content, and/or objects in energy-related data, compressing energy-related data, streaming energy-related data, filtering energy-related data, loading and/or storing energy-related data, routing and/or transporting energy-related data, or maintaining security of energy-related data.

In embodiments, the AI-based platform further includes at least one AI-based model and/or algorithm, wherein the at least one AI-based model and/or algorithm is trained based on a training data set, and the training data set is based on one or more of, one or more human tags and/or labels, one or more human interactions with a hardware and/or software system, one or more outcomes, one or more AI-generated training data samples, a supervised learning training process, a semi-supervised learning training process, or a deep learning training process.

In embodiments, the system is further configured to orchestrate delivery of energy to one or more points of consumption, and the delivery of the energy includes one or more of, one or more fixed transmission lines, one or more instances of wireless energy transmission, one or more deliveries of fuel, or one or more deliveries of stored energy.

In embodiments, the system is further configured to record, in a distributed ledger and/or blockchain, one or more energy-related events, the one or more energy-related events including one or more of, an energy purchase and/or sale event, a service charge associated with an energy purchase and/or sale event, an energy consumption event, an energy generation event, an energy distribution event, an energy storage event, a carbon emission production event, a carbon emission abatement event, a renewable energy credit event, a pollution production event, or a pollution abatement event.

In embodiments, at least one of the distributed energy edge resources is deployed in an off-grid environment, and the off-grid environment includes one or more of, an off-grid energy generation system, an off-grid energy storage system, or an off-grid energy mobilization system.

In embodiments, the system is configured to facilitate governance of a mining operation.

In embodiments, the system includes mine-level Internet of Things (IoT) sensing of the mining environment, ground-penetrating sensing of unmined portions of the mining environment, mass spectrometry and computer vision-based sensing of mined materials, asset tagging of smart containers, wearable device for detecting physiological status of miners, secure recording and resolution of transactions and transaction-related events, smart contracts for automatically allocating proceeds derived from the mining environment, and an automated system for recording, reporting, and assessing compliance with contractual, regulatory, and legal policy requirements.

In embodiments, the system includes a set of carbon-aware energy edge solutions, the solutions including exploring, configuring, and implementing a set of policies regarding carbon generation.

In embodiments, the solutions require energy production by a mining operation to be monitored to track carbon emissions generated by the mining operation.

In embodiments, the solutions require energy production by a mining operation to require offsetting carbon generation by the mining operation.

In embodiments, the platform includes a user interface and system includes a set of automated energy policy deployment solutions, the solutions being configurable via user interaction with the user interface.

In embodiments, the system includes an intelligent agent trained to generate policies related to governance of the mining operation, the intelligent agent being trained on a training set of historical data, feedback from outcomes, and human policy-setting interactions.

In embodiments, the system facilitates governance of the mining operation by implementing policies including one or more of, setting maximum energy usage for an entity for a time period, setting maximum energy cost for an entity for a time period, setting maximum carbon production for an entity for a time period, setting maximum pollution emissions for an entity for a time period, setting carbon offset requirements, setting renewable energy credit requirements, setting energy mix requirements, setting profit margin minimums based on energy and other marginal costs for a production entity, or setting minimum storage baselines for energy storage entities.

In embodiments, the system includes a set of energy governance smart contract solutions configured to allow a user of the platform to design, generate, and deploy a smart contract that automatically provides a degree of governance of a set of energy transaction.

In embodiments, the system includes a set of automated energy financial control solutions configured to allow a user of the platform to design, generate, configure, or deploy a policy related to control of financial factors related to one or more of energy generation, storage, delivery, or utilization.

### Adaptive, Autonomous Data Handling Systems in the Energy Edge

In embodiments, an AI-based platform for enabling intelligent orchestration and management of power and energy includes a set of adaptive, autonomous data handling systems, wherein each of the adaptive, autonomous data handling systems is configured to collect data relating to energy generation, storage, or delivery from a set of edge devices that are in operational control of a set of distributed energy resources and is configured to autonomously adjust, based on the collected data, a set of operational parameters for such operational control.

For example, in an industrial facility such as a manufacturing plant, the set of operational parameters may include an allocation of resources to produce various products. The manufacturing plant may perform various manufacturing tasks to produce each of the various products, and may be configured to adapt the selection of products to be produced based on a variety of inputs, such as resource costs, product demand, market conditions, the operating status and capacity of various machines of the manufacturing plant, or the like. The AI-based platform may determine an allocation of resources to produce various products that is consistent with both manufacturing objectives of the manufacturing plant (e.g., a completion of certain quantities of manufactured units within a designated time frame) and the needs of the various manufacturing tasks (e.g., a delivery of manufacturing materials to various manufacturing machines to keep them supplied, and/or a performance of a maintenance task to a manufacturing machine while it is out of operation). The AI-based platform may further determine the allocation based on the collected data related to energy generation, storage, and/or delivery from the set of edge devices that are in operational control of the distributed energy resources. For example, the AI-based platform may configure the edge devices to generate, store, and/or deliver energy in synchrony with the allocation of products to be produced, and/or to coordinate the allocation of products to be produced based on the availability and/or cost of generated, stored, and/or transported energy.

As another example, in an industrial facility such as a manufacturing plant, the set of operational parameters may include a schedule of operating various manufacturing equipment and/or performing various manufacturing processes. The manufacturing plant may perform various manufacturing tasks according to various times and/or under various conditions, such as a speed of a manufacturing machine or an assembly line, or a schedule of transporting manufacturing materials within the manufacturing plant. The AI-based platform may determine a schedule of the manufacturing tasks that is consistent with both manufacturing objectives of the manufacturing plant (e.g., a completion of certain quantities of manufactured units within a designated time frame) and the needs of the various manufacturing tasks (e.g., a delivery of manufacturing materials to various manufacturing machines to keep them supplied, and/or a performance of a maintenance task to a manufacturing machine while it is out of operation). The AI-based platform may further determine the schedule based on the collected data related to energy generation, storage, and/or delivery from the set of edge devices that are in operational control of the distributed energy resources. For example, the AI-based platform may configure the edge devices to generate, store, and/or deliver energy in synchrony with the schedule of operational processes, and/or to coordinate the schedule of operational processes based on the availability and/or cost of generated, stored, and/or transported energy.

As yet another example, in a residential community with multiple homes, the set of operational parameters may include the allocation and distribution of energy during various peak and non-peak times. Homes within the community may have various energy consumption patterns, some may have solar panels for energy generation with energy storage devices like home batteries, while others may rely solely on grid power. The AI-based platform collects data regarding individual home energy consumption, battery storage levels, solar energy generation, and grid energy prices. By analyzing this data, the AI-based platform may adjust operational parameters such as when to draw energy from the grid, when to use stored energy, and even when to sell excess energy back to the grid.

As still another example, in a commercial building, such as a shopping mall or business complex, the operational parameters may include the allocation of energy resources across various retail outlets, central air conditioning systems, lighting, and other utilities. The AI-based platform may continuously gather data from a multitude of sensors distributed throughout the building, monitoring energy consumption patterns of individual outlets, lighting systems, HVAC units, and more. The AI-based platform may identify that certain outlets or areas have higher footfall and energy consumption during specific hours. Using this data, the AI-based platform may adapt operational parameters to prioritize energy distribution to these high-footfall areas during peak hours, ensuring optimal lighting, temperature, and operational efficiency. Moreover, if the commercial building has renewable energy sources like rooftop solar panels, the AI-based platform can make decisions on when to use the generated energy, when to store it, or even when to feed it back to the grid, ensuring optimal energy usage and cost efficiency.

In embodiments, each of the adaptive, autonomous data handling systems is further configured to adapt a transport of data over a network and/or communication system, wherein the adapting is based on one or more of, a congestion condition, a delay and/or latency condition, a packet loss condition, an error rate condition, a cost of transport condition, a quality-of-service (QoS) condition, a usage condition, a market factor condition, or a user configuration condition.

In embodiments, each of the adaptive, autonomous data handling systems includes an adaptive energy digital twin that represents one or more of, an energy stakeholder entity, an energy distribution resource, a stakeholder information technology, a networking infrastructure entity, an energy-dependent stakeholder production facility, a stakeholder transportation system, a market condition, or an energy usage priority condition.

In embodiments, each of the adaptive, autonomous data handling systems includes an adaptive energy digital twin that is configured to perform one or more of, providing a visual and/or analytic indicator of energy consumption by one or more energy consumers, filtering energy data, highlighting energy data, or adjusting energy data.

In embodiments, each of the adaptive, autonomous data handling systems includes an adaptive energy digital twin that is configured to generate a visual and/or analytic indicator of energy consumption by one or more of, one or more machines, one or more factories, or one or more vehicles in a vehicle fleet.

In embodiments, each of the adaptive, autonomous data handling systems is further configured to perform one or more of, extracting energy-related data, detecting and/or correcting errors in energy-related data, transforming, converting, normalizing, and/or cleansing energy-related data, parsing energy-related data, detecting patterns, content, and/or objects in energy-related data, compressing energy-related data, streaming energy-related data, filtering energy-related data, loading and/or storing energy-related data, routing and/or transporting energy-related data, or maintaining security of energy-related data.

In embodiments, the energy edge data is based on one or more public data resources, the public data resources including one or more of, a weather data resource, a satellite data resource, a census, population, demographic, and/or psychographic data resource, a market data resource, or an ecommerce data resource.

In embodiments, the energy edge data is based on one or more enterprise data resources, the enterprise data resources including one or more of, resource planning data, sales and/or marketing data, financial planning data, demand planning data, supply chain data, procurement data, pricing data, customer data, product data, or operating data.

In embodiments, the AI-based platform further includes at least one AI-based model and/or algorithm, wherein the at least one AI-based model and/or algorithm is trained based on a training data set, and the training data set is based on one or more of, one or more human tags and/or labels, one or more human interactions with a hardware and/or software system, one or more outcomes, one or more AI-generated training data samples, a supervised learning training process, a semi-supervised learning training process, or a deep learning training process.

In embodiments, each of the adaptive, autonomous data handling systems is further configured to orchestrate delivery of energy to one or more points of consumption, and the delivery of the energy includes one or more of, one or more fixed transmission lines, one or more instances of wireless energy transmission, one or more deliveries of fuel, or one or more deliveries of stored energy.

In embodiments, each of the adaptive, autonomous data handling systems is further configured to record, in a distributed ledger and/or blockchain, one or more energy-related events, the one or more energy-related events including one or more of, an energy purchase and/or sale event, a service charge associated with an energy purchase and/or sale event, an energy consumption event, an energy generation event, an energy distribution event, an energy storage event, a carbon emission production event, a carbon emission abatement event, a renewable energy credit event, a pollution production event, or a pollution abatement event.

In embodiments, at least one of the adaptive, autonomous data handling systems is deployed in an off-grid environment, and the off-grid environment includes one or more of, an off-grid energy generation system, an off-grid energy storage system, or an off-grid energy mobilization system.

In embodiments, the platform further comprises an adaptive energy data pipeline configured to communicate data across a set of nodes in a network.

In embodiments, the set of nodes in the network that comprise the adaptive energy data pipeline comprise a set of edge networking devices that govern at least one of energy consumption, energy storage, energy delivery or energy consumption by a set of operating devices that are controlled via the edge networking devices.

In embodiments, the adaptive energy data pipeline is further configured to automatically select a least-cost route for data communicated across the set of nodes, the selection being based on a low-priority energy use related to the data.

In embodiments, the adaptive energy data pipeline is further configured to automatically select a high-quality of service route for data communicated across the set of nodes, the selection being based on a high-priority energy use related to the data.

In embodiments, the adaptive energy data pipeline includes a set of artificial intelligence capabilities, the capabilities being configured to adapt the pipeline to enable optimization of elements of data transmission in coordination with energy orchestration needs.

In embodiments, the adaptive energy data pipeline includes a self-organizing data storage, the data storage being configured to store data on a device based on one or more of patterns of the data, content of the data, or context of the data.

In embodiments, the adaptive energy data pipeline is configured to perform automated, adaptive networking, the adaptive networking including one or more of adaptive protocol selection, adaptive routing of data based on RF conditions, adaptive filtering of data, adaptive slicing of network bandwidth, adaptive use of cognitive network capacity, or adaptive use of peer-to-peer network capacity.

In embodiments, the adaptive energy data pipeline is configured to perform enterprise contextual adaptation by automatically processing data based on one or more of an operating context of an enterprise, a transactional context of an enterprise, or a financial context of an enterprise.

### Digital Twin of a Mine

In embodiments, an AI-based platform for enabling intelligent orchestration and management of power and energy includes a digital twin system having a digital twin of a mine, wherein the digital twin includes at least one parameter that is detected by a sensor of the mine.

For example, the at least one parameter detected by a sensor of the mine may include at least one physical property of the mine, temperature, humidity, pressure, strain, the presence of chemicals and/or radiation, or the like. The at least one parameter may include at least one physical property of a resource of the mine, such as a location, size, composition, or extraction status of an oil deposit. The at least one parameter may include at least one property of a machine of the mine, such as a location, condition, and/or operating state of a pump, drill, or vehicle. The at least one parameter may include at least one property of a process associated with the mine, such as an objective, set of requirements, allocation of resources, operating status, and/or projected result of an oil extraction process. The at least one parameter may include at least one property of an individual associated with the mine, such as an identity, type, skill set, current task, and/or health condition of a mine worker. The at least one parameter may include at least one property of a data set associated with the mine, such as a content, generation date, update date, and/or usage of a survey of an oil deposit or land feature of the mine.

For example, the mine may include industrial operations for surveying, accessing, and extracting minerals from areas of a mining site. The industrial operations may be associated with various pieces of equipment, such as lighting, cameras, ventilating fans, heating and cooling systems, drills, pumps, refineries, storage containers, transports, and the like. Each piece of equipment may have various energy-related needs, such as an energy type, quantity, storage capacity, and consumption rate. Some pieces of equipment may also be associated with one or more sensors that detect various properties, such as environmental sensors that detect temperature, humidity, pressure, strain, the presence of chemicals and/or radiation, or the like. The detected properties may relate to the piece of equipment (e.g., a speed, operating condition, or health state of the piece of equipment), a user of the piece of equipment (e.g., a presence, identity, activity, or health state of the user), the environment (e.g., an ambient or weather condition), or the like. The AI-based platform may orchestrate and manage energy in view of the energy needs of each piece of equipment of the mine based, at least in part, on the properties detected by the sensors. For example, the AI-based platform may monitor energy usage by each piece of equipment over the course of a period of time. The AI-based platform may then determine a schedule for generating, storing, and/or transporting energy to the pieces of the equipment, based on the monitoring, in order to meet the energy needs of the equipment over a future corresponding period of time. The schedule may be based, in part, on simulated operation of each piece of equipment, based on a corresponding digital twin and the properties detected by the sensors associated with the piece of equipment.

In embodiments, the at least one parameter is associated with one or more of, an unmined portion of the mine, a mining of materials from the mine, a smart container event involving a smart container associated with the mine, a physiological status of a miner associated with the mine, a transaction-related event associated with the mine, or a compliance of the mine with one or more contractual, regulatory, and/or legal policies.

In embodiments, the digital twin system of the AI-based platform additionally represents one or more of, an energy stakeholder entity, an energy distribution resource, a stakeholder information technology, a networking infrastructure entity, an energy-dependent stakeholder production facility, a stakeholder transportation system, a market condition, or an energy usage priority condition.

In embodiments, the digital twin system of the AI-based platform is further configured to perform one or more of, providing a visual and/or analytic indicator of energy consumption by one or more energy consumers, filtering energy data, highlighting energy data, or adjusting energy data.

In embodiments, the digital twin system of the AI-based platform is further configured to generate a visual and/or analytic indicator of energy consumption by one or more of, one or more machines, one or more factories, or one or more vehicles in a vehicle fleet.

In embodiments, the parameter is based on one or more public data resources, the public data resources including one or more of, a weather data resource, a satellite data resource, a census, population, demographic, and/or psychographic data resource, a market data resource, or an ecommerce data resource.

In embodiments, the parameter is based on one or more enterprise data resources, the enterprise data resources including one or more of, resource planning data, sales and/or marketing data, financial planning data, demand planning data, supply chain data, procurement data, pricing data, customer data, product data, or operating data.

In embodiments, the digital twin system of the AI-based platform includes at least one AI-based model and/or algorithm, wherein the at least one AI-based model and/or algorithm is trained based on a training data set, and the training data set is based on one or more of, one or more human tags and/or labels, one or more human interactions with a hardware and/or software system, one or more outcomes, one or more AI-generated training data samples, a supervised learning training process, a semi-supervised learning training process, or a deep learning training process.

In embodiments, the digital twin system of the AI-based platform is further configured to orchestrate delivery of energy to one or more points of consumption, and the delivery of the energy includes one or more of, one or more fixed transmission lines, one or more instances of wireless energy transmission, one or more deliveries of fuel, or one or more deliveries of stored energy.

In embodiments, the digital twin system of the AI-based platform is further configured to record, in a distributed ledger and/or blockchain, one or more energy-related events, the one or more energy-related events including one or more of, an energy purchase and/or sale event, a service charge associated with an energy purchase and/or sale event, an energy consumption event, an energy generation event, an energy distribution event, an energy storage event, a carbon emission production event, a carbon emission abatement event, a renewable energy credit event, a pollution production event, or a pollution abatement event.

In embodiments, the digital twin system of the AI-based platform is deployed in an off-grid environment, and the off-grid environment includes one or more of, an off-grid energy generation system, an off-grid energy storage system, or an off-grid energy mobilization system.

In embodiments, the mine is a data mine.

In embodiments, the mine is a set of resources for conducting computational operations.

In embodiments, the AI-based platform includes mine-level Internet of Things (IoT) sensing of the mining environment, ground-penetrating sensing of unmined portions of the mining environment, mass spectrometry and computer vision-based sensing of mined materials, asset tagging of smart containers, wearable device for detecting physiological status of miners, secure recording and resolution of transactions and transaction-related events, smart contracts for automatically allocating proceeds derived from the mining environment, and an automated system for recording, reporting, and assessing compliance with contractual, regulatory, and legal policy requirements.

In embodiments, the AI-based platform includes a set of carbon-aware energy edge solutions, the solutions including exploring, configuring, and implementing a set of policies regarding carbon generation.

In embodiments, the AI-based platform requires energy production by a mining operation to be monitored to track carbon emissions generated by the mining operation.

In embodiments, the AI-based platform requires energy production by a mining operation to require offsetting carbon generation by the mining operation.

In embodiments, the AI-based platform includes a user interface and platform includes a set of automated energy policy deployment solutions, the solutions being configurable via user interaction with the user interface.

In embodiments, the AI-based platform includes an intelligent agent trained to generate policies related to governance of a mining operation, the intelligent agent being trained on a training set of historical data, feedback from outcomes, and human policy-setting interactions.

In embodiments, the AI-based platform facilitates governance of a mining operation by implementing policies including one or more of, setting maximum energy usage for an entity for a time period, setting maximum energy cost for an entity for a time period, setting maximum carbon production for an entity for a time period, setting maximum pollution emissions for an entity for a time period, setting carbon offset requirements, setting renewable energy credit requirements, setting energy mix requirements, setting profit margin minimums based on energy and other marginal costs for a production entity, or setting minimum storage baselines for energy storage entities.

AI-Based Platform for Automated Labor Law Compliance Associated with Mining Operations

An AI-based platform for enabling intelligent orchestration and management of power and energy includes a governance system for a mining operation; and a reporting system for conveying at least one parameter that is sensed by a sensor of a mine of the mining operation, wherein the at least one parameter is associated with a compliance of the mining operation with a set of labor standards.

For example, the labor standard may include a set of tasks that a laborer with a particular background is trained, competent, and/or authorized to perform. The AI-based platform may adapt parameters associated with the operation of the mine to ensure compliance with the labor standard, such as adjusting parameters of an allocation of laborers to tasks to be performed in the mine, such that laborers are only allocated to tasks that they are trained, competent, and/or authorized to perform based on the labor standard.

As another example, the labor policy may include a set of work requirements for a laborer to perform a particular task, such as a maximum length of a work period, an allocation of breaks during the work period, a performance of a safety check during the work period, and/or an availability of a piece of safety equipment during the work period. The AI-based platform may adapt parameters associated with the operation of the mine to ensure compliance with the labor standard, such as adjusting parameters of an allocation of a laborer to a task to be performed in the mine, such that the work period of the laborer does not exceed a maximum length, includes an allocation of breaks, includes a required safety check, and/or is allocated only when a required piece of safety equipment is available, based on the labor standard.

As yet another example, the labor standard may specify that laborers working in certain zones of the mine with high risks, like deeper mine shaft, must undergo periodic training and certification. The AI-based platform can maintain a digital record of training and certification status of each laborer. Before a particular laborer is allocated to a task in these high-risk zones, the AI-based platform can verify that his/her training is up-to-date and have the required certification. If not, the AI-based platform may re-route the concerned laborer to another task, and may further flag that particular laborer for training before he/she can be assigned to the high-risk zone. This ensures that only adequately trained laborers work in areas with high risks to as to maintain compliance with the labor standards.

As still another example, the labor standard may include health monitoring requirements for laborers who are exposed to certain hazardous environments in the mine, such as areas with high levels of harmful gases. The AI-based platform, integrated with health monitoring devices like wearable sensors, may continuously monitor vital signs of laborers, ensuring that any irregularities, such as elevated heart rates, are detected in real time. If such anomalies are detected, the AI-based platform may initiate corresponding protocols, such as alerting onsite medical personnel, or even halting certain mining operations temporarily. This ensures that health of the laborers is not compromised and that the mining operation remains compliant with health monitoring standards.

In embodiments, the AI-based platform retrieves information about the labor standard from a labor standard information source, such as a labor policy library associated with a geographic region of the mine. The AI-based platform may determine and execute one or more processes for assessing compliance of the mining operation with the set of labor standards based on the available sensors and parameters. For example, the labor standards may include a safety standard for a labor condition associated with a miner, such as a work schedule, a determined physical health state, a determined mental and/or emotional health state, or an exposure of the miner to various health hazards such as radiation or pollution. The AI-based platform may determine, based on labor policy information, which labor standards apply to the miner. The AI-based platform may determine detectable parameter thresholds that apply to such standards (e.g., a maximum exposure to radiation over a given period of time). The AI-based platform may then identify sensors in the mine that are capable of detecting the detectable parameters (e.g., among a set of distributed radiation sensors, which radiation sensors are capable of providing data that is indicative of the exposure of the miner to radiation). The AI-based platform may orchestrate and manage the collection of information from the identified sensors in order to ensure that the collective data is indicative of the exposure of the miner to radiation over a period of time. Such orchestration and management may include scheduling and executing a generation, storage, and/or transport of power to each of the identified sensors so that sufficient data is reported to the AI-based platform to carry out its labor standard auditing function and to achieve governance of the mining operation.

In embodiments, the reporting system is further configured to adapt a transport of data over a network and/or communication system, wherein the adapting is based on one or more of, a congestion condition, a delay and/or latency condition, a packet loss condition, an error rate condition, a cost of transport condition, a quality-of: service (QoS) condition, a usage condition, a market factor condition, or a user configuration condition.

In embodiments, the AI-based platform includes an adaptive energy digital twin that represents one or more of, an energy stakeholder entity, an energy distribution resource, a stakeholder information technology, a networking infrastructure entity, an energy-dependent stakeholder production facility, a stakeholder transportation system, a market condition, or an energy usage priority condition.

In embodiments, the AI-based platform includes an adaptive energy digital twin that is configured to perform one or more of, providing a visual and/or analytic indicator of energy consumption by one or more energy consumers, filtering energy data, highlighting energy data, adjusting energy data, or generating a visual and/or analytic indicator of energy consumption by one or more of, one or more machines, one or more factories, or one or more vehicles in a vehicle fleet.

In embodiments, the reporting system is further configured to perform one or more of, extracting energy-related data, detecting and/or correcting errors in energy-related data, transforming, converting, normalizing, and/or cleansing energy-related data, parsing energy-related data, detecting patterns, content, and/or objects in energy-related data, compressing energy-related data, streaming energy-related data, filtering energy-related data, loading and/or storing energy-related data, routing and/or transporting energy-related data, or maintaining security of energy-related data.

In embodiments, the reporting system is further configured to record, in a distributed ledger and/or blockchain, one or more energy-related events, the one or more energy-related events including one or more of, an energy purchase and/or sale event, a service charge associated with an energy purchase and/or sale event, an energy consumption event, an energy generation event, an energy distribution event, an energy storage event, a carbon emission production event, a carbon emission abatement event, a renewable energy credit event, a pollution production event, or a pollution abatement event.

In embodiments, at least one of the at least one parameter is based on one or more of, one or more public data resources, the one or more public data resources including one or more of, a weather data resource, a satellite data resource, a census, population, demographic, and/or psychographic data resource, a market data resource, or an ecommerce data resource, or one or more enterprise data resources, the one or more enterprise data resources including one or more of, resource planning data, sales and/or marketing data, financial planning data, demand planning data, supply chain data, procurement data, pricing data, customer data, product data, or operating data.

In embodiments, the AI-based platform includes at least one AI-based model and/or algorithm, wherein the at least one AI-based model and/or algorithm is trained based on a training data set, and the training data set is based on one or more of, one or more human tags and/or labels, one or more human interactions with a hardware and/or software system, one or more outcomes, one or more AI-generated training data samples, a supervised learning training process, a semi-supervised learning training process, or a deep learning training process.

In embodiments, the governance system is further configured to orchestrate delivery of energy to one or more points of consumption, and the delivery of the energy includes one or more of, one or more fixed transmission lines, one or more instances of wireless energy transmission, one or more deliveries of fuel, or one or more deliveries of stored energy.

In embodiments, the set of labor standards is associated with at least one activity performed by a laborer of the mine, and conveying the at least one parameter that is sensed by the sensor includes conveying an indication of a performance of the at least one activity by the laborer that is sensed by the sensor.

In embodiments, the set of labor standards is associated with at least one object associated with a laborer of the mine, and conveying the at least one parameter that is sensed by the sensor includes conveying an indication of a detection of the at least one object by the sensor.

In embodiments, the set of labor standards includes a threshold of a property of the mine, and the reporting system is further configured to convey a determination based on a comparison of the at least one parameter sensed by the sensor with the threshold.

In embodiments, the AI-based platform includes a compliance restoration system that is configured to perform at least one compliance restoration action based on a determination that the at least one parameter sensed by the sensor indicates a condition that is not in compliance with the set of labor standards.

In embodiments, the AI-based platform includes an emergency response system that is configured to perform at least one emergency response action based on a determination that the at least one parameter sensed by the sensor indicates an occurrence of an emergency associated with the mine.

In embodiments, the AI-based platform includes a sensor configuration system that is configured to determine a configuration of the sensor to perform sensing of the at least one parameter, wherein the configuration is based on the compliance of the mining operation with the set of labor standards.

In embodiments, the AI-based platform of claim 15, wherein the set of labor standards is accessible to the sensor configuration system and is specified in a natural language, and the sensor configuration system is configured to determine the configuration of the sensor based on a natural language parsing of the set of labor standards.

In embodiments, the AI-based platform includes a sensor remediation system that is configured to perform at least one sensor remediation measure based on a determination of a failure of the sensor to sense the at least one parameter, wherein the at least one sensor remediation measure includes one or more of, initiating a replacement of the sensor, initiating a diagnostic operation involving the sensor, initiating a reconfiguration of the sensor to detect the at least one parameter in a different manner, initiating a request for a laborer of the mine to perform a manual sensing of the at least one parameter, or initiating a substitution of the sensor of the mine with at least one other sensor of the mine to sense the at least one parameter.

In embodiments, the AI-based platform includes a compliance verification system that is configured to verify that the at least one parameter sensed by the sensor indicates compliance of the mining operation with the set of labor standards, wherein the verifying includes one or more of, verifying a calibration of the sensor of the mine, verifying the at least one parameter sensed by the sensor of the mine based on a comparison of the at least one parameter with at least one parameter sensed by at least one other sensor of the mine, requesting manual verification of the at least one parameter by a laborer of the mine, or requesting verification by a compliance officer that the at least one parameter indicates the compliance of the mining operation with the set of labor standards.

In embodiments, the AI-based platform includes a laborer communication interface that is configured to engage in a communication with a laborer of the mine based on the at least one parameter sensed by the sensor, wherein the communication is associated with the compliance of the mining operation with the set of labor standards.

In embodiments, the AI-based platform includes a user interface that is configured to display a map of the mining operation, wherein the map includes an indication of the compliance of the mining operation with the set of labor standards based on the at least one parameter sensed by the sensor.

AI-Based Platform with Carbon Generation and/or Emissions Awareness of Set of Edge Devices

In embodiments, an AI-based platform for enabling intelligent orchestration and management of power and energy includes a set of edge devices, wherein each edge device of the set is configured to maintain awareness of carbon generation and/or emissions of at least one entity of a set of energy-using entities that are linked to and/or governed by the set of edge devices.

For example, the AI-based platform may include a set of sensors deployed within a geographic region to monitor the generation and/or emission of carbon-containing substances, such as methane, carbon monoxide, and/or carbon dioxide. Each sensor may detect, at regular intervals, a concentration of the carbon-containing substances in a localized area of the sensor, and the sensors may report of the carbon-containing substances at regular intervals to a particular server of the AI-based platform. The AI-based platform may analyze the reports to determine patterns of generation and/or emission of the carbon-containing substances over time and/or in various regions, as well as related factors, such as sources of the generated and/or emitted carbon-containing substances and/or effects of the carbon-containing substances on populations of individuals, animals, plants, and/or the environment or ecosystem of the geographic region. Based on the analysis, each of the set of sensors may generate localized reports of the carbon-containing substances to raise awareness by one or more users regarding the generating and/or emitting. The sensors may also control various industrial processes based on the analysis, such as adjusting rates of manufacturing processes in order to align future industrial processes that generated and/or emitted carbon-containing substances with one or more targets or goals of generated and/or emitted carbon-containing substances, such as a maximum or cap of generated and/or emitted carbon-containing substances within a designated period.

In embodiments, the set of edge devices is configured to maintain awareness of the generation and/or emission of carbon-containing substances by a set of generating and/or emitting resources, such as mines, manufacturing facilities, transportation facilities, vehicles, server farms, or the like. The generating and/or emitting resources may be under control of a same one or more entities that control the set of edge devices (e.g., an entity that owns and/or manages both the generating and/or emitting resources and the set of edge devices), or may be under control of one or more different entities (e.g., a set of edge devices owned by a local government of a region to maintain awareness of carbon emissions of vehicles owned and operated by individuals in the region). Alternatively or additionally, the set of edge devices is configured to maintain awareness of the generation and/or emission of carbon-containing substances by a set of industrial processes, such as resource extraction processes, manufacturing processes, material processing processes, storage processes, transportation processes, resource consumption processes, industrial services provided to third parties, or the like. The industrial processes may be under control of a same one or more entities that control the set of edge devices (e.g., an entity that owns and/or manages the set of edge devices and also performs the generating and/or emitting processes), or may be under control of one or more different entities (e.g., a set of edge devices owned by a local government of a region to maintain awareness of carbon emissions resulting from industrial processes performed by industrial organizations in the region).

In embodiments, the carbon-containing substances may include carbon monoxide, carbon dioxide, methane, and/or various short-chain hydrocarbons and/or volatile organic compounds (VOCs). The set of edge devices may also be configured to maintain awareness of the generation and/or emission of non-carbon-containing substances that may be generated and/or emitted with carbon-containing substances, such as nitrous oxide, sulfur dioxide, or the like. The generated and/or emitted carbon-containing substances may be of various forms, including (without limitation) gas, vapor, particulate matter, viscous or non-viscous liquids, solutions, or solids, or combinations thereof. The generated and/or emitted carbon-containing substances may be released into the environment, absorbed by and/or deposited into substrates, combined in solutions with other materials, stored in various containers, sequestered in various forms (e.g., underground storage vaults or by organisms or microorganisms), or the like.

In embodiments, at least one edge device of the set of edge devices is configured to measure the generation and/or emission of carbon-containing substances (optionally including non-carbon-containing substances), e.g., based on input from sensors coupled to and/or accessible by the set of edge devices. Alternatively or additionally, at least one edge device of the set of edge devices is configured to analyze and/or extrapolate measurements of the generation and/or emission of carbon-containing substances from one or more entities that are associated with the generation and/or emission of carbon-containing substances (e.g., analyzing received sensor data to attribute various quantities and/or proportions of generated and/or emitted carbon-containing substances to one or more entities). Alternatively or additionally, at least one edge device of the set of edge devices is configured to receive measurements of the generation and/or emission of carbon-containing substances from one or more entities that are associated with the generation and/or emission of carbon-containing substances (e.g., via reports received from third parties that are generating and/or emitting the carbon-containing and/or non-carbon-containing substances, and/or from devices maintained thereby). Alternatively or additionally, at least one edge device of the set of edge devices is configured to receive measurements of the generation and/or emission of carbon-containing substances from one or more entities that are not associated with the generation and/or emission of carbon-containing substances (e.g., via reports received from environmental monitoring agencies that monitor generated and/or emitted carbon-containing and/or non-carbon-containing substances by other third parties, or of the environment in general).

In embodiments, at least one edge device of the set of edge devices is configured to maintain awareness of the generation and/or emission of carbon-containing substances in various ways. For example, at least one edge device of the set of edge devices may be configured to report metrics and/or qualitative assessments of the generated and/or emitted carbon-containing substances to one or more entities (e.g., governments, companies, organizations, users, or the like) and/or devices (e.g., servers, industrial equipment, vehicles, mobile devices, or the like). Alternatively or additionally, at least one edge device of the set of edge devices may be configured to record metrics and/or qualitative assessments of the generated and/or emitted carbon-containing substances in one or more databases, data warehouses, centralized or distributed ledgers, or the like. Alternatively or additionally, at least one edge device of the set of edge devices may be configured to generate reports that aggregate metrics and/or qualitative assessments of the generated and/or emitted carbon-containing substances by various dimensions, such as time (e.g., periodic reports over periods of a day, month, season, or year), source (e.g., reports of various machines in a processing plant), emission type (e.g., reports of different types of generated and/or emitted carbon-containing substances), affected region (e.g., reports of the generation and/or emission of carbon-containing substances in various locations of a region), or the like. Alternatively or additionally, at least one edge device of the set of edge devices may be configured to issue one or more alerts of generated and/or emitted carbon-containing substances (e.g., generating an alert upon detecting and/or determining that a quantity of generated and/or emitted carbon-containing substances has exceeded a generation and/or emissions threshold, such as a target, goal, and/or cap for a maximum quantity of generated and/or emitted carbon-containing substances within a period of time). Alternatively or additionally, at least one edge device of the set of edge devices may be configured to alter an operation of one or more pieces of equipment and/or processes based on measurements and/or qualitative assessments of the generation and/or emission of carbon-containing substances (e.g., scheduling an operation of machines within a manufacturing plant based on the detected and/or determined generation and/or emission of carbon-containing substances). Alternatively or additionally, at least one edge device of the set of edge devices may be configured to generate one or more recommendations for one or more entities and/or individuals based on measurements and/or qualitative assessments of the generation and/or emission of carbon-containing substances (e.g., a recommendation to a manufacturing plant manager to operate manufacturing equipment in a manner that may reduce the generation and/or emission of carbon-containing substances). Additionally or alternatively, at least one edge device of the set of edge devices may be configured to integrate with renewable energy sources, such as solar panels or wind turbines, to determine the extent of carbon offset being achieved, and thereby determine the amount of energy generated from these sources and correlate it to the reduction in carbon emissions compared to traditional energy sources. Additionally or alternatively, at least one edge device of the set of edge devices may be configured to interface with transportation systems, monitoring vehicle routes, fuel consumption, maintenance schedules and emissions from fleets of vehicles, such delivery trucks, and may use this data to optimize routes, schedule vehicle maintenance, or even transition to cleaner fuel alternatives, to reduce carbon emissions.

In embodiments, at least one edge device of the set is configured to simulate the carbon generation and/or emissions of at least one entity of the set of energy-using entities.

In embodiments, at least one edge device of the set is configured to execute a set of machine-learned algorithms trained on a training data set of carbon generation data to calculate a metric of the carbon generation and/or emissions for a set of operational entities.

In embodiments, at least one edge device of the set is configured to execute a set of machine-learned algorithms trained on a training data set of carbon generation data to calculate a metric of the carbon generation and/or emissions for a set of operational entities.

In embodiments, at least one edge device of the set is further configured to adapt a transport of data over a network and/or communication system, wherein the adapting is based on one or more of, a congestion condition, a delay and/or latency condition, a packet loss condition, an error rate condition, a cost of transport condition, a quality-of-service (QoS) condition, a usage condition, a market factor condition, or a user configuration condition.

In embodiments, the AI-based platform includes an adaptive energy digital twin that represents one or more of, an energy stakeholder entity, an energy distribution resource, a stakeholder information technology, a networking infrastructure entity, an energy-dependent stakeholder production facility, a stakeholder transportation system, a market condition, or an energy usage priority condition.

In embodiments, the AI-based platform includes an adaptive energy digital twin that is configured to perform one or more of, providing a visual and/or analytic indicator of energy consumption by one or more energy consumers, filtering energy data, highlighting energy data, adjusting energy data, or generating a visual and/or analytic indicator of energy consumption by one or more of, one or more machines, one or more factories, or one or more vehicles in a vehicle fleet.

In embodiments, at least one edge device of the set is further configured to perform one or more of, extracting energy-related data, detecting and/or correcting errors in energy-related data, transforming, converting, normalizing, and/or cleansing energy-related data, parsing energy-related data, detecting patterns, content, and/or objects in energy-related data, compressing energy-related data, streaming energy-related data, filtering energy-related data, loading and/or storing energy-related data, routing and/or transporting energy-related data, or maintaining security of energy-related data.

In embodiments, at least one edge device of the set includes at least one AI-based model and/or algorithm, wherein the at least one AI-based model and/or algorithm is trained based on a training data set, and the training data set is based on one or more of, one or more human tags and/or labels, one or more human interactions with a hardware and/or software system, one or more outcomes, one or more AI-generated training data samples, a supervised learning training process, a semi-supervised learning training process, or a deep learning training process.

In embodiments, at least one edge device of the set is configured to orchestrate delivery of energy to one or more points of consumption, and the delivery of the energy includes one or more of, one or more fixed transmission lines, one or more instances of wireless energy transmission, one or more deliveries of fuel, or one or more deliveries of stored energy.

In embodiments, at least one edge device of the set is further configured to record, in a distributed ledger and/or blockchain, one or more energy-related events, the one or more energy-related events including one or more of, an energy purchase and/or sale event, a service charge associated with an energy purchase and/or sale event, an energy consumption event, an energy generation event, an energy distribution event, an energy storage event, a carbon emission production event, a carbon emission abatement event, a renewable energy credit event, a pollution production event, or a pollution abatement event.

In embodiments, at least one edge device of the set is deployed in an off-grid environment, and the off-grid environment includes one or more of, an off-grid energy generation system, an off-grid energy storage system, or an off-grid energy mobilization system.

In embodiments, at least one edge device of the set is further configured to determine a change in the carbon generation and/or emissions over a period of time based on a comparison of a current metric of the carbon generation and/or emissions with a historical metric of the carbon generation and/or emissions.

In embodiments, at least one edge device of the set is further configured to determine a target for the carbon generation and/or emissions based on a policy for the carbon generation and/or emissions.

In embodiments, at least one edge device of the set is further configured to, perform a comparison of a metric of the carbon generation and/or emissions with a target of the carbon generation and/or emissions, and determine a compliance of the carbon generation and/or emissions with a policy for the carbon generation and/or emissions based on the comparison.

In embodiments, at least one edge device of the set is further configured to determine an environmental impact of the carbon generation and/or emissions based on a metric of the carbon generation and/or emissions with a target of the carbon generation and/or emissions.

In embodiments, the carbon generation and/or emissions are associated with a set of activities, and at least one edge device of the set is further configured to allocate at least a portion of the carbon generation and/or emissions to at least one activity of the set of activities.

In embodiments, at least one edge device of the set is further configured to associate at least one indicator with a metric of the carbon generation and/or emissions with a target of the carbon generation and/or emissions, wherein the indicator includes one or more of, a date, time, and/or time period of the carbon generation and/or emissions, a source location of the carbon generation and/or emissions, a direction and/or speed of a conveyance of the carbon generation and/or emissions, an impacted location of the carbon generation and/or emissions, a physical metric of the carbon generation and/or emissions, a chemical component of the carbon generation and/or emissions, a weather pattern occurring in an area that is associated with the carbon generation and/or emissions, a wildlife population in an area that is associated with the carbon generation and/or emissions, or a human activity that is affected by the carbon generation and/or emissions.

In embodiments, at least one edge device of the set is further configured to transmit an alert associated with the carbon generation and/or the emissions based on a comparison of a metric of the carbon generation and/or the emissions with an alert threshold associated with the carbon generation and/or the emissions.

In embodiments, at least one edge device of the set is further configured to adjust an activity associated with the carbon generation and/or the emissions based on a metric of the carbon generation and/or the emissions, and the adjusting modifies a future state of the carbon generation and/or the emissions.

### Dynamic Digital Twin of Distributed Energy Demand

In embodiments, an AI-based platform for enabling intelligent orchestration and management of power and energy includes a digital twin that is updated by a data collection system that dynamically maintains a set of historical, current, and/or forecast energy demand parameters for a set of fixed entities and a set of mobile entities within a defined domain, wherein the updating of the digital twin is based on the set of energy demand parameters.

For example, the digital twin may include a digital representation of at least one entity, such as a physical object, person, process, or the like. In some cases, the digital twin may include a representation of multiple entities, such as a collection of machines or computing devices, or a collection of people representing a social group. The digital twin may be configured to correspond to various properties of the entity, such as a digital model of a machine, wherein various properties of the digital model correspond to various physical properties of the machine (e.g., size, shape, relative position and/or orientation, material, composition, or the like). The digital twin may include a number of components that respectively correspond to components of the entity, such as a digital representation including a number of digital components that correspond to various physical components of an entity such as a machine. The digital twin may include representations of relationships among one or more components, such as representations of interconnections among components of a machine, or representations of social connections among members of a social group. The digital twin may include representations of a past, present, and/or future status of the entity, such as a history of past, present, and/or future operating conditions of a machine. The digital twin may include representations of past, present, and/or future events associated with the entity, such as past, present, and/or future operations performed by a machine or past, present, and/or future interactions among members of a social group. The digital twin may include representations of a physical environment in which the entity exists, such as representations of characteristics of an industrial plant in which an industrial machine is located. The digital twin may include representations of dynamic systems like traffic patterns in a city, which may integrate data from vehicles, traffic lights, pedestrian movements, public transportation schedules, etc., to allow city planners to simulate and predict the outcomes of changes like road closures, the introduction of a new metro line, and the like. The digital twin may include representations of interactions between the entity and external entities, such as a digital twin of a social group that includes representations of interactions between members of the social group and other individuals who are not included in the social group. The digital twin may include representations of entire ecosystems to allow researchers to simulate the impact of changes (like installation of a solar farm nearby a forest) on the ecosystem. The digital twin may include representations of a specific organism, say a human body, helping medical professionals predict effects on the human body due to pollution from energy generation facilities. The digital twin may include representations of complex molecular structures or chemical compositions, including properties such as electron distributions, potential reaction sites, etc. to allow researchers to predict how a molecule (say, molecule of a bio-fuel) may behave under certain conditions.

The digital twin may be configured to receive one or more signals that correspond to inputs to the digital twin. For example, a digital twin of an industrial machine may be configured to receive, as input, signals that correspond to materials that are introduced to the machine for industrial processing. Alternatively or additionally, the digital twin may be configured to receive, as input, one or more requests and/or commands to perform one or more operations, based on inputs received by the digital twin and/or an internal state of the digital twin. For example, a digital twin of an industrial machine may receive, as input, a command to perform an industrial process based on inserted materials. Alternatively or additionally, the digital twin may be configured to receive, as input, ambient environmental data to perform one or more control operations. For example, a digital twin of an industrial machine may receive, as input, ambient temperature data to control an industrial process related to inserted materials. Alternatively or additionally, the digital twin may be configured to receive, as input, operational patterns to regulate decision-making. For example, a digital twin of an industrial machine may receive, as input, worker movement patterns to decide path for movement of robots on a floor of an industrial facility. Alternatively or additionally, the digital twin may include an internal state that is altered by input and/or environmental conditions, such as the passage of time. For example, a digital twin of an industrial machine may include representations of the states of the physical components of the industrial machine, and the representations of the digital twin may change to reflect corresponding changes in the state of the internal components due to the performance of industrial processes, the materials processed, environmental factors such as temperature or humidity, or the passage of time. The digital twin may be configured to generate representations of one or more forms of output, such as representations of products of an industrial process. The output may include a representation of defining an internal state of an industrial machine to adapt to materials that are introduced to the machine for industrial processing. The output may include a representation of an updated internal state of the machine, for example, in response to a performed process. The output may include a representation of an adjustment in its internal state, for example, to change ambient conditions for controlling an industrial process. The output may include a representation of e-regulating an internal state of industrial management system, for example, in response to operational patterns.

For example, the digital twin may be configured as a digital representation of a represented entity that functions in a corresponding manner as the entity. For example, in response to a given set of inputs and a given internal state, a physical machine may perform a particular process and may produce a given set of outputs. In an example, the digital twin of a physical robot configured to sort objects based on color may simulate this sorting process when presented with digital representations of colored objects, adjusting its internal logic and subsequent actions. In another example, the digital twin configured to model chemical interactions may simulate the behavior of a certain chemical composition when exposed to specific conditions, and may predict the outcome of a chemical reaction. In yet another example, the digital twin configured to simulate a salesperson's interactions with customers may predict decisions based on inputs like customer queries or displayed emotions. In still another example, the digital twin configured to simulate group behaviors during a collaborative task based on individual's skills, preferences, and historical interactions. The digital twin of the machine is configured to perform a simulation of the particular process based on digital representations of the given set of inputs and the given internal state, and to generate digital representations of outputs that correspond to the given set of outputs. The digital twin may be inspected during performance of the process to determine how the entity is expected to perform the process based on the given set of inputs and the given internal state, wherein the results of the inspection correspond to the results of inspecting the physical machine during performance of the physical process. The outputs of the digital twin may be inspected upon completion of the process, wherein the outputs of the digital twin correspond to the outputs of the machine after completion of the performance of the physical process. The digital twin may support a large variety of processes, inputs, internal states, and the like, and may be expected to correspond to the represented entity (e.g., a represented machine or social group) with regard to its internal state, operating conditions, outputs in response to inputs and internal state, and the like.

For example, the digital twin may include a variety of digital components that correspond to the represented entity. For example, based on a physical component of a machine, the digital twin may include one or more three-dimensional digital (CAD) models that correspond to the physical component of the machine. For example, for a complex system like an autonomous vehicle that relies on multiple sensors and decision-making layers, the digital twin may include a hierarchical organization of machine learning models. For example, when simulating social entities like a community, the digital twin may include a graph-based model to represent the interrelationships within the community. Based on an industrial machine that performs a process, the digital twin may include one or more algorithms that determine outputs of the process based on one or more inputs to the process and/or an internal state of the industrial machine while performing the process. Based on a cognitive process such as a classification task, the digital twin may include one or more machine learning models that correspond to various features of the cognitive process, such as a classifier neural network that classifies inputs in a similar manner as the cognitive process. Based on a transportation system, such as a bus network, the digital twin may include routing algorithms and real-time traffic analytics to simulate the movement of vehicles, determine optimal paths, and forecast potential delays.

In embodiments, a digital twin is included in an AI-based platform for enabling intelligent orchestration and management of power and energy. For example, the digital twin may represent an industrial plant, and the AI-based platform may enable intelligent orchestration and management of power and energy based on actions that have been, are being, and/or could be performed by the industrial plant. The AI-based platform may do so by inspecting various properties of the digital twin during various industrial processes, such as manufacturing processes, transformative processes, and/or transportation processes. Based on the inspection of the digital twin, the AI-based platform may determine how power and energy are generated, stored, transported, and/or consumed by the industrial plant, and may intelligently orchestrate and manage further operation of the industrial plant based on the results of the inspection. For example, the AI-based platform may be guided by a policy of conserving power and energy consumption, and may intelligently orchestrate and/or manage the industrial plant by scheduling the occurrence of industrial processes in a manner that furthers the policy of conserving power and energy consumption, wherein the schedule is based on an inspection of the digital twin to determine how power and energy are consumed by various candidate schedules.

In embodiments, the digital twin is updated by a data collection system that dynamically maintains a set of historical, current, and/or forecast energy demand parameters. For example, the data collection system may store historical, current, and/or forecast energy demand parameters over various time periods, and may dynamically adjust a length of each time period (e.g., choosing shorter time periods during which energy demand is high and/or accuracy of simulating energy demand is of high significance, and choosing longer time periods during which energy demand is low and/or accuracy of simulating energy demand is of low significance). The data collection system may store historical, current, and/or forecast energy demand parameters for various energy-consuming entities, and may dynamically adjust a granularity of data collection for each entity (e.g., collecting copious data on high-consumption entities, and collecting sparse data on low-consumption entities). The data collection system may store historical, current, and/or forecast energy demand parameters for various types of energy, and may dynamically adjust the kind of data stored for each type of energy based on its kind and usage (e.g., for long-term stored energy such as batteries, storing demand parameters such as energy storage capacity, energy storage density, and energy storage and discharge cycles; and for energy in transit such as power conveyances over power lines, storing demand parameters such as average current, peak current, and occurrences of demand surge). The data collection system may dynamically update the collection of historical, current, and/or forecast energy demand parameters (e.g., reconfiguring sensors to collect different forms of data for a particular type of energy demand). Alternatively or additionally, the data collection system may dynamically update the storage of historical, current, and/or forecast energy demand parameters (e.g., reprocessing and modifying stored data to increase, decrease, annotate, summarize, and/or transform the stored data for a particular type of energy demand). Alternatively or additionally, the data collection system may dynamically update the presentation of historical, current, and/or forecast energy demand parameters (e.g., changing the type, amount, and/or structure of data reported for a particular type of energy demand).

In embodiments, a set of operating entities is controlled via a set of edge networking devices that are linked to the set of operating entities, and the energy demand parameters are based on one or more of, a current set of aggregate data derived from demand from the set of operating entities, wherein the set of operating entities is controlled via a set of edge networking devices that are linked to the set of operating entities, a historical set of aggregate data derived from demand from the set of operating entities, wherein the set of operating entities is controlled via a set of edge networking devices that are linked to the set of operating entities, or a simulated set of aggregate data derived from demand from the set of operating entities.

In embodiments, the data collection system is further configured to adapt a transport of data over a network and/or communication system, wherein the adapting is based on one or more of, a congestion condition, a delay and/or latency condition, a packet loss condition, an error rate condition, a cost of transport condition, a quality-of-service (QoS) condition, a usage condition, a market factor condition, or a user configuration condition.

In embodiments, the digital twin represents one or more of, an energy stakeholder entity, an energy distribution resource, a stakeholder information technology, a networking infrastructure entity, an energy-dependent stakeholder production facility, a stakeholder transportation system, a market condition, or an energy usage priority condition.

In embodiments, the digital twin is further configured to perform one or more of, providing a visual and/or analytic indicator of energy consumption by one or more energy consumers, filtering energy data, highlighting energy data, adjusting energy data, or generating a visual and/or analytic indicator of energy consumption by one or more of, one or more machines, one or more factories, or one or more vehicles in a vehicle fleet.

In embodiments, at least one of the energy demand parameters is based on one or more of, on one or more public data resources, the one or more public data resources including one or more of, a weather data resource, a satellite data resource, a census, population, demographic, and/or psychographic data resource, a market data resource, or an ecommerce data resource, or one or more enterprise data resources, the one or more enterprise data resources including one or more of, resource planning data, sales and/or marketing data, financial planning data, demand planning data, supply chain data, procurement data, pricing data, customer data, product data, or operating data.

In embodiments, the digital twin includes at least one AI-based model and/or algorithm, wherein the at least one AI-based model and/or algorithm is trained based on a training data set, and the training data set is based on one or more of, one or more human tags and/or labels, one or more human interactions with a hardware and/or software system, one or more outcomes, one or more AI-generated training data samples, a supervised learning training process, a semi-supervised learning training process, or a deep learning training process.

In embodiments, the digital twin is further configured to orchestrate delivery of energy to one or more points of consumption, and the delivery of the energy includes one or more of, one or more fixed transmission lines, one or more instances of wireless energy transmission, one or more deliveries of fuel, or one or more deliveries of stored energy.

In embodiments, the digital twin is further configured to adjust the delivery of energy to the one or more points of consumption based on an energy delivery and/or consumption policy.

In embodiments, the digital twin is further configured to determine a carbon generation and/or emissions effect of the delivery of energy to the one or more points of consumption.

In embodiments, the digital twin is further configured to adjust the delivery of energy to the one or more points of consumption based on a probability of a deficiency of available energy at the one or more points of consumption and a consequence of the deficiency of available energy at the one or more points of consumption.

In embodiments, the digital twin is further configured to determine the delivery of energy to the one or more points of consumption based on a comparison of energy availability at each of two or more energy sources, wherein the comparison includes one or more of, a current and/or future quantity of energy stored by at least one of the two or more energy sources, a current and/or future resource expenditure associated with acquiring, storing, and/or delivering the energy by at least one of the two or more energy sources, or a current and/or future demand by other energy consumers for the energy of at least one of the two or more energy sources.

In embodiments, the digital twin is further configured to record, in a distributed ledger and/or blockchain, one or more energy-related events, the one or more energy-related events including one or more of, an energy purchase and/or sale event, a service charge associated with an energy purchase and/or sale event, an energy consumption event, an energy generation event, an energy distribution event, an energy storage event, a carbon emission production event, a carbon emission abatement event, a renewable energy credit event, a pollution production event, or a pollution abatement event.

In embodiments, the digital twin is deployed in an off-grid environment, and the off-grid environment includes one or more of, an off-grid energy generation system, an off-grid energy storage system, or an off-grid energy mobilization system.

In embodiments, the AI-based platform is configured to measure a performance of the digital twin based on a prediction delta, and the prediction delta is based on a comparison of a prediction generated by the digital twin based on the set of energy demand parameters with a measurement within the data collection system that corresponds to the prediction.

In embodiments, the AI-based platform is configured to update the digital twin based on the prediction delta, and the updating includes one or more of, retraining the digital twin based on the prediction delta, adjusting a prediction correction applied to predictions of the digital twin based on the prediction delta, supplementing the digital twin with at least one other trained machine learning model, or replacing the digital twin with a substitute digital twin.

In embodiments, the digital twin is further configured to generate, a prediction based on at least one of the energy demand parameters, and an indication of an effect of at least one of the energy demand parameters on the prediction.

In embodiments, the digital twin is further configured to determine one or more modifications of the set of energy demand parameters to improve future predictions of the digital twin, wherein the one or more modifications include one or more of, one or more additional historical, current, and/or forecast energy demand parameters associated with the set of fixed entities and the set of mobile entities within the defined domain, or one or more modifications of one or more of the historical, current, and/or forecast energy demand parameters associated with the set of fixed entities and the set of mobile entities within the defined domain.

In embodiments, the digital twin is further configured to orchestrate a delivery of energy to one or more points of consumption based on one or more entity parameters received from at least one entity of the set of fixed entities and/or the set of mobile entities within the defined domain, and the one or more entity parameters includes one or more of, a current and/or future energy status of the at least one entity, a current and/or future energy consumption by the at least one entity, or a current and/or future activity performed by the at least one entity that is associated with energy consumption.

In embodiments, the digital twin is further configured to transmit, to at least one entity of the set of fixed entities and/or the set of mobile entities within the defined domain, a request to adjust one or more entity parameters associated with the at least one entity, and the one or more entity parameters includes one or more of, a current and/or future energy status of the at least one entity, a current and/or future energy consumption by the at least one entity, or a current and/or future activity performed by the at least one entity that is associated with energy consumption.

Modular, Distributed Energy Systems that are Configurable Based on Local Demand Requirements

In embodiments, an AI-based platform for enabling intelligent orchestration and management of power and energy includes a set of modular, distributed energy systems that are configurable based on local demand requirements.

For example, the modular, distributed energy systems may include one or more energy generation systems, such as one or more solar panels or solar panel farms; one or more wind-powered generators such as windmills; one or more water-powered generators such as hydroelectric plants; one or more nuclear power facilities; one or more geothermal generators; or the like. The modular, distributed energy systems may include one or more energy storage systems, such as one or more batteries, capacitors, flywheels, or fuel tanks. The modular, distributed energy systems may include one or more energy transportation systems, such as electric power transmission lines, wireless power routes, and/or vehicular transportation facilities. The modular, distributed energy systems may include one or more energy consumption systems, such as an industrial plant that consumes power to perform various industrial processes. One or more of the energy systems may be mobile (e.g., a mobile solar farm). One or more of the energy systems may be stationary (e.g., a power plant).

For example, the modular energy systems may be distributed in various ways. For example, the energy systems may be owned, operated, managed, and/or accessed by different entities, such as power plants owned by different governments or companies and/or used by different consumers. The energy systems may be geographically distributed in different locations of a geographic region, such as different cities or provinces in a state. The energy systems may be operationally distributed, e.g., industrial plants associated with different types of industrial processing in different industries. The energy systems may be functionally distributed, e.g., a subset of on-grid energy systems that commonly access and depend upon a power grid, and a subset of off-grid energy systems that do not commonly access and/or do not depend upon the power grid.

The modular energy systems may be configurable based on local demand requirements. For example, peak energy demand may vary in different areas due to varying geographic weather conditions. Accordingly, each energy generating system of a modular, distributed set of generating systems may change an amount of generated energy based on the energy demand in a locale associated with the energy generating system. As another example, surge capacity energy demand may vary for different industrial processes (e.g., a server farm may consume a relatively consistent amount of power and may not often produce surges in demand, while a manufacturing plant may frequently require surge power to accommodate high-production periods and/or energy-intensive processes). Accordingly, each energy generating system of a modular, distributed set of generating systems may change an amount of reserved capacity to accommodate demand surges based on the energy demand of an industry that is associated with the energy generating system. As yet another example, energy demand among a population of entities (e.g., individuals, companies, vehicles, or the like) may change in location due to travel and migration patterns among the entities. Accordingly, each energy generating system of a modular, distributed set of generating systems may change a location of energy provision and access resources (e.g., locations of mobile power delivery resources) based on the dynamic locations of energy demand. As still another example, seasonal events and festivities (e.g., regions celebrating major holidays) may also lead to variations in local energy demand due to increased usage of lighting, heating or cooling appliances, etc. Accordingly, each energy generating system of a modular, distributed set of generating systems may be configured to increase energy production during these periods to meet the demand. As still another example, tourism during peak tourist seasons can significantly influence local energy demand (e.g., owing to the operation of hotels, resorts, and various tourist attractions at full capacity). Accordingly, each energy generating system of a modular, distributed set of generating systems may be configured with predictive models to forecast tourist inflow, and thereby increase or decrease energy production based on anticipated demand.

In embodiments, the modular energy systems are configured based on local demand requirements in a decentralized manner. For example, a modular energy system may determine, within a set of energy demand requirements, a subset of energy demand requirements that the modular energy system is to be configured to serve, and the modular energy system may reconfigure its resources to serve the identified energy demand requirements. For example, each modular energy system may determine an allocation of its resources to meet a subset of the energy demand requirements without direct instruction from a centralized allocation process, such as a centralized server. A modular energy system may receive an instruction from a centralized server (e.g., an identification of a subset of energy demand requirements to be served by the modular energy system) and may determine its configuration in a decentralized, distributed manner (e.g., determining an allocation of its resources in order to serve the identified energy demand requirements). A modular energy system may perform a decentralized, distributed determination of a subset of energy demand requirements to be served by the modular energy system, and may receive a corresponding configuration from a centralized allocation process, such as a centralized server (e.g., receiving a configuration of its resources in order to serve the energy demand requirements that were identified in a decentralized, distributed manner).

In embodiments, a modular energy system is configured in a distributed, decentralized manner based on automated discovery of information. For example, the modular energy system may include and/or have access to a variety of sensors or information sources, and may automatically discover, identify, and/or characterize a set of energy demand requirements (e.g., an automated exploration of industrial processes of an industrial plant, or an automated survey of energy usage of a set of energy supplies such as batteries or outlets). The modular energy system may use the automatically discovered information to determine a configuration of energy resources to serve the discovered energy demand requirements, optionally without communicating with other modular energy systems and/or any centralized allocation process in regard to the automatically discovered information and/or configuration.

In embodiments, a modular energy system communicates with one or more other modular energy systems to identify a subset of energy demand requirements to be met and/or a configuration of an allocation of resources that may serve the subset of energy demand requirements. Such communication may include, for example, communication techniques such as information sharing, voting, consensus, negotiation, software agents, policy discovery and/or development, objective optimization, simulation, stochastic modeling, or the like.

In embodiments, a modular energy system is configured to determine an allocation of energy resources to serve an identified set of energy demand requirements. For example, the modular energy system may include a number of energy stores, and the modular energy system may determine locations of the energy stores based on the locations of energy demand requirements within a region. The modular energy system may also arrange transportation of the energy stores to arrive at the determined locations (e.g., a configuration of a fleet of autonomous vehicles to transport the energy stores to the determined locations). The modular energy system may include energy stores of various types, wherein each type has various properties, such as energy storage capacity, energy storage status, peak power delivery, power delivery surge capacity, or the like. The modular energy system may allocate the energy stores to serve various energy demand requirements based on matching the properties of each energy store with corresponding properties of the energy demand requirements (e.g., allocating an energy store to a particular energy consumer that has sufficient power delivery capacity to meet the power consumption requirement of the energy consumer). The modular energy system may be integrated with predictive analytics capabilities to forecast future energy demands and identify patterns of energy consumption of different areas for allocation of energy resources to different areas accordingly. The modular energy system may be configured to respond to emergency situations by dynamically allocating stored energy from non-essential zones to critical facilities such as hospitals. The modular energy system may be synchronized with traffic management systems to understand the flow of traffic patterns and predict the demand from electric vehicles for charging stations in different zones, and accordingly allocate energy resources to the charging stations.

In embodiments, the modular energy system may determine locations of the energy stores based on the locations of energy demand requirements within a region.

In embodiments, the local demand requirements are forecast by demand forecasting algorithm operating on a set of edge networking devices that are linked to a set of systems that consume energy.

In embodiments, at least one of the modular, distributed energy systems of the set is configured by the AI-based platform to be located in proximity to a location and time of demand.

In embodiments, at least one of the modular, distributed energy systems of the set is configured by the AI-based platform to be located based on a location and type of a local demand requirement.

In embodiments, at least one of the modular, distributed energy systems of the set is configured by the AI-based platform to generate energy at a point of local demand.

In embodiments, at least one of the modular, distributed energy systems of the set is configured by the AI-based platform to deliver a modular generation system to a location of demand.

In embodiments, at least one of the modular, distributed energy systems of the set is configured by the AI-based platform to route a delivery of energy by a set of energy delivery facilities to a location of demand.

In embodiments, at least one of the modular, distributed energy systems of the set is orchestrated by the AI-based platform to store energy in proximity to a location and time of demand.

In embodiments, at least one of the modular, distributed energy systems of the set is further configured to adapt a transport of data over a network and/or communication system, wherein the adapting is based on one or more of, a congestion condition, a delay and/or latency condition, a packet loss condition, an error rate condition, a cost of transport condition, a quality-of-service (QoS) condition, a usage condition, a market factor condition, or a user configuration condition.

In embodiments, the AI-based platform includes an adaptive energy digital twin that represents one or more of, an energy stakeholder entity, an energy distribution resource, a stakeholder information technology, a networking infrastructure entity, an energy-dependent stakeholder production facility, a stakeholder transportation system, a market condition, or an energy usage priority condition.

In embodiments, the AI-based platform includes an adaptive energy digital twin that is configured to perform one or more of, providing a visual and/or analytic indicator of energy consumption by one or more energy consumers, filtering energy data, highlighting energy data, adjusting energy data, or generating a visual and/or analytic indicator of energy consumption by one or more of, one or more machines, one or more factories, or one or more vehicles in a vehicle fleet.

In embodiments, at least one of the modular, distributed energy systems is further configured to perform one or more of, extracting energy-related data, detecting and/or correcting errors in energy-related data, transforming, converting, normalizing, and/or cleansing energy-related data, parsing energy-related data, detecting patterns, content, and/or objects in energy-related data, compressing energy-related data, streaming energy-related data, filtering energy-related data, loading and/or storing energy-related data, routing and/or transporting energy-related data, or maintaining security of energy-related data.

In embodiments, the local demand requirements are based one or more of, on one or more public data resources, the one or more public data resources including one or more of, a weather data resource, a satellite data resource, a census, population, demographic, and/or psychographic data resource, a market data resource, or an ecommerce data resource, or one or more enterprise data resources, the one or more enterprise data resources including one or more of, resource planning data, sales and/or marketing data, financial planning data, demand planning data, supply chain data, procurement data, pricing data, customer data, product data, or operating data.

In embodiments, the AI-based platform includes at least one AI-based model and/or algorithm, wherein the at least one AI-based model and/or algorithm is trained based on a training data set, and the training data set is based on one or more of, one or more human tags and/or labels, one or more human interactions with a hardware and/or software system, one or more outcomes, one or more AI-generated training data samples, a supervised learning training process, a semi-supervised learning training process, or a deep learning training process.

In embodiments, at least one of the modular, distributed energy systems is configured to orchestrate delivery of energy to one or more points of consumption, and the delivery of the energy includes one or more of, one or more fixed transmission lines, one or more instances of wireless energy transmission, one or more deliveries of fuel, or one or more deliveries of stored energy.

In embodiments, wherein a first system of the modular, distributed energy systems is configured to communicate with a second system of the modular, distributed energy systems to orchestrate the delivery of energy to the one or more points of consumption by adjusting an energy generation, storage, delivery, and/or consumption by one or both of the first system or the second system.

In embodiments, at least one of the modular, distributed energy systems is configured to adjust the delivery of energy to the one or more points of consumption based on a carbon generation and/or emissions policy.

In embodiments, at least one of the modular, distributed energy systems is further configured to record, in a distributed ledger and/or blockchain, one or more energy-related events, the one or more energy-related events including one or more of, an energy purchase and/or sale event, a service charge associated with an energy purchase and/or sale event, an energy consumption event, an energy generation event, an energy distribution event, an energy storage event, a carbon emission production event, a carbon emission abatement event, a renewable energy credit event, a pollution production event, or a pollution abatement event.

In embodiments, at least one of the modular, distributed energy systems is deployed in an off-grid environment, and the off-grid environment includes one or more of, an off-grid energy generation system, an off-grid energy storage system, or an off-grid energy mobilization system.

In embodiments, at least one of the modular, distributed energy systems is associated with a digital twin that is configured to model and/or predict one or more properties and/or operations of the at least one of the modular, distributed energy systems.

### Process-Aware AI Platform for Orchestration and Management of Power and Energy

In embodiments, an AI-based platform for enabling intelligent orchestration and management of power and energy includes an artificial intelligence system that is configured to: perform an analysis of a pattern of energy associated with an operating process that involves a set of resources, the set of resources being at least partially independent of an electrical grid; and output a set of operating parameters to provision energy generation, storage, and/or consumption to enable the operating process, wherein the set of operating parameters is based on the analysis.

For example, the operating process may include a manufacturing process that involves a set of energy resources, such as a supply of fuel to transport manufacturing materials to a manufacturing facility; a supply of power to operate the machines that perform the manufacturing process; a supply of power to perform auxiliary processes, such as data collection, auditing, and reporting; a supply of power to store manufacturing raw materials and/or manufactured products, such as refrigeration; and a supply of fuel to transport manufactured products to destinations.

The energy resources are at least partly independent of an electrical grid. For example, fuel may be delivered by one or more fuel pipelines or fuel transport vehicles that do not depend on an electrical grid. Power may be delivered by one or more renewable power resources that do not depend on an electrical grid, such as solar panels, solar farms, wind turbines, hydroelectric power facilities, or nuclear power plants. Power may be stored by one or more power storage facilities that do not depend on an electrical grid, such as a battery, a capacitor, or a fuel tank or pipeline. In some cases, one or more of the energy resources may be partly coupled to an electrical grid, such as a backup source of power in case a primary mechanism of power generation, storage, and/or transport were to fail, or as a source of power for performing auxiliary functions, such as monitoring or auditing a state or capacity of the resources. In some cases, one or more of the energy resources may be completely independent of an electrical grid, such as a manufacturing plant that is supplied by power entirely and exclusively by a solar panel farm.

The AI-based platform may perform an analysis of the operating processes to determine patterns of energy associated with the operating process. For example, the AI-based platform may determine patterns of energy availability, such as deliveries of fuel to fuel depots or vehicles and/or patterns of power delivery by power lines to on-premises power storage facilities. The AI-based platform may determine patterns of energy storage, such as peak storage capacity, peak storage, peak storage density, per-unit storage cost efficiency, leakage of stored power, or power surge capacity. The AI-based platform may determine patterns of energy transport, such as patterns of fuel delivery by fuel pipelines and/or fuel delivery vehicles, or patterns of power transfer via power lines. The AI-based platform may determine patterns of energy consumption, such as peak power demand, power demand surge, power usage efficiency, or power consumption waste.

The AI-based platform may perform such determinations of patterns based on a variety of analytic techniques. Such analytic techniques may include, for example: auditing of collected information, including historical, current, and/or forecast information; simulation, including one or more digital twins of various energy resources and/or energy-related processes; stochastic modeling; classification; clustering; time series analysis; geospatial analysis; deep learning; and/or inference by one or more machine learning models. These techniques enable the AI-based platform to understand, predict, and manage energy patterns with precision and efficiency.

In embodiments, at least one operating parameter in the set of operating parameters is a generation output level for a distributed energy generation resource.

In embodiments, at least one operating parameter in the set of operating parameters is a target storage level for a distributed energy storage resource.

In embodiments, at least one operating parameter in the set of operating parameters is a delivery timing for a distributed energy delivery resource.

In embodiments, the artificial intelligence system is further configured to adapt a transport of data over a network and/or communication system, wherein the adapting is based on one or more of, a congestion condition, a delay and/or latency condition, a packet loss condition, an error rate condition, a cost of transport condition, a quality-of-service (QoS) condition, a usage condition, a market factor condition, or a user configuration condition.

In embodiments, the AI-based platform includes an adaptive energy digital twin that represents one or more of, an energy stakeholder entity, an energy distribution resource, a stakeholder information technology, a networking infrastructure entity, an energy-dependent stakeholder production facility, a stakeholder transportation system, a market condition, or an energy usage priority condition.

In embodiments, the AI-based platform includes an adaptive energy digital twin that is configured to perform one or more of, providing a visual and/or analytic indicator of energy consumption by one or more energy consumers, filtering energy data, highlighting energy data, adjusting energy data, or generating a visual and/or analytic indicator of energy consumption by one or more of, one or more machines, one or more factories, or one or more vehicles in a vehicle fleet.

In embodiments, the artificial intelligence system is further configured to perform one or more of, extracting energy-related data, detecting and/or correcting errors in energy-related data, transforming, converting, normalizing, and/or cleansing energy-related data, parsing energy-related data, detecting patterns, content, and/or objects in energy-related data, compressing energy-related data, streaming energy-related data, filtering energy-related data, loading and/or storing energy-related data, routing and/or transporting energy-related data, or maintaining security of energy-related data.

In embodiments, at least one of the operating parameters is based on one or more of, one or more public data resources, the one or more public data resources including one or more of, a weather data resource, a satellite data resource, a census, population, demographic, and/or psychographic data resource, a market data resource, or an ecommerce data resource, or one or more enterprise data resources, the one or more enterprise data resources including one or more of, resource planning data, sales and/or marketing data, financial planning data, demand planning data, supply chain data, procurement data, pricing data, customer data, product data, or operating data.

In embodiments, the artificial intelligence system is trained based on a training data set, and the training data set is based on one or more of, one or more human tags and/or labels, one or more human interactions with a hardware and/or software system, one or more outcomes, one or more AI-generated training data samples, a supervised learning training process, a semi-supervised learning training process, or a deep learning training process.

In embodiments, the artificial intelligence system is configured to orchestrate delivery of energy to one or more points of consumption, and the delivery of the energy includes one or more of, one or more fixed transmission lines, one or more instances of wireless energy transmission, one or more deliveries of fuel, or one or more deliveries of stored energy.

In embodiments, the artificial intelligence system is further configured to record, in a distributed ledger and/or blockchain, one or more energy-related events, the one or more energy-related events including one or more of, an energy purchase and/or sale event, a service charge associated with an energy purchase and/or sale event, an energy consumption event, an energy generation event, an energy distribution event, an energy storage event, a carbon emission production event, a carbon emission abatement event, a renewable energy credit event, a pollution production event, or a pollution abatement event.

In embodiments, the artificial intelligence system is deployed in an off-grid environment, and the off-grid environment includes one or more of, an off-grid energy generation system, an off-grid energy storage system, or an off-grid energy mobilization system.

In embodiments, the artificial intelligence system is further configured to determine an environmental impact of a carbon generation and/or emission associated with the operating process on an area that is associated with the operating process.

In embodiments, the artificial intelligence system is further configured to evaluate a compliance of the operating process with one or both of, a carbon generation and/or emissions policy, or a set of labor standards associated with the operating process.

In embodiments, the artificial intelligence system is further configured to adjust the set of operating parameters to provision energy generation, storage, and/or consumption associated with the operating process based on one or both of, a carbon generation and/or emissions policy, or a set of labor standards associated with the operating process.

In embodiments, the artificial intelligence system is further configured to transmit a message to at least one edge device of a set of edge devices that are associated with the operating process, and the message includes a request to adjust at least one operation of the at least one edge device based on the set of operating parameters.

In embodiments, the artificial intelligence system is further configured to receive, from at least one edge device of a set of edge devices that are associated with the operating process, an indicator of a current and/or predicted energy status of the at least one edge device, and the set of operating parameters is based on the indicator of the current and/or predicted energy status of the at least one edge device.

In embodiments, the artificial intelligence system is further configured to determine the set of operating parameters based on an output of a digital twin that represents at least one edge device of a set of edge devices that are associated with the operating process, and the output of the digital twin indicates a current and/or predicted energy status of the at least one edge device.

In embodiments, the artificial intelligence system is further configured to orchestrate a set of modular, distributed energy systems to generate, store, and/or deliver energy, wherein the orchestrating is based on the set of operating parameters and local demand requirements.

### Policy and Governance Engines for Energy and Power Management of Edge Computing Devices

In embodiments, an AI-based platform for enabling intelligent orchestration and management of power and energy includes a policy and governance engine configured to deploy a set of rules and/or policies that govern a set of energy generation, storage, and/or consumption workloads, wherein the rules and/or policies are associated with a configuration of a set of edge devices operating in local data communication with a set of energy generation facilities, energy storage facilities, energy delivery facilities or energy consumption systems.

For example, the rules and/or policies may include one or more objectives related to energy generation, storage, and/or consumption workloads. Such objectives may include, for example: energy efficiency; energy conservation; maximization of matching between energy supply and energy demand (e.g., allocating energy sources to energy consumption based on factors such as peak demand, surge demand, and total energy usage); reduction of the generation and/or emission of carbon-based substances; cost reduction; reduction of risk of energy shortages and/or cost surpluses; availability of energy for surge and/or emergency demand; and/or prioritization of renewable energy sources over non-renewable energy sources.

For example, the AI-based platform may receive the set of rules and/or policies from a policy source, such as a user, an organization, a government, or a policy bank. Alternatively or additionally, the AI-based platform may automatically generate and/or refine the set of rules and/or policies based on various heuristics (e.g., based on an objective of optimizing an efficiency of an organization, the AI-based platform may automatically determine a rule and/or policy of conserving energy). Alternatively or additionally, the AI-based platform may automatically generate and/or refine the set of rules and/or policies based on various sources of information (e.g., based on historical data of energy supply, demand, and shortages during various industrial processes of an industrial plant, the AI-based platform may determine rules and/or policies that are likely to reduce energy shortages and/or improve efficiency of energy use in the future).

In embodiments, the AI-based platform uses the set of rules and/or policies that govern the set of energy generation, storage, and/or consumption workloads to determine the configuration of the set of edge devices. For example, the AI-based platform may configure an allocation of the set of edge devices to monitor various aspects of the energy generation, storage, and/or consumption workloads. For example, various edge devices may include various sensors that may be connected to various data sources to monitor various aspects of the workloads. Based on rules and/or policies associated with conserving energy, the AI-based platform may configure the edge devices to configure the sensors to monitor workloads that have been determined to consume high amounts of energy and/or to be energy-inefficiency. The adaptation of the edge devices to focus their monitoring capabilities on the workloads that are likely to be sources of high energy consumption and/or inefficiency may inform analyses of industrial process changes that may improve energy conservation. As another example, the edge devices may be operably coupled to various industrial machines and/or processes, and may be configurable to adapt various operational parameters of such industrial machines and/or processes, such as a schedule, speed, temperature, or manufacturing capacity of the industrial machine and/or process. Based on rules and/or policies associated with improving energy efficiency, the AI-based platform may configure the edge devices to adjust various operational parameters of such industrial machines and/or processes, such as choosing a schedule or operating speed of an industrial machine that exhibits comparatively high energy usage efficiency. As yet another example, the AI-based platform may configure the edge devices to prioritize monitoring of renewable energy generation sources, such as wind turbines or solar panels, to ensure their optimal functioning. Based on rules and/or policies associated with monitoring, the AI-based platform may configure the edge devices to detect if there is a decrease in energy production from these sources, such as, for example, if a solar panel's efficiency drops due to accumulated dirt or a malfunction. In such case, the edge devices may alert maintenance teams to clean the solar panel to optimize energy generation. As still another example, the AI-based platform may configure the edge devices to monitor real-time energy pricing from the grid. Based on rules and/or policies associated with pricing, the AI-based platform may configure the edge devices to automatically adjust the operational parameters of connected devices, like HVAC systems, to operate at their minimal required level when electricity prices surge during peak demand periods.

In embodiments, upon configuration in the policy and governance engine, a policy associated with an energy generation instruction is automatically applied by at least one of the edge devices to control energy generation by at least one energy generation system that is controlled via the edge device.

In embodiments, upon configuration in the policy and governance engine, a policy associated with an energy consumption instruction is automatically applied by at least one of the edge devices to control energy consumption by at least one energy consuming system that is controlled via the edge device.

In embodiments, upon configuration in the policy and governance engine, a policy associated with an energy delivery instruction is automatically applied by at least one of the edge devices to control energy delivery by at least one energy delivery system that is controlled via the edge device.

In embodiments, upon configuration in the policy and governance engine, a policy associated with an energy storage instruction is automatically applied by at least one of the edge devices to control energy storage by at least one energy storage system that is controlled via the edge device.

In embodiments, the policy and governance engine is configured to operate on a stored set of policy templates in order to configure a policy.

In embodiments, a set of recommended policies is automatically generated for presentation in the policy and governance engine based on a data set of historical policies, a data set representing operating states and/or configurations of a set of distributed energy resources, and a set of historical outcomes.

In embodiments, the policy and governance engine is further configured to adjust the rules and/or policies based on at least one contextual factor, and the at least one contextual factor includes at least one of, historical data of energy transactions, at least one operational factor, at least one market factor, at least one anticipated market behavior, or at least one anticipated customer behavior.

In embodiments, the policy and governance engine is further configured to adapt a transport of data over a network and/or communication system, wherein the adapting is based on at least one of, a congestion condition, a delay and/or latency condition, a packet loss condition, an error rate condition, a cost of transport condition, a quality-of-service (QoS) condition, a usage condition, a market factor condition, or a user configuration condition.

In embodiments, the AI-based platform of claim 1, further comprising an adaptive energy digital twin that represents at least one of, an energy stakeholder entity, an energy distribution resource, a stakeholder information technology, a networking infrastructure entity, an energy-dependent stakeholder production facility, a stakeholder transportation system, a market condition, or an energy usage priority condition.

In embodiments, the AI-based platform of claim 1, further comprising an adaptive energy digital twin that is configured to perform at least one of, providing a visual and/or analytic indicator of energy consumption by at least one energy consumer, filtering energy data, highlighting energy data, or adjusting energy data.

In embodiments, the AI-based platform of claim 1, further comprising an adaptive energy digital twin that is configured to generate a visual and/or analytic indicator of energy consumption by at least one of, at least one machine, at least one factory, or at least one vehicle in a vehicle fleet.

In embodiments, the policy and governance engine is further configured to perform at least one of, extracting energy-related data, detecting and/or correcting errors in energy-related data, transforming, converting, normalizing, and/or cleansing energy-related data, parsing energy-related data, detecting patterns, content, and/or objects in energy-related data, compressing energy-related data, streaming energy-related data, filtering energy-related data, loading and/or storing energy-related data, routing and/or transporting energy-related data, or maintaining security of energy-related data.

In embodiments, at least one of the rules and/or policies is based on at least one public data resource, the at least one public data resource including at least one of, a weather data resource, a satellite data resource, a census, population, demographic, and/or psychographic data resource, a market data resource, or an ecommerce data resource.

In embodiments, at least one of the rules and/or policies is based on at least one enterprise data resource, the at least one enterprise data resource including at least one of, resource planning data, sales and/or marketing data, financial planning data, demand planning data, supply chain data, procurement data, pricing data, customer data, product data, or operating data.

In embodiments, the AI-based platform of claim 1, further comprising at least one AI-based model and/or algorithm, wherein the at least one AI-based model and/or algorithm is trained based on a training data set, and the training data set is based on at least one of, at least one human tag and/or label, at least one human interaction with a hardware and/or software system, at least one outcome, at least one AI-generated training data sample, a supervised learning training process, a semi-supervised learning training process, or a deep learning training process.

In embodiments, the policy and governance engine is configured to orchestrate delivery of energy to at least one point of consumption, and the delivery of the energy includes at least one of, at least one fixed transmission line, at least one instance of wireless energy transmission, at least one delivery of fuel, or at least one delivery of stored energy.

In embodiments, the policy and governance engine is further configured to record, in a distributed ledger and/or blockchain, at least one energy-related event, the at least one energy-related event including at least one of, an energy purchase and/or sale event, a service charge associated with an energy purchase and/or sale event, an energy consumption event, an energy generation event, an energy distribution event, an energy storage event, a carbon emission production event, a carbon emission abatement event, a renewable energy credit event, a pollution production event, or a pollution abatement event.

In embodiments, the policy and governance engine is deployed in an off-grid environment, and the off-grid environment includes at least one of, an off-grid energy generation system, an off-grid energy storage system, or an off-grid energy mobilization system.

In embodiments, the policy and governance engine is further configured to generate and/or execute at least one smart contract, wherein each of the at least one smart contract applies the rules and/or policies to at least one energy-related transaction.

### Governance Engines for Energy- and Power-Related Facilities and Systems

In embodiments, an AI-based platform for enabling intelligent orchestration and management of power and energy includes a set of edge devices configured to, communicate with at least one energy generation facility, energy storage facility, and/or energy consumption system, and automatically execute a set of preconfigured policies that govern energy generation, energy storage, or energy consumption of the respective energy generation facilities, energy storage facilities, or energy consumption systems.

For example, each edge device of the set of edge devices may be configured to manage the operations of a particular energy generation and/or storage facility, and to execute a preconfigured policy based on an objective of operating the energy generating and/or storage facility based on historical, current, and/or forecast energy demands. In furtherance of this preconfigured policy, each edge device may communicate with other energy generation facilities, energy storage facilities, and/or energy consumption facilities to determine patterns in energy generation, storage, transport, and/or consumption that indicate some periods of overall available power sufficiency for energy consumers and some periods of some periods of overall available power scarcity for energy consumers. Based on this communication and the preconfigured policy, the edge device may determine a schedule of various operating processes of the energy generation and/or storage facility, such that the energy generation and/or storage facility is configured to generate and/or store sufficient power for at least a portion for the energy consumers. For example, the edge device may configure an energy generation plant to generate more energy in anticipation of a surge of energy demand by the energy consumers, and to generate less energy in anticipation of a diminishing energy demand by the energy consumers. As another example, the edge device may configure an energy storage facility to store more energy in anticipation of a surge of energy demand by the energy consumers, and to store less energy in anticipation of a diminishing energy demand by the energy consumers.

As another example, each edge device of the set of edge devices may be configured to manage the operations of a particular industrial plant, and to execute a preconfigured policy based on an objective of operating the industrial plant based on the sufficiency of available power. In furtherance of this preconfigured policy, each edge device may communicate with the collection of energy generation facilities, energy storage facilities, and/or energy consumption facilities to determine patterns in energy generation, storage, transport, and/or consumption that indicate some periods of overall available power sufficiency for the industrial plant and some periods of some periods of overall available power scarcity. Based on this communication and the preconfigured policy, the edge device may determine a schedule of various operating processes of the industrial plant, such that the operations are scheduled to occur during the determined periods of overall available power sufficiency and not to occur during the determined periods of overall available power scarcity.

As another example, each edge device of the set of edge devices may be configured to manage the operations of a particular energy consumer, and to execute a preconfigured policy based on an objective of operating the industrial plant based on a prioritization of available power. For example, while sufficient power may be forecast to be available for all of the energy consumption systems, some energy consumption systems, such as hospitals, emergency vehicles, and uninterruptible industrial processes, may represent higher-priority uses of power than other energy consumption systems, such as interruptible industrial processes and leisure facilities. In furtherance of this preconfigured policy, each edge device may communicate with the collection of energy generation facilities, energy storage facilities, and/or energy consumption facilities to determine both the energy consumption patterns of various energy consumers and their respective priorities. Based on this communication and the preconfigured policy, the edge device may determine an allocation and/or schedule of various operating processes of the energy consumer, such that plentiful energy is always available and reserved for high-priority energy consumers (e.g., hospitals and personal residences), and operating processes of lower-priority energy consumers (e.g., interruptible industrial processes) only occur when sufficient energy is available in excess of the energy requirements of the high-priority energy consumers.

As yet another example, each edge device of the set of edge devices may be configured to manage the operations of an interconnected grid system, comprising both renewable and non-renewable energy sources. The preconfigured policy may be based on an objective of maximizing the use of renewable energy while ensuring grid stability. In furtherance of this preconfigured policy, each edge device may communicate with a collection of solar farms, wind turbines, hydroelectric plants, as well as conventional coal and gas plants. Based on this communication and the preconfigured policy, the edge device may determine the availability of energy from each source. By way of example, during periods of sunshine or high wind speeds, the edge device may prioritize using power from solar panels or wind turbines, respectively; however, if a drop in renewable energy generation is anticipated due to weather changes, the edge device may pre-emptively increase energy use from more consistent sources, like hydroelectric plants or switch to backup non-renewable sources, to promote the use of clean energy without compromising grid stability.

As yet another example, each edge device of the set of edge devices may be configured to manage energy operations within a smart city infrastructure. The preconfigured policy may be based on optimizing energy distribution across various city services in view of daily urban activities and events. In furtherance of this preconfigured policy, each edge device may communicate with public transport systems, public facilities, etc. Based on this communication and the preconfigured policy, the edge device may determine energy needs and accordingly adjust energy allocation to ensure that energy needs of the city are met efficiently.

In embodiments, the automatically executed policies are a set of contextual policies that adjust based on a current status of a set of energy generation entities in an energy grid.

In embodiments, the automatically executed policies are a set of contextual policies that adjust based on a current status of a set of energy generation entities in an energy generation environment that includes an energy grid and a set of distributed energy resources that operate independently of the energy grid.

In embodiments, the automatically executed policies are a set of contextual policies that adjust based on a current status of a set of energy storage entities in an energy grid.

In embodiments, the automatically executed policies are a set of contextual policies that adjust based on a current status of a set of energy storage entities in an energy storage environment that includes an energy grid and a set of distributed energy resources that operate independently of the energy grid, wherein the automatically executed policies are a set of contextual policies that adjust based on the current status of a set of energy delivery entities in an energy grid.

In embodiments, the automatically executed policies are a set of contextual policies that adjust based on a current status of a set of energy transmission entities in an energy transmission environment that includes an energy grid and a set of distributed energy resources that operate independently of the energy grid.

In embodiments, the automatically executed policies are a set of contextual policies that adjust based on a current status of a set of energy consumption entities that consume energy from an energy grid.

In embodiments, the automatically executed policies are a set of contextual policies that adjust based on a current status of a set of energy consumption entities that consume energy from an energy grid and from a set of distributed energy resources that operate independently of the energy grid.

In embodiments, the set of edge devices is further configured to adjust the set of preconfigured policies based on at least one contextual factor, and the at least one contextual factor includes at least one of, historical data of energy transactions, at least one operational factor, at least one market factor, at least one anticipated market behavior, or at least one anticipated customer behavior.

In embodiments, at least one of the edge devices is further configured to adapt a transport of data over a network and/or communication system, wherein the adapting is based on at least one of, a congestion condition, a delay and/or latency condition, a packet loss condition, an error rate condition, a cost of transport condition, a quality-of-service (QoS) condition, a usage condition, a market factor condition, or a user configuration condition.

In embodiments, the AI-based platform of claim 1, further comprising an adaptive energy digital twin that represents at least one of, an energy stakeholder entity, an energy distribution resource, a stakeholder information technology, a networking infrastructure entity, an energy-dependent stakeholder production facility, a stakeholder transportation system, a market condition, or an energy usage priority condition.

In embodiments, the AI-based platform of claim 1, further comprising an adaptive energy digital twin that is configured to perform at least one of, providing a visual and/or analytic indicator of energy consumption by at least one energy consumer, filtering energy data, highlighting energy data, or adjusting energy data.

In embodiments, the AI-based platform of claim 1, further comprising an adaptive energy digital twin that is configured to generate a visual and/or analytic indicator of energy consumption by at least one of, at least one machine, at least one factory, or at least one vehicle in a vehicle fleet.

In embodiments, at least one of the edge devices is further configured to perform at least one of, extracting energy-related data, detecting and/or correcting errors in energy-related data, transforming, converting, normalizing, and/or cleansing energy-related data, parsing energy-related data, detecting patterns, content, and/or objects in energy-related data, compressing energy-related data, streaming energy-related data, filtering energy-related data, loading and/or storing energy-related data, routing and/or transporting energy-related data, or maintaining security of energy-related data.

In embodiments, at least one of the preconfigured policies is based on at least one public data resource, the at least one public data resource including at least one of, a weather data resource, a satellite data resource, a census, population, demographic, and/or psychographic data resource, a market data resource, or an ecommerce data resource.

In embodiments, at least one of the preconfigured policies is based on at least one enterprise data resource, the at least one enterprise data resource including at least one of, resource planning data, sales and/or marketing data, financial planning data, demand planning data, supply chain data, procurement data, pricing data, customer data, product data, or operating data.

In embodiments, at least one of the edge devices includes at least one AI-based model and/or algorithm, wherein the at least one AI-based model and/or algorithm is trained based on a training data set, and the training data set is based on at least one of, at least one human tag and/or label, at least one human interaction with a hardware and/or software system, at least one outcome, at least one AI-generated training data sample, a supervised learning training process, a semi-supervised learning training process, or a deep learning training process.

In embodiments, at least one of the edge devices is further configured to orchestrate delivery of energy to at least one point of consumption, and the delivery of the energy includes at least one of, at least one fixed transmission line, at least one instance of wireless energy transmission, at least one delivery of fuel, or at least one delivery of stored energy.

In embodiments, at least one of the edge devices is further configured to record, in a distributed ledger and/or blockchain, at least one energy-related event, the at least one energy-related event including at least one of, an energy purchase and/or sale event, a service charge associated with an energy purchase and/or sale event, an energy consumption event, an energy generation event, an energy distribution event, an energy storage event, a carbon emission production event, a carbon emission abatement event, a renewable energy credit event, a pollution production event, or a pollution abatement event.

In embodiments, at least one of the edge devices is deployed in an off-grid environment, and the off-grid environment includes at least one of, an off-grid energy generation system, an off-grid energy storage system, or an off-grid energy mobilization system.

### Intelligent Orchestration Systems for Energy and Power Management of Edge Devices

In embodiments, an AI-based platform for enabling intelligent orchestration and management of power and energy includes a machine learning system trained on a set of energy intelligence data and deployed on an edge device, wherein the machine learning system is configured to receive additional training by the edge device to improve energy management.

For example, the edge device may be configured to pursue one or more energy management objectives based on an energy management policy and/or rule, such as energy capacity, energy conservation, energy usage efficiency, reduction of generation and/or emission of carbon-based substances, cost reduction, or the like. The edge device may be configured to revie the energy intelligence data to determine patterns of energy generation, storage, transport, and/or consumption that are associated with the energy management policy and/or rule, such as patterns of activity that result in excessive energy use, energy usage inefficiency, excessive costs, or the like.

For example, at least a portion of the energy intelligence data may include a labeled training data set (e.g., a data set indicating energy usage patterns, and one or more labels that indicate periods of efficient energy usage and periods of inefficiency energy usage). The edge device may use the labeled machine learning data to train a machine learning model to analyze, as input, a currently detected pattern of energy usage, and to generate, as output, a label indicating whether the pattern denotes efficient energy usage or inefficient energy usage. Alternatively or additionally, at least a portion of the energy intelligence set may include unlabeled data (e.g., a data set indicating energy usage patterns, but without labels that indicate periods of efficient energy usage and periods of inefficient energy usage). The edge device may apply unsupervised training techniques (e.g., clustering) to determine within the unlabeled data, one or more patterns of energy usage that are associated with efficient energy usage and/or one or more patterns of energy usage that are associated with inefficient energy usage.

As another example, the edge device may perform the additional training of the machine learning model based on a change in the circumstances and/or environment in which the machine learning model is applied. For example, the machine learning model may be transferred from monitoring, analyzing, and/or managing a first energy consumer to monitoring, analyzing, and/or managing a second energy consumer. The transfer may cause the machine learning model to receive different data as input (e.g., input from different types of sensors, and/or input associated with a different industrial process of the second energy consumer). The edge device may perform the additional training of the machine learning model in order to adapt the existing processing capabilities of the machine learning model to the characteristics of the new energy consumer.

As another example, the edge device may perform the additional training of a machine learning model based on a detection of an indication of model drift, such as a difference in the determinations of the machine learning model in response to a training data set than the determinations of the machine learning model in response to the same training data set at a time of training completion. Machine learning model drift may occur, for example, when the configuration, internal weights, and/or state of the machine learning model are changed after an initial completion of training, such that the machine learning model now reaches different and possibly less accurate conclusions over the same input data than were previously generated. In response to a detection of model drift, the edge device may initiate a retraining of the machine learning model over the original training data set and/or over new training data in order to adapt the machine learning model to generate more desirable output. Alternatively or additionally, the edge device may replace the machine learning model with another machine learning models (e.g., a machine learning model with greater capacity, a different architecture, a different set of hyperparameters and/or parameters, and/or a machine learning model that has been subjected to a different training process). Alternatively or additionally, the edge device may combine the machine learning model with other machine learning models as part of an ensemble, and may thereafter determine outputs in response to various inputs based on a consensus of the machine learning model and the other machine learning models.

As another example, the edge device may perform the additional training of a machine learning model based on the receipt of additional data, such as data collected from a continued operation of an energy generation, storage, transport, and/or consumption facility. The additional data may indicate one or more new or changed trends within energy patterns, such as energy consumption by a new industrial process, or energy consumption changes due to industrial process changes. The additional training may involve training the machine learning model to analyze the additional data and to identify new or changed patterns, such as new patterns of energy usage inefficiency that are associated with one or more new or changed industrial processes.

As another example, the edge device may perform further training of a machine learning model based on feedback systems integrated within energy system, such as sensors measuring energy savings, user feedback on system performance, or data from energy management system. By way of example, after the machine learning model proposes specific energy-saving actions, the results of these actions can be observed and compared to the predicted outcomes. If differences arise between the predicted and actual outcomes, this feedback may be utilized to further train the machine learning model to ensure that the machine learning model remains in sync with real-world outcomes.

As another example, the edge device may perform further training of a machine learning model based on external factors like regulatory changes, such as new regulation for carbon emissions. In such cases, the edge device can analyze data pertaining to these new regulations and train the machine learning model to optimize energy usage while ensuring compliance.

In embodiments, the energy management includes management of generation of energy by a set of distributed energy generation resources.

In embodiments, the energy management includes management of storage of energy by a set of distributed energy storage resources.

In embodiments, the energy management includes management of delivery of energy by a set of distributed energy delivery resources.

In embodiments, the energy management includes management of consumption of energy by a set of distributed energy consumption resources.

In embodiments, the energy management is based on a set of rules and/or policies associated with the edge device and a set of energy generation facilities, energy storage facilities, energy delivery facilities or energy consumption systems.

In embodiments, the machine learning system is further configured to adapt a transport of data over a network and/or communication system, wherein the adapting is based on at least one of, a congestion condition, a delay and/or latency condition, a packet loss condition, an error rate condition, a cost of transport condition, a quality-of-service (QoS) condition, a usage condition, a market factor condition, or a user configuration condition.

In embodiments, the AI-based platform further includes an adaptive energy digital twin that represents at least one of, an energy stakeholder entity, an energy distribution resource, a stakeholder information technology, a networking infrastructure entity, an energy-dependent stakeholder production facility, a stakeholder transportation system, a market condition, or an energy usage priority condition.

In embodiments, the AI-based platform further includes an adaptive energy digital twin that is configured to perform at least one of, providing a visual and/or analytic indicator of energy consumption by at least one energy consumer, filtering energy data, highlighting energy data, or adjusting energy data.

In embodiments, the AI-based platform further includes an adaptive energy digital twin that is configured to generate a visual and/or analytic indicator of energy consumption by at least one of, at least one machine, at least one factory, or at least one vehicle in a vehicle fleet.

In embodiments, the machine learning system is further configured to perform at least one of, extracting energy-related data, detecting and/or correcting errors in energy-related data, transforming, converting, normalizing, and/or cleansing energy-related data, parsing energy-related data, detecting patterns, content, and/or objects in energy-related data, compressing energy-related data, streaming energy-related data, filtering energy-related data, loading and/or storing energy-related data, routing and/or transporting energy-related data, or maintaining security of energy-related data.

In embodiments, the energy intelligence data is based on at least one public data resource, the at least one public data resources including at least one of, a weather data resource, a satellite data resource, a census, population, demographic, and/or psychographic data resource, a market data resource, or an ecommerce data resource.

In embodiments, the energy intelligence data is based on at least one enterprise data resource, the at least one enterprise data resource including at least one of, resource planning data, sales and/or marketing data, financial planning data, demand planning data, supply chain data, procurement data, pricing data, customer data, product data, or operating data.

In embodiments, the machine learning system is further trained based on a training data set, and the training data set is based on at least one of, at least one human tag and/or label, at least one human interaction with a hardware and/or software system, at least one outcome, at least one AI-generated training data sample, a supervised learning training process, a semi-supervised learning training process, or a deep learning training process.

In embodiments, the machine learning system is further configured to orchestrate delivery of energy to at least one point of consumption, and the delivery of the energy includes at least one of, at least one fixed transmission line, at least one instance of wireless energy transmission, at least one delivery of fuel, or at least one delivery of stored energy.

In embodiments, the machine learning system is further configured to record, in a distributed ledger and/or blockchain, at least one energy-related event, the at least one energy-related event including at least one of, an energy purchase and/or sale event, a service charge associated with an energy purchase and/or sale event, an energy consumption event, an energy generation event, an energy distribution event, an energy storage event, a carbon emission production event, a carbon emission abatement event, a renewable energy credit event, a pollution production event, or a pollution abatement event.

In embodiments, the edge device is deployed in an off-grid environment, and the off-grid environment includes at least one of, an off-grid energy generation system, an off-grid energy storage system, or an off-grid energy mobilization system.

In embodiments, the edge device is located in proximity to at least one entity that generates, stores, delivers, and/or uses energy.

In embodiments, the edge device provides information about an energy state and/or energy flow of at least one entity that generates, stores, delivers, and/or uses energy.

In embodiments, the edge device contains and/or governs at least one sensor of a set of sensors, and the set of sensors is associated with a set of infrastructure assets that are configured to generate, store, deliver, and/or use energy.

### Intelligent Orchestration Systems for Energy and Power Management of Heterogeneous Energy-Related Systems and Devices

In embodiments, an AI-based platform for enabling intelligent orchestration and management of power and energy includes a set of edge devices including a set of artificial intelligence systems that are configured to process data handled by the edge devices and determine, based on the data, a mix of energy generation, storage, delivery and/or consumption characteristics for a set of systems that are in local communication with the edge devices and to output a data set that represents the constituent proportions of the mix.

For example, the set of systems may be configured to generate and/or store energy by two or more of: wind turbines, solar photovoltaics (PV), flexible and/or floating solar systems, fuel cells, modular nuclear reactors, nuclear batteries, modular hydropower systems, microturbines and turbine arrays, reciprocating engines, combustion turbines, and cogeneration plants, among others. The distributed energy storage systems may include battery storage energy (including chemical batteries and others), molten salt energy storage, electro-thermal energy storage (ETES), gravity-based storage, compressed fluid energy storage, pumped hydroelectric energy storage (PHES), and liquid air energy storage (LAES). Each energy system may exhibit a particular combination of characteristics, such as overall energy availability, peak energy capacity, surge energy capacity, energy efficiency, energy leakage, energy cost per unit, energy stability (e.g., susceptibility to weather conditions), energy renewability, and generation and/or emission of carbon-based substances. Similarly, various types of energy consumption may be associated with various energy demand requirements, such as peak energy consumption, surge energy consumption, energy consumption efficiency, energy consumption predictability, energy consumption priority, and generation and/or emission of carbon-based substances by the energy consumption.

In embodiments, the set of artificial intelligence systems communicate with a set of energy systems to collect data based on the characteristics of energy generation, delivery, transport, and/or consumption. An edge device may use the data set collected by the artificial intelligence system to orchestrate and manage delivery of energy to points of consumption by determining, for each energy consumer, a mix of energy sources among the set of systems from which to receive and consume energy. For example, the edge device may identify an energy consumer, may analyze patterns of energy consumption by the energy consumer to determine various energy demand requirements of the energy consumer, and may select a mix of the energy systems, wherein the mix satisfies the energy demand requirements. Based on the mix, the edge device may configure or reconfigure the energy consumer to use the selected energy systems. For example, an industrial process may be capable of operating on fuel, solar power, or transmitted electricity. The edge device may compare the characteristics of the energy systems that provide different types of energy with the energy demand requirements of the industrial process to determine the mix of energy systems that correspond to the energy demand requirements of the industrial process. The edge device may output a data set that represents the constituent proportions of the mix. For example, based on the mix, the edge device may configure the industrial process to use various constituent proportions of the energy systems (e.g., configuring a power management component of an industrial plan to operate on a combination of fuel, solar power, and/or transmitted electricity in order to supply power to the industrial process, with various proportions). The edge device may interact with a smart home system to monitor and analyze energy consumption patterns from various home appliances and determine a mix of energy sources to cater to these demands. For example, during peak sunshine hours, the edge device may prioritize solar power harvested from rooftop panels, and during evening, the edge device may utilize stored energy from home battery systems or use energy from the grid. The edge device may factor in weather data to predict energy generation potential from renewable sources and accordingly adjust the energy mix, to ensure continuous energy supply, while optimizing the use of renewable sources.

As another example, an edge device may use a data set collected by the artificial intelligence system to orchestrate and manage delivery of energy to points of consumption by determining, for each energy consumer, a schedule of mixed energy sources to use among the set of systems from which to receive and consume energy. For example, the edge device may identify an energy consumer, may analyze patterns of energy consumption by the energy consumer at various times to determine various energy demand requirements of the energy consumer at various times. The edge device may determine a schedule for using the mix of energy systems, wherein the schedule satisfies the energy demand requirements. Based on the schedule, the edge device may configure or reconfigure the energy consumer to use the mixed set of energy systems. For example, an industrial process may be capable of operating on fuel, solar power, or transmitted electricity. The edge device may compare the characteristics of the energy systems that provide different types of energy with the energy demand requirements of the industrial process to determine the schedule of using the mixed energy systems that correspond to the energy demand requirements of the industrial process. The edge device may output a data set that represents the schedule and the constituent proportions of the mix. For example, based on the schedule and the mix, the edge device may schedule the industrial process to use various constituent proportions of the energy systems at various times (e.g., configuring a power management component of an industrial plan to operate on a combination of fuel, solar power, and/or transmitted electricity in order to supply power to the industrial process, with various proportions).

In embodiments, in the AI-based platform, the output data set indicates a fraction of energy generated by an energy grid and a fraction of energy generated by a set of distributed energy resources that operate independently of the energy grid.

In embodiments, in the AI-based platform, the output data set indicates a fraction of energy generated by renewable energy resources and a fraction of energy generated by nonrenewable resources.

In embodiments, in the AI-based platform, the output data set indicates a fraction of energy generation by type for each interval in a series of time intervals.

In embodiments, in the AI-based platform, the output data set indicates carbon generation associated with energy generation for each type of energy in the energy mix during each interval of a series of time intervals.

In embodiments, in the AI-based platform, the output data set indicates carbon emissions associated with energy generation for each type of energy in the energy mix during each interval of a series of time intervals.

In embodiments, in the AI-based platform, at least one of the edge devices is further configured to adapt a transport of data over a network and/or communication system, wherein the adapting is based on one or more of, a congestion condition, a delay and/or latency condition, a packet loss condition, an error rate condition, a cost of transport condition, a quality-of-service (QoS) condition, a usage condition, a market factor condition, or a user configuration condition.

In embodiments, the AI-based platform includes an adaptive energy digital twin that represents one or more of, an energy stakeholder entity, an energy distribution resource, a stakeholder information technology, a networking infrastructure entity, an energy-dependent stakeholder production facility, a stakeholder transportation system, a market condition, or an energy usage priority condition.

In embodiments, the AI-based platform includes an adaptive energy digital twin that is configured to perform one or more of, providing a visual and/or analytic indicator of energy consumption by one or more energy consumers, filtering energy data, highlighting energy data, or adjusting energy data.

In embodiments, the AI-based platform includes an adaptive energy digital twin that is configured to generate a visual and/or analytic indicator of energy consumption by one or more of, one or more machines, one or more factories, or one or more vehicles in a vehicle fleet.

In embodiments, in the AI-based platform, at least one of the edge devices is further configured to perform one or more of, extracting energy-related data, detecting and/or correcting errors in energy-related data, transforming, converting, normalizing, and/or cleansing energy-related data, parsing energy-related data, detecting patterns, content, and/or objects in energy-related data, compressing energy-related data, streaming energy-related data, filtering energy-related data, loading and/or storing energy-related data, routing and/or transporting energy-related data, or maintaining security of energy-related data.

In embodiments, in the AI-based platform, the data is based on one or more public data resources, the public data resources including one or more of, a weather data resource, a satellite data resource, a census, population, demographic, and/or psychographic data resource, a market data resource, or an ecommerce data resource.

In embodiments, in the AI-based platform, the data is based on one or more enterprise data resources, the enterprise data resources including one or more of, resource planning data, sales and/or marketing data, financial planning data, demand planning data, supply chain data, procurement data, pricing data, customer data, product data, or operating data.

In embodiments, in the AI-based platform, at least one of the edge devices includes at least one AI-based model and/or algorithm, the at least one AI-based model and/or algorithm is trained based on a training data set, and the training data set is based on one or more of, one or more human tags and/or labels, one or more human interactions with a hardware and/or software system, one or more outcomes, one or more AI-generated training data samples, a supervised learning training process, a semi-supervised learning training process, or a deep learning training process.

In embodiments, in the AI-based platform, at least one of the edge devices is further configured to orchestrate delivery of energy to one or more points of consumption, and the delivery of the energy includes one or more of, one or more fixed transmission lines, one or more instances of wireless energy transmission, one or more deliveries of fuel, or one or more deliveries of stored energy.

In embodiments, in the AI-based platform, at least one of the edge devices is further configured to record, in a distributed ledger and/or blockchain, one or more energy-related events, the one or more energy-related events including one or more of, an energy purchase and/or sale event, a service charge associated with an energy purchase and/or sale event, an energy consumption event, an energy generation event, an energy distribution event, an energy storage event, a carbon emission production event, a carbon emission abatement event, a renewable energy credit event, a pollution production event, or a pollution abatement event.

In embodiments, in the AI-based platform, at least one of the edge devices is deployed in an off-grid environment, and the off-grid environment includes one or more of, an off-grid energy generation system, an off-grid energy storage system, or an off-grid energy mobilization system.

In embodiments, in the AI-based platform, at least a portion of the set of edge devices is located in proximity to at least one entity that generates, stores, delivers, and/or uses energy.

In embodiments, in the AI-based platform, the set of edge devices provides information about an energy state and/or energy flow of at least one entity that generates, stores, delivers, and/or uses energy.

In embodiments, in the AI-based platform, the set of edge devices contains and/or governs at least one sensor of a set of sensors, and the set of sensors is associated with a set of infrastructure assets that are configured to generate, store, deliver, and/or use energy.

Intelligent Orchestration Systems for Energy and Power Grid Entities Fused with Distributed Energy- and Power-Related Entities

In embodiments, an AI-based platform for enabling intelligent orchestration and management of power and energy includes a data processing system configured to fuse at least one entity of an energy grid entity generation, storage, delivery or consumption grid data set with at least one entity of an off-grid energy entity generation, storage, delivery and/or consumption data set.

For example, at least one entity is deployed in an off-grid environment, and the off-grid environment includes one or more of, an off-grid energy generation system, an off-grid energy storage system, or an off-grid energy mobilization system. For example, off-grid entities may include residences, mobile homes, encampments, or the like that develop, store, transport, and/or consume energy supplied by renewable energy resources. The off-grid entity may be at least partly independent of an electrical grid. For example, fuel may be delivered by one or more fuel pipelines or fuel transport vehicles that do not depend on an electrical grid. Power may be delivered by one or more renewable power resources that do not depend on an electrical grid, such as solar panels, solar farms, wind turbines, hydroelectric power facilities, or nuclear power plants. Power may be stored by one or more power storage facilities that do not depend on an electrical grid, such as a battery, a capacitor, or a fuel tank or pipeline. In some cases, one or more of the off-grid entities may be partly coupled to an electrical grid, such as a backup source of power in case a primary mechanism of power generation, storage, and/or transport were to fail, or as a source of power for performing auxiliary functions, such as monitoring or auditing a state or capacity of the resources. In some cases, one or more of the off-grid entities may be completely independent of an electrical grid, such as a manufacturing plant that is supplied by power entirely and exclusively by a solar panel farm.

The AI-based platform may be configured to couple the off-grid entity with various other entities, such as on-grid or off-grid energy generators, energy stores, energy transport, and/or consumers, based on the characteristics of the off-grid entity. For example, an energy source may provide supplemental and/or emergency energy generation, storage, and/or transport facilities that can provide power to the off-grid entity in case off-grid renewable energy resources fail to meet demand. An off-grid energy generator and/or storage entity may provide supplemental and/or emergency energy generation, storage, and/or transport facilities that can provide power to other on-grid and/or off-grid entities in case energy grid and/or off-grid energy resources fail to meet demand. The AI-based platform may identify energy generation, storage, and/or transport facilities that can make use of excess power that is generated by one or more off-grid entities beyond the energy consumption needs of such off-grid entities. The adaptive energy data pipeline may coordinate the development of energy grid resources based on the entities of the off-grid environment, such as adjusting the capacity, scale, and/or development of new energy plants, storage facilities, and/or transmission channels based on the initiation, expansion, reduction, and/or collapse of communities of entities in the off-grid environment.

In these and other scenarios, the AI-based platform may formulate various determinations of coupling between the off-grid entity and various on-grid entities and/or other off-grid entities based on a fusion of a grid energy data set with an off-grid energy data set. For example, patterns of activity that are determined to occur within the on-grid energy data may be combined with, compared to, contrasted with, aggregated with, distinguished from, extrapolated from, interpolated from, and/or inferred from the off-grid energy data. Similarly, patterns of activity that are determined to occur within the off-grid energy data may be combined with, compared to, contrasted with, aggregated with, distinguished from, extrapolated from, interpolated from, and/or inferred from the on-grid energy data.

For example, the AI-based platform may identify shared features of on-grid energy data and off-grid energy data, such as shared patterns of energy generation, storage, transport, consumption, supply, demand, predictability, efficiency, cost, or the like. Such shared features may enable the AI-based platform to reach certain determinations with regard to the on-grid data that are not present and/or apparent in the on-grid data, but that are present and/or apparent in the off-grid data (e.g., inferring missing data about causes of energy demand in on-grid environments, based on available data about causes of energy demand in off-grid environments). Alternatively or additionally, such shared features may enable the AI-based platform to reach certain determinations with regard to the off-grid data that are not present and/or apparent in the on-grid data, but that are present and/or apparent in the on-grid data (e.g., inferring missing data about causes of energy demand in off-grid environments, based on available data about causes of energy demand in on-grid environments).

As another example, the AI-based platform may utilize data from on-grid and off-grid energy storage solutions. On-grid energy storage solutions may employ large-scale battery storage facilities, while off-grid energy storage solutions may include smaller, modular storage solutions. By using data from both, the AI-based platform may extract insights on battery performance and efficiency under various usage scenarios, and determine strategies for optimal battery usage between the on-grid and off-grid energy storage solutions, ensuring longer lifespans and consistent performance.

As another example, the AI-based platform may utilize weather data, which affect both on-grid and off-grid energy generation strategies, especially for renewable energy sources. For on-grid environments that predominantly rely on solar power farms or wind turbines, certain patterns in weather, such as cloud cover or wind speeds, directly influence energy generation. Similarly, off-grid setups using portable solar panels or mini wind turbines may have corresponding patterns. By using the on-grid and off-grid data, the AI-based platform may develop comprehensive understanding of how localized weather phenomena impact broader energy generation strategies. This may enable the AI-based platform for more accurate forecasting, where, by way of example, an off-grid location's weather data may provide early indicators of potential energy generation disruptions in a larger on-grid setup located nearby.

As another example, the AI-based platform may identify distinguishing features between on-grid energy data and off-grid energy data, such as shared patterns of energy generation, storage, transport, consumption, supply, demand, predictability, efficiency, cost, or the like. Such distinguishing features may enable the AI-based platform to classify a particular piece of energy data as being associated with and/or characteristic of one of an on-grid environment or an off-grid environment. Also, such distinguishing features may enable the AI-based platform to adapt data from the on-grid environment for application to an off-grid environment. For example, the AI-based platform may seek to determine how energy consumption would change if an industrial process were moved from an on-grid environment to an off-grid environment. The AI-based platform could identify data associated with energy consumption of the industrial process in the on-grid environment, and adapt it based on previous determinations of how energy consumption tends to differ between on-grid and off-grid industrial processes. The AI-based platform could use the adapted data to forecast and/or plan the adaptation of the industrial process to the off-grid environment. As another example, such distinguishing features may enable the AI-based platform to classify a particular piece of energy data as being associated with and/or characteristic of one of an on-grid environment or an off-grid environment. Also, such distinguishing features may enable the AI-based platform to adapt data from the on-grid environment for application to an off-grid environment. Similarly, the AI-based platform may seek to determine how energy consumption would change if an industrial process were moved from an off-grid environment to an on-grid environment. The AI-based platform could identify data associated with energy consumption of the industrial process in the off-grid environment, and adapt it based on previous determinations of how energy consumption tends to differ between on-grid and off-grid industrial processes. The AI-based platform could use the adapted data to forecast and/or plan the adaptation of the industrial process to the on-grid environment.

In embodiments, the data processing system is configured to automatically time align energy grid entity data with off-grid energy entity data.

In embodiments, the data processing system is configured to automatically collect off-grid energy entity sensor data from a set of edge devices via which a set of off-grid energy entities are controlled.

In embodiments, the data processing system is configured to automatically normalize the energy grid entity data and the off-grid energy entity data such as to present the data according to a set of common units.

In embodiments, the data processing system is further configured to adapt a transport of data over a network and/or communication system, wherein the adapting is based on at least one of, a congestion condition, a delay and/or latency condition, a packet loss condition, an error rate condition, a cost of transport condition, a quality-of-service (QoS) condition, a usage condition, a market factor condition, or a user configuration condition.

In embodiments, the AI-based platform further includes an adaptive energy digital twin that represents at least one of, an energy stakeholder entity, an energy distribution resource, a stakeholder information technology, a networking infrastructure entity, an energy-dependent stakeholder production facility, a stakeholder transportation system, a market condition, or an energy usage priority condition.

In embodiments, the AI-based platform further includes an adaptive energy digital twin that is configured to perform at least one of, providing a visual and/or analytic indicator of energy consumption by at least one energy consumer, filtering energy data, highlighting energy data, or adjusting energy data.

In embodiments, the AI-based platform further includes an adaptive energy digital twin that is configured to generate a visual and/or analytic indicator of energy consumption by at least one of, at least one machine, at least one factory, or at least one vehicle in a vehicle fleet.

In embodiments, the data processing system is further configured to perform at least one of, extracting energy-related data, detecting and/or correcting errors in energy-related data, transforming, converting, normalizing, and/or cleansing energy-related data, parsing energy-related data, detecting patterns, content, and/or objects in energy-related data, compressing energy-related data, streaming energy-related data, filtering energy-related data, loading and/or storing energy-related data, routing and/or transporting energy-related data, or maintaining security of energy-related data.

In embodiments, the AI-based platform further includes at least one AI-based model and/or algorithm, wherein the at least one AI-based model and/or algorithm is trained based on a training data set, and the training data set is based on at least one of, at least one human tag and/or label, at least one human interaction with a hardware and/or software system, at least one outcome, at least one AI-generated training data sample, a supervised learning training process, a semi-supervised learning training process, or a deep learning training process.

In embodiments, the data processing system is further configured to orchestrate delivery of energy to at least one point of consumption, and the delivery of the energy includes at least one of, at least one fixed transmission line, at least one instance of wireless energy transmission, at least one delivery of fuel, or at least one delivery of stored energy.

In embodiments, the data processing system is further configured to record, in a distributed ledger and/or blockchain, at least one energy-related event, the at least one energy-related event including at least one of, an energy purchase and/or sale event, a service charge associated with an energy purchase and/or sale event, an energy consumption event, an energy generation event, an energy distribution event, an energy storage event, a carbon emission production event, a carbon emission abatement event, a renewable energy credit event, a pollution production event, or a pollution abatement event.

In embodiments, the at least one entity of an off-grid energy generation, storage, and/or consumption data set is deployed in an off-grid environment, and the off-grid environment includes at least one of, an off-grid energy generation system, an off-grid energy storage system, or an off-grid energy mobilization system.

In embodiments, the data processing system is further configured to intelligently orchestrate and manage power and/or energy based on a data set of energy generation, storage, and/or consumption data for a set of infrastructure assets, and the data set is produced at least in part by a set of sensors contained in and/or governed by a set of edge devices.

In embodiments, the data processing system is further configured to manage at least one of, generation of energy by a set of distributed energy generation resources, storage of energy by a set of distributed energy storage resources, delivery of energy by a set of distributed energy delivery resources, or consumption of energy by a set of distributed energy consumption resources.

In embodiments, the data processing system is further configured to intelligently orchestrate and manage power and/or energy of a set of entities, wherein the set of entities includes at least one of, a weather data resource, a satellite data resource, a census, population, demographic, and/or psychographic data resource, a market data resource, or an ecommerce data resource.

In embodiments, the data processing system is further configured to execute at least one algorithm that perform a simulation of energy consumption by at least one of the entities, wherein the simulation is based on a data set that includes alternative state or event parameters for at least one of the entities that reflect alternative consumption scenarios, and the algorithms accesses a demand response model that accounts for how energy demand responds to changes in a price of energy or a price of an operation or activity for which the energy is consumed.

In embodiments, the data processing system includes a policy and governance engine that is configured to deploy a set of rules and/or policies to at least one edge device that is in local communication with at least one of the entities, and the edge device is configured to govern at least one of the entities based on the rules and/or policies.

In embodiments, the data processing system includes an analytic system that represents a set of operating parameters and current states of at least one of the entities based on a set of sensed parameters, the set of sensed parameters is generated by a set of edge devices that are in proximity to at least one of the entities, and the analytic system is configured to provide a recommendation associated with at least one the at least one of the entities or at least one additional available entity.

In embodiments, the data processing system includes an artificial intelligence system that is trained on a historical data set relating to energy generation, storage, and/or utilization of an operating process associated with at least one of the entities, and the data processing system is further configured to, analyze an energy pattern for the operating process, and output a forecast of energy requirements of the operating process based on a current state and/or information associated with at least one of the entities.

### Intelligent Orchestration Systems for Delivery of Heterogeneous Energy and Power Resources

In embodiments, an AI-based platform for enabling intelligent orchestration and management of power and energy includes a set of autonomous orchestration systems for improving delivery of a heterogeneous set of energy types to a point of consumption based on: a location of the point of consumption, and a set of consumption attributes, the consumption attributes including at least one of: a peak power requirement at the point of consumption; a continuity of power requirement at the point of consumption; and a type of energy that can be used at the point of consumption.

For example, the heterogeneous set of energy types may be generated and/or stored by two or more of: wind turbines, solar photovoltaics (PV), flexible and/or floating solar systems, fuel cells, modular nuclear reactors, nuclear batteries, modular hydropower systems, microturbines and turbine arrays, reciprocating engines, combustion turbines, and cogeneration plants, among others. The distributed energy storage systems may include battery storage energy (including chemical batteries and others), molten salt energy storage, electro-thermal energy storage (ETES), gravity-based storage, compressed fluid energy storage, pumped hydroelectric energy storage (PHES), and liquid air energy storage (LAES).

For example, each energy type may exhibit a particular combination of characteristics, such as overall energy availability, peak energy capacity, surge energy capacity, energy efficiency, energy leakage, energy cost per unit, energy stability (e.g., susceptibility to weather conditions), energy renewability, and generation and/or emission of carbon-based substances. Similarly, various types of energy consumption may be associated with various energy demand requirements, such as peak energy consumption, surge energy consumption, energy consumption efficiency, energy consumption predictability, energy consumption priority, and generation and/or emission of carbon-based substances by the energy consumption.

In embodiments, the set of orchestration systems improves delivery of energy to points of consumption based on matching each energy consumer and/or instance of energy consumption with one or more of the heterogeneous sets of energy types. For example, the set of orchestration systems may identify an energy consumer, may analyze patterns of energy consumption by the energy consumer to determine various energy demand requirements of the energy consumer, and may select, from the heterogeneous set of energy types, one or more selected energy types that correspond to the energy demand requirements. Based on the selection, the set of orchestration systems may configure or reconfigure the energy consumer to use the selected energy types. For example, an industrial process may be capable of operating on fuel, solar power, or transmitted electricity. The set of orchestration systems may compare the characteristics of each energy type with the energy demand requirements of the industrial process to select one or more energy types that correspond to the energy demand requirements of the industrial process. The set of orchestration systems may then configure the industrial process to use the selected one or more energy types (e.g., configuring a power management component of an industrial plan to operate on fuel, solar power, and/or transmitted electricity in order to supply power to the industrial process).

As another example, the set of orchestration systems may identify an entire set of energy consumers, may analyze patterns of energy consumption by the entire set of energy consumers to determine various energy demand requirements of each of the energy consumers of the set, and may perform a holistic mapping of the heterogeneous set of energy types to the energy demand requirements of the energy consumers, wherein the mapping couples each energy consumer with a selection among the heterogeneous set of energy types that are sufficient to meet the energy demand requirements of the energy consumer, and that each of the energy types is not overallocated to serve more energy consumers than the energy type can satisfy.

As yet another example, the set of orchestration systems improve delivery of a heterogeneous set of energy types by forecasting energy demand requirements and allocating resources to develop new energy sources of various energy types. For example, the set of orchestration systems may determine that a collection of energy demand requirements indicate a forecasted and/or unmet need, such as forecasted and/or currently unmet surge capacity in the event of extreme weather events, or forecasted and/or currently unmet increases in demands for industrial output. The set of orchestration systems may allocate resources to develop additional energy sources, such as additional energy plants, additional solar panel farms, and/or additional fuel delivery pipelines or vehicles. While considering the allocation of resources to develop additional energy sources, the set of orchestration systems may take into account the characteristics of various energy types (e.g., the advantages and disadvantages to using each of additional energy plants, additional solar panel farms, and/or additional fuel delivery pipelines or vehicles), and may compare such characteristics with the details of the forecasted and/or unmet energy demand requirements. The set of orchestration systems may adjust the allocation of development resources based on this comparison, such that the additional energy sources provide energy with characteristics that match the details of the forecasted and/or unmet energy demand requirements.

As still another example, the set of orchestration systems may consider the energy storage capabilities associated with various energy types to ensure reliability and continuity. By way of example, the set of orchestration systems may integrate energy storage solutions like battery banks for intermittent renewable energy sources, such as solar and wind. In periods of high energy generation and low consumption, excess energy is stored. Conversely, during periods of high demand or low generation, the stored energy is released. Thus, the set of orchestration systems ensure that there is always a backup energy source available to meet demand.

As still another example, the set of orchestration systems may employ hybrid energy systems, which combine two or more energy generation methods, typically renewable and conventional fuel, for locations where the renewable sources are not fully dependable. The set of orchestration systems may primarily use renewable sources, but when these are insufficient, the systems may switch to a conventional fuel backup. The set of orchestration system may manage this transition, ensuring that energy supply remains reliable.

In embodiments, the set of autonomous orchestration systems orchestrates delivery of defined types of energy generation capacity to the point of consumption.

In embodiments, the set of autonomous orchestration systems orchestrates delivery of defined types of energy storage capacity to the point of consumption.

In embodiments, the type of energy that can be used is determined at least in part based on a set of operational compatibility parameters.

In embodiments, the type of energy that can be used is determined at least in part based on a set of governance parameters.

In embodiments, the set of governance parameters relates to use of renewable energy resources.

In embodiments, the set of governance parameters relates to carbon generation or emissions.

In embodiments, at least one of the set of autonomous orchestration systems is further configured to adapt a transport of data over a network and/or communication system, wherein the adapting is based on at least one of, a congestion condition, a delay and/or latency condition, a packet loss condition, an error rate condition, a cost of transport condition, a quality-of-service (QoS) condition, a usage condition, a market factor condition, or a user configuration condition.

In embodiments, the AI-based platform further includes an adaptive energy digital twin that represents at least one of, an energy stakeholder entity, an energy distribution resource, a stakeholder information technology, a networking infrastructure entity, an energy-dependent stakeholder production facility, a stakeholder transportation system, a market condition, or an energy usage priority condition.

In embodiments, the AI-based platform further includes an adaptive energy digital twin that is configured to perform at least one of, providing a visual and/or analytic indicator of energy consumption by at least one energy consumer, filtering energy data, highlighting energy data, or adjusting energy data.

In embodiments, the AI-based platform further includes an adaptive energy digital twin that is configured to generate a visual and/or analytic indicator of energy consumption by at least one of, at least one machine, at least one factory, or at least one vehicle in a vehicle fleet.

In embodiments, at least one of the set of autonomous orchestration systems is further configured to perform at least one of, extracting energy-related data, detecting and/or correcting errors in energy-related data, transforming, converting, normalizing, and/or cleansing energy-related data, parsing energy-related data, detecting patterns, content, and/or objects in energy-related data, compressing energy-related data, streaming energy-related data, filtering energy-related data, loading and/or storing energy-related data, routing and/or transporting energy-related data, or maintaining security of energy-related data.

In embodiments, at least one of the consumption attributes is based on at least one public data resource, the public data resources including at least one of, a weather data resource, a satellite data resource, a census, population, demographic, and/or psychographic data resource, a market data resource, or an ecommerce data resource.

In embodiments, at least one of the consumption attributes is based on at least one enterprise data resource, the enterprise data resources including at least one of, resource planning data, sales and/or marketing data, financial planning data, demand planning data, supply chain data, procurement data, pricing data, customer data, product data, or operating data.

In embodiments, the AI-based platform further includes at least one AI-based model and/or algorithm, wherein the at least one AI-based model and/or algorithm is trained based on a training data set, and the training data set is based on at least one of, at least one human tag and/or label, at least one human interaction with a hardware and/or software system, at least one outcome, at least one AI-generated training data sample, a supervised learning training process, a semi-supervised learning training process, or a deep learning training process.

In embodiments, at least one of the set of autonomous orchestration systems is further configured to orchestrate delivery of energy to at least one point of consumption, and the delivery of the energy includes at least one of, at least one fixed transmission line, at least one instance of wireless energy transmission, at least one delivery of fuel, or at least one delivery of stored energy.

In embodiments, at least one of the set of autonomous orchestration systems is further configured to record, in a distributed ledger and/or blockchain, at least one energy-related event, the at least one energy-related event including at least one of, an energy purchase and/or sale event, a service charge associated with an energy purchase and/or sale event, an energy consumption event, an energy generation event, an energy distribution event, an energy storage event, a carbon emission production event, a carbon emission abatement event, a renewable energy credit event, a pollution production event, or a pollution abatement event.

In embodiments, at least one of the set of autonomous orchestration systems is deployed in an off-grid environment, and the off-grid environment includes at least one of, an off-grid energy generation system, an off-grid energy storage system, or an off-grid energy mobilization system.

In embodiments, the set of autonomous orchestration systems is further configured to determine the delivery of the heterogeneous set of energy types based on a set of rules and/or policies that govern a set of energy generation, storage, and/or consumption workloads, and the rules and/or policies are associated with a configuration of a set of edge devices operating in local data communication with a set of energy generation facilities, energy storage facilities, energy delivery facilities or energy consumption systems.

In embodiments, the set of autonomous orchestration systems is further configured to determine the delivery of the heterogeneous set of energy types based on a simulation of energy consumption by at least one energy consumer, the simulation is based on a data set that includes alternative state or event parameters for at least one of the at least one energy consumer that reflect alternative consumption scenarios, and the simulation is based on a demand response model that accounts for how energy demand responds to changes in a price of energy or a price of an operation or activity for which the energy is consumed.

### Agent-Based Intelligent Orchestration Systems for Energy and Power Management

In embodiments, an AI-based platform for enabling intelligent orchestration and management of power and energy includes an intelligent agent trained on a data set of expert interactions with an energy provisioning system, wherein the intelligent agent is trained to generate at least one recommendation and/or instruction with respect to optimization of at least one energy objective and at least one other objective.

For example, the intelligent agent may be configured to manage processing tasks on a device, such as data communication, metering, auditing, reporting, forecasting, policy evaluation, and/or machine learning model training. The processing tasks may be associated with one or more of energy generation, energy storage, energy transport, energy consumption. The intelligent agent may be configured to schedule these processing tasks based on priorities, value, and cost, as well as based on energy policies, including efficiency, availability management, cost containment, emissions reduction, or the like. The intelligent agent may be configured to manage the processing tasks based on the energy policies. The intelligent agent may be configured to migrate among devices to collect information related to an energy policy; to share information with other intelligent agents; to apply a determined policy to a local device; and/or to manage the processing tasks on the device based on the policy. For example, a first intelligent agent may be configured to apply energy policies related to energy conservation, and a second intelligent agent may be configured to apply energy policies related to emissions reduction. Both intelligent agents may migrate freely among a distributed set of devices to collect information related to their respective policies and to adjust the execution of the processing tasks of each device based on their respective policies. The intelligent agents may also exchange information with each other (e.g., while executing on the same device) to resolve policy conflicts, e.g., by determining a ranking of priorities by the collection of intelligent agents, and/or to determine schedules for the processing tasks that satisfy the policies of various intelligent agents.

In another example, the intelligent agent may be configured to anticipate future energy needs using predictive analysis. Herein, the intelligent agent may forecast times of high energy demand, such as during specific industrial processes or peak hours. This allows the intelligent agent to make proactive adjustments, ensuring that energy is sourced in advance to meet the predicted demand. By way of example, if the intelligent agent predicts a spike in energy demand due to an upcoming industrial operation, it may proactively store excess energy in batteries or request increased energy inflow from the grid.

In yet another example, the intelligent agent may be integrated with advanced sensor networks, to understand energy flows, consumption patterns, and inefficiencies. By way of example, if sensors in a factory detect increased energy consumption in a machine (possibly due to a malfunction), the intelligent agent may advise maintenance and/or adjust energy allocation to prevent inefficiencies.

For example, an intelligent agent may include a software component that processes input and/or produces output based on one or more heuristics, objectives, policies, and/or rules. For example, an intelligent agent may be configured to evaluate energy processes to measure, analyze, profile, summarize, adjust, and/or improve energy efficiency. The intelligent agent may be deployed on one or more devices that generate, storage, transport, and/or consume energy (e.g., a machine in an industrial facility, a computing device such as an edge device, a vehicle, or the like). The intelligent agent may be configured to analyze the energy generation, storage, transport, and/or consumption to determine the energy efficiency of the device. Based on the analysis, the intelligent agent may be configured to adapt one or more operating properties of the device in order to measure, analyze, and/or promote energy efficiency.

In embodiments, an intelligent agent may be developed for and/or deployed to a specific one or more devices by a user and/or management process. Alternatively or additionally, an intelligent agent may be portable and/or mobile, and may autonomously travel among devices of an infrastructure in order to pursue the one or more heuristics, objectives, policies, and/or rules. For example, an intelligent agent in an industrial facility that includes a multitude of devices may autonomously travel to each device of the industrial facility to measure energy efficiency. At each device, the intelligent agent may collect, store, analyze, summarize, aggregate, and/or transmit data regarding the energy efficiency of the device. The information may be centrally stored (e.g., in a database that also includes data reported by other intelligent agents). The information may be reported to a user (e.g., a report on energy efficiency of the devices of the industrial facility, and/or a recommendation for improving the energy efficiency of the industrial facility based on the collected data).

In embodiments, an intelligent agent may communicate with other intelligent agents. For example, a collection of intelligent agents may share a set of one or more heuristics, objectives, policies, and/or rules, and each intelligent agent may apply the one or more heuristics, objectives, policies, and/or rules to a subset of devices of an industrial facility. The intelligent agents may communicate collected data and/or analytic results with one other (e.g., to compile and/or compare collected information for different devices). As another example, each intelligent agent of a collection of intelligent agents may have a distinct a set of one or more heuristics, objectives, policies, and/or rules; for example, each agent may have different one or more heuristics, objectives, policies, and/or rules than other intelligent agents. For example, a first intelligent agent may store and use a set of one or more heuristics, objectives, policies, and/or rules based on energy efficiency, while a second intelligent agent may store and use a set of one or more heuristics, objectives, policies, and/or rules based on reducing the generation and/or emission of carbon-based substances. The intelligent agents may reach different determinations of how to adjust the operational parameters of various devices based on their different sets of heuristics, objectives, policies, and/or rules. The intelligent agents may therefore communicate with one another to determine a set of operational parameters for each device that is consistent with the heuristics, objectives, policies, and/or rules of both agents. Such communication may include various reconciliation processes, such as negotiation, prioritization, voting, consensus, simulation, or the like.

In embodiments, an intelligent agent may function autonomously to pursue the one or more heuristics, objectives, policies, and/or rules. For example, at each device, the intelligent agent may automatically adapt one or more operating properties of the device in order to measure, analyze, and/or promote energy efficiency. Alternatively or additionally, the intelligent agent may generate and present to a user (e.g., an administrator of an industrial facility) one or more recommendations for adapting the operating properties of one or more of the devices. The adjusted properties may include, e.g., a selection of industrial processes to command a device to perform; an adjustment of operating features of an industrial process that the device performs; a selection of one or more maintenance tasks to be performed on the device; an analysis and/or decommissioning of a device that is not satisfying the one or more heuristics, objectives, policies, and/or rules; and/or a replacement of the device with another device that is more capable of satisfying the one or more heuristics, objectives, policies, and/or rules.

In embodiments, the other objective is an operational objective of an enterprise.

In embodiments, the intelligent agent operates on status data from a set of edge devices via which a set of energy generation resources are controlled.

In embodiments, the intelligent agent operates on status data from a set of edge devices via which a set of energy consumption resources are controlled.

In embodiments, the intelligent agent operates on status data from a set of edge devices via which a set of energy storage resources are controlled.

In embodiments, the intelligent agent operates on status data from a set of edge devices via which a set of energy delivery resources are controlled.

In embodiments, the intelligent agent is further configured to adapt a transport of data over a network and/or communication system, wherein the adapting is based on at least one of, a congestion condition, a delay and/or latency condition, a packet loss condition, an error rate condition, a cost of transport condition, a quality-of: service (QoS) condition, a usage condition, a market factor condition, or a user configuration condition.

In embodiments, the AI-based platform further includes an adaptive energy digital twin that represents at least one of, an energy stakeholder entity, an energy distribution resource, a stakeholder information technology, a networking infrastructure entity, an energy-dependent stakeholder production facility, a stakeholder transportation system, a market condition, or an energy usage priority condition.

In embodiments, the AI-based platform further includes an adaptive energy digital twin that is configured to perform at least one of, providing a visual and/or analytic indicator of energy consumption by at least one energy consumer, filtering energy data, highlighting energy data, or adjusting energy data.

In embodiments, the AI-based platform further includes an adaptive energy digital twin that is configured to generate a visual and/or analytic indicator of energy consumption by at least one of, at least one machine, at least one factory, or at least one vehicle in a vehicle fleet.

In embodiments, the intelligent agent is further configured to perform at least one of, extracting energy-related data, detecting and/or correcting errors in energy-related data, transforming, converting, normalizing, and/or cleansing energy-related data, parsing energy-related data, detecting patterns, content, and/or objects in energy-related data, compressing energy-related data, streaming energy-related data, filtering energy-related data, loading and/or storing energy-related data, routing and/or transporting energy-related data, or maintaining security of energy-related data.

In embodiments, the data set is based on at least one public data resource, the public data resources including at least one of, a weather data resource, a satellite data resource, a census, population, demographic, and/or psychographic data resource, a market data resource, or an ecommerce data resource.

In embodiments, the data set is based on at least one enterprise data resource, the enterprise data resources including at least one of, resource planning data, sales and/or marketing data, financial planning data, demand planning data, supply chain data, procurement data, pricing data, customer data, product data, or operating data.

In embodiments, the intelligent agent is trained based on a training data set, and the training data set is based on at least one of, at least one human tag and/or label, at least one human interaction with a hardware and/or software system, at least one outcome, at least one AI-generated training data sample, a supervised learning training process, a semi-supervised learning training process, or a deep learning training process.

In embodiments, the intelligent agent is further configured to orchestrate delivery of energy to at least one point of consumption, and the delivery of the energy includes at least one of, at least one fixed transmission line, at least one instance of wireless energy transmission, at least one delivery of fuel, or at least one delivery of stored energy.

In embodiments, the intelligent agent is further configured to record, in a distributed ledger and/or blockchain, at least one energy-related event, the at least one energy-related event including at least one of, an energy purchase and/or sale event, a service charge associated with an energy purchase and/or sale event, an energy consumption event, an energy generation event, an energy distribution event, an energy storage event, a carbon emission production event, a carbon emission abatement event, a renewable energy credit event, a pollution production event, or a pollution abatement event.

In embodiments, the intelligent agent is deployed in an off-grid environment, and the off-grid environment includes at least one of, an off-grid energy generation system, an off-grid energy storage system, or an off-grid energy mobilization system.

In embodiments, the intelligent agent is located in proximity to at least one entity that generates, stores, delivers, and/or uses energy.

In embodiments, the intelligent agent provides information about an energy state and/or energy flow of at least one entity that generates, stores, delivers, and/or uses energy.

In embodiments, the intelligent agent governs at least one sensor of a set of sensors, and the set of sensors is associated with a set of infrastructure assets that are configured to generate, store, deliver, and/or use energy. INTELLIGENT ORCHESTRATION SYSTEMS FOR ENERGY AND POWER MANAGEMENT WITHIN DEFINED DOMAINS

In embodiments, an AI-based platform for enabling intelligent orchestration and management of power and energy includes an artificial intelligence system that is trained on a set of energy generation, energy storage, energy delivery and/or energy consumption outcomes, wherein the artificial intelligence system is configured to, analyze a data set of current energy generation, current energy storage, current energy delivery and/or current energy consumption information, and provide a recommendation including at least one operating parameter that satisfies both of a mobile entity energy demand or a fixed location energy demand in a defined domain.

For example, energy generation, energy storage, energy delivery and/or energy consumption outcomes may be based on one or more energy-related objectives, such as reducing costs, improving energy efficiency, prioritizing energy availability for organizational processes, reducing emissions, shifting to renewable energy resources, establishing new resources in particular geographic regions, entering new markets, developing new products, undertaking new manufacturing processes, or the like. Each outcome may include various constraints, such as a resource allocation, a timeframe or target date, a schedule of milestones, an achievement of a quantitative goal, a cost/benefit analysis, or the like.

The defined domain may include various boundaries that include both the mobile entity energy demand and the fixed location energy demand. For example, the domain may include a geographic boundary, e.g., a geographic region of a particular size, shape, or identity, and all of the mobile and/or fixed energy demands that arise within the geographic boundary. The domain may include a device type boundary, e.g., a defined set of devices of a particular device type, and the energy demands associated with those devices. The domain may include a user type boundary, e.g., a defined set of devices used by one or more particular users, and the energy demands associated with those devices. The domain may include an organization boundary, e.g., a defined set of devices used by a particular organization, and the energy demands associated with those devices. The domain may include a task boundary, e.g., a defined set of devices that are associated with a particular task (e.g., collection of weather data around the world), and the energy demands associated with those devices. The domain may include an industry boundary, e.g., a defined set of devices that are associated with a particular industry, and the energy demands associated with those devices.

The mobile entity energy demand may include various types of demand with mobile characteristics. For example, the mobile entity energy demand may include the energy demands of mobile devices, such as mobile phones, tablets, wearable devices, vehicles, and the like. The mobile entity energy demand may include the energy demands of a particular individual who is mobile, such as a user who uses a set of fixed terminals in various locations. The mobile entity energy demand may include an energy demand that is mobile, such as a need for energy that occurs at different locations at different times.

The fixed location energy demand may include various types of demand that are associated with a fixed location. For example, the fixed location energy demand may include the energy demands of one or more stationary devices in a particular location, such as workstations, terminals, industrial machines, and the like. The devices may be stationary by nature (e.g., incapable of being reasonably moved); may be mobile, but secured in place (e.g., a mobile device that is locked down in a fixed location); and/or may be associated with immobile processes in a fixed location (e.g., a mobile machine that is deployed and in permanent service of a fixed-location industrial process). The fixed location energy demand may include the energy demands of a particular individual who is stationary, such as a user who interacts with devices only in a specific, fixed location (e.g., a secured facility with an airgap security measure) The fixed location energy demand may include an energy demand that is immobile, such as a need for energy that occurs only in a specified set of locations.

In embodiments, the artificial intelligence system is trained to provide recommendations including at least one operating parameter that satisfies both of a mobile entity energy demand or a fixed location energy demand in a defined domain. For example, based on a domain that includes one or more mobile devices and one or more fixed-location devices, the artificial intelligence system may be configured to generate recommendations for the generation, storage, and/or transport of energy that satisfies both of a mobile entity energy demand or a fixed location energy demand in a defined domain, such as a recommendation of portable power supplies that can be deployed either to a current or forecasted location of the one or more mobile devices, and also to the fixed location of the one or more fixed-location devices. Alternatively or additionally, the artificial intelligence system may be configured to generate a recommendation of the provision of power meters at that are capable of detecting energy usage at both a current or forecasted location of the one or more mobile devices, and also at the fixed location of the one or more fixed-location devices. Readings from the power meters may indicate patterns of energy demand by both the mobile devices and the fixed-location devices. Alternatively or additionally, the artificial intelligence system may be configured to generate a recommendation of the development of new energy resources that are capable of supplying power to both a current or forecasted location of the one or more mobile devices, and also to the fixed location of the one or more fixed-location devices, such as the construction of power outlets at the respective locations, the deployment of solar panels at each of the respective locations, or the development of a connective power grid or wireless power transfer conduit that interconnects the respective locations to exchange power. Alternatively or additionally, the artificial intelligence system may be configured to generate recommendations for dynamic power allocation based on the simultaneous energy demands of both mobile entities and fixed-location entities. By way of example, with electric vehicles (mobile entities) and industrial machinery (fixed-location entities), the artificial intelligence system may dynamically allocate power, ensuring that charging stations provide rapid charging to vehicles during peak transit times, while diverting power to industrial operations during off-peak hours.

In embodiments, the defined domain includes a defined geolocation and a defined time period.

In embodiments, the at least one operating parameter indicates a generation instruction for a set of energy generation resources.

In embodiments, the at least one operating parameter indicates a storage instruction for a set of energy storage resources.

In embodiments, the at least one operating parameter indicates a delivery instruction for a set of energy delivery resources.

In embodiments, the at least one operating parameter indicates a consumption instruction for a set of entities that consume energy.

In embodiments, the artificial intelligence system is further configured to adapt a transport of data over a network and/or communication system, wherein the adapting is based on at least one of, a congestion condition, a delay and/or latency condition, a packet loss condition, an error rate condition, a cost of transport condition, a quality-of-service (QoS) condition, a usage condition, a market factor condition, or a user configuration condition.

In embodiments, the AI-based platform further includes an adaptive energy digital twin that represents at least one of, an energy stakeholder entity, an energy distribution resource, a stakeholder information technology, a networking infrastructure entity, an energy-dependent stakeholder production facility, a stakeholder transportation system, a market condition, or an energy usage priority condition.

In embodiments, the AI-based platform further includes an adaptive energy digital twin that is configured to perform at least one of, providing a visual and/or analytic indicator of energy consumption by at least one energy consumer, filtering energy data, highlighting energy data, or adjusting energy data.

In embodiments, the AI-based platform further includes an adaptive energy digital twin that is configured to generate a visual and/or analytic indicator of energy consumption by at least one of, at least one machine, at least one factory, or at least one vehicle in a vehicle fleet.

In embodiments, the artificial intelligence system is further configured to perform at least one of, extracting energy-related data, detecting and/or correcting errors in energy-related data, transforming, converting, normalizing, and/or cleansing energy-related data, parsing energy-related data, detecting patterns, content, and/or objects in energy-related data, compressing energy-related data, streaming energy-related data, filtering energy-related data, loading and/or storing energy-related data, routing and/or transporting energy-related data, or maintaining security of energy-related data.

In embodiments, the data set is based on at least one public data resource, the at least one public data resource including at least one of, a weather data resource, a satellite data resource, a census, population, demographic, and/or psychographic data resource, a market data resource, or an ecommerce data resource.

In embodiments, the data set is based on at least one enterprise data resource, the at least one enterprise data resources including at least one of, resource planning data, sales and/or marketing data, financial planning data, demand planning data, supply chain data, procurement data, pricing data, customer data, product data, or operating data.

In embodiments, the artificial intelligence system is trained based on a training data set, and the training data set is based on at least one of, at least one human tag and/or label, at least one human interaction with a hardware and/or software system, at least one outcome, at least one AI-generated training data sample, a supervised learning training process, a semi-supervised learning training process, or a deep learning training process.

In embodiments, the artificial intelligence system is further configured to orchestrate delivery of energy to at least one point of consumption, and the delivery of the energy includes at least one of, at least one fixed transmission line, at least one instance of wireless energy transmission, at least one delivery of fuel, or at least one delivery of stored energy.

In embodiments, the artificial intelligence system is further configured to record, in a distributed ledger and/or blockchain, at least one energy-related event, the at least one energy-related event including at least one of, an energy purchase and/or sale event, a service charge associated with an energy purchase and/or sale event, an energy consumption event, an energy generation event, an energy distribution event, an energy storage event, a carbon emission production event, a carbon emission abatement event, a renewable energy credit event, a pollution production event, or a pollution abatement event.

In embodiments, the artificial intelligence system is deployed in an off-grid environment, and the off-grid environment includes at least one of, an off-grid energy generation system, an off-grid energy storage system, or an off-grid energy mobilization system.

In embodiments, the artificial intelligence system is located in proximity to at least one entity that generates, stores, delivers, and/or uses energy.

In embodiments, the artificial intelligence system provides information about an energy state and/or energy flow of at least one entity that generates, stores, delivers, and/or uses energy.

In embodiments, the artificial intelligence system governs at least one sensor of a set of sensors, and the set of sensors is associated with a set of infrastructure assets that are configured to generate, store, deliver, and/or use energy.

### Intelligent Orchestration Systems for Energy and Power Management Based on Monitoring Local Conditions

In embodiments, an AI-based platform for enabling intelligent orchestration and management of power and energy includes an artificial intelligence system configured to, analyze a data set of monitored local conditions, and generate a recommended configuration of at least one distributed system of a set of distributed systems, each distributed system of the set of distributed systems being configurable both to produce energy and to consume energy, wherein the configuration causes the at least one distributed system to produce and/or consume energy based on the monitored local conditions.

In embodiments, the artificial intelligence system configures a plurality of the distributed systems in the set such that a set of aggregate performance requirements are satisfied across the plurality.

In embodiments, the aggregate performance requirements are a set of economic performance requirements.

In embodiments, the aggregate performance requirements are a set of regulatory performance requirements.

In embodiments, the aggregate performance requirements relate to carbon generation or emissions.

In embodiments, the aggregate performance requirements are a set of consumption requirements.

In embodiments, the artificial intelligence system is further configured to adapt a transport of data over a network and/or communication system, wherein the adapting is based on at least one of, a congestion condition, a delay and/or latency condition, a packet loss condition, an error rate condition, a cost of transport condition, a quality-of-service (QoS) condition, a usage condition, a market factor condition, or a user configuration condition.

In embodiments, the AI-based platform further includes an adaptive energy digital twin that represents at least one of, an energy stakeholder entity, an energy distribution resource, a stakeholder information technology, a networking infrastructure entity, an energy-dependent stakeholder production facility, a stakeholder transportation system, a market condition, or an energy usage priority condition.

In embodiments, the AI-based platform further includes an adaptive energy digital twin that is configured to perform at least one of, providing a visual and/or analytic indicator of energy consumption by at least one energy consumer, filtering energy data, highlighting energy data, or adjusting energy data.

In embodiments, the AI-based platform further includes an adaptive energy digital twin that is configured to generate a visual and/or analytic indicator of energy consumption by at least one of, at least one machine, at least one factory, or at least one vehicle in a vehicle fleet.

In embodiments, the artificial intelligence system is further configured to perform at least one of, extracting energy-related data, detecting and/or correcting errors in energy-related data, transforming, converting, normalizing, and/or cleansing energy-related data, parsing energy-related data, detecting patterns, content, and/or objects in energy-related data, compressing energy-related data, streaming energy-related data, filtering energy-related data, loading and/or storing energy-related data, routing and/or transporting energy-related data, or maintaining security of energy-related data.

In embodiments, the data set is based on at least one public data resource, the public data resources including at least one of, a weather data resource, a satellite data resource, a census, population, demographic, and/or psychographic data resource, a market data resource, or an ecommerce data resource.

In embodiments, the data set is based on at least one enterprise data resource, the enterprise data resources including at least one of, resource planning data, sales and/or marketing data, financial planning data, demand planning data, supply chain data, procurement data, pricing data, customer data, product data, or operating data.

In embodiments, the artificial intelligence system is further configured to orchestrate delivery of energy to at least one point of consumption, and the delivery of the energy includes at least one of, at least one fixed transmission line, at least one instance of wireless energy transmission, at least one delivery of fuel, or at least one delivery of stored energy.

In embodiments, the artificial intelligence system is further configured to record, in a distributed ledger and/or blockchain, at least one energy-related event, the at least one energy-related event including at least one of, an energy purchase and/or sale event, a service charge associated with an energy purchase and/or sale event, an energy consumption event, an energy generation event, an energy distribution event, an energy storage event, a carbon emission production event, a carbon emission abatement event, a renewable energy credit event, a pollution production event, or a pollution abatement event.

In embodiments, the artificial intelligence system is deployed in an off-grid environment, and the off-grid environment includes at least one of, an off-grid energy generation system, an off-grid energy storage system, or an off-grid energy mobilization system.

In embodiments, the artificial intelligence system is trained based on a training data set, and the training data set is based on at least one of, at least one human tag and/or label, at least one human interaction with a hardware and/or software system, at least one outcome, at least one AI-generated training data sample, a supervised learning training process, a semi-supervised learning training process, or a deep learning training process.

In embodiments, the artificial intelligence system is located in proximity to at least one entity that generates, stores, delivers, and/or uses energy.

In embodiments, the artificial intelligence system provides information about an energy state and/or energy flow of at least one entity that generates, stores, delivers, and/or uses energy.

In embodiments, the artificial intelligence system governs at least one sensor of a set of sensors, and the set of sensors is associated with a set of infrastructure assets that are configured to generate, store, deliver, and/or use energy.

### Intelligent Orchestration Systems for Energy and Power Management of Edge Networking Devices and Distributed Energy Entities

In embodiments, an AI-based platform for enabling intelligent orchestration and management of power and energy includes a set of adaptive, autonomous data handling systems for energy data collection and transmission from a set of edge networking devices via which a set of distributed energy entities are controlled, wherein the data handling systems are trained based on a training data set to recognize a set of events and/or signals that indicate at least one energy pattern of the set of distributed energy entities.

In embodiments, the adaptive, autonomous data handling systems and/or the edge networking devices are configured to detect, determine, store, receive, and/or transmit a set of events and/or signals based on patterns of historical, current, and/or forecast energy generation, storage, transport, and/or consumption. For example, the adaptive, autonomous data handling systems and/or the edge networking devices may be configured to store events and/or signals based on patterns of historical, current, and/or forecast energy supply and/or demand over various time periods. Accordingly, the adaptive, autonomous data handling systems may be configured to analyze information collected from the edge networking devices to determine patterns of energy supply and/or demand that occurred within each time period. Further, the adaptive, autonomous data handling systems may be configured to adjust the collection of information by the edge networking devices (e.g., instructing the edge networking devices to collect and/or transmit information over shorter time periods during which energy demand is high and/or accuracy of simulating energy demand is of high significance, and over longer time periods during which energy demand is low and/or accuracy of simulating energy demand is of low significance). Alternatively or additionally, the adaptive, autonomous data handling systems may be configured to instruct the edge networking devices to adjust operational parameters of the distributed energy entities that are controlled thereby (e.g., instructing the edge networking devices to cause distributed energy entities to generate, store, and/or transmit more power, or to consume less power, during periods in which energy demand is high, and instructing the edge networking devices to cause distributed energy entities to generate, store, and/or transmit less power, or to consume more power, during periods in which energy demand is low).

As another example, the adaptive, autonomous data handling systems and/or the edge networking devices may be configured to store events and/or signals based on patterns of historical, current, and/or forecast energy supply and/or demand in view of varying granularity of data collection for each entity of a set of entities (e.g., copious data collected on high-consumption entities, and sparse data collected on low-consumption entities). Accordingly, the adaptive, autonomous data handling systems may be configured to analyze information collected from the edge networking devices to determine patterns of energy supply and/or demand for each of the consuming entities based on the collected data. Further, the adaptive, autonomous data handling systems may be configured to adjust the collection of information by the edge networking devices (e.g., instructing the edge networking devices to collect and/or transmit more copious data associated with high-consumption entities, and to collect and/or transmit more sparse data associated with low-consumption entities). Alternatively or additionally, the adaptive, autonomous data handling systems may be configured to instruct the edge networking devices to adjust operational parameters of the distributed energy entities that are controlled thereby (e.g., instructing the edge networking devices to cause high-consuming distributed energy entities to consume more power during periods in which energy availability is high, and/or instructing the edge networking devices to cause high-consuming distributed energy entities to consume less power during periods in which energy availability is low).

As another example, the adaptive, autonomous data handling systems and/or the edge networking devices may be configured to store events and/or signals based on patterns of historical, current, and/or forecast energy supply and/or demand in view of varying granularity of data collection for each energy usage type of a set of energy usage types (e.g., copious data collected on high-consumption processes, and sparse data collected on low-consumption processes). Accordingly, the adaptive, autonomous data handling systems may be configured to analyze information collected from the edge networking devices to determine patterns of energy supply and/or demand for each of the processes based on the collected data. Further, the adaptive, autonomous data handling systems may be configured to adjust the collection of information by the edge networking devices (e.g., instructing the edge networking devices to collect and/or transmit more copious data associated with high-consumption processes, and to collect and/or transmit more sparse data associated with low-consumption processes). Alternatively or additionally, the adaptive, autonomous data handling systems may be configured to instruct the edge networking devices to adjust operational parameters of the distributed energy entities that are controlled thereby (e.g., instructing the edge networking devices to schedule the performance of high-consumption processes during periods in which energy availability is high, and/or instructing the edge networking devices to refrain from scheduling the performance of high-consumption processes during periods in which energy availability is low).

In embodiments, the adaptive, autonomous data handling systems are trained based on a training data set to recognize a set of events and/or signals that indicate at least one energy pattern. For example, the training may involve the training of one or more machine learning models based on a training data set of energy patterns. At least a portion of the training data set may include a labeled training data set (e.g., a data set indicating energy usage metrics, and one or more labels that indicate patterns of energy usage, such as labels associated with efficient energy usage and labels associated with inefficiency energy usage). The training data may be labeled by the edge networking devices; by the adaptive, autonomous data handling systems; or by a third party, such as a user or another process. The adaptive, autonomous data handling systems may use the labeled training data set to train a machine learning model to analyze, as input, measurements of energy generation, storage, transport, and/or consumption, and to generate, as output, a label indicating whether the pattern denotes efficient energy usage or inefficient energy usage. Alternatively or additionally, at least a portion of the training data set may include unlabeled data (e.g., a data set indicating energy usage, but without labels that indicate patterns of energy usage). The adaptive, autonomous data handling systems may apply unsupervised training techniques (e.g., clustering) to determine, within the unlabeled data, one or more patterns of energy usage that are associated with efficient energy usage and/or one or more patterns of energy usage that are associated with inefficient energy usage.

In embodiments, the adaptive, autonomous data handling systems are configured to generate various types of recommendations based on the determination of patterns of energy usage. For example, the adaptive, autonomous data handling systems may be configured to generate recommendations that include metrics and/or qualitative assessments of energy usage patterns to one or more entities (e.g., governments, companies, organizations, users, or the like) and/or devices (e.g., servers, industrial equipment, vehicles, mobile devices, or the like). Alternatively or additionally, the adaptive, autonomous data handling systems may be configured to generate recommendations that include metrics and/or qualitative assessments of energy usage patterns stored in one or more databases, data warehouses, centralized or distributed ledgers, or the like. Alternatively or additionally, the adaptive, autonomous data handling systems may be configured to generate recommendations that include aggregate metrics and/or qualitative assessments of the energy usage patterns by various dimensions, such as time (e.g., periodic reports over periods of a day, month, season, or year), source (e.g., reports of various machines in a processing plant), energy usage type (e.g., reports of different types of energy usage by various machines), associated region (e.g., reports of energy patterns in various locations of a region), or the like. Alternatively or additionally, the adaptive, autonomous data handling systems may be configured to generate recommendations that include alerts of energy usage patterns (e.g., recommendations based on detecting and/or determining that an energy usage pattern has exceeded an energy usage threshold, such as a target, goal, and/or cap for maximum energy consumption within a period of time). Alternatively or additionally, the adaptive, autonomous data handling systems may be configured to generate recommendations to instruct at least one of the edge networking devices to alter an operation of one or more pieces of equipment and/or processes based on measurements and/or qualitative assessments of the energy usage patterns (e.g., scheduling an operation of machines within a manufacturing plant based on the detected and/or determined energy usage pattern). Alternatively or additionally, the adaptive, autonomous data handling systems may be configured to generate recommendations for predictive maintenance based on energy usage patterns of various components within the distributed energy entities. By way of example, a sudden or consistent increase in energy consumption by a particular machine may indicate a malfunction potentially due to component wear, and in such case, the recommendations may include guidance for proactive maintenance to avoid costly downtime. Alternatively or additionally, the adaptive, autonomous data handling systems may be configured to generate recommendations for energy source utilization. By way of example, by analyzing patterns, the systems may determine periods when certain renewable energy sources, such as solar or wind, are less reliable, and may accordingly recommend utilizing alternative energy sources during those times, to ensure consistent energy supply.

In embodiments, the set of distributed energy entities includes at least one energy generation resource.

In embodiments, the set of distributed energy entities includes at least one energy consuming entity.

In embodiments, the set of distributed energy entities includes at least one energy storage resource.

In embodiments, the set of distributed energy entities includes at least one energy delivery resource.

In embodiments, the training data set includes historical energy generation data for a set of entities similar to the entities controlled via the edge networking devices.

In embodiments, the training data set includes historical energy consumption data for a set of entities similar to the entities controlled via the edge networking devices.

In embodiments, the training data set includes historical energy delivery data for a set of entities similar to the entities controlled via the edge networking devices.

In embodiments, the training data set includes historical energy storage data for a set of entities similar to the entities controlled via the edge networking devices.

In embodiments, at least one of the adaptive, autonomous data handling systems is further configured to adapt a transport of data over a network and/or communication system, wherein the adapting is based on at least one of, a congestion condition, a delay and/or latency condition, a packet loss condition, an error rate condition, a cost of transport condition, a quality-of-service (QoS) condition, a usage condition, a market factor condition, or a user configuration condition.

In embodiments, the AI-based platform further includes an adaptive energy digital twin that represents at least one of, an energy stakeholder entity, an energy distribution resource, a stakeholder information technology, a networking infrastructure entity, an energy-dependent stakeholder production facility, a stakeholder transportation system, a market condition, or an energy usage priority condition.

In embodiments, the AI-based platform further includes an adaptive energy digital twin that is configured to perform at least one of, providing a visual and/or analytic indicator of energy consumption by at least one energy consumer, filtering energy data, highlighting energy data, or adjusting energy data.

In embodiments, the AI-based platform further includes an adaptive energy digital twin that is configured to generate a visual and/or analytic indicator of energy consumption by at least one of, at least one machine, at least one factory, or at least one vehicle in a vehicle fleet.

In embodiments, at least one of the adaptive, autonomous data handling systems is further configured to perform at least one of, extracting energy-related data, detecting and/or correcting errors in energy-related data, transforming, converting, normalizing, and/or cleansing energy-related data, parsing energy-related data, detecting patterns, content, and/or objects in energy-related data, compressing energy-related data, streaming energy-related data, filtering energy-related data, loading and/or storing energy-related data, routing and/or transporting energy-related data, or maintaining security of energy-related data.

In embodiments, the energy edge set is based on at least one public data resource, the public data resources including at least one of, a weather data resource, a satellite data resource, a census, population, demographic, and/or psychographic data resource, a market data resource, or an ecommerce data resource.

In embodiments, the energy edge set is based on at least one enterprise data resource, the at least one enterprise data resource including at least one of, resource planning data, sales and/or marketing data, financial planning data, demand planning data, supply chain data, procurement data, pricing data, customer data, product data, or operating data.

In embodiments, the AI-based platform further includes at least one AI-based model and/or algorithm, wherein the at least one AI-based model and/or algorithm is trained based on a training data set, and the training data set is based on at least one of, at least one human tag and/or label, at least one human interaction with a hardware and/or software system, at least one outcome, at least one AI-generated training data sample, a supervised learning training process, a semi-supervised learning training process, or a deep learning training process.

In embodiments, at least one of the adaptive, autonomous data handling systems is further configured to orchestrate delivery of energy to at least one point of consumption, and the delivery of the energy includes at least one of, at least one fixed transmission line, at least one instance of wireless energy transmission, at least one delivery of fuel, or at least one delivery of stored energy.

In embodiments, at least one of the adaptive, autonomous data handling systems is further configured to record, in a distributed ledger and/or blockchain, at least one energy-related event, the at least one energy-related event including at least one of, an energy purchase and/or sale event, a service charge associated with an energy purchase and/or sale event, an energy consumption event, an energy generation event, an energy distribution event, an energy storage event, a carbon emission production event, a carbon emission abatement event, a renewable energy credit event, a pollution production event, or a pollution abatement event.

In embodiments, at least one of the adaptive, autonomous data handling systems is deployed in an off-grid environment, and the off-grid environment includes at least one of, an off-grid energy generation system, an off-grid energy storage system, or an off-grid energy mobilization system.

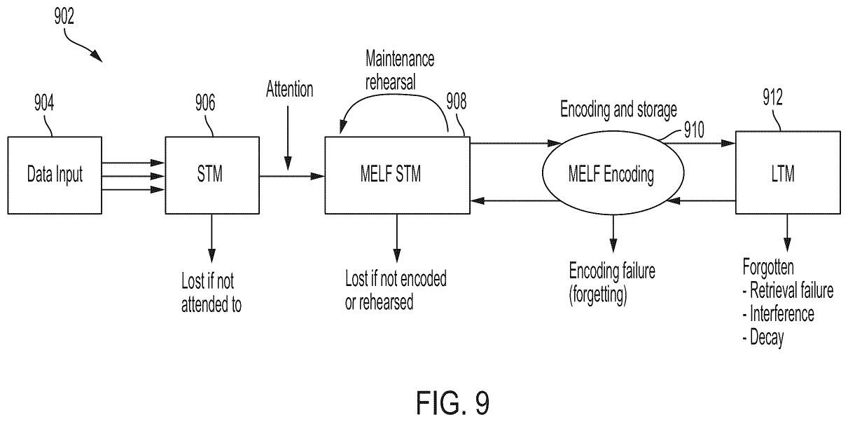

### FIGS. 9-37: Neural Network Examples

The foregoing neural networks may have a variety of nodes or neurons, which may perform a variety of functions on inputs, such as inputs received from sensors or other data sources, including other nodes. Functions may involve weights, features, feature vectors, and the like. Neurons may include perceptrons, neurons that mimic biological functions (such as of the human senses of touch, vision, taste, hearing, and smell), and the like. Continuous neurons, such as with sigmoidal activation, may be used in the context of various forms of neural net, such as where back propagation is involved.

In many embodiments, an expert system or neural network may be trained, such as by a human operator or supervisor, or based on a data set, model, or the like. Training may include presenting the neural network with one or more training data sets that represent values, such as sensor data, event data, parameter data, and other types of data (including the many types described throughout this disclosure), as well as one or more indicators of an outcome, such as an outcome of a process, an outcome of a calculation, an outcome of an event, an outcome of an activity, or the like. Training may include training in optimization, such as training a neural network to optimize one or more systems based on one or more optimization approaches, such as Bayesian approaches, parametric Bayes classifier approaches, k-nearest-neighbor classifier approaches, iterative approaches, interpolation approaches, Pareto optimization approaches, algorithmic approaches, and the like. Feedback may be provided in a process of variation and selection, such as with a genetic algorithm that evolves one or more solutions based on feedback through a series of rounds.

In embodiments, a plurality of neural networks may be deployed in a cloud platform that receives data streams and other inputs collected (such as by mobile data collectors) in one or more energy edge environments and transmitted to the cloud platform over one or more networks, including using network coding to provide efficient transmission. In the cloud platform, optionally using massively parallel computational capability, a plurality of different neural networks of various types (including modular forms, structure-adaptive forms, hybrids, and the like) may be used to undertake prediction, classification, control functions, and provide other outputs as described in connection with expert systems disclosed throughout this disclosure. The different neural networks may be structured to compete with each other (optionally including use evolutionary algorithms, genetic algorithms, or the like), such that an appropriate type of neural network, with appropriate input sets, weights, node types and functions, and the like, may be selected, such as by an expert system, for a specific task involved in a given context, workflow, environment process, system, or the like.

In embodiments, methods and systems described herein that involve an expert system or self-organization capability may use a feed forward neural network, which moves information in one direction, such as from a data input, like a data source related to at least one resource or parameter related to a transactional environment, such as any of the data sources mentioned throughout this disclosure, through a series of neurons or nodes, to an output. Data may move from the input nodes to the output nodes, optionally passing through one or more hidden nodes, without loops. In embodiments, feed forward neural networks may be constructed with various types of units, such as binary McCulloch-Pitts neurons, the simplest of which is a perceptron.

In embodiments, methods and systems described herein that involve an expert system or self-organization capability may use a capsule neural network, such as for prediction, classification, or control functions with respect to a transactional environment, such as relating to one or more of the machines and automated systems described throughout this disclosure.

In embodiments, methods and systems described herein that involve an expert system or self-organization capability may use a radial basis function (RBF) neural network, which may be preferred in some situations involving interpolation in a multi-dimensional space (such as where interpolation is helpful in optimizing a multi-dimensional function, such as for optimizing a data marketplace as described here, optimizing the efficiency or output of a power generation system, a factory system, or the like, or other situation involving multiple dimensions. In embodiments, each neuron in the RBF neural network stores an example from a training set as a “prototype.” Linearity involved in the functioning of this neural network offers RBF the advantage of not typically suffering from problems with local minima or maxima.

In embodiments, methods and systems described herein that involve an expert system or self-organization capability may use a radial basis function (RBF) neural network, such as one that employs a distance criterion with respect to a center (e.g., a Gaussian function). A radial basis function may be applied as a replacement for a hidden layer, such as a sigmoidal hidden layer transfer, in a multi-layer perceptron. An RBF network may have two layers, such as where an input is mapped onto each RBF in a hidden layer. In embodiments, an output layer may comprise a linear combination of hidden layer values representing, for example, a mean predicted output. The output layer value may provide an output that is the same as or similar to that of a regression model in statistics. In classification problems, the output layer may be a sigmoid function of a linear combination of hidden layer values, representing a posterior probability. Performance in both cases is often improved by shrinkage techniques, such as ridge regression in classical statistics. This corresponds to a prior belief in small parameter values (and therefore smooth output functions) in a Bayesian framework. RBF networks may avoid local minima, because the only parameters that are adjusted in the learning process are the linear mapping from hidden layer to output layer. Linearity ensures that the error surface is quadratic and therefore has a single minimum. In regression problems, this can be found in one matrix operation. In classification problems, the fixed non-linearity introduced by the sigmoid output function may be handled using an iteratively re-weighted least-squares function or the like.

RBF networks may use kernel methods such as support vector machines (SVM) and Gaussian processes (where the RBF is the kernel function). A non-linear kernel function may be used to project the input data into a space where the learning problem can be solved using a linear model.

In embodiments, an RBF neural network may include an input layer, a hidden layer and a summation layer. In the input layer, one neuron appears in the input layer for each predictor variable. In the case of categorical variables, N-1 neurons are used, where N is the number of categories. The input neurons may, in embodiments, standardize the value ranges by subtracting the median and dividing by the interquartile range. The input neurons may then feed the values to each of the neurons in the hidden layer. In the hidden layer, a variable number of neurons may be used (determined by the training process). Each neuron may consist of a radial basis function that is centered on a point with as many dimensions as a number of predictor variables. The spread (e.g., radius) of the RBF function may be different for each dimension. The centers and spreads may be determined by training. When presented with a vector of input values from the input layer, a hidden neuron may compute a Euclidean distance of the test case from the neuron's center point and then apply the RBF kernel function to this distance, such as using the spread values. The resulting value may then be passed to the summation layer. In the summation layer, the value coming out of a neuron in the hidden layer may be multiplied by a weight associated with the neuron and may add to the weighted values of other neurons. This sum becomes the output. For classification problems, one output is produced (with a separate set of weights and summation units) for each target category. The value output for a category is the probability that the case being evaluated has that category. In training of an RBF, various parameters may be determined, such as the number of neurons in a hidden layer, the coordinates of the center of each hidden-layer function, the spread of each function in each dimension, and the weights applied to outputs as they pass to the summation layer. Training may be used by clustering algorithms (such as k-means clustering), by evolutionary approaches, and the like.

In embodiments, a recurrent neural network may have a time-varying, real-valued (more than just zero or one) activation (output). Each connection may have a modifiable real-valued weight. Some of the nodes are called labeled nodes, some output nodes, and others hidden nodes. For supervised learning in discrete time settings, training sequences of real-valued input vectors may become sequences of activations of the input nodes, one input vector at a time. At each time step, each non-input unit may compute its current activation as a nonlinear function of the weighted sum of the activations of all units from which it receives connections. The system can explicitly activate (independent of incoming signals) some output units at certain time steps.

In embodiments, methods and systems described herein that involve an expert system or self-organization capability may use a self-organizing neural network, such as a Kohonen self-organizing neural network, such as for visualization of views of data, such as low-dimensional views of high-dimensional data. The self-organizing neural network may apply competitive learning to a set of input data, such as from one or more sensors or other data inputs from or associated with a transactional environment, including any machine or component that relates to the transactional environment. In embodiments, the self-organizing neural network may be used to identify structures in data, such as unlabeled data, such as in data sensed from a range of data sources about or sensors in or about in a transactional environment, where sources of the data are unknown (such as where events may be coming from any of a range of unknown sources). The self-organizing neural network may organize structures or patterns in the data, such that they can be recognized, analyzed, and labeled, such as identifying market behavior structures as corresponding to other events and signals.

In embodiments, methods and systems described herein that involve an expert system or self-organization capability may use a recurrent neural network, which may allow for a bidirectional flow of data, such as where connected units (e.g., neurons or nodes) form a directed cycle. Such a network may be used to model or exhibit dynamic temporal behavior, such as involved in dynamic systems, such as a wide variety of the automation systems, machines and devices described throughout this disclosure, such as an automated agent interacting with a marketplace for purposes of collecting data, testing spot market transactions, execution transactions, and the like, where dynamic system behavior involves complex interactions that a user may desire to understand, predict, control and/or optimize. For example, the recurrent neural network may be used to anticipate the state of a market, such as one involving a dynamic process or action, such as a change in state of a resource that is traded in or that enables a marketplace of transactional environment. In embodiments, the recurrent neural network may use internal memory to process a sequence of inputs, such as from other nodes and/or from sensors and other data inputs from or about the transactional environment, of the various types described herein. In embodiments, the recurrent neural network may also be used for pattern recognition, such as for recognizing a machine, component, agent, or other item based on a behavioral signature, a profile, a set of feature vectors (such as in an audio file or image), or the like. In a non-limiting example, a recurrent neural network may recognize a shift in an operational mode of a marketplace or machine by learning to classify the shift from a training data set consisting of a stream of data from one or more data sources of sensors applied to or about one or more resources.

In embodiments, methods and systems described herein that involve an expert system or self-organization capability may use a modular neural network, which may comprise a series of independent neural networks (such as ones of various types described herein) that are moderated by an intermediary. Each of the independent neural networks in the modular neural network may work with separate inputs, accomplishing sub tasks that make up the task the modular network as whole is intended to perform. For example, a modular neural network may comprise a recurrent neural network for pattern recognition, such as to recognize what type of machine or system is being sensed by one or more sensors that are provided as input channels to the modular network and an RBF neural network for optimizing the behavior of the machine or system once understood. The intermediary may accept inputs of each of the individual neural networks, process them, and create output for the modular neural network, such an appropriate control parameter, a prediction of state, or the like.

Combinations among any of the pairs, triplets, or larger combinations, of the various neural network types described herein, are encompassed by the present disclosure. This may include combinations where an expert system uses one neural network for recognizing a pattern (e.g., a pattern indicating a problem or fault condition) and a different neural network for self-organizing an activity or workflow based on the recognized pattern (such as providing an output governing autonomous control of a system in response to the recognized condition or pattern). This may also include combinations where an expert system uses one neural network for classifying an item (e.g., identifying a machine, a component, or an operational mode) and a different neural network for predicting a state of the item (e.g., a fault state, an operational state, an anticipated state, a maintenance state, or the like). Modular neural networks may also include situations where an expert system uses one neural network for determining a state or context (such as a state of a machine, a process, a work flow, a marketplace, a storage system, a network, a data collector, or the like) and a different neural network for self-organizing a process involving the state or context (e.g., a data storage process, a network coding process, a network selection process, a data marketplace process, a power generation process, a manufacturing process, a refining process, a digging process, a boring process, or other process described herein).

In embodiments, methods and systems described herein that involve an expert system or self-organization capability may use a physical neural network where one or more hardware elements is used to perform or simulate neural behavior. In embodiments, one or more hardware neurons may be configured to stream voltage values, current values, or the like that represent sensor data, such as to calculate information from analog sensor inputs representing energy consumption, energy production, or the like, such as by one or more machines providing energy or consuming energy for one or more transactions. One or more hardware nodes may be configured to stream output data resulting from the activity of the neural net. Hardware nodes, which may comprise one or more chips, microprocessors, integrated circuits, programmable logic controllers, application-specific integrated circuits, field-programmable gate arrays, or the like, may be provided to optimize the machine that is producing or consuming energy, or to optimize another parameter of some part of a neural net of any of the types described herein. Hardware nodes may include hardware for acceleration of calculations (such as dedicated processors for performing basic or more sophisticated calculations on input data to provide outputs, dedicated processors for filtering or compressing data, dedicated processors for de-compressing data, dedicated processors for compression of specific file or data types (e.g., for handling image data, video streams, acoustic signals, thermal images, heat maps, or the like), and the like. A physical neural network may be embodied in a data collector, including one that may be reconfigured by switching or routing inputs in varying configurations, such as to provide different neural net configurations within the data collector for handling different types of inputs (with the switching and configuration optionally under control of an expert system, which may include a software-based neural net located on the data collector or remotely). A physical, or at least partially physical, neural network may include physical hardware nodes located in a storage system, such as for storing data within a machine, a data storage system, a distributed ledger, a mobile device, a server, a cloud resource, or in a transactional environment, such as for accelerating input/output functions to one or more storage elements that supply data to or take data from the neural net. A physical, or at least partially physical, neural network may include physical hardware nodes located in a network, such as for transmitting data within, to or from an energy edge environment, such as for accelerating input/output functions to one or more network nodes in the net, accelerating relay functions, or the like. In embodiments of a physical neural network, an electrically adjustable resistance material may be used for emulating the function of a neural synapse. In embodiments, the physical hardware emulates the neurons, and software emulates the neural network between the neurons. In embodiments, neural networks complement conventional algorithmic computers. They are versatile and can be trained to perform appropriate functions without the need for any instructions, such as classification functions, optimization functions, pattern recognition functions, control functions, selection functions, evolution functions, and others.

In embodiments, methods and systems described herein that involve an expert system or self-organization capability may use a multilayered feed forward neural network, such as for complex pattern classification of one or more items, phenomena, modes, states, or the like. In embodiments, a multilayered feed forward neural network may be trained by an optimization technical, such as a genetic algorithm, such as to explore a large and complex space of options to find an optimum, or near-optimum, global solution. For example, one or more genetic algorithms may be used to train a multilayered feed forward neural network to classify complex phenomena, such as to recognize complex operational modes of machines, such as modes involving complex interactions among machines (including interference effects, resonance effects, and the like), modes involving non-linear phenomena, modes involving critical faults, such as where multiple, simultaneous faults occur, making root cause analysis difficult, and others. In embodiments, a multilayered feed forward neural network may be used to classify results from monitoring of a marketplace, such as monitoring systems, such as automated agents, that operate within the marketplace, as well as monitoring resources that enable the marketplace, such as computing, networking, energy, data storage, energy storage, and other resources.

In embodiments, methods and systems described herein that involve an expert system or self-organization capability may use a feed-forward, back-propagation multi-layer perceptron (MLP) neural network, such as for handling one or more remote sensing applications, such as for taking inputs from sensors distributed throughout various transactional environments. In embodiments, the MLP neural network may be used for classification of transactional environments and resource environments, such as lending markets, spot markets, forward markets, energy markets, renewable energy credit (REC) markets, networking markets, advertising markets, spectrum markets, ticketing markets, rewards markets, compute markets, and others mentioned throughout this disclosure, as well as physical resources and environments that produce them, such as energy resources (including renewable energy environments, mining environments, exploration environments, drilling environments, and the like, including classification of geological structures (including underground features and above ground features), classification of materials (including fluids, minerals, metals, and the like), and other problems. This may include fuzzy classification.

In embodiments, methods and systems described herein that involve an expert system or self-organization capability may use a structure-adaptive neural network, where the structure of a neural network is adapted, such as based on a rule, a sensed condition, a contextual parameter, or the like. For example, if a neural network does not converge on a solution, such as classifying an item or arriving at a prediction, when acting on a set of inputs after some amount of training, the neural network may be modified, such as from a feed forward neural network to a recurrent neural network, such as by switching data paths between some subset of nodes from unidirectional to bidirectional data paths. The structure adaptation may occur under control of an expert system, such as to trigger adaptation upon occurrence of a trigger, rule or event, such as recognizing occurrence of a threshold (such as an absence of a convergence to a solution within a given amount of time) or recognizing a phenomenon as requiring different or additional structure (such as recognizing that a system is varying dynamically or in a non-linear fashion). In one non-limiting example, an expert system may switch from a simple neural network structure like a feed forward neural network to a more complex neural network structure like a recurrent neural network, a convolutional neural network, or the like upon receiving an indication that a continuously variable transmission is being used to drive a generator, turbine, or the like in a system being analyzed.

In embodiments, methods and systems described herein that involve an expert system or self-organization capability may use an autoencoder, autoassociator or Diabolo neural network, which may be similar to a multilayer perceptron (MLP) neural network, such as where there may be an input layer, an output layer and one or more hidden layers connecting them. However, the output layer in the auto-encoder may have the same number of units as the input layer, where the purpose of the MLP neural network is to reconstruct its own inputs (rather than just emitting a target value). Therefore, the auto encoders may operate as an unsupervised learning model. An auto encoder may be used, for example, for unsupervised learning of efficient codings, such as for dimensionality reduction, for learning generative models of data, and the like. In embodiments, an auto-encoding neural network may be used to self-learn an efficient network coding for transmission of analog sensor data from a machine over one or more networks or of digital data from one or more data sources. In embodiments, an auto-encoding neural network may be used to self-learn an efficient storage approach for storage of streams of data.

In embodiments, methods and systems described herein that involve an expert system or self-organization capability may use a probabilistic neural network (PNN), which in embodiments may comprise a multi-layer (e.g., four-layer) feed forward neural network, where layers may include input layers, hidden layers, pattern/summation layers and an output layer. In an embodiment of a PNN algorithm, a parent probability distribution function (PDF) of each class may be approximated, such as by a Parzen window and/or a non-parametric function. Then, using the PDF of each class, the class probability of a new input is estimated, and Bayes' rule may be employed, such as to allocate it to the class with the highest posterior probability. A PNN may embody a Bayesian network and may use a statistical algorithm or analytic technique, such as Kernel Fisher discriminant analysis technique. The PNN may be used for classification and pattern recognition in any of a wide range of embodiments disclosed herein. In one non-limiting example, a probabilistic neural network may be used to predict a fault condition of an engine based on collection of data inputs from sensors and instruments for the engine.

In embodiments, methods and systems described herein that involve an expert system or self-organization capability may use a time delay neural network (TDNN), which may comprise a feed forward architecture for sequential data that recognizes features independent of sequence position. In embodiments, to account for time shifts in data, delays are added to one or more inputs, or between one or more nodes, so that multiple data points (from distinct points in time) are analyzed together. A time delay neural network may form part of a larger pattern recognition system, such as using a perceptron network. In embodiments, a TDNN may be trained with supervised learning, such as where connection weights are trained with back propagation or under feedback. In embodiments, a TDNN may be used to process sensor data from distinct streams, such as a stream of velocity data, a stream of acceleration data, a stream of temperature data, a stream of pressure data, and the like, where time delays are used to align the data streams in time, such as to help understand patterns that involve understanding of the various streams (e.g., changes in price patterns in spot or forward markets).

In embodiments, methods and systems described herein that involve an expert system or self-organization capability may use a convolutional neural network (referred to in some cases as a CNN, a ConvNet, a shift invariant neural network, or a space invariant neural network), wherein the units are connected in a pattern similar to the visual cortex of the human brain. Neurons may respond to stimuli in a restricted region of space, referred to as a receptive field. Receptive fields may partially overlap, such that they collectively cover the entire (e.g., visual) field. Node responses can be calculated mathematically, such as by a convolution operation, such as using multilayer perceptrons that use minimal preprocessing. A convolutional neural network may be used for recognition within images and video streams, such as for recognizing a type of machine in a large environment using a camera system disposed on a mobile data collector, such as on a drone or mobile robot. In embodiments, a convolutional neural network may be used to provide a recommendation based on data inputs, including sensor inputs and other contextual information, such as recommending a route for a mobile data collector. In embodiments, a convolutional neural network may be used for processing inputs, such as for natural language processing of instructions provided by one or more parties involved in a workflow in an environment. In embodiments, a convolutional neural network may be deployed with a large number of neurons (e.g., 100,000, 500,000 or more), with multiple (e.g., 4, 5, 6 or more) layers, and with many (e.g., millions) of parameters. A convolutional neural net may use one or more convolutional nets.

In embodiments, methods and systems described herein that involve an expert system or self-organization capability may use a regulatory feedback network, such as for recognizing emergent phenomena (such as new types of behavior not previously understood in a transactional environment).

In embodiments, methods and systems described herein that involve an expert system or self-organization capability may use a self-organizing map (SOM), involving unsupervised learning. A set of neurons may learn to map points in an input space to coordinates in an output space. The input space can have different dimensions and topology from the output space, and the SOM may preserve these while mapping phenomena into groups.

In embodiments, methods and systems described herein that involve an expert system or self-organization capability may use a learning vector quantization neural net (LVQ). Prototypical representatives of the classes may parameterize, together with an appropriate distance measure, in a distance-based classification scheme.

In embodiments, methods and systems described herein that involve an expert system or self-organization capability may use an echo state network (ESN), which may comprise a recurrent neural network with a sparsely connected, random hidden layer. The weights of output neurons may be changed (e.g., the weights may be trained based on feedback). In embodiments, an ESN may be used to handle time series patterns, such as, in an example, recognizing a pattern of events associated with a market, such as the pattern of price changes in response to stimuli.

In embodiments, methods and systems described herein that involve an expert system or self-organization capability may use a Bi-directional, recurrent neural network (BRNN), such as using a finite sequence of values (e.g., voltage values from a sensor) to predict or label each element of the sequence based on both the past and the future context of the element. This may be done by adding the outputs of two RNNs, such as one processing the sequence from left to right, the other one from right to left. The combined outputs are the predictions of target signals, such as ones provided by a teacher or supervisor. A bi-directional RNN may be combined with a long short-term memory RNN.

In embodiments, methods and systems described herein that involve an expert system or self-organization capability may use a hierarchical RNN that connects elements in various ways to decompose hierarchical behavior, such as into useful subprograms. In embodiments, a hierarchical RNN may be used to manage one or more hierarchical templates for data collection in a transactional environment.

In embodiments, methods and systems described herein that involve an expert system or self-organization capability may use a stochastic neural network, which may introduce random variations into the network. Such random variations can be viewed as a form of statistical sampling, such as Monte Carlo sampling.

In embodiments, methods and systems described herein that involve an expert system or self-organization capability may use a genetic scale recurrent neural network. In such embodiments, a RNN (often a LSTM) is used where a series is decomposed into a number of scales where every scale informs the primary length between two consecutive points. A first order scale consists of a normal RNN, a second order consists of all points separated by two indices and so on. The Nth order RNN connects the first and last node. The outputs from all the various scales may be treated as a committee of members, and the associated scores may be used genetically for the next iteration.

In embodiments, methods and systems described herein that involve an expert system or self-organization capability may use a committee of machines (CoM), comprising a collection of different neural networks that together “vote” on a given example. Because neural networks may suffer from local minima, starting with the same architecture and training, but using randomly different initial weights often gives different results. A CoM tends to stabilize the result.

In embodiments, methods and systems described herein that involve an expert system or self-organization capability may use an associative neural network (ASNN), such as involving an extension of committee of machines that combines multiple feed forward neural networks and a k-nearest neighbor technique. It may use the correlation between ensemble responses as a measure of distance amid the analyzed cases for the kNN. This corrects the bias of the neural network ensemble. An associative neural network may have a memory that can coincide with a training set. If new data become available, the network instantly improves its predictive ability and provides data approximation (self-learns) without retraining. Another important feature of ASNN is the possibility to interpret neural network results by analysis of correlations between data cases in the space of models.

In embodiments, methods and systems described herein that involve an expert system or self-organization capability may use an instantaneously trained neural network (ITNN), where the weights of the hidden and the output layers are mapped directly from training vector data.

In embodiments, methods and systems described herein that involve an expert system or self-organization capability may use a spiking neural network, which may explicitly consider the timing of inputs. The network input and output may be represented as a series of spikes (such as a delta function or more complex shapes). SNNs can process information in the time domain (e.g., signals that vary over time, such as signals involving dynamic behavior of markets or transactional environments). They are often implemented as recurrent networks.

In embodiments, methods and systems described herein that involve an expert system or self-organization capability may use a dynamic neural network that addresses nonlinear multivariate behavior and includes learning of time-dependent behavior, such as transient phenomena and delay effects. Transients may include behavior of shifting market variables, such as prices, available quantities, available counterparties, and the like.

In embodiments, cascade correlation may be used as an architecture and supervised learning algorithm, supplementing adjustment of the weights in a network of fixed topology. Cascade-correlation may begin with a minimal network, then automatically trains and add new hidden units one by one, creating a multi-layer structure. Once a new hidden unit has been added to the network, its input-side weights may be frozen. This unit then becomes a permanent feature-detector in the network, available for producing outputs or for creating other, more complex feature detectors. The cascade-correlation architecture may learn quickly, determine its own size and topology, and retain the structures it has built even if the training set changes and requires no back-propagation.

In embodiments, methods and systems described herein that involve an expert system or self-organization capability may use a neuro-fuzzy network, such as involving a fuzzy inference system in the body of an artificial neural network. Depending on the type, several layers may simulate the processes involved in a fuzzy inference, such as fuzzification, inference, aggregation and defuzzification. Embedding a fuzzy system in a general structure of a neural net as the benefit of using available training methods to find the parameters of a fuzzy system.

In embodiments, methods and systems described herein that involve an expert system or self-organization capability may use a compositional pattern-producing network (CPPN), such as a variation of an associative neural network (ANN) that differs the set of activation functions and how they are applied. While typical ANNs often contain only sigmoid functions (and

sometimes Gaussian functions), CPPNs can include both types of functions and many others. Furthermore, CPPNs may be applied across the entire space of possible inputs, so that they can represent a complete image. Since they are compositions of functions, CPPNs in effect encode images at infinite resolution and can be sampled for a particular display at whatever resolution is optimal.

This type of network can add new patterns without re-training. In embodiments, methods and systems described herein that involve an expert system or self-organization capability may use a one-shot associative memory network, such as by creating a specific memory structure, which assigns each new pattern to an orthogonal plane using adjacently connected hierarchical arrays.

In embodiments, methods and systems described herein that involve an expert system or self-organization capability may use a hierarchical temporal memory (HTM) neural network, such as involving the structural and algorithmic properties of the neocortex. HTM may use a biomimetic model based on memory-prediction theory. HTM may be used to discover and infer the high-level causes of observed input patterns and sequences.

In embodiments, methods and systems described herein that involve an expert system or self-organization capability may use a holographic associative memory (HAM) neural network, which may comprise an analog, correlation-based, associative, stimulus-response system. Information may be mapped onto the phase orientation of complex numbers. The memory is effective for associative memory tasks, generalization and pattern recognition with changeable attention.

In embodiments, various embodiments involving network coding may be used to code transmission data among network nodes in neural net, such as where nodes are located in one or more data collectors or machines in a transactional environment.

Referring to FIG. 9 through FIG. 37, embodiments of the present disclosure, including ones involving expert systems, self-organization, machine learning, artificial intelligence, and the like, may benefit from the use of a neural net, such as a neural net trained for pattern recognition, for classification of one or more parameters, characteristics, or phenomena, for support of autonomous control, and other purposes. References to a neural net throughout this disclosure should be understood to encompass a wide range of different types of neural networks, machine learning systems, artificial intelligence systems, and the like, such as dual-process artificial neural networks (DPANN), feed forward neural networks, radial basis function neural networks, self-organizing neural networks (e.g., Kohonen self-organizing neural networks), recurrent neural networks, modular neural networks, artificial neural networks, physical neural networks, multi-layered neural networks, convolutional neural networks, hybrids of neural networks with other expert systems (e.g., hybrid fuzzy logic—neural network systems), Autoencoder neural networks, probabilistic neural networks, time delay neural networks, convolutional neural networks, regulatory feedback neural networks, radial basis function neural networks, recurrent neural networks, Hopfield neural networks, Boltzmann machine neural networks, self-organizing map (SOM) neural networks, learning vector quantization (L VQ) neural networks, fully recurrent neural networks, simple recurrent neural networks, echo state neural networks, long short-term memory neural networks, bi-directional neural networks, hierarchical neural networks, stochastic neural networks, genetic scale RNN neural networks, committee of machines neural networks, associative neural networks, physical neural networks, instantaneously trained neural networks, spiking neural networks, neocognitron neural networks, dynamic neural networks, cascading neural networks, neuro-fuzzy neural networks, compositional pattern-producing neural networks, memory neural networks, hierarchical temporal memory neural networks, deep feed forward neural networks, gated recurrent unit (GCU) neural networks, auto encoder neural networks, variational auto encoder neural networks, de-noising auto encoder neural networks, sparse auto-encoder neural networks, Markov chain neural networks, restricted Boltzmann machine neural networks, deep belief neural networks, deep convolutional neural networks, de-convolutional neural networks, deep convolutional inverse graphics neural networks, generative adversarial neural networks, liquid state machine neural networks, extreme learning machine neural networks, echo state neural networks, deep residual neural networks, support vector machine neural networks, neural Turing machine neural networks, and/or holographic associative memory neural networks, or hybrids or combinations of the foregoing, or combinations with other expert systems, such as rule-based systems, model-based systems (including ones based on physical models, statistical models, flow-based models, biological models, biomimetic models, and the like).

In embodiments, the platform 102 includes a dual process artificial neural network (DPANN) system. The DPANN system includes an artificial neural network (ANN) having behaviors and operational processes (such as decision-making) that are products of a training system and a retraining system. The training system is configured to perform automatic, trained execution of ANN operations. The retraining system performs effortful, analytical, intentional retraining of the ANN, such as based on one or more relevant aspects of the ANN, such as memory, one or more input data sets (including time information with respect to elements in such data sets), one or more goals or objectives (including ones that may vary dynamically, such as periodically and/or based on contextual changes, such as ones relating to the usage context of the ANN), and/or others. In cases involving memory-based retraining, the memory may include original/historical training data and refined training data. The DPANN system includes a dual process learning function or DPLF 902 configured to manage and perform an ongoing data retention process. The DPLF 902 (including, where applicable, memory management process) facilitate retraining and refining of behavior of the ANN. The DPLF 902 provides a framework by which the ANN creates outputs such as predictions, classifications, recommendations, conclusions and/or other outputs based on a historic inputs, new inputs, and new outputs (including outputs configured for specific use cases, including ones determined by parameters of the context of utilization (which may include performance parameters such as latency parameters, accuracy parameters, consistency parameters, bandwidth utilization parameters, processing capacity utilization parameters, prioritization parameters, energy utilization parameters, and many others).

In embodiments, the DPANN system stores training data, thereby allowing for constant retraining based on results of decisions, predictions, and/or other operations of the ANN, as well as allowing for analysis of training data upon the outputs of the ANN. The management of entities stored in the memory allows the construction and execution of new models, such as ones that may be processed, executed or otherwise performed by or under management of the training system. The DPANN system uses instances of the memory to validate actions (e.g., in a manner similar to the thinking of a biological neural network (including retrospective or self-reflective thinking about whether actions that were undertaken under a given situation where optimal) and perform training of the ANN, including training that intentionally feeds the ANN with appropriate sets of memories (i.e., ones that produce favorable outcomes given the performance requirements for the ANN).

In embodiments, FIG. 9 illustrates an exemplary process of the DPLF 902. The DPLF 902 may be or include the continued process retention of one or more training datasets and/or memories stored in the memory over time. The DPLF 902 thereby allows the ANN to apply existing neural functions and draw upon sets of past events (including ones that are intentionally varied and/or curated for distinct purposes), such as to frame understanding of and behavior within present, recent, and/or new scenarios, including in simulations, during training processes, and in fully operational deployments of the ANN. The DPLF 902 may provide the ANN with a framework by which the ANN may analyze, evaluate, and/or manage data, such as data related to the past, present and future. As such, the DPLF 902 plays a crucial role in training and retraining the ANN via the training system and the retraining system.

In embodiments, the DPLF 902 is configured to perform a dual-process operation to manage existing training processes and is also configured to manage and/or perform new training processes, i.e., retraining processes. In embodiments, each instance of the ANN is trained via the training system and configured to be retrained via the retraining system. The ANN encodes training and/or retraining datasets, stores the datasets, and retrieves the datasets during both training via the training system and retraining via the retraining system. The DPANN system may recognize whether a dataset (the term dataset in this context optionally including various subsets, supersets, combinations, permutations, elements, metadata, augmentations, or the like, relative to a base dataset used for training or retraining), storage activity, processing operation and/or output, has characteristics that natively favor the training system versus the retraining system based on its respective inputs, processing (e.g., based on its structure, type, models, operations, execution environment, resource utilization, or the like) and/or outcomes (including outcome types, performance requirements (including contextual or dynamic requirements), and the like. For example, the DPANN system may determine that poor performance of the training system on a classification task may indicate a novel problem for which the training of the ANN was not adequate (e.g., in type of data set, nature of input models and/or feedback, quantity of training data, quality of tagging or labeling, quality of supervision, or the like), for which the processing operations of the ANN are not well-suited (e.g., where they are prone to known vulnerabilities due to the type of neural network used, the type of models used, etc.), and that may be solved by engaging the retraining system to retrain the model to teach the model to learn to solve the new classification problem (e.g., by feeding it many more labeled instances of correctly classified items). With periodic or continuous evaluation of the performance of the ANN, the DPANN system may subsequently determine that highly stable performance of the ANN (such as where only small improvements of the ANN occur over many iterations of retraining by the retraining system) indicates readiness for the training system to replace the retraining system (or be weighted more favorably where both are involved). Over longer periods of time, cycles of varying performance may emerge, such as where a series of novel problems emerge, such that the retraining system of the DPANN is serially engaged, as needed, to retrain the ANN and/or to augment the ANN by providing a second source of outputs (which may be fused or combined with ANN outputs to provide a single result (with various weightings across them), or may be provided in parallel, such as enabling comparison, selection, averaging, or context- or situation-specific application of the respective outputs).

In embodiments, the ANN is configured to learn new functions in conjunction with the collection of data according to the dual-process training of the ANN via the training system and the retraining system. The DPANN system performs analysis of the ANN via the training system and performs initial training of the ANN such that the ANN gains new internal functions (or internal functions are subtracted or modified, such as where existing functions are not contributing to favorable outcomes). After the initial training, the DPANN system performs retraining of the ANN via the retraining system. To perform the retraining, the retraining system evaluates the memory and historic processing of the ANN to construct targeted DPLF 902 processes for retraining. The DPLF 902 processes may be specific to identified scenarios. The ANN processes can run in parallel with the DPLF 902 processes. By way of example, the ANN may function to operate a particular make and model of a self-driving car after the initial training by the training system. The DPANN system may perform retraining of the functions of the ANN via the retraining system, such as to allow the ANN to operate a different make and model of car (such as one with different cameras, accelerometers and other sensors, different physical characteristics, different performance requirements, and the like), or even a different kind of vehicle, such as a bicycle or a spaceship.

In embodiments, as quality of outputs and/or operations of the ANN improves, and as long as the performance requirements and the context of utilization for the ANN remain fairly stable, performing the dual-process training process can become a decreasingly demanding process. As such, the DPANN system may determine that fewer neurons of the ANN are required to perform operations and/or processes of the ANN, that performance monitoring can be less intensive (such as with longer intervals between performance checks), and/or that the retraining is no longer necessary (at least for a period of time, such as until a long-term maintenance period arrives and/or until there are significant shifts in context of utilization). As the ANN continues to improve upon existing functions and/or add new functions via the dual-process training process, the ANN may perform other, at times more “intellectually-demanding” (e.g., retraining intensive) tasks simultaneously. For example, utilizing dual process-learned knowledge of a function or process being trained, the ANN can solve an unrelated complex problem or make a retraining decision simultaneously. The retraining may include supervision, such as where an agent (e.g., human supervisor or intelligent agent) directs the ANN to a retraining objective (e.g., “master this new function”) and provides a set of training tasks and feedback functions (such as supervisory grading) for the retraining. In-embodiments, the ANN can be used to organize the supervision, training and retraining of other dual process-trained ANNs, to seed such training or retraining, or the like.

In embodiments, one or more behaviors and operational processes (such as decision-making) of the ANN may be products of training and retraining processes facilitated by the training system and the retraining system, respectively. The training system may be configured to perform automatic training of ANN, such as by continuously adding additional instances of training data as it is collected by or from various data sources. The retraining system may be configured to perform effortful, analytical, intentional retraining of the ANN, such as based on memory (e.g., stored training data or refined training data) and/or optionally based on reasoning or other factors. For example, in a deployment management context, the training system may be associated with a standard response by the ANN, while the retraining system may implement DPLF 902 retraining and/or network adaptation of the ANN. In some cases, retraining of the ANN beyond the factory, or “out-of-the-box,” training level may involve more than retraining by the retraining system. Successful adjustment of the ANN by one or more network adaptations may be dependent on the operation of one or more network adjustments of the training system.

In embodiments, the training system may facilitate fast operating by and training of the ANN by applying existing neural functions of the ANN based on training of the ANN with previous datasets. Standard operational activities of the ANN that may draw heavily on the training system may include one or more of the methods, processes, workflows, systems, or the like described throughout this disclosure and the documents incorporated herein, such as, without limitation: defined functions within networking (such as discovering available networks and connections, establishing connections in networks, provisioning network bandwidth among devices and systems, routing data within networks, steering traffic to available network paths, load balancing across networking resources, and many others); recognition and classification (such as of images, text, symbols, objects, video content, music and other audio content, speech content, and many others); spoken words; prediction of states and events (such as prediction of failure modes of machines or systems, prediction of events within workflows, predictions of behavior in shopping and other activities, and many others); control (such as controlling autonomous or semi-autonomous systems, automated agents (such as automated call-center operations, chat bots, and the like) and others); and/or optimization and recommendation (such as for products, content, decisions, and many others). ANNs may also be suitable for training datasets for scenarios that only require output. The standard operational activities may not require the ANN to actively analyze what is being asked of the ANN beyond operating on well-defined data inputs, to calculate well-defined outputs for well-defined use cases. The operations of the training system and/or the retraining system may be based on one or more historic data training datasets and may use the parameters of the historic data training datasets to calculate results based on new input values and may be performed with small or no alterations to the ANN or its input types. In embodiments, an instance of the training system can be trained to classify whether the ANN is capable of performing well in a given situation, such as by recognizing whether an image or sound being classified by the ANN is of a type that has historically been classified with a high accuracy (e.g., above a threshold).

In embodiments, network adaptation of the ANN by one or both of the training system and the retraining system may include a number of defined network functions, knowledge, and intuition-like behavior of the ANN when subjected to new input values. In such embodiments, the retraining system may apply the new input values to the DPLF 902 system to adjust the functional response of the ANN, thereby performing retraining of the ANN. The DPANN system may determine that retraining the ANN via network adjustment is necessary when, for example, without limitation, functional neural networks are assigned activities and assignments that require the ANN to provide a solution to a novel problem, engage in network adaptation or other higher-order cognitive activity, apply a concept outside of the domain in which the DPANN was originally designed, support a different context of deployment (such as where the use case, performance requirements, available resources, or other factors have changed), or the like. The ANN can be trained to recognize where the retraining system is needed, such as by training the ANN to recognize poor performance of the training system, high variability of input data sets relative to the historical data sets used to train the training system, novel functional or performance requirements, dynamic changes in the use case or context, or other factors. The ANN may apply reasoning to assess performance and provide feedback to the retraining system. The ANN may be trained and/or retrained to perform intuitive functions, optionally including by a combinatorial or re-combinatorial process (e.g., including genetic programming wherein inputs (e.g., data sources), processes/functions (e.g., neural network types and structures), feedback, and outputs, or elements thereof, are arranged in various permutations and combinations and the ANN is tested in association with each (whether in simulations or live deployments), such as in a series of rounds, or evolutionary steps, to promote favorable variants until a preferred ANN, or preferred set of ANNs is identified for a given scenario, use case, or set of requirements). This may include generating a set of input “ideas” (e.g., combinations of different conclusions about cause-and-effect in a diagnostic process) for processing by the retraining system and subsequent training and/or by an explicit reasoning process, such as a Bayesian reasoning process, a casuistic or conditional reasoning process, a deductive reasoning process, an inductive reasoning process, or others (including combinations of the above) as described in this disclosure or the documents incorporated herein by reference.

In embodiments, the DPLF 902 may perform an encoding process of the DPLF 902 to process datasets into a stored form for future use, such as retraining of the ANN by the retraining system. The encoding process enables datasets to be taken in, understood, and altered by the DPLF 902 to better support storage in and usage from the memory. The DPLF 902 may apply current functional knowledge and/or reasoning to consolidate new input values. The memory can include short-term memory or STM 906, long-term memory or LTM 912, or a combination thereof. The datasets may be stored in one or both of the STM 906 and the LTM 912. The STM 906 may be implemented by the application of specialized behaviors inside the ANN (such as recurrent neural network, which may be gated or un-gated, or long-term short-term neural networks). The LTM 912 may be implemented by storing scenarios, associated data, and/or unprocessed data that can be applied to the discovery of new scenarios. The encoding process may include processing and/or storing, for example, visual encoding data (e.g., processed through a Convolution Neural Network), acoustic sensor encoding data (e.g., how something sounds, speech encoding data (e.g., processed through a deep neural network (DNN), optionally including for phoneme recognition), semantic encoding data of words, such to determine semantic meaning, e.g., by using a Hidden Markov Model (HMM); and/or movement and/or tactile encoding data (such as operation on vibration/accelerometer sensor data, touch sensor data, positional or geolocation data, and the like). While datasets may enter the DPLF 902 system through one of these modes, the form in which the datasets are stored may differ from an original form of the datasets and may pass-through neural processing engines to be encoded into compressed and/or context-relevant format. For example, an unsupervised instance of the ANN can be used to learn the historic data into a compressed format.

In embodiments, the encoded datasets are retained within the DPLF 902 system. Encoded datasets are first stored in short-term DPLF 902, i.e., STM 906. For example, sensor datasets may be primarily stored in STM 906, and may be kept in STM 906 through constant repetition. The datasets stored in the STM 906 are active and function as a kind of immediate response to new input values. The DPANN system may remove datasets from STM 906 in response to changes in data streams due to, for example, running out of space in STM 906 as new data is imported, processed and/or stored. For example, it is viable for short-term DPLF 902 to only last between 15 and 30 seconds. STM 906 may only store small amounts of data typically embedded inside the ANN.

In embodiments, the DPANN system may measure attention based on utilization of the training system, of the DPANN system as a whole, and/or the like, such as by consuming various indicators of attention to and/or utilization of outputs from the ANN and transmitting such indicators to the ANN in response (similar to a “moment of recognition” in the brain where attention passes over something and the cognitive system says “aha!”). In embodiments, attention can be measured by the sheer amount of the activity of one or both of the systems on the data stream. In embodiments, a system using output from the ANN can explicitly indicate attention, such as by an operator directing the ANN to pay attention to a particular activity (e.g., to respond to a diagnosed problem, among many other possibilities). The DPANN system may manage data inputs to facilitate measures of attention, such as by prompting and/or calculating greater attention to data that has high inherent variability from historical patterns (e.g., in rates of change, departure from norm, etc.), data indicative of high variability in historical performance (such as data having similar characteristics to data sets involved in situations where the ANN performed poorly in training), or the like.

In embodiments, the DPANN system may retain encoded datasets within the DPLF 902 system according to and/or as part of one or more storage processes. The DPLF 902 system may store the encoded datasets in LTM 912 as necessary after the encoded datasets have been stored in STM 906 and determined to be no longer necessary and/or low priority for a current operation of the ANN, training process, retraining process, etc. The LTM 912 may be implemented by storing scenarios, and the DPANN system may apply associated data and/or unprocessed data to the discovery of new scenarios. For example, data from certain processed data streams, such as semantically encoded datasets, may be primarily stored in LTM 912. The LTM 912 may also store image (and sensor) datasets in encoded form, among many other examples.

In embodiments, the LTM 912 may have relatively high storage capacity, and datasets stored within LTM 912 may, in some scenarios, be effectively stored indefinitely. The DPANN system may be configured to remove datasets from the LTM 912, such as by passing LTM 912 data through a series of memory structures that have increasingly long retrieval periods or increasingly high threshold requirements to trigger utilization (similar to where a biological brain “thinks very hard” to find precedent to deal with a challenging problem), thereby providing increased salience of more recent or more frequently used memories while retaining the ability to retrieve (with more time/effort) older memories when the situation justifies more comprehensive memory utilization. As such, the DPANN system may arrange datasets stored in the LTM 912 on a timeline, such as by storing the older memories (measured by time of origination and/or latest time of utilization) on a separate and/or slower system, by penalizing older memories by imposing artificial delays in retrieval thereof, and/or by imposing threshold requirements before utilization (such as indicators of high demand for improved results). Additionally or alternatively, LTM 912 may be clustered according to other categorization protocols, such as by topic. For example, all memories proximal in time to a periodically recognized person may be clustered for retrieval together, and/or all memories that were related to a scenario may be clustered for retrieval together.

In embodiments, the DPANN system may modularize and link LTM 912 datasets, such as in a catalog, a hierarchy, a cluster, a knowledge graph (directed/acyclic or having conditional logic), or the like, such as to facilitate search for relevant memories. For example, all memory modules that have instances involving a person, a topic, an item, a process, a linkage of n-tuples of such things (e.g., all memory modules that involve a selected pair of entities), etc. The DPANN system may select sub-graphs of the knowledge graph for the DPLF 902 to implement in one or more domain-specific and/or task-specific uses, such as training a model to predict robotic or human agent behavior by using memories that relate to a particular set of robotic or human agents, and/or similar robotic or human agents. The DPLF 902 system may cache frequently used modules for different speed and/or probability of utilization. High value modules (e.g., ones with high-quality outcomes, performance characteristics, or the like) can be used for other functions, such as selection/training of STM 906 keep/forget processes.

In embodiments, the DPANN system may modularize and link LTM datasets, such as in various ways noted above, to facilitate search for relevant memories. For example, memory modules that have instances involving a person, a topic, an item, a process, a linkage of n-tuples of such things (such as all memory modules that involve a selected pair of entities), or all memories associated with a scenario, etc., may be linked and searched. The DPANN system may select subsets of the scenario (e.g., sub-graphs of a knowledge graph) for the DPLF 902 for a domain-specific and/or task-specific use, such as training a model to predict robotic or human agent behavior by using memories that relate to a particular set of robotic or human agents and/or similar robotic or human agents. Frequently used modules or scenarios can be cached for different speed/probability of utilization, or other performance characteristics. High value modules or scenarios (ones where high-quality outcomes results) can be used for other functions, such as selection/training of STM 906 keep/forget processes, among others.

In embodiments, the DPANN system may perform LTM planning, such as to find a procedural course of action for a declaratively described system to reach its goals while optimizing overall performance measures. The DPANN system may perform LTM planning when, for example, a problem can be described in a declarative way, the DPANN system has domain knowledge that should not be ignored, there is a structure to a problem that makes the problem difficult for pure learning techniques, and/or the ANN needs to be trained and/or retrained to be able to explain a particular course of action taken by the DPANN system. In embodiments, the DPANN system may be applied to a plan recognition problem, i.e., the inverse of a planning problem: instead of a goal state, one is given a set of possible goals, and the objective in plan recognition is to find out which goal was being achieved and how.

In embodiments, the DPANN system may facilitate LTM scenario planning by users to develop long-term plans. For example, LTM scenario planning for risk management use cases may place added emphasis on identifying extreme or unusual, yet possible, risks and opportunities that are not usually considered in daily operations, such as ones that are outside a bell curve or normal distribution, but that in fact occur with greater-than-anticipated frequency in “long tail” or “fat tail” situations, such as involving information or market pricing processes, among many others. LTM scenario planning may involve analyzing relationships between forces (such as social, technical, economic, environmental, and/or political trends) in order to explain the current situation, and/or may include providing scenarios for potential future states.

In embodiments, the DPANN system may facilitate LTM scenario planning for predicting and anticipating possible alternative futures along with the ability to respond to the predicted states. The LTM planning may be induced from expert domain knowledge or projected from current scenarios, because many scenarios (such as ones involving results of combinatorial processes that result in new entities or behaviors) have never yet occurred and thus cannot be projected by probabilistic means that rely entirely on historical distributions. The DPANN system may prepare the application to LTM 912 to generate many different scenarios, exploring a variety of possible futures to the DPLM for both expected and surprising futures. This may be facilitated or augmented by genetic programming and reasoning techniques as noted above, among others.

In embodiments, the DPANN system may implement LTM scenario planning to facilitate transforming risk management into a plan recognition problem and apply the DPLF 902 to generate potential solutions. LTM scenario induction addresses several challenges inherent to forecast planning. LTM scenario induction may be applicable when, for example, models that are used for forecasting have inconsistent, missing, unreliable observations; when it is possible to generate not just one but many future plans; and/or when LTM domain knowledge can be captured and encoded to improve forecasting (e.g., where domain experts tend to outperform available computational models). LTM scenarios can be focused on applying LTM scenario planning for risk management. LTM scenarios planning may provide situational awareness of relevant risk drivers by detecting emerging storylines. In addition, LTM scenario planning can generate future scenarios that allow DPLM, or operators, to reason about, and plan for, contingencies and opportunities in the future.

In embodiments, the DPANN system may be configured to perform a retrieval process via the DPLF 902 to access stored datasets of the ANN. The retrieval process may determine how well the ANN performs with regard to assignments designed to test recall. For example, the ANN may be trained to perform a controlled vehicle parking operation, whereby the autonomous vehicle returns to a designated spot, or the exit, by associating a prior visit via retrieval of data stored in the LTM 912. The datasets stored in the STM 906 and the LTM may be retrieved by differing processes. The datasets stored in the STM 906 may be retrieved in response to specific input and/or by order in which the datasets are stored, e.g., by a sequential list of numbers. The datasets stored in the LTM 912 may be retrieved through association and/or matching of events to historic activities, e.g., through complex associations and indexing of large datasets.

In embodiments, the DPANN system may implement scenario monitoring as at least a part of the retrieval process. A scenario may provide context for contextual decision-making processes. In embodiments, scenarios may involve explicit reasoning (such as cause-and-effect reasoning, Bayesian, casuistic, conditional logic, or the like, or combinations thereof) the output of which declares what LTM-stored data is retrieved (e.g., a timeline of events being evaluated and other timelines involving events that potentially follow a similar cause-and-effect pattern). For example, diagnosis of a failure of a machine or workflow may retrieve historical sensor data as well as LTM data on various failure modes of that type of machine or workflow (and/or a similar process involving a diagnosis of a problem state or condition, recognition of an event or behavior, a failure mode (e.g., a financial failure, contract breach, or the like), or many others).

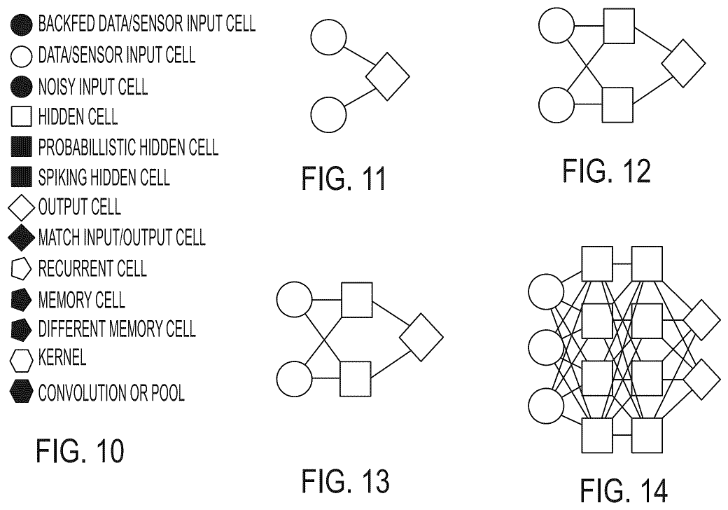

In embodiments, FIG. 10 through FIG. 37 depict exemplary neural networks and FIG. 10 depicts a legend showing the various components of the neural networks depicted throughout FIG. 10 to FIG. 37. FIG. 10 depicts various neural net components depicted in cells that are assigned functions and requirements. In embodiments, the various neural net examples may include (from top to bottom in the example of FIG. 10): back fed data/sensor input cells, data/sensor input cells, noisy input cells, and hidden cells. The neural net components also include probabilistic hidden cells, spiking hidden cells, output cells, match input/output cells, recurrent cells, memory cells, different memory cells, kernels, and convolution or pool cells.

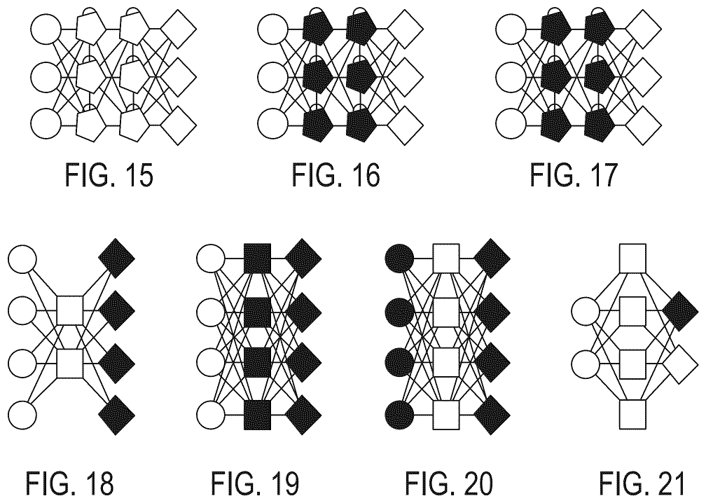

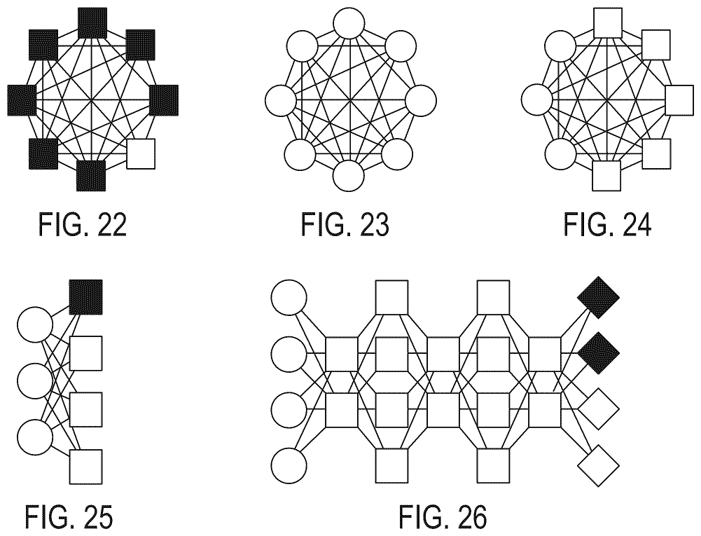

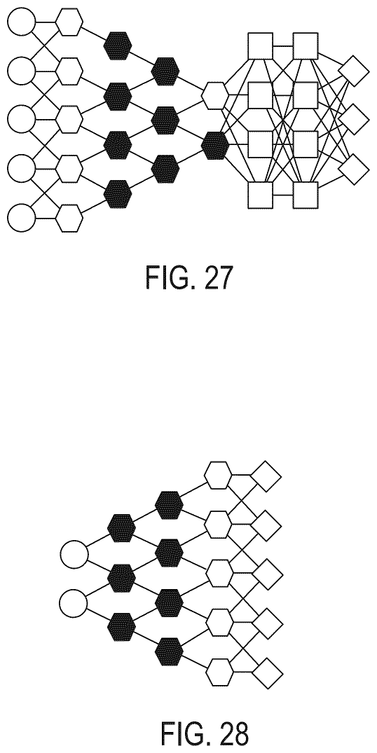

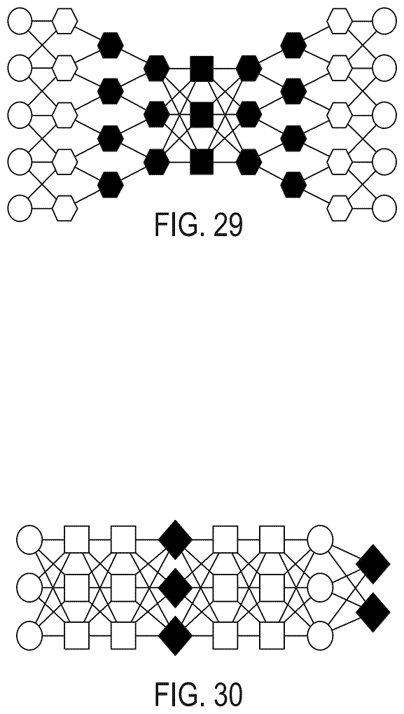

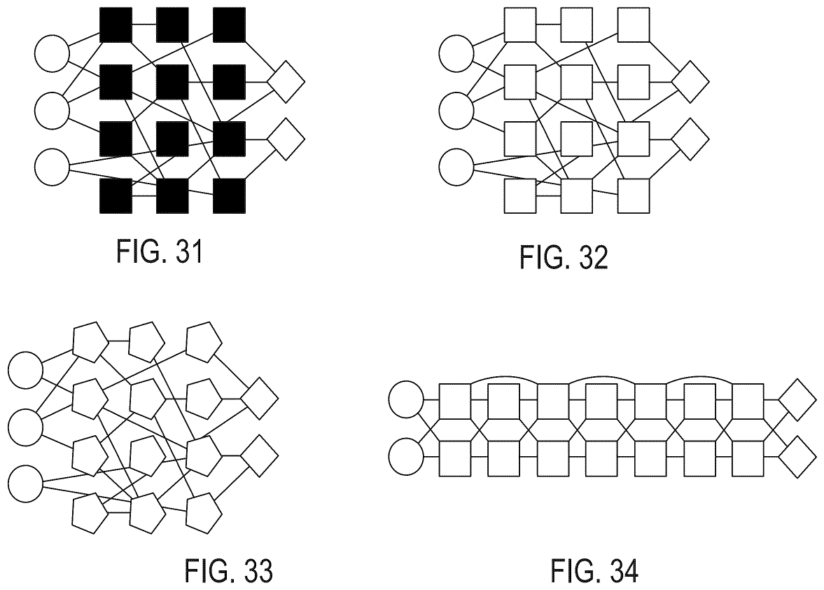

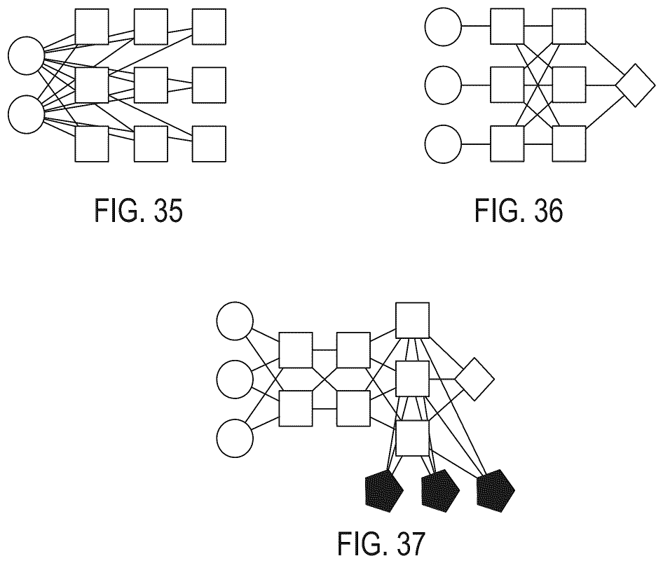

In embodiments, FIG. 11 depicts an exemplary perceptron neural network that may connect to, integrate with, or interface with the platform 102. The platform 102 may also be associated with further neural net systems such as a feed forward neural network (FIG. 12), a radial basis neural network (FIG. 13), a deep feed forward neural network (FIG. 14), a recurrent neural network (FIG. 15), a long/short term neural network (FIG. 16), and a gated recurrent neural network (FIG. 17). The platform 102 may also be associated with further neural net systems such as an auto encoder neural network (FIG. 18), a variational neural network (FIG. 19), a denoising neural network (FIG. 20), a sparse neural network (FIG. 21), a Markov chain neural network (FIG. 22), and a Hopfield network neural network (FIG. 23). The platform 102 may further be associated with additional neural net systems such as a Boltzmann machine neural network (FIG. 24), a restricted BM neural network (FIG. 25), a deep belief neural network (FIG. 26), a deep convolutional neural network (FIG. 27), a deconvolutional neural network (FIG. 28), and a deep convolutional inverse graphics neural network (FIG. 29). The platform 102 may also be associated with further neural net systems such as a generative adversarial neural network (FIG. 30), a liquid state machine neural network (FIG. 31), an extreme learning machine neural network (FIG. 32), an echo state neural network (FIG. 33), a deep residual neural network (FIG. 34), a Kohonen neural network (FIG. 35), a support vector machine neural network (FIG. 36), and a neural Turing machine neural network (FIG. 37).

The foregoing neural networks may have a variety of nodes or neurons, which may perform a variety of functions on inputs, such as inputs received from sensors or other data sources, including other nodes. Functions may involve weights, features, feature vectors, and the like. Neurons may include perceptrons, neurons that mimic biological functions (such as of the human senses of touch, vision, taste, hearing, and smell), and the like. Continuous neurons, such as with sigmoidal activation, may be used in the context of various forms of neural net, such as where back propagation is involved.

In many embodiments, an expert system or neural network may be trained, such as by a human operator or supervisor, or based on a data set, model, or the like. Training may include presenting the neural network with one or more training data sets that represent values, such as sensor data, event data, parameter data, and other types of data (including the many types described throughout this disclosure), as well as one or more indicators of an outcome, such as an outcome of a process, an outcome of a calculation, an outcome of an event, an outcome of an activity, or the like. Training may include training in optimization, such as training a neural network to optimize one or more systems based on one or more optimization approaches, such as Bayesian approaches, parametric Bayes classifier approaches, k-nearest-neighbor classifier approaches, iterative approaches, interpolation approaches, Pareto optimization approaches, algorithmic approaches, and the like. Feedback may be provided in a process of variation and selection, such as with a genetic algorithm that evolves one or more solutions based on feedback through a series of rounds.

In embodiments, a plurality of neural networks may be deployed in a cloud platform that receives data streams and other inputs collected (such as by mobile data collectors) in one or more energy edge environments and transmitted to the cloud platform over one or more networks, including using network coding to provide efficient transmission. In the cloud platform, optionally using massively parallel computational capability, a plurality of different neural networks of various types (including modular forms, structure-adaptive forms, hybrids, and the like) may be used to undertake prediction, classification, control functions, and provide other outputs as described in connection with expert systems disclosed throughout this disclosure. The different neural networks may be structured to compete with each other (optionally including use evolutionary algorithms, genetic algorithms, or the like), such that an appropriate type of neural network, with appropriate input sets, weights, node types and functions, and the like, may be selected, such as by an expert system, for a specific task involved in a given context, workflow, environment process, system, or the like.

In embodiments, methods and systems described herein that involve an expert system or self-organization capability may use a feed forward neural network, which moves information in one direction, such as from a data input, like a data source related to at least one resource or parameter related to a transactional environment, such as any of the data sources mentioned throughout this disclosure, through a series of neurons or nodes, to an output. Data may move from the input nodes to the output nodes, optionally passing through one or more hidden nodes, without loops. In embodiments, feed forward neural networks may be constructed with various types of units, such as binary McCulloch-Pitts neurons, the simplest of which is a perceptron.

In embodiments, methods and systems described herein that involve an expert system or self-organization capability may use a capsule neural network, such as for prediction, classification, or control functions with respect to a transactional environment, such as relating to one or more of the machines and automated systems described throughout this disclosure.

In embodiments, methods and systems described herein that involve an expert system or self-organization capability may use a radial basis function (RBF) neural network, which may be preferred in some situations involving interpolation in a multi-dimensional space (such as where interpolation is helpful in optimizing a multi-dimensional function, such as for optimizing a data marketplace as described here, optimizing the efficiency or output of a power generation system, a factory system, or the like, or other situation involving multiple dimensions. In embodiments, each neuron in the RBF neural network stores an example from a training set as a “prototype.” Linearity involved in the functioning of this neural network offers RBF the advantage of not typically suffering from problems with local minima or maxima.

In embodiments, methods and systems described herein that involve an expert system or self-organization capability may use a radial basis function (RBF) neural network, such as one that employs a distance criterion with respect to a center (e.g., a Gaussian function). A radial basis function may be applied as a replacement for a hidden layer, such as a sigmoidal hidden layer transfer, in a multi-layer perceptron. An RBF network may have two layers, such as where an input is mapped onto each RBF in a hidden layer. In embodiments, an output layer may comprise a linear combination of hidden layer values representing, for example, a mean predicted output. The output layer value may provide an output that is the same as or similar to that of a regression model in statistics. In classification problems, the output layer may be a sigmoid function of a linear combination of hidden layer values, representing a posterior probability. Performance in both cases is often improved by shrinkage techniques, such as ridge regression in classical statistics. This corresponds to a prior belief in small parameter values (and therefore smooth output functions) in a Bayesian framework. RBF networks may avoid local minima, because the only parameters that are adjusted in the learning process are the linear mapping from hidden layer to output layer. Linearity ensures that the error surface is quadratic and therefore has a single minimum. In regression problems, this may be found in one matrix operation. In classification problems, the fixed non-linearity introduced by the sigmoid output function may be handled using an iteratively re-weighted least-squares function or the like. RBF networks may use kernel methods such as support vector machines (SVM) and Gaussian processes (where the RBF is the kernel function). A non-linear kernel function may be used to project the input data into a space where the learning problem may be solved using a linear model.

In embodiments, an RBF neural network may include an input layer, a hidden layer, and a summation layer. In the input layer, one neuron appears in the input layer for each predictor variable. In the case of categorical variables, N-1 neurons are used, where N is the number of categories. The input neurons may, in embodiments, standardize the value ranges by subtracting the median and dividing by the interquartile range. The input neurons may then feed the values to each of the neurons in the hidden layer. In the hidden layer, a variable number of neurons may be used (determined by the training process). Each neuron may consist of a radial basis function that is centered on a point with as many dimensions as a number of predictor variables. The spread (e.g., radius) of the RBF function may be different for each dimension. The centers and spreads may be determined by training. When presented with the vector of input values from the input layer, a hidden neuron may compute a Euclidean distance of the test case from the neuron's center point and then apply the RBF kernel function to this distance, such as using the spread values. The resulting value may then be passed to the summation layer. In the summation layer, the value coming out of a neuron in the hidden layer may be multiplied by a weight associated with the neuron and may add to the weighted values of other neurons. This sum becomes the output. For classification problems, one output is produced (with a separate set of weights and summation units) for each target category. The value output for a category is the probability that the case being evaluated has that category. In training of an RBF, various parameters may be determined, such as the number of neurons in a hidden layer, the coordinates of the center of each hidden-layer function, the spread of each function in each dimension, and the weights applied to outputs as they pass to the summation layer. Training may be used by clustering algorithms (such as k-means clustering), by evolutionary approaches, and the like.

In embodiments, a recurrent neural network may have a time-varying, real-valued (more than just zero or one) activation (output). Each connection may have a modifiable real-valued weight. Some of the nodes are called labeled nodes, some output nodes, and others hidden nodes. For supervised learning in discrete time settings, training sequences of real-valued input vectors may become sequences of activations of the input nodes, one input vector at a time. At each time step, each non-input unit may compute its current activation as a nonlinear function of the weighted sum of the activations of all units from which it receives connections. The system may explicitly activate (independent of incoming signals) some output units at certain time steps.

In embodiments, methods and systems described herein that involve an expert system or self-organization capability may use a self-organizing neural network, such as a Kohonen self-organizing neural network, such as for visualization of views of data, such as low-dimensional views of high-dimensional data. The self-organizing neural network may apply competitive learning to a set of input data, such as from one or more sensors or other data inputs from or associated with a transactional environment, including any machine or component that relates to the transactional environment. In embodiments, the self-organizing neural network may be used to identify structures in data, such as unlabeled data, such as in data sensed from a range of data sources about or sensors in or about in a transactional environment, where sources of the data are unknown (such as where events may be coming from any of a range of unknown sources). The self-organizing neural network may organize structures or patterns in the data, such that they may be recognized, analyzed, and labeled, such as identifying market behavior structures as corresponding to other events and signals.

In embodiments, methods and systems described herein that involve an expert system or self-organization capability may use a recurrent neural network, which may allow for a bidirectional flow of data, such as where connected units (e.g., neurons or nodes) form a directed cycle. Such a network may be used to model or exhibit dynamic temporal behavior, such as involved in dynamic systems, such as a wide variety of the automation systems, machines and devices described throughout this disclosure, such as an automated agent interacting with a marketplace for purposes of collecting data, testing spot market transactions, execution transactions, and the like, where dynamic system behavior involves complex interactions that a user may desire to understand, predict, control and/or optimize. For example, the recurrent neural network may be used to anticipate the state of a market, such as one involving a dynamic process or action, such as a change in state of a resource that is traded in or that enables a marketplace of transactional environment. In embodiments, the recurrent neural network may use internal memory to process a sequence of inputs, such as from other nodes and/or from sensors and other data inputs from or about the transactional environment, of the various types described herein. In embodiments, the recurrent neural network may also be used for pattern recognition, such as for recognizing a machine, component, agent, or other item based on a behavioral signature, a profile, a set of feature vectors (such as in an audio file or image), or the like. In a non-limiting example, a recurrent neural network may recognize a shift in an operational mode of a marketplace or machine by learning to classify the shift from a training data set consisting of a stream of data from one or more data sources of sensors applied to or about one or more resources.

In embodiments, methods and systems described herein that involve an expert system or self-organization capability may use a modular neural network, which may comprise a series of independent neural networks (such as ones of various types described herein) that are moderated by an intermediary. Each of the independent neural networks in the modular neural network may work with separate inputs, accomplishing sub tasks that make up the task the modular network as whole is intended to perform. For example, a modular neural network may comprise a recurrent neural network for pattern recognition, such as to recognize what type of machine or system is being sensed by one or more sensors that are provided as input channels to the modular network and an RBF neural network for optimizing the behavior of the machine or system once understood. The intermediary may accept inputs of each of the individual neural networks, process them, and create output for the modular neural network, such an appropriate control parameter, a prediction of state, or the like.

Combinations among any of the pairs, triplets, or larger combinations, of the various neural network types described herein, are encompassed by the present disclosure. This may include combinations where an expert system uses one neural network for recognizing a pattern (e.g., a pattern indicating a problem or fault condition) and a different neural network for self-organizing an activity or workflow based on the recognized pattern (such as providing an output governing autonomous control of a system in response to the recognized condition or pattern). This may also include combinations where an expert system uses one neural network for classifying an item (e.g., identifying a machine, a component, or an operational mode) and a different neural network for predicting a state of the item (e.g., a fault state, an operational state, an anticipated state, a maintenance state, or the like). Modular neural networks may also include situations where an expert system uses one neural network for determining a state or context (such as a state of a machine, a process, a work flow, a marketplace, a storage system, a network, a data collector, or the like) and a different neural network for self-organizing a process involving the state or context (e.g., a data storage process, a network coding process, a network selection process, a data marketplace process, a power generation process, a manufacturing process, a refining process, a digging process, a boring process, or other process described herein).

In embodiments, methods and systems described herein that involve an expert system or self-organization capability may use a physical neural network where one or more hardware elements is used to perform or simulate neural behavior. In embodiments, one or more hardware neurons may be configured to stream voltage values, current values, or the like that represent sensor data, such as to calculate information from analog sensor inputs representing energy consumption, energy production, or the like, such as by one or more machines providing energy or consuming energy for one or more transactions. One or more hardware nodes may be configured to stream output data resulting from the activity of the neural net. Hardware nodes, which may comprise one or more chips, microprocessors, integrated circuits, programmable logic controllers, application-specific integrated circuits, field-programmable gate arrays, or the like, may be provided to optimize the machine that is producing or consuming energy, or to optimize another parameter of some part of a neural net of any of the types described herein. Hardware nodes may include hardware for acceleration of calculations (such as dedicated processors for performing basic or more sophisticated calculations on input data to provide outputs, dedicated processors for filtering or compressing data, dedicated processors for de-compressing data, dedicated processors for compression of specific file or data types (e.g., for handling image data, video streams, acoustic signals, thermal images, heat maps, or the like), and the like. A physical neural network may be embodied in a data collector, including one that may be reconfigured by switching or routing inputs in varying configurations, such as to provide different neural net configurations within the data collector for handling different types of inputs (with the switching and configuration optionally under control of an expert system, which may include a software-based neural net located on the data collector or remotely). A physical, or at least partially physical, neural network may include physical hardware nodes located in a storage system, such as for storing data within a machine, a data storage system, a distributed ledger, a mobile device, a server, a cloud resource, or in a transactional environment, such as for accelerating input/output functions to one or more storage elements that supply data to or take data from the neural net. A physical, or at least partially physical, neural network may include physical hardware nodes located in a network, such as for transmitting data within, to or from an energy edge environment, such as for accelerating input/output functions to one or more network nodes in the net, accelerating relay functions, or the like. In embodiments of a physical neural network, an electrically adjustable resistance material may be used for emulating the function of a neural synapse. In embodiments, the physical hardware emulates the neurons, and software emulates the neural network between the neurons. In embodiments, neural networks complement conventional algorithmic computers. They are versatile and may be trained to perform appropriate functions without the need for any instructions, such as classification functions, optimization functions, pattern recognition functions, control functions, selection functions, evolution functions, and others.

In embodiments, methods and systems described herein that involve an expert system or self-organization capability may use a multilayered feed forward neural network, such as for complex pattern classification of one or more items, phenomena, modes, states, or the like. In embodiments, a multilayered feed forward neural network may be trained by an optimization technique, such as a genetic algorithm, such as to explore a large and complex space of options to find an optimum, or near-optimum, global solution. For example, one or more genetic algorithms may be used to train a multilayered feed forward neural network to classify complex phenomena, such as to recognize complex operational modes of machines, such as modes involving complex interactions among machines (including interference effects, resonance effects, and the like), modes involving non-linear phenomena, modes involving critical faults, such as where multiple, simultaneous faults occur, making root cause analysis difficult, and others. In embodiments, a multilayered feed forward neural network may be used to classify results from monitoring of a marketplace, such as monitoring systems, such as automated agents, that operate within the marketplace, as well as monitoring resources that enable the marketplace, such as computing, networking, energy, data storage, energy storage, and other resources.

In embodiments, methods and systems described herein that involve an expert system or self-organization capability may use a feed-forward, back-propagation multi-layer perceptron (MLP) neural network, such as for handling one or more remote sensing applications, such as for taking inputs from sensors distributed throughout various transactional environments. In embodiments, the MLP neural network may be used for classification of energy edge environments and resource environments, such as spot markets, forward markets, energy markets, renewable energy credit (REC) markets, networking markets, advertising markets, spectrum markets, ticketing markets, rewards markets, compute markets, and others mentioned throughout this disclosure, as well as physical resources and environments that produce them, such as energy resources (including renewable energy environments, mining environments, exploration environments, drilling environments, and the like, including classification of geological structures (including underground features and above ground features), classification of materials (including fluids, minerals, metals, and the like), and other problems. This may include fuzzy classification. In embodiments, methods and systems described herein that involve an expert system or self-organization capability may use a structure-adaptive neural network, where the structure of a neural network is adapted, such as based on a rule, a sensed condition, a contextual parameter, or the like. For example, if a neural network does not converge on a solution, such as classifying an item or arriving at a prediction, when acting on a set of inputs after some amount of training, the neural network may be modified, such as from a feed forward neural network to a recurrent neural network, such as by switching data paths between some subset of nodes from unidirectional to bidirectional data paths. The structure adaptation may occur under control of an expert system, such as to trigger adaptation upon occurrence of a trigger, rule or event, such as recognizing occurrence of a threshold (such as an absence of a convergence to a solution within a given amount of time) or recognizing a phenomenon as requiring different or additional structure (such as recognizing that a system is varying dynamically or in a non-linear fashion). In one non-limiting example, an expert system may switch from a simple neural network structure like a feed forward neural network to a more complex neural network structure like a recurrent neural network, a convolutional neural network, or the like upon receiving an indication that a continuously variable transmission is being used to drive a generator, turbine, or the like in a system being analyzed.

In embodiments, methods and systems described herein that involve an expert system or self-organization capability may use an autoencoder, autoassociator or Diabolo neural network, which may be similar to a multilayer perceptron (MLP) neural network, such as where there may be an input layer, an output layer and one or more hidden layers connecting them. However, the output layer in the auto-encoder may have the same number of units as the input layer, where the purpose of the MLP neural network is to reconstruct its own inputs (rather than just emitting a target value). Therefore, the auto encoders may operate as an unsupervised learning model. An auto encoder may be used, for example, for unsupervised learning of efficient codings, such as for dimensionality reduction, for learning generative models of data, and the like. In embodiments, an auto-encoding neural network may be used to self-learn an efficient network coding for transmission of analog sensor data from a machine over one or more networks or of digital data from one or more data sources. In embodiments, an auto-encoding neural network may be used to self-learn an efficient storage approach for storage of streams of data.

In embodiments, methods and systems described herein that involve an expert system or self-organization capability may use a probabilistic neural network (PNN), which, in embodiments, may comprise a multi-layer (e.g., four-layer) feed forward neural network, where layers may include input layers, hidden layers, pattern/summation layers and an output layer. In an embodiment of a PNN algorithm, a parent probability distribution function (PDF) of each class may be approximated, such as by a Parzen window and/or a non-parametric function. Then, using the PDF of each class, the class probability of a new input is estimated, and Bayes' rule may be employed, such as to allocate it to the class with the highest posterior probability. A PNN may embody a Bayesian network and may use a statistical algorithm or analytic technique, such as Kernel Fisher discriminant analysis technique. The PNN may be used for classification and pattern recognition in any of a wide range of embodiments disclosed herein. In one non-limiting example, a probabilistic neural network may be used to predict a fault condition of an engine based on collection of data inputs from sensors and instruments for the engine.

In embodiments, methods and systems described herein that involve an expert system or self-organization capability may use a time delay neural network (TDNN), which may comprise a feed forward architecture for sequential data that recognizes features independent of sequence position. In embodiments, to account for time shifts in data, delays are added to one or more inputs, or between one or more nodes, so that multiple data points (from distinct points in time) are analyzed together. A time delay neural network may form part of a larger pattern recognition system, such as using a perceptron network. In embodiments, a TDNN may be trained with supervised learning, such as where connection weights are trained with back propagation or under feedback. In embodiments, a TDNN may be used to process sensor data from distinct streams, such as a stream of velocity data, a stream of acceleration data, a stream of temperature data, a stream of pressure data, and the like, where time delays are used to align the data streams in time, such as to help understand patterns that involve understanding of the various streams (e.g., changes in price patterns in spot or forward markets).

In embodiments, methods and systems described herein that involve an expert system or self-organization capability may use a convolutional neural network (referred to in some cases as a CNN, a ConvNet, a shift invariant neural network, or a space invariant neural network), wherein the units are connected in a pattern similar to the visual cortex of the human brain. Neurons may respond to stimuli in a restricted region of space, referred to as a receptive field. Receptive fields may partially overlap, such that they collectively cover the entire (e.g., visual) field. Node responses may be calculated mathematically, such as by a convolution operation, such as using multilayer perceptrons that use minimal preprocessing. A convolutional neural network may be used for recognition within images and video streams, such as for recognizing a type of machine in a large environment using a camera system disposed on a mobile data collector, such as on a drone or mobile robot. In embodiments, a convolutional neural network may be used to provide a recommendation based on data inputs, including sensor inputs and other contextual information, such as recommending a route for a mobile data collector. In embodiments, a convolutional neural network may be used for processing inputs, such as for natural language processing of instructions provided by one or more parties involved in a workflow in an environment. In embodiments, a convolutional neural network may be deployed with a large number of neurons (e.g., 100,000, 500,000 or more), with multiple (e.g., 4, 5, 6 or more) layers, and with many (e.g., millions) of parameters. A convolutional neural net may use one or more convolutional nets.

In embodiments, methods and systems described herein that involve an expert system or self-organization capability may use a regulatory feedback network, such as for recognizing emergent phenomena (such as new types of behavior not previously understood in a transactional environment).

In embodiments, methods and systems described herein that involve an expert system or self-organization capability may use a self-organizing map (SOM), involving unsupervised learning. A set of neurons may learn to map points in an input space to coordinates in an output space. The input space may have different dimensions and topology from the output space, and the SOM may preserve these while mapping phenomena into groups.

In embodiments, methods and systems described herein that involve an expert system or self-organization capability may use a learning vector quantization neural net (LVQ). Prototypical representatives of the classes may parameterize, together with an appropriate distance measure, in a distance-based classification scheme.

In embodiments, methods and systems described herein that involve an expert system or self-organization capability may use an echo state network (ESN), which may comprise a recurrent neural network with a sparsely connected, random hidden layer. The weights of output neurons may be changed (e.g., the weights may be trained based on feedback). In embodiments, an ESN may be used to handle time series patterns, such as, in an example, recognizing a pattern of events associated with a market, such as the pattern of price changes in response to stimuli.

In embodiments, methods and systems described herein that involve an expert system or self-organization capability may use a Bi-directional, recurrent neural network (BRNN), such as using a finite sequence of values (e.g., voltage values from a sensor) to predict or label each element of the sequence based on both the past and the future context of the element. This may be done by adding the outputs of two RNNs, such as one processing the sequence from left to right, the other one from right to left. The combined outputs are the predictions of target signals, such as ones provided by a teacher or supervisor. A bi-directional RNN may be combined with a long short-term memory RNN.

In embodiments, methods and systems described herein that involve an expert system or self-organization capability may use a hierarchical RNN that connects elements in various ways to decompose hierarchical behavior, such as into useful subprograms. In embodiments, a hierarchical RNN may be used to manage one or more hierarchical templates for data collection in a transactional environment.

In embodiments, methods and systems described herein that involve an expert system or self-organization capability may use a stochastic neural network, which may introduce random variations into the network. Such random variations may be viewed as a form of statistical sampling, such as Monte Carlo sampling.

In embodiments, methods and systems described herein that involve an expert system or self-organization capability may use a genetic scale recurrent neural network. In such embodiments, an RNN (often an LSTM) is used where a series is decomposed into a number of scales where every scale informs the primary length between two consecutive points. A first order scale consists of a normal RNN, a second order consists of all points separated by two indices and so on. The Nth order RNN connects the first and last node. The outputs from all the various scales may be treated as a committee of members, and the associated scores may be used genetically for the next iteration.

In embodiments, methods and systems described herein that involve an expert system or self-organization capability may use a committee of machines (CoM), comprising a collection of different neural networks that together “vote” on a given example. Because neural networks may suffer from local minima, starting with the same architecture and training, but using randomly different initial weights often gives different results. A CoM tends to stabilize the result.

In embodiments, methods and systems described herein that involve an expert system or self-organization capability may use an associative neural network (ASNN), such as involving an extension of a committee of machines that combines multiple feed forward neural networks and a k-nearest neighbor technique. It may use the correlation between ensemble responses as a measure of distance amid the analyzed cases for the kNN. This corrects the bias of the neural network ensemble. An associative neural network may have a memory that may coincide with a training set. If new data become available, the network instantly improves its predictive ability and provides data approximation (self-learns) without retraining. Another important feature of ASNN is the possibility to interpret neural network results by analysis of correlations between data cases in the space of models.

In embodiments, methods and systems described herein that involve an expert system or self-organization capability may use an instantaneously trained neural network (ITNN), where the weights of the hidden and the output layers are mapped directly from training vector data.

In embodiments, methods and systems described herein that involve an expert system or self-organization capability may use a spiking neural network, which may explicitly consider the timing of inputs. The network input and output may be represented as a series of spikes (such as a delta function or more complex shapes). SNNs may process information in the time domain (e.g., signals that vary over time, such as signals involving dynamic behavior of markets or transactional environments). They are often implemented as recurrent networks.

In embodiments, methods and systems described herein that involve an expert system or self-organization capability may use a dynamic neural network that addresses nonlinear multivariate behavior and includes learning of time-dependent behavior, such as transient phenomena and delay effects. Transients may include behavior of shifting market variables, such as prices, available quantities, available counterparties, and the like.

In embodiments, cascade correlation may be used as an architecture and supervised learning algorithm, supplementing adjustment of the weights in a network of fixed topology. Cascade-correlation may begin with a minimal network, then automatically trains and add new hidden units one by one, creating a multi-layer structure. Once a new hidden unit has been added to the network, its input-side weights may be frozen. This unit then becomes a permanent feature-detector in the network, available for producing outputs or for creating other, more complex feature detectors. The cascade-correlation architecture may learn quickly, determine its own size and topology, and retain the structures it has built even if the training set changes and requires no back-propagation.

In embodiments, methods and systems described herein that involve an expert system or self-organization capability may use a neuro-fuzzy network, such as involving a fuzzy inference system in the body of an artificial neural network. Depending on the type, several layers may simulate the processes involved in a fuzzy inference, such as fuzzification, inference, aggregation and defuzzification. Embedding a fuzzy system in a general structure of a neural net as the benefit of using available training methods to find the parameters of a fuzzy system.

In embodiments, methods and systems described herein that involve an expert system or self-organization capability may use a compositional pattern-producing network (CPPN), such as a variation of an associative neural network (ANN) that differs the set of activation functions and how they are applied. While typical ANNs often contain only sigmoid functions (and sometimes Gaussian functions), CPPNs may include both types of functions and many others. Furthermore, CPPNs may be applied across the entire space of possible inputs, so that they may represent a complete image. Since they are compositions of functions, CPPNs in effect encode images at infinite resolution and may be sampled for a particular display at whatever resolution is optimal.

This type of network may add new patterns without re-training. In embodiments, methods and systems described herein that involve an expert system or self-organization capability may use a one-shot associative memory network, such as by creating a specific memory structure, which assigns each new pattern to an orthogonal plane using adjacently connected hierarchical arrays.

In embodiments, methods and systems described herein that involve an expert system or self-organization capability may use a hierarchical temporal memory (HTM) neural network, such as involving the structural and algorithmic properties of the neocortex. HTM may use a biomimetic model based on memory-prediction theory. HTM may be used to discover and infer the high-level causes of observed input patterns and sequences.

In embodiments, methods and systems described herein that involve an expert system or self-organization capability may use a holographic associative memory (HAM) neural network, which may comprise an analog, correlation-based, associative, stimulus-response system. Information may be mapped onto the phase orientation of complex numbers. The memory is effective for associative memory tasks, generalization and pattern recognition with changeable attention.

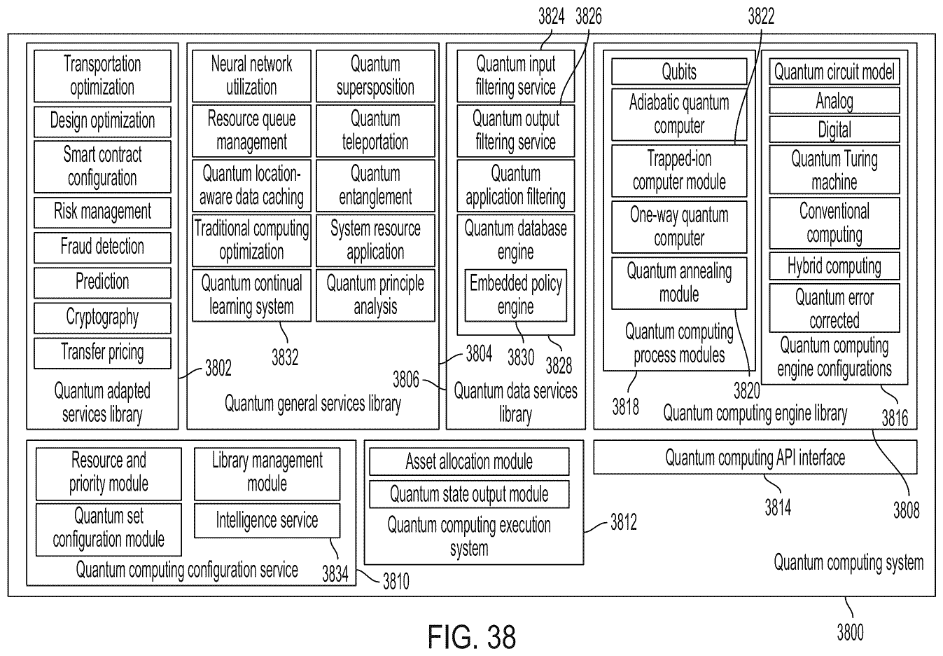

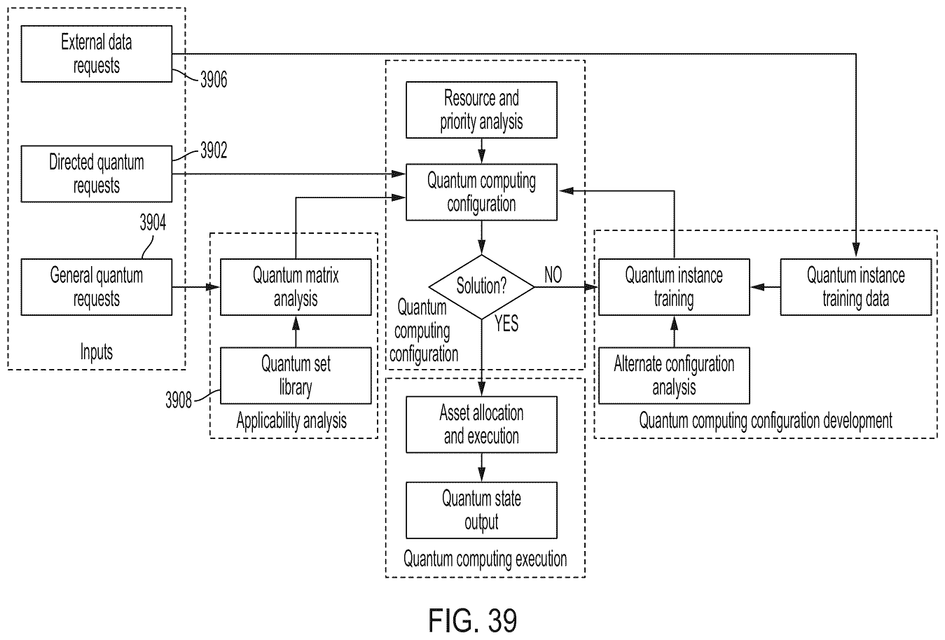

### FIGS. 38 and 39: Quantum Computing Service

FIG. 38 illustrates an example quantum computing system 3800 according to some embodiments of the present disclosure. In embodiments, the quantum computing system 3800 provides a framework for providing a set of quantum computing services to one or more quantum computing clients. In some embodiments, the quantum computing system 3800 framework may be at least partially replicated in respective quantum computing clients. In these embodiments, an individual client may include some or all of the capabilities of the quantum computing system 3800, whereby the quantum computing system 3800 is adapted for the specific functions performed by the subsystems of the quantum computing client. Additionally, or alternatively, in some embodiments, the quantum computing system 3800 may be implemented as a set of microservices, such that different quantum computing clients may leverage the quantum computing system 3800 via one or more APIs exposed to the quantum computing clients. In these embodiments, the quantum computing system 3800 may be configured to perform various types of quantum computing services that may be adapted for different quantum computing clients. In either of these configurations, a quantum computing client may provide a request to the quantum computing system 3800, whereby the request is to perform a specific task (e.g., an optimization). In response, the quantum computing system 3800 executes the requested task and returns a response to the quantum computing client.

Referring to FIG. 38, in some embodiments, the quantum computing system 3800 may include a quantum adapted services library 3802, a quantum general services library 3804, a quantum data services library 3806, a quantum computing engine library 3808, a quantum computing configuration service 3810, a quantum computing execution system 3812, and quantum computing API interface 3814.

In embodiments, the quantum computing engine library 3808 includes quantum computing engine configurations 3816 and quantum computing process modules 3818 based on various supported quantum models. In embodiments, the quantum computing system 3800 may support many different quantum models, including, but not limited to, the quantum circuit model, quantum Turing machine, adiabatic quantum computer, spintronic computing system (such as using spin-orbit coupling to generate spin-polarized electronic states in non-magnetic solids, such as ones using diamond materials), one-way quantum computer, quantum annealing, and various quantum cellular automata. Under the quantum circuit model, quantum circuits may be based on the quantum bit, or “qubit”, which is somewhat analogous to the bit in classical computation. Qubits may be in a 1 or 0 quantum state or they may be in a superposition of the 1 and 0 states. However, when qubits have measured the result of a measurement, qubits will always be in is always either a 1 or 0 quantum state. The probabilities related to these two outcomes depend on the quantum state that the qubits were in immediately before the measurement. Computation is performed by manipulating qubits with quantum logic gates, which are somewhat analogous to classical logic gates.

In embodiments, the quantum computing system 3800 may be physically implemented using an analog approach or a digital approach. Analog approaches may include, but are not limited to, quantum simulation, quantum annealing, and adiabatic quantum computation. In embodiments, digital quantum computers use quantum logic gates for computation. Both analog and digital approaches may use quantum bits, or qubits.

In embodiments, the quantum computing system 3800 includes a quantum annealing module 3820 wherein the quantum annealing module may be configured to find the global minimum or maximum of a given objective function over a given set of candidate solutions (e.g., candidate states) using quantum fluctuations. As used herein, quantum annealing may refer to a meta-procedure for finding a procedure that identifies an absolute minimum or maximum, such as a size, length, cost, time, distance or other measure, from within a possibly very large, but finite, set of possible solutions using quantum fluctuation-based computation instead of classical computation. The quantum annealing module 3820 may be leveraged for problems where the search space is discrete (e.g., combinatorial optimization problems) with many local minima, such as finding the ground state of a spin glass or the traveling salesman problem.

In embodiments, the quantum annealing module 3820 starts from a quantum-mechanical superposition of all possible states (candidate states) with equal weights. The quantum annealing module 3820 may then evolve, such as following the time-dependent Schrödinger equation, a natural quantum-mechanical evolution of systems (e.g., physical systems, logical systems, or the like). In embodiments, the amplitudes of all candidate states change, realizing quantum parallelism according to the time-dependent strength of the transverse field, which causes quantum tunneling between states. If the rate of change of the transverse field is slow enough, the quantum annealing module 3820 may stay close to the ground state of the instantaneous Hamiltonian. If the rate of change of the transverse field is accelerated, the quantum annealing module 3820 may leave the ground state temporarily but produce a higher likelihood of concluding in the ground state of the final problem energy state or Hamiltonian.

In embodiments, the quantum computing system 3800 may include arbitrarily large numbers of qubits and may transport ions to spatially distinct locations in an array of ion traps, building large, entangled states via photonically connected networks of remotely entangled ion chains.

In some implementations, the quantum computing system 3800 includes a trapped ion computer module 3822, which may be a quantum computer that applies trapped ions to solve complex problems. Trapped ion computer module 3822 may have low quantum decoherence and may be able to construct large solution states. Ions, or charged atomic particles, may be confined and suspended in free space using electromagnetic fields. Qubits are stored in stable electronic states of each ion, and quantum information may be transferred through the collective quantized motion of the ions in a shared trap (interacting through the Coulomb force). Lasers may be applied to induce coupling between the qubit states (for single-qubit operations) or coupling between the internal qubit states and the external motional states (for entanglement between qubits).

In some embodiments of the invention, a traditional computer, including a processor, memory, and a graphical user interface (GUI), may be used for designing, compiling, and providing output from the execution and the quantum computing system 3800 may be used for executing the machine language instructions. In some embodiments of the invention, the quantum computing system 3800 may be simulated by a computer program executed by the traditional computer. In such embodiments, a superposition of states of the quantum computing system 3800 can be prepared based on input from the initial conditions. Since the initialization operation available in a quantum computer can only initialize a qubit to either the 10> or 1> state, initialization to a superposition of states is physically unrealistic. For simulation purposes, however, it may be useful to bypass the initialization process and initialize the quantum computing system 3800 directly.

In some embodiments, the quantum computing system 3800 provides various quantum data services, including quantum input filtering, quantum output filtering, quantum application filtering, and a quantum database engine.

In embodiments, the quantum computing system 3800 may include a quantum input filtering service 3824. In embodiments, quantum input filtering service 3824 may be configured to select whether to run a model on the quantum computing system 3800 or to run the model on a classic computing system. In some embodiments, quantum input filtering service 3824 may filter data for later modeling on a classic computer. In embodiments, the quantum computing system 3800 may provide input to traditional compute platforms while filtering out unnecessary information from flowing into distributed systems. In some embodiments, the quantum computing system 3800 may trust through filtered specified experiences for intelligent agents.

In embodiments, a system in the system of systems may include a model or system for automatically determining, based on a set of inputs, whether to deploy quantum computational or quantum algorithmic resources to an activity, whether to deploy traditional computational resources and algorithms, or whether to apply a hybrid or combination of them. In embodiments, inputs to a model or automation system may include demand information, supply information, financial data, energy cost information, capital costs for computational resources, development costs (such as for algorithms), energy costs, operational costs (including labor and other costs), performance information on available resources (quantum and traditional), and any of the many other data sets that may be used to simulate (such as using any of a wide variety of simulation techniques described herein and/or in the documents incorporated herein by refence) and/or predict the difference in outcome between a quantum-optimized result and a non-quantum-optimized result. A machine learned model (including in a DPANN system) may be trained, such as by deep learning on outcomes or by a data set from human expert decisions, to determine what set of resources to deploy given the input data for a given request. The model may itself be deployed on quantum computational resources and/or may use quantum algorithms, such as quantum annealing, to determine whether, where and when to use quantum systems, conventional systems, and/or hybrids or combinations.

In some embodiments of the invention, the quantum computing system 3800 may include a quantum output filtering service 3826. In embodiments, the quantum output filtering service 3826 may be configured to select a solution from solutions of multiple neural networks. For example, multiple neural networks may be configured to generate solutions to a specific problem and the quantum output filtering service 3826 may select the best solution from the set of solutions.

In some embodiments, the quantum computing system 3800 connects and directs a neural network development or selection process. In this embodiment, the quantum computing system 3800 may directly program the weights of a neural network such that the neural network gives the desired outputs. This quantum-programmed neural network may then operate without the oversight of the quantum computing system 3800 but will still be operating within the expected parameters of the desired computational engine.

In embodiments, the quantum computing system 3800 includes a quantum database engine 3828. In embodiments, the quantum database engine 3828 is configured with in-database quantum algorithm execution. In embodiments, a quantum query language may be employed to query the quantum database engine 3828. In some embodiments, the quantum database engine may have an embedded policy engine 3830 for prioritization and/or allocation of quantum workflows, including prioritization of query workloads, such as based on overall priority as well as the comparative advantage of using quantum computing resources versus others. In embodiments, quantum database engine 3828 may assist with the recognition of entities by establishing a single identity for that is valid across interactions and touchpoints. The quantum database engine 3828 may be configured to perform optimization of data matching and intelligent traditional compute optimization to match individual data elements. The quantum computing system 3800 may include a quantum data obfuscation system for obfuscating data.

The quantum computing system 3800 may include, but is not limited to, analog quantum computers, digital computers, and/or error-corrected quantum computers. Analog quantum computers may directly manipulate the interactions between qubits without breaking these actions into primitive gate operations. In embodiments, quantum computers that may run analog machines include, but are not limited to, quantum annealers, adiabatic quantum computers, and direct quantum simulators. The digital computers may operate by carrying out an algorithm of interest using primitive gate operations on physical qubits. Error-corrected quantum computers may refer to a version of gate-based quantum computers made more robust through the deployment of quantum error correction (QEC), which enables noisy physical qubits to emulate stable logical qubits so that the computer behaves reliably for any computation. Further, quantum information products may include, but are not limited to, computing power, quantum predictions, and quantum inventions.

In some embodiments, the quantum computing system 3800 is configured as an engine that may be used to optimize traditional computers, integrate data from multiple sources into a decision-making process, and the like. The data integration process may involve real-time capture and management of interaction data by a wide range of tracking capabilities, both directly and indirectly related to value chain network activities. In embodiments, the quantum computing system 3800 may be configured to accept cookies, email addresses and other contact data, social media feeds, news feeds, event and transaction log data (including transaction events, network events, computational events, and many others), event streams, results of web crawling, distributed ledger information (including blockchain updates and state information), results from distributed or federated queries of data sources, streams of data from chat rooms and discussion forums, and many others.

In embodiments, the quantum computing system 3800 includes a quantum register having a plurality of qubits. Further, the quantum computing system 3800 may include a quantum control system for implementing the fundamental operations on each of the qubits in the quantum register and a control processor for coordinating the operations required.

In embodiments, the quantum computing system 3800 is configured to optimize the pricing of a set of goods or services. In embodiments, the quantum computing system 3800 may utilize quantum annealing to provide optimized pricing. In embodiments, the quantum computing system 3800 may use q-bit based computational methods to optimize pricing.

In embodiments, the quantum computing system 3800 is configured to automatically discover smart contract configuration opportunities. Automated discovery of smart contract configuration opportunities may be based on published APIs to marketplaces and machine learning (e.g., by robotic process automation (RPA) of stakeholder, asset, and transaction types.

In embodiments, quantum-established or other blockchain-enabled smart contracts enable frequent transactions occurring among a network of parties, and manual or duplicative tasks are performed by counterparties for each transaction. The quantum-established or other blockchain acts as a shared database to provide a secure, single source of truth, and smart contracts automate approvals, calculations, and other transacting activities that are prone to lag and error. Smart contracts may use software code to automate tasks, and in some embodiments, this software code may include quantum code that enables extremely sophisticated optimized results.

In embodiments, the quantum computing system 3800 or other system in the system of systems may include a quantum-enabled or other risk identification module that is configured to perform risk identification and/or mitigation. The steps that may be taken by the risk identification module may include, but are not limited to, risk identification, impact assessment, and the like. In some embodiments, the risk identification module determines a risk type from a set of risk types. In embodiments, risks may include, but are not limited to, preventable, strategic, and external risks. Preventable risks may refer to risks that come from within and that can usually be managed on a rule-based level, such as employing operational procedures monitoring and employee and manager guidance and instruction. Strategy risks may refer to those risks that are taken on voluntarily to achieve greater rewards. External risks may refer to those risks that originate outside and are not in the businesses' control (such as natural disasters). External risks are not preventable or desirable. In embodiments, the risk identification module can determine a predicted cost for many categories of risk. The risk identification module may perform a calculation of current and potential impact on an overall risk profile. In embodiments, the risk identification module may determine the probability and significance of certain events. Additionally, or alternatively, the risk identification module may be configured to anticipate events.

In embodiments, the quantum computing system 3800 or other system of the quantum computing system 3800 is configured for graph clustering analysis for anomaly and fraud detection.

In some embodiments, the quantum computing system 3800 includes a quantum prediction module, which is configured to generate predictions. Furthermore, the quantum prediction module may construct classical prediction engines to further generate predictions, reducing the need for ongoing quantum calculation costs, which, can be substantial compared to traditional computers.

In embodiments, the quantum computing system 3800 may include a quantum principal component analysis (QPCA) algorithm that may process input vector data if the covariance matrix of the data is efficiently obtainable as a density matrix, under specific assumptions about the vectors given in the quantum mechanical form. It may be assumed that the user has quantum access to the training vector data in a quantum memory. Further, it may be assumed that each training vector is stored in the quantum memory in terms of its difference from the class means. These QPCA algorithms can then be applied to provide for dimension reduction using the calculational benefits of a quantum method.

In embodiments, the quantum computing system 3800 is configured for graph clustering analysis for certified randomness for proof-of-stake blockchains. Quantum cryptographic schemes may make use of quantum mechanics in their designs, which enables such schemes to rely on presumably unbreakable laws of physics for their security. The quantum cryptography schemes may be information-theoretically secure such that their security is not based on any non-fundamental assumptions. In the design of blockchain systems, information-theoretic security is not proven. Rather, classical blockchain technology typically relies on security arguments that make assumptions about the limitations of attackers' resources.

In embodiments, the quantum computing system 3800 is configured for detecting adversarial systems, such as adversarial neural networks, including adversarial convolutional neural networks. For example, the quantum computing system 3800 or other systems of the quantum computing system 3800 may be configured to detect fake trading patterns.

In embodiments, the quantum computing system 3800 includes a quantum continual learning system, or QCL system 3832, wherein the QCL system 3832 learns continuously and adaptively about the external world, enabling the autonomous incremental development of complex skills and knowledge by updating a quantum model to account for different tasks and data distributions. The QCL system 3832 operates on a realistic time scale where data and/or tasks become available only during operation. Previous quantum states can be superimposed into the quantum engine to provide the capacity for QCL. Because the QCL system 3832 is not constrained to a finite number of variables that can be processed deterministically, it can continuously adapt to future states, producing a dynamic continual learning capability. The QCL system 3832 may have applications where data distributions stay relatively static, but where data is continuously being received. For example, the QCL system 3832 may be used in quantum recommendation applications or quantum anomaly detection systems where data is continuously being received and where the quantum model is continuously refined to provide for various outcomes, predictions, and the like. QCL enables asynchronous alternate training of tasks and only updates the quantum model on the real-time data available from one or more streaming sources at a particular moment.

In embodiments, the QCL system 3832 operates in a complex environment in which the target data keeps changing based on a hidden variable that is not controlled. In embodiments, the QCL system 3832 can scale in terms of intelligence while processing increasing amounts of data and while maintaining a realistic number of quantum states. The QCL system 3832 applies quantum methods to drastically reduce the requirement for storage of historic data while allowing the execution of continuous computations to provide for detail-driven optimal results. In embodiments, a QCL system 3832 is configured for unsupervised streaming perception data since it continually updates the quantum model with new available data.

In embodiments, QCL system 3832 enables multi-modal-multi-task quantum learning. The QCL system 3832 is not constrained to a single stream of perception data but allows for many streams of perception data from different sensors and input modalities. In embodiments, the QCL system 3832 can solve multiple tasks by duplicating the quantum state and executing computations on the duplicate quantum environment. A key advantage to QCL is that the quantum model does not need to be retrained on historic data, as the superposition state holds information relating to all prior inputs. Multi-modal and multi-task quantum learning enhance quantum optimization since it endows quantum machines with reasoning skills through the application of vast amounts of state information.

In embodiments, the quantum computing system 3800 supports quantum superposition, or the ability of a set of states to be overlaid into a single quantum environment.

In embodiments, the quantum computing system 3800 supports quantum teleportation. For example, information may be passed between photons on chipsets even if the photons are not physically linked.

In embodiments, the quantum computing system 3800 may include a quantum transfer pricing system. Quantum transfer pricing allows for the establishment of prices for the goods and/or services exchanged between subsidiaries, affiliates, or commonly controlled companies that are part of a larger enterprise and may be used to provide tax savings for corporations. In embodiments, solving a transfer pricing problem involves testing the elasticities of each system in the system of systems with a set of tests. In these embodiments, the testing may be done in periodic batches and then may be iterated. As described herein, transfer pricing may refer to the price that one division in a company charges another division in that company for goods and services.

In embodiments, the quantum transfer pricing system consolidates all financial data related to transfer pricing on an ongoing basis throughout the year for all entities of an organization wherein the consolidation involves applying quantum entanglement to overlay data into a single quantum state. In embodiments, the financial data may include profit data, loss data, data from intercompany invoices (potentially including quantities and prices), and the like.

In embodiments, the quantum transfer pricing system may interface with a reporting system that reports segmented profit and loss, transaction matrices, tax optimization results, and the like based on superposition data. In embodiments, the quantum transfer pricing system automatically generates forecast calculations and assesses the expected local profits for any set of quantum states.

In embodiments, the quantum transfer pricing system may integrate with a simulation system for performing simulations. Suggested optimal values for new product prices can be discussed cross-border via integrated quantum workflows and quantum teleportation communicated states.

In embodiments, quantum transfer pricing may be used to proactively control the distribution of profits within a multi-national enterprise (MNE), for example, during the course of a calendar year, enabling the entities to achieve arms-length profit ranges for each type of transaction.

In embodiments, the QCL system 3832 may use a number of methods to calculate quantum transfer pricing, including the quantum comparable uncontrolled price (QCUP) method, the quantum cost plus percent method (QCPM), the quantum resale price method (QRPM), the quantum transaction net margin method (QTNM), and the quantum profit-split method.

The QCUP method may apply quantum calculations to find comparable transactions made between related and unrelated organizations, potentially through the sharing of quantum superposition data. By comparing the price of goods and/or services in an intercompany transaction with the price used by independent parties through the application of a quantum comparison engine, a benchmark price may be determined.

The QCPM method may compare the gross profit to the cost of sales, thus measuring the cost-plus mark-up (the actual profit earned from the products). Once this mark-up is determined, it should be equal to what a third party would make for a comparable transaction in a comparable context with similar external market conditions. In embodiments, the quantum engine may simulate the external market conditions.

The QRPM method looks at groups of transactions rather than individual transactions and is based on the gross margin or difference between the price at which a product is purchased and the price at which it is sold to a third party. In embodiments, the quantum engine may be applied to calculate the price differences and to record the transactions in the superposition system.

The QTNM method is based on the net profit of a controlled transaction rather than comparable external market pricing. The calculation of the net profit is accomplished through a quantum engine that can consider a wide variety of factors and solve optimally for the product price. The net profit may then be compared with the net profit of independent enterprises, potentially using quantum teleportation.

The quantum profit-split method may be used when two related companies work on the same business venture, but separately. In these applications, the quantum transfer pricing is based on profit. The quantum profit-split method applies quantum calculations to determine how the profit associated with a particular transaction would have been divided between the independent parties involved.

In embodiments, the quantum computing system 3800 may leverage one or artificial networks to fulfill the request of a quantum computing client. For example, the quantum computing system 3800 may leverage a set of artificial neural networks to identify patterns in images (e.g., using image data from a liquid lens system), perform binary matrix factorization, perform topical content targeting, perform similarity-based clustering, perform collaborative filtering, perform opportunity mining, or the like.

In embodiments, the system of systems may include a hybrid computing allocation system for prioritization and allocation of quantum computing resources and traditional computing resources. In embodiments, the prioritization and allocation of quantum computing resources and traditional computing resources may be measure-based (e.g., measuring the extent of the advantage of the quantum resource relative to other available resources), cost-based, optimality-based, speed-based, impact-based, or the like. In some embodiments the hybrid computing allocation system is configured to perform time-division multiplexing between the quantum computing system 3800 and a traditional computing system. In embodiments, the hybrid computing allocation system may automatically track and report on the allocation of computational resources, the availability of computational resources, the cost of computational resources, and the like.

In embodiments, the quantum computing system 3800 may be leveraged for queue optimization for utilization of quantum computing resources, including context-based queue optimizations.

In embodiments, the quantum computing system 3800 may support quantum-computation-aware location-based data caching.

In embodiments, the quantum computing system 3800 may be leveraged for optimization of various system resources in the system of systems, including the optimization of quantum computing resources, traditional computing resources, energy resources, human resources, robotic fleet resources, smart container fleet resources, I/O bandwidth, storage resources, network bandwidth, attention resources, or the like.

The quantum computing system 3800 may be implemented where a complete range of capabilities are available to or as part of any configured service. Configured quantum computing services may be configured with subsets of these capabilities to perform specific predefined function, produce newly defined functions, or various combinations of both.

FIG. 39 illustrates quantum computing service request handling according to some embodiments of the present disclosure. A directed quantum computing request 3902 may come from one or more quantum-aware devices or stack of devices, where the request is for known application configured with specific quantum instance(s), quantum computing engine(s), or other quantum computing resources, and where data associated with the request may be preprocessed or otherwise optimized for use with quantum computing.

A general quantum computing request 3904 may come from any system in the system of systems or configured service, where the requestor has determined that quantum computing resources may provide additional value or other improved outcomes. Improved outcomes may also be suggested by the quantum computing service in association with some form of monitoring and analysis. For a general quantum computing request 3904, input data may not be structured or formatted as necessary for quantum computing.

In embodiments, external data requests 3906 may include any available data that may be necessary for training new quantum instances. The sources of such requests could be public data, sensors, ERP systems, and many others.

Incoming operating requests and associated data may be analyzed using a standardized approach that identifies one or more possible sets of known quantum instances, quantum computing engines, or other quantum computing resources that may be applied to perform the requested operation(s). Potential existing sets may be identified in the quantum set library 3908.

In embodiments, the quantum computing system 3800 includes a quantum computing configuration service 3810. The quantum computing configuration service may work alone or with the intelligence service 3834 to select a best available configuration using a resource and priority analysis that also includes the priority of the requestor. The quantum computing configuration service may provide a solution (YES) or determine that a new configuration is required (NO).

In one example, the requested set of quantum computing services may not exist in the quantum set library 3908. In this example, one or more new quantum instances must be developed (trained) with the intelligence service 3834 using available data. In embodiments, alternate configurations may be developed with assistance from the intelligence service 3834 to identify alternate ways to provide all or some of the requested quantum computing services until appropriate resources become available. For example, a quantum/traditional hybrid model may be possible that provides the requested service, but at a slower rate.

In embodiments, alternate configurations may be developed with assistance from the intelligence service 3834 to identify alternate and possibly temporary ways to provide all or some of the requested quantum computing services. For example, a hybrid quantum/traditional model may be possible that provides the requested service, but at a slower rate. This may also include a feedback learning loop to adjust services in real time or to improved stored library elements.

When a quantum computing configuration has been identified and available, it is allocated and programmed for execution and delivery of one or more quantum states (solutions).

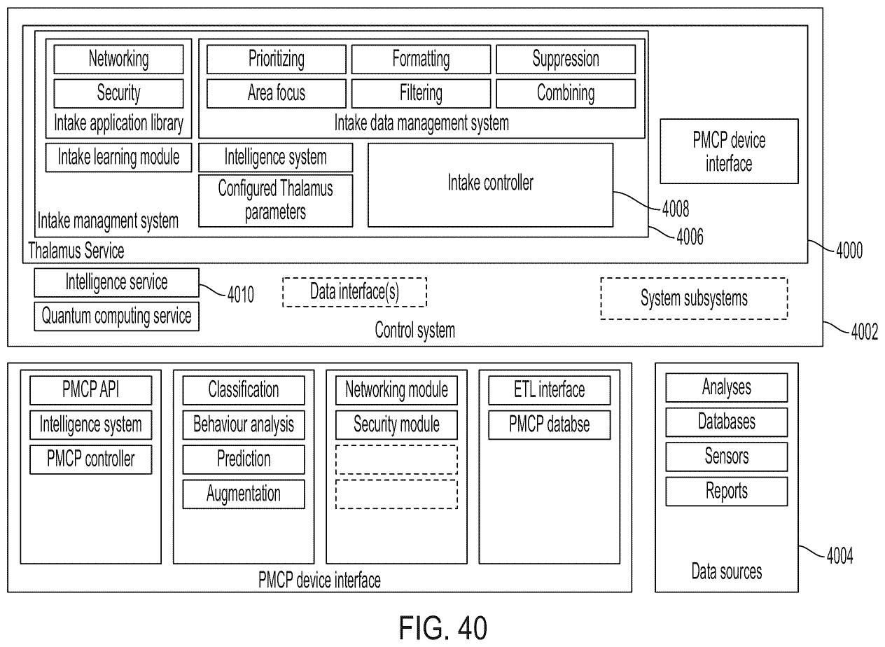

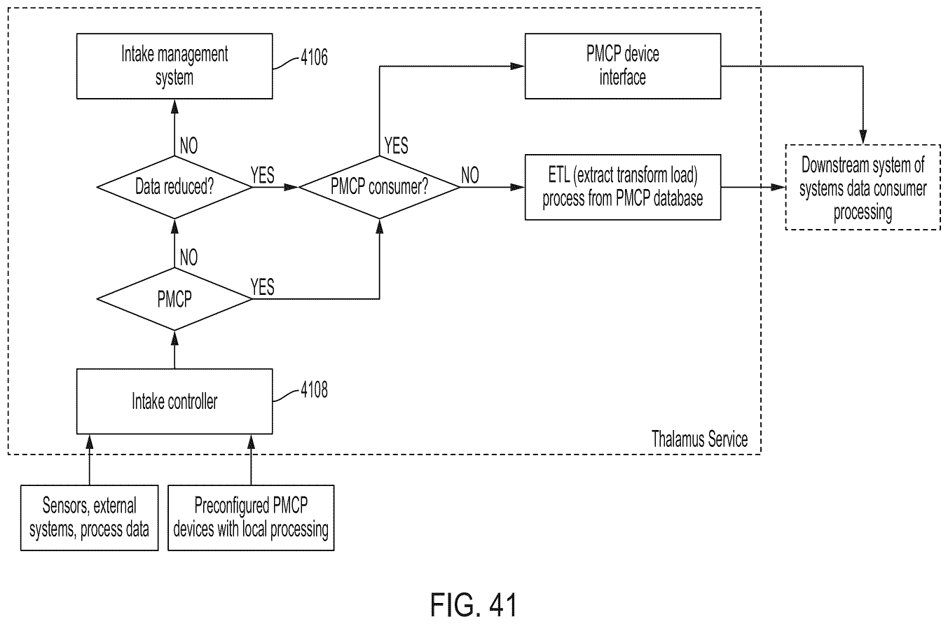

### FIGS. 40 and 41: Biology-Based Systems, Methods, Kits, and Apparatuses

FIGS. 40 and 41 together show a thalamus service 4000 and a set of input sensors streaming data from various sources across a central control system 4002 with its centrally-managed data sources 4004. The thalamus service 4000 filters the into the central control system 4002 such that the control system is never overwhelmed by the total volume of information. In embodiments, the thalamus service 4000 provides an information suppression mechanism for information flows within the system. This mechanism monitors all data streams and strips away irrelevant data streams by ensuring that the maximum data flows from all input sensors are always constrained.

The thalamus service 4000 may be a gateway for all communication that responds to the prioritization of the central control system 4002. The central control system 4002 may decide to change the prioritization of the data streamed from the thalamus service 4000, for example, during a known fire in an isolated area, and the event may direct the thalamus service 4000 to continue to provide flame sensor information despite the fact that majority of this data is not unusual. The thalamus service 4000 may be an integral part of the overall system communication framework.

In embodiments, the thalamus service 4000 includes an intake management system 4006. The intake management system 4006 may be configured to receive and process multiple large datasets by converting them into data streams that are sized and organized for subsequent use by a central control system 4002 operating within one or more systems. For example, a robot may include vision and sensing systems that are used by the central control system 4002 to identify and move through an environment in real time. The intake management system 4006 can facilitate robot decision-making by parsing, filtering, classifying, or otherwise reducing the size and increasing the utility of multiple large datasets that would otherwise overwhelm the central control system 4002. In embodiments, the intake management system may include an intake controller 4008 that works with an intelligence service 4010 to evaluate incoming data and take actions-based evaluation results. Evaluations and actions may include specific instruction sets received by the thalamus service 4000, for example the use of a set of specific compression and prioritization tools stipulated within a “Networking” library module. In another example, thalamus service inputs may direct the use of specific filtering and suppression techniques. In a third example, thalamus service inputs may stipulate data filtering associated with an area of interest such as a certain type of financial transaction. The intake management system is also configured to recognize and manage datasets that are in a vectorized format such as PCMP, where they may be passed directly to central control, or alternatively deconstructed and processed separately. The intake management system 4006 may include a learning module that receives data from external sources that enables improvement and creation of application and data management library modules. In some cases, the intake management system may request external data to augment existing datasets.

In embodiments, the central control system 4002 may direct the thalamus service 4000 to alter its filtering to provide more input from a set of specific sources. This indication more input is handled by the thalamus service 4000 by suppressing other information flows based to constrain the total data flows to within a volume the central control system can handle.

The thalamus service 4000 can operate by suppressing data based on several different factors, and in embodiments, the default factor maybe unusualness of the data. This unusualness is a constant monitoring of all input sensors and determining the unusualness of the data.

In some embodiments, the thalamus service 4000 may suppress data based on geospatial factors. The thalamus service 4000 may be aware of the geospatial location of all sensors and is able to look for unusual patterns in data based on geospatial context and suppress data accordingly.

In some embodiments, the thalamus service 4000 may suppress data based on temporal factors. Data can be suppressed temporally, for example, if the cadence of the data can be reduced such that the overall data stream is filtered to level that can be handled by the central processing unit.

In some embodiments, the thalamus service 4000 may suppress data based on contextual factors. In embodiments, context-based filtering is a filtering event in which the thalamus service 4000 is aware of some context-based event. In this context the filtering is made to suppress information flows not relating to the data from the event.

In embodiments, the central control system 4002 can override the thalamus filtering and decide to focus on a completely different area for any specific reason.

In embodiments, the system may include a vector module. In embodiments, the vector module may be used to convert data to a vectorized format. In many examples, the conversion of a long sequence of oftentimes similar numbers into a vector, which may include short term future predictions, makes the communication both smaller in size and forward looking in nature. In embodiments, forecast methods may include: moving average; weighted moving average; Kalman filtering; exponential smoothing; autoregressive moving average (ARMA) (forecasts depend on past values of the variable being forecast, and on past prediction errors); autoregressive integrated moving average (ARIMA) (ARMA on the period-to-period change in the forecasted variable); extrapolation; linear prediction; trend estimation (predicting the variable as a linear or polynomial function of time); growth curve (e.g., statistics); and recurrent neural network.

In embodiments, the system may include a predictive model communication protocol (PMCP) system to support vector-based predictive models and a predictive model communication protocol (PMCP). Under the PMCP protocol, instead of traditional streams where individual data items are transmitted, vectors representing how the data is changing or what is the forecast trend in the data is communicated. The PMCP system may transmit actual model parameters and receiving units such that edge devices can apply the vector-based predictive models to determine future states. For example, each automated device in a network could train a regression model or a neural network, constantly fitting the data streams to current input data. All automated devices leveraging the PMCP system would be able to react in advance of events actually happening, rather than waiting for depletion of inventory for an item, for example, to occur. Continuing the example, the stateless automated device can react to the forecast future state and make the necessary adjustments, such as ordering more of the item.

In embodiments, the PMCP system enables communicating vectorized information and algorithms that allow vectorized information to be processed to refine the known information regarding a set of probability-based states. For example, the PMCP system may support communicating the vectorized information gathered at each point of a sensor reading but also adding algorithms that allow the information to be processed. Applied in an environment with large numbers of sensors with different accuracies and reliabilities, the probabilistic vector-based mechanism of the PMCP system allows large numbers, if not all, data streams to combine to produce refined models representing the current state, past states and likely future states of goods. Approximation methods may include importance sampling, and the resulting algorithm is known as a particle filter, condensation algorithm, or Monte Carlo localization.

In embodiments, the vector-based communication of the PMCP system allows future security events to be anticipated, for example, by simple edge node devices that are running in a semi-autonomous way. The edge devices may be responsible for building a set of forecast models showing trends in the data. The parameters of this set of forecast models may be transmitted using the PMCP system.

Security systems are constantly looking for vectors showing change in state, as unusual events tend to trigger multiple vectors to show unusual patterns. In a security setting, seeing multiple simultaneous unusual vectors may trigger escalation and a response by, for example, the control system. In addition, one of the major areas of communication security concern is around the protection of stored data, and in a vector-based system data does not need to be stored, and so the risk of data loss is simply removed.

In embodiments, PMCP data can be directly stored in a queryable database where the actual data is reconstructed dynamically in response to a query. In some embodiments, the PMCP data streams can be used to recreate the fine-grained data so they become part of an Extract Transform and Load (ETL) process.

In embodiments where there are edge devices with very limited capacities, additional edge communication devices can be added to convert the data into PMCP format. For example, to protect distributed medical equipment from hacking attempts many manufacturers will choose to not connect the device to any kind of network. To overcome this limitation, the medical equipment may be monitored using sensors, such as cameras, sound monitors, voltage detectors for power usage, chemical sniffers, and the like. Functional unit learning and other data techniques may be used to determine the actual usage of the medical equipment detached from the network functional unit.

Communication using vectorized data allows for a constant view of likely future states. This allows the future state to be communicated, allowing various entities to respond ahead of future state requirements without needing access to the fine-grained data.

In embodiments, the PMCP protocol can be used to communicate relevant information about production levels and future trends in production. This PMCP data feed, with its built-in data obfuscation allows real contextual information about production levels to be shared with consumers, regulators, and other entities without requiring sensitive data to be shared. For example, when choosing to purchase a new car, if there is an upcoming shortage of red paint then the consumer could be encouraged to choose a different color in order to maintain a desired delivery time. PMCP and vector data enables simple data informed interactive systems that user can apply without having to build enormously complex big data engines. As an example, an upstream manufacturer has an enormously complex task of coordinating many downstream consumption points. Through the use of PMCP, the manufacturer is able to provide real information to consumers without the need to store detailed data and build complex models.

In embodiments, edge device units may communicate via the PMCP system to show direction of movement and likely future positions. For example, a moving robot can communicate its likely track of future movement.

In embodiments, the PMCP system enables visual representations of vector-based data (e.g., via a user interface), highlighting of areas of concern without the need to process enormous volumes of data. The representation allows for the display of many monitored vector inputs. The user interface can then display information relating to the key items of interest, specifically vectors showing areas of unusual or troublesome movement. This mechanism allows sophisticated models that are built at the edge device edge nodes to feed into end user communications in a visually informative way.

Functional units produce a constant stream of “boring” data. By changing from producing data, to being monitored for problems, issues with the logistical modules are highlighted without the need for scrutiny of fine-grained data. In embodiments, the vectorizing process could constantly manage a predictive model showing future state. In the context of maintenance, these changes to the parameters in the predictive model are in and of themselves predictors of change in operational parameters, potentially indicating the need for maintenance. In embodiments, functional areas are not always designed to be connected, but by allowing for an external device to virtually monitor devices, functional areas that do not allow for connectivity can become part of the information flow in the goods. This concept extends to allow functional areas that have limited connectivity to be monitored effectively by embellishing their data streams with vectorized monitored information. Placing an automated device in the proximity of the functional unit that has limited or no connectivity allows capture of information from the devices without the requirement of connectivity. There is also potential to add training data capture functional units for these unconnected or limitedly connected functional areas. These training data capture functional units are typically quite expensive and can provide high quality monitoring data, which is used as an input into the proximity edge device monitoring device to provide data for supervised learning algorithms.

Oftentimes, locations are laden with electrical interference, causing fundamental challenges with communications. The traditional approach of streaming all the fine-grained data is dependent on the completeness of the data stream. For example, if an edge device was to go offline for 10 minutes, the streaming data and its information would be lost. With vectorized communication, the offline unit continues to refine the predictive model until the moment when it reconnects, which allows the updated model to be transmitted via the PMCP system.

In embodiments, systems and devices may be based on the PMCP protocol. For example, cameras and vision systems (e.g., liquid lens systems), user devices, sensors, robots, smart containers, and the like may use PMCP and/or vector-based communication. By using vector-based cameras, for example, only information relating to the movement of items is transmitted. This reduces the data volume and by its nature filters information about static items, showing only the changes in the images and focusing the data communication on elements of change. The overall shift in communication to communication of change is similar to how the human process of sight functions, where stationary items are not even communicated to the higher levels of the brain.

Radio Frequency Identification allows for massive volumes of mobile tags to be tracked in real-time. In embodiments, the movement of the tags may be communicated as vector information via the PMCP protocol, as this form of communication is naturally suited to handing information regarding the location of tag within the goods. Adding the ability to show future state of the location using predictive models that can use paths of prior movement allows the goods to change the fundamental communication mechanism to one where units consuming data streams are consuming information about the likely future state of the goods. In embodiments, each tagged item may be represented as a probability-based location matrix showing the likely probability of the tagged item being at a position in space. The communication of movement shows the transformation of the location probability matrix to a new set of probabilities. This probabilistic locational overview provides for constant modeling of areas of likely intersection of moving units and allows for refinement of the probabilistic view of the location of items. Moving to a vector-based probability matrix allows units to constantly handle the inherent uncertainty in the measurement of status of various items, entities, and the like. In embodiments, status includes, but is not limited to, location, temperature, movement and power consumption.

In embodiments, continuous connectivity is not required for continuous monitoring of sensor inputs in a PMCP-based communication system. For example, a mobile robotic device with a plurality of sensors will continue to build models and predictions of data streams while disconnected from the network, and upon reconnection, the updated models are communicated. Furthermore, other systems or devices that use input from the monitored system or device can apply the best known, typically last communicated, vector predictions to continue to maintain a probabilistic understanding of the states of the goods.

### Graph Neural Networks

### INTRODUCTION

In various embodiments, one or more techniques involve the processing of graph data using one or more machine learning algorithms. In some such embodiments, the one or more machine learning algorithms include one or more graph neural networks (GNNs). The following discussion provides an overview of graph data and graph neural networks.

In a graph data set, a set of nodes is interconnected by one or more edges that respectively represents a relationship among two or more connected nodes. In many graph data sets, each edge connects two nodes. In other graph data sets that represent hypergraphs, a hyperedge can connect three or more nodes. In various graph data sets, each of the one or more edges is directed or undirected. An undirected edge represents a relationship that relates two or more nodes without any particular ordering of the related nodes. A first undirected relationship that connects a first node N1 and a second node N2 may be equivalent to a second undirected relationship that also connects a first node N1 and a second node N2. In some such graphs, the relationship represents a group to which the two or more related nodes belong. In some such graphs, the relationship represents an undirected and/or omnidirectional connection between two or more nodes. For example, in a graph representing a geographic region, each node may represent a city, and each edge may represent a road that connects two or more cities and that can be traveled in either direction. By contrast, a directed edge includes a direction of the relationship between a first node and a second node. For example, in a graph representing a genealogy or lineage, each node represents a person, and each edge connects a parent to a child. A first directed edge that connects a first node N1 to a second node N2 is not equivalent to a second directed edge that connects the second node N2 to the first node N1. Some graph data sets include one or more unidirectional edges, that is, an edge with one direction among two or more connected nodes. Some graph data sets include one or more multidirectional edges, that is, an edge with two or more directions among the two or more connected nodes. Some graph data sets may include one or more undirected edges, one or more unidirectional edges, and/or one or more multidirectional edges. For example, in a graph representing a geographic region, each node may represent a city; one or more unidirectional edges may represent a one-way road that connects a first city to a second city and can only be traveled from the first city to the second city; and one or more bidirectional or undirected edges that represent a bidirectional road between the first city and the second city that can be traveled in either direction. Some graph data may include, for two or more nodes, a plurality of edges that interconnect the two or more nodes. For example, a graph data set representing a collection of devices may include nodes that respectively correspond to each device of the collection and edges that respectively correspond to an instance of communication and/or interaction among two or more of the devices. In such a graph data set, a particular subset of two or more devices may engage in a plurality, including a multitude, of instances of communication and/or interaction, and may therefore be connected by a plurality, including a multitude, of edges.

Some directed and/or undirected graph data sets may include one or more cycles. For example, in a graph representing a social network, a first edge E1 may connect a first node N1 (representing a first person) and a second node N2 (representing a second person) to represent a relationship between the first person and the second person. A second edge E2 may connect the second node N2 and a third node N3 (representing a third person) to represent a relationship between the second person and the third person. A third edge E3 may connect the third node N3 and the first node N1 to represent a relationship between the third person and the first person. Such cycles can occur in undirected graphs (e.g., edges in a social network graph that indicate mutual relationships among two or more individuals), directed graphs (e.g., edges in a social network graph that indicate that a first person is influenced by a second person, a second person is influenced by a third person, and a third person is influenced by the first person), and/or hypergraphs (e.g., cycles of relationships among three or more clusters that respectively include three or more nodes). Some cyclic graphs may include one or more cycles that are interlinked (e.g., one or more nodes and/or edges that are included in two or more cycles). Other directed and/or undirected graph data sets may be acyclic (e.g., graphs in which nodes are strictly arranged according to a top-down hierarchy). Still other directed and/or undirected graph data sets may be partially acyclic (e.g., mostly acyclic) but may include one or more cycles among one or more subsets of nodes and/or edges.

In some graph data sets, one or more nodes includes one or more node properties. For example, in a graph representing a geographic area, each node may represent a city, and each node may include one or more node properties that correspond to one or more properties of the city, such as a size, a population, or a latitude and/or longitude coordinate. Each node property may be of various types, including (without limitation) a Boolean value, an integer, a floating-point number, a set of numbers such as a vector, a string, or the like. In some graph data sets, one or more nodes does not include a node property. For example, in a graph data set representing a set of particles, each particle may be identical to each other particle, and there may be no specific data that distinguishes any particle from any other particular. Thus, the nodes of the graph data set may not include any node properties.

In some graph data sets, one or more edges includes one or more edge properties. For example, in a graph representing a geographic area, each edge may represent a road, and each edge may include one or more edge properties that correspond to one or more properties of the road, such as a distance, a number of lanes, a direction, a speed limit, a volume of traffic, a start latitude and/or longitude coordinate, and/or an ending latitude and/or longitude coordinate. In some graph data sets, a direction of an edge may be represented as an edge property. Alternatively or additionally, in some graph data sets, a direction of an edge may be represented separately from one or more edge properties. In some graph data sets, one or more edges does not include an edge property. For example, in a graph data set representing a line drawing of a set of points, each edge may represent a line connecting two points, and the edges may be significant only due to connecting two points. Thus, the edges of the graph data sets may not include any edge properties.

In some graph data sets, the graph includes one or more graph properties. Such graph properties may be global graph properties that correspond to one or more properties of the entire graph. For example, in a graph data set representing a geographic region, the graph may include graph properties such as a total number of nodes and/or cities, a two-dimensional or three-dimensional area represented by the graph, and/or a latitude and/or longitude of a center of the graph. Such graph properties may be global graph properties that correspond to one or more properties of all of the nodes of the graph. For example, in a graph data set representing a geographic region, the graph may include graph properties such as an average population size of the cities represented by the nodes and/or an average connectedness of each city to other cities included in the graph.

Some graph data sets include a single set of data that includes all nodes and all edges. For example, a graph representing a geographic region may include a set of nodes that represent all cities in the geographic region. Some other graph data sets include one or more subgraphs, wherein each subgraph includes a subset of the nodes of the graph and/or a subset of the edges of the graph. For example, a graph representing a geographic region may include a number of subgraphs, each representing a subregion of the geographic region, and the edges that interconnect the cities within each subregion. As another example, a graph representing a geographic region may include a first subgraph representing cities (e.g., groups of people over a threshold population size and/or population density) and a second subgraph representing towns (e.g., groups of people under the threshold population size and/or population density). In some graph data sets, each node and/or each edge belongs exclusively to one subgraph. In some graph data sets, at least one node and/or at least one edge can belong to two or more subgraphs. For example, in a graph representing a geographic region that includes a number of subgraphs respectively representing different geographic subregion, each node representing a city may be exclusively included in one subgraph, while each edge may interconnect two or more cities within one subgraph (i.e., within one subregion) or may interconnect a first city in a first subgraph (i.e., within a first subregion) and a second city in a second subgraph (i.e., within a second subregion).

Graph neural networks can include features and/or functionality that are the same as or similar to the features and/or functionality of other neural networks. For example, graph neural networks include one or more neurons arranged in various configurations. Each neuron receives one or more inputs from the graph data set or another neuron, evaluates the one or more inputs (e.g., via an activation function), and generates one or more outputs that are delivered to one or more other neurons and/or as an output of the graph neural network. Examples of activation functions that can be included in various neurons of the graph neural network include (without limitation) a Heaviside or unit step activation function, a linear activation function, a rectified linear unit (ReLU) activation function, a logistic activation function, a tanh activation function, a hyperbolic activation function, or the like.

As an example, some graph neural networks include only a single neuron, or only a single layer of neurons that is configured to receive graph data as input and to provide graph data as output of the graph neural network. Some graph neural networks are arranged in a series of two or more layers, wherein input is received by neurons included in a first layer. The output of one or more neurons included in the first layer is delivered, as input, to one or more neurons included in a second layer. For example, each neuron in the first layer may include one or more synapses that respectively interconnect the neuron to one or more neurons of the second layer. In many graph neural networks, each neuron N1 of a preceding layer L 1 is connected to each neuron N2 of a following layer by a synapse that includes a weight W. Neuron N2 receives, as input, the output of the neuron N1 multiplied by the weight of the synapse connecting neuron N1 and neuron N2. In many neural networks, layer L 1 includes a bias B, which is added to the product of the output of neuron N1 and the weight W of the synapse connecting neuron N1 and neuron N2. As a result, the input to neuron N2 includes the sum of the bias B of layer L 1 and the product of the output of neuron N1 and the weight W of the synapse connecting neuron N1 and neuron N2. The output of the neurons included in the second layer can be provided as an output of the graph neural network and/or as input to one or more neurons included in a third layer. Each layer of the graph neural network may include a same number of neurons as a preceding and/or following layer of the graph neural network, or a different number of neurons as preceding and/or following layer of the graph neural network.

As another example, some graph neural networks include one or more layers that perform particular functions on the output of neurons of another layer, such as a pooling layer that performs a pooling operation (e.g., a minimum, a maximum, or an average) of the outputs of one or more neurons, and that generates output that is received by one or more other neurons (e.g., one or more neurons in a following layer of the graph neural network) and/or as an output of the graph neural network. For example, some graph neural networks (e.g., graph convolution networks) include one or more convolutional layers, each of which performs a convolution operation to an output of neurons of a preceding layer of the graph neural network.

As another example, some graph neural networks include memory based on an internal state, wherein the processing of a first input data set causes the graph neural network to generate and/or alter an internal state, and the internal state resulting from the processing of one or more earlier input data sets affects the processing of second and later input data sets. That is, the internal state retains a memory of some aspects of earlier processing that contribute to later processing of the graph neural network. Examples of graph neural networks that include memory features and/or stateful features include graph neural networks featuring one or more gated recurrence units (GRUs) and/or one or more long-short-term-memory (LSTM) cells.

As another example, some graph neural networks feature recurrent and/or reentrant properties. For example, at least a portion of output of the graph neural network during a first processing is included as input to the graph neural network during a second or later processing, and/or at least a portion of an output from a layer is provided as input to the same layer or a preceding layer of the graph neural network. As another example, in some graph neural networks, an output of a neuron is also received as input by the same neuron during a same processing of an input and/or a subsequent processing of an input. The output of the neuron may be evaluated (e.g., weighted, such as decayed) before being provided to the neuron as input. As another example, some graph neural networks may include one or more skip connections, in which at least a portion of an output of a first layer is provided as input to a third layer without being processed by a second layer. That is, the output of the first layer is provided as input both to the second layer (which generates a second layer output) and to the third layer. In some such graph neural networks, the third layer receives, as input, either the output of the first layer or the output of the second layer. That is, the third layer multiplexes between the output of the first layer and the output of the second layer. Alternatively or additionally, in some such graph neural networks, the third layer receives, as input, both the output of the first layer and the output of the second layer (e.g., as a concatenation of the output vectors to generate the input vector for the third layer), and/or an aggregation of the output of the first layer and the output of the second layer (e.g., a sum or average of the output of the first layer and the output of the second layer). Examples of graph neural networks that include one or more skip connections include jump knowledge networks and highway graph neural networks (highway GNNs).

As another example, some graph neural networks include two or more subnetworks (e.g., two or more graph neural networks that are configured to process graph data concurrently and/or consecutively). Some graph neural networks include, or are included in, an ensemble of two or more neural networks of the same, similar, or different types (e.g., a graph neural network that outputs data that is processed by a non-graph neural network, Gaussian classifier, random forest, or the like). For example, a random graph forest may include a multitude of graph neural networks, each configured to receive at least a portion of an input graph data set and to generate an output based on a different feature set, different architectures, and/or different forms of processing. The outputs of respective graphs of the random graph forest may be combined in various ways (e.g., a selection of an output based on a minimization and/or maximization of an objective function, or a sum and/or averaging of the outputs) to generate an output of the random graph forest.

In these and other graph neural networks, the number of layers and the configuration of each layer of the graph neural network (e.g., the number of neurons and the activation function used by each neuron of each layer) can be referred to as hyperparameters of the graph neural network that are determined upon generation of the graph neural network. The weights of node synapses and/or the biases of the layers can be referred to as parameters of the graph neural network that are learned through a training or retraining process. Further explanation and/or examples of various concepts of other types of neural networks that can also apply to graph neural networks, and additional concepts that apply to other types of neural networks that can also be included in graph neural networks, are presented elsewhere in this disclosure and/or will be known to or appreciated by persons of ordinary skill in the art.

Unlike other types of neural networks, graph neural networks are configured to receive, process, generate, and/or transform one or more graph data sets. Some graph neural networks are configured to receive data representing and/or derived from a graph data set, such as an input vector that includes data representing one or more nodes of the graph (optionally including one or more node properties of one or more nodes), one or more edges of the graph (optionally including one or more edge properties of one or more edges), and/or one or more graph properties of the graph. Some graph neural networks are configured to receive an input vector comprising all of the data of a graph data set (e.g., all of the data representing all nodes, all edges, and the graph). Some graph neural networks are configured to receive an input vector comprising only a portion of the data of a graph data set (e.g., only a subset of the nodes of the graph and/or only a subset of the edges of the graph). For example, some graph data sets include a number of subgraphs, and the input vector to the graph neural network includes the data for all of the nodes and/or all of the edges included in one subgraph of the graph. The entire graph can be processed by processing (e.g., concurrently and/or consecutively) each subgraph and combining the output resulting from the processing of each subgraph. As another example, a graph data set representing a set of users of a social network may be processed by a graph neural network that receives, as input, a subset of nodes that correspond to the most influential users of the social network (e.g., those having more than a threshold number of social network connections) and a subset of edges that interconnect the nodes representing those users. Some graph neural networks are configured to receive, as input, data derived from a graph neural network. For example, a graph data set representing a social network may be processed by a graph neural network that receives, as input, data associated with messages exchanged among users of the social network, and provides, as output, an analysis of the messages. Some graph neural networks are configured to receive, as input, non-graph data (e.g., an input vector including coordinates of roads and/or cities in a geographic region) and generate graph data as output (e.g., a graph including odes that represent the cities, and edges that represent roads interconnecting the nodes representing the cities).

Some graph neural networks are configured to process input data as graph data. As an example, some graph neural networks are configured to receive, as input, data that represents each of one or more nodes of a graph data set and one or more edges that respectively interconnect two or more nodes of the graph data set. The graph neural network may process a state of each node and/or edge of the input graph data in order to generate an updated state of the node and/or edge. The term “message passing” refers to evaluating and updating the state of a node N or an edge E of a graph based on the states of one or more neighboring nodes N and/or connecting edges E. For example, for each node N1, the graph neural network may evaluate the state of node N1 and/or states of a set of nodes N that are connected to node N1 by at least one edge (e.g., a neighborhood of nodes that includes N1) and may determine an updated state of node N1 based on the state of the node N1 and/or the states of the neighboring nodes N. As another example, for each node N1, the graph neural network may evaluate the state of the node N1 and/or the states of a set of edges E that connect node N1 to one or more other nodes of the graph, and may determine an updated state of node N1 based on the state of the node N1 and/or the states of the edges E. As yet another example, for each edge E1 of the input graph, the graph neural network may evaluate a state of the edge E1 and/or the states of a set of nodes N of the graph that are connected to the edge E1 and may determine an updated state of edge E1 based on the state of the edge E1 and/or the states of the connected nodes N. As yet another example, for each edge E1 of the input graph that connects a set of nodes N of the graph, the graph neural network may evaluate the state of the edge E1 and the states of the set of edges E that are also connected at least one of the set of nodes N and may determine an updated state of edge E1 based on the state of the edge E1 and/or the states of the other edges. In these and other scenarios, each node N and/or each edge E is evaluated and updated based on a collection of “messages” corresponding to the states of neighboring nodes N and/or connecting edges E.

In some graph neural networks, each node N1 is updated based a neighborhood of size 1, including only on the states of the edges E that are directly connected to node N1 and/or the states of the other nodes N that are directly connected to node N1 by an edge. In some other graph neural networks, each node N1 is updated based a neighborhood of a size S greater than 1, including the states of other nodes N that are within S edge connections of node N1 and/or edges E that are connected to any such nodes N. In some graph neural networks, each edge E1 is updated based a neighborhood of size 1, including only on the states of the nodes N that edge E1 connects and/or the edges E that are also connected to the nodes N that edge E1 connects. In some other graph neural networks, each edge E1 is updated based a neighborhood of a size S greater than 1, including the states of other nodes N that are within S edge connections of node N1 and/or the set of edges E that are connected to any such nodes N. In some graph neural networks with a neighborhood of size greater than 1, one or more first layers of neurons process each node and/or edge based on the nodes and/or edges within a neighborhood of size 1; a second one or more following layers of neurons further process each node and/or edge based on the nodes and/or edges within a neighborhood of size 2; and so on. That is, the first one or more layers update the state of each node and/or edge based on the states of the directly connected nodes and/or edges, and each following one or more layers further updates the state of each node and/or edge additionally based on the states of indirectly connected nodes and/or edges that are one or more further connections.

In some graph neural networks, the states of nodes N and/or edges E are evaluated and updated concurrently (e.g., the graph neural network may evaluate the features relevant to each node N and/or each edge E to determine an update, and may do so for all nodes N and/or all edges E, before applying the updates to update the internal states of each node N and/or each edge E). In some graph neural networks, the states of nodes N and/or edges E are evaluated and updated consecutively (e.g., the graph neural network may evaluate the features relevant to a first node N1 and update the state of node N1 before evaluating the features relevant to a second node N2 and updating the state of node N2). In some graph neural networks, the states of the nodes N and/or the edges E are consecutively evaluated and updated according to a sequential order (e.g., the graph neural network first evaluates and updates a state of a first node N1 that is of a high priority, and then evaluates and updates a state of a first node N2 that is of a lower priority than N1). In some graph neural networks, a state of a node N2 is evaluated after updating a state of a node N1 and, further, based on the updated state of node N1. In some graph neural networks, a state of an edge E2 is evaluated after updating a state of an edge E1 and, further, based on the updated state of an edge E1. In some graph neural networks, the states of nodes N are concurrently evaluated and updated, and then the states of edges E are concurrently evaluated and updated concurrently. In some graph neural networks, the states of edges E are concurrently evaluated and updated, and then the states of nodes N are concurrently evaluated and updated concurrently. These variations in the order of updating the nodes N and/or edges E can be variously combined with the previously discussed variations in the processing of neighborhoods. For example, a graph neural network may include a first one or more layers that are configured to evaluate and concurrently update the states of all nodes and edges within a neighborhood of size 1, followed by a second one or more layers that are configured to evaluate and concurrently update the states of all nodes and edges within a neighborhood of size 2. Another graph neural network may a graph neural network may include a first one or more layers that are configured to evaluate and concurrently update the states of all nodes within a neighborhood of size 1, followed by a second one or more layers that are configured to evaluate and concurrently update the states of all nodes within a neighborhood of size 2, further followed by one or more layers that are configured to update the states of all edges within a neighborhood of size 1 or more.

Some graph neural networks are configured to evaluate and/or update one or more node properties of one or more nodes of a graph data set. For example, a graph representing a social network may include nodes that represent people, and a graph neural network may evaluate the nodes and/or edges of the graph to predict one or more node properties that correspond to attributes of the person, such as a type of the person, an age of the person, or an opinion of the person. Some graph neural networks are configured to evaluate and/or update one or more edge properties of one or more edges of a graph data set. Some graph neural networks are configured to evaluate and/or update one or more edge properties of one or more edges of a graph data set. For example, a graph representing a social network may include nodes that represent people and edges that represent relationships between people, and a graph neural network may evaluate the nodes and/or edges of the graph to predict one or more edge properties that correspond to attributes of a relationship among two or more people, such as a type of the relationship, a strength of a relationship, or a recency of the relationship. Some graph neural networks are configured to evaluate and/or update one or more graph properties of the graph data set. For example, a graph representing a social network may include nodes that represent people and edges that represent relationships between people, and a graph neural network may evaluate the nodes and/or edges of the graph to predict a feature of a social group to which all of the people belong, such as a common interest or a common demographic trait that is shared by at least many of the people of the social network.

Some graph neural networks are configured to generate graph data as output. The generated graph data may include one or more nodes (optionally including one or more node properties), one or more edges (optionally including one or more edge properties), and/or one or more graph properties. The generated graph data may be based on input graph data. Some graph neural networks may be configured to receive at least a portion of a graph data set as input, and may generate, as output, modified graph data. As an example, the input graph data set may include a number of nodes and a number of edges interconnecting the nodes, and in the output graph data set generated by the graph neural network, each of the nodes and/or edges of the graph may have been updated based on one or more nodes and/or one or more edges of the input graph data. For example, an input graph data set may represent a social network including a nodes representing people and edges representing relationships between people. A graph neural network may be configured to receive at least a portion of the input graph data set, and may output an adjusted graph data set, wherein a state at least one of the nodes and/or at least one of the edges is updated based on the processing of the input data set. For example, various edges representing relationships may be updated to include additional data (e.g., edge properties) to represent an updated relationship between two people represented by nodes. Various nodes may be updated with to include additional data (e.g., node properties) to represent updated information about corresponding people based on the relationships. Various graph properties of the at least a portion of the graph data set may be updated based on the updated edges and/or nodes, e.g., a new common interest that is shared among many of the people in the social network.

Some graph neural networks may be configured to output graph data that includes one or more newly discovered nodes based on the input graph data set. For example, an input graph data set representing travel events may include edges that include routes of travelers and nodes that represent locations of interest. A graph neural network may receive the input graph data set, and based on processing of the routes of the travelers, may output an updated graph data set that includes a new node that represents a new location of interest (e.g., a destination of a large number of recent travelers). The output of the graph neural network may include, for one or more new or existing nodes, one or more new or updated node properties (e.g., a classification of the location of interest based on the travel routes). Alternatively or additionally, some graph neural networks may be configured to output graph data that excludes one or more existing nodes of an input graph data set. For example, based on processing the input data set representing routes of travelers, a graph neural network may output an updated graph data set that excludes one of the nodes of the input graph data set representing a location that is no longer a location of interest (e.g., a destination that travelers no longer visit).

Some graph neural networks may be configured to output graph data that includes one or more newly discovered edges based on the input graph data set. For example, an input graph data set may represent a social network including nodes that represent people and edges that represent connections between people. A graph neural network may receive the input graph data set, and based on processing of the people and connections, may output an updated graph data set that includes a new connection between two people (e.g., a likely relationship based on shared traits and/or mutual relationships with a number of other people representing a social circle). The output of the graph neural network may include, for one or more new or existing edges, one or more new or updated edge properties (e.g., a classification of a relationship between two or more people). Alternatively or additionally, some graph neural networks may be configured to output graph data that excludes one or more existing edges of an input graph data set. For example, based on processing the input data set representing a social network, a graph neural network may output an updated graph data set that excludes one or more of the edges of the input data set representing a relationship that no longer exists (e.g., a lost connection based on a splitting of a social circle).

Some graph neural networks may output graph data that is based on data that does not represent an input graph data set. For example, a graph neural network may be configured to receive non-graph data, such as lists of travel routes of drivers, and may generate and output a graph data set including nodes that represent locations of interest and edges that interconnect the locations of interest. Conversely, some graph neural networks may receive input that includes at least a portion of a graph data set and that outputs non-graph data based on the input graph data. For example, a graph neural network may be configured to receive input including graph data, such as a graph of a social network including nodes that represent people and edges that represent connections, and to output non-graph data based on analyses of the input graph data, such as statistics about the people represented in the social network and activity occurring therein.

### Properties

Graph neural networks, including (without limitation) those described above, may be subject to various properties and/or considerations of design and/or operation. These considerations may affect their architecture, processing, implementation, deployment, efficiency, and/or performance.

As previously discussed, graph neural networks may include edges with varying directionality, such as undirected edges (e.g., edges that represent distances between pairs of nodes that represent cities in a graph that represents a region), unidirectional edges (e.g., edges that represent parent/child relationships among nodes that represent people in a graph that represents a genealogy or lineage), and/or multidirectional edges (e.g., bidirectional edges that represent bidirectional roads between nodes that represent cities in a graph that represents a region). In some graph data sets, all of the edges have a same directionality (e.g., all edges are undirected). A graph neural network can be configured to receive an input vector corresponding to the input data set and to process the edges according to the uniform directionality of the edges (e.g., processing undirected edges without regard to the order in which the nodes are represented as being connected to the edge). Other graph data sets may include edges with different directionality (e.g., in a graph that represents a region, edges can represent roads between nodes that represent cities, and each edge can be either unidirectional to represent a one-way road or bidirectional to represent a two-way road). A graph neural network can be configured to receive an input vector corresponding to the input data set and to process the edges according to the distinct directionality of each edge (e.g., processing a unidirectional edge in a different manner than a bidirectional edge). As one such example, the graph neural network can interpret a bidirectional edge connecting two nodes N1, N2 as a first unidirectional edge that connects node N1 to N2 and a second unidirectional edge that connected node N2 to node N1. The pair of unidirectional edges can share various edge properties and/or can be evaluated and/or updated in a same or similar manner (e.g., for a pair of unidirectional edges corresponding to a bidirectional road, the graph neural network can process data representing a weather condition in a same or similar manner to both unidirectional edges associated with the bidirectional road).

As previously discussed, some graph neural networks are configured to process nodes according to a “message passing” paradigm, in which the evaluation of each node N1 is based on the states and/or evaluations of other nodes within a neighborhood of the node N1 and/or the edges that connect the node N1 to other nodes in the neighborhood of the node N1. That is, the state of each node in the neighborhood of the node N1 and/or the state of each edge that connects N1 to other nodes of the neighborhood serves as a “message” that informs the evaluation and/or updating of the state of node N1 by the graph neural network. Alternatively or additionally, the evaluation of each edge E1 is based on the states and/or evaluations of other edges within a neighborhood of the edge E1. That is, the state of each node connected by edge E1, and, optionally, the states of other nodes connected to those nodes and/or other edges in such connections, serves as a “message” that informs the evaluation and/or updating of the state of edge E1 by the graph neural network. In each case, the size of the neighborhood can vary; for example, the graph neural network can evaluate each node according to a one-hop neighborhood or a multi-hop neighborhood. Graph neural networks that perform multi-hop neighborhood evaluation can include multiple layers, where a first one or more layers are configured to process a first hop between a node N1 and a one-hop neighborhood including its directly connected neighbors and/or directly connected edges, and a second one or more layers following the first one or more layers are configured to process a second hop between the nodes and/or edges of the one-hop neighborhood and additional nodes and/or edges that are directly connected to the nodes and/or edges of the one-hop neighborhood. In this manner, each node N1 is first evaluated and/or updated based on message passing among the one-hop neighborhood, and is then evaluated and/or updated based on additional messages within the two-hop neighborhood, etc. Other architectures of graph neural networks may perform multi-hop neighborhood evaluation in other ways, e.g., by processing individual clusters of nodes and/or edges to perform message passing among the nodes and/or edges of each cluster, and then performing additional message passing between clusters to update nodes and/or edges of each cluster based on the nodes and/or edges of one or more neighboring clusters.

In some scenarios, a graph may include nodes and/or edges that are stored, represented, and/or provided as input that is not subject to any particular order (e.g., nodes representing points in a line drawing may not have any node properties, and may therefore be represented in arbitrarily different orders in the input graph data set). In such scenarios, a multitude of semantically equivalent input graph data sets may be logically equivalent to one another. That is, a first representation of a graph may include the nodes and/or edges in a particular order, while a second representation of the same graph may include the same nodes and/or edges in a different order. While both representations of the graph are logically equivalent, the different ordering in which the nodes and/or edges are provided as input to the graph neural network may cause the graph neural network to provide different output. In other scenarios, a graph comprising a set of nodes and a set of interconnecting edges may be organized, stored, and/or represented in a particular order. For example, the nodes may be ordered according to a property of the nodes, and/or edges may be ordered according to a property of the edges (e.g., in a social network, nodes representing people may be ordered according to the alphabetical order of their names, and edges representing relationships may be ordered according to the alphabetical order of the names of the related people). In such scenarios, changes to the order and/or the selected subsets of graph data may result in different input data sets that represent the same or similar (e.g., logically equivalent) graphs. Due to the manner in which a graph neural network processes the input graph data set, logically equivalent input graph data sets may result in different and logically distinct output data.

In such scenarios, it may be undesirable for the graph neural network to generate different output for different but logically equivalent representations. That is, it may be desirable for the graph neural network to provide the same or equivalent output for different but logically equivalent representations of a graph. Graph neural networks that exhibit this property can be referred to as “permutation invariant,” that is, capable of providing output that does not vary across permutations in the representation of the input graph data set. A variety of techniques may be used to achieve, improve, and/or promote permutation invariance. Some such techniques involve changing representations of the input data set. For example, before processing an input graph data set, the graph neural network may reorder the input data set (e.g., by reordering the units of an input vector) such that nodes and edges are represented in a consistent order. As one such example, an input graph data set may include nodes that represent cities, and the input graph data set may include the nodes and/or edges in varying orders. Prior to processing the input graph data set, the graph neural network may reorder the nodes based on latitude and longitude coordinates of the cities, and the edges can similarly be reordered based on the latitude and longitude coordinates of the nodes connected by each edge. Thus, any representation of the graph including nodes that represent the same set of cities is processed in a similar manner. Similar reordering may involve various node properties and/or edge properties, including (without limitation) an alphabetic ordering of names in a graph including nodes that represent people, a chronological ordering of dates in a graph including nodes that represent events, a numeric ordering of content-based hashcodes in a graph including nodes that represent objects, and/or a numeric ordering of identifiers in a graph including nodes that possess unique numeric identifiers. Other techniques for achieving, improving, and/or promoting permutation invariance involve transforming an input graph data set into a different, permutation-invariant representation that is provided as input to and processed by the graph neural network. For example, a graph data set representing a two-dimensional image or a three-dimensional point cloud may include nodes that represent pixels and edges that represent spatial relationships (e.g., distances and/or orientations) between respective pairs of pixels of the image or respective pairs of points in the point cloud. Different orderings of the pixels and/or points may result in differently ordered, but logically equivalent, graph data sets for a particular image or point cloud. Instead of processing the graph data sets as input, a graph neural network may be configured to convert the input graph data set into a spectral representation, e.g., based on a spectral decomposition of a Laplacian L of the input graph data set. Instead of encoding information about individual pixels and/or points, the spectral representation instead encodes spectral components of the input graph data sets. The spectral components can be ordered in various ways (e.g., by frequency and/or polynomial order) to generate a permutation-invariant input vector, and the processing of the permutation-invariant input vector by a graph neural network may result in invariant (e.g., identical or at least similar) output of the graph neural network for various permutations of the input graph data set.

Alternatively or additionally, some techniques for achieving, improving, and/or promoting permutation invariance may relate to the structure of the graph neural network. For example, as an alternative or addition to reordering an input graph data set, a graph neural network may include one or more layers of neurons that process an input vector and generate permutation-invariant output. As one such example, a graph neural network may include a pooling layer that receives an input vector (e.g., an input vector corresponding to an input graph data set, and/or an input vector corresponding to an output of one or more previous layers of the graph neural network) and generates output that is pooled over the input, such as a minimum, maximum, or average of the units of the input. Because operations such as a minimum, maximum, and/or average over a data set are permutation-invariant mathematical operations, the graph neural network may therefore exhibit permutation-invariance of output based on the pooling operation for differently ordered but logically equivalent representations of a particular graph data set. As another such example, a graph neural network may include a filtering layer that receives an input vector (e.g., an input vector corresponding to an input graph data set, and/or an input vector corresponding to an output of one or more previous layers of the graph neural network) and generates output that is filtered based on certain permutation-invariant criteria. For example, in a graph representing a social network that includes nodes representing people, a layer of the graph neural network may filter the nodes to limit the input data set based on the top n nodes of the graph neural network that correspond to the most influential people in the social network. Such filtering may be based, e.g., on a count of the edges of each node (i.e., a count of the number of relationships of each person to other people of the social network), or a weighted calculation based on the influence of the nodes to which each node is related and/or the strength of each such relationship. Because such filtering operation are permutation-invariant logical operations, the graph neural network may therefore exhibit permutation-invariance of output based on the filtering operation for differently ordered but logically equivalent representations of the nodes (i.e., people) and edges (i.e., relationships) of the social network. As yet another example, some graph neural networks include an encoding or “bottleneck” layer, in which an output from N neurons of a preceding layer is received as input and processed by a following layer that includes fewer than N neurons. Due to the smaller number of neurons in the following layer, the volume of data that encodes features of the output of the preceding layer is compressed into a smaller volume of data that encodes features of the output of the following layer. This compression of features, based on learned parameters and training of the graph neural network to produce expected outputs, can cause the graph neural network to encode only more significant features of the processed data, and to discard less significant features of the processed data. The reduced-size output of the neurons of the following layer can be referred to as a latent space encoding of the input feature set. For example, whereas an input graph data set may include nodes that correspond to all pixels of an image of a cat, and an output of a previous layer of the graph neural network may include partially processed information about each node (i.e., each pixel) of the image of the cat, the output of the following layer of the graph neural network may include only features that correspond to visually significant features of the cat (e.g., features that correspond to the pixels that represent the distinctively shaped ears, eyes, nose, and mouth of the cat). Thus, the latent space encoding may reduce the processed input of the graph data set into a smaller encoding of nodes that represent significant visual features of the graph data set, and may exclude data about nodes that do not represent significant visual features of the graph data set. Many such graph neural networks include one or more “bottleneck” layers as one or more autoencoder layers, e.g., layers that automatically learn to generate latent space encodings of input data sets. As one such example, deep generative models may be used to generate output graph data that corresponds to various data types (e.g., images, text, video, scene graphs, or the like) based on an encoding, including an autoencoding, of an input such as a prompt or a random seed, Additional techniques for achieving or promoting permeation-invariance are presented elsewhere in this disclosure and/or will be known to or appreciated by persons of ordinary skill in the art.

In some scenarios, a graph data set may include a large number of nodes and/or a large number of edges. For example, a graph data set representing a social network may include thousands of nodes that represent people and millions of edges that represent relationships among the people. The size of the graph data set may result in an input vector that is very large (e.g., a very long input vector), and that might require a correspondingly large graph neural network to process (e.g., a graph neural network featuring millions of weights that connect the input graph data set to the nodes of a first layer of the graph neural network). The size of the input data set may result in large and perhaps prohibitive computational resources to receive and/or process the graph data set (e.g., large and costly storage and/or processing to store the input graph data set and/or the parameters and/or hyperparameters of the graph neural network, and/or a protracted delay in completing the processing of an input graph data set by the graph neural network). Further, the graph data set may exhibit properties of sparsity that cause a large portion of the input data set to be inconsequential. For example, a graph data set representing a social network may be encoded as a vector of N units respectively representing each node (i.e., each person) followed by a vector of N×N units that respectively represent a potential relationship between each node N1 and each node N2. Edges that represent a multidimensional mapping of connections between nodes (such as an N×N mapping of edges that represent possible connections between nodes) can be referred to as an adjacency matrix. However, in the social network, most person may have only a small number of relationships (i.e., far less than N-1 relationships with all other people of the social network). Thus, in the vector encoding of the input graph data set, a large majority of the N×N units that respectively represent potential relationships between each pair of nodes N1, N2 (i.e., the adjacency matrix) may be negative or empty (representing no relationship), and only a very small minority of the N×N units that respectively represent potential relationships between each pair of nodes N1, N2 may be positive or non-empty (representing a relationship). As another example, a graph data set representing a region may include N nodes representing cities and N×N edges representing possible roads between cities. However, if each city is only directly connected to a small number of neighboring cities, then a large majority of the N×N edges representing possible roads between cities (i.e., the adjacency matrix) may be negative or empty (representing no road connection), and only a very small minority of the N×N units that respectively represent potential roads between each pair of nodes N1, N2 may be positive or non-empty (representing an existing road). In such cases, the sparsity of an input vector representing the graph neural network may inefficiently consume computational resources (e.g., inefficiently applying storage and/or computation to large numbers of negative or empty units of the input vector) and/or may unproductively delay the completion of processing of the input graph data set.

Various techniques can be applied to reduce the sparsity of graph data sets and the processing of such graph data sets by graph neural networks. As a first example, the graph neural network can be pruned to reduce the number of nodes and/or edges included as an input data set (e.g., filtering the nodes of a graph neural network to a small cluster of densely related nodes, such as a small number of highly interrelated nodes that represent the members of a social circle in a social network). As a second example, the graph neural network can be encoded in a way that reduces sparsity. For example, rather than encoding the input graph data set as an adjacency matrix, the graph neural network may be configured to receive an encoding of the input graph data set as an adjacency list, i.e., as a list of edges that respectively connect two or more nodes of the graph. Due to encoding only information about existing edges, an adjacency list can eliminate or at least reduce the encoding of nonexistent edges. As a result, the size of the adjacency list may therefore be much smaller than a size of a corresponding adjacency matrix, and can therefore eliminate or at least reduce the sparsity of the input graph data set. The adjacency list can include edge properties of the edges of the graph data set. The adjacency list can be limited to a particular size (e.g., the top N most influential connections in a social network). The nodes of the input graph data set can be limited based on the edges included in the adjacency list (e.g., excluding any nodes that are not connected to at least one of the edges included in the adjacency list). As yet another example, rather than encoding an entire set of nodes and edges, a graph neural network can be represented as an encoding of the nodes and edges. For example, a graph data set may include nodes that represent pixels of an image and edges that represent spatial representations of the pixels. However, if large areas of the image are inconsequential (e.g., dark, empty, or not associated with any notable objects in a segmented image), then large portions of the nodes and/or edges would be inconsequential. Instead, the image can be reencoded as a frequency-domain representation as coefficients associated with respective frequencies of visual features within the image. The frequency-domain representation may present greater information density than the adjacency matrix of pixels, and therefore may present an input to the graph neural network that encodes the visual features of the input graph data set with reduced sparsity.

Other techniques for eliminating or reducing sparsity, and therefore increasing efficiency, involve the architecture of the graph neural network. For example, the input graph data set may encode edges as an adjacency matrix, and a first layer of the graph neural network may reencode the edges of the input graph data set as an adjacency list for further processing by the graph neural network. As another example, the graph neural network may include a first one or more layers that is configured to process an entirety or at least a large portion of the nodes and/or edges of an input graph data set, followed by a filtering layer that is configured to limit an output of the first one or more layers of the graph neural network. For example, in a graph data set that includes nodes that represent people and edges that represent connections, a first one or more layers may process all of the nodes and/or edges, and a filtering layer can limit the further processing of the output of the first one or more layers to the nodes and/or edges for which the outputs of the first one or more layers are above a threshold (e.g., an influence and/or relationship significance threshold). As still another example, the graph neural network may receive a sparse graph input data set but may only process a portion of the input graph data set (e.g., one or more random sampling of subsets of nodes and/or edges). In some cases, the graph neural network may compare results of the processing of subsets of the input graph data set (e.g., randomly sampled subsets of the nodes and/or edges) and may aggregate such results until the results appear to converge within a confidence threshold. In this manner, the graph neural network may generate an acceptable output within the confidence threshold while avoiding processing an entirety of the sparse input graph data set. Many such techniques for eliminating and/or reducing sparsity are presented elsewhere in this disclosure and/or will be known to or appreciated by persons of ordinary skill in the art.

### Input, Processing, and Output

Graph data sets may represent a variety of data types, including (without limitation) maps of geographic regions, including nodes representing cities and edges representing roads that connect two or more cities; social networks, including nodes representing people and edges representing relationships between two or more people; communication networks, including nodes representing people or devices and edges representing communication connections between the nodes or edges; economies, including nodes representing companies and edges representing transactions between two or more companies; molecules, including nodes representing atoms and edges representing bonds between two or more atoms; collections of events, including nodes representing individual events and edges representing causal relationships among two or more events; and periods of time, including nodes representing events and edges representing chronological periods among two or more events. Graph data sets may also be represent data types, such as passages of text, including nodes representing words and edges representing relationships among two or more words; images, including nodes representing pixels and edges representing spatial relationships among two or more pixels; object graphs, including nodes representing objects and edges representing dependencies among two or more objects; and three-dimensional spatial maps, including nodes representing three-dimensional objects and edges representing spatial relationships among two or more of the three-dimensional objects. Some graph data sets may include two or more subgraphs. In some such graph data sets, each node and/or each edge is exclusively included in one subgraph. In some other graph data sets, at least one node and/or at least one edge may be included in two or more subgraphs, or in zero subgraphs. Some graph data sets are associated with non-graph data that is also included as input to a graph neural network. For example, a graph neural network that evaluates traffic patterns within a geographic region may receive, as input, both an input graph data set that includes nodes that represent cities and edges that represent roads interconnecting the cities, and also non-graph data representing traffic and/or weather features within the geographic region (e.g., traffic volume estimates and current or forecasted weather conditions that affect the traffic patterns).

As another example, some graph data sets may include an indication of zero or more cycles occurring among the nodes and/or edges of the graph data set. For example, a directed and/or undirected graph data set may include an indication that a particular cycle exists within the graph and includes a particular subset of nodes and/or edges. Alternatively, a directed and/or undirected graph data set may include an indication that the graph is acyclic and does not include any cycles. A graph neural network may be configured to receive, as input, and process a graph data set that includes an indication of zero or more cycles.

As another example, some graph data sets may include nodes for which the edges provide spatial dimensions. As a first example, in a graph representing a geographic region, nodes that represent cities are related by edges that represent distances, wherein the nodes and interrelated edges can form a spatial map of the geographic region. As a second example, in a graph representing a molecule, nodes that represent atoms are related by edges that represent chemical bonds between the atoms, and the arrangement of atoms by the bonds forms a three-dimensional molecular structure. In some such scenarios, the spatial relationships are well-defined by the nodes and edges. In other such scenarios, the spatial relationships can be inferred based on semantic relationships among the nodes and/or edges of the graph data set. For example, in a graph representing a language, nodes that represent words are related by edges that represent semantic relatedness of the words within a high-dimensional language space. A language model can generate an embedding of the words of the language in a multidimensional embedding space, wherein nodes that are close together within the embedding space represent synonyms, closely related concepts, or words that frequently appear together in certain contexts, whereas nodes that are not close together within the embedding space represent unrelated concepts or words that do not commonly appear together in various contexts. A variety of graph embedding models may be applied to this task, including (without limitation) DeepWalk, node2vec, line, and/or GraphSAGE. A graph neural network can be configured to receive, as input, an embedding of a graph data set instead of representations of the nodes and/or edges of the graph data set. Alternatively, a graph neural network can be configured to receive an input graph data set including representations of the nodes and/or edges of the graph data set, generate an embedding based on the input graph data set, and apply further processing to the embedding instead of to the input graph data set. A graph neural network that is configured to process an embedding instead of an input graph data set may exhibit greater permutation invariance (e.g., due to the semantic associations represented by the embedding) and/or increased efficiency due to reduced sparsity of the input.

Some graph data sets include representations of each of one or more nodes and each of one or more edges. Some graph neural networks are configured to receive and process such representations of graph neural networks. For example, the graph neural network may be configured to receive an input vector including an array of data representing each of the one or more nodes followed by an array of data representing each of the one or more edges, either as an adjacency matrix of possible edges between pairs of nodes or an adjacency list of existing edges. The input vector may encode the nodes and/or edges in a particular order (e.g., a priority order of nodes and/or a weight order of edges) or in an unordered manner. Alternatively or additionally, the graph data set may include and/or encode other types of information about each of one or more nodes and/or each of one or more edges of the graph data set. For example, the graph may include a hierarchical organization of nodes and/or edges relative to one another and/or to a fixed reference point. The graph neural network may be configured to receive and process an input graph data set that includes an indication of the arrangement of one or more nodes and/or one or more edges in the hierarchical organization.

As another example, a graph may include an indication of a centrality of one or more nodes and/or edges within the graph (e.g., a graph of a social network including nodes that are ranked based on a centrality of each node to a cluster). The graph neural network may be configured to receive and process an input graph data set that includes an indication of a centrality of one or more nodes and/or one or more edges in the graph.

As another example, a graph may include an indication of a degree of connectivity of one or more nodes and/or edges within the graph (e.g., a graph of a social network including nodes that are ranked according to a count of other nodes to which each node is connected by one or more edges, and/or a degree of significance of a relationship represented by an edge based on the nature of the relationship and/or the degrees of the nodes connected by the edge). The graph neural network may be configured to receive and process an input graph data set that includes an indication of a degree of one or more nodes and/or one or more edges in the graph.

As another example, a graph may include an indication of one or more clusters occurring within the graph. For example, a graph may include a result of a clustering analysis of the graph, e.g., a determination of k clusters within the graph and an identification of the nodes and/or edges that are included in each cluster. The clusters may be determined by a k-means clustering analysis, a Gaussian mixture model of with variable numbers of clusters and variable Gaussian orders, or the like. A graph may include a clustering coefficient of one or more nodes and/or one or more edges (e.g., a measurement of a degree to which at least some of the nodes and/or edges of a subgraph of the graph are clustered based on similarity and/or activity). The graph neural network may be configured to receive and process an input graph data set that includes an indication of a clustering coefficient of one or more nodes and/or one or more edges in the graph or a subgraph thereof.

As another example, a graph may include an indication of a graphlet degree vector that indicates a graphlet that is represented one or more times in the graph. For example, in a graph representing atoms in a regular structure such as a crystal, the graph may include a graphlet degree vector that indicates and/or describes a graphlet representing a recurring atomic structure, and an encoding of the regular structure that indicates each of one or more occurrences of a graphlet, including a location and/or orientation, and/or a count of occurrences of the graphlet. The graph neural network may be configured to receive and process an input graph data set that includes a graphlet degree vector, and, optionally, features of one or more occurrences of a graphlet in the graph and/or a count of the occurrences of the graphlet in the graph.

As another example, a graph may include an indication of one or more paths and/or traversals of one or more nodes and/or one or more edges of the graph, optionally including additional details associated with a path or traversal such as a popularity, frequency, length, difficulty, cost, or the like. For example, in a graph representing a spatial arrangement of nodes, the graph may include a path or traversal of edges that connect a first node to a second node through zero or more other nodes, as well as properties of the path or traversal such as a total length, distance, time, and/or cost. The graph neural network may be configured to receive and process an input graph data set that includes additional details associated with one or more paths or traversals, including an indication (e.g., a list) of the associated nodes and/or edges and a list of one or more properties of the path and/or traversal.

As another example, a graph may include an indication of metrics or properties that relate one or more nodes and/or one or more edges. For example, in a graph including a spatial arrangement of nodes, the graph may include an indication of a shortest distance between two nodes and/or an indication of a set of nodes and/or edges that are common to two nodes. As another example, a graph representing a network of communicating devices may include a routing table of one or more routes that respectively indicate, for a particular node and a particular edge connected to the node, a list of other nodes and/or edges that can be efficiently reached by traversing based on the particular edge. As yet another example, in a graph representing a social network including nodes that represent people, the graph may indicate, for at least one pair of nodes, a measurement of similarity of the nodes based on their node properties, edges, locations in the social network, connections to other nodes, or the like (e.g., a Katz index of node similarity) and/or, for at least one pair of edges, a measurement of similarity of the edges based on their edge properties, connected nodes, locations in the social network, or the like (e.g., a Katz index of edge similarity). The graph neural network may be configured to receive and process an input graph data set that includes one or more metrics or properties that relate one or more nodes and/or one or more edges (e.g., a routing table of routes within the graph, and/or a Katz index that indicates a measurement of similarity among at least two nodes and/or at least two edges).

As another example, a graph may include an indication of various graph properties of the graph (e.g., a graph size, graph density, graph interconnectivity, graph chronological period, graph classification, a count of subgraphs within the graph, or the like). For example, in a graph including two or more subgraphs (e.g., a social network including two or more social circles), the graph data set may include a measurement of a similarity of each subset of at least two subgraphs of the graph. The measurement of the similarity may be determined based on one or more graph kernel methods (e.g., a Gaussian radial basis function that can be applied to the graph to identify one or more clusters of similar nodes that comprise a subgraph). As another example, a graph may include a measurement of similarity with respect to another graph (e.g., an indication of whether a particular social network graph resembles other social network graphs that have been classified as representing a genealogy or lineage, a set of friendships, and/or a set of professional relationships). The graph neural network may be configured to receive and process an input graph data set that includes measurements determined by one or more graph properties (e.g., one or more measurements of similarity of one or more nodes, edges, and/or subgraphs, and/or a measurement of similarity of the graph to other graphs). Further explanation and/or examples of various graph data sets that may be provided as input to graph neural networks are presented elsewhere in this disclosure and/or will be known to or appreciated by persons of ordinary skill in the art.

Graph neural networks may be configured to perform various types of processing over such graph data sets. As previously discussed, a graph neural network can be organized as a series of layers, each of which can include one or more nodes that receive input, apply an activation function, and generate output. The output of each node of a first layer can be multiplied by a weight of a connection between the node and a node of a second layer, and then added to a bias associated with the first layer, to generate an input to the node of the second layer. The graph neural network can include various additional layers that perform other types of processing, including (without limitation) pooling, filtering, and/or latent space encoding operations, memory or stateful features, and recurrent and/or reentrant processing.

Some graph neural networks may perform label propagation among the nodes and/or edges of a graph data set. For example, in an input graph data set, one or more nodes and/or one or more edges may be associated with one or more labels of a label set, while one or more other nodes and/or one or more other edges may not be associated with any labels. A graph neural network may apply a label propagation algorithm (LPA) to assign labels to one or more unlabeled nodes and/or one or more unlabeled edges. For example, the graph neural network may assign a label to an unlabeled node based on labels associated with one or more edges connected to the node, and/or with one or more other nodes that are connected to the node by the one or more edges. The graph neural network may assign a label to an unlabeled edge based on labels associated with one or more nodes connected by the edge, and/or with one or more other edges that are also connected to the nodes connected by the edge. Some graph neural networks may perform label propagation based on a voting, consensus, weighting, and/or scoring determination. For example, a graph neural network may be unable to perform a classification of an unlabeled node and/or unlabeled edge based solely on the node properties and/or edge properties, but may be able to perform the classification based on a further consideration of the labels associated with other nodes and/or edges within a neighborhood of the unlabeled node and/or unlabeled edge.

Some graph neural sets may perform a scoring and/or ranking of nodes and/or edges of a graph data set. As an example, in a graph data set that represents the World Wide Web and that includes nodes that represent web pages and directed edges that represent hyperlinks of linking web pages to linked web pages, a graph neural network may determine one or more scores of each node (i.e., each web page) based on the scores of other nodes that hyperlink to the node. Each score may further be based on the scores of the other nodes that include a directed edge to this node (e.g., the scores of other web pages that hyperlink to this page). Additionally, each score associated with a node may represent a weight of an association between the web page and a particular topic (e.g., a particular topic or keyword that is associated with the web page, hyperlinks, and/or other pages that hyperlink to this web page). In some cases, the scores may be personalized based on the activities of a particular user (e.g., based on the hyperlinks from pages that the user frequently visits). A search engine may use the scores as rankings in order to generate search results for web searches including various topics or keywords (e.g., in response to a web search for a particular search term, present search results that correspond to the nodes with the highest scores associated with the search term, and present the search results in ranked order based on the scores). As another example, for a graph data set representing a social network, a graph neural network may generate a reputation score for each node based on other nodes that are associated with the node and the reputation scores of such other nodes. The scores of the nodes may be used to recommend new connections in the social network (e.g., recommending a first person connect with a second person, based on a high reputation score of the second person by people who are closely associated with the first person).

Some graph neural networks may perform a clustering analysis of the nodes and/or edges of a graph data set. As a first example, in a graph data set representing a social network, a graph neural network may perform a clustering analysis of the nodes representing the people of the social network, based on edges representing relationships among two or more nodes, in order to identify one or more clusters that represent social circles of highly interconnected people within the social network. Based on this clustering analysis, the graph neural network may partition the social network into subgraphs that respectively represent social circles, and may perform further, finer-grained evaluation of each social circle and the people represented by the nodes in each subgraph. As a second example, in a graph data set representing a social network, a graph neural network may perform a clustering analysis of the edges representing the relationships among people of the social network, in order to identify one or more clusters that represent different types of relationships, such as familial relationships, friendships, and professional relationships. Based on this clustering analysis, the graph neural network may partition the social network into subgraphs that respectively represent different types of social networks, and may perform further analysis of relationships among two or more individuals based on the type of relationship associated with the subgraph to which the relationship belongs. In these and other scenarios, in order to perform clustering analysis, a graph neural network may utilize a variety of clustering algorithms. As one such example, a graph neural network may apply spectral clustering techniques, wherein a similarity matrix that represents similarities among nodes and/or edges is evaluated to identify eigenvalues that indicate significant similarity relationships. Based on the similarity matrix, the graph neural network may perform a dimensionality reduction of the graph data set (e.g., reducing the features of the nodes and/or edges that are evaluated to determine clusters in order to focus on features that are highly correlated with and/or indicative of significant similarities). Dimensionality reduction of the graph data set based on the similarity matrix may enable the graph neural network to determine clusters more efficiently and/or rapidly, e.g., by reducing a high-dimensionality graph data set (wherein each node and/or edge is characterized by a multitude of node properties and/or edge properties) into a lower-dimensionality graph data set of a subset of features that are highly correlated with and/or indicative of similarity and clustering.

Some graph neural networks may perform a centrality determination among nodes and/or edges of a graph data set. For example, for a graph data set representing a social network, a graph neural network may evaluate the graph data set to identify a subset of nodes based on a centrality among the edges representing the connections of the social network, e.g., people who are at the center of each of one or more social circles within the social network. Alternatively or additionally, some graph neural networks may perform a “betweenness” determination among the nodes and/or edges of the graph data set. For example, a node may be considered to be “between” two clusters of nodes, such as a member of two or more clusters representing two or more social circles. Such “between” nodes may represent a communication bridge that conducts information between clusters (e.g., a person who can convey ideas and/or influence from a first social circle to a second social circle and vice versa). Some such graph neural networks may perform “betweenness” determinations based on a betweenness centrality measurement, e.g., based on a measurement of a shortest path between all pairs of nodes in the graph data set. As another example, a graph data set may represent a collection of text documents, wherein each node represents a document and each edge represents a relationship between documents (e.g., a unidirectional or bidirectional citation between a first document and a second document). A graph neural network can perform a centrality determination and/or a betweenness determination to determine significant documents within the collection (e.g., a document that is heavily cited by one or more clusters of other documents, and/or a document that includes ideas or associations between the documents of a first cluster and the documents of a second cluster).

Some graph neural networks may perform analyses of structures occurring within a graph neural network. As an example, for a graph data set that represents a social network, a graph neural network may determine a notable sequence of relationships, such as a first relationship between node N1 and node N2 based on a shared interest, a second relationship between node N2 and node N3 based on the same shared interest, and a third relationship between node N3 and node N4 based on the same shared interest. Based on this sequence or chain of relationships, the graph neural network may recommend to a person represented by node N1 some further relationships with the people represented by nodes N3 and N4, due to the combination of shared interests and mutual relationships. In some such cases, a graph neural network may perform such structural analysis based on a traversal algorithm that traverses a sequence of nodes connected by one or more edges, and/or that traverses a sequence of edges connected by one or more nodes. As an example, a graph neural network may perform a random walk within the graph data set, such as starting with a first node (e.g., a first person of a social network) and following a limited set of edges that connect the first node to other nodes. In some cases, the traversal may be random (e.g., traversing from a node based on a random selection among the edges that connect the node to other nodes). In some other cases, the traversal may be weighted (e.g., each edge may include an edge property including a weight that represents a strength of a relationship among two or more nodes, and the traversal may be based on a weighted random selection that preferentially selects higher-weighted connections over lower-weighted connections). In some cases, the traversal can include a restart probability, e.g., a probability of retrying the traversal beginning with the original node or another node, based on a score such as a distance of the traversal with respect to the original node. In these and other cases, the results of a random walk can be used in further analyses and/or activities of the graph neural network (e.g., presenting recommendations for new social connections among the nodes of a social network).

Some graph neural networks may perform an analysis of a graph data set based on an attention model. For example, in a social network, the influence of a particular person P1 may not be determined by the connectedness of person P1 to other people in the social network, but based on a perception of person P1 by other people of the social network as being knowledgeable, skilled, influential, or the like. Thus, a graph neural network may be configured to evaluate a graph data set representing a social network in which nodes represent people and edges represent relationships, but may be unable to determine influence based only on graph concepts such as connectedness of the nodes based on the edges. Rather, the graph neural network might model influence as an attention of each node (i.e., a second person P2 of the social network) upon each other node (e.g., person P1 of the social network). Thus, a particular opinion of person P2 of the social network may depend not only on the connections of person P2 to other people of the social network (including person P1), but also upon the attention that person P2 accords to such other people of the social network (including person P1). That is, even though person P2 is closely connected to certain people of the social network by various edges, the opinion of person P2 may be heavily shaped by person P1 and other people to whom person P2 is only indirectly connected in the social network. As a second such example, in a graph data set that represents traffic flow within a region, an edge E1 (e.g., a first road) may be directly connected to other edges of the graph data set, but an edge property of the edge E1 (e.g., a traffic volume and/or congestion of the road) may be impacted more heavily by edge properties of other edges to which edge E1 is not directly connected (e.g., roads in other parts of the geographic region for which traffic volume and/or congestion is highly determinative of the traffic volume and/or congestion of this road). Thus, in order to predict and/or estimate a traffic volume and/or congestion of a particular road, a graph neural network may evaluate not only the traffic volume and/or congestion of other roads that are directly connected to the particular road, but also other roads for which traffic volume and/or congestion is highly determinative of corresponding conditions of this road. In these and other scenarios, a graph neural network may evaluate a graph data set based on an attention model, in which analyses and updates of the state of nodes and/or edges of the graph data set are based, at least in part, on an attention of each node and/or edge upon other nodes and/or edges of the graph data set. For example, the graph neural network may include an attention layer that determines, for a particular node and/or edge of an input graph data set, which other nodes and/or edges of the input graph data set are likely to be relevant to determining an updated state of the particular node and/or edge. Various attention models may be used by such graph neural networks, including multi-head attention models in which each node and/or edge is related to a plurality of other nodes and/or other edges with varying weighted attention values (e.g., by each of a plurality of attention layers). Multi-head attention models can allow a graph neural network to consider the influences upon a particular node and/or edge of a plurality of other nodes and/or edges, which may (or may not) be further related to one another by the graph structure and/or attention. Based on the attention model and the attention layers included in the graph neural network, the graph neural network can perform a more sophisticated graph analysis that is based on more than the structural relationships of the graph.

Some graph neural networks may be configured to process a graph data set in order to determine, and optionally output, various types of data (e.g., measurements, calculations, inferences, explanations, or the like) that relate to one or more nodes, one or more edges, and/or one or more subgraphs of the input graph data set and/or to the input data graph set as a whole. Some graph neural networks are configured to generate, and optionally output, various types of representations of graph neural networks. For example, the graph neural network may be configured to determine, and optionally output, an output vector including an array of data representing each of the one or more nodes followed by an array of data representing each of the one or more edges, either as an adjacency matrix of possible edges between pairs of nodes or an adjacency list of existing edges. The output vector may encode the nodes and/or edges in a particular order (e.g., a priority order of nodes and/or a weight order of edges, or corresponding to a corresponding order of the nodes and/or edges in the input graph data set) or in an unordered manner. Alternatively or additionally, the graph neural network may be configured to determine, and optionally output, other types of information about each of one or more nodes and/or each of one or more edges of the graph data set. For example, the graph neural network may be configured to determine, and optionally output, a hierarchical organization of nodes and/or edges relative to one another and/or to a fixed reference point. Alternatively or additionally, the graph neural network may be configured to determine, and optionally output, an output graph data set that includes an indication of the arrangement of one or more nodes and/or one or more edges in the hierarchical organization.

As another example, a graph neural network may be configured to determine, and optionally output, an indication of a centrality of one or more nodes and/or edges within the input graph data set (e.g., a graph of a social network including nodes that are ranked based on a centrality of each node to a cluster). Alternatively or additionally, the graph neural network may be configured to determine, and optionally output, an output graph data set that includes an indication of a centrality of one or more nodes and/or one or more edges in the graph.

As another example, a graph neural network may be configured to determine, and optionally output, an indication of a degree of connectivity of one or more nodes and/or edges of an input graph data set (e.g., a graph of a social network including nodes that are ranked according to a count of other nodes to which each node is connected by one or more edges, and/or a degree of significance of a relationship represented by an edge based on the nature of the relationship and/or the degrees of the nodes connected by the edge). Alternatively or additionally, the graph neural network may be configured to determine, and optionally output, an output graph data set that includes an indication of a degree of one or more nodes and/or one or more edges in the output graph data set.

As another example, a graph neural network may be configured to detect, identify, and/or analyze one or more clusters occurring within an input graph data set. For example, a graph neural network may be configured to perform a clustering analysis of an input graph data set to determine, and optionally output, a determination of k clusters within the input graph data set and an identification of the nodes and/or edges that are included in each cluster. The graph neural network may be configured to determine clusters based on a k-means clustering analysis, a Gaussian mixture model of with variable numbers of clusters and variable Gaussian orders, or the like. The graph neural network may be configured to determine, and optionally output, an indication of a clustering coefficient of one or more nodes and/or one or more edges of an input graph data set (e.g., a measurement of a degree to which at least some of the nodes and/or edges of a subgraph of the graph are clustered based on similarity and/or activity). Alternatively or additionally, the graph neural network may be configured to determine, and optionally output, an output graph data set that includes an indication of one or more clusters including one or more nodes and/or one or more edges in the output graph data set or a subgraph thereof (e.g., a result of a k¬-means clustering analysis of an output graph data set, a Gaussian mixture model of an output graph data set, and/or one or more clustering coefficients of an output graph data set).

As another example, a graph neural network may be configured to determine, and optionally output, an indication of a graphlet degree vector that indicates a graphlet that is represented one or more times in an input graph data set. For example, for a graph representing atoms in a regular structure such as a crystal, the graph neural network may be configured to determine, and optionally output, a graphlet degree vector that indicates and/or describes a graphlet representing a recurring atomic structure, and an encoding of the regular structure that indicates each of one or more occurrences of a graphlet, including a location and/or orientation, and/or a count of occurrences of the graphlet in the input graph data set. Alternatively or additionally, the graph neural network may be configured to determine, and optionally output, an output graph data set that includes a graphlet degree vector, and, optionally, features of one or more occurrences of a graphlet in the output graph data set and/or a count of the occurrences of the graphlet in the output graph data set.

As another example, a graph neural network may be configured to determine, and optionally output, an indication of one or more paths and/or traversals of one or more nodes and/or one or more edges of the input graph data set, optionally including additional details associated with a path or traversal such as a popularity, frequency, length, difficulty, cost, or the like. For example, for an input graph data set representing a spatial arrangement of nodes, the graph neural network may be configured to determine, and optionally output, a path or traversal of edges that connect a first node to a second node through zero or more other nodes of the input graph data set, as well as properties of the path or traversal such as a total length, distance, time, and/or cost. Alternatively or additionally, the graph neural network may be configured to determine, and optionally output, an output graph data set that includes additional details associated with one or more paths or traversals, including an indication (e.g., a list) of the associated nodes and/or edges of the output graph data set and a list of one or more properties of each such path and/or traversal.

As another example, a graph neural network may be configured to determine, and optionally output, an indication of metrics or properties that relate one or more nodes and/or one or more edges of an input graph data set. For example, for an input graph data set including a spatial arrangement of nodes, the graph neural network may be configured to determine, and optionally output, an indication of a shortest distance between two nodes and/or an indication of a set of nodes and/or edges that are common to two nodes of the input graph data set. As another example, for an input graph data set representing a network of communicating devices, the graph neural network may be configured to determine, and optionally output, a routing table of one or more routes that respectively indicate, for a particular node of the input graph data set and a particular edge connected to the node, a list of other nodes and/or edges of the input graph data set that can be efficiently reached by traversing based on the particular edge. As yet another example, for an input graph data set representing a social network including nodes that represent people, the graph neural network may be configured to determine, and optionally output, an indication for at least one pair of nodes of a measurement of similarity of the nodes of the input graph data set based on their node properties, edges, locations in the social network, connections to other nodes, or the like (e.g., a Katz index of node similarity) and/or, for at least one pair of edges of the input graph data set, a measurement of similarity of the edges based on their edge properties, connected nodes, locations in the social network, or the like (e.g., a Katz index of edge similarity). Alternatively or additionally, the graph neural network may be configured to determine, and optionally output, an output graph data set that includes one or more metrics or properties that relate one or more nodes and/or one or more edges (e.g., a routing table of routes within the graph, and/or a Katz index that indicates a measurement of similarity among at least two nodes and/or at least two edges).

As another example, a graph neural network may be configured to determine, and optionally output, an indication of various graph properties of an input graph data set (e.g., a graph size, graph density, graph interconnectivity, graph chronological period, graph classification, a count of subgraphs within the graph, or the like). For example, for an input graph data set including two or more subgraphs (e.g., a social network including two or more social circles), the graph neural network may be configured to determine, and optionally output, a measurement of a similarity of each subset of at least two subgraphs of the input graph data set. The measurement of the similarity may be determined based on one or more graph kernel methods (e.g., a Gaussian radial basis function that can be applied to the input graph data set to identify one or more clusters of similar nodes that comprise a subgraph). As another example, a graph neural network may be configured to determine, and optionally output, a measurement of similarity of an input graph data set with respect to another graph data set (e.g., an indication of whether a particular social network graph resembles other social network graphs that have been classified as representing a genealogy or lineage, a set of friendships, and/or a set of professional relationships). Alternatively or additionally, the graph neural network may be configured to determine, and optionally output, an output graph data set that includes measurements determined by one or more graph properties of an output graph data set (e.g., one or more measurements of similarity of one or more nodes, edges, and/or subgraphs, and/or a measurement of similarity of the output graph data set to the input graph data set and/or other graph data sets). Further explanation and/or examples of various types of processing that graph neural networks can determine, and optionally output, for various input graph data sets and/or output graph data sets are presented elsewhere in this disclosure and/or will be known to or appreciated by persons of ordinary skill in the art.

Graph neural networks may be configured to generate various forms of output that correspond to various tasks. For example, graph neural networks can generate output that represents node-level predictions that relate to one or more nodes of an input graph data set. The node-level predictions can include a discovery of a new node that was not included in the input graph data set. For example, in a graph data set including edges that represent travel of individuals in a region, the nodes can represent points of interest, and the graph neural network can discover a new node that corresponds to a new point of interest. The node-level predictions can include an exclusion of a node that is included in the input graph data set. For example, in a graph data set including edges that represent travel of individuals in a region, the nodes can represent points of interest, and the graph neural network can exclude an existing node that no longer represents a point of interest. The node-level predictions can include a classification of a node that is included in the input graph data set, or of a newly discovered node that was not included in the input graph data set (e.g., a classification of the node as being of a node type selected from a set of node types, as being associated with one or more labels of a classification label set, and/or as belonging to zero or more subgraphs of the graph data set). For example, in a graph data set representing locations within a geographic region, the graph neural network can generate a prediction of a classification of a location of interest as one or more particular types of locations of interest (e.g., a source of food, a source of fuel, a lodging location, and/or a tourist destination). The node-level predictions can include an identification of a node from among the nodes of the input graph data set based on various features, or of a newly discovered node. For example, in a graph data set representing a social network and including nodes that represent people, the graph neural network can identify a particular node that corresponds to a particular person, such as an influential person of the social network. The node-level predictions can include a determination and/or updating of one or more node properties of one or more existing and/or newly discovered nodes, such as a prediction of a demographic feature, opinion, or interest of a node representing a person in a social network.

As another example, graph neural networks can generate output that represents edge-level predictions that relate to one or more edges of an input graph data set. The edge-level predictions can include a discovery of a new edge that was not included in the input graph data set. For example, in a graph data set representing a social network that includes nodes that represent people, a graph neural network can output a prediction (e.g., a recommendation) of a relationship between two nodes that correspond to two people in a small social circle of highly interconnected people. The node-level predictions can include an exclusion of a node that is included in the input graph data set. For example, in a graph data set representing a social network that includes nodes that represent people, a graph neural network can output a prediction of a no-longer-existing edge that corresponds to a relationship that no longer exists (e.g., a lost connection based on a splitting of a social circle). The edge-level predictions can include a classification of an edge that is included in the input graph data set, or of a newly discovered edge that was not included in the input graph data set (e.g., a classification of an edge as being a of an edge type selected from a set of edge types, as being associated with one or more labels of a classification label set, and/or as belonging to zero or more subgraphs of the graph data set). For example, in a graph data set representing a social network, a graph neural network can generate a predicted classification of an edge as representing a relationship between two people as of one or more relationship types (e.g., a familial relationship, a friendship, or a professional relationship). The edge-level predictions can include an identification of an edge from among the edges of the input graph data set based on various features, or of a newly discovered edge. For example, in a graph data set representing a social network and including edges that represent relationships, the graph neural network can identify a particular edge that corresponds to a potential relationship to be recommended to the associated people, such as two people of the social network who are not yet connected but who share common personal or professional interests. The edge-level predictions can include a determination and/or updating of one or more edge properties of one or more existing and/or newly discovered edges, such as a prediction of a demographic feature, opinion, or interest that serves as the basis for a relationship between two people of the social network.

As another example, graph neural networks can generate output that represents graph-level predictions that relate to one or more graph properties of the input graph data set. The graph-level predictions can include a discovery of a new graph property that was not associated with the input graph data set. For example, in a graph data set representing a social network that includes nodes that represent people and edges that represent relationships, a graph neural network can output a prediction of a demographic trait, opinion, or interest that is common or popular among the people of the social network, or a relationship behavior that is exhibited in the relationships among the people of the social network. The graph-level predictions can include an exclusion of a graph property that was associated with the input graph data set. For example, in a graph data set representing a social network that includes a graph property based on a shared interest, a graph neural network can output a prediction that the interest no longer appears to be common and/or popular among the people of the social network, or of a relationship behavior that is no longer exhibited among the relationships of the people of the social network. The graph-level predictions can include a classification of the input graph data set (e.g., a classification of the graph data set, or at least a portion thereof, as being associated with one or more labels of a classification label set). For example, in a graph data set representing a social network, a graph neural network can generate a predicted classification of the graph as representing a familial social network, a friendship social network, and/or a professional social network. The graph-level predictions can include an identification of one or more subgraphs of the graph based on common features of the nodes and/or edges included in the subgraph. For example, in a graph data set representing a social network, the graph neural network can subgraphs that correspond to various social circles of highly interconnected people. The graph-level predictions can include a determination and/or updating of one or more graph properties of the graph, such as an updating of a frequency of communication and/or a strength of relationships among the people of a social network.

As another example, graph neural networks can perform graph-to-graph translation by receiving an input graph data set and generating output that represents a different graph data set. For example, a graph neural network can receive an input graph data set and can generate an output graph data set that includes one or more newly discovered nodes and/or edges; an exclusion of one or more nodes and/or edges; a classification of one or more nodes and/or edges; an identification of one or more nodes and/or edges; and/or an update of one or more node properties, edge properties, and/or graph properties. A graph neural network can receive an input graph data set and can generate an output graph data set that shares various similarities with the input graph data set. For example, a graph neural network can receive, as input, a first graph representing a first geographic region (e.g., a real geographic region) and can generate, as output, a first graph representing a different geographic region (e.g., a fictitious geographic region) that shares similarities with the first graph and that has some dissimilarities with respect to the first graph. A graph neural network can receive, as input, an input graph data set and can generate, as output, a subgraph of the input graph data set. A graph neural network can receive, as input, an input graph data set and can generate, as output, an expanded graph including a first subgraph corresponding to the input graph data set and a second subgraph that is newly generated. A graph neural network can receive, as input, a first graph that corresponds to a first time and can generate, as output, a second graph that corresponds to a different time than the first time. For example, the graph neural network can receive, as input, a graph data set that corresponds to a state of a geographic region at a current time, and can generate, as output, a graph data set that predicts the state of the geographic region at a past time or a future time.

As another example, graph neural networks can generate graphs from non-graph input data. For example, a graph neural network can receive, as input, locations of travelers within a geographic region over a period of time, and can generate, as output, graph data that includes one or more nodes that represent points of interest among the travelers and edges that represent paths between the points of interest (e.g., roads that connect the points of interest). As another example, a graph neural network can receive, as input, a description of a graph (e.g., a natural-language description of a geographic location) and can generate, as output, graph data that corresponds to the description of the graph (e.g., a graph of a region that includes one or more nodes representing locations and one or more edges representing roads that interconnect the locations). The graph neural network may receive both graph data and non-graph data (e.g., a graph representing a social network and an indication of a particular person in the social network) and can generate, as output, graph data based on the input (e.g., a subgraph of the people who consider the identified person to be influential).

As another example, graph neural networks can receive an input graph data set and can generate, as output, non-graph data. For example, a graph neural network can receive, as input, a graph representing a social network including nodes that represent people and edges that represent relationships, and can generate, as output, one or more metrics of the social network (e.g., an average number of connections among the people of the social network, an identification of a person of high influence within the social network, or a description of a relationship behavior that commonly occurs within the social network). As another example, a graph neural network can receive, as input, a graph representing a geographic region including nodes that represent locations and edges that represent roads connecting the locations, and can generate, as output, one or more predictions and/or measurements of traffic within the geographic region. The graph neural network may receive both graph data and non-graph data (e.g., a graph representing a social network and an indication of a particular person in the social network) and can generate, as output, non-graph data based on the input (e.g., a summary and/or prediction of the social behaviors of the identified person). For example, a graph neural network that evaluates traffic patterns within a geographic region may process, and optionally output, both an output graph data set that includes nodes that represent cities and edges that represent roads interconnecting the cities, and also non-graph output data representing predictions and/or inferences of traffic and/or weather features within the geographic region (e.g., traffic volume estimates and current or forecasted weather conditions that affect the traffic patterns).

As another example, some graph neural networks may be configured to determine, and optionally output, an indication of zero or more cycles occurring among the nodes and/or edges of an input graph data set. For example, for a directed and/or undirected input graph data set, a graph neural network may determine, and optionally output, an indication that a particular cycle exists within the input graph data set and includes a particular subset of nodes and/or edges. Alternatively, for a directed and/or undirected graph data set, a graph neural network may determine, and optionally output, an indication that the graph is acyclic and does not include any cycles. A graph neural network may be configured to determine, and optionally output, an output graph data set that includes an indication of zero or more cycles.

As another example, graph neural networks can receive an input graph data set and can generate, as output, an interpretation and/or explanation of the input graph data set. For example, a graph neural network can receive, as input, a graph representing a collection of devices, including nodes that respectively represent a device and edges that respectively represent an instance of communication and/or interaction among two or more devices. The graph neural network can generate, as output, an interpretation and/or explanation of the communications and/or interactions represented in the graph, such as an explanation of a set of interactions as being part of a collective and/or collaborative effort among the two or more devices and/or a related series of interactions that are associated with a particular activity. The explanation and/or interpretation may include, for example, a classification of one or more nodes, edges, patterns of activity, and/or the graph; a natural-language summary or narrative explanation of one or more nodes, edges, patterns of activity, and/or the graph; a data set that characterizes one or more nodes, edges, patterns of activity, and/or the graph; and/or a presentation (e.g., a static or motion visualization) of one or more nodes, edges, patterns of activity, and/or the graph. As one such example, a graph neural network may identify, within an input graph data set, one or more subgraphs (e.g., one or more clusters of related nodes and/or edges), and may output an interpretation and/or explanation of the subgraph (e.g., a description of the set of features that characterize the subgraph or cluster). As another example, a graph neural network may generate a visualization of a subgraph of an input graph data set, wherein the visualization depicts, highlights, and/or illustrates a structure and/or an anomalous feature of the subgraph. Some such graph neural networks may be configured to generate interpretations and/or explanations of any input graph data set, e.g., based on an identification of features of an input data set that inform such interpretations and/or explanations, such as clusters, outliers, or determinations of apparent structure and/or data relationships. Other such graph neural networks may be configured to generate domain-specific interpretations and/or explanations of domain-specific graph data sets. For example, a graph neural network may be configured to analyze a graph data set representing a social network identify both a subset of the social network corresponding to an influential cluster of people of the social network and also an interpretation and/or explanation of why this cluster of people appears to be influential within the social network. Graph neural networks can generate interpretations and/or explanations using a variety of techniques, including “white-box” analysis techniques that can be applied to various properties of graph data sets and components thereof. Examples of graph neural networks that include instance-level explanations based on gradients and/or features include, without limitation, Guided BP, class activation mapping (CAM), and GradCAM. Examples of graph neural networks that include instance-level explanations based on perturbations include, without limitation, GNNExplainer, PGExplainer, ZORRO, and Graphmask. Examples of graph neural networks that include instance-level explanations based on decomposition include, without limitation, layer-wise relevance propagation (LRP), Excitation BP, and GNN LRP. Examples of graph neural networks that include instance-level explanations based on surrogate analysis include, without limitation, GraphLIME, RelEX, and PGMExplainer. Examples of graph neural networks that include model-level explanations include XGNN. Further explanation and/or examples of various interpretable and/or explainable features of graph data sets or components thereof that may be generated by graph neural networks are presented elsewhere in this disclosure and/or will be known to or appreciated by persons of ordinary skill in the art.

### Architectures and Frameworks

Graph neural networks may be designed and/or organized according to various architectures. For example, a multilayer graph neural network may include a number of layers, each layer including a number of neurons. In each layer of the graph neural network, the neurons may be configured to receive, as input, at least a portion of an input data set (e.g., an input graph data set) and/or at least a portion of an output of at least one neuron of one or more layers of the graph neural network. Additionally, in each layer of the graph neural network, the neurons may be configured to generate, as output, at least a portion of an output data set of the graph neural network (e.g., an output graph data set of graph neural network) and/or at least a portion of an input to at least one neuron of one or more layers of the graph neural network.

In some graph neural networks, an architecture of the graph neural network is based on the input to the graph neural network. For example, a fixed-size graph of N nodes and E edges interconnecting the nodes may be received and processed by a graph neural network that includes an input layer featuring N neurons respectively configured to receive input from one of the N nodes and/or E neurons respectively configured to receive input from one of the E edges. A graph including an adjacency list having a maximum of E edges may be received and processed by a graph neural network that includes an input layer featuring E neurons respectively configured to receive and process one of the E edges represented in the adjacency list. A graph including two subgraphs may be received and processed by a graph neural network that includes an input layer featuring a first set of neurons that are configured to process the nodes and/or edges of the first subgraph and a second set of neurons that are configured to process the nodes and/or edges of the second subgraph. In some graph neural networks, an architecture of the graph neural network may be based on non-graph input data that is received and processed by the graph neural network. For example, a graph neural network may be configured to receive, as input, a description of a graph (e.g., a number of nodes and/or edges and one or more properties of the graph). The graph neural network may be further configured to generate a graph corresponding to the description, and to process and optionally output the graph according to various graph neural network processing techniques.

In some graph neural networks, an architecture of the graph neural network is based on an output of the graph neural network. For example, a graph neural network may be configured to determine, and optionally output, a fixed-size output graph data set including N nodes and E edges. The graph neural network may therefore include an output layer featuring N neurons respectively configured to generate output corresponding to one of the N nodes and/or E neurons respectively configured to generate output corresponding to one of the E edges. A graph neural network may be configured to determine, and optionally output, an adjacency list having a maximum of E edges. The graph neural network may therefore include an output layer featuring E neurons that respectively generate output corresponding to one of the E edges represented in the adjacency list. A graph neural network may be configured to determine, and optionally output, an output graph data set including two subgraphs. The graph neural network may therefore include an output layer featuring a first set of neurons that are configured to generate output corresponding to the nodes and/or edges of the first subgraph and a second set of neurons that are configured to process the nodes and/or edges of the second subgraph. In some graph neural networks, an architecture of the graph neural network may be based on non-graph output data that is determined, and optionally output, by the graph neural network. For example, a graph neural network may be configured to determine, and optionally output, a description of an input graph data set and/or an output graph data set (e.g., a number of nodes and/or edges and one or more properties of the input graph data set and/or the output graph data set), according to various graph neural network processing techniques.

In some graph neural networks, an architecture of the graph neural network may be based on a directionality of one or more edges included in an input data set and/or an output data set. For example, an input graph data set including a undirected edge that connects a first node N1 and a second node N2 may be received and processed by a graph neural network including a first neuron NN1 and a second neuron NN2 that are bidirectionally connected to one another, such that message passing can occur from the first node NN1 to the second node NN 2 and, concurrently or consecutively, from the second node NN2 to the first node NN1. An input graph data set including a unidirectional edge that connects a first node N1 to a second node N2 may be received and processed by a graph neural network including a first neuron NN1 (e.g., a neuron in a first layer of a feed-forward graph neural network) that is unidirectionally connected to a second neuron NN2 (e.g., a neuron in a second layer of a feed-forward graph neural network), such that message passing can occur from the first node NN1 to the second node NN 2 but not from the second node NN2 to the first node NN1. An input graph data set including an edge that connects three or more nodes may be received and processed by a graph neural network in which three or more nodes are correspondingly connected.

Some graph neural networks may be configured to receive and process an input graph data set including a homogeneous set of nodes and/or a homogeneous set of edges. For example, a first neuron of the graph neural network that corresponds to a first node and/or edge of the input graph data set may include a same or similar number of inputs, a same or similar activation function, and/or a same or similar number of outputs as a second neuron of the graph neural network that corresponds to a second node and/or edge of the input graph data set.

Some graph neural networks may be configured to receive and process an input graph data set including a heterogeneous set of nodes and/or a heterogeneous set of edges. For example, different nodes of an input graph data set may be associated with different labels that respectively indicate different classifications of the nodes, and/or different edges of the input graph data set may be associated with different labels that respectively indicate different classifications of the edges. An architecture of the graph neural network may exhibit variations corresponding to the heterogeneity of the nodes and/or edges. For example, a first neuron of the graph neural network that corresponds to a first node and/or edge of the input graph data set that is associated with a first label or classification may include a different number of inputs, a different activation function, and/or a different number of outputs as a second neuron of the graph neural network that corresponds to a second node and/or edge of the input graph data set that is associated with a second label or classification. As another example, a graph neural network may include a first layer that receives and processes, as input, a first portion of an input data set that includes a first subset of neurons and/or edges that are associated with a first label or classification, and a second layer that receives and processes, as input, a second portion of an input data set that includes a second subset of neurons and/or edges that are associated with a second label or classification. The first layer and the second layer may be processed concurrently or consecutively. The first layer and the second layer may be processed independently (e.g., each layer providing a different portion of an output graph data set). Alternatively, the first layer and the second layer may be processed together (e.g., an output of the first layer may be additionally provided as input to the second layer, and/or an output of the second layer may be additionally provided as input to the first layer).

Some graph neural networks may include an architecture that is based on one or more node properties of one or more nodes of an input graph data set, one or more edge properties of one or more edges of the input graph data set, and/or one or more graph properties of the input graph data set. As an example, in some input graph data sets, one or more nodes may include a node property indicating a weight of the node (e.g., an indication of a centrality and/or betweenness of a node among at least a portion of the nodes of the input graph data set). The graph neural network may include a neuron that corresponds to the node, wherein one or more weights of synapses that connect the neuron to other neurons of the graph neural network is based on the weight of the node. As another example, in some input graph data sets, one or more edges may include an edge property indicating a weight of the edge (e.g., an indication of a significance and/or priority of a relationship among two or more nodes of the input graph data set). The graph neural network may include two or more nodes that are connected by a synapse, wherein a weight of the synapse connecting the two or more nodes is based on a weight of an edge of the input graph data set. Examples of node-based graph neural networks include, without limitation, GraphSAGE, PinSAGE, and VR-GCN. Examples of layer-based graph neural networks include, without limitation, FastGCN and LADIES. Examples of subgraph-based graph neural networks include, without limitation, ClusterGCN and GraphSAINT.

Some graph neural networks may be configured to receive and process fixed input graph data sets, wherein a number and arrangement of nodes and edges of an input data set that is received and processed by the graph neural network does not vary for different instances of processing the input data set. The architecture of such graph neural networks may be configured based on the invariance of the input graph data set. For example, the graph neural network may feature a fixed number and/or arrangement of neurons and/or layers, wherein the fixed architecture of the graph neural network corresponds to the fixed nature of the input graph data set.

Some graph neural networks may be configured to receive and process dynamic input graph data sets, wherein a number and arrangement of nodes and edges of an input data set that is received and processed by the graph neural network during a first instance of processing can differ from a number and arrangement of nodes and edges of an input data set that is received and processed by the graph neural network during a second instance of processing. As an example, a graph neural network may be configured to perform node and/or edge discovery of an input graph data set and to generate, as output, an output graph data set that includes at least one more node and/or at least one more edge than the input graph data set. Further, the graph neural network may be configured to receive the output graph data set from a first processing as input for a second processing, wherein a number of nodes and/or edges received as input during the second processing is greater than a corresponding number of nodes and/or edges received as input during the first processing. In such cases, an architecture of such graph neural networks may be fixed, but may be configured to receive and process a variety of different input graph data sets (e.g., input graph data sets with a variable number of nodes and/or connections). For example, the graph neural network may include an input layer featuring N input neurons, each corresponding to a node of an input graph data set. Such a graph neural network may be configured to use the fixed architecture to receive and process input graph data sets featuring a variable number of nodes up to, but not exceeding, N. For example, in order to receive and process an input graph data set featuring fewer than N nodes, the graph neural network may activate only a number of input neurons of the input layer that correspond to the number of nodes in the input graph data set, and to deactivate remaining neurons of the input layer that do not correspond to a node of the input graph data set (e.g., refraining from processing the remaining neurons, and/or processing the neurons but zeroing the weights of the synapses that connect the neurons to other neurons of the graph neural network). As another example, the graph neural network may perform a first processing of a first input graph data set including N nodes, and, accordingly, may deactivate one or more neurons of the input layer. The graph neural network may then perform a second processing of a second input graph data set including more than N nodes (e.g., an output of the first processing may include an output graph data set that includes one or more newly discovered nodes). During the second processing, the graph neural network may activate one or more of the previously deactivated neurons of the input layer in order to receive and process input from the additional nodes of the second input graph data set. For example, the graph neural network may enable or reenable the processing of one or more neurons of the input layer, and/or may reset (e.g., restore and/or initialize) the weights of one or more synapses that connect one or more neurons of the input layer to other neurons of the graph neural network. In some cases, an architecture of such graph neural networks may dynamic, and may change in correspondence with a dynamic nature of the input graph data set. For example, a graph neural network may include an input layer with a variable number of neurons, and may select, adapt, and/or change the number of neurons in the input layer based on a dynamic property of an input graph data set (e.g., a number of nodes and/or edges in the input graph data set). Such graph neural networks may generate new neurons of the input layer (e.g., initializing and/or selecting weights of the synapses of the new neurons, such as copying the weights from the synapses of other neurons of the input layer) based on a larger number of nodes and/or edges of an input graph data set to be received and processed as input. Alternatively or additionally, such graph neural networks may be configured to eliminate and/or merge neurons of the input layer (e.g., initializing and/or selecting weights of the new neurons) based on a smaller number of nodes and/or edges of an input graph data set to be received and processed as input.

In some graph neural networks, an architecture of the neural network may be selected and/or adapted based on a topology of one or more input graph data sets and/or output graph data sets. For example, a bipartite input graph data set may include two more subgraphs, and a graph neural network may include two or more distinct subsets of neurons that are respectively configured to receive and process data associated with the nodes and/or edges included in one of the subgraphs. As another example, a multigraph input graph data set may include a plurality of edges connecting two or more nodes. For example, a graph representing a social network may include various types of edges that represent various types of relationships (e.g., familial relationships, friendships, and/or professional relationships), and two or more nodes may be connected by a plurality of edges (e.g., a first edge indicating a friendship among the two or more nodes and a second edge indicating a professional relationship among the two or more nodes). An architecture of the graph neural network may correspond to the multigraph nature of the input graph data set. For example, a graph neural network may include two or more distinct subsets of neurons that are respectively configured to receive and process data associated with a subset of edges of the input graph data set that are of a particular edge type (e.g., a first subset of neurons that is configured to receive and process nodes connected by edges that represent friendships, and a second subset of neurons that is configured to receive and process nodes connected by edges representing professional relationships). As yet another example, an input hypergraph data set may include one or more hyperedges that interconnect three or more nodes. An architecture of a graph neural network that is configured to receive and process the input hypergraph data set may include one or more neurons with synapses that interconnect to two or more other neurons in correspondence with one or more hyperedges of the input hypergraph data set.

As another example, an architecture of some graph neural networks include one or more layers that perform particular functions on the output of neurons of another layer, such as a pooling layer that performs a pooling operation (e.g., a minimum, a maximum, or an average) of the outputs of one or more neurons, and that generates output that is received by one or more other neurons (e.g., one or more neurons in a following layer of the graph neural network) and/or as an output of the graph neural network. Examples of graph neural networks that include one or more direct pooling layers include, without limitation, SimplePooling, Set2Set, and SortPooling. Examples of graph neural networks that include one or more hierarchical pooling layers include, without limitation, Coarsening, ECC, DiffPool, TopK, gPool, Eigenpooling, and SAGPool.

As another example, some graph neural networks (e.g., graph convolution networks) include one or more convolutional layers, each of which performs a convolution operation to an output of neurons of a preceding layer of the graph neural network.

As another example, an architecture of some graph neural networks include memory based on an internal state, wherein the processing of a first input data set causes the graph neural network to generate and/or alter an internal state, and the internal state resulting from the processing of one or more earlier input data sets affects the processing of second and later input data sets. That is, the internal state retains a memory of some aspects of earlier processing that contribute to later processing of the graph neural network. Examples of graph neural networks that include memory features and/or stateful features include graph neural networks featuring one or more gated recurrence units (GRUs) and/or one or more long-short-term-memory (LSTM) cells. In some graph neural networks, these features may be further adapted to accommodate graph processing, such as gated graph neural networks (GGRUs), tree LSTM networks, graph LSTM networks, and/or sentence LSTM networks.

As another example, an architecture of some graph neural networks includes one or more recurrent and/or reentrant properties. For example, at least a portion of output of the graph neural network during a first processing is included as input to the graph neural network during a second or later processing, and/or at least a portion of an output from a layer is provided as input to the same layer or a preceding layer of the graph neural network. As another example, in some graph neural networks, an output of a neuron is also received as input by the same neuron during a same processing of an input and/or a subsequent processing of an input. The output of the neuron may be evaluated (e.g., weighted, such as decayed) before being provided to the neuron as input.

As another example, an architecture of some graph neural networks includes two or more subnetworks (e.g., two or more graph neural networks that are configured to process graph data concurrently and/or consecutively). Some graph neural networks include, or are included in, an ensemble of two or more neural networks of the same, similar, or different types (e.g., a graph neural network that outputs data that is processed by a non-graph neural network, Gaussian classifier, random forest, or the like). For example, a random graph forest may include a multitude of graph neural networks, each configured to receive at least a portion of an input graph data set and to generate an output based on a different feature set, different architectures, and/or different forms of processing. The outputs of respective graphs of the random graph forest may be combined in various ways (e.g., a selection of an output based on a minimization and/or maximization of an objective function, or a sum and/or averaging of the outputs) to generate an output of the random graph forest.

In some cases, an architecture of a graph neural network may be designed by a user. For example, a user may choose one or more hyperparameters of a graph neural network (e.g., a number of layers, a number of neurons in each layer, an activation function used by at least some neurons, and the like) in order to process an input graph data set. In some cases, the selected one or more hyperparameters may be based on domain-specific knowledge, e.g., a specific data type, internal organization or structure, and/or task associated with an input graph data set.

Alternatively or additionally, in some cases, an architecture of a graph neural network may be selected by an automated process. For example, a hyperparameter search process may determine one or more hyperparameters of a graph neural network based on an analysis of an input graph data set to be received and processed by the graph neural network and/or an analysis of an output graph data set to be generated and provided as output by the graph neural network. The hyperparameter search process may determine various combinations of hyperparameters for variations of the graph neural network (e.g., graph neural networks with different numbers of layers, different numbers of neurons within each layer, graph neural networks including neurons with different activation functions, and/or graph neural networks with different sets of synapses interconnecting the neurons of various layers). The hyperparameter search process may process an input graph data set (e.g., a training input graph data set) using different graph neural networks that correspond to different sets of hyperparameters. The hyperparameter search process may compare the output of the different graph neural networks (e.g., determining a performance measurement for the output of each graph neural network, and comparing the performance measurements of the different graph neural networks) in order to determine and select a graph neural network that generates desirable output (e.g., output that most closely corresponds to a target output associated with the training input graph data set). The hyperparameter search process may discard the other graph neural networks and may use the selected graph neural network to process input graph data sets. In some cases, the hyperparameter search process may iteratively generate and test refined combinations of hyperparameters. For example, after selecting a graph neural network in a first hyperparameter search processing the hyperparameter search process may perform a second hyperparameter search processing by generating additional graph neural networks based on combinations of hyperparameters that are closer to the hyperparameters of the selected graph neural network, and evaluating the output of the additional graph neural networks. In some cases, the hyperparameter search process may perform a grid search over the set of valid hyperparameter combinations. Iterative refinement of the hyperparameters may enable the hyperparameter search process to determine an architecture of a graph neural network that is well-tuned to a particular task (e.g., an architecture of a graph neural network that demonstrates consistently high performance on input graph data sets within a particular domain of data and/or a particular task). In some cases, a hyperparameter search process may communicate with a user to determine combinations of hyperparameters to evaluate and/or to select for the graph neural network. For example, the hyperparameter search process may present, to a user, a result of a first hyperparameter evaluation (e.g., an output of a graph neural network that was selected through a first hyperparameter search processing). Based on an evaluation of the output by the user, the hyperparameter search process may perform a second or further hyperparameter search processing (e.g., choosing a small refinement of the hyperparameters based on a positive response of the user to the output of a selected graph neural network, and/or choosing a larger refinement of the hyperparameters based on a negative response of the user to the output of the selected graph neural network).

As another example, some graph neural networks include architectures based on graph convolutional networks (GCNs), wherein a convolutional layer applies a convolution operation to outputs of one or more filters of a previous filter layer of the graph convolutional network. Graph convolutional networks may include spectral convolutional networks that are configured to receive, as input, a spectral representation of an input graph data set, and to apply processing (including one or more convolutional operations) to various spectral components of the spectral representation of the input graph data set. Examples of spectral convolutional networks include, without limitation ChebNet and diversified graph convolutional networks (DGCNs). As another example, some graph convolutional networks include architectures based on spatial convolutional networks (SCNs) that are configured to receive, as input, spatial representations of an input graph data set (e.g., spatial information that represents one or more neighborhoods of nodes and/or edges of the input graph data set), and to apply processing (including one or more convolutional operations) to various spatial components of the spatial representation of the input graph data set. Examples of spatial convolutional networks include, without limitation, spatial convolutional neural networks (SCNNs), spatial and/or spatial-temporal GraphSAGE networks, and some deep convolutional neural networks (DCNNs).

Graph neural networks can be generated by a variety of machine learning platforms, frameworks, and/or tools, including, without limitation, PyTorch Geometroc, Deep Graph Library, TensorFlow GNN, Graph Nets, Spektral, and Jraph. Frameworks for graph convolutional networks include, without limitation, message passing neural networks (MPNNs), non-local neural networks (NLNNs), mixture model neural networks (MoNet), and Graph Networks (GN).

Further explanation and/or examples of various architectures of graph neural networks, including the design and implementation of designs and architectures of such graph neural networks, are presented elsewhere in this disclosure and/or will be known to or appreciated by persons of ordinary skill in the art.

### Training and Performance Evaluation

Like other types of neural networks, graph neural networks are typically generated with arbitrarily selected parameters (e.g., synaptic weights that are initially set to randomized values). Also, like other types of neural networks, an initialized graph neural network to evaluate input graph data sets through training, in which the parameters of the graph neural network are adjusted to promote desirable processing that produces expected and/or desirable outputs.

The training of graph neural networks may involve one or more training data sets. For graph neural networks that receive and process input graph data sets, the training data may include one or more training input graph data sets. Alternatively or additionally, for graph neural networks that receive and process input non-graph data, the training data may include one or more sets of training non-graph data.

The training data for a graph neural network may be based on authentic input data that was previously collected and/or analyzed, or that was collected and analyzed for the purpose of training the graph neural network. For example, in order to process graphs that represent an industrial environment, the training data may include sensor data that was previously and/or is currently received from one or more sensors associated with the industrial environment. Alternatively or additionally, the training data may include partially and/or fully synthetic data. For example, a first portion of training data may include data derived from an analysis of authentic data; authentic data that has been supplemented with synthetic data (e.g., an image of a real-world scene including an inserted artificial object); authentic data that has been modified by a suer (e.g., an image of a real-world scene that has been modified by a user); and/or data generated by one or more algorithms (e.g., other machine learning models and/or simulations of real-world processes). In some cases, the training data set may include both authentic training data and synthetic training data that is based on the authentic training data (e.g., both a real-world image and a modified version of the real-world image that has been adjusted in brightness, contrast, size, resolution, scale, shape, aspect ratio, color depth, or the like).

The training data for a graph neural network may be limited to a selected data domain. For example, training data for a graph neural network that analyzes social networks may include one or more samples of individuals from within one or more selected social networks. In other cases, the training data for a graph neural network may be generated from a variety of data domains. For example, training data for a graph neural network that analyzes geographic data may include one or more samples of locations of interest and interconnecting pathways from natural outdoor geographic regions (e.g., forests), artificial outdoor geographic regions (e.g., road networks), indoor geographic regions (e.g., caves or shopping malls), historic geographic regions (e.g., maps from ancestral eras and/or civilizations), and/or synthetic geographic regions (e.g., geographic maps from videogames).

The training data for a graph neural network may be wholly or partially unlabeled. For example, the training data set for an industrial environment may include sensor measurements collected from the industrial environment, but may not include any data indicating an analysis, classification, metadata, interpolations, extrapolations, interpretation, explanation, and/or user reaction associated with the sensor measurements. Alternatively or additionally, the training data for a graph neural network may be wholly or partially labeled. For example, the training data set for an industrial environment may include sensor measurements collected from the industrial environment, and one or more subsets of sensor measurements may be associated with one or more analyses, classification labels, metadata, interpolations, extrapolations, determinations, interpretations, explanations, and/or user reactions associated with the subset of sensor measurements. Training data may associate labels, metadata, or the like with one or more nodes and/or node properties of a training input graph data set; one or more edges and/or edge properties of a training input graph data set; one or more graph properties of the training input graph data set; and/or one or more portions of non-graph data of a training input data set. In some cases, the labels, data, metadata, or the like associated with at least a portion of a training input data set are selected by one or more users (e.g., a human classification of at least a portion of the training data set). In some cases, the labels, data, metadata, or the like associated with at least a portion of a training input data set are selected by another algorithm (e.g., a simulation or another machine learning model). In some cases, the labels, data, metadata, or the like associated with at least a portion of a training input data set are selected by a cooperation of a human and an algorithm (e.g., a determination by a simulation or another machine learning model that is verified by a reviewing human user).

Graph neural networks can be trained based on one or more training data sets and one or more learning techniques. As an example, some graph neural networks are trained through an unsupervised learning technique. For example, a training input data set may not include any labels, data, metadata, or the like associated with various portions of the training input data set. The graph neural network may be trained to identify patterns arising within the training input data sets. For example, a training input data set may include data that indicates one or more anomalies (e.g., nodes and/or edges that appear to represent outliers in a data distribution of the nodes and/or edges of the graph) and/or distinctive patterns or structures arising in the data (e.g., cycles arising in a directed and/or undirected graph). The graph neural network may be trained to detect such anomalies, patterns, and/or structure in the training input data sets. The results of unsupervised learning of a graph neural network may be evaluated based on an evaluation of the output of the graph neural network (e.g., a confusion matrix that includes determinations of true positive determinations, true negative determinations, false positive determinations, and/or false negative determinations) and/or performance scores (e.g., an F1 performance score based on ratios of true positives, false positives, true negatives, and false negatives). The weights of various parameters of the graph neural network can be automatically adjusted, corrected, refined, or the like, such that subsequent processing of the same input training data set and/or other input training data sets generates improved evaluations and/or performance scores.

As another example, some graph neural networks are trained through a supervised learning technique. For example, a training input data set may associate respective portions (e.g., respective training data samples, such as different training input graph data sets) with one or more labeled outputs that are expected and/or desirable of the trained graph neural network. As an example, a graph neural network may be trained to output a classification of a training input graph data set and/or one or more nodes and/or edges thereof. During a supervised learning process, the training input graph data set may be provided as input to the graph neural network and processed by the graph neural network to generate a predicted classification of a training input graph data set and/or one or more nodes and/or edges thereof. The predicted classifications may be compared with one or more labeled outputs associated with the training input graph data set (e.g., one or more labels associated with an expected and/or desirable classification of the training input graph data set and/or one or more nodes and/or edges thereof). Based on the comparison, the weights of various parameters of the graph neural network can be automatically adjusted, corrected, refined, or the like, such that subsequent processing of the same input training data set and/or other input training data sets generates improved evaluations and/or performance scores (e.g., more accurate predictions of one or more labels associated with an expected and/or desirable classification of the training input graph data set and/or one or more nodes and/or edges thereof). As another example, a graph neural network may be trained to generate, as output, an output graph data set that is based on a processing of a training input graph data set. During a supervised learning process, the training input graph data set may be provided as input to the graph neural network and processed by the graph neural network to generate an output graph data set. The output graph data set generated by the graph neural network may be compared with one or more expected and/or desirable output graph data sets corresponding to the training input graph data set (e.g., one or more output graph data sets that are expected and/or desired as output when the graph neural network processes the training input graph data set). Based on the comparison, the weights of various parameters of the graph neural network can be automatically adjusted, corrected, refined, or the like, such that subsequent processing of the same input training data set and/or other input training data sets generates improved evaluations and/or performance scores (e.g., more desirable and/or expected output graph data sets).

As another example, some graph neural networks are trained through a blended training process that includes both supervised and unsupervised learning. For example, a blended training process may evaluate the performance of a graph neural network in training based on both a comparison of predicted outputs of the graph neural network to expected and/or desirable outputs corresponding to an input training data set, and based on one or more automatically determined performance metrics, such as a confusion matrix and/or F1 scores. Some blended training processes may include a round of supervised learning following by a round of unsupervised learning, or may perform rounds of training that include both supervised and unsupervised learning techniques (e.g., optionally with different weights and/or performance thresholds associated with the evaluation of the graph neural network and the updating of the parameters).

As another example, some graph neural networks are trained through a semi-supervised learning process. For example, a training data set may include a large number of samples, of which only a small number of samples are labeled (e.g., associated with expected and/or desirable outputs) and a large remainder of the samples are unlabeled (e.g., not associated with expected and/or desirable outputs). The graph neural network may be trained based on the labeled and/or unlabeled training data, and a performance of the graph neural network may be evaluated based on the labels and/or other metrics. In particular, some unlabeled portions of the input training data may be identified as being incorrectly evaluated by the graph neural network (e.g., the graph neural network may generate incorrect outputs such as predictions or classifications, incorrect and/or malformed output graph data sets, or the like). At least a portion of such unlabeled portions of the input training data (e.g., training data samples that appear to be difficult to classify correctly and/or with high confidence) may be submitted to a human reviewer, and the semi-supervised learning process may receive, from the human reviewer, one or more labels that correspond to an expected and/or desirable output of the graph neural network for such portions of the input training data. Training or retraining of the graph neural network may involve the newly labeled portions of the input training data, as well as other portions of the input training data. Semi-supervised learning may enable graph neural networks to be trained based on a smaller degree of human involvement (e.g., a smaller number of labels associated with portions of the input training data set by human reviewers), and may therefore improve a speed, cost, and/or performance of training the graph neural network.

A training of a graph neural network may occur in one or more epochs. For example, for each epoch, the graph neural network may be provided with input comprising each portion of a training data set, a performance of the graph neural network may be determined based on the output of the graph neural network for each portion of the training data set. Based on the determined performance, and one or more parameters of the graph neural network may be updated. For example, weights of the synapses between neurons of the graph neural network may be adjusted such that a performance of the graph neural network over each portion of the training data set. During the training of a graph neural network, various techniques may be used to evaluate the performance of the graph neural network. As a first example, outputs of the graph neural network (e.g., output graph data sets and/or predictions, such as classifications of the graph, one or more nodes, and/or one or more edges) may be compared with expected and/or desirable outputs. Differences between the outputs and the expected and/or desirable outputs may be used to determine an entropy and/or loss of the output of the graph neural network as compared with corresponding expected and/or desirable outputs. In some variations, the entropy or loss of the graph neural network determined during or after a current epoch may be compared with an entropy or loss of the graph neural network determined during or after a previous epoch to determine a differential and/or marginal entropy or loss. A negative differential and/or marginal entropy or loss may indicate that the training of the graph neural network is productive (e.g., the performance of the graph neural network improved in the current epoch as compared with a previous epoch). A zero or positive differential and/or marginal entropy or loss may indicate that the training of the graph neural network is unproductive (e.g., the performance of the graph neural network did not improve, or diminished, in the current epoch as compared with a previous epoch). Training of the graph neural network may therefore continue as long as the differential and/or marginal entropy or loss remains negative and, optionally, exceeds a threshold magnitude that indicates significant training progress.

As another example, outputs of the graph neural network (e.g., output graph data sets and/or predictions, such as classifications of the graph, one or more nodes, and/or one or more edges) may be classified as one of a true positive, a false positive, a true negative, or a false negative. The performance of the graph neural network may be evaluated as a confusion matrix, e.g., based on a calculation of the performance over the incidence of true positive, false positive, true negative and false negative outputs. In some cases, the calculation may be weighted based on a risk matrix that applies different weights to each classification of the output. For example, in a graph neural network that generates classifications of graphs that correspond to diagnoses of medical conditions, it may be determined false negatives (e.g., missed diagnoses) are very harmful or costly, while false positives (e.g., misdiagnoses that can be corrected by further evaluation) may be determined to be comparatively harmless. Accordingly, the performance of the graph neural network may be determined based on a weighted calculation over the confusion matrix that more severely penalizes the performance based on false negatives than false positives.

As another example, the training of a graph neural network may involve an improvement of an objective function that serves as a basis for measuring the performance of the graph neural network. For example, the objective function may include (without limitation) a loss minimization, an entropy minimization, a precision maximization, a recall maximization, an error minimization, or a consistency maximization. The objective function may include a comparison of the performance of the graph neural network over various distributions of the input data set (e.g., a minimax optimization, such as minimizing a maximum loss over any portion of the input data set, or a maximin optimization, such as maximizing a minimum loss over any portion of the input data set). In some training scenarios that involve reinforcement learning, the output of a graph neural network may include and/or may be interpreted as a policy, e.g., a set of responses of an agent based on respective conditions. The performance of the graph neural network may be based on various objective functions that evaluate various properties of the generated and/or interpreted policy. For example, in a q-learning reinforcement learning process, the objective function applied to the policy may include a maximization of an action value of each behavior that may be performed in response to various conditions.

As another example, the training of graph neural networks may occur concurrently with the hyperparameter search and/or selection. For example, a hyperparameter search process may initially identify a first set of combinations of hyperparameters of graph neural networks to be evaluated using a training data set. Based on each such combination of hyperparameters, a graph neural network may be generated and at least partially trained to determine its performance. Based on the evaluation of the outputs of the graph neural networks corresponding to respective combinations of hyperparameters, the hyperparameter search process may identify a candidate graph neural network with the highest performance. The hyperparameter search process may then generate a second set of combinations of hyperparameters based on the hyperparameters of the candidate graph neural network, and may further (at least partially) train and evaluate the performance of additional graph neural networks based on the second set of combinations of hyperparameters. A comparison of the performance of the additional graph neural networks may cause the hyperparameter search process to retain the candidate graph neural network or to choose a new candidate graph neural network from among the additional graph neural networks. The hyperparameter search process may continue until additional improvements in the performance of candidate graph neural networks are not achievable and/or are below a threshold performance improvement. In this selection process, a variety of performance metrics may be used. As previously discussed, the performance metrics may include an evaluation of the outputs of the graph neural networks (e.g., a loss or entropy, a differential or marginal loss or entropy, a confusion matrix, an F1 score, or the like). Alternatively or additionally, the performance metrics may include other features of the output, such as a consistency of the output of the graph neural network over the distribution of data in the training data set and/or a bias in the performance the output of the graph neural network for selected data distributions of the training data set, and/or a smoothness or oversmoothness of the graph nodes represented in the graph neural network. Alternatively or additionally, the performance metrics may include one or more measurements of computational resource expenditures to perform training and/or inference of input data sets with the graph neural network (e.g., CPU and/or GPU utilization, memory usage, training time and/or complexity, processing latency between receiving input and generating output, or the like). Aggregate performance measurements may be based on a variety of such considerations, and may enable a human designer and/or a hyperparameter search process to perform a selection of a graph neural network based on various performance tradeoffs (e.g., a preference for a first graph neural network that produces high-accuracy, high-consistency, and/or high-confidence results but that requires a large amount of computational resources, time, and/or cost, vs. a preference for a second graph neural network that produces reasonable-accuracy, reasonable-consistency, and/or reasonable-confidence results using a smaller amount of computational resources, time, and/or cost). For example, a measurement of computational resource utilization by a particular graph neural network may correspond to a numeric penalty in various measurement of the performance of the graph neural network (e.g., a loss, entropy, and/or objective function output).

In various forms of graph neural network training based on these and other learning techniques, various training methods can be used to update the parameters of a graph neural network in training and/or to evaluate the performance of a graph neural network in training. For example, optimizers that may be used during the training of graph neural networks may include (without limitation) linear regression; root mean squared propagation (RMSprop); stochastic gradient descent; adaptive stochastic gradient descent (Adagrad); adaptive stochastic gradient descent with adaptive learning (Adadelta); adaptive moment estimation (Adam); Nesterov accelerated adaptive moment estimation (Nadam); Nesterov accelerated gradient and momentum (NAG); Monte Carlo simulations involving various variance reduction techniques, such as control variates; or the like, including variations and/or combinations thereof. Training techniques for particular types of graph neural networks may include optimizers that are specialized for such particular types of graph neural networks (e.g., graph convolutional networks may be trained using a FastGCN optimizer and/or receptive field control (RFC) optimizers).

As further examples, graph neural network training may include a variety of techniques that are also applicable to non-graph machine learning models, including non-graph neural networks. As a first such example, training may occur in batches and/or mini-batches of the training data set, wherein the graph neural network evaluates a batch (e.g., plurality of input data sets) of an input training data set, and the parameters of the graph neural network are updated based on an aggregation of the evaluation of the outputs of the graph neural network for the batch of input data sets. In various training techniques, batches may be selected at random from the training input data set or may be selected in an organized manner, e.g., as various subsets that are representative of one or more data distributions of the training input data set. For example, if the graph neural network in training exhibits good performance over some data distributions of the training input data and poor performance over other data distributions of the training input data, the continued training of the graph neural network may focus on, prioritize, and/or overweight the training based on batches of training input data that reflect the data distributions associated with poor performance. In various training techniques, a batch size of batches of training input data sets may be fixed, or the batch size may vary based on a progress of the training of the graph neural network.

As another example, in various training techniques for graph neural networks, an entire set of training input data may be partitioned into a training data set that is used only to train the graph neural network and update its parameters; a validation data set that is used only to evaluate a prospective and/or in-training graph neural network; and/or a test data set that is used to only evaluate a final performance of the fully trained graph neural network. The partitioning of the training input data may be based on one or more ratios (e.g., a 90/5/5 partitioning of the training input data into a training data set, a validation data set, and a test data set, or a 98/1/1 partitioning of the training input data into a training data set, a validation data set, and a test data set). For example, during an epoch, the performance of the graph neural network may be evaluated based on various portions of the training data set, and the parameters of the graph neural network may be adjusted based on the determined performance. However, continued training and updating of the graph neural network based on the training data set may result in overfitting, e.g., “memoization” of correct outputs that correspond to various portions of the training data set. Due to such overfitting, the performance of the graph neural network in evaluating previously evaluated input data sets may improve, but performance of the graph neural network on previously unevaluated input data sets may decline. Instead, at the conclusion of an epoch, the performance of the graph neural network may instead be evaluated based on various portions of the validation data set, which is not otherwise used to update the parameters of the graph neural network. Evaluation of the performance of the graph neural network on previously unseen data can indicate that the performance of the graph neural network is genuinely improving (e.g., based on learned principles of data evaluation that apply consistently to both previously seen and previously unseen input data sets), resulting in a continuation of training. Alternatively, Evaluation of the performance of the graph neural network on previously unseen data can indicate that the performance of the graph neural network is resulting in overfitting to the training data set (e.g., based on “memoization” of correct outputs for previously seen input data sets that do not inform the correct evaluation of previously unseen input data sets), resulting in a conclusion of training. Such conclusion may be referred to as “early stopping” of training to reduce overfitting of the graph neural network to the training data set and to preserve the performance of the graph neural network on previously unsee input data sets.

As another example, various training techniques for graph neural networks may include one or more regularization techniques, in which the inputs to the graph neural network and/or the processing of the input are adjusted to reduce overfitting. As a first example, the training of a graph neural network may include a dropout regularization technique, in which some neurons of the graph neural network are disabled for some instances of processing input data sets. In various regularization techniques, neurons to be disabled are selected randomly (e.g., 5% of the neurons during each epoch) and/or can be selected in a sequence (e.g., a round-robin selection of deactivated neurons). The selected neurons may be disabled by refraining from processing the inputs of the neurons and setting the outputs of the selected neurons to zero, and/or by processing the selected neurons but temporarily setting the weights of the synapses of the neurons to zero. As a second example, the training of a graph neural network may include a dropnode and/or dropedge regularization technique, in which portions of an input graph data set that include some nodes and/or some edges of the input graph data set are disabled. In various regularization techniques, nodes and/or edges to be disabled for an instance of processing are selected randomly (e.g., 5% of the nodes and/or edges during each epoch) and/or can be selected in a sequence (e.g., a round-robin selection of deactivated nodes and/or edges). The selected nodes and/or edges may be disabled by refraining from processing portions of the input data set that correspond to the selected nodes and/or edges, and/or by deactivating neurons of an input layer of the graph neural network that are configured to receive input data from the selected nodes and/or edges. As a third example, the performance of a graph neural network may be subjected to various forms of regularization, including L 1 (“lasso”) regularization and/or L2 (“ridge”) regularization. These and other forms of regularization may be used, alone or in combination, to reduce overfitting of a graph neural network to an input training data set. For example, regularization may reduce an overweighting of a subset of nodes, edges, and/or neurons in the processing of various input data sets (e.g., by reducing and/or penalizing neurons having synaptic weights with magnitudes that are disproportionately large compared to the synaptic weights of other neurons of the graph neural network).

As another example, various training techniques for graph neural networks may combine a graph neural network with one or more other machine learning models, including one or more other graph neural networks and/or one or more non-graph neural networks. For example, a bootstrap aggregation (“bagging”) training technique involves a determination of a decision tree as an ensemble of machine learning models based on different bootstrap samples of the training input data set. Each machine learning model, including one or more graph neural networks, may be trained based on a random subsample of the training input data set. For a particular input data set, many of the trained machine learning models of the ensemble, including one or more graph neural networks, may present poor or only adequate performance. However, one or a few of the trained machine learning models may generate high-performance output for the particular input data set and others like it (e.g., for input data sets that share one or more properties, such as a select graph property, a select node property, and/or a select edge property). Thus, for any particular input data set, an evaluation of the specific properties of the particular input data set may enable a selection among the available models of the ensemble that may be used to evaluate the particular input data set. That is, a machine learning model (e.g., a graph neural network) that is generally a poorly performing model on most input data sets may exhibit good performance over a small neighborhood of input data sets that includes the particular data set, and may therefore be selected to evaluate the particular data set. Alternatively or additionally, the bootstrap aggregation may involve an evaluation of an input data set by a plurality of machine learning models (optionally including one or more graph neural networks of the ensemble) and a combination of the outputs of the selected machine learning models. In such scenarios, it is possible the individual outputs of the individual machine learning models exhibit poor performance (e.g., incorrect and/or low-confidence classifications of an input data set), but a determination of a consensus over the outputs of the multiple machine learning models may exhibit high performance (e.g., accurate and/or high-confidence classifications of the input data set).

As another example, various training techniques for graph neural networks may include a boosting ensemble technique, in which an output of a first trained machine learning model (e.g., a first graph neural network) is evaluated by a second trained machine learning model (e.g., a second graph neural network) to predict an accuracy and/or confidence of the prediction of the first trained machine learning model. For example, a first trained graph neural network may be evaluated to determine that it generates accurate and/or high-confidence output for a first group of input data sets (e.g., input graph data sets that include a first graph property, a first node property, and/or a first edge property), but inaccurate and/or low-confidence output for a second group of input data sets (e.g., input graph data sets that include a second graph property, a second node property, and/or a second edge property). A particular input data set may initially be processed by the first trained graph neural network to determine a first output (e.g., an output graph neural network or a prediction, such as a classification). A second trained graph neural network may evaluate the input data set and/or the output of the first graph neural network to predict an accuracy and/or confidence of the first graph neural network over input data sets that resemble the particular input data set. If the second trained graph neural network predicts that the output of the first graph neural network is likely to be of high accuracy and/or confidence, then the second trained graph neural network may provide the output of the first trained graph neural network as its output. However, if the second trained graph neural network predicts that the output of the first graph neural network is likely to be of low accuracy and/or confidence, then the second trained graph neural network may adjust, correct, and/or discard the output of the first trained graph neural network, or preferentially select an output of a different machine learning model (e.g., a third trained graph neural network) to be provided as output instead of the output of the first trained graph neural network. In such scenarios, it is possible that the individual outputs of the individual machine learning models exhibit poor performance (e.g., incorrect and/or low-confidence classifications of an input data set), but the review and validation of the output of some machine learning models by other machine learning models may enable a determination of a consensus over the outputs of the multiple machine learning models that exhibits high performance (e.g., accurate and/or high-confidence classifications of the input data set).

As another example, following conclusion of training a graph neural network, the graph neural network may be deployed for use (e.g., transferred to one or more devices, deployed into a production environment, and/or connected to a source of production input data). The performance of the graph neural network over input data sets may continue to be evaluated and monitored to verify that the graph neural network continues to perform well over various inputs. In some cases, the performance of the graph neural network may change between training and deployment. For example, a distribution of production input data processed by the graph neural network may differ from the distribution of training input data that was used to train the graph neural network. Alternatively or additionally, a distribution of production input data may change over time, e.g., between a time of deploying the graph neural network and a later time after such deployment. Such instances of changes in the performance of a fully trained and deployed graph neural network may be referred to as “drift.” In some such cases, “drift” may be reduced or eliminated by retraining or continuing training of the graph neural network, e.g., using additional training input data that corresponds to an actual or current distribution of the production input data. Alternatively or additionally, “drift” may be reduced or eliminated by training a substitute graph neural network to replace the initially deployed graph neural network. For example, the substitute graph neural network may include a different set of hyperparameters than the initially deployed graph neural network (e.g., additional layers and/or neurons to provide greater learning capacity; additional regularization techniques to reduce overfitting to the training data set; and/or the inclusion of specialized layers, such as pooling, filtering, memory, and/or attention layers). As another example, the initially deployed graph neural network may be added to an ensemble of other machine learning models, optionally including other graph neural networks, to generate improved outputs (e.g., higher-accuracy predictions) based on a consensus determined over the outputs of a number of machine learning models.

As another example, the training and/or use of graph neural networks may be susceptible to various forms of adversarial attack. For example, in an adversarial attack scenario, a particularly designed and/or selected input to a graph neural network (an “adversarial input,” such as an unusual, malformed, and/or anomalous) may cause the graph neural network to generate output that is incorrect, inconsistent with other outputs, and/or surprising. As an example, in a form of graph modification adversarial attack that may be referred to as node injection poisoning adversarial attack (NIPA), one or more nodes of an input graph data set are selected and/or altered to shift an output of the graph neural network based on the adversarial input (e.g., altering a classification and/or prediction of the input graph data set, or altering an output graph data set based on the adversarial input graph data set). As another example, in a form of graph modification adversarial attack that may be referred to as an edge perturbing adversarial attack (NIPA), one or more edges of an input graph data set are selected and/or altered to shift an output of the graph neural network based on the adversarial input (e.g., altering a classification and/or prediction of the input graph data set, or altering an output graph data set based on the adversarial input graph data set). As another example, in a training data injection attack, one or more portions of training input data on which a graph neural network is trained are designed and/or altered to alter the training of the graph neural network (e.g., a mislabeling of a particular training data input that causes the graph neural network to misclassify other inputs that correspond to the mislabeled training data input, and/or an injection of data samples into a training data set that alter a data distribution of the training data set upon which the graph neural network is trained). As another example, in a membership inference adversarial attack, properties and/or outputs of a graph data set are evaluated to identify properties of one or more training data inputs on which the graph data set was trained (e.g., an influential property of an input data set that causes the graph data set to select a particular classification for the any input data sets that include the property). As another example, in a property inference adversarial attack, properties and/or outputs of a graph data set are evaluated to identify general properties of training data inputs on which the graph data set was trained (e.g., a distribution of data included in the training data set, which may indicate particular distributions of input data over which the graph neural network was not trained, or over which the graph neural network was incompletely and/or incorrectly trained). As another example, in a model inversion adversarial attack, outputs of a graph neural network are examined to identify properties of corresponding input data sets that cause the graph neural network to generate such outputs.

Based on these and other forms of adversarial attack, the training and/or evaluation of a graph neural network may be adjusted to protect the graph neural network from such adversarial attack. For example, before an input to a graph neural network is processed, the input may be evaluated and/or classified (e.g., by another machine learning model, including another graph neural network) in order to determine whether the input is adversarial. If so, the graph neural network may refrain from processing the adversarial input, may process the adversarial input in more limited conditions (e.g., processing only a portion of the adversarial input, and/or replacing a malformed or anomalous portion of the adversarial input with a corresponding non-malformed and/or non-anomalous portion). As another example, during processing of an input data set, the internal behavior of the graph neural network may be evaluated and/or classified (e.g., by another machine learning model, including another graph neural network) to determine whether the behavior indicates a processing of adversarial input (e.g., unusual neuron activations, unusual outputs of one or more neurons, and/or updates of internal states of memory units). If so, the processing of the adversarial input may be halted and/or an internal state of the graph neural network may be restored to a time before the adversarial input was processed. As another example, before output of a graph neural network is provided in response to an input data set, the output may be examined and/or classified (e.g., by another machine learning model, including another graph neural network) to determine whether it is incorrect, inconsistent with other inputs, and/or surprising. If so, the output of the graph neural network may be discarded and/or altered before being provided in response to the input data set. Further explanation and/or examples of various techniques for training and performance evaluation of graph neural networks are presented elsewhere in this disclosure and/or will be known to or appreciated by persons of ordinary skill in the art.

### Applications

Graph neural networks can be applied to input data sets (including input graph data sets and/or input non-graph data sets) in various applications, and can be configured and/or trained to generate outputs (including output graph data sets and/or output predictions, such as classifications) that are relevant to various tasks within such applications.

For example, in the field of social networking, a graph data set may represent at least a portion of a social network, including nodes that represent people and that are connected by edges that represent relationships among two or more people. The graph data set representing a social network may be provided, as input, to a graph neural network that is configured to receive and process the input graph data set. The graph neural network may generate, as output, an output graph data set. For example, the output graph data set may include one or more new nodes that correspond to one or more newly discovered people within the social network, and/or one or more new edges that correspond to one or more newly discovered relationships that connect two or more people of the social network. The output graph data set may include one or more subgraphs and/or clusters that represent highly interconnected people of the social network, e.g., a social circle. The output graph data set may include a prediction of a recommendation of a relationship among two or more nodes corresponding to two or more people of the social network who share common personal traits, interests, and/or connections to other people. The output graph data set may include a prediction of a classification of a node corresponding to a person of the social network, e.g., a prediction of a personal interest of the person or a demographic trait of the person. The output graph data set may include a prediction of a classification of an edge that connects nodes representing two or more people of the social network, e.g., a prediction of a criminal association among two or more people of the social network. The output graph data set may include a determination of a relationship within the social network based on an attention model, e.g., an identification of a first node corresponding to a first person of the social network that appears to be influential to a second person of the social network represented by a second node of the graph. The output graph data set may include a prediction of a graph property of the graph, e.g., a classification of the social network as one or more types (e.g., a genealogy or familial social network, a friendship social network, and/or a professional relationship social network).

As another example, in the field of pharmaceuticals, a graph data set may represent at least a portion of a molecule (e.g., a protein or a DNA sequence), including nodes that represent atoms of the molecule and that are connected by edges that represent bonds and/or spatial relationships among two or more atoms. The graph data set representing a molecule may be provided, as input, to a graph neural network that is configured to receive and process the input graph data set. The graph neural network may generate, as output, an output graph data set. For example, the output graph data set may include one or more new nodes that correspond to one or more newly discovered atoms that may be added to the molecule, and/or one or more new edges that correspond to one or more newly discovered atoms of the molecule. The output graph data set may include one or more subgraphs and/or clusters that represent highly interconnected subregions of the molecule, such as carbon atoms that form a benzene ring or a binding site for a protein. The output graph data set may include a prediction of a classification of one or more nodes corresponding to one or more atoms of the molecule, e.g., a prediction that a subset of atoms of the molecule include a binding site for an enzyme that may active and/or deactivate a protein. The output graph data set may include a prediction of a classification of an edge that connects nodes representing atoms of the molecule, e.g., a prediction of a chemically reactive bond that can be altered to alter a property of the molecule. The output graph data set may include a prediction of a graph property of the graph, e.g., a prediction of a shape or organization of the molecule, a classification of the molecule as an enzyme, and/or a prediction of a potential side-effect of a drug due to an undesirable interaction with another drug.

As another example, in the field of software, a graph data set may represent at least a portion of a marketplace, including nodes that represent products and that are connected by edges that represent relationships between products. The graph data set representing a marketplace may be provided, as input, to a graph neural network that is configured to receive and process the input graph data set. The graph neural network may generate, as output, an output graph data set. For example, the output graph data set may include one or more new nodes that correspond to one or more newly discovered product, and/or one or more new edges that correspond to one or more newly discovered products. The output graph data set may include one or more subgraphs and/or clusters that represent highly interconnected products (e.g., two or more products that are often purchased and/or used together, or that compete in a particular market sector). The output graph data set may include a prediction of a recommendation of a relationship among two or more nodes corresponding to two or more products. The output graph data set may include a prediction of a classification of a node corresponding to a product, e.g., a prediction of an appeal, value, and/or demand of a product in a particular market segment, such as a particular subset of users. The output graph data set may include a prediction of a classification of an edge that connects nodes representing products, e.g., a prediction of a functional relationship between two or more products. The output graph data set may include a prediction of a graph property of the graph, e.g., a classification of the marketplace as increasing and/or decreasing in terms of supply, demand, size, prognosis, and/or public interest.

As another example, in the field of logistics, a graph data set may represent at least a portion of a supply chain, including nodes that represent locations where resources are generated, manufactured, stored, exchanged, and/or consumed and that are connected by edges that represent means of transport of resources between two or more locations. The graph data set representing a supply chain may be provided, as input, to a graph neural network that is configured to receive and process the input graph data set. The graph neural network may generate, as output, an output graph data set. For example, the output graph data set may include one or more new nodes that correspond to one or more newly discovered location of interest, and/or one or more new edges that correspond to one or more newly discovered locations of interest. The output graph data set may include one or more subgraphs and/or clusters that represent highly interconnected locations of interest, such as locations between which certain resources are frequently transported. The output graph data set may include a prediction of a recommendation of a relationship among two or more nodes corresponding to two or more locations of interest. The output graph data set may include a prediction of a classification of a node corresponding to a location of interest, e.g., a prediction of an availability, supply, demand, value, and/or appeal of a resource in the location of interest. The output graph data set may include a prediction of a classification of an edge that connects nodes representing locations of interest, e.g., a prediction of a volume of utilization of a mode of transport between two locations of interest. The output graph data set may include a prediction of a graph property of the graph, e.g., a classification of a stability of the supply chain based on social, economic, political, and/or environmental changes.

As another example, in the field of energy, a graph data set may represent at least a portion of an energy grid, including nodes that represent energy generators, stores, distributors, and/or consumers, and that are connected by edges that represent relationships among energy generators, stores, distributors, and/or consumers. The graph data set representing an energy grid may be provided, as input, to a graph neural network that is configured to receive and process the input graph data set. The graph neural network may generate, as output, an output graph data set. For example, the output graph data set may include one or more new nodes that correspond to one or more newly discovered energy generators, stores, distributors, and/or consumers, and/or one or more new edges that correspond to one or more newly discovered energy generators, stores, distributors, and/or consumers. The output graph data set may include one or more subgraphs and/or clusters that represent highly interconnected energy generators, stores, distributors, and/or consumers. The output graph data set may include a prediction of a recommendation of a relationship among two or more nodes corresponding to two or more energy generators, stores, distributors, and/or consumers. The output graph data set may include a prediction of a classification of a node corresponding to energy generators, stores, distributors, and/or consumers, e.g., a prediction of a current or future state or property of the energy generator, store, distributor, and/or consumer. The output graph data set may include a prediction of a classification of an edge that connects nodes representing energy generators, stores, distributors, and/or consumers, e.g., a prediction of a transaction between two or more energy generators, stores, distributors, and/or consumers. The output graph data set may include a prediction of a graph property of the graph, e.g., a classification of a stability of the energy grid to sustain energy generation and to support energy demands based on social, economic, political, and/or environmental changes.

As another example, in the field of civil engineering, a graph data set may represent at least a portion of a geographic region, including nodes that represent locations of interest and that are connected by edges that represent roads. The graph data set representing a geographic region may be provided, as input, to a graph neural network that is configured to receive and process the input graph data set. The graph neural network may generate, as output, an output graph data set. For example, the output graph data set may include one or more new nodes that correspond to one or more newly discovered locations of interest, and/or one or more new edges that correspond to one or more newly discovered locations of interest. The output graph data set may include one or more subgraphs and/or clusters that represent highly interconnected locations of interest. The output graph data set may include a prediction of a recommendation of a relationship among two or more nodes corresponding to two or more locations of interest. The output graph data set may include a prediction of a classification of a node corresponding to location of interest, e.g., a prediction of a current or future volume of visitors to a location of interest and/or a volume of traffic at or through the location of interest. The output graph data set may include a prediction of a classification of an edge that connects nodes representing locations of interest, e.g., a prediction of a volume of traffic on a road that connects two or more locations of interest. The output graph data set may include a prediction of a graph property of the graph, e.g., a classification of a sufficiency of a road network of the geographic region to support a current or future volume of traffic.

As another example, in the field of industrial systems, a graph data set may represent at least a portion of an industrial plant, including nodes that represent machines of the industrial plant and that are connected by edges that represent functional relationships among the machines. The graph data set representing the industrial plant may be provided, as input, to a graph neural network that is configured to receive and process the input graph data set. The graph neural network may generate, as output, an output graph data set. For example, the output graph data set may include one or more new nodes that correspond to one or more newly discovered machines, and/or one or more new edges that correspond to one or more newly discovered machines. The output graph data set may include one or more subgraphs and/or clusters that represent highly interconnected machines. The output graph data set may include a prediction of a recommendation of a relationship among two or more nodes corresponding to two or more machines. The output graph data set may include a prediction of a classification of a node corresponding to a machine, e.g., a prediction of a current or future maintenance state of a machine. The output graph data set may include a prediction of a classification of an edge that connects nodes representing machines, e.g., a prediction of a functional relationship between a first machine and a second machine that may significantly impact an efficiency, output, cost, or the like of the industrial plant. The output graph data set may include a prediction of a graph property of the graph, e.g., a classification of the industrial plant as belonging to a particular industry, such as raw material processing, semiconductor fabrication, tool manufacturing, vehicle manufacturing, textile manufacturing, and/or pharmaceuticals manufacturing. The output graph data set may include a prediction of a future and/or optimized state of the industrial plant, e.g., a reorganization of the machines of the industrial plant to optimize machine placement and/or floor planning.

As another example, in the field of cybersecurity, a graph data set may represent at least a portion of a device network, including nodes that represent devices and that are connected by edges that represent communication and/or interactions among two or more devices. The graph data set representing the device network may be provided, as input, to a graph neural network that is configured to receive and process the input graph data set. The graph neural network may generate, as output, an output graph data set. For example, the output graph data set may include one or more new nodes that correspond to one or more newly discovered devices, and/or one or more new edges that correspond to one or more newly discovered devices. The output graph data set may include one or more subgraphs and/or clusters that represent highly interconnected devices. The output graph data set may include a prediction of a recommendation of a relationship among two or more nodes corresponding to two or more devices. The output graph data set may include a prediction of a classification of a node corresponding to a device, e.g., a prediction of a security status of the device as being safe, vulnerable, or corrupted. The output graph data set may include a prediction of an activity occurring among the nodes of the graph data set, e.g., an occurrence of an intrusion or an attack based on anomalous activities represented by the edges of the graph data set. The output graph data set may include a prediction of a classification of an edge that connects nodes representing devices, e.g., a prediction that a particular interaction between two or more devices is associated with a security vulnerability or attack. The output graph data set may include a prediction of a graph property of the graph, e.g., a classification of the set of devices as safe from security flaws or vulnerable to one or more attack mechanisms, such as denial-of: service (DoS) attacks, distributed-denial-of-service (DDoS) attacks, social engineering attacks such as phishing, eavesdropping attacks such as man-in-the-middle attacks, or the like. The output graph data set may include a prediction of a theoretical state of the graph data set, e.g., a security state of the device network in response to a particular type of attack, and/or a security state of the device network based on the inclusion of additional devices in the future. The output graph data set may include a recommendation to modify the graph neural network based on one or more security considerations, e.g., a recommendation to reorganize the device network to reduce susceptibilities to one or more security risks. The output graph data set may include a technique to defend the graph neural network from various types of adversarial attack, e.g., training-time attacks that affect the manner in which the graph neural network learns to evaluate and/or classify the graph data set, one or more nodes, and/or one or more edges. For example, the message passing operations of the graph neural network may be modified to reduce a susceptibility of the graph neural network to adversarial perturbation during training, while preserving the learning capabilities of the graph neural network.

Examples of additional applications of various graph neural networks to various graph data sets include, without limitation: graph mining applications (e.g., graph matching and/or clustering); physics (e.g., physical systems modeling and/or evolution over time); chemistry (e.g., molecular fingerprints and/or chemical reaction predictions); biology (e.g., protein interface predictions, side effects predictions, and/or disease classification); knowledge graphs (e.g., knowledge graph completion and/or knowledge graph alignment); generation (e.g., output graph data set generation that corresponds to an expression, an image, a video, a music sample, or a scene graph); combinatorial optimization; traffic networks (e.g., traffic state prediction); recommendation systems (e.g., user-item interaction predictions and/or social recommendations); economic networks (e.g., stock markets); software and information technology (e.g., software defined networks, AMR graph-to-text tasks, and program verification); text processing (e.g., text classification, sequence labeling, machine translation, relation extraction, event extraction, fact verification, question answering, and/or relational reasoning); and image processing (e.g., social relationship understanding, image classification, visual question answering, object detection, interaction detection, region classification, and/or semantic segmentation). Further examples of applications for processing various graph data sets by various graph neural networks are presented elsewhere in this disclosure and/or will be known to or appreciated by persons of ordinary skill in the art.

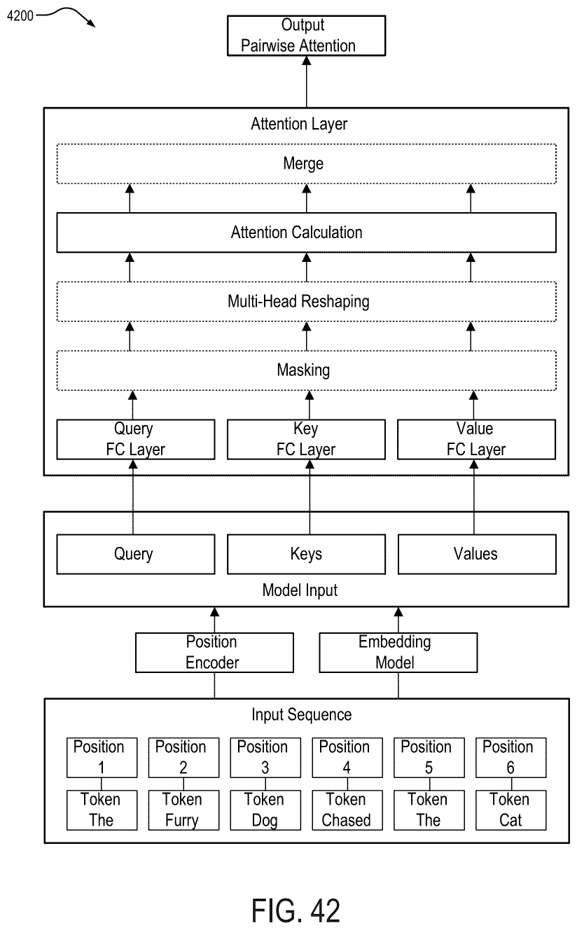

### FIG. 42: Attention

In embodiments, an artificial intelligence system, machine learning model, or the like, of any of the types disclosed herein, may comprise, integrate, link to, or include an attention feature. Attention may be generally described as a determination, among a set of inputs, of the relatedness of each input to the other inputs in the set of inputs. In “self-attention,” the input includes a sequence of elements, and attention is determined between each pair of elements in the sequence. As a first example, the set of inputs includes a sequence of words in a language, and attention is applied to determine, for each word in the sequence, the relatedness of the word to each other word in the sequence. As a second example, an input includes an image comprising a set of pixels, and attention is applied to determine, for each group of pixels in the image, the relatedness of the group of pixels to each other group of pixels in the image. Attention can also be applied between sets of input, wherein attention is determined between each element of a first set of input and each element of a second set of input. For example, the set of inputs can include a first sequence of words in a first language and a second sequence of words in a second language, and attention can be determined to indicate how each word in the first sequence is related to each word in the second sequence.

FIG. 42 presents an example 4200 of a determination of attention by a machine learning model. In the example of FIG. 42, an input sequence includes a set of tokens, each representing a word (“The”, “Furry”, “Dog”, “Chased”, “The”, “Cat”). Each token includes an indicator of a position of the token in the sequence. In various embodiments, the tokens of the input sequence may include complete words, portions of words (e.g., a first token indicating a word root and a second token indicating a modifier of the word root), punctuation, or the like. Some tokens may indicate metadata, such as a start-of-sequence token, an end-of-sequence token, or a null token indicating a padding of the sequence or a mask that hides a token of the sequence.

The input sequence is processed by a position encoder that determines, for each token, an encoding of the position. In some embodiments, the position encoding may include an ordinal numerical value that indices the ordinal position of each token in the sequence, such as an index beginning at zero or one. In some embodiments, the position encoding may include a relative numerical value that indicates a position of each token in the sequence relative to a fixed position, such as a current word (encoded position 0), an immediately preceding word (encoded position −1), or an immediately following word (encoded position 1). In some embodiments, the position encoding may include non-integer values and/or multiple values, such as a first index indicating a sine calculation (with a given frequency) of the position of each token and a second index indicating a cosine calculation (with a same or different frequency) of the position of each token.

The input sequence is also processed by an embedding model. The embedding model determines, for each token in the input sequence, a mapping of the token into a latent space representation of the input (e.g., a latent space representation of a language). The latent space may position each token along a plurality of n dimensions, wherein each dimension represents a distinct type of relationship among the elements of the language. The embedding model clusters the tokens such that related tokens are positioned closer to each other within the latent space. For example, along one dimension of the latent space, the words “Cat” and “Dog” may be positioned close together as being words that describe animals, while also being positioned apart from words that do not describe animals, such as “Baseball” and “School.” Along another dimension of the latent space, the words “Dog” and “Furry” may be positioned close together as words that commonly occur in the context of dogs, while also being positioned apart from words that do not describe dogs, including “Cat.” For each token of the input sequence, the embedding model generates one or more values that indicate the position of the token within the latent space. In some embodiments, the values are encoded as a vector, and the proximity of two tokens within the latent space may be determined based on vector proximity calculations, such as cosine similarity.

Based on the positions encoded by the position encoder and the embeddings determined by the embedding model, a model input can be generated for the input sequence. As shown in FIG. 42, the model input includes a query, a set of keys, and a set of values. As an example, the query may include an indicator of a particular token in the input sequence, such as the sixth token (“Cat”). The keys may include the position encodings of respective tokens of the input sequence, as determined by the position encoder, and a corresponding embedding of the respective token as determined by the embedding model. The values may indicate additional data features of the tokens. As an example, the values may indicate, for each token of the input sequence, a determined sentiment (e.g., a ranking between −1, indicating very negative words, and +1, indicating very positive words). In some embodiments, no additional data features are available, and the values are identical to the keys.

The model input is received and processed by an attention layer. In FIG. 42, the attention layer first includes a set of fully-connected layers: a first fully-connected layer processes the query of the model input; a second fully-connected layer processes the keys of the model input; and a third fully-connected layer processes the values of the model input. Each fully-connected layer includes a bias and a set of weights that adjust the values of the query, key, or value, respectively. The bias and weights of each fully-connected layer are model parameters that are initialized (e.g., to random values) and then incrementally adjusted during training.

Optionally, in some embodiments, the outputs of the fully-connected layers are further processed by a masking layer. The masking layer removes one or more values from the model input adjusted by the fully-connected layers. As a first example, the masking layer can reduce to zero the values of the key and/or value at a given position, such as a token at a current position to be predicted, or a token at a position following the current position that is to be hidden from the model. As a second example, the masking layer can reduce to zero the values of particular keys and/or values, such as padding values that are provided to adapt the size of the model input to a size of input that the attention layer is configured to receive and process. The masking layer can produce output for certain tokens (e.g., reduced to zero) for the indicated tokens (e.g., the current token, future tokens, and/or padding tokens) and that is the same as the input for the remaining tokens.

Optionally, in some embodiments, the outputs of the masking layer are further processed by a multi-head reshaping layer. The multi-head reshaping layer can reshape an input vector comprising the weighted and/or masked model input such that subsets of the input can be processed in parallel by different attention heads. As an example, an attention layer may include two attention heads, and the input can be reshaped such that each attention head is applied to only half of the inputs. The multi-head attention model can enable attention determinations over different subsets of the input (e.g., a first attention head can determine the relatedness of a first token to a first subset of tokens of the input sequence, and a second attention head can determine the relatedness of the same first token to a second subset of tokens of the input sequence). Alternatively or additionally, the multi-head attention model can enable different types of attention determinations among the tokens of the input sequence (e.g., a first attention head can determine a first type of relatedness of a first token to a subset of tokens of the input sequence, and a second attention head can determine a second type of relatedness of the same first token to the same or different subset of tokens of the input sequence). The multi-head attention model may enable parallel processing of the input sequence (e.g., the input for each attention head can be processed by a different processing core).

The attention layer includes an attention calculation that determines, based on the model input, the attention of a token of the input sequence with respect to other tokens of the input sequence. In some embodiments, the attention calculation includes an additive attention (“Bahdanau Attention”) calculation, in which attention is determined as a sum of weighted calculations of the distances of the tokens along each dimension of the latent space. In some embodiments, the attention calculation includes a dot product determination, as a comparison of the distances between the vectors of the tokens within the latent space. In some embodiments, the attention calculation is performed over the query, keys, and values of the model input, optionally after processing with a masking layer. In some embodiments, the attention calculation is performed for each of a plurality of attention heads, each of which processes a particular subset of the tokens of the input sequence.

In embodiments that include multi-head reshaping, the output of the attention calculation is further processed by a merge operation that merges the attention calculations for the respective attention heads. In some embodiments, the merge operation includes a concatenation and/or interleaving of the attention calculations of the attention heads. In some embodiments, the merge operation includes an arithmetic operation applied to the attention calculations of the attention heads, such as an arithmetic mean, median, min, and/or max calculation.

The attention layer outputs, for at least one token of the input sequence, a determination of attention between the token and at least one other token of the input sequence. The output of the attention calculation may include a vector that indicates, for at least one token of the input sequence, the determinations of attention between the token and a set of other tokens of the input sequence. The output of the attention calculation may include a set of vectors that indicate, for respective tokens of the input sequence, the determinations of attention between the respective token and at least one other token of the input sequence. The output of the attention calculation may indicate, for a token of a first sequence, the attention of the token to one or more tokens of a second sequence. As shown in FIG. 42, the output of the attention layer includes pairwise determinations of relatedness between pairs of tokens (e.g., each pair including a current token in an input sequence and each preceding token in the input sequence). In some embodiments, the pairwise determinations may be further processed. For example, a softmax calculation can be applied to normalize the pairwise attention determinations based on a desired range of output values (e.g., probability values between 0.0 and 1.0, with a 1.0 sum over all output values).

The attention layer may be trained by providing sets of training input sequences and comparing the outputs of the attention layer with expected outputs. Alternatively or additionally, the attention layer may be trained by incorporating the attention layer into a larger model (e.g., a transformer model) and adjusting the parameters of the attention layer (e.g., the parameters of the fully-connected layers) for a given training input sequence in order to adjust the output of the attention layer toward a desired output for the training input sequence. As an example, in a backpropagation training process, the output of the attention layer is provided as input to a succeeding layer. The output of the model including the attention layer and the succeeding layer may be compared with a desired output for the training input sequence. Based on this comparison, adjustments of the output of the succeeding layer (e.g., based on an error calculation) may inform a determination of desired adjustments of the input of the succeeding layer, which correspond to adjustments of the output of the attention layer. The adjustments of the output may be achieved by internally adjusting the parameters of the attention layer (e.g., the weights and/or biases of the fully-connected layers shown in FIG. 42) such that the attention layer subsequently generates output for the training input sequence that more closely corresponds to the desired input for the succeeding layer. Incremental training over a set of training input sequences can cause the attention layer to generate output that corresponds to the desired output for the training input sequences. As an example, if the input sequences are sentences in a language and the desired output of the model includes the probabilities of words in the language that could follow a given set of input words, the attention layer can be incrementally adjusted to indicate the attention (e.g., relatedness) between the next word in the input sequence and the preceding words in the input sequence.

It is to be appreciated that the attention layer shown in FIG. 42 presents only one example, and that attention layers may include a variety of variations with respect to the example of FIG. 42. For example, attention layers may include, without exception, additional layers or sub-layers that perform one or more of: normalization; randomization; regularization (e.g., dropout); one or more sparsely-connected layers; one or more additional fully-connected layers; additional masking; additional reshaping and/or merging; pooling; sampling; recurrent or reentrant features, such as gated recurrence units (GRUs), long short-term memory (LSTM) units, or the like; and/or alternative layers, such as skip layers. Alternatively or additionally, the architecture of the attention layer shown in FIG. 42 may vary in numerous respects. For example, masking may be applied to the model input instead of to the outputs of the fully-connected layers. One or more fully-connected layers may be omitted, replaced with a sparsely-connected layer, and/or provided as multiple fully-connected layers, including a sequence of two or more fully-connected layers; or the like. Model parameters (e.g., weights and biases) and/or hyperparameters (e.g., layer counts, sizes, and/or embedded calculations) may be modified and/or replaced with variant parameters and/or hyperparameters. Many such variations may be included in attention layers that are incorporated in a variety of machine learning models to process a variety of types of input sequences.

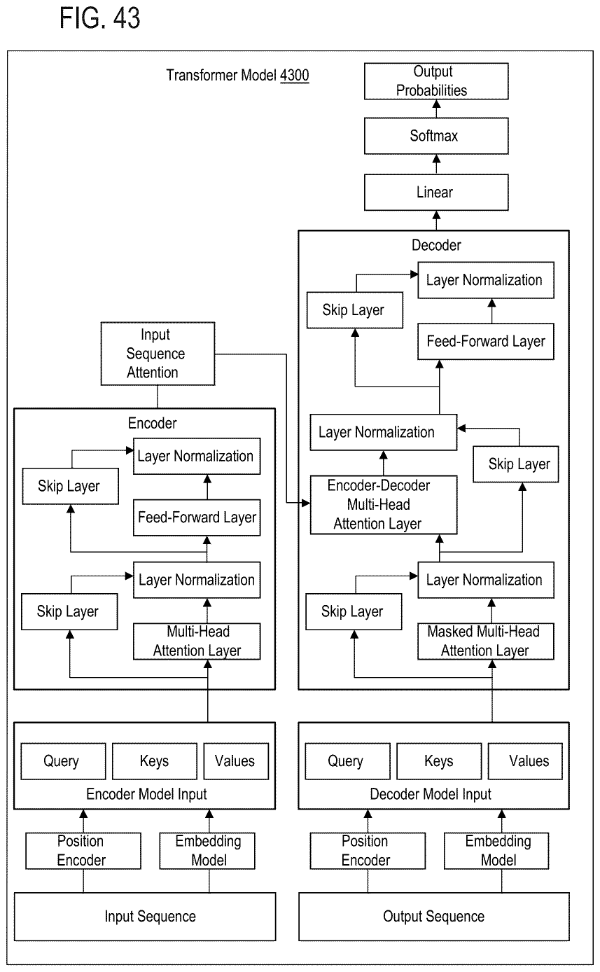

### FIG. 43: Transformer Models

In embodiments, an artificial intelligence system, machine learning model, or the like, of any of the types disclosed herein, may comprise, integrate, link to, or include a transformer model, that is, a neural network that learns context and meaning by tracking relationships in a set of sequential data inputs. Transformer models may include one or more attention layers, including (but not limited to) the attention layer shown in FIG. 42.

FIG. 43 presents an example of a transformer model 4300. The transformer model 4300 of FIG. 43 is based on an encoder-decoder architecture in which an encoder processes an input sequence and a decoder processes an output sequence to generate output probabilities. As a first example, the input sequence may include a sequence of words in a first language; the output sequence may include a sequence of words in a second language corresponding to a translation of the input sequence; and the output probabilities may include the probabilities of words in the second language for a particular position in the translation. As a second example, the input sequence may include a sequence of words in a language that represent a query or prompt; the output sequence may include a sequence of words in the same language that represent a response to the query or prompt; and the output probabilities may include the probabilities of words in the second language for a particular position in the response. In some cases, the output sequence includes only the tokens up to a particular position (e.g., the first n-1 tokens of the output sequence), and the output probabilities represent the probabilities of tokens in the language of the output sequence that could follow the output sequence (e.g., the nth token in the output sequence). In some cases, the output sequence includes all of the tokens except the token a particular position (e.g., all of the tokens except the nth token of the output sequence), and the output probabilities represent the probabilities of tokens in the language of the output sequence that could represent the missing token in the output sequence (e.g., the nth token in the output sequence).

The encoder receives an input sequence comprising a set of tokens. The input sequence may be padded to a given length corresponding to a configured input size for the encoder. The input sequence is processed by a position encoder to encode the positions of the respective tokens of the input sequence. The input sequence is also processed by an embedding model to determine the embeddings of the tokens of the input sequence. The encoded positions and embeddings are used to generate an encoder model input, including a query (e.g., a position of one or more tokens in the input sequence), a set of keys (e.g., the encoded positions and embeddings for each token of the input sequence), and a set of values (e.g., additional language features of the tokens such as outputs of sentiment analysis). The set of values may be a copy of the set of keys if no additional data features are available. The encoder model input is processed by a multi-head attention layer, such as an instance of the attention layer shown in FIG. 42. The multi-head attention layer determines self-attention within the input sequence (e.g., the relatedness of a respective token of the input sequence to each other token of the input sequence). The output of the multi-head attention layer is received and processed by a layer normalization component. Additionally, a skip layer is provided that passes the encoder model input through to the layer normalization component. The layer normalization component combines the output of the multi-head attention layer with the encoder model input (e.g., via arithmetic mean, median, min, max, addition, multiplication, or the like) and normalizes the combined output to within a desired range. In some embodiments, the encoder includes a sequence of two or more instances of this combination of multi-head attention layers, skip layer, and layer normalization components. The encoder also includes a feed-forward layer (e.g., a fully-connected layer and/or a sparsely-connected layer) including a set of trainable parameters. The output of the feed-forward layer is provided to another layer normalization component, along with the output of the preceding layer normalization component via a skip layer. The encoder outputs an input sequence attention, which indicates, for each of one or more tokens of the input sequence, the relatedness of each other token of the input sequence.

The decoder features an architecture that is similar to the encoder, but that includes additional components to incorporate the input sequence attention generated by the encoder. The decoder receives an output sequence comprising a set of tokens. The output sequence may be padded to a given length corresponding to a configured input size for the decoder. The output sequence is processed by a position encoder to encode the positions of the respective tokens of the output sequence. The output sequence is also processed by an embedding model to determine the embeddings of the tokens of the output sequence. The encoded positions and embeddings are used to generate a decoder model input, including a query (e.g., a position of one or more tokens in the output sequence), a set of keys (e.g., the encoded positions and embeddings for each token of the output sequence), and a set of values (e.g., additional language features of the tokens such as outputs of sentiment analysis). The set of values may be a copy of the set of keys if no additional data features are available. The decoder model input is processed by a masked multi-head attention layer, such as an instance of the attention layer shown in FIG. 42. In addition to determining attention, the masked multi-head attention layer masks the input values of a current token of the output sequence and any tokens of the output sequence that follow the current token. The masked multi-head attention layer determines self-attention within the output sequence (e.g., the relatedness of a respective token of the output sequence to each preceding token of the output sequence). The output of the multi-head attention layer is received and processed by a layer normalization component. Additionally, a skip layer is provided that passes the encoder model input through to the layer normalization component. The layer normalization component combines the output of the multi-head attention layer with the encoder model input (e.g., via arithmetic mean, median, min, max, addition, multiplication, or the like) and normalizes the combined output to within a desired range. In some embodiments, the encoder includes a sequence of two or more instances of this combination of multi-head attention layers, skip layer, and layer normalization components. The decoder further includes an encoder-decoder multi-head attention layer that receives both the output of the preceding layer normalization component and the input sequence attention generated by the encoder. The encoder-decoder multi-head attention layer does not determine self-attention within the output sequence, but, rather, determines the attention between the tokens of the output sequence and the corresponding tokens of the input sequence. The output of the encoder-decoder multi-head attention unit is also received and processed by a second layer normalization component. Additionally, a skip layer is provided that passes the input to the encoder-decoder multi-head attention layer through to the second layer normalization component. The second layer normalization component combines the output of the multi-head attention layer with the input to the encoder-decoder multi-head attention unit (e.g., via arithmetic mean, median, min, max, addition, multiplication, or the like) and normalizes the combined output to within a desired range. The decoder also includes a feed-forward layer (e.g., a fully-connected layer and/or a sparsely-connected layer) including a set of trainable parameters. The output of the feed-forward layer is provided to a third layer normalization component, along with the output of the preceding layer normalization component via a skip layer. The output of the decoder is processed by a fully-connected layer and a softmax normalization layer based on a cross-entropy determination.

The output of the softmax normalization layer includes a set of probabilities for each possible token of a language of the output sequence for the current token. As a first example, the input sequence may include a sequence of words in a first language; the output sequence may include a sequence of words in a second language corresponding to a translation of the input sequence, up to a current (nth) word in the translation; the output probabilities may include the probabilities of words in the second language for the nth word in the translation. As a second example, the input sequence may include a sequence of words in a language that represent a query or prompt; the output sequence may include a sequence of words in the same language that represent a response to the query or prompt, up to a current (nth) word in the response; and the output probabilities may include the probabilities of words in the language for the nth word in the response.

During training, the transformer model 4300 may be provided with a set of input sequences and complete corresponding output sequences. As a first example involving language translation, the transformer model 4300 may be provided with a training data set including a first corpus of sentences in a first language and a second corpus of sentences in a second language that respectively correspond to the sentences in the first language. As a second example involving a generative model, the transformer model 4300 may be provided with a training data set including a first corpus of queries or prompts in a language and a second corpus of responses in the language that correspond to the respective queries or prompts. For each training data input, a pair of sentences of the first corpus and second corpus are selected. The encoder is provided with the first (input) sentence, and the model is processed to determine the first word in the second (output) sentence. In this case, the output sequence provided to the decoder is completely masked so that the decoder cannot make predictions based on the expected words in the second sentence. The word probabilities determined by the decoder are compared with the actual first word in the output sequence, and backpropagation is applied through the decoder and encoder to increase the likelihood of outputting the expected word. The backpropagation includes adjusting the parameters of the attention layers to increase the attention between the first word and related words of the input sequence. The encoder is then provided again with the first (input) sentence, and the model is processed to determine the second word in the second (output) sentence. In this case, the output sequence provided to the decoder includes the unmasked first word, but masks all words after the first word. The word probabilities determined by the decoder are compared with the actual second word in the output sequence, and backpropagation is applied through the decoder and encoder to increase the likelihood of outputting the expected word. The backpropagation includes adjusting the parameters of the attention layers to increase the attention between the second word, the known first word of the output sequence, and related words of the input sequence. In this manner, the transformer model 4300 performs an autoregressive prediction, wherein the output probability of each nth token of the output sequence is based on the input sequence, the previously predicted tokens of the output sequence, and the encoder-decoder attention therebetween. Training continues over the entirety of the first and second corpora to improve the output predictions.

In many cases, the training of the transformer model 4300 occurs in batches. For example, the previous (simplified) training example described an incremental training of the transformer model 4300 over each corresponding pair of sentences of the first and second corpora, wherein the parameters of the transformer model 4300 are adjusted via backpropagation after each instance of processing. In batch training, the input and output sequences are vectorized, as are the layers of the transformer model 4300, such that predictions over each word of the output sequence are predicted in parallel. Backpropagation parameter adjustment is performed for each batch of the training data set, based on the outputs for all of the pairwise inputs of each batch of the training data set.

After training, the transformer model 4300 can be used to predict an output sequence based on an input sequence. First, the input sequence is processed by the encoder, while the decoder processes a null output sequence (e.g., an output sequence in which all outputs are initially nulled and/or masked by the masked multi-head attention layer). The output probability of the decoder is used to determine a first token of the output sequence. In some embodiments, the first token is chosen as the token having the highest probability. In other embodiments, the first token is chosen based on a random sampling over the output probabilities. In either case, the transformer is then applied to the same input sequence and an output sequence including only the determined first token of the output sequence, and the output of the decoder determines the second token of the output sequence. This process continues until reaching an output token cap and/or upon determining, as the output of the decoder, an end-of-sequence token. In this manner, the transformer model 4300 is applied over the input sequence to determine, in serial and autoregressive manner, the tokens of the output sequence.

It is to be appreciated that the transformer model 4300 shown in FIG. 43 presents only one example, and that transformer models may include a variety of variations with respect to the example of FIG. 43. For example, the architecture of the encoder and/or decoder may include, without exception, additional layers or sub-layers that perform one or more of: normalization; randomization; regularization (e.g., dropout); one or more sparsely-connected layers; one or more additional fully-connected layers; additional masking; additional reshaping and/or merging; pooling; sampling; recurrent or reentrant features, such as gated recurrence units (GRUs), long short-term memory (LSTM) units, or the like; and/or alternative layers, such as skip layers. Alternatively or additionally, the architecture of the encoder and/or decoder shown in FIG. 43 may vary in numerous respects. For example, masking may be applied directly to the output sequence instead of within the multi-head attention models. One or more fully-connected layers may be omitted, replaced with a sparsely-connected layer, and/or provided as multiple fully-connected layers, including a sequence of two or more fully-connected layers; or the like. Model parameters (e.g., weights and biases) and/or hyperparameters (e.g., layer counts, sizes, and/or embedded calculations) may be modified and/or replaced with variant parameters and/or hyperparameters. Many such variations may be included in transformer models to process a variety of types of input and output sequences.

Transformer models, including the example shown in FIG. 43, may be applied in a variety of circumstances. As an example, transformer models may be trained on and/or configured to process a variety of types of input sequences and/or output sequences. Sequential data inputs and/or outputs can include a wide variety of types described herein, such as strings of text, sequences of sensor data from or about an entity, sequences of steps in a process (e.g., chemical, physical, biological, and many others) or flow (e.g., a human workflow, information technology traffic flow, physical traffic flow, sequences of user behavior (e.g., attention to content, clickstream behavior, shopping behavior (digital and real world), and many others. Any of these, and others can be provided as inputs to train a transformer model, which may be alternatively described herein as a self-attention model, a foundation model, or the like. A range of mathematical self-attention techniques can be applied to detect how data elements in sequential data mutually affect each other (such as in feed forward, feedback, and other forms of influence and dependency). In various embodiments described herein and in the documents incorporated by reference herein, a set of transformer models may be deployed for a wide range of use cases, including for predictive text applications (e.g., generating a next token of text based on a previous set of tokens, such as for intelligent agent dialog, responses to queries, and the like); for extraction of information (such as extraction of meaningful elements from sensor data, signal data, and the like, such as analog signal data from sensors on machines, wearable devices, infrastructure sensors, edge and IoT devices, and many others); for analysis of human factors, such as emotional response, sentiment, satisfaction, opinion, and the like; for summarizing data (such as providing summaries of text, images, video, sensor data, and many other streams of data of the type collected and processed as described herein); for trend detection, prediction and forecasting (and hence also for anomaly detection, such as fraud in financial transactions), including for a wide range of trends, including health (human, animal, mental, financial, machine condition, and others), performance (wellness, financial, physical, and many others), and many others; for recognition of entities and behaviors (such as objects appearing in video or image data, objects captured in LIDAR and other point-cloud rendering systems, objects located by SLAM systems, and many others); for generation and execution of instructions (e.g., recipes, control instructions, rules, regulations, governance instructions, and many others); and for many other uses.

In embodiments, an input data set, such as an analog or digital sensor data stream, a body of text, a set of images, a set of structured data (such as data from a graph database or other form of database noted herein, a sequence of blockchain or distributed ledger entries (or other ledger data, such as accounting, financial, health or other data), a set of signals (of the various types noted herein), is provided in order to train a transformer model. In embodiments, initial training may include a step of facilitating compression of the input data, such as by constraining the size of the transformer neural network and/or its outputs, to dimensionality that is significantly smaller (or less granular, etc.) than that of the input data. By requiring the output of the constrained transformer model to match, within a required metric of fidelity, the input data, the transformer model is caused to generate an “embedding” of the input data into a more compressed, efficient format. A decoding neural network may then be trained to operate on the output of the constrained, embedding transformer model, such that it can reproduce the input data from the output of the constrained model within the required metric, thereby assuring that the data is compressed without losing critical meaning.

Once the embedding transformer model is so trained, the decoding neural network can be removed and replaced by one or more of a set of use-case driven decoding models, each of which is trained to operate on the output of the embedding model to produce a target outcome, such as performing any of the use cases noted above to a satisfactory degree. These use-case decoding models can be fine-tuned iteratively over time with feedback from users, outcomes, or the like. Thus, a trained embedding foundation/transformer model, once created, can be used across many different use cases that may benefit from understanding the meaning of the input data set.

In embodiments, one type of use-case decoder can be trained to allow the embedding transformer model to operate on lower quality data than was originally supplied to train the model. To accomplish this, both low quality and high quality data (such as high granularity sensor data and low granularity sensor data, or high dimensionality signal data and low dimensionality signal data, or noisy acoustic data and filtered acoustic data, or the like) can be simultaneously fed to a pair or more of instances of the trained, embedding transformer model, and a decoder for the instance of low quality data can be trained to generate an output that matches, within a metric of fidelity, the output of the instance of the embedding transformer model that is fed the high quality data. As an example, gap-free analog waveform data from a three-axis vibration sensor on a machine component can be captured simultaneously with less granular data from a single- or two-axis accelerometer on the same component, and a decoder, operating on the output of the instance of the embedding transformer model that takes the single- or two-axis input, can be trained to match (within a tolerance) the output of the instance of the embedding transformer model that takes the more granular data as an input. Once created, the resulting decoder, coupled with the embedding transformer model, serves as a projection transformer model, effectively projecting lower quality data into higher quality data, which can then be used by other decoders to enable use cases. This class of projecting transformer models can be applied to a wide range of use cases where high quality data can be obtained during a training phase (often at higher expense), but lower quality data can be used as an input during a deployment phase (such as where lower quality data is more widely or cheaply available, such as in the case of vibration data noted above). Among other things, these projecting transformer models allow powerful, real-time, low latency use cases for AI even when input data is sparse, noisy, of low dimensionality, or the like.

In embodiments, feedback from various decoder models can be used to improve instances of an embedding foundational or transformer model. In embodiments, a set of transformer models, a set of decoders, or both, can be arranged in a workflow, which may be directed/acyclical or with processing loops, to create higher-level use cases that benefit from multiple applications of AI. For example, one model may be used to classify a condition, another used to generate a recommendation, and another used to generate a control instruction, among a huge range of possible embodiments. This may include serial, parallel, iterative, feed forward, feedback and other configurations.

In embodiments, a set of models may be trained to generate instructions for configuration of other models.

In embodiments, transformer models may be deep learning, self-learning, self-organizing, or the like, and may be used for any of the embodiments of self-learning, self-organization, or other self-referential capabilities noted throughout this disclosure or the documents incorporated by reference herein. They may also be supervised, semi-supervised, or the like. Transformer models may be coupled with, integrated with, linked to, or the like, in series, parallel or other more complex workflows, with other AI types, such as other neural network types (e.g., CNNs, RNNs, and others). For example, in embodiments, a transformer model operating on sequential data may be coupled with a model suited to operate on non-sequential data (e.g., for pattern recognition) to achieve a use case.

In embodiments, transformer models discover patterns in large bodies of data by application of a set of mathematical functions, optionally operating in parallel processing configurations, thereby eliminating or reducing the need for human labeling (and thereby greatly expanding the set of available data that can be used to train a model).

Self-attention may be accomplished in a transformer model by introducing a set of positional encoders that tag data elements entering and exiting a neural network and inserting a set of attention units at appropriate places in the encoding and decoding framework of an AI system. The attention units generate a mathematical map of interrelationships among data elements. In embodiments multi-headed attention units are deployed, executing a matrix of equations in parallel to determine the interrelationships. Transformer models, using self-attention, have displayed strong capabilities to provide outputs that are consistent with how humans find patterns and meaning in data.

In embodiments, transformer models may be embodied with very large numbers of parameters (e.g., hundreds of millions, billions, trillions, or more) operating on very large sets of parallel processors. For example, the Megatron-Turing Natural Language Generation Model by NVIDIA and Microsoft is reported to have 530 billion parameters. As noted above, from a foundational model, various use-case specific models (decoders, projections, and the like) can be purpose-built for specific applications. Accordingly, in embodiments a set of transformer models may be deployed using advanced computational techniques and/or processing architectures, such as ones that simplify or converge processors, simplify I/O, and the like. For example, 3D chipset or chiplet architectures may facilitate much higher density, faster computation, making transformer models more cost-effective. Quantum computation may also facilitate massively parallel processing in form factors that are faster, more energy efficient, or the like. Similarly, embodiments may use a tensor-engine GPU chip with a specific transformer engine, such as the NVIDIA H100 Tensor Core GPU. Another example of a transformer model is Google's switch transformer model, a trillion-parameter model that uses sparsity and a mixture-of-experts architecture to enable gains in performance and reductions in training speed.

As noted above, in embodiments smaller or more constrained transformer models may be trained to generate embeddings, particularly for very complex data sets, such as granular analog data.

In embodiments a set of transformer models may be configured to operate on structured data processing systems, such as on results from queries that are directed to a database, results of inputs directed to a set of APIs, or the like. This may facilitate better understanding of what meaning a transformer model is recognizing in a data pattern, which can be critical to ensuring quality (e.g., where a model may, due to flaws in underlying data, generate poor conclusion, such as replicating historical racial bias, missing critical balancing information, failing to understand formal logical constructs, or the like). As noted elsewhere in this disclosure and the documents incorporated herein, governance of AI in general, is a need, and the scale and complexity of transformer models likely compounds problems recognized with other neural networks, including their “black box” nature, uncertainty about input quality, and the like. Thus, governance concepts disclosed herein and in documents incorporated by reference should be understood to apply to various embodiments that use transformer models, as with other types of AI. One example is in the training of models, where models may be trained, in embodiments, in various disciplines, optionally similar to the educational frameworks by which humans are trained not just to sense pattern meaning, but also how to test and govern those abilities with formal reasoning and logic, mathematics, probability, and frameworks of ethics and morality.

### Energy Edge Digital Twin Platforms and Systems

Throughout this disclosure and the documents incorporated by reference herein, various embodiments are provided of digital twin platforms and systems that leverage sensors and other information sources, robust connectivity, and intelligence systems to allow users to experience accurate representations of the states and activities of the many entities that are involved in the workflows of an individual, group or enterprise (e.g., a company, business unit, department, government, household, non-profit, or other enterprise). These include, among others, role-based digital twins that can be configured, or that self-configure, how data is collected, stored, processed and/or presented in ways that account for the roles of respective users (e.g., ones directed to financial users, strategic users, operational users, many others). Digital twins also include adaptive digital twins that leverage intelligence systems, such as artificial intelligence, analytic systems, expert systems, or hybrids involving various permutations and combinations thereof, to adapt how data is collected, stored, processed and/or presented based on context, such as based on the content of the information that is collected and processed. Among these adaptive digital twins, a subset, AI-driven digital twins, may use component artificial intelligence systems at any of the stages of the pipeline of information from a sensor or other basic information source to the presentation of content to a user. Artificial intelligence systems can provide outputs along a spectrum of autonomy, including: a) presenting reports, alerts, classifications, predictions, recommendations, analyses and other outputs for human review and action; b) undertaking human-supervised control of one or more aspects of a workflow, where the artificial intelligence system (acting as a co-pilot, assistant, intelligent agent, or the like to a human user) outputs a prediction and/or a recommendation for an action (which may be embodied in an instruction that can be processed by a system), and a human confirms, or adjusts, the nature of the action before it is implemented; and c) undertaking autonomous control of one or more systems or subsystems, where the artificial intelligence processes relevant information, completes necessary classifications, predictions and other decision-making steps (including where applicable, confirming risk management, governance, self-reflection or other steps) and triggers an action (such as by providing an instruction, control signal, or the like) to a system or component.

Along this spectrum from basic reporting to full autonomy, there is a varying extent to which there is a human being in the decision-making loop. Artificial intelligence systems have enormous promise to automate individual, group and enterprise workflows, providing more reliable, seamless monitoring of ongoing activities, faster response times to unexpected events, and more efficient execution of many types of tasks, among many other benefits. However, the extent to which AI systems can be trusted can vary widely, such as based on: a) the stakes involved (e.g., are there risks to human life, health or property in making a wrong decision?); b) how the AI system was trained (e.g., are there reasons to believe that there is bias in the training data that will be carried forward into the outputs of the AI system); c) how the AI system is governed or supervised (e.g., is in compliance with regulatory, legal or other governance frameworks embedded in the workloads of the system as contemplated in this disclosure and the documents incorporated by reference herein, or is there a need for separate governance or supervision?); d) how the AI system performs, in absolute terms and relative to other available systems, including other AI systems, analytic systems, or human beings (experts, other individuals, groups, or crowds, for example); e) the quality, type and/or availability of data (which can include factoring in the cost of the data); f) the quality, type and/or availability of connectivity (which can include factoring in the cost of the connectivity); g) the quality, type and/or availability of computational resources (which can include factoring in the cost of the computational resources); h) the quality, type and/or availability of other necessary resources (e.g., energy); i) environmental or contextual parameters of the workflow to which the AI system will be applied (such as the complexity of a physical environment, the presence of human beings in proximity, or the like); and other factors. As an example among many, a well-trained AI system may be highly capable of driving a vehicle down a highway during daylight, doing so more safely than a human being who could be prone to sleepiness or distraction, but if computational, networking, or other resources are uncertain, it may be decided that the AI system should not be trusted to perform the task. Decisions about the extent to which one can trust an artificial intelligence system can be very difficult, and the extent of trust is a major factor in determining whether or not AI systems, and their many benefits, can be unlocked.

A major benefit of the various digital twin systems disclosed herein is that a digital twin platform, particularly one that is adaptive and self-configuring, can provide an ideal environment for decision making. Good decisions usually need a combination of a) fresh, accurate, relevant information; b) application of some degree of expertise; c) use of judgment to consider tradeoffs of risks; and/or d) leadership to cause implementation (which may encompass, among other things, taking on the consequences when outcomes are unfavorable). Each of these attributes can be supported by the data collection, storage and processing systems, connectivity systems, computational systems and intelligence systems described throughout this disclosure and the documents incorporated by reference herein. For example, a pipeline of IoT and edge devices and high QoS networks (adaptive networking) can pass granular, real-time sensor data about all entities in an operating environment (machines, components, humans, infrastructure, etc.), which manifests in visibility, such as for big data analytics and consulting use cases, as well as data for machine learning. Data architectures (e.g., adaptive sensing and data collection; edge query language; intelligent data storage and processing layers) and advanced computational architectures (hybrid cloud, edge, and quantum computing) can be used to optimize conditions for application of human and machine intelligence. For example, data architectures can adapt visual representations for human cognitive processing (including based on the skillset, role, experience, expertise, or cognitive parameters of a human, such measured by neurometrics, psychometrics, or other systems) and/or prepare and stage data for artificial intelligence systems (including by cleansing, deduplication, generation of synthetic data, entity resolution, normalization and other processing, generation of various embeddings that use one AI system (e.g., a trained neural network) to transform and/or compressed input data into outputs that are suitable for efficient processing by AI systems, and the like). Computational architectures can be adapted to use an appropriate mix of cloud, edge and on-device processing systems (including various chipsets described herein, such as AI chipsets and hybrid chipsets involving AI and other functions integrated together). This can include quantum computing where beneficial. Systems integration, including various configurations of systems, systems-of-systems and the like into platform and infrastructure solutions (including PaaS and IaaS configurations), with various architectures, including service-oriented architectures, microservices architectures, and the like, can integrate all relevant systems across an individual's or group's set of activities, an enterprise, or an entire business ecosystem, such that a digital twin can have access to current state and activity parameters for many relevant entities. Data and sensor fusion, such as involving sensor data and many other data sets can assist in tracking or predicting outcomes (environmental data, market data, transaction data and many others). Advanced artificial intelligence techniques can combine with human insight to generate expert systems and models that understand and predict operational states, flows and more complex behaviors reflected in data (big data analytics and advanced artificial intelligence techniques), including compact models that are capable of operating effectively on sparse data and/or constrained computational architectures at the edge, as well as generative AI outputs that provide summaries, creative content, instructions, reports, and many other outputs from various inputs, including text, image, video, audio and multi-modal generative AI systems. AI-driven stakeholder interfaces can adaptively filter, prioritize, and distribute information for planning, simulation, decision making and operational action to appropriate stakeholders across an entire enterprise.

With the above stack of integrated systems, taking the form of the many embodiments disclosed herein and in the document incorporated herein by reference, distribution of control, of the various disparate systems, systems-of-systems, components, platforms, infrastructure elements, and other entities involved in the activities of an individual, group, or various levels and roles of enterprise can be enabled, with consideration being given, as noted above, to factors such as latency, security, safety, operational efficiency, reliability and trust.

The untapped power of the digital twin is its ability to enable collaboration, and to distribute decision making, to the right mix of human beings, artificial intelligence systems and other systems, whether in an enterprise or in the activities of an individual or group. The digital twin allows incremental change, experimentation, and easily reversible implementation, removing fear of closing the loop. For example, a digital twin can include a simulation environment that simulates, based on actual historical and current data, what outcomes most likely ensue from deployment of particular configurations of human and artificial intelligence elements in decision making and control loops. The digital twin can also provide a planning environment for deployment of artificial intelligence systems, as well as the data collection, data processing, networking, connectivity, energy, and computational systems and architectures that support them; for example, an enterprise can, using the digital twin, plan various scenarios for obtaining resources to enable more powerful AI systems, comparing projected outcomes at various resource levels and mixes. The digital twin can enable graceful migration among humans, human-AI mixes (e.g., with agents and co-pilots) and autonomous AI systems, including deploying them in ways that can be rapidly adjusted, or reversed, such as based on changing performance capabilities, contextual and environmental factors, and events; for example, an AI system might be permitted to control transactions during normal daily operations, but it could be removed from the loop, or provided with greater human supervision, in the case of major shifts in an environment, such as during severe swings in the market, after an environmental catastrophe, or the like. Thus, provided herein is a digital twin having a simulation environment that simulates, based on data for the entities, states and activities processed and displayed by the digital twin, a simulation of a set of outcomes predicted to result upon deployment of a set of human and artificial intelligence systems in the decision making or control workflows of an entity. Also provided herein is a digital twin that includes a planning system for deployment of a set of artificial intelligence systems and the resources required to enable the artificial intelligence systems, wherein the planning system provides a prediction of the outcomes of deployment of at least a plurality of distinctive sets of artificial intelligence systems or a plurality of distinctive sets of resource configurations. The resources may include ones for data collection, data processing, networking, connectivity, energy, and computational systems and architectures that support them.

As noted throughout this disclosure and the documents incorporated by reference herein disclose the training of machine learning systems in various configurations, including deep learning, supervised learning, semi-supervised learning, and the like. In many such embodiments, a human expert provides input data that is used to train the AI system, such as by tagging data sets to assist in AI classification systems; by producing code, text, images, audio, video and other inputs that are used to train generative AI systems to predict a set of outputs from a prompt; by undertaking activities and behaviors that indicate preferences to train AI systems to generate recommendations; by configuring systems, platforms and architectures that can be used to train AI systems to generate similar configurations and recommendations; by undertaking decisions in various contexts and environments that are used to train AI systems to produce recommendations, make decisions and/or output control signals in similar contexts and environments, among others. In embodiments, any of the machine learning systems or other artificial intelligence systems disclosed herein or in the documents incorporated by reference herein may be embedded in a digital twin for the purpose of enabling training of the digital twin. This may include designating a set of users (such as domain experts, managers, operational supervisors, executives, or the like) as trainers for the AI system, including based on the role, core competency, expertise, experience, or other aspects of the set of users. In embodiments, this may include designating one set of users to provide input data for initial training of a particular AI system and another set of users (possibly overlapping in part with the first set) to supervise the outputs of the AI system. Thus, disclosed herein is a digital twin system with an interface system for designating a set of users as trainers for the creation of an artificial intelligence system that is represented in the digital twin, wherein the artificial intelligence system operates on the data that is used to populate the digital twin. Also disclosed herein is a digital twin system with an interface system for designating a set of users as supervisors for an artificial intelligence system that is represented in the digital twin, wherein the artificial intelligence system operates on the data that is used to populate the digital twin.

In embodiments, provided herein is a digital twin system that displays a set of options for distribution of decision making authority or control across various systems, systems-of-systems or components across a set of entities and workflows. This may be implemented at the level of an individual component or system, such as by allowing a user to configure, within the digital twin, the conditions under which a human (or group of humans, a combined system (human and AI co-pilot, for example), or an AI system alone will be designated as the authority for making a decision. This can include permanent settings (“never” or “always”), semi-permanent settings (e.g., ones that are reviewed on a systematic or episodic basis) and dynamic settings (i.e., where contextual conditions, environmental conditions, or other factors are processed in real time to determine what set of entities will be designed at the decision making authority). In embodiments, decision making authority may be distributed within the digital twin based on a broader decision making framework, such as a hierarchical framework (such as an enterprise hierarchy in which individual workers are organized into groups, with lines of reporting and supervision), a rules-based framework (such as a set of voting rules by which disputes about a decision are resolved), a collaborative framework (such as where prospective alternatives are presented and discussed by a set of contributors seeking a consensus recommendation, optionally involving simulations and planning capabilities noted above), a simulation framework (where, as noted above, the digital twin can simulate outcomes based on historical and real-time data), an enterprise planning framework (which may include integration of the digital twin with enterprise planning systems and dashboard), a competitive framework (such as where alternative options are configured to compete with each other to determine which is superior, optionally involving genetic programming or other evolutionary computing systems, as noted elsewhere in this disclosure), a peer-to-peer framework (e.g., where decisions are negotiated bi-laterally or multi-laterally among entities involved); an algorithmic framework (such as where decisions are reached by a defined set of stages, possibly involving various other frameworks as hybrids in parallel, in series, in iterative loops, or the like), a principles-based framework (such as where a set of personal, group, or enterprise principles (e.g., ethical principles, values, mission statements, or the like) are codified for use when certain contextual decisions are presented), or others. As an example, many daily operational decisions might be configured to be executed autonomously by AI systems, but if those decisions are determined to have an aggregate impact on an element of the mission of an enterprise (such as a mission to continue to develop and employ a set of individuals), then the digital twin can highlight the need to bring an appropriate set of human decision makers into the loop. Thus, in embodiments, provided herein is a digital twin wherein authority for decision making about what set of entities among human beings, human-AI systems, or autonomous AI systems is distributed within the digital twin based on a decision making framework selected from a hierarchical framework, a rules-based framework, a simulation framework, an enterprise planning framework, an algorithmic framework, a principles-based framework, a collaborative framework, a peer-to-peer framework, or a competitive framework.

In embodiments, a digital twin may display various metrics to facilitate decisions about what sets and configurations of human and AI systems should be selected for a given system, system-of-systems, component, or the like. These metrics may be calculated using the data available to the digital twin through its processing functions (such as real time information about the user, available human workers, resource availability for AI systems, contextual and environmental information, information about states and activities of the entities involved in various workflows and the like) as well as by using external data sources, such as data indicating performance metrics for individuals (which may include the general population or domain experts, groups (which may include expert groups, crowds (including by crowdsourcing as disclosed elsewhere herein)) or for AI systems (including how the systems perform under various resource conditions). Metrics may include indicators of training history, such as educational experience, work experience, and job reviews, among many others, for humans. Metrics may include training data or metadata for artificial intelligence systems, including the size of the training data set, the vintage of the training data set, the configuration of neural networks used in training, the presence or absence of synthetic data in the training data set, metrics indicating the quality of the training data set (including indicators of bias, autocorrelation, heteroskedasticity or other statistical or econometric indicators), metrics about the expertise or capabilities of the human beings used to seed and/or supervise the AI systems, and many others. As an example, two similar generative AI systems may be presented along with indicators of the time period over which they were trained, allowing a user to evaluate whether the AI systems are likely to miss important context (e.g., where training data from a time period outside one of the sets is likely to have a major influence on the outcome) or generate hallucinations (such as where a spike in unusual training data during a training period may have unduly swayed results). Thus, in embodiments, provided herein is a digital twin system that displays a set of training metrics for a set of humans that are available to perform a set of decision making tasks for a set of entities presented in the digital twin. Also provided herein, in embodiments, is a digital twin system that displays a set of training metrics for a set of hybrid human-AI systems that are available to perform a set of decision making tasks for a set of entities presented in the digital twin. Also provided herein, in embodiments, is a digital twin system that displays a set of training metrics for a set of AI systems that are available to perform a set of decision making tasks for a set of entities presented in the digital twin.

In embodiments, metrics provided within the digital twin may include performance metrics for one or more sets of human and AI entities. Human performance metrics may include metrics for individuals, experts, and groups (including crowds) of the many types, and collected by the many methods and systems, disclosed herein and in the documents incorporated by reference. For individuals, these may include various cognitive, neurometric, psychometric, emotional, attention and other metrics, including ones disclosed herein and in the documents incorporated herein, including collected by neuro-metric measurement systems (e.g., EEG, fMRI and other scanning systems), genomic and transportomics systems, psychometric testing, physiological monitoring systems (including wearable sensors, cameras, IoT systems and many others as disclosed throughout this disclosure), systems for detecting emotional state (e.g., anxiety, distress, anger, calm and others, and others), systems for measuring attention, and others. Human performance metrics may also include metrics of task performance, including quality metrics, output metrics, job assessment metrics, indicators of specific skills, expertise or competencies (e.g., educational credentials, publications and certifications), indicators of success (e.g., rates of return of a business led by the individual) and many others. Human metrics can include metrics for groups, including crowds; for example, outcome metrics from a crowdsourcing system that accumulates the “wisdom of the crowd” for a set of predictions, ideas, solutions, or the like can be compared to those of individual experts and those of various AI systems (including standalone systems and human-AI combinations). AI performance metrics may include a wide range of metrics, including metrics of predictive accuracy, metrics indicating outcomes from use of the systems (including ones accounting for context of use), metrics of computational speed and latency, metrics of resource utilization (e.g., computation, energy, network resources, and the like), and many others. In embodiments, the digital twin may present comparative metrics across human, human-AI combinations and autonomous AI systems (including multiple options for each), so that a user of the digital twin can select, accounting for context of use, an appropriate configuration. Thus, provided herein, in embodiments, is a digital twin system that displays a set of performance metrics for a set of humans that are available to perform a set of decision making tasks for a set of entities presented in the digital twin. Also provided herein, in embodiments, is a digital twin system that displays a set of performance metrics for a set of hybrid human-AI systems that are available to perform a set of decision making tasks for a set of entities presented in the digital twin. Also provided herein, in embodiments, is a digital twin system that displays a set of performance metrics for a set of AI systems that are available to perform a set of decision making tasks for a set of entities presented in the digital twin. Also provided herein, in embodiments, is a digital twin system that displays a set of comparative performance metrics among one or more of a set of individual humans, a human-led enterprise, a crowd of humans, a human-AI combination system, or a set of AI systems that are available to perform a set of decision making tasks for a set of entities presented in the digital twin.

It should be noted that an intelligent agent (referred to in some cases herein as an opportunity miner) can be used to discover sets of available sets of humans, human-AI combinations, and/or artificial intelligence systems that may be capable of improving outcomes of one or more systems, systems-of-systems or other entities represented in the digital twin. In embodiments, a user of a digital twin may configure a set of intelligent agents to undertake discovery based on prioritization by the user, such as where a user flags elements of an enterprise workflow that are perceived (or determined by metrics) to be most in need of improvement, or most likely to benefit from artificial intelligence. Thus, a digital twin system may be used as a tool for exploration of applications of artificial intelligence as well as for configuring decisions around deployment of artificial intelligence once discovered. Thus, provided herein is an intelligent agent that automatically discovers sets of available systems, among human systems, combined human-AI systems and standalone artificial intelligence systems that are capable of performing a desired function. Also provided herein is a digital twin system having an embedded intelligent agent system that automatically discovers sets of available systems, among human systems, combined human-AI systems and standalone artificial intelligence systems that are capable of performing a desired function.

In embodiments, a user of a digital twin may configure a set of intelligent agents to undertake discovery based on prioritization by the user, such as where a user flags elements of an enterprise workflow that are perceived (or determined by metrics) to be most in need of improvement, or most likely to benefit from artificial intelligence.

In embodiments, an artificial intelligence system may be trained, such as based on a set of human decisions, a set of outcomes, or the like, and used to configure (or recommend configuration of) deployment of one or more appropriate sets of human, human-AI combinations and autonomous AI systems. This deployment configuration system for artificial intelligence may be integrated or embedded as an enabling service or utility within a digital twin, or it may be a standalone system used to determine what options are to be presented to a user of a digital twin. Thus, provided herein is an intelligent agent that operates as a deployment configuration system to at least one of recommend a set of deployment configuration parameters for or automatically configure a set of deployment parameters for a set of human, human-AI combinations or autonomous AI systems. Also provided herein is a digital twin system having an integrated intelligent agent that operates as a deployment configuration system to at least one of recommend a set of deployment configuration parameters for or automatically configure a set of deployment parameters for a set of human, human-AI combinations or autonomous AI systems.

In embodiments, the various discovery and configuration systems noted above may be based on general metrics of performance (e.g., comparing how humans in general perform relative to artificial intelligence systems at performing particular tasks). In other embodiments, the comparison may be highly contextual and situational, such as comparing the capabilities of specific sets of individuals that will be available at the time of decision making and the capabilities of artificial intelligence systems that will be available, either to operate as standalone systems or to work in human-AI combinations (including the general performance capabilities of the AI systems, and also the available computational, networking, energy and other resources that will be needed to run them). Situational comparison can include contextual factors, such as time of day, workforce availability, market and environmental data, and many others, such that a discovery or configuration system can recommend an appropriate configuration for a particular system, at a given place and time. For example, a moderately expensive AI system that performs well autonomously may be recommended or selected for an overnight control task, where human experts are not likely to be available and where computational, energy, or other resources are less constrained (and less expensive). An intelligent agent, as noted above, may be configured to generate a recommendation, or a configuration, based on multi-factor optimization, using various decision frameworks noted above, including being trained on a set of human decisions and/or on feedback of outcomes from past configuration actions.

Thus, provided herein is an intelligent agent that operates as a deployment configuration system to at least one of recommend a set of deployment configuration parameters for or automatically configure a set of deployment parameters for a set of human, human-AI combinations or autonomous AI systems, wherein a deployment configuration is determined at least in part on a set of situational factors, the situational factors being among one or more of a set of availability factors for human resources or artificial intelligence resources, a set of capability factors for human resources or artificial intelligence resources, a set of resource availability factors for enabling a set of human resources or artificial intelligence resources, or a set of contextual or environmental factors for the system to which the configuration is to be deployed.

In embodiments, as noted throughout this disclosure, smart contracts can be integrated with one or more systems of a digital twin, such that they operate on input data (e.g., detection of various events) and produce outputs that reflect transactional terms embedded in the smart contract. This may include, for example, a set of smart contracts that set liability terms relating to the consequences of the outputs of a system to which the smart contract relates. For example, a smart contract may be configured such that the provider of an AI system embedded in the digital twin (or in a system to which the digital twin has access) agrees to provide indemnification, proof of insurance, acceptance of liability, or the like for some set of consequences of using the AI system. Such terms can also include various limitations (e.g., constraints on permitted use; limitations of liability), exclusions, restrictions, and the like, thus providing, in the digital twin, a mechanism for expressly allocating the consequences of selection of a particular mix of human and AI systems to the appropriate person or organization. By referencing the performance metrics noted above, operating in real time on operational and other data, a decision maker can be aided to make a rational decision about implementation of AI, guided by a more reliable estimation of the expected value of implementing a particular mix of human and AI systems, rather than being governed by emotional factors. Thus, provided herein are methods and systems having a smart contract system embedded in a digital twin that sets terms and conditions for liability resulting from the output of a system that is displayed in the digital twin. The system displayed in the digital twin may be an artificial intelligence system.

As good decisions made within a digital twin environment or other decision making platform lead to better outcomes, trust in the reliability of machine recommendations increases, which can be tested and validated by outcome metrics. Individuals, groups and enterprises can gradually migrate decision making from centralized authority to the operating environment and from human action through various degrees of supervision to autonomy, with appropriate checks and balances at all stages (automated governance), reversing direction when the situation calls for it. Over time as trust builds in the capabilities of artificial intelligence, or human-AI combinations, to outperform humans alone, an enterprise can increasingly close loops among information technology, operations technology, and artificial intelligence technologies, enabling low-latency, highly efficient, well governed autonomous response to changing conditions at the operational level. Operators that don't ultimately close the loop will be slower than their competitors to respond to changing conditions, less efficient in their operations, and less effective in their decision making.

Individuals, groups and enterprises can unlock great benefits by properly distributing decision making and control where and when it is most effective throughout an enterprise, enabled by the integrated stack of technologies that enable a digital twin, each enhanced by artificial intelligence as described throughout this disclosure and the documents incorporated by reference herein. The true power of the convergence of information technology and operations technology (IT/OT convergence) can be realized when decision making is optimally distributed across humans and machines, an outcome that is achieved by progressively building trust in intelligence technologies and the people who supervise them. Organizations that progress more rapidly to a more optimal state will have significant competitive advantages in operational efficiency (particularly through closed loop automation) and agility to respond to shifting market and competitive dynamics.

In embodiments, various embodiments of digital twins, intelligent agents for discovery and configuration, decision making frameworks and other methods and systems disclosed herein may be used to facilitate configuration and allocation of decision making across the various resources, entities, activities, operations, transactions, offerings and workflows involved in various energy and computational environments described throughout this disclosure and the documents incorporated by reference herein.

### Energy Edge Graph Neural Networks

In embodiments, various embodiments of energy edge architectures and distributed energy resources (DERs) are represented by one or more graph neural networks.

In some aspects, the techniques described herein relate to an AI-based platform for enabling intelligent orchestration and management of power and energy, wherein the AI-based platform includes a graph neural network including a set of nodes respectively representing at least one distributed energy resource (DER) and a set of edges respectively interconnecting the set of nodes, wherein each edge represents at least one energy-related feature among at least two nodes of the set of nodes. The at least one node of the set of nodes includes information about the at least one distributed energy resource, and the information includes at least one of a power generation capability of the at least one distributed energy resource, a power storage capability of the at least one distributed energy resource, a power transmission capability of the at least one distributed energy resource, a power exchange capability of the at least one distributed energy resource, a power conversion capability of the at least one distributed energy resource, a power delivery capability of the at least one distributed energy resource, or a power consumption capability of the at least one distributed energy resource. At least one node of the set of nodes indicates information about at least one energy-related pattern associated with at least one distributed energy resource, and the at least one energy-related pattern includes at least one of, an energy demand pattern, an energy supply pattern, an energy storage capacity pattern, an energy market price pattern, an energy availability pattern, or an energy emissions pattern. At least one edge included in the graph neural network representing an energy-related feature among at least two nodes indicates at least one energy-related relationship among the at least two nodes, and the at least one energy-related relationship includes at least one of, an electrical connection relationship among the at least two nodes, a power transmission capability relationship among the at least two nodes, a power transfer relationship among the at least two nodes, a power exchange relationship among the at least two nodes, a power conversion relationship among the at least two nodes, a power generation dependency relationship among the at least two nodes, a power supply dependency relationship among the at least two nodes, a power delivery dependency relationship among the at least two nodes, a power storage dependency relationship among the at least two nodes, or a power consumption dependency relationship among the at least two nodes. At least one edge included in the graph neural network is a directed edge, and a direction of the directed edge represents a directional dependency relationship among at least two nodes of the set of nodes. At least one edge included in the graph neural network representing an energy-related feature among at least two nodes indicates at least one energy-related event, and the at least one energy-related event includes at least one of, an energy generation event associated with the at least two nodes, an energy storage event associated with the at least two nodes, an energy transmission event associated with the at least two nodes, an energy supply event associated with the at least two nodes, an energy demand event associated with the at least two nodes, an energy surplus event associated with the at least two nodes, an energy shortage event associated with the at least two nodes, an energy consumption event associated with the at least two nodes, an energy emissions event associated with the at least two nodes, or an energy leakage event associated with the at least two nodes. The AI-based platform may further include at least one artificial intelligence model configured to generate the graph neural network based on data associated with at least one distributed energy resource. The data associated with the at least one distributed energy resource includes at least one of, energy generation data associated with the at least one distributed energy resource, energy storage data associated with the at least one distributed energy resource, energy transmission data associated with the at least one distributed energy resource, energy supply data associated with the at least one distributed energy resource, energy demand data associated with the at least one distributed energy resource, energy surplus data associated with the at least one distributed energy resource, energy shortage data associated with the at least one distributed energy resource, energy consumption data associated with the at least one distributed energy resource, energy emissions data associated with the at least one distributed energy resource, or energy leakage data associated with the at least one distributed energy resource. The data associated with the at least one distributed energy resource includes at least one of, historical data that indicates at least one historical feature associated with the at least one distributed energy resource, current data that indicates at least one current feature associated with the at least one distributed energy resource, or forecasted data that indicates at least one forecasted feature associated with the at least one distributed energy resource. At least one distributed energy resources represented by at least one node of the graph neural network represents at least one of, a wind turbine, a solar photovoltaic (PV), a flexible solar energy system, a floating solar energy system, a solar energy farm, a fuel cell, a coal mine, a petroleum well, a natural gas well, a modular nuclear reactor, a nuclear battery, a modular hydropower system, a microturbine, a turbine array, a reciprocating engine, a combustion turbine, a cogeneration plant, a biomass generator, a municipal solid waste incinerator, a battery storage system, a capacitive energy storage system, a geothermal energy system, a molten salt energy storage system, an electro-thermal energy storage (ETES) system, a gravity-based storage system, a compressed fluid energy storage, a pumped hydroelectric energy storage (PHES) system, a liquid air energy storage (LAES) system, a coal storage facility, a petroleum storage tank, a natural gas storage tank, a liquefied natural gas (LNG) storage tank, a flywheel, a gravity battery, a fuel transport vehicle, a fuel transport pipeline, a wired power transmission system, or a wireless power transmission system.

In some aspects, the techniques described herein relate to an AI-based platform for enabling intelligent orchestration and management of power and energy, wherein the AI-based platform includes a supply graph neural network a set of nodes respectively representing at least one distributed energy resource (DER) configured to generate, store, convert, and/or transport energy, a demand graph neural network a set of nodes respectively representing at least one distributed energy resource (DER) configured to consume energy. The AI-based platform may further include an AI-based energy orchestration model configured to reserve at least one energy supply capability of at least one node of the supply graph neural network for at least one energy demand of at least one node of the demand graph neural network. The AI-based platform may further include an AI-based energy orchestration model configured to orchestrate and manage power and energy by meshing the supply graph neural network and the demand graph neural network. The AI-based energy orchestration model may mesh the supply graph neural network and the demand graph neural network by matching each node of the demand graph neural network with at least one node of the supply graph neural network. The AI-based energy orchestration model may mesh the supply graph neural network and the demand graph neural network based on an energy-related event graph neural network, wherein the energy-related event graph neural network includes, a set of nodes respectively representing at least one energy-related event involving at least one node of the supply graph neural network and/or at least one node of the demand graph neural network, and a set of edges respectively associated with at least two nodes of the energy-related event graph neural network. The AI-based energy orchestration model may be configured to generate the energy-related event graph neural network based on at least one interaction among at least one node of the supply graph neural network and/or at least one node of the demand graph neural network.

In some aspects, the techniques described herein relate to an AI-based platform for enabling intelligent orchestration and management of power and energy, wherein the AI-based platform includes at least one digital twin representing at least one distributed energy resource (DER), and a graph neural network including a set of nodes associated with at least one digital twin and a set of edges respectively interconnecting the set of nodes. The AI-based platform may include at least one artificial intelligence model configured to generate the graph neural network based on data indicated by the at least one digital twin. The data indicated by the at least one digital twin may include at least one of, energy generation data associated with the at least one distributed energy resource, energy storage data associated with the at least one distributed energy resource, energy transmission data associated with the at least one distributed energy resource, energy supply data associated with the at least one distributed energy resource, energy demand data associated with the at least one distributed energy resource, energy surplus data associated with the at least one distributed energy resource, energy shortage data associated with the at least one distributed energy resource, energy consumption data associated with the at least one distributed energy resource, energy emissions data associated with the at least one distributed energy resource, or energy leakage data associated with the at least one distributed energy resource. The data associated with the at least one distributed energy resource includes at least one of, historical data that indicates at least one historical feature associated with the at least one distributed energy resource, current data that indicates at least one current feature associated with the at least one distributed energy resource, or forecasted data that indicates at least one forecasted feature associated with the at least one distributed energy resource. The at least one digital twin may be associated with at least one node of the graph neural network representing at least one of, a wind turbine, a solar photovoltaic (PV), a flexible solar energy system, a floating solar energy system, a solar energy farm, a fuel cell, a coal mine, a petroleum well, a natural gas well, a modular nuclear reactor, a nuclear battery, a modular hydropower system, a microturbine, a turbine array, a reciprocating engine, a combustion turbine, a cogeneration plant, a biomass generator, a municipal solid waste incinerator, a battery storage system, a capacitive energy storage system, a geothermal energy system, a molten salt energy storage system, an electro-thermal energy storage (ETES) system, a gravity-based storage system, a compressed fluid energy storage, a pumped hydroelectric energy storage (PHES) system, a liquid air energy storage (LAES) system, a coal storage facility, a petroleum storage tank, a natural gas storage tank, a liquefied natural gas (LNG) storage tank, a flywheel, a gravity battery, a fuel transport vehicle, a fuel transport pipeline, a wired power transmission system, or a wireless power transmission system. The AI-based platform may perform at least one simulation of energy-related events based on the graph neural network, wherein the at least one simulation is based on a simulation of at least one distributed energy resource by at least one digital twin.

In some aspects, the techniques described herein relate to an AI-based platform for enabling intelligent orchestration and management of power and energy, wherein the AI-based platform includes a graph neural network including a set of nodes respectively representing at least one distributed energy resource (DER) and a set of edges respectively interconnecting the set of nodes, and an attention model that indicates at least one attention relationship among at least two nodes of the set of nodes of the graph neural network. The attention model may further include a dependency model that indicates at least one energy-related dependency relationship among at least two nodes of the set of nodes of the graph neural network, and the dependency model is based on the set of edges interconnecting the set of nodes. The AI-based platform may include an AI-based energy orchestration model that is configured to orchestrate and manage power and energy among the at least one distributed energy resource based on the dependency model. The attention model may further include an energy flow model that indicates a flow of energy among at least two nodes of the set of nodes of the graph neural network, and the energy flow model is based on the set of edges interconnecting the set of nodes. The platform may include an AI-based energy orchestration model that is configured to orchestrate and manage power and energy among the at least one distributed energy resource based on the energy flow model.

In some aspects, the techniques described herein relate to an AI-based platform for enabling intelligent orchestration and management of power and energy, wherein the AI-based platform includes a graph neural network including a set of nodes respectively representing at least one distributed energy resource (DER) and a set of edges respectively interconnecting the set of nodes, and a large language model configured to generate at least one description of the set of nodes and the set of edges included in the graph neural network. The large language model may include at least one transformer model. The at least one description generated by the large language model includes at least one of, a description of at least one energy-related capability of at least one distributed energy resource associated with at least one node of the set of nodes, a description of an aggregated energy-related capability based on at least a portion of the set of nodes, a description of an energy-related cost of at least one distributed energy resource associated with at least one node of the set of nodes, a description of an aggregated energy-related cost based on at least a portion of the set of nodes, a description of an energy-related deficiency of the at least one distributed energy resource, a description of an aggregated energy-related deficiency based on at least a portion of the set of nodes, a description of an energy-related event associated with at least one node of the set of nodes, or a description of an aggregated energy-related event based on at least a portion of the set of nodes. The at least one description generated by the large language model may be based on at least one prompt, and the at least one prompt is associated with at least one of, at least one distributed energy resource associated with the graph neural network, at least one distributed energy capability associated with the graph neural network, at least one distributed energy feature associated with the graph neural network, or at least one energy-related event associated with the graph neural network. The AI-based platform may further include an AI-based energy orchestration model configured to orchestrate and manage power and energy among the at least one distributed energy resource based on the at least one description generated by the large language model. The AI-based platform may further include an AI-based energy presentation model that presents the at least one description of at least one distributed energy resource based on the at least one description generated by the large language model.

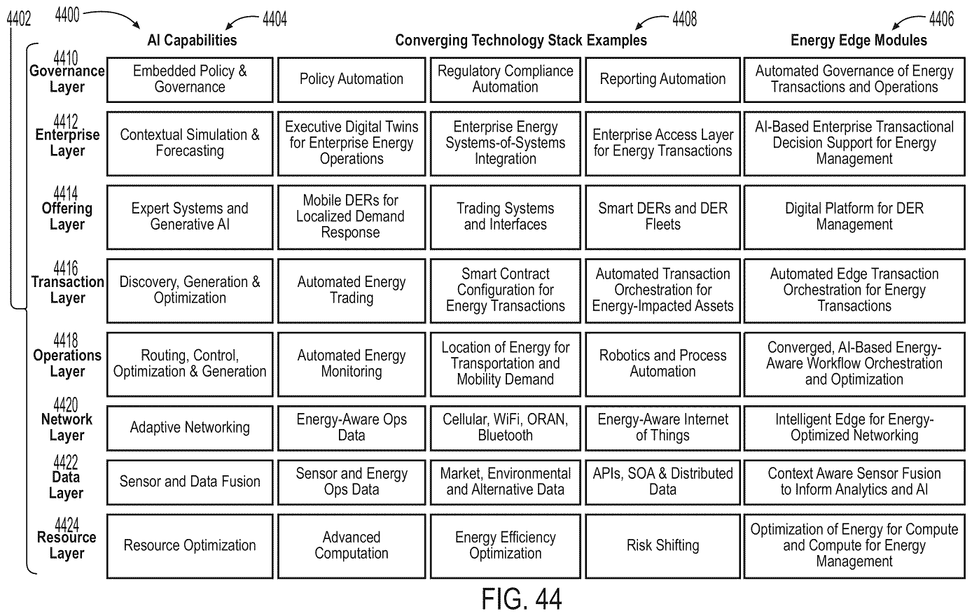

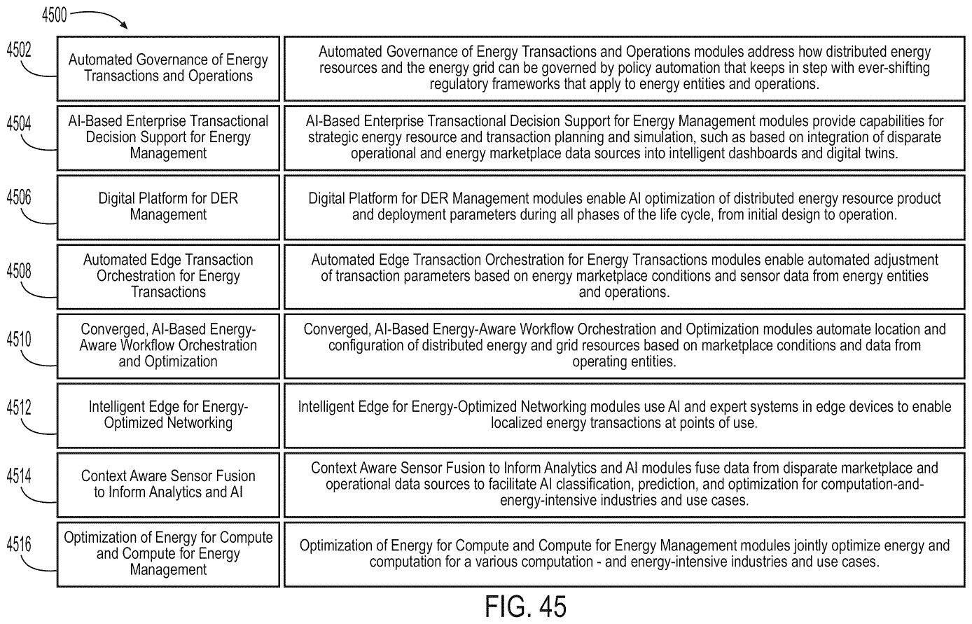

### FIGS. 44 and 45: Energy Edge Converging Technology Stack

Referring to FIG. 44, an energy edge converging technology stack 4400 is illustrated in accordance with some embodiments. A plurality of energy edge modules 4406 are increasingly enabled at various layers 4402 by the convergence of AI capabilities 4404 with other technologies, impacting energy edge operations. In some cases, entirely new energy edge operations are made possible.

Technology convergence enables various energy edge operations, which support use cases or converging technology stack examples 4408 for a multitude of energy edge scenarios.

The energy edge modules 4406 include automated governance of energy transactions and operations at the governance layer 4410, AI-based enterprise transactional decision support for energy management at the enterprise layer 4412, digital platform for DER management at the offering layer 4414, automated edge transaction orchestration for energy transactions at the transaction layer 4416, converged AI-based energy aware workflow orchestration and optimization at the operations layer 4418, intelligent edge for energy-optimized networking at the network layer 4420, context aware sensor fusion to inform analytics and AI at the data layer 4422, and optimization of energy for compute and compute for energy management at the resource layer 4424.

At the governance layer 4410, AI capabilities 4404 for embedded policy and governance enable the automated governance of energy transactions and operations modules 4406 for automated governance of transactions and operations. Converging technology stack examples 4408 at the governance layer 4410 include policy automation, regulatory compliance automation, and reporting automation. The automated governance of energy transactions and operations modules address how distributed energy resources and the energy grid can be governed by policy automation that keeps in step with ever-shifting regulatory frameworks that apply to energy entities and operations.

In embodiments, an automated governance of energy transactions and operations module is underpinned by advanced embedded policy and governance artificial intelligence (AI) capabilities. The module may be designed to autonomously enforce compliance and governance standards across energy transactions and operations by leveraging a sophisticated AI framework. The AI system is adept at interpreting and applying a comprehensive array of regulatory requirements, internal control policies, and industry standards to real-time transactional and operational data flows. The module utilizes machine learning algorithms to continuously monitor, analyze, and make determinations on the compliance status of each transaction, thereby ensuring adherence to the pertinent legal and regulatory frameworks. The AI-driven module may dynamically adapt to regulatory changes, thereby maintaining up-to-date compliance. Furthermore, the module may automate the generation of detailed compliance reports and maintain an immutable audit trail for each transaction, thereby facilitating transparency and accountability. By embedding these AI capabilities directly within the transactional and operational infrastructure, the module significantly enhances the efficiency, accuracy, and reliability of the governance process, while simultaneously mitigating risk and reducing the operational burden associated with manual governance and compliance checks.

At the enterprise layer 4412, AI capabilities 4404 for contextual simulation and forecasting enable a financial infrastructure module 4406 for AI-based enterprise transactional decision support for energy management. Converging technology stack examples 4408 at the enterprise layer 4412 include executive digital twins for enterprise energy operations, enterprise energy system-of-systems integration, and an enterprise access layer for energy transactions. AI-based enterprise transactional decision support for energy management modules provides provide capabilities for strategic energy resources and transaction planning and simulation, such as based on integration of disparate operational and energy marketplace data sources into intelligent dashboards and digital twins.

In embodiments, an AI-based enterprise transactional decision support for energy management module is empowered by contextual simulation and forecasting capabilities. This module integrates a sophisticated artificial intelligence framework that utilizes contextual data analysis to simulate various transactional scenarios and forecast potential outcomes. By processing vast datasets, including historical energy transaction records, current energy market trends, and predictive indicators, the AI system can generate comprehensive models that provide deep insights into the potential ramifications of different transactional strategies. The module's forecasting engine employs advanced algorithms to predict future energy market conditions, financial performance, and risk exposure, thereby enabling enterprises to make informed decisions. The contextual simulation aspect allows for the creation of virtual environments where hypothetical energy transactional decisions can be tested, providing a sandbox for strategic planning without the risk of actual financial commitment. This AI-driven decision support tool is designed to assist enterprises in optimizing their transactional workflows for energy management, aligning financial strategies with business objectives, and proactively managing risks, thereby enhancing the overall efficacy and strategic agility of the enterprise's energy management operations.

At the offering layer 4414, AI capabilities 4404 for expert systems and generative AI enable a digital platform for DER management module 4406 for management of DERs. Converging technology stack examples 4408 at the offering layer 4414 include mobile DERs for localized demand response, trading systems and interfaces, and smart DERs and DER fleets. The digital platform for DER management modules enable AI optimization of DER product and deployment parameters during all phases of the DER lifecycle, from initial design to operation.

In embodiments, a digital platform for DER management module leverages the combined strengths of expert systems and generative artificial intelligence (AI) to deliver strategic transaction and energy operation offerings. Expert systems within the module utilize a rule-based approach to analyze energy profiles and transaction histories, enabling the identification of energy transaction and operation needs and preferences. Concurrently, generative AI algorithms may synthesize this data to create and propose energy operations and transaction offerings. This dual-faceted AI approach ensures that offerings and proposed operations and transactions are not only relevant but also creatively adapted to present and predicted future circumstances. The module seamlessly integrates with energy edge devices such as DERs. The transaction systems user interface is designed to be intuitive, providing users with a clear and interactive platform to view and manage these offerings. Furthermore, the targeting and recommendation use cases may be implemented through a dynamic feedback loop, where interactions with the offerings and proposals are continuously fed back into the system, refining the AI models to enhance future offering and proposal accuracy and efficacy. This sophisticated module thus represents a significant advancement in the customization and delivery of energy offerings and proposals, driving value for users of energy edge devices and platforms.

At the transaction layer 4416, AI capabilities 4404 for discovery, generation, and optimization enable an automated edge transaction orchestration for energy transactions module 4406 for automated transaction orchestration. Converging technology stack examples 4408 at the transaction layer 4416 include automated energy trading, smart contract configuration for energy transactions, and automated transaction orchestration for energy-impacted assets. Automated edge transaction orchestration for energy transactions modules enable automated adjustment of transaction parameters based on energy marketplace conditions and sensor data from energy entities and operations.

In embodiments, an automated edge transaction orchestration for energy transactions module is fundamentally enabled by artificial intelligence (AI) capabilities specializing in discovery, generation, and optimization. This module employs AI to intelligently navigate the vast landscape of potential transactional partners, utilizing data-driven insights to facilitate counterparty discovery. The module analyzes market behaviors, transactional histories, and compatibility metrics to recommend optimal transactional matches, thereby streamlining the process of identifying suitable counterparties. Once a counterparty is identified, the module may leverage generative AI to configure smart contracts that encapsulate the terms of the energy transaction, ensuring that all contractual obligations are met with precision and in accordance with predefined regulatory and compliance standards. The optimization AI may further refine this process by assessing various transactional parameters and adjusting the smart contract terms in real-time to maximize efficiency and minimize risk. The automated transaction orchestration use case is implemented through a combination of machine learning algorithms that predict transactional outcomes, natural language processing for contract generation, and neural networks that adaptively learn from each transaction to enhance future performance. Technical solutions for the implementation may include blockchain technology for secure and transparent smart contract execution, distributed ledgers for maintaining a consistent and immutable record of transactions, and cloud-based computing resources that provide the necessary scalability and computational power to process complex AI algorithms. This module thus represents a convergence of AI and energy transaction technology, offering a robust solution for automating and optimizing transactional workflows within the energy sector.

At the operations layer 4418, AI capabilities 4404 for routing, control, optimization, and generation enable a converged, AI-based energy-aware workflow orchestration and optimization module 4406 for converged, AI-based energy transaction and operation orchestration. Converging technology stack examples 4408 at the operations layer 4418 include automated energy monitoring, location of energy for transportation and mobility demand, and robotics and process automation. Converged, AI-based energy-aware workflow orchestration and optimization modules automate location and configuration of distributed energy and grid resources based on marketplace conditions and data from operation entities.

In embodiments, a converged, AI-based energy-aware workflow orchestration and optimization module is enabled by sophisticated artificial intelligence (AI) capabilities in routing, control, optimization, and generation. This module utilizes AI to oversee and manage the entire lifecycle of energy transactions and operations, from initiation to completion. For automated energy transaction and operation monitoring, the module may deploy AI algorithms that track the progress of transactions and operations in real-time, identifying bottlenecks and anomalies that could indicate potential issues and automatically initiating corrective actions. The module may apply machine learning techniques to assess risk profiles by analyzing vast datasets, thereby streamlining energy transactions and operations and reducing risks of failure. Robotics and process automation may be implemented to execute repetitive and rule-based tasks within the energy transaction and operation workflow, such as data entry and compliance checks, with robotic process automation (RPA) bots acting as digital workers that interact with various systems and databases. Technical solutions may include deep neural networks for pattern recognition and predictive analytics, natural language processing for interpreting unstructured data within transaction documents and operations records, and blockchain technology for secure and immutable transaction and operation event recording. Additionally, cloud computing may provide the scalable infrastructure necessary to support the computational demands of the AI models, while API integrations may facilitate seamless communication between disparate energy systems. Collectively, these AI-driven capabilities and technical solutions may empower the module to orchestrate complex energy transaction and operation workflows with enhanced efficiency, accuracy, and compliance.

At the network layer 4420, AI capabilities 4404 for adaptive networking enable an intelligent edge for energy-optimized networking module 4406 for intelligent edge for distributed energy transactions and operations. Converging technology stack examples 4408 at the network layer 4420 include energy-aware edge and cloud cellular, Wi-Fi, ORAN, Bluetooth, and energy-aware internet of things. Intelligent edge for energy-optimized networking modules use AI and expert systems in edge devices to enable localized energy transactions at points of use.

In embodiments, an intelligent edge for energy-optimized networking module is innovatively enabled by adaptive networking artificial intelligence (AI). This module is designed to facilitate seamless and secure energy transactions and operations across a distributed network by leveraging AI to dynamically adapt network configurations and optimize data flow. The integration of edge computing with cloud services ensures that transaction processing and operation orchestration can occur closer to the data source, reducing latency and enhancing real-time decision-making capabilities. The module's AI algorithms are capable of intelligently routing transaction data through the most efficient network paths, whether they be cellular, Wi-Fi, Open Radio Access Network (ORAN), Bluetooth, or other IoT communication protocols. For implementation, the module may utilize technical features such as machine learning for predictive network traffic management, ensuring bandwidth is allocated where needed most, and cryptographic techniques for securing data at the edge. Additionally, the module may employ AI-driven anomaly detection systems to monitor network health and preemptively address potential disruptions. The use of containerization and microservices architectures allows for rapid deployment and scaling of transaction processing capabilities across the network. By integrating these technical features, the intelligent edge module provides a robust infrastructure capable of supporting the complex requirements of modern distributed energy transactions and operations, ensuring that they are executed swiftly, reliably, and in compliance with regulatory standards.

At the data layer 4422, AI capabilities 4404 for sensor data and fusion enable a context aware sensor fusion to inform analytics and AI module 4406 for context aware sensor fusion to inform energy transaction and operation analytics and AI. Converging technology stack examples 4408 at the data layer 4422 include sensor and energy operations data, market, environmental, and alternative data, and APIs, SOA and distributed data. Context aware sensor fusion to inform analytics and AI modules fuse data from disparate marketplace and operational data sources to facilitate AI classification, prediction, and optimization for computation- and energy-intensive industries and use cases.

In embodiments, a context aware sensor fusion to inform analytics and AI module is enabled by the integration of sensor fusion technology. This module is adept at synthesizing diverse data streams, including real-time sensor data, regional and local energy analytics, and web data, to provide a comprehensive view of energy transactional and operational environments. By employing sensor fusion, the module may aggregate and process data from various sources, such as IoT devices, energy edge device logs, and energy operational data to generate a multidimensional context for each transaction and operation. The use of APIs and Service-Oriented Architecture (SOA) facilitates the seamless integration and exchange of data across distributed systems, ensuring that the module has access to the most relevant and up-to-date information. Technical features for implementation may include advanced data normalization techniques to harmonize disparate data formats, machine learning algorithms for pattern recognition and predictive analytics within the fused data sets, and robust data security protocols to protect sensitive transactional information. The AI component of the module may utilize the enriched data to enhance transaction and operation analytics, providing insights into energy infrastructure and device behavior, energy market trends, and potential risks. By leveraging these technical features, the context aware sensor fusion module may significantly improve the accuracy and reliability of energy transaction and operation analytics, enabling users to make data-driven decisions with greater confidence and strategic foresight.

At the resource layer 4424, AI capabilities 4404 for resource optimization enable an optimization of energy for compute and compute for energy management module 4406 for energy and computational resource optimization. Converging technology stack examples 4408 at the resource layer 4424 include advanced computation, energy efficiency optimization, and risk shifting. Optimization of energy for compute and compute for energy management modules jointly optimize energy and computation for various computation- and energy-intensive industries and use cases.

In embodiments, an optimization of energy for compute and compute for energy management module is enhanced by resource optimization AI. The module may be designed to optimize the allocation and utilization of both energy and computational resources through the application of advanced AI algorithms. In the context of advanced computation, the module may employ AI to dynamically allocate processing power and memory resources across various energy applications, ensuring optimal performance and cost-efficiency. For energy efficiency optimization, the AI may analyze energy efficiency ratios and metrics in real-time, adjusting investment strategies and capital distributions to balance returns against risk exposure. Risk shifting may be achieved through AI-driven models that predict energy market volatility and credit risk, enabling proactive rebalancing of portfolios to mitigate potential losses. Technical features enabling these implementations may include deep learning networks for complex energy modeling, real-time analytics engines for monitoring resource utilization, and evolutionary algorithms that adapt energy strategies to changing market conditions. Additionally, the module may incorporate distributed ledger technology for transparent tracking of resource allocation decisions and smart contracts for the automated execution of optimization strategies. By integrating these technical features, the resource optimization modules provide a sophisticated framework for maximizing the efficiency and effectiveness of energy and computational resource management within the energy sector.

Referring to FIG. 45, a set of capabilities 4500 of an energy edge convergence technology stack is illustrated in accordance with some embodiments. It may be appreciated that energy edge convergence technology stack may exhibit a wide range of capabilities when implemented in various contexts and/or with various resources. FIG. 45 presents an example set of such capabilities, which may be better understood in the context of more specific examples and embodiments presented herein. It is to be appreciated that an example embodiment of the energy edge convergence technology stack may exhibit one or more the following capabilities as may be relevant to a context in which the energy edge convergence technology stack is and/or will be deployed, used, managed, or the like.

As shown, an energy edge convergence technology stack may include one or more modules that perform automated governance of energy transactions and operations 4502. In this context, such modules may provide capabilities for addressing how distributed energy resources and the energy grid can be governed by policy automation that keeps in step with ever-shifting regulatory frameworks that apply to energy entities and operations.

As shown, an energy edge convergence technology stack may include one or more modules that provide AI-based enterprise transactional decision support for energy management 4504. In this context, such modules may provide capabilities for strategic energy resource and transaction planning and simulation, such as based on integration of disparate operational and energy marketplace data sources into intelligent dashboards and digital twins.

As shown, an energy edge convergence technology stack may include one or more modules that provide a digital platform for distributed energy resources (DER) management 4506. In this context, such modules may provide capabilities for enabling AI optimization of distributed energy resource product and deployment parameters during all phases of the life cycle, from initial design to operation.

As shown, an energy edge convergence technology stack may include one or more modules that perform automated edge transaction orchestration for energy transactions 4508. In this context, such modules may provide capabilities for enabling automated adjustment of transaction parameters based on energy marketplace conditions and sensor data from energy entities and operations.

As shown, an energy edge convergence technology stack may include one or more modules that perform converged, AI-based energy-aware workflow orchestration and optimization 4510. In this context, such modules may provide capabilities for automating a determination of locations and/or configurations of distributed energy and grid resources based on marketplace conditions and data from operating entities.

As shown, an energy edge convergence technology stack may include one or more modules that provide an intelligent edge for energy-optimized networking 4512. In this context, such modules may provide capabilities for using AI and expert systems in edge devices to enable localized energy transactions at points of use.

As shown, an energy edge convergence technology stack may include one or more modules that perform context-aware sensor fusion to inform analytics and AI 4514. In this context, such modules may provide capabilities for fusing data from disparate marketplace and operational data sources to facilitate AI classification, prediction, and optimization for computation- and energy-intensive industries and use cases.

As shown, an energy edge convergence technology stack may include one or more modules that perform optimization of energy for compute and/or optimization of compute for energy management 4516. In this context, such modules may provide capabilities for jointly optimizing energy and computation for a various computation- and energy-intensive industries and use cases.

### Additional Exemplary Embodiments

### AI-Based Energy Edge Platform

In embodiments, provided herein is an AI-based platform for enabling intelligent orchestration and management of power and energy. In embodiments, provided herein is an AI-based platform for enabling intelligent orchestration and management of power and energy and having a system for communicating data across a set of nodes in a network, wherein each node is adapted to operate on an energy data set of energy generation, storage or consumption data, wherein a set of nodes is configured with at least one of an algorithm or a rule set for filtering, compressing, or routing the energy data set based on at least one of network conditions, network error correction requirements, data size, data granularity, or data content. In embodiments, provided herein is an AI-based platform for enabling intelligent orchestration and management of power and energy and having a system for communicating data across a set of nodes in a network, wherein at least a subset of nodes are configured with at least one of a rule or an algorithm that is adapted to set at least one parameter of data communication based on a set of indicators of current network conditions in order to optimize energy used in the data communication. In embodiments, provided herein is an AI-based platform for enabling intelligent orchestration and management of power and energy and having a system for communicating data across a set of nodes in a network, wherein at least a subset of nodes are configured with at least one of a rule or an algorithm that is adapted to set a routing instruction for data communication based on a set of indicators of current network conditions in order to optimize energy used in the data communication. In embodiments, provided herein is an AI-based platform for enabling intelligent orchestration and management of power and energy and having a system for communicating data across a set of nodes in a network, wherein at least a subset of nodes are configured with at least one of a rule or an algorithm that is adapted to set a route parameter for data communication based on a set of indicators of current network conditions in order to optimize energy used in the data communication. In embodiments, provided herein is an AI-based platform for enabling intelligent orchestration and management of power and energy and having a system for communicating data across a set of nodes in a network, wherein at least a subset of nodes are configured with at least one of a rule or an algorithm that is adapted to set an error correction parameter for data communication based on a set of indicators of current network conditions in order to optimize energy used in the data communication. In embodiments, provided herein is an AI-based platform for enabling intelligent orchestration and management of power and energy and having a system for communicating data across a set of nodes in a network, wherein at least a subset of nodes are configured with at least one of a rule or an algorithm that is adapted to set a compression parameter for data communication based on a set of indicators of current network conditions in order to optimize energy used in the data communication. In embodiments, provided herein is an AI-based platform for enabling intelligent orchestration and management of power and energy and having a system for communicating data across a set of nodes in a network, wherein at least a subset of nodes are configured with at least one of a rule or an algorithm that is adapted to set a storage parameter for data communication based on a set of indicators of current network conditions in order to optimize energy used in the data communication. In embodiments, provided herein is an AI-based platform for enabling intelligent orchestration and management of power and energy and having a system for communicating data across a set of nodes in a network, wherein at least a subset of nodes are configured with at least one of a rule or an algorithm that is adapted to set a timing parameter for data communication based on a set of indicators of current network conditions in order to optimize energy used in the data communication. In embodiments, provided herein is an AI-based platform for enabling intelligent orchestration and management of power and energy and having an edge device artificial intelligence system for operating on data that is communicated through the edge device to optimize energy collectively used by the edge device and by a set of systems controlled by the edge device. In embodiments, provided herein is an AI-based platform for enabling intelligent orchestration and management of power and energy and having a system for automated and coordinated governance or provisioning of a set of grid energy facilities and a set of distributed edge energy resource sets that are electrically independent of the grid. In embodiments, provided herein is an AI-based platform for enabling intelligent orchestration and management of power and energy and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid. In embodiments, provided herein is an AI-based platform for enabling intelligent orchestration and management of power and energy and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by artificial intelligence processing of a data set. In embodiments, provided herein is an AI-based platform for enabling intelligent orchestration and management of power and energy and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by natural language processing of social data content. In embodiments, provided herein is an AI-based platform for enabling intelligent orchestration and management of power and energy and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by computer vision processing of satellite image content or web image content. In embodiments, provided herein is an AI-based platform for enabling intelligent orchestration and management of power and energy and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by automated processing of a set of energy transaction logs. In embodiments, provided herein is an AI-based platform for enabling intelligent orchestration and management of power and energy and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein the discovery of the grid-independent resources is by application of having an artificial intelligence system that is trained on a historical training data set of grid and off-grid energy pattern to recognize the presence of an off-grid energy resource. In embodiments, provided herein is an AI-based platform for enabling intelligent orchestration and management of power and energy and having an artificial intelligence system operating on a data set of energy generation, storage or consumption data for a set of infrastructure assets produced at least in part by a set of sensors contained in or governed by a set of edge devices to produce an output operating parameter for energy generation by at least one of the legacy infrastructure assets. In embodiments, provided herein is an AI-based platform for enabling intelligent orchestration and management of power and energy and having an artificial intelligence system operating on a data set of energy generation, storage or consumption data for a set of infrastructure assets produced at least in part by a set of sensors contained in or governed by a set of edge devices to produce an output operating parameter for energy storage for at least one of the legacy infrastructure assets. In embodiments, provided herein is an AI-based platform for enabling intelligent orchestration and management of power and energy and having an artificial intelligence system operating on a data set of energy generation, storage or consumption data for a set of infrastructure assets produced at least in part by a set of sensors contained in or governed by a set of edge devices to produce an output operating parameter for energy consumption by at least one of the legacy infrastructure assets. In embodiments, provided herein is an AI-based platform for enabling intelligent orchestration and management of power and energy and having a set of edge devices for collection of energy generation data for a set of infrastructure assets based on a set of sensors contained in or governed by the edge devices. In embodiments, provided herein is an AI-based platform for enabling intelligent orchestration and management of power and energy and having a set of edge devices for collection of energy storage data for a set of infrastructure assets based on a set of sensors contained in or governed by the edge devices. In embodiments, provided herein is an AI-based platform for enabling intelligent orchestration and management of power and energy and having a set of edge devices for collection of energy consumption data for a set of infrastructure assets based on a set of sensors contained in or governed by the edge devices. In embodiments, provided herein is an AI-based platform for enabling intelligent orchestration and management of power and energy and having a set of adaptive, autonomous data handling systems for energy edge data collection and transmission.

### Adaptive Energy Data Pipeline

In embodiments, provided herein is an AI-based platform for enabling intelligent orchestration and management of power and energy having a system for communicating data across a set of nodes in a network, wherein each node is adapted to operate on an energy data set of energy generation, storage or consumption data, wherein a set of nodes is configured with at least one of an algorithm or a rule set for filtering, compressing, or routing the energy data set based on at least one of network conditions, network error correction requirements, data size, data granularity, or data content. In embodiments, provided herein is an AI-based platform for enabling intelligent orchestration and management of power and energy having a system for communicating data across a set of nodes in a network, wherein each node is adapted to operate on an energy data set of energy generation, storage or consumption data, wherein a set of nodes is configured with at least one of an algorithm or a rule set for filtering, compressing, or routing the energy data set based on at least one of network conditions, network error correction requirements, data size, data granularity, or data content and having a system for communicating data across a set of nodes in a network, wherein at least a subset of nodes are configured with at least one of a rule or an algorithm that is adapted to set at least one parameter of data communication based on a set of indicators of current network conditions in order to optimize energy used in the data communication. In embodiments, provided herein is an AI-based platform for enabling intelligent orchestration and management of power and energy having a system for communicating data across a set of nodes in a network, wherein each node is adapted to operate on an energy data set of energy generation, storage or consumption data, wherein a set of nodes is configured with at least one of an algorithm or a rule set for filtering, compressing, or routing the energy data set based on at least one of network conditions, network error correction requirements, data size, data granularity, or data content and having a system for communicating data across a set of nodes in a network, wherein at least a subset of nodes are configured with at least one of a rule or an algorithm that is adapted to set a routing instruction for data communication based on a set of indicators of current network conditions in order to optimize energy used in the data communication. In embodiments, provided herein is an AI-based platform for enabling intelligent orchestration and management of power and energy having a system for communicating data across a set of nodes in a network, wherein each node is adapted to operate on an energy data set of energy generation, storage or consumption data, wherein a set of nodes is configured with at least one of an algorithm or a rule set for filtering, compressing, or routing the energy data set based on at least one of network conditions, network error correction requirements, data size, data granularity, or data content and having a system for communicating data across a set of nodes in a network, wherein at least a subset of nodes are configured with at least one of a rule or an algorithm that is adapted to set a route parameter for data communication based on a set of indicators of current network conditions in order to optimize energy used in the data communication. In embodiments, provided herein is an AI-based platform for enabling intelligent orchestration and management of power and energy having a system for communicating data across a set of nodes in a network, wherein each node is adapted to operate on an energy data set of energy generation, storage or consumption data, wherein a set of nodes is configured with at least one of an algorithm or a rule set for filtering, compressing, or routing the energy data set based on at least one of network conditions, network error correction requirements, data size, data granularity, or data content and having a system for communicating data across a set of nodes in a network, wherein at least a subset of nodes are configured with at least one of a rule or an algorithm that is adapted to set an error correction parameter for data communication based on a set of indicators of current network conditions in order to optimize energy used in the data communication. In embodiments, provided herein is an AI-based platform for enabling intelligent orchestration and management of power and energy having a system for communicating data across a set of nodes in a network, wherein each node is adapted to operate on an energy data set of energy generation, storage or consumption data, wherein a set of nodes is configured with at least one of an algorithm or a rule set for filtering, compressing, or routing the energy data set based on at least one of network conditions, network error correction requirements, data size, data granularity, or data content and having a system for communicating data across a set of nodes in a network, wherein at least a subset of nodes are configured with at least one of a rule or an algorithm that is adapted to set a compression parameter for data communication based on a set of indicators of current network conditions in order to optimize energy used in the data communication. In embodiments, provided herein is an AI-based platform for enabling intelligent orchestration and management of power and energy having a system for communicating data across a set of nodes in a network, wherein each node is adapted to operate on an energy data set of energy generation, storage or consumption data, wherein a set of nodes is configured with at least one of an algorithm or a rule set for filtering, compressing, or routing the energy data set based on at least one of network conditions, network error correction requirements, data size, data granularity, or data content and having a system for communicating data across a set of nodes in a network, wherein at least a subset of nodes are configured with at least one of a rule or an algorithm that is adapted to set a storage parameter for data communication based on a set of indicators of current network conditions in order to optimize energy used in the data communication. In embodiments, provided herein is an AI-based platform for enabling intelligent orchestration and management of power and energy having a system for communicating data across a set of nodes in a network, wherein each node is adapted to operate on an energy data set of energy generation, storage or consumption data, wherein a set of nodes is configured with at least one of an algorithm or a rule set for filtering, compressing, or routing the energy data set based on at least one of network conditions, network error correction requirements, data size, data granularity, or data content and having a system for communicating data across a set of nodes in a network, wherein at least a subset of nodes are configured with at least one of a rule or an algorithm that is adapted to set a timing parameter for data communication based on a set of indicators of current network conditions in order to optimize energy used in the data communication. In embodiments, provided herein is an AI-based platform for enabling intelligent orchestration and management of power and energy having a system for communicating data across a set of nodes in a network, wherein each node is adapted to operate on an energy data set of energy generation, storage or consumption data, wherein a set of nodes is configured with at least one of an algorithm or a rule set for filtering, compressing, or routing the energy data set based on at least one of network conditions, network error correction requirements, data size, data granularity, or data content and having an edge device artificial intelligence system for operating on data that is communicated through the edge device to optimize energy collectively used by the edge device and by a set of systems controlled by the edge device. In embodiments, provided herein is an AI-based platform for enabling intelligent orchestration and management of power and energy having a system for communicating data across a set of nodes in a network, wherein each node is adapted to operate on an energy data set of energy generation, storage or consumption data, wherein a set of nodes is configured with at least one of an algorithm or a rule set for filtering, compressing, or routing the energy data set based on at least one of network conditions, network error correction requirements, data size, data granularity, or data content and having a system for automated and coordinated governance or provisioning of a set of grid energy facilities and a set of distributed edge energy resource sets that are electrically independent of the grid. In embodiments, provided herein is an AI-based platform for enabling intelligent orchestration and management of power and energy having a system for communicating data across a set of nodes in a network, wherein each node is adapted to operate on an energy data set of energy generation, storage or consumption data, wherein a set of nodes is configured with at least one of an algorithm or a rule set for filtering, compressing, or routing the energy data set based on at least one of network conditions, network error correction requirements, data size, data granularity, or data content and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid. In embodiments, provided herein is an AI-based platform for enabling intelligent orchestration and management of power and energy having a system for communicating data across a set of nodes in a network, wherein each node is adapted to operate on an energy data set of energy generation, storage or consumption data, wherein a set of nodes is configured with at least one of an algorithm or a rule set for filtering, compressing, or routing the energy data set based on at least one of network conditions, network error correction requirements, data size, data granularity, or data content and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by artificial intelligence processing of a data set. In embodiments, provided herein is an AI-based platform for enabling intelligent orchestration and management of power and energy having a system for communicating data across a set of nodes in a network, wherein each node is adapted to operate on an energy data set of energy generation, storage or consumption data, wherein a set of nodes is configured with at least one of an algorithm or a rule set for filtering, compressing, or routing the energy data set based on at least one of network conditions, network error correction requirements, data size, data granularity, or data content and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by natural language processing of social data content. In embodiments, provided herein is an AI-based platform for enabling intelligent orchestration and management of power and energy having a system for communicating data across a set of nodes in a network, wherein each node is adapted to operate on an energy data set of energy generation, storage or consumption data, wherein a set of nodes is configured with at least one of an algorithm or a rule set for filtering, compressing, or routing the energy data set based on at least one of network conditions, network error correction requirements, data size, data granularity, or data content and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by computer vision processing of satellite image content or web image content. In embodiments, provided herein is an AI-based platform for enabling intelligent orchestration and management of power and energy having a system for communicating data across a set of nodes in a network, wherein each node is adapted to operate on an energy data set of energy generation, storage or consumption data, wherein a set of nodes is configured with at least one of an algorithm or a rule set for filtering, compressing, or routing the energy data set based on at least one of network conditions, network error correction requirements, data size, data granularity, or data content and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by automated processing of a set of energy transaction logs. In embodiments, provided herein is an AI-based platform for enabling intelligent orchestration and management of power and energy having a system for communicating data across a set of nodes in a network, wherein each node is adapted to operate on an energy data set of energy generation, storage or consumption data, wherein a set of nodes is configured with at least one of an algorithm or a rule set for filtering, compressing, or routing the energy data set based on at least one of network conditions, network error correction requirements, data size, data granularity, or data content and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein the discovery of the grid-independent resources is by application of having an artificial intelligence system that is trained on a historical training data set of grid and off-grid energy pattern to recognize the presence of an off-grid energy resource. In embodiments, provided herein is an AI-based platform for enabling intelligent orchestration and management of power and energy having a system for communicating data across a set of nodes in a network, wherein each node is adapted to operate on an energy data set of energy generation, storage or consumption data, wherein a set of nodes is configured with at least one of an algorithm or a rule set for filtering, compressing, or routing the energy data set based on at least one of network conditions, network error correction requirements, data size, data granularity, or data content and having an artificial intelligence system operating on a data set of energy generation, storage or consumption data for a set of infrastructure assets produced at least in part by a set of sensors contained in or governed by a set of edge devices to produce an output operating parameter for energy generation by at least one of the legacy infrastructure assets. In embodiments, provided herein is an AI-based platform for enabling intelligent orchestration and management of power and energy having a system for communicating data across a set of nodes in a network, wherein each node is adapted to operate on an energy data set of energy generation, storage or consumption data, wherein a set of nodes is configured with at least one of an algorithm or a rule set for filtering, compressing, or routing the energy data set based on at least one of network conditions, network error correction requirements, data size, data granularity, or data content and having an artificial intelligence system operating on a data set of energy generation, storage or consumption data for a set of infrastructure assets produced at least in part by a set of sensors contained in or governed by a set of edge devices to produce an output operating parameter for energy storage for at least one of the legacy infrastructure assets. In embodiments, provided herein is an AI-based platform for enabling intelligent orchestration and management of power and energy having a system for communicating data across a set of nodes in a network, wherein each node is adapted to operate on an energy data set of energy generation, storage or consumption data, wherein a set of nodes is configured with at least one of an algorithm or a rule set for filtering, compressing, or routing the energy data set based on at least one of network conditions, network error correction requirements, data size, data granularity, or data content and having an artificial intelligence system operating on a data set of energy generation, storage or consumption data for a set of infrastructure assets produced at least in part by a set of sensors contained in or governed by a set of edge devices to produce an output operating parameter for energy consumption by at least one of the legacy infrastructure assets. In embodiments, provided herein is an AI-based platform for enabling intelligent orchestration and management of power and energy having a system for communicating data across a set of nodes in a network, wherein each node is adapted to operate on an energy data set of energy generation, storage or consumption data, wherein a set of nodes is configured with at least one of an algorithm or a rule set for filtering, compressing, or routing the energy data set based on at least one of network conditions, network error correction requirements, data size, data granularity, or data content and having a set of edge devices for collection of energy generation data for a set of infrastructure assets based on a set of sensors contained in or governed by the edge devices. In embodiments, provided herein is an AI-based platform for enabling intelligent orchestration and management of power and energy having a system for communicating data across a set of nodes in a network, wherein each node is adapted to operate on an energy data set of energy generation, storage or consumption data, wherein a set of nodes is configured with at least one of an algorithm or a rule set for filtering, compressing, or routing the energy data set based on at least one of network conditions, network error correction requirements, data size, data granularity, or data content and having a set of edge devices for collection of energy storage data for a set of infrastructure assets based on a set of sensors contained in or governed by the edge devices. In embodiments, provided herein is an AI-based platform for enabling intelligent orchestration and management of power and energy having a system for communicating data across a set of nodes in a network, wherein each node is adapted to operate on an energy data set of energy generation, storage or consumption data, wherein a set of nodes is configured with at least one of an algorithm or a rule set for filtering, compressing, or routing the energy data set based on at least one of network conditions, network error correction requirements, data size, data granularity, or data content and having a set of edge devices for collection of energy consumption data for a set of infrastructure assets based on a set of sensors contained in or governed by the edge devices. In embodiments, provided herein is an AI-based platform for enabling intelligent orchestration and management of power and energy having a system for communicating data across a set of nodes in a network, wherein each node is adapted to operate on an energy data set of energy generation, storage or consumption data, wherein a set of nodes is configured with at least one of an algorithm or a rule set for filtering, compressing, or routing the energy data set based on at least one of network conditions, network error correction requirements, data size, data granularity, or data content and having a set of adaptive, autonomous data handling systems for energy edge data collection and transmission.

### Automatically Optimizing Energy Used in Edge Data Pipeline

In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set at least one parameter of data communication based on a set of indicators of current network conditions in order to optimize energy used in the data communication. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set at least one parameter of data communication based on a set of indicators of current network conditions in order to optimize energy used in the data communication and having a system for communicating data across a set of nodes in a network, wherein at least a subset of nodes are configured with at least one of a rule or an algorithm that is adapted to set a routing instruction for data communication based on a set of indicators of current network conditions in order to optimize energy used in the data communication. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set at least one parameter of data communication based on a set of indicators of current network conditions in order to optimize energy used in the data communication and having a system for communicating data across a set of nodes in a network, wherein at least a subset of nodes are configured with at least one of a rule or an algorithm that is adapted to set a route parameter for data communication based on a set of indicators of current network conditions in order to optimize energy used in the data communication. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set at least one parameter of data communication based on a set of indicators of current network conditions in order to optimize energy used in the data communication and having a system for communicating data across a set of nodes in a network, wherein at least a subset of nodes are configured with at least one of a rule or an algorithm that is adapted to set an error correction parameter for data communication based on a set of indicators of current network conditions in order to optimize energy used in the data communication. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set at least one parameter of data communication based on a set of indicators of current network conditions in order to optimize energy used in the data communication and having a system for communicating data across a set of nodes in a network, wherein at least a subset of nodes are configured with at least one of a rule or an algorithm that is adapted to set a compression parameter for data communication based on a set of indicators of current network conditions in order to optimize energy used in the data communication. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set at least one parameter of data communication based on a set of indicators of current network conditions in order to optimize energy used in the data communication and having a system for communicating data across a set of nodes in a network, wherein at least a subset of nodes are configured with at least one of a rule or an algorithm that is adapted to set a storage parameter for data communication based on a set of indicators of current network conditions in order to optimize energy used in the data communication. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set at least one parameter of data communication based on a set of indicators of current network conditions in order to optimize energy used in the data communication and having a system for communicating data across a set of nodes in a network, wherein at least a subset of nodes are configured with at least one of a rule or an algorithm that is adapted to set a timing parameter for data communication based on a set of indicators of current network conditions in order to optimize energy used in the data communication. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set at least one parameter of data communication based on a set of indicators of current network conditions in order to optimize energy used in the data communication and having an edge device artificial intelligence system for operating on data that is communicated through the edge device to optimize energy collectively used by the edge device and by a set of systems controlled by the edge device. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set at least one parameter of data communication based on a set of indicators of current network conditions in order to optimize energy used in the data communication and having a system for automated and coordinated governance or provisioning of a set of grid energy facilities and a set of distributed edge energy resource sets that are electrically independent of the grid. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set at least one parameter of data communication based on a set of indicators of current network conditions in order to optimize energy used in the data communication and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set at least one parameter of data communication based on a set of indicators of current network conditions in order to optimize energy used in the data communication and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by artificial intelligence processing of a data set. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set at least one parameter of data communication based on a set of indicators of current network conditions in order to optimize energy used in the data communication and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by natural language processing of social data content. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set at least one parameter of data communication based on a set of indicators of current network conditions in order to optimize energy used in the data communication and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by computer vision processing of satellite image content or web image content. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set at least one parameter of data communication based on a set of indicators of current network conditions in order to optimize energy used in the data communication and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by automated processing of a set of energy transaction logs. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set at least one parameter of data communication based on a set of indicators of current network conditions in order to optimize energy used in the data communication and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein the discovery of the grid-independent resources is by application of having an artificial intelligence system that is trained on a historical training data set of grid and off-grid energy pattern to recognize the presence of an off-grid energy resource. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set at least one parameter of data communication based on a set of indicators of current network conditions in order to optimize energy used in the data communication and having an artificial intelligence system operating on a data set of energy generation, storage or consumption data for a set of infrastructure assets produced at least in part by a set of sensors contained in or governed by a set of edge devices to produce an output operating parameter for energy generation by at least one of the legacy infrastructure assets. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set at least one parameter of data communication based on a set of indicators of current network conditions in order to optimize energy used in the data communication and having an artificial intelligence system operating on a data set of energy generation, storage or consumption data for a set of infrastructure assets produced at least in part by a set of sensors contained in or governed by a set of edge devices to produce an output operating parameter for energy storage for at least one of the legacy infrastructure assets. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set at least one parameter of data communication based on a set of indicators of current network conditions in order to optimize energy used in the data communication and having an artificial intelligence system operating on a data set of energy generation, storage or consumption data for a set of infrastructure assets produced at least in part by a set of sensors contained in or governed by a set of edge devices to produce an output operating parameter for energy consumption by at least one of the legacy infrastructure assets. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set at least one parameter of data communication based on a set of indicators of current network conditions in order to optimize energy used in the data communication and having a set of edge devices for collection of energy generation data for a set of infrastructure assets based on a set of sensors contained in or governed by the edge devices. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set at least one parameter of data communication based on a set of indicators of current network conditions in order to optimize energy used in the data communication and having a set of edge devices for collection of energy storage data for a set of infrastructure assets based on a set of sensors contained in or governed by the edge devices. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set at least one parameter of data communication based on a set of indicators of current network conditions in order to optimize energy used in the data communication and having a set of edge devices for collection of energy consumption data for a set of infrastructure assets based on a set of sensors contained in or governed by the edge devices. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set at least one parameter of data communication based on a set of indicators of current network conditions in order to optimize energy used in the data communication and having a set of adaptive, autonomous data handling systems for energy edge data collection and transmission.

### Optimizing Energy Used in Edge Data Pipeline by Routing

In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a routing instruction for data communication based on a set of indicators of current network conditions in order to optimize energy used in the data communication. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a routing instruction for data communication based on a set of indicators of current network conditions in order to optimize energy used in the data communication and having a system for communicating data across a set of nodes in a network, wherein at least a subset of nodes are configured with at least one of a rule or an algorithm that is adapted to set a route parameter for data communication based on a set of indicators of current network conditions in order to optimize energy used in the data communication. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a routing instruction for data communication based on a set of indicators of current network conditions in order to optimize energy used in the data communication and having a system for communicating data across a set of nodes in a network, wherein at least a subset of nodes are configured with at least one of a rule or an algorithm that is adapted to set an error correction parameter for data communication based on a set of indicators of current network conditions in order to optimize energy used in the data communication. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a routing instruction for data communication based on a set of indicators of current network conditions in order to optimize energy used in the data communication and having a system for communicating data across a set of nodes in a network, wherein at least a subset of nodes are configured with at least one of a rule or an algorithm that is adapted to set a compression parameter for data communication based on a set of indicators of current network conditions in order to optimize energy used in the data communication. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a routing instruction for data communication based on a set of indicators of current network conditions in order to optimize energy used in the data communication and having a system for communicating data across a set of nodes in a network, wherein at least a subset of nodes are configured with at least one of a rule or an algorithm that is adapted to set a storage parameter for data communication based on a set of indicators of current network conditions in order to optimize energy used in the data communication. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a routing instruction for data communication based on a set of indicators of current network conditions in order to optimize energy used in the data communication and having a system for communicating data across a set of nodes in a network, wherein at least a subset of nodes are configured with at least one of a rule or an algorithm that is adapted to set a timing parameter for data communication based on a set of indicators of current network conditions in order to optimize energy used in the data communication. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a routing instruction for data communication based on a set of indicators of current network conditions in order to optimize energy used in the data communication and having an edge device artificial intelligence system for operating on data that is communicated through the edge device to optimize energy collectively used by the edge device and by a set of systems controlled by the edge device. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a routing instruction for data communication based on a set of indicators of current network conditions in order to optimize energy used in the data communication and having a system for automated and coordinated governance or provisioning of a set of grid energy facilities and a set of distributed edge energy resource sets that are electrically independent of the grid. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a routing instruction for data communication based on a set of indicators of current network conditions in order to optimize energy used in the data communication and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a routing instruction for data communication based on a set of indicators of current network conditions in order to optimize energy used in the data communication and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by artificial intelligence processing of a data set. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a routing instruction for data communication based on a set of indicators of current network conditions in order to optimize energy used in the data communication and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by natural language processing of social data content. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a routing instruction for data communication based on a set of indicators of current network conditions in order to optimize energy used in the data communication and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by computer vision processing of satellite image content or web image content. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a routing instruction for data communication based on a set of indicators of current network conditions in order to optimize energy used in the data communication and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by automated processing of a set of energy transaction logs. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a routing instruction for data communication based on a set of indicators of current network conditions in order to optimize energy used in the data communication and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein the discovery of the grid-independent resources is by application of having an artificial intelligence system that is trained on a historical training data set of grid and off-grid energy pattern to recognize the presence of an off-grid energy resource. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a routing instruction for data communication based on a set of indicators of current network conditions in order to optimize energy used in the data communication and having an artificial intelligence system operating on a data set of energy generation, storage or consumption data for a set of infrastructure assets produced at least in part by a set of sensors contained in or governed by a set of edge devices to produce an output operating parameter for energy generation by at least one of the legacy infrastructure assets. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a routing instruction for data communication based on a set of indicators of current network conditions in order to optimize energy used in the data communication and having an artificial intelligence system operating on a data set of energy generation, storage or consumption data for a set of infrastructure assets produced at least in part by a set of sensors contained in or governed by a set of edge devices to produce an output operating parameter for energy storage for at least one of the legacy infrastructure assets. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a routing instruction for data communication based on a set of indicators of current network conditions in order to optimize energy used in the data communication and having an artificial intelligence system operating on a data set of energy generation, storage or consumption data for a set of infrastructure assets produced at least in part by a set of sensors contained in or governed by a set of edge devices to produce an output operating parameter for energy consumption by at least one of the legacy infrastructure assets. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a routing instruction for data communication based on a set of indicators of current network conditions in order to optimize energy used in the data communication and having a set of edge devices for collection of energy generation data for a set of infrastructure assets based on a set of sensors contained in or governed by the edge devices. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a routing instruction for data communication based on a set of indicators of current network conditions in order to optimize energy used in the data communication and having a set of edge devices for collection of energy storage data for a set of infrastructure assets based on a set of sensors contained in or governed by the edge devices. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a routing instruction for data communication based on a set of indicators of current network conditions in order to optimize energy used in the data communication and having a set of edge devices for collection of energy consumption data for a set of infrastructure assets based on a set of sensors contained in or governed by the edge devices. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a routing instruction for data communication based on a set of indicators of current network conditions in order to optimize energy used in the data communication and having a set of adaptive, autonomous data handling systems for energy edge data collection and transmission.

### Optimizing Energy Used in Edge Data Pipeline by Route Parameter Selection

In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a route parameter for data communication based on a set of indicators of current network conditions in order to optimize energy used in the data communication. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a route parameter for data communication based on a set of indicators of current network conditions in order to optimize energy used in the data communication and having a system for communicating data across a set of nodes in a network, wherein at least a subset of nodes are configured with at least one of a rule or an algorithm that is adapted to set an error correction parameter for data communication based on a set of indicators of current network conditions in order to optimize energy used in the data communication. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a route parameter for data communication based on a set of indicators of current network conditions in order to optimize energy used in the data communication and having a system for communicating data across a set of nodes in a network, wherein at least a subset of nodes are configured with at least one of a rule or an algorithm that is adapted to set a compression parameter for data communication based on a set of indicators of current network conditions in order to optimize energy used in the data communication. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a route parameter for data communication based on a set of indicators of current network conditions in order to optimize energy used in the data communication and having a system for communicating data across a set of nodes in a network, wherein at least a subset of nodes are configured with at least one of a rule or an algorithm that is adapted to set a storage parameter for data communication based on a set of indicators of current network conditions in order to optimize energy used in the data communication. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a route parameter for data communication based on a set of indicators of current network conditions in order to optimize energy used in the data communication and having a system for communicating data across a set of nodes in a network, wherein at least a subset of nodes are configured with at least one of a rule or an algorithm that is adapted to set a timing parameter for data communication based on a set of indicators of current network conditions in order to optimize energy used in the data communication. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a route parameter for data communication based on a set of indicators of current network conditions in order to optimize energy used in the data communication and having an edge device artificial intelligence system for operating on data that is communicated through the edge device to optimize energy collectively used by the edge device and by a set of systems controlled by the edge device. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a route parameter for data communication based on a set of indicators of current network conditions in order to optimize energy used in the data communication and having a system for automated and coordinated governance or provisioning of a set of grid energy facilities and a set of distributed edge energy resource sets that are electrically independent of the grid. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a route parameter for data communication based on a set of indicators of current network conditions in order to optimize energy used in the data communication and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a route parameter for data communication based on a set of indicators of current network conditions in order to optimize energy used in the data communication and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by artificial intelligence processing of a data set. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a route parameter for data communication based on a set of indicators of current network conditions in order to optimize energy used in the data communication and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by natural language processing of social data content. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a route parameter for data communication based on a set of indicators of current network conditions in order to optimize energy used in the data communication and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by computer vision processing of satellite image content or web image content. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a route parameter for data communication based on a set of indicators of current network conditions in order to optimize energy used in the data communication and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by automated processing of a set of energy transaction logs. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a route parameter for data communication based on a set of indicators of current network conditions in order to optimize energy used in the data communication and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein the discovery of the grid-independent resources is by application of having an artificial intelligence system that is trained on a historical training data set of grid and off-grid energy pattern to recognize the presence of an off-grid energy resource. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a route parameter for data communication based on a set of indicators of current network conditions in order to optimize energy used in the data communication and having an artificial intelligence system operating on a data set of energy generation, storage or consumption data for a set of infrastructure assets produced at least in part by a set of sensors contained in or governed by a set of edge devices to produce an output operating parameter for energy generation by at least one of the legacy infrastructure assets. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a route parameter for data communication based on a set of indicators of current network conditions in order to optimize energy used in the data communication and having an artificial intelligence system operating on a data set of energy generation, storage or consumption data for a set of infrastructure assets produced at least in part by a set of sensors contained in or governed by a set of edge devices to produce an output operating parameter for energy storage for at least one of the legacy infrastructure assets. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a route parameter for data communication based on a set of indicators of current network conditions in order to optimize energy used in the data communication and having an artificial intelligence system operating on a data set of energy generation, storage or consumption data for a set of infrastructure assets produced at least in part by a set of sensors contained in or governed by a set of edge devices to produce an output operating parameter for energy consumption by at least one of the legacy infrastructure assets. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a route parameter for data communication based on a set of indicators of current network conditions in order to optimize energy used in the data communication and having a set of edge devices for collection of energy generation data for a set of infrastructure assets based on a set of sensors contained in or governed by the edge devices. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a route parameter for data communication based on a set of indicators of current network conditions in order to optimize energy used in the data communication and having a set of edge devices for collection of energy storage data for a set of infrastructure assets based on a set of sensors contained in or governed by the edge devices. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a route parameter for data communication based on a set of indicators of current network conditions in order to optimize energy used in the data communication and having a set of edge devices for collection of energy consumption data for a set of infrastructure assets based on a set of sensors contained in or governed by the edge devices. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a route parameter for data communication based on a set of indicators of current network conditions in order to optimize energy used in the data communication and having a set of adaptive, autonomous data handling systems for energy edge data collection and transmission.

### Optimizing Energy Used in Edge Data Pipeline by Error Correction Parameter Configuration

In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set an error correction parameter for data communication based on a set of indicators of current network conditions in order to optimize energy used in the data communication. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set an error correction parameter for data communication based on a set of indicators of current network conditions in order to optimize energy used in the data communication and having a system for communicating data across a set of nodes in a network, wherein at least a subset of nodes are configured with at least one of a rule or an algorithm that is adapted to set a compression parameter for data communication based on a set of indicators of current network conditions in order to optimize energy used in the data communication. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set an error correction parameter for data communication based on a set of indicators of current network conditions in order to optimize energy used in the data communication and having a system for communicating data across a set of nodes in a network, wherein at least a subset of nodes are configured with at least one of a rule or an algorithm that is adapted to set a storage parameter for data communication based on a set of indicators of current network conditions in order to optimize energy used in the data communication. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set an error correction parameter for data communication based on a set of indicators of current network conditions in order to optimize energy used in the data communication and having a system for communicating data across a set of nodes in a network, wherein at least a subset of nodes are configured with at least one of a rule or an algorithm that is adapted to set a timing parameter for data communication based on a set of indicators of current network conditions in order to optimize energy used in the data communication. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set an error correction parameter for data communication based on a set of indicators of current network conditions in order to optimize energy used in the data communication and having an edge device artificial intelligence system for operating on data that is communicated through the edge device to optimize energy collectively used by the edge device and by a set of systems controlled by the edge device. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set an error correction parameter for data communication based on a set of indicators of current network conditions in order to optimize energy used in the data communication and having a system for automated and coordinated governance or provisioning of a set of grid energy facilities and a set of distributed edge energy resource sets that are electrically independent of the grid. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set an error correction parameter for data communication based on a set of indicators of current network conditions in order to optimize energy used in the data communication and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set an error correction parameter for data communication based on a set of indicators of current network conditions in order to optimize energy used in the data communication and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by artificial intelligence processing of a data set. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set an error correction parameter for data communication based on a set of indicators of current network conditions in order to optimize energy used in the data communication and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by natural language processing of social data content. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set an error correction parameter for data communication based on a set of indicators of current network conditions in order to optimize energy used in the data communication and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by computer vision processing of satellite image content or web image content. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set an error correction parameter for data communication based on a set of indicators of current network conditions in order to optimize energy used in the data communication and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by automated processing of a set of energy transaction logs. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set an error correction parameter for data communication based on a set of indicators of current network conditions in order to optimize energy used in the data communication and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein the discovery of the grid-independent resources is by application of having an artificial intelligence system that is trained on a historical training data set of grid and off-grid energy pattern to recognize the presence of an off-grid energy resource. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set an error correction parameter for data communication based on a set of indicators of current network conditions in order to optimize energy used in the data communication and having an artificial intelligence system operating on a data set of energy generation, storage or consumption data for a set of infrastructure assets produced at least in part by a set of sensors contained in or governed by a set of edge devices to produce an output operating parameter for energy generation by at least one of the legacy infrastructure assets. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set an error correction parameter for data communication based on a set of indicators of current network conditions in order to optimize energy used in the data communication and having an artificial intelligence system operating on a data set of energy generation, storage or consumption data for a set of infrastructure assets produced at least in part by a set of sensors contained in or governed by a set of edge devices to produce an output operating parameter for energy storage for at least one of the legacy infrastructure assets. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set an error correction parameter for data communication based on a set of indicators of current network conditions in order to optimize energy used in the data communication and having an artificial intelligence system operating on a data set of energy generation, storage or consumption data for a set of infrastructure assets produced at least in part by a set of sensors contained in or governed by a set of edge devices to produce an output operating parameter for energy consumption by at least one of the legacy infrastructure assets. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set an error correction parameter for data communication based on a set of indicators of current network conditions in order to optimize energy used in the data communication and having a set of edge devices for collection of energy generation data for a set of infrastructure assets based on a set of sensors contained in or governed by the edge devices. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set an error correction parameter for data communication based on a set of indicators of current network conditions in order to optimize energy used in the data communication and having a set of edge devices for collection of energy storage data for a set of infrastructure assets based on a set of sensors contained in or governed by the edge devices. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set an error correction parameter for data communication based on a set of indicators of current network conditions in order to optimize energy used in the data communication and having a set of edge devices for collection of energy consumption data for a set of infrastructure assets based on a set of sensors contained in or governed by the edge devices. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set an error correction parameter for data communication based on a set of indicators of current network conditions in order to optimize energy used in the data communication and having a set of adaptive, autonomous data handling systems for energy edge data collection and transmission.

### Optimizing Energy Used in Edge Data Pipeline by Compression Parameter Selection

In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a compression parameter for data communication based on a set of indicators of current network conditions in order to optimize energy used in the data communication. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a compression parameter for data communication based on a set of indicators of current network conditions in order to optimize energy used in the data communication and having a system for communicating data across a set of nodes in a network, wherein at least a subset of nodes are configured with at least one of a rule or an algorithm that is adapted to set a storage parameter for data communication based on a set of indicators of current network conditions in order to optimize energy used in the data communication. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a compression parameter for data communication based on a set of indicators of current network conditions in order to optimize energy used in the data communication and having a system for communicating data across a set of nodes in a network, wherein at least a subset of nodes are configured with at least one of a rule or an algorithm that is adapted to set a timing parameter for data communication based on a set of indicators of current network conditions in order to optimize energy used in the data communication. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a compression parameter for data communication based on a set of indicators of current network conditions in order to optimize energy used in the data communication and having an edge device artificial intelligence system for operating on data that is communicated through the edge device to optimize energy collectively used by the edge device and by a set of systems controlled by the edge device. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a compression parameter for data communication based on a set of indicators of current network conditions in order to optimize energy used in the data communication and having a system for automated and coordinated governance or provisioning of a set of grid energy facilities and a set of distributed edge energy resource sets that are electrically independent of the grid. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a compression parameter for data communication based on a set of indicators of current network conditions in order to optimize energy used in the data communication and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a compression parameter for data communication based on a set of indicators of current network conditions in order to optimize energy used in the data communication and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by artificial intelligence processing of a data set. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a compression parameter for data communication based on a set of indicators of current network conditions in order to optimize energy used in the data communication and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by natural language processing of social data content. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a compression parameter for data communication based on a set of indicators of current network conditions in order to optimize energy used in the data communication and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by computer vision processing of satellite image content or web image content. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a compression parameter for data communication based on a set of indicators of current network conditions in order to optimize energy used in the data communication and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by automated processing of a set of energy transaction logs. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a compression parameter for data communication based on a set of indicators of current network conditions in order to optimize energy used in the data communication and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein the discovery of the grid-independent resources is by application of having an artificial intelligence system that is trained on a historical training data set of grid and off-grid energy pattern to recognize the presence of an off-grid energy resource. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a compression parameter for data communication based on a set of indicators of current network conditions in order to optimize energy used in the data communication and having an artificial intelligence system operating on a data set of energy generation, storage or consumption data for a set of infrastructure assets produced at least in part by a set of sensors contained in or governed by a set of edge devices to produce an output operating parameter for energy generation by at least one of the legacy infrastructure assets. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a compression parameter for data communication based on a set of indicators of current network conditions in order to optimize energy used in the data communication and having an artificial intelligence system operating on a data set of energy generation, storage or consumption data for a set of infrastructure assets produced at least in part by a set of sensors contained in or governed by a set of edge devices to produce an output operating parameter for energy storage for at least one of the legacy infrastructure assets. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a compression parameter for data communication based on a set of indicators of current network conditions in order to optimize energy used in the data communication and having an artificial intelligence system operating on a data set of energy generation, storage or consumption data for a set of infrastructure assets produced at least in part by a set of sensors contained in or governed by a set of edge devices to produce an output operating parameter for energy consumption by at least one of the legacy infrastructure assets. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a compression parameter for data communication based on a set of indicators of current network conditions in order to optimize energy used in the data communication and having a set of edge devices for collection of energy generation data for a set of infrastructure assets based on a set of sensors contained in or governed by the edge devices. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a compression parameter for data communication based on a set of indicators of current network conditions in order to optimize energy used in the data communication and having a set of edge devices for collection of energy storage data for a set of infrastructure assets based on a set of sensors contained in or governed by the edge devices. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a compression parameter for data communication based on a set of indicators of current network conditions in order to optimize energy used in the data communication and having a set of edge devices for collection of energy consumption data for a set of infrastructure assets based on a set of sensors contained in or governed by the edge devices. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a compression parameter for data communication based on a set of indicators of current network conditions in order to optimize energy used in the data communication and having a set of adaptive, autonomous data handling systems for energy edge data collection and transmission.

### Optimizing Energy Used in Edge Data Pipeline by Storage Parameter Selection

In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a storage parameter for data communication based on a set of indicators of current network conditions in order to optimize energy used in the data communication. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a storage parameter for data communication based on a set of indicators of current network conditions in order to optimize energy used in the data communication and having a system for communicating data across a set of nodes in a network, wherein at least a subset of nodes are configured with at least one of a rule or an algorithm that is adapted to set a timing parameter for data communication based on a set of indicators of current network conditions in order to optimize energy used in the data communication. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a storage parameter for data communication based on a set of indicators of current network conditions in order to optimize energy used in the data communication and having an edge device artificial intelligence system for operating on data that is communicated through the edge device to optimize energy collectively used by the edge device and by a set of systems controlled by the edge device. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a storage parameter for data communication based on a set of indicators of current network conditions in order to optimize energy used in the data communication and having a system for automated and coordinated governance or provisioning of a set of grid energy facilities and a set of distributed edge energy resource sets that are electrically independent of the grid. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a storage parameter for data communication based on a set of indicators of current network conditions in order to optimize energy used in the data communication and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a storage parameter for data communication based on a set of indicators of current network conditions in order to optimize energy used in the data communication and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by artificial intelligence processing of a data set. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a storage parameter for data communication based on a set of indicators of current network conditions in order to optimize energy used in the data communication and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by natural language processing of social data content. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a storage parameter for data communication based on a set of indicators of current network conditions in order to optimize energy used in the data communication and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by computer vision processing of satellite image content or web image content. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a storage parameter for data communication based on a set of indicators of current network conditions in order to optimize energy used in the data communication and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by automated processing of a set of energy transaction logs. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a storage parameter for data communication based on a set of indicators of current network conditions in order to optimize energy used in the data communication and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein the discovery of the grid-independent resources is by application of having an artificial intelligence system that is trained on a historical training data set of grid and off-grid energy pattern to recognize the presence of an off-grid energy resource. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a storage parameter for data communication based on a set of indicators of current network conditions in order to optimize energy used in the data communication and having an artificial intelligence system operating on a data set of energy generation, storage or consumption data for a set of infrastructure assets produced at least in part by a set of sensors contained in or governed by a set of edge devices to produce an output operating parameter for energy generation by at least one of the legacy infrastructure assets. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a storage parameter for data communication based on a set of indicators of current network conditions in order to optimize energy used in the data communication and having an artificial intelligence system operating on a data set of energy generation, storage or consumption data for a set of infrastructure assets produced at least in part by a set of sensors contained in or governed by a set of edge devices to produce an output operating parameter for energy storage for at least one of the legacy infrastructure assets. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a storage parameter for data communication based on a set of indicators of current network conditions in order to optimize energy used in the data communication and having an artificial intelligence system operating on a data set of energy generation, storage or consumption data for a set of infrastructure assets produced at least in part by a set of sensors contained in or governed by a set of edge devices to produce an output operating parameter for energy consumption by at least one of the legacy infrastructure assets. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a storage parameter for data communication based on a set of indicators of current network conditions in order to optimize energy used in the data communication and having a set of edge devices for collection of energy generation data for a set of infrastructure assets based on a set of sensors contained in or governed by the edge devices. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a storage parameter for data communication based on a set of indicators of current network conditions in order to optimize energy used in the data communication and having a set of edge devices for collection of energy storage data for a set of infrastructure assets based on a set of sensors contained in or governed by the edge devices. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a storage parameter for data communication based on a set of indicators of current network conditions in order to optimize energy used in the data communication and having a set of edge devices for collection of energy consumption data for a set of infrastructure assets based on a set of sensors contained in or governed by the edge devices. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a storage parameter for data communication based on a set of indicators of current network conditions in order to optimize energy used in the data communication and having a set of adaptive, autonomous data handling systems for energy edge data collection and transmission.

### Optimizing Energy Used in Edge Data Pipeline by Timing Parameter Selection

In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a timing parameter for data communication based on a set of indicators of current network conditions in order to optimize energy used in the data communication. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a timing parameter for data communication based on a set of indicators of current network conditions in order to optimize energy used in the data communication and having an edge device artificial intelligence system for operating on data that is communicated through the edge device to optimize energy collectively used by the edge device and by a set of systems controlled by the edge device. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a timing parameter for data communication based on a set of indicators of current network conditions in order to optimize energy used in the data communication and having a system for automated and coordinated governance or provisioning of a set of grid energy facilities and a set of distributed edge energy resource sets that are electrically independent of the grid. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a timing parameter for data communication based on a set of indicators of current network conditions in order to optimize energy used in the data communication and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a timing parameter for data communication based on a set of indicators of current network conditions in order to optimize energy used in the data communication and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by artificial intelligence processing of a data set. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a timing parameter for data communication based on a set of indicators of current network conditions in order to optimize energy used in the data communication and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by natural language processing of social data content. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a timing parameter for data communication based on a set of indicators of current network conditions in order to optimize energy used in the data communication and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by computer vision processing of satellite image content or web image content. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a timing parameter for data communication based on a set of indicators of current network conditions in order to optimize energy used in the data communication and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by automated processing of a set of energy transaction logs. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a timing parameter for data communication based on a set of indicators of current network conditions in order to optimize energy used in the data communication and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein the discovery of the grid-independent resources is by application of having an artificial intelligence system that is trained on a historical training data set of grid and off-grid energy pattern to recognize the presence of an off-grid energy resource. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a timing parameter for data communication based on a set of indicators of current network conditions in order to optimize energy used in the data communication and having an artificial intelligence system operating on a data set of energy generation, storage or consumption data for a set of infrastructure assets produced at least in part by a set of sensors contained in or governed by a set of edge devices to produce an output operating parameter for energy generation by at least one of the legacy infrastructure assets. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a timing parameter for data communication based on a set of indicators of current network conditions in order to optimize energy used in the data communication and having an artificial intelligence system operating on a data set of energy generation, storage or consumption data for a set of infrastructure assets produced at least in part by a set of sensors contained in or governed by a set of edge devices to produce an output operating parameter for energy storage for at least one of the legacy infrastructure assets. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a timing parameter for data communication based on a set of indicators of current network conditions in order to optimize energy used in the data communication and having an artificial intelligence system operating on a data set of energy generation, storage or consumption data for a set of infrastructure assets produced at least in part by a set of sensors contained in or governed by a set of edge devices to produce an output operating parameter for energy consumption by at least one of the legacy infrastructure assets. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a timing parameter for data communication based on a set of indicators of current network conditions in order to optimize energy used in the data communication and having a set of edge devices for collection of energy generation data for a set of infrastructure assets based on a set of sensors contained in or governed by the edge devices. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a timing parameter for data communication based on a set of indicators of current network conditions in order to optimize energy used in the data communication and having a set of edge devices for collection of energy storage data for a set of infrastructure assets based on a set of sensors contained in or governed by the edge devices. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a timing parameter for data communication based on a set of indicators of current network conditions in order to optimize energy used in the data communication and having a set of edge devices for collection of energy consumption data for a set of infrastructure assets based on a set of sensors contained in or governed by the edge devices. In embodiments, provided herein is an AI-based platform for enabling intelligent orchestration and management of power and energy having a system for communicating data across a set of nodes in a network, wherein at least a subset of nodes are configured with at least one of a rule or an algorithm that is adapted to set a timing parameter for data communication based on a set of indicators of current network conditions in order to optimize energy used in the data communication and having a set of adaptive, autonomous data handling systems for energy edge data collection and transmission.

Edge Device with AI for Energy Optimization and Data Communication

In embodiments, provided herein is an AI-based platform for enabling intelligent orchestration and management of power and energy having an edge device artificial intelligence system for operating on data that is communicated through the edge device to optimize energy collectively used by the edge device and by a set of systems controlled by the edge device. In embodiments, provided herein is an AI-based platform for enabling intelligent orchestration and management of power and energy having an edge device artificial intelligence system for operating on data that is communicated through the edge device to optimize energy collectively used by the edge device and by a set of systems controlled by the edge device and having a system for automated and coordinated governance or provisioning of a set of grid energy facilities and a set of distributed edge energy resource sets that are electrically independent of the grid. In embodiments, provided herein is an AI-based platform for enabling intelligent orchestration and management of power and energy having an edge device artificial intelligence system for operating on data that is communicated through the edge device to optimize energy collectively used by the edge device and by a set of systems controlled by the edge device and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid. In embodiments, provided herein is an AI-based platform for enabling intelligent orchestration and management of power and energy having an edge device artificial intelligence system for operating on data that is communicated through the edge device to optimize energy collectively used by the edge device and by a set of systems controlled by the edge device and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by artificial intelligence processing of a data set. In embodiments, provided herein is an AI-based platform for enabling intelligent orchestration and management of power and energy having an edge device artificial intelligence system for operating on data that is communicated through the edge device to optimize energy collectively used by the edge device and by a set of systems controlled by the edge device and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by natural language processing of social data content. In embodiments, provided herein is an AI-based platform for enabling intelligent orchestration and management of power and energy having an edge device artificial intelligence system for operating on data that is communicated through the edge device to optimize energy collectively used by the edge device and by a set of systems controlled by the edge device and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by computer vision processing of satellite image content or web image content. In embodiments, provided herein is an AI-based platform for enabling intelligent orchestration and management of power and energy having an edge device artificial intelligence system for operating on data that is communicated through the edge device to optimize energy collectively used by the edge device and by a set of systems controlled by the edge device and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by automated processing of a set of energy transaction logs. In embodiments, provided herein is an AI-based platform for enabling intelligent orchestration and management of power and energy having an edge device artificial intelligence system for operating on data that is communicated through the edge device to optimize energy collectively used by the edge device and by a set of systems controlled by the edge device and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein the discovery of the grid-independent resources is by application of having an artificial intelligence system that is trained on a historical training data set of grid and off-grid energy pattern to recognize the presence of an off-grid energy resource. In embodiments, provided herein is an AI-based platform for enabling intelligent orchestration and management of power and energy having an edge device artificial intelligence system for operating on data that is communicated through the edge device to optimize energy collectively used by the edge device and by a set of systems controlled by the edge device and having an artificial intelligence system operating on a data set of energy generation, storage or consumption data for a set of infrastructure assets produced at least in part by a set of sensors contained in or governed by a set of edge devices to produce an output operating parameter for energy generation by at least one of the legacy infrastructure assets. In embodiments, provided herein is an AI-based platform for enabling intelligent orchestration and management of power and energy having an edge device artificial intelligence system for operating on data that is communicated through the edge device to optimize energy collectively used by the edge device and by a set of systems controlled by the edge device and having an artificial intelligence system operating on a data set of energy generation, storage or consumption data for a set of infrastructure assets produced at least in part by a set of sensors contained in or governed by a set of edge devices to produce an output operating parameter for energy storage for at least one of the legacy infrastructure assets. In embodiments, provided herein is an AI-based platform for enabling intelligent orchestration and management of power and energy having an edge device artificial intelligence system for operating on data that is communicated through the edge device to optimize energy collectively used by the edge device and by a set of systems controlled by the edge device and having an artificial intelligence system operating on a data set of energy generation, storage or consumption data for a set of infrastructure assets produced at least in part by a set of sensors contained in or governed by a set of edge devices to produce an output operating parameter for energy consumption by at least one of the legacy infrastructure assets. In embodiments, provided herein is an AI-based platform for enabling intelligent orchestration and management of power and energy having an edge device artificial intelligence system for operating on data that is communicated through the edge device to optimize energy collectively used by the edge device and by a set of systems controlled by the edge device and having a set of edge devices for collection of energy generation data for a set of infrastructure assets based on a set of sensors contained in or governed by the edge devices. In embodiments, provided herein is an AI-based platform for enabling intelligent orchestration and management of power and energy having an edge device artificial intelligence system for operating on data that is communicated through the edge device to optimize energy collectively used by the edge device and by a set of systems controlled by the edge device and having a set of edge devices for collection of energy storage data for a set of infrastructure assets based on a set of sensors contained in or governed by the edge devices. In embodiments, provided herein is an AI-based platform for enabling intelligent orchestration and management of power and energy having an edge device artificial intelligence system for operating on data that is communicated through the edge device to optimize energy collectively used by the edge device and by a set of systems controlled by the edge device and having a set of edge devices for collection of energy consumption data for a set of infrastructure assets based on a set of sensors contained in or governed by the edge devices. In embodiments, provided herein is an AI-based platform for enabling intelligent orchestration and management of power and energy having an edge device artificial intelligence system for operating on data that is communicated through the edge device to optimize energy collectively used by the edge device and by a set of systems controlled by the edge device and having a set of adaptive, autonomous data handling systems for energy edge data collection and transmission.

### Automated and Coordinated Governance or Provisioning of a Grid and a Distributed Edge (Non-Grid) Resource Set

In embodiments, provided herein is an AI-based platform for enabling intelligent orchestration and management of power and energy having a system for automated and coordinated governance or provisioning of a set of grid energy facilities and a set of distributed edge energy resource sets that are electrically independent of the grid. In embodiments, provided herein is an AI-based platform for enabling intelligent orchestration and management of power and energy having a system for automated and coordinated governance or provisioning of a set of grid energy facilities and a set of distributed edge energy resource sets that are electrically independent of the grid and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid. In embodiments, provided herein is an AI-based platform for enabling intelligent orchestration and management of power and energy having a system for automated and coordinated governance or provisioning of a set of grid energy facilities and a set of distributed edge energy resource sets that are electrically independent of the grid and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by artificial intelligence processing of a data set. In embodiments, provided herein is an AI-based platform for enabling intelligent orchestration and management of power and energy having a system for automated and coordinated governance or provisioning of a set of grid energy facilities and a set of distributed edge energy resource sets that are electrically independent of the grid and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by natural language processing of social data content. In embodiments, provided herein is an AI-based platform for enabling intelligent orchestration and management of power and energy having a system for automated and coordinated governance or provisioning of a set of grid energy facilities and a set of distributed edge energy resource sets that are electrically independent of the grid and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by computer vision processing of satellite image content or web image content. In embodiments, provided herein is an AI-based platform for enabling intelligent orchestration and management of power and energy having a system for automated and coordinated governance or provisioning of a set of grid energy facilities and a set of distributed edge energy resource sets that are electrically independent of the grid and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by automated processing of a set of energy transaction logs. In embodiments, provided herein is an AI-based platform for enabling intelligent orchestration and management of power and energy having a system for automated and coordinated governance or provisioning of a set of grid energy facilities and a set of distributed edge energy resource sets that are electrically independent of the grid and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein the discovery of the grid-independent resources is by application of having an artificial intelligence system that is trained on a historical training data set of grid and off-grid energy pattern to recognize the presence of an off-grid energy resource. In embodiments, provided herein is an AI-based platform for enabling intelligent orchestration and management of power and energy having a system for automated and coordinated governance or provisioning of a set of grid energy facilities and a set of distributed edge energy resource sets that are electrically independent of the grid and having an artificial intelligence system operating on a data set of energy generation, storage or consumption data for a set of infrastructure assets produced at least in part by a set of sensors contained in or governed by a set of edge devices to produce an output operating parameter for energy generation by at least one of the legacy infrastructure assets. In embodiments, provided herein is an AI-based platform for enabling intelligent orchestration and management of power and energy having a system for automated and coordinated governance or provisioning of a set of grid energy facilities and a set of distributed edge energy resource sets that are electrically independent of the grid and having an artificial intelligence system operating on a data set of energy generation, storage or consumption data for a set of infrastructure assets produced at least in part by a set of sensors contained in or governed by a set of edge devices to produce an output operating parameter for energy storage for at least one of the legacy infrastructure assets. In embodiments, provided herein is an AI-based platform for enabling intelligent orchestration and management of power and energy having a system for automated and coordinated governance or provisioning of a set of grid energy facilities and a set of distributed edge energy resource sets that are electrically independent of the grid and having an artificial intelligence system operating on a data set of energy generation, storage or consumption data for a set of infrastructure assets produced at least in part by a set of sensors contained in or governed by a set of edge devices to produce an output operating parameter for energy consumption by at least one of the legacy infrastructure assets. In embodiments, provided herein is an AI-based platform for enabling intelligent orchestration and management of power and energy having a system for automated and coordinated governance or provisioning of a set of grid energy facilities and a set of distributed edge energy resource sets that are electrically independent of the grid and having a set of edge devices for collection of energy generation data for a set of infrastructure assets based on a set of sensors contained in or governed by the edge devices. In embodiments, provided herein is an AI-based platform for enabling intelligent orchestration and management of power and energy having a system for automated and coordinated governance or provisioning of a set of grid energy facilities and a set of distributed edge energy resource sets that are electrically independent of the grid and having a set of edge devices for collection of energy storage data for a set of infrastructure assets based on a set of sensors contained in or governed by the edge devices. In embodiments, provided herein is an AI-based platform for enabling intelligent orchestration and management of power and energy having a system for automated and coordinated governance or provisioning of a set of grid energy facilities and a set of distributed edge energy resource sets that are electrically independent of the grid and having a set of edge devices for collection of energy consumption data for a set of infrastructure assets based on a set of sensors contained in or governed by the edge devices. In embodiments, provided herein is an AI-based platform for enabling intelligent orchestration and management of power and energy having a system for automated and coordinated governance or provisioning of a set of grid energy facilities and a set of distributed edge energy resource sets that are electrically independent of the grid and having a set of adaptive, autonomous data handling systems for energy edge data collection and transmission.

### Automated Discovery of Off-Grid Energy Resources for Automated and Coordinated Governance of Energy Resources

In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by artificial intelligence processing of a data set. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by natural language processing of social data content. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by computer vision processing of satellite image content or web image content. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by automated processing of a set of energy transaction logs. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein the discovery of the grid-independent resources is by application of having an artificial intelligence system that is trained on a historical training data set of grid and off-grid energy pattern to recognize the presence of an off-grid energy resource. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid and having an artificial intelligence system operating on a data set of energy generation, storage or consumption data for a set of infrastructure assets produced at least in part by a set of sensors contained in or governed by a set of edge devices to produce an output operating parameter for energy generation by at least one of the legacy infrastructure assets. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid and having an artificial intelligence system operating on a data set of energy generation, storage or consumption data for a set of infrastructure assets produced at least in part by a set of sensors contained in or governed by a set of edge devices to produce an output operating parameter for energy storage for at least one of the legacy infrastructure assets. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid and having an artificial intelligence system operating on a data set of energy generation, storage or consumption data for a set of infrastructure assets produced at least in part by a set of sensors contained in or governed by a set of edge devices to produce an output operating parameter for energy consumption by at least one of the legacy infrastructure assets. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid and having a set of edge devices for collection of energy generation data for a set of infrastructure assets based on a set of sensors contained in or governed by the edge devices. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid and having a set of edge devices for collection of energy storage data for a set of infrastructure assets based on a set of sensors contained in or governed by the edge devices. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid and having a set of edge devices for collection of energy consumption data for a set of infrastructure assets based on a set of sensors contained in or governed by the edge devices. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid and having a set of adaptive, autonomous data handling systems for energy edge data collection and transmission.

### Automated Discovery of Off-Grid Energy Resources for Automated and Coordinated Governance of Energy Resources by Use of Alternative Data Sets

In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by artificial intelligence processing of a data set. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by artificial intelligence processing of a data set and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by natural language processing of social data content. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by artificial intelligence processing of a data set and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by computer vision processing of satellite image content or web image content. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by artificial intelligence processing of a data set and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by automated processing of a set of energy transaction logs. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by artificial intelligence processing of a data set and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein the discovery of the grid-independent resources is by application of having an artificial intelligence system that is trained on a historical training data set of grid and off-grid energy pattern to recognize the presence of an off-grid energy resource. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by artificial intelligence processing of a data set and having an artificial intelligence system operating on a data set of energy generation, storage or consumption data for a set of infrastructure assets produced at least in part by a set of sensors contained in or governed by a set of edge devices to produce an output operating parameter for energy generation by at least one of the legacy infrastructure assets. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by artificial intelligence processing of a data set and having an artificial intelligence system operating on a data set of energy generation, storage or consumption data for a set of infrastructure assets produced at least in part by a set of sensors contained in or governed by a set of edge devices to produce an output operating parameter for energy storage for at least one of the legacy infrastructure assets. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by artificial intelligence processing of a data set and having an artificial intelligence system operating on a data set of energy generation, storage or consumption data for a set of infrastructure assets produced at least in part by a set of sensors contained in or governed by a set of edge devices to produce an output operating parameter for energy consumption by at least one of the legacy infrastructure assets. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by artificial intelligence processing of a data set and having a set of edge devices for collection of energy generation data for a set of infrastructure assets based on a set of sensors contained in or governed by the edge devices. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by artificial intelligence processing of a data set and having a set of edge devices for collection of energy storage data for a set of infrastructure assets based on a set of sensors contained in or governed by the edge devices. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by artificial intelligence processing of a data set and having a set of edge devices for collection of energy consumption data for a set of infrastructure assets based on a set of sensors contained in or governed by the edge devices. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by artificial intelligence processing of a data set and having a set of adaptive, autonomous data handling systems for energy edge data collection and transmission.

### Automated Discovery of Off-Grid Energy Resources for Automated and Coordinated Governance of Energy Resources by Use of Social Data

In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by natural language processing of social data content. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by natural language processing of social data content and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by computer vision processing of satellite image content or web image content. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by natural language processing of social data content and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by automated processing of a set of energy transaction logs. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by natural language processing of social data content and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein the discovery of the grid-independent resources is by application of having an artificial intelligence system that is trained on a historical training data set of grid and off-grid energy pattern to recognize the presence of an off-grid energy resource. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by natural language processing of social data content and having an artificial intelligence system operating on a data set of energy generation, storage or consumption data for a set of infrastructure assets produced at least in part by a set of sensors contained in or governed by a set of edge devices to produce an output operating parameter for energy generation by at least one of the legacy infrastructure assets. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by natural language processing of social data content and having an artificial intelligence system operating on a data set of energy generation, storage or consumption data for a set of infrastructure assets produced at least in part by a set of sensors contained in or governed by a set of edge devices to produce an output operating parameter for energy storage for at least one of the legacy infrastructure assets. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by natural language processing of social data content and having an artificial intelligence system operating on a data set of energy generation, storage or consumption data for a set of infrastructure assets produced at least in part by a set of sensors contained in or governed by a set of edge devices to produce an output operating parameter for energy consumption by at least one of the legacy infrastructure assets. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by natural language processing of social data content and having a set of edge devices for collection of energy generation data for a set of infrastructure assets based on a set of sensors contained in or governed by the edge devices. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by natural language processing of social data content and having a set of edge devices for collection of energy storage data for a set of infrastructure assets based on a set of sensors contained in or governed by the edge devices. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by natural language processing of social data content and having a set of edge devices for collection of energy consumption data for a set of infrastructure assets based on a set of sensors contained in or governed by the edge devices. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by natural language processing of social data content and having a set of adaptive, autonomous data handling systems for energy edge data collection and transmission.

### Automated Discovery of Off-Grid Energy Resources for Automated and Coordinated Governance of Energy Resources by Use of Computer Vision

In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by computer vision processing of satellite image content or web image content. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by computer vision processing of satellite image content or web image content and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by automated processing of a set of energy transaction logs. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by computer vision processing of satellite image content or web image content and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein the discovery of the grid-independent resources is by application of having an artificial intelligence system that is trained on a historical training data set of grid and off-grid energy pattern to recognize the presence of an off-grid energy resource. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by computer vision processing of satellite image content or web image content and having an artificial intelligence system operating on a data set of energy generation, storage or consumption data for a set of infrastructure assets produced at least in part by a set of sensors contained in or governed by a set of edge devices to produce an output operating parameter for energy generation by at least one of the legacy infrastructure assets. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by computer vision processing of satellite image content or web image content and having an artificial intelligence system operating on a data set of energy generation, storage or consumption data for a set of infrastructure assets produced at least in part by a set of sensors contained in or governed by a set of edge devices to produce an output operating parameter for energy storage for at least one of the legacy infrastructure assets. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by computer vision processing of satellite image content or web image content and having an artificial intelligence system operating on a data set of energy generation, storage or consumption data for a set of infrastructure assets produced at least in part by a set of sensors contained in or governed by a set of edge devices to produce an output operating parameter for energy consumption by at least one of the legacy infrastructure assets. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by computer vision processing of satellite image content or web image content and having a set of edge devices for collection of energy generation data for a set of infrastructure assets based on a set of sensors contained in or governed by the edge devices. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by computer vision processing of satellite image content or web image content and having a set of edge devices for collection of energy storage data for a set of infrastructure assets based on a set of sensors contained in or governed by the edge devices. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by computer vision processing of satellite image content or web image content and having a set of edge devices for collection of energy consumption data for a set of infrastructure assets based on a set of sensors contained in or governed by the edge devices. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by computer vision processing of satellite image content or web image content and having a set of adaptive, autonomous data handling systems for energy edge data collection and transmission.

### Automated Discovery of Off-Grid Energy Resources for Automated and Coordinated Governance of Energy Resources by Use of Transaction Logs

In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by automated processing of a set of energy transaction logs. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by automated processing of a set of energy transaction logs and having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein the discovery of the grid-independent resources is by application of having an artificial intelligence system that is trained on a historical training data set of grid and off-grid energy pattern to recognize the presence of an off-grid energy resource. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by automated processing of a set of energy transaction logs and having an artificial intelligence system operating on a data set of energy generation, storage or consumption data for a set of infrastructure assets produced at least in part by a set of sensors contained in or governed by a set of edge devices to produce an output operating parameter for energy generation by at least one of the legacy infrastructure assets. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by automated processing of a set of energy transaction logs and having an artificial intelligence system operating on a data set of energy generation, storage or consumption data for a set of infrastructure assets produced at least in part by a set of sensors contained in or governed by a set of edge devices to produce an output operating parameter for energy storage for at least one of the legacy infrastructure assets. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by automated processing of a set of energy transaction logs and having an artificial intelligence system operating on a data set of energy generation, storage or consumption data for a set of infrastructure assets produced at least in part by a set of sensors contained in or governed by a set of edge devices to produce an output operating parameter for energy consumption by at least one of the legacy infrastructure assets. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by automated processing of a set of energy transaction logs and having a set of edge devices for collection of energy generation data for a set of infrastructure assets based on a set of sensors contained in or governed by the edge devices. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by automated processing of a set of energy transaction logs and having a set of edge devices for collection of energy storage data for a set of infrastructure assets based on a set of sensors contained in or governed by the edge devices. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by automated processing of a set of energy transaction logs and having a set of edge devices for collection of energy consumption data for a set of infrastructure assets based on a set of sensors contained in or governed by the edge devices. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein automated discovery of the grid-independent resources is by automated processing of a set of energy transaction logs and having a set of adaptive, autonomous data handling systems for energy edge data collection and transmission.

### Automated Discovery of Off-Grid Energy Resources for Automated and Coordinated Governance of Energy Resources by Pattern Recognition Using Artificial Intelligence

In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein the discovery of the grid-independent resources is by application of having an artificial intelligence system that is trained on a historical training data set of grid and off-grid energy pattern to recognize the presence of an off-grid energy resource. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein the discovery of the grid-independent resources is by application of having an artificial intelligence system that is trained on a historical training data set of grid and off-grid energy pattern to recognize the presence of an off-grid energy resource and having an artificial intelligence system operating on a data set of energy generation, storage or consumption data for a set of infrastructure assets produced at least in part by a set of sensors contained in or governed by a set of edge devices to produce an output operating parameter for energy generation by at least one of the legacy infrastructure assets. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein the discovery of the grid-independent resources is by application of having an artificial intelligence system that is trained on a historical training data set of grid and off-grid energy pattern to recognize the presence of an off-grid energy resource and having an artificial intelligence system operating on a data set of energy generation, storage or consumption data for a set of infrastructure assets produced at least in part by a set of sensors contained in or governed by a set of edge devices to produce an output operating parameter for energy storage for at least one of the legacy infrastructure assets. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein the discovery of the grid-independent resources is by application of having an artificial intelligence system that is trained on a historical training data set of grid and off-grid energy pattern to recognize the presence of an off-grid energy resource and having an artificial intelligence system operating on a data set of energy generation, storage or consumption data for a set of infrastructure assets produced at least in part by a set of sensors contained in or governed by a set of edge devices to produce an output operating parameter for energy consumption by at least one of the legacy infrastructure assets. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein the discovery of the grid-independent resources is by application of having an artificial intelligence system that is trained on a historical training data set of grid and off-grid energy pattern to recognize the presence of an off-grid energy resource and having a set of edge devices for collection of energy generation data for a set of infrastructure assets based on a set of sensors contained in or governed by the edge devices. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein the discovery of the grid-independent resources is by application of having an artificial intelligence system that is trained on a historical training data set of grid and off-grid energy pattern to recognize the presence of an off-grid energy resource and having a set of edge devices for collection of energy storage data for a set of infrastructure assets based on a set of sensors contained in or governed by the edge devices. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein the discovery of the grid-independent resources is by application of having an artificial intelligence system that is trained on a historical training data set of grid and off-grid energy pattern to recognize the presence of an off-grid energy resource and having a set of edge devices for collection of energy consumption data for a set of infrastructure assets based on a set of sensors contained in or governed by the edge devices. In embodiments, provided herein is an AI-based platform for enabling intelligent orchestration and management of power and energy having a system for automated discovery of energy generation or storage resources that are electrically independent of the electrical grid that is in data communication with having a system for coordinated governance or provisioning of a set of grid energy facilities and a set of distributed edge energy resource sets that are electrically independent of the grid, wherein the discovery of the grid-independent resources is by application of having an artificial intelligence system that is trained on a historical training data set of grid and off-grid energy pattern to recognize the presence of an off-grid energy resource and having a set of adaptive, autonomous data handling systems for energy edge data collection and transmission.

### Edge at Optimization of Energy Generation Based on Edge Energy Intelligence

In embodiments, provided herein is an AI-based platform for enabling intelligent orchestration and management of power and energy having an artificial intelligence system operating on a data set of energy generation, storage or consumption data for a set of infrastructure assets produced at least in part by a set of sensors contained in or governed by a set of edge devices to produce an output operating parameter for energy generation by at least one of the legacy infrastructure assets. In embodiments, provided herein is an AI-based platform for enabling intelligent orchestration and management of power and energy having an artificial intelligence system operating on a data set of energy generation, storage or consumption data for a set of infrastructure assets produced at least in part by a set of sensors contained in or governed by a set of edge devices to produce an output operating parameter for energy generation by at least one of the legacy infrastructure assets and having an artificial intelligence system operating on a data set of energy generation, storage or consumption data for a set of infrastructure assets produced at least in part by a set of sensors contained in or governed by a set of edge devices to produce an output operating parameter for energy storage for at least one of the legacy infrastructure assets. In embodiments, provided herein is an AI-based platform for enabling intelligent orchestration and management of power and energy having an artificial intelligence system operating on a data set of energy generation, storage or consumption data for a set of infrastructure assets produced at least in part by a set of sensors contained in or governed by a set of edge devices to produce an output operating parameter for energy generation by at least one of the legacy infrastructure assets and having an artificial intelligence system operating on a data set of energy generation, storage or consumption data for a set of infrastructure assets produced at least in part by a set of sensors contained in or governed by a set of edge devices to produce an output operating parameter for energy consumption by at least one of the legacy infrastructure assets. In embodiments, provided herein is an AI-based platform for enabling intelligent orchestration and management of power and energy having an artificial intelligence system operating on a data set of energy generation, storage or consumption data for a set of infrastructure assets produced at least in part by a set of sensors contained in or governed by a set of edge devices to produce an output operating parameter for energy generation by at least one of the legacy infrastructure assets and having a set of edge devices for collection of energy generation data for a set of infrastructure assets based on a set of sensors contained in or governed by the edge devices. In embodiments, provided herein is an AI-based platform for enabling intelligent orchestration and management of power and energy having an artificial intelligence system operating on a data set of energy generation, storage or consumption data for a set of infrastructure assets produced at least in part by a set of sensors contained in or governed by a set of edge devices to produce an output operating parameter for energy generation by at least one of the legacy infrastructure assets and having a set of edge devices for collection of energy storage data for a set of infrastructure assets based on a set of sensors contained in or governed by the edge devices. In embodiments, provided herein is an AI-based platform for enabling intelligent orchestration and management of power and energy having an artificial intelligence system operating on a data set of energy generation, storage or consumption data for a set of infrastructure assets produced at least in part by a set of sensors contained in or governed by a set of edge devices to produce an output operating parameter for energy generation by at least one of the legacy infrastructure assets and having a set of edge devices for collection of energy consumption data for a set of infrastructure assets based on a set of sensors contained in or governed by the edge devices. In embodiments, provided herein is an AI-based platform for enabling intelligent orchestration and management of power and energy having an artificial intelligence system operating on a data set of energy generation, storage or consumption data for a set of infrastructure assets produced at least in part by a set of sensors contained in or governed by a set of edge devices to produce an output operating parameter for energy generation by at least one of the legacy infrastructure assets and having a set of adaptive, autonomous data handling systems for energy edge data collection and transmission.

### Edge at Optimization of Energy Storage Based on Edge Energy Intelligence

In embodiments, provided herein is an AI-based platform for enabling intelligent orchestration and management of power and energy having an artificial intelligence system operating on a data set of energy generation, storage or consumption data for a set of infrastructure assets produced at least in part by a set of sensors contained in or governed by a set of edge devices to produce an output operating parameter for energy storage for at least one of the legacy infrastructure assets. In embodiments, provided herein is an AI-based platform for enabling intelligent orchestration and management of power and energy having an artificial intelligence system operating on a data set of energy generation, storage or consumption data for a set of infrastructure assets produced at least in part by a set of sensors contained in or governed by a set of edge devices to produce an output operating parameter for energy storage for at least one of the legacy infrastructure assets and having an artificial intelligence system operating on a data set of energy generation, storage or consumption data for a set of infrastructure assets produced at least in part by a set of sensors contained in or governed by a set of edge devices to produce an output operating parameter for energy consumption by at least one of the legacy infrastructure assets. In embodiments, provided herein is an AI-based platform for enabling intelligent orchestration and management of power and energy having an artificial intelligence system operating on a data set of energy generation, storage or consumption data for a set of infrastructure assets produced at least in part by a set of sensors contained in or governed by a set of edge devices to produce an output operating parameter for energy storage for at least one of the legacy infrastructure assets and having a set of edge devices for collection of energy generation data for a set of infrastructure assets based on a set of sensors contained in or governed by the edge devices. In embodiments, provided herein is an AI-based platform for enabling intelligent orchestration and management of power and energy having an artificial intelligence system operating on a data set of energy generation, storage or consumption data for a set of infrastructure assets produced at least in part by a set of sensors contained in or governed by a set of edge devices to produce an output operating parameter for energy storage for at least one of the legacy infrastructure assets and having a set of edge devices for collection of energy storage data for a set of infrastructure assets based on a set of sensors contained in or governed by the edge devices. In embodiments, provided herein is an AI-based platform for enabling intelligent orchestration and management of power and energy having an artificial intelligence system operating on a data set of energy generation, storage or consumption data for a set of infrastructure assets produced at least in part by a set of sensors contained in or governed by a set of edge devices to produce an output operating parameter for energy storage for at least one of the legacy infrastructure assets and having a set of edge devices for collection of energy consumption data for a set of infrastructure assets based on a set of sensors contained in or governed by the edge devices. In embodiments, provided herein is an AI-based platform for enabling intelligent orchestration and management of power and energy having an artificial intelligence system operating on a data set of energy generation, storage or consumption data for a set of infrastructure assets produced at least in part by a set of sensors contained in or governed by a set of edge devices to produce an output operating parameter for energy storage for at least one of the legacy infrastructure assets and having a set of adaptive, autonomous data handling systems for energy edge data collection and transmission.

### Edge at Optimization of Energy Consumption Based on Edge Energy Intelligence

In embodiments, provided herein is an AI-based platform for enabling intelligent orchestration and management of power and energy having an artificial intelligence system operating on a data set of energy generation, storage or consumption data for a set of infrastructure assets produced at least in part by a set of sensors contained in or governed by a set of edge devices to produce an output operating parameter for energy consumption by at least one of the legacy infrastructure assets. In embodiments, provided herein is an AI-based platform for enabling intelligent orchestration and management of power and energy having an artificial intelligence system operating on a data set of energy generation, storage or consumption data for a set of infrastructure assets produced at least in part by a set of sensors contained in or governed by a set of edge devices to produce an output operating parameter for energy consumption by at least one of the legacy infrastructure assets and having a set of edge devices for collection of energy generation data for a set of infrastructure assets based on a set of sensors contained in or governed by the edge devices. In embodiments, provided herein is an AI-based platform for enabling intelligent orchestration and management of power and energy having an artificial intelligence system operating on a data set of energy generation, storage or consumption data for a set of infrastructure assets produced at least in part by a set of sensors contained in or governed by a set of edge devices to produce an output operating parameter for energy consumption by at least one of the legacy infrastructure assets and having a set of edge devices for collection of energy storage data for a set of infrastructure assets based on a set of sensors contained in or governed by the edge devices. In embodiments, provided herein is an AI-based platform for enabling intelligent orchestration and management of power and energy having an artificial intelligence system operating on a data set of energy generation, storage or consumption data for a set of infrastructure assets produced at least in part by a set of sensors contained in or governed by a set of edge devices to produce an output operating parameter for energy consumption by at least one of the legacy infrastructure assets and having a set of edge devices for collection of energy consumption data for a set of infrastructure assets based on a set of sensors contained in or governed by the edge devices. In embodiments, provided herein is an AI-based platform for enabling intelligent orchestration and management of power and energy having an artificial intelligence system operating on a data set of energy generation, storage or consumption data for a set of infrastructure assets produced at least in part by a set of sensors contained in or governed by a set of edge devices to produce an output operating parameter for energy consumption by at least one of the legacy infrastructure assets and having a set of adaptive, autonomous data handling systems for energy edge data collection and transmission.

### Edge Device-Governed Data Collection for Legacy Infrastructure Energy Generation Intelligence

In embodiments, provided herein is an AI-based platform for enabling intelligent orchestration and management of power and energy having a set of edge devices for collection of energy generation data for a set of infrastructure assets based on a set of sensors contained in or governed by the edge devices. In embodiments, provided herein is an AI-based platform for enabling intelligent orchestration and management of power and energy having a set of edge devices for collection of energy generation data for a set of infrastructure assets based on a set of sensors contained in or governed by the edge devices and having a set of edge devices for collection of energy storage data for a set of infrastructure assets based on a set of sensors contained in or governed by the edge devices. In embodiments, provided herein is an AI-based platform for enabling intelligent orchestration and management of power and energy having a set of edge devices for collection of energy generation data for a set of infrastructure assets based on a set of sensors contained in or governed by the edge devices and having a set of edge devices for collection of energy consumption data for a set of infrastructure assets based on a set of sensors contained in or governed by the edge devices. In embodiments, provided herein is an AI-based platform for enabling intelligent orchestration and management of power and energy having a set of edge devices for collection of energy generation data for a set of infrastructure assets based on a set of sensors contained in or governed by the edge devices and having a set of adaptive, autonomous data handling systems for energy edge data collection and transmission.

### Edge Device-Governed Data Collection for Legacy Infrastructure Energy Storage Intelligence

In embodiments, provided herein is an AI-based platform for enabling intelligent orchestration and management of power and energy having a set of edge devices for collection of energy storage data for a set of infrastructure assets based on a set of sensors contained in or governed by the edge devices. In embodiments, provided herein is an AI-based platform for enabling intelligent orchestration and management of power and energy having a set of edge devices for collection of energy storage data for a set of infrastructure assets based on a set of sensors contained in or governed by the edge devices and having a set of edge devices for collection of energy consumption data for a set of infrastructure assets based on a set of sensors contained in or governed by the edge devices. In embodiments, provided herein is an AI-based platform for enabling intelligent orchestration and management of power and energy having a set of edge devices for collection of energy storage data for a set of infrastructure assets based on a set of sensors contained in or governed by the edge devices and having a set of adaptive, autonomous data handling systems for energy edge data collection and transmission.

### Edge Device-Governed Data Collection for Legacy Infrastructure Energy Consumption Intelligence

In embodiments, provided herein is an AI-based platform for enabling intelligent orchestration and management of power and energy having a set of edge devices for collection of energy consumption data for a set of infrastructure assets based on a set of sensors contained in or governed by the edge devices. In embodiments, provided herein is an AI-based platform for enabling intelligent orchestration and management of power and energy having a set of edge devices for collection of energy consumption data for a set of infrastructure assets based on a set of sensors contained in or governed by the edge devices and having a set of adaptive, autonomous data handling systems for energy edge data collection and transmission.

### Adaptive, Autonomous Data Handling Systems in the Energy Edge

In embodiments, provided herein is an AI-based platform for enabling intelligent orchestration and management of power and energy having a set of adaptive, autonomous data handling systems for energy edge data collection and transmission.

### Computer-Based Implementations

### INTRODUCTION

The methods and/or processes described in the disclosure, and steps associated therewith, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The elements described and depicted herein, including in flow charts and block diagrams throughout the figures, imply logical boundaries between the elements. However, according to software or hardware engineering practices, the depicted elements and the functions thereof may be implemented on machines through computer executable code using a processor capable of executing program instructions stored thereon as a monolithic software structure, as standalone software modules, or as modules that employ external routines, code, services, and so forth, or any combination of these, and all such implementations may be within the scope of the disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices, artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described in the disclosure may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

### Special-Purpose Systems

A special-purpose system includes hardware and/or software and may be described in terms of an apparatus, a method, or a computer-readable medium. In various embodiments, functionality may be apportioned differently between software and hardware. For example, some functionality may be implemented by hardware in one embodiment and by software in another embodiment. Further, software may be encoded by hardware structures, and hardware may be defined by software, such as in software-defined networking or software-defined radio.

In this application, including the claims, the term module refers to a special-purpose system. The module may be implemented by one or more special-purpose systems. The one or more special-purpose systems may also implement some or all of the other modules. In this application, including the claims, the term “module” may be replaced with the term “controller” or the term “circuit.” In this application, including the claims, the term platform refers to one or more modules that offer a set of functions. In this application, including the claims, the term system may be used interchangeably with module or with the term special-purpose system.

The special-purpose system may be directed or controlled by an operator. The special-purpose system may be hosted by one or more of assets owned by the operator, assets leased by the operator, and third-party assets. The assets may be referred to as a private, community, or hybrid cloud computing network or cloud computing environment. For example, the special-purpose system may be partially or fully hosted by a third-party offering software as a service (SaaS), platform as a service (PaaS), and/or infrastructure as a service (IaaS). The special-purpose system may be implemented using agile development and operations (DevOps) principles. In embodiments, some or all of the special-purpose system may be implemented in a multiple-environment architecture. For example, the multiple environments may include one or more production environments, one or more integration environments, one or more development environments, etc.

A special-purpose system may be partially or fully implemented using or by a mobile device.

A special-purpose system may be partially or fully implemented using or by a network device.

A special-purpose system may be partially or fully implemented using a computer having a variety of form factors and other characteristics. For example, the computer may be characterized as a personal computer, as a server, etc. The computer may be portable, as in the case of a laptop, netbook, etc. The computer may or may not have any output device, such as a monitor, line printer, liquid crystal display (LCD), light emitting diodes (LEDs), etc. The computer may or may not have any input device, such as a keyboard, mouse, touchpad, trackpad, computer vision system, barcode scanner, button array, etc. The computer may run a general-purpose operating system, such as the WINDOWS operating system from Microsoft Corporation, the MACOS operating system from Apple, Inc., or a variant of the LINUX operating system.

A special-purpose system may be distributed across multiple different software and hardware entities. Communication within a special-purpose system and between special-purpose systems may be performed using networking hardware. The distribution may vary across embodiments and may vary over time. For example, the distribution may vary based on demand, with additional hardware and/or software entities invoked to handle higher demand. In various embodiments, a load balancer may direct requests to one of multiple instantiations of the special purpose system. The hardware and/or software entities may be physically distinct and/or may share some hardware and/or software, such as in a virtualized environment. Multiple hardware entities may be referred to as a server rack, server farm, data center, etc.

### Hardware

The term “hardware” encompasses components such as processing hardware, storage hardware, networking hardware, and other general-purpose and special-purpose components. Note that these are not mutually exclusive categories. For example, processing hardware may integrate storage hardware and vice versa.

Multiple components of the hardware may be integrated, such as on a single die, in a single package, or on a single printed circuit board or logic board. For example, multiple components of the hardware may be implemented as a system-on-chip. A component, or a set of integrated components, may be referred to as a chip, chipset, chiplet, or chip stack.

The hardware may integrate and/or receive signals from sensors. The sensors may allow observation and measurement of conditions including temperature, pressure, wear, light, humidity, deformation, expansion, contraction, deflection, bending, stress, strain, load-bearing, shrinkage, power, energy, mass, location, temperature, humidity, pressure, viscosity, liquid flow, chemical/gas presence, sound, and air quality. A sensor may include image and/or video capture in visible and/or non-visible (such as thermal) wavelengths, such as a charge-coupled device (CCD) or complementary metal-oxide semiconductor (CMOS) sensor.

Some or all features of hardware may be defined using a language for hardware description, such as IEEE Standard 1364-2005 (commonly called “Verilog”) and IEEE Standard 1076-2008 (commonly called “VHDL”). The hardware description language may be used to manufacture and/or program hardware.

The methods and systems described herein may transform physical and/or intangible items from one state to another. The methods and systems described herein may also transform data representing physical and/or intangible items from one state to another.

### Storage Hardware and Computer-Readable Media

Storage hardware is or includes a computer-readable medium. The term computer-readable medium, as used in this disclosure, encompasses both nonvolatile storage and volatile storage, such as dynamic random-access memory (DRAM). The term computer-readable medium only excludes transitory electrical or electromagnetic signals propagating through a medium (such as on a carrier wave). A computer-readable medium in this disclosure is therefore non-transitory and may also be considered tangible. The storage hardware may include cache memory, which may be collocated with or integrated with processing hardware. Storage hardware may have read-only, write-once, or read/write properties. Storage hardware may be random access or sequential access. Storage hardware may be location-addressable, file-addressable, and/or content-addressable.

### Processing Hardware and Architecture

The methods and systems described herein may be deployed in part or in whole through machines that execute computer software, program codes, and/or instructions on processing hardware (also referred to as a “processor”). The disclosure may be implemented as a method on the machine(s), as a system or apparatus as part of or in relation to the machine(s), or as a computer program product embodied in a computer readable medium executing on one or more of the machines. In embodiments, the processor may be part of a server, cloud server, client, network infrastructure, mobile computing platform, stationary computing platform, or other computing platforms. A processor may be any kind of computational or processing device capable of executing program instructions, codes, binary instructions and the like, including a central processing unit (CPU), a general processing unit (GPU), a logic board, a chip (e.g., a graphics chip, a video processing chip, a data compression chip, or the like), a chipset, a controller, a system-on-chip (e.g., an RF system on chip, an AI system on chip, a video processing system on chip, or others), an integrated circuit, an application specific integrated circuit (ASIC), a field programmable gate array (FPGA), an approximate computing processor, a quantum computing processor, a parallel computing processor, a neural network processor, or other type of processor. The processor may be or may include a signal processor, digital processor, data processor, embedded processor, microprocessor or any variant such as a co-processor (math co-processor, graphic co-processor, communication co-processor, video co-processor, AI co-processor, and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor, or any machine utilizing one, may include non-transitory memory that stores methods, codes, instructions and programs as described herein and elsewhere. The processor may access a non-transitory storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache, network-attached storage, server-based storage, and the like.

A processor may include one or more cores that may enhance speed and performance of a multiprocessor. In embodiments, the process may be a dual core processor, quad core processors, other chip-level multiprocessor and the like that combine two or more independent cores (sometimes called a die).

The processor may enable execution of multiple threads. These multiple threads may correspond to different programs. In various embodiments, a single program may be implemented as multiple threads by the programmer or may be decomposed into multiple threads by the processing hardware. The threads may be executed simultaneously to enhance the performance of the processor and to facilitate simultaneous operations of the application.

A processor may be implemented as a packaged semiconductor die. The die includes one or more processing cores and may include additional functional blocks, such as cache. In various embodiments, the processor may be implemented by multiple dies, which may be combined in a single package or packaged separately.

### Networking Hardware and Infrastructure

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements. The methods and systems described herein may be adapted for use with any kind of private, community, or hybrid cloud computing network or cloud computing environment, including those which involve features of software as a service (SaaS), platform as a service (PaaS), and/or infrastructure as a service (IaaS).

The methods, program codes, and instructions described herein and elsewhere may be implemented on a cellular network with multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, 4G, 5G, LTE, EVDO, mesh, or other network types.

The networking hardware may include one or more interface circuits. In some examples, the interface circuit(s) may implement wired or wireless interfaces that connect, directly or indirectly, to one or more networks. A wide-area network may also be referred to as a distributed communications system (DCS). The networks may include one or more of point-to-point and mesh technologies. Data transmitted or received by the networking components may traverse the same or different networks. Networks may be connected to each other over a WAN or point-to-point leased lines using technologies such as Multiprotocol Label Switching (MPLS) and virtual private networks (VPNs).

### Software

Software includes instructions that are machine-readable and/or executable. Instructions may be logically grouped into programs, codes, methods, steps, actions, routines, functions, libraries, objects, classes, etc. Software may be stored by storage hardware or encoded in other hardware. Software encompasses (i) descriptive text to be parsed, such as HTML (hypertext markup language), XML (extensible markup language), and JSON (JavaScript Object Notation), (ii) assembly code, (iii) object code generated from source code by a compiler, (iv) source code for execution by an interpreter, (v) bytecode, (vi) source code for compilation and execution by a just-in-time compiler, etc. As examples only, source code may be written using syntax from languages including C, C++, JavaScript, Java, Python, R, etc. The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the devices described in the disclosure, as well as heterogeneous combinations of processors, processor architectures, or combinations of different hardware and software, or any other machine capable of executing program instructions. Computer software may employ virtualization, virtual machines, containers, dock facilities, portainers, and other capabilities. In example embodiments, methods described in the disclosure and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described in the disclosure may include any of the hardware and/or software described in the disclosure. All such permutations and combinations are intended to fall within the scope of the disclosure.

Software also includes data. However, data and instructions are not mutually exclusive categories. In various embodiments, the instructions may be used as data in one or more operations. As another example, instructions may be derived from data. The functional blocks and flowchart elements in this disclosure serve as software specifications, which can be translated into software by the routine work of a skilled technician or programmer. Software may include and/or rely on firmware, processor microcode, an operating system (OS), a basic input/output system (BIOS), application programming interfaces (APIs), libraries such as dynamic-link libraries (DLLs), device drivers, hypervisors, user applications, background services, background applications, etc. Software includes native applications and web applications. For example, a web application may be served to a device through a browser using hypertext markup language 5th revision (HTML5).

Software may include artificial intelligence systems, which may include machine learning or other computational intelligence. For example, artificial intelligence may include one or more models used for one or more problem domains. When presented with many data features, identification of a subset of features that are relevant to a problem domain may improve prediction accuracy, reduce storage space, and increase processing speed. This identification may be referred to as feature engineering. Feature engineering may be performed by users or may only be guided by users. In various implementations, a machine learning system may computationally identify relevant features, such as by performing singular value decomposition on the contributions of different features to outputs. Examples of the models include recurrent neural networks (RNNs) such as long short-term memory (LSTM), deep learning models such as transformers, decision trees, support-vector machines, genetic algorithms, Bayesian networks, and regression analysis. Examples of systems based on a transformer model include bidirectional encoder representations from transformers (BERT) and generative pre-trained transformer (GPT). Training a machine-learning model may include supervised learning (for example, based on labelled input data), unsupervised learning, and reinforcement learning. In various embodiments, a machine-learning model may be pre-trained by their operator or by a third party. Problem domains include nearly any situation where structured data can be collected, and includes natural language processing (NLP), computer vision (CV), classification, image recognition, etc.

Entities recording transactions, such as in a blockchain, may reach consensus using an algorithm such as proof-of-stake, proof-of-work, and proof-of-storage. Elements of the present disclosure may be represented by or encoded as non-fungible tokens (NFTs). Ownership rights related to the non-fungible tokens may be recorded in or referenced by a distributed ledger. Transactions initiated by or relevant to the present disclosure may use one or both of fiat currency and cryptocurrencies, examples of which include bitcoin and ether.

### Architectures

The methods and systems described herein may be deployed in part or in whole through machines that execute computer software on various devices including a server, client, firewall, gateway, hub, router, switch, infrastructure-as-a-service, platform-as-a-service, or other such computer and/or networking hardware or system. The software may be associated with a server that may include a file server, print server, domain server, internet server, intranet server, cloud server, infrastructure-as-a-service server, platform-as-a-service server, web server, and other variants such as secondary server, host server, distributed server, failover server, backup server, server farm, and the like. The server may include one or more of memories, processors, computer readable media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, social networks, and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

A software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs, or codes as described herein and elsewhere may be executed by the client. In addition, other devices required for the execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

In a client-server model, some of the software executes on first hardware identified functionally as a server, while other of the software executes on second hardware identified functionally as a client. The identity of the client and server is not fixed: for some functionality, the first hardware may act as the server while for other functionality, the first hardware may act as the client. In different embodiments and in different scenarios, functionality may be shifted between the client and the server. In one dynamic example, some functionality normally performed by the second hardware is shifted to the first hardware when the second hardware has less capability. In various embodiments, the term “local” may be used in place of “client,” and the term “remote” may be used in place of “server.”

Some or all of the software may run in a virtual environment rather than directly on hardware. The virtual environment may include a hypervisor, emulator, sandbox, container engine, etc. The software may be built as a virtual machine, a container, etc. Virtualized resources may be controlled using, for example, a DOCKER™ container platform, a pivotal cloud foundry (PCF) platform, etc.

Some or all of the software may be logically partitioned into microservices. Each microservice offers a reduced subset of functionality. In various embodiments, each microservice may be scaled independently depending on load, either by devoting more resources to the microservice or by instantiating more instances of the microservice. In various embodiments, functionality offered by one or more microservices may be combined with each other and/or with other software not adhering to a microservices model.

Some or all of the software may be arranged logically into layers. In a layered architecture, a second layer may be logically placed between a first layer and a third layer. The first layer and the third layer would then generally interact with the second layer and not with each other. In various embodiments, this is not strictly enforced—for example, some direct communication may occur between the first and third layers.

The methods, program codes, and instructions described herein and elsewhere may be implemented on or through mobile devices. The mobile devices may include navigation devices, cell phones, mobile phones, mobile personal digital assistants, laptops, palmtops, netbooks, pagers, electronic book readers, music players and the like. These devices may include, apart from other components, a storage medium such as flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

### EXAMPLES

Examples of hardware components include integrated circuits (ICs), application specific integrated circuit (ASICs), digital circuit elements, analog circuit elements, combinational logic circuits, gate arrays such as field programmable gate arrays (FPGAs), digital signal processors (DSPs), and complex programmable logic devices (CPLDs).

Examples of servers include a file server, print server, domain server, internet server, intranet server, cloud server, infrastructure-as-a-service server, platform-as-a-service server, web server, secondary server, host server, distributed server, failover server, and backup server.

Examples of mobile devices include navigation devices, cell phones, smart phones, mobile phones, mobile personal digital assistants, palmtops, netbooks, pagers, electronic book readers, tablets, and music players.

Examples of network devices include switches, routers, firewalls, gateways, hubs, base stations, access points, repeaters, head-ends, user equipment, cell sites, antennas, and towers.

Examples of processing hardware include a central processing unit (CPU), a graphics processing unit (GPU), an approximate computing processor, a quantum computing processor, a parallel computing processor, a neural network processor, a signal processor, a digital processor, a data processor, an embedded processor, a microprocessor, and a co-processor. The co-processor may provide additional processing functions and/or optimizations, such as for speed or power consumption. Examples of a co-processor include a math co-processor, a graphics co-processor, a communication co-processor, a video co-processor, and an artificial intelligence (AI) co-processor.

Examples of a system-on-chip include a radio frequency (RF) system-on-chip, an artificial intelligence (AI) system-on-chip, a video processing system-on-chip, an organ-on-chip, a quantum algorithm system-on-chip, etc.

Examples of storage hardware and/or computer-readable media include computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, network-attached storage, network storage, NVME-accessible storage, PCIE connected storage, and distributed storage.

Examples of storage implemented by the storage hardware include a database (such as a relational database or a NoSQL database), a data store, a data lake, a column store, a data warehouse.

Example of storage hardware include nonvolatile memory devices, volatile memory devices, magnetic storage media, a storage area network (SAN), network-attached storage (NAS), optical storage media, printed media (such as bar codes and magnetic ink), and paper media (such as punch cards and paper tape).

Example of nonvolatile memory devices include flash memory (including NAND and NOR technologies), solid state drives (SSDs), an erasable programmable read-only memory device such as an electrically erasable programmable read-only memory (EEPROM) device, and a mask read-only memory device (ROM).

Example of volatile memory devices include processor registers and random-access memory (RAM), such as static RAM (SRAM), dynamic RAM (DRAM), synchronous DRAM (SDRAM), synchronous graphics RAM (SGRAM), and video RAM (VRAM).

Example of magnetic storage media include analog magnetic tape, digital magnetic tape, and rotating hard disk drive (HDDs).

Examples of optical storage media include a CD (such as a CD-R, CD-RW, or CD-ROM), a DVD, a Blu-ray disc, and an Ultra HD Blu-ray disc.

Examples of storage implemented by the storage hardware include a distributed ledger, such as a permissioned or permissionless blockchain.

Examples of networks include a cellular network, a local area network (LAN), a wireless personal area network (WPAN), a metropolitan area network (MAN), and/or a wide area network (WAN).

Examples of local area networks (LANs) include Institute of Electrical and Electronics Engineers (IEEE) Standard 802.11-2020 (also known as the Wi-Fi wireless networking standard) and IEEE Standard 802.3-2018 (also known as the ETHERNET wired networking standard).

Examples of a WPAN include IEEE Standard 802.15.4, including the ZIGBEE standard from the ZigBee Alliance. Further examples of a WPAN include the BLUETOOTH wireless networking standard, including Core Specification versions 3.0, 4.0, 4.1, 4.2, 5.0, and 5.1 from the Bluetooth Special Interest Group (SIG).

Examples of cellular networks include GSM, GPRS, 3G, 4G, 5G, LTE, and EVDO. The cellular network may be implemented using frequency division multiple access (FDMA) network or code division multiple access (CDMA) network.

Examples of wide-area networks (WANs) include the Internet.

### Further Information and Use of Terms

The background description is presented simply for context, and is not necessarily well-understood, routine, or conventional. Further, the background description is not an admission of what does or does not qualify as prior art. In fact, some or all of the background description may be work attributable to the named inventors that is otherwise unknown in the art.

While only a few embodiments of the disclosure have been shown and described, it will be obvious to those skilled in the art that many changes and modifications may be made thereunto without departing from the spirit and scope of the disclosure as described in the following claims. All patent applications and patents, both foreign and domestic, and all other publications referenced herein are incorporated herein in their entireties to the full extent permitted by law.

The detailed description includes specific examples for illustration only, and not to limit the disclosure or its applicability. The examples are not intended to be an exhaustive list, but instead simply demonstrate possession by the inventors of the full scope of the currently presented and envisioned future claims. Variations, combinations, and equivalents of the examples are within the scope of the disclosure. No language in the specification should be construed as indicating that any non-claimed element is essential or critical to the practice of the disclosure. Although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of multiple embodiments remain within the scope of this disclosure. No language in the specification should be construed as indicating any non-claimed element as essential to the practice of the disclosure.

All methods described herein can be performed in any suitable order unless otherwise indicated herein or otherwise clearly contradicted by context. For example, one or more elements (e.g., steps within a method, instructions, actions, or operations) may be executed in a different order (and/or concurrently) without altering the principles of the present disclosure. Unless technically infeasible, elements described as being in series may be implemented partially or fully in parallel. Similarly, unless technically infeasible, elements described as being in parallel may be implemented partially or fully in series.

While the disclosure describes structures corresponding to claimed elements, those elements do not necessarily invoke a means plus function interpretation unless they explicitly use the signifier “means for.” Unless otherwise indicated, recitations of ranges of values are merely intended to serve as a shorthand way of referring individually to each separate value falling within the range, and each separate value is hereby incorporated into the specification as if it were individually recited.

Physical (such as spatial and/or electrical) and functional relationships between elements (for example, between modules, circuit elements, semiconductor layers, etc.) are described using various terms. Unless explicitly described as being “direct,” when a relationship between first and second elements is described, that relationship encompasses both (i) a direct relationship where no other intervening elements are present between the first and second elements and (ii) an indirect relationship where one or more intervening elements are present between the first and second elements. Example relationship terms include “adjoining,” “transmitting,” “receiving,” “connected,” “engaged,” “coupled,” “adjacent,” “next to,” “on top of,” “above,” “below,” “abutting,” and “disposed.”

While the drawings divide elements of the disclosure into different functional blocks or action blocks, these divisions are for illustration only. According to the principles of the present disclosure, functionality can be combined in other ways such that some or all functionality from multiple separately-depicted blocks can be implemented in a single functional block; similarly, functionality depicted in a single block may be separated into multiple blocks. Unless explicitly stated as mutually exclusive, features depicted in different drawings can be combined consistent with the principles of the present disclosure.

In the drawings, reference numbers may be reused to identify identical elements or may simply identify elements that implement similar functionality. Numbering or other labeling of instructions or method steps is done for convenient reference, not to indicate a fixed order. In the drawings, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. As one example, for information sent from element A to element B, element B may send requests and/or acknowledgements to element A.

While the foregoing written description enables one skilled to make and use what is considered presently to be the best mode thereof, those skilled in the art will understand and appreciate the existence of variations, combinations, and equivalents of the specific embodiment, method, and examples herein. The disclosure should therefore not be limited by the above-described embodiment, method, and examples, but by all embodiments and methods within the scope and spirit of the disclosure. The spirit and scope of the disclosure is not to be limited by the foregoing examples, but is to be understood in the broadest sense allowable by law.

The use of the terms “a” and “an” and “the” and similar referents in the context of describing the disclosure (especially in the context of the following claims) is to be construed to cover both the singular and the plural, unless otherwise indicated herein or clearly contradicted by context. The phrase “at least one of A, B, and C” should be construed to mean a logical (A OR B OR C), using a non-exclusive logical OR, and should not be construed to mean “at least one of A, at least one of B, and at least one of C.” The terms “comprising,” “with,” “including,” and “containing” are to be construed as open-ended terms (i.e., meaning “including, but not limited to,”) unless otherwise noted. Recitations of ranges of values herein are merely intended to serve as a shorthand method of referring individually to each separate value falling within the range, unless otherwise indicated herein, and each separate value is incorporated into the specification as if it were individually recited herein. The term “exemplary” simply means “example” and does not indicate a best or preferred example. The use of any and all examples, or exemplary language (e.g., “such as”) provided herein, is intended merely to better illuminate the disclosure and does not pose a limitation on the scope of the disclosure unless otherwise claimed. The term “set” may include a set with a single member. The term “set” does not necessarily exclude the empty set—in other words, in some circumstances a “set” may have zero elements. The term “non-empty set” may be used to indicate exclusion of the empty set—that is, a non-empty set must have one or more elements. The term “subset” does not necessarily require a proper subset. In other words, a “subset” of a first set may be coextensive with (equal to) the first set. Further, the term “subset” does not necessarily exclude the empty set—in some circumstances a “subset” may have zero elements.

1.-10. (canceled)

11. An AI-based platform for enabling intelligent orchestration and management of power and energy, comprising:
a supply graph neural network a set of nodes respectively representing at least one distributed energy resource (DER) configured to generate, store, convert, and/or transport energy;
a demand graph neural network a set of nodes respectively representing at least one distributed energy resource (DER) configured to consume energy; and
an AI-based energy orchestration model configured to orchestrate and manage power and energy by meshing the supply graph neural network and the demand graph neural network.

12. The AI-based platform of claim 11 wherein at least one node of the set of nodes included in the supply graph neural network indicates information about the at least one distributed energy resource, and the information includes at least one of:
a power generation capability of the at least one distributed energy resource, a power storage capability of the at least one distributed energy resource,
a power transmission capability of the at least one distributed energy resource, a power exchange capability of the at least one distributed energy resource,
a power conversion capability of the at least one distributed energy resource, a power delivery capability of the at least one distributed energy resource, or
a power consumption capability of the at least one distributed energy resource.

13. The AI-based platform of claim 11 wherein at least one node of the set of nodes included in the supply graph neural network indicates information about at least one energy-related pattern associated with at least one distributed energy resource, and the at least one energy-related pattern includes at least one of:
an energy demand pattern,
an energy supply pattern,
an energy storage capacity pattern,
an energy market price pattern,
an energy availability pattern, or
an energy emissions pattern.

14. The AI-based platform of claim 11 wherein the supply graph neural network includes at least one edge representing at least one energy-related relationship among at least two nodes of the supply graph neural network, and the at least one energy-related relationship includes at least one of,
an electrical connection relationship among the at least two nodes,
a power transmission capability relationship among the at least two nodes, a power transfer relationship among the at least two nodes,
a power exchange relationship among the at least two nodes, a power conversion relationship among the at least two nodes,
a power generation dependency relationship among the at least two nodes, a power supply dependency relationship among the at least two nodes,
a power delivery dependency relationship among the at least two nodes,
a power storage dependency relationship among the at least two nodes, or
a power consumption dependency relationship among the at least two nodes.

15. The AI-based platform of claim 11,
wherein the supply graph neural network includes at least one edge representing an energy-related relationship among at least two nodes of the supply graph neural network,
wherein the at least one edge included in the supply graph neural network is a directed edge, and
wherein a direction of the directed edge represents a directional dependency relationship among at least two nodes of the set of nodes of the supply graph neural network.

16. The AI-based platform of claim 11,
wherein the supply graph neural network includes at least one edge representing at least one energy-related event among at least two nodes of the supply graph neural network, and
wherein the at least one energy-related event includes at least one of:
an energy generation event associated with the at least two nodes,
an energy storage event associated with the at least two nodes,
an energy transmission event associated with the at least two nodes,
an energy supply event associated with the at least two nodes,
an energy demand event associated with the at least two nodes,
an energy surplus event associated with the at least two nodes,
an energy shortage event associated with the at least two nodes,
an energy consumption event associated with the at least two nodes,
an energy emissions event associated with the at least two nodes, or
an energy leakage event associated with the at least two nodes.

17. The AI-based platform of claim 11 further comprising at least one artificial intelligence model configured to generate at least one of the supply graph neural network or the demand graph neural network based on data associated with at least one distributed energy resource.

18. The AI-based platform of claim 17 wherein the data associated with the at least one distributed energy resource includes at least one of:
energy generation data associated with the at least one distributed energy resource, energy storage data associated with the at least one distributed energy resource, energy transmission data associated with the at least one distributed energy resource, energy supply data associated with the at least one distributed energy resource, energy demand data associated with the at least one distributed energy resource, energy surplus data associated with the at least one distributed energy resource, energy shortage data associated with the at least one distributed energy resource, energy consumption data associated with the at least one distributed energy resource, energy emissions data associated with the at least one distributed energy resource, or energy leakage data associated with the at least one distributed energy resource.

19. The AI-based platform of claim 17 wherein the data associated with the at least one distributed energy resource includes at least one of:
historical data that indicates at least one historical feature associated with the at least one distributed energy resource,
current data that indicates at least one current feature associated with the at least one distributed energy resource, or
forecasted data that indicates at least one forecasted feature associated with the at least one distributed energy resource.

20. The AI-based platform of claim 11 wherein at least one distributed energy resources represented by at least one node of the supply graph neural network represents at least one of:
a wind turbine,
a solar photovoltaic (PV),
a flexible solar energy system,
a floating solar energy system,
a solar energy farm,
a fuel cell, a coal mine,
a petroleum well,
a natural gas well,
a modular nuclear reactor,
a nuclear battery,
a modular hydropower system,
a microturbine,
a turbine array,
a reciprocating engine,
a combustion turbine,
a cogeneration plant,
a biomass generator,
a municipal solid waste incinerator,
a battery storage system,
a capacitive energy storage system,
a geothermal energy system,
a molten salt energy storage system,
an electro-thermal energy storage (ETES) system,
a gravity-based storage system,
a compressed fluid energy storage,
a pumped hydroelectric energy storage (PHES) system,
a liquid air energy storage (LAES) system,
a coal storage facility,
a petroleum storage tank, a natural gas storage tank,
a liquefied natural gas (LNG) storage tank,
a flywheel,
a gravity battery,
a fuel transport vehicle,
a fuel transport pipeline,
a wired power transmission system, or
a wireless power transmission system.

21. The AI-based platform of claim 11, wherein the AI-based energy orchestration model to reserves at least one energy supply capability of at least one node of the supply graph neural network for at least one energy demand of at least one node of the demand graph neural network.

22. (canceled)

23. The AI-based platform of claim 11 wherein the AI-based energy orchestration model meshes the supply graph neural network and the demand graph neural network by matching each node of the demand graph neural network with at least one node of the supply graph neural network.

24. The AI-based platform of claim 11 wherein the AI-based energy orchestration model meshes the supply graph neural network and the demand graph neural network based on an energy-related event graph neural network, and the energy-related event graph neural network includes:
a set of nodes respectively representing at least one energy-related event involving at least one of: a node of the supply graph neural network or a node of the demand graph neural network; and
a set of edges respectively associated with at least two nodes of the energy-related event graph neural network.

25. The AI-based platform of claim 24 wherein the AI-based energy orchestration model is configured to generate the energy-related event graph neural network based on at least one interaction among at least one node of the supply graph neural network, or at least one node of the demand graph neural network.

26.-65. (canceled)

66. A method for enabling intelligent orchestration and management of power and energy comprising:
generating at least one supply graph neural network based on data associated with at least one distributed energy resource configured to perform at least one of: generate energy, store energy, convert energy, or transport energy;
generating at least one demand graph neural network based on data associated with at least one distributed energy resource configured to consume energy; and
orchestrating and managing power and energy by meshing the at least one supply graph neural network and the at least one demand graph neural network.

67. The method of claim 66, further comprising reserving at least one energy supply capability of at least one node of the at least one supply graph neural network for at least one energy demand of at least one node of the at least one demand graph neural network.

68. The method of claim 66, wherein the meshing the at least one supply graph neural network and the at least one demand graph neural network includes matching each node of the at least one demand graph neural network with at least one node of the at least one supply graph neural network.
